(19) United States
(12) Patent Application Publication
(10) Pub. No.: US 2026/0228163 A1
(43) Pub. Date: Aug. 6, 2026

(54) Translating Between UALink and CXL.mem for Memory Access Across Heterogeneous Interconnects, Enabling Scale-Up Memory Tier for GPUs and Accelerators

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/630,151

(22) Filed: Mar. 26, 2026

Related U.S. Application Data
(63) Continuation-in-part of application No. 19/371,779, filed on Oct. 28, 2025, now Pat. No. 12,657,153.
Application No. 19/371,779 is a continuation of application No. 19/017,420, filed on Jan. 11, 2025, now Pat. No. 12,613,826.
Application No. 19/017,420 is a continuation-in-part of application No. 18/981,443, filed on Dec. 13, 2024.
(60) Provisional application No. 63/609,833, filed on Dec. 13, 2023.
(60) Provisional application No. 63/641,404, filed on May 1, 2024.
(60) Provisional application No. 63/652,165, filed on May 27, 2024.
(60) Provisional application No. 63/678,045, filed on Jul. 31, 2024.
(60) Provisional application No. 63/695,957, filed on Sep. 18, 2024.
(60) Provisional application No. 63/701,554, filed on Sep. 30, 2024.
(60) Provisional application No. 63/719,640, filed on Nov. 12, 2024.
(60) Provisional application No. 63/734,031, filed on Dec. 13, 2024.
(60) Provisional application No. 63/743,658, filed on Jan. 10, 2025.
(60) Provisional application No. 63/752,940, filed on Feb. 3, 2025.
(60) Provisional application No. 63/784,089, filed on Apr. 5, 2025.
(60) Provisional application No. 63/811,859, filed on May 25, 2025.
(60) Provisional application No. 63/826,342, filed on Jun. 18, 2025.
(60) Provisional application No. 63/856,653, filed on Aug. 3, 2025.
(60) Provisional application No. 63/874,393, filed on Sep. 2, 2025.
(60) Provisional application No. 63/895,053, filed on Oct. 7, 2025.
(60) Provisional application No. 63/906,709, filed on Oct. 28, 2025.
(60) Provisional application No. 63/931,124, filed on Dec. 4, 2025.
(60) Provisional application No. 63/991,122, filed on Feb. 25, 2026.

(51) Int. Cl. G06F 13/42

(52) U.S. Cl. CPC G06F 13/4221; G06F 2213/0026

(57) ABSTRACT

Translating between UALink UPLI and CXL.mem enables memory access across different protocol domains. Some implementations describe receiving a UPLI request comprising a read command and a first physical address, translating the UPLI request to a CXL.mem M2S request comprising MemRd* and a second physical address, and sending the CXL.mem M2S request to a second entity. The translation may include address, Tag, and opcode translations between the UPLI and CXL.mem domains. Other implementations describe a processing unit providing a first memory path from a UALink port to a first memory via a memory controller, and a second memory path from the UALink port to a second memory via a CXL port. Yet other implementations describe a system with a switch, accelerators, a resource provisioning unit (RPU), and CXL memory devices, wherein the RPU translates UPLI requests and routes them to respective CXL memory devices.

### CROSS-REFERENCE TO RELATED APPLICATIONS

This application claims priority to: U.S. Provisional Patent Application No. 63/991,122, filed Feb. 25, 2026; U.S. Provisional Patent Application No. 63/931,124, filed Dec. 4, 2025; U.S. Provisional Patent Application No. 63/906,709, filed Oct. 28, 2025; U.S. Provisional Patent Application No. 63/895,053, filed Oct. 7, 2025; U.S. Provisional Patent Application No. 63/874,393, filed Sep. 2, 2025; U.S. Provisional Patent Application No. 63/856,653, filed Aug. 3, 2025; U.S. Provisional Patent Application No. 63/826,342, filed Jun. 18, 2025; U.S. Provisional Patent Application No. 63/811,859, filed May 25, 2025; and U.S. Provisional Patent Application No. 63/784,089, filed Apr. 5, 2025. This application is also a Continuation-In-Part of U.S. patent application Ser. No. 19/371,779, filed Oct. 28, 2025, which claims priority to: U.S. Provisional Patent Application No. 63/752,940, filed Feb. 3, 2025; U.S. Provisional Patent Application No. 63/743,658, filed Jan. 10, 2025; and U.S. Provisional Patent Application No. 63/734,031, filed Dec. 13, 2024. U.S. patent application Ser. No. 19/371,779 is a Continuation of U.S. patent application Ser. No. 19/017,420, filed Jan. 11, 2025, which claims priority to: U.S. Provisional Patent Application No. 63/719,640, filed 12 Nov. 2024; U.S. Provisional Patent Application No. 63/701,554, filed 30 Sep. 2024; U.S. Provisional Patent Application No. 63/695,957, filed 18 Sep. 2024; U.S. Provisional Patent Application No. 63/678,045, filed 31 Jul. 2024; U.S. Provisional Patent Application No. 63/652,165, filed 27 May 2024; and U.S. Provisional Patent Application No. 63/641,404, filed 1 May 2024. U.S. patent application Ser. No. 19/017,420 is also a Continuation-In-Part of U.S. patent application Ser. No. 18/981,443, filed Dec. 13, 2024, which claims priority to U.S. Provisional Patent Application No. 63/609,833, filed 13 Dec. 2023.

### BACKGROUND

Ultra Accelerator Link (UALink) is an interconnect protocol that enables communication among accelerators and switches in high-performance computing environments. UALink defines a Protocol Level Interface (UPLI) that specifies channels, commands, and fields for memory read and write transactions between originators and completers.

Compute Express Link (CXL) is an interconnect protocol that enables cache-coherent memory access and high-bandwidth communication between hosts and devices. CXL defines sub-protocols including CXL.mem, CXL.io, and CXL.cache, each serving different communication patterns. CXL.mem defines Master-to-Subordinate (M2S) messages and Subordinate-to-Master (S2M) messages for memory access operations between hosts and memory devices.

### SUMMARY

Some of the following implementations describe systems and methods for translating between UALink UPLI and CXL.mem to enable memory access across different protocol domains. In various implementations, a method comprises communicating with a first entity according to UPLI, communicating with a second entity according to CXL.mem, receiving from the first entity a UPLI request comprising a read command and a first physical address, translating the UPLI request to a CXL.mem Master-to-Subordinate (M2S) request comprising a MemRd* and a second physical address, and sending the CXL.mem M2S request to the second entity. The translation may include address translations between different address spaces, Tag translations between UPLI ReqTag values and CXL.mem Tag values, opcode translations, and error propagation across protocol boundaries. The method may be performed by a resource provisioning unit (RPU), a processor, a switch, or other suitable device.

In other implementations, a system comprises a processing unit including a UALink port, a memory controller coupled to a first memory, and a CXL port coupled to a second memory. The processing unit provides a first memory path from the UALink port to the first memory via the memory controller, and a second memory path from the UALink port to the second memory via the CXL port. The processing unit further comprises an RPU configured to receive UPLI requests from an entity and forward translated requests to the first memory via the first memory path or to the second memory via the second memory path.

In yet other implementations, a system comprises a switch, accelerators coupled to the switch and communicating according to a UALink-based protocol, an RPU coupled to the switch, a first CXL memory device coupled to the RPU, and a second CXL memory device coupled to the RPU. The RPU is configured to receive a first UPLI request and a second UPLI request from a first accelerator of the accelerators via the switch, translate the first UPLI request to a first CXL.mem M2S request and send the first CXL.mem M2S request to the first CXL memory device, and translate the second UPLI request to a second CXL.mem M2S request and send the second CXL.mem M2S request to the second CXL memory device. The CXL memory devices may include CXL memory expanders, CXL memory pools, or GFDs, and may be coupled to the RPU via a CXL fabric.

In yet other implementations, a method comprises communicating with a first entity according to UPLI, communicating with a second entity according to CXL.mem, receiving from the first entity a UPLI request comprising a write command, a first physical address, and write data, translating the UPLI request to a CXL.mem M2S RwD comprising a MemWr* and a second physical address, sending the CXL.mem M2S RwD and the write data to the second entity, receiving from the second entity a CXL.mem S2M NDR comprising Cmp*, translating the CXL.mem S2M NDR to a UPLI WrRsp, and sending the UPLI WrRsp to the first entity. The translation may include address translations between different address spaces, Tag translations between UPLI ReqTag values and CXL.mem Tag values, opcode translations, byte enable propagation, and write splitting when the UPLI transfer size exceeds a CXL.mem cacheline size.

### BRIEF DESCRIPTION OF THE DRAWINGS

FIG. 1A illustrates an example of a system comprising an RPU that translates between UALink-based traffic and CXL.mem-based traffic;

FIG. 1B illustrates an example of a TFD demonstrating translations between UPLI request and CXL.mem M2S Req MemRd;

FIG. 2A illustrates an example of a system comprising an RPU that enables UALink-based entities to access CXL-based resources coupled to the RPU;

FIG. 2B illustrates an example of a TFD demonstrating intent-based translation between UPLI and CXL.mem;

FIG. 3A illustrates an example of a system comprising a processor comprising a UALink port enabling external entities to access memory resources mapped to an address space utilized by the processor's coherent interconnect;

FIG. 3B illustrates an example of a TFD demonstrating two UPLI requests forwarded to different memories mapped to an address space utilized by a processor's coherent interconnect;

FIG. 4A illustrates an example of a system comprising a processor comprising a coherent interconnect, a UALink port, and a CXL RP;

FIG. 4B illustrates an example of a TFD demonstrating translating two UPLI requests to a coherent interconnect request and to a CXL.mem request;

FIG. 5A illustrates an example of a system that translates between UALink-based traffic and CXL.mem traffic;

FIG. 5B illustrates an example of a TFD demonstrating translations between UPLI request and CXL.mem request, with an optional speculative memory read;

FIG. 6A and FIG. 6B illustrate examples of translating between CXL.mem and UALink-based protocol;

FIG. 7A illustrates an example of an RPU comprising a cache, which translates between CXL.mem and UPLI;

FIG. 7B illustrates an example of an RPU without a cache, translates between CXL.mem and UPLI;

FIG. 8 illustrates an example of a host CPU accessing various devices over CXL.mem to UALink;

FIG. 9A illustrates an example of a system comprising a cable configured to translate between CXL and NVLink;

FIG. 9B illustrates an example of a TFD demonstrating translating between CXL.mem M2S MemRd request and NVLink read request;

FIG. 10 illustrates an example of a system wherein inference context data is migrated between accelerator local memory and the CXL memory device across UALink and CXL protocol domains;

FIG. 11A illustrates an example of a system that translates between UALink-based traffic and CXL.cache traffic when communicating with a host;

FIG. 11B illustrates an example of a TFD demonstrating translations between a UPLI request and a CXL.cache D2H RdCurr request;

FIG. 11C illustrates an example of a TFD demonstrating translations between a UPLI request and a CXL.cache D2H RdShared request;

FIG. 12A illustrates an example of a system that translates between UALink-based traffic and CXL.cache traffic when communicating with a device;

FIG. 12B illustrates an example of a TFD demonstrating translations between a UPLI request and a CXL.cache H2D SnpCur request;

FIG. 12C illustrates an example of a TFD demonstrating translations between a UPLI request and a CXL.cache H2D SnpData request;

FIG. 13A illustrates an example of a system comprising a processor comprising an RPU chiplet that translates between UALink and CXL;

FIG. 13B illustrates an example of a TFD demonstrating translating a UPLI request to a protocol utilized by a processor's coherent interconnect;

FIG. 14A illustrates an example of a system comprising a cable that translates between UALink-based traffic and CXL-based traffic;

FIG. 14B illustrates an example of an active optical cable comprising an RPU that translates between UALink-based traffic and CXL-based traffic;

FIG. 15A illustrates an example of a system that translates between UALink-based traffic and CXL-based traffic;

FIG. 15B illustrates an example of a TFD demonstrating translations between a UPLI transaction comprising UPLI read response/data and a CXL transaction;

FIG. 15C illustrates an example of a TFD demonstrating translations between a UPLI transaction comprising UPLI write response and a CXL transaction;

FIG. 16A and FIG. 16B illustrate examples comprising an RPU with a cache that differentiates between requests received from a UALink network and requests received from local CUs when translating to CXL.cache;

FIG. 17A illustrates an example of a system comprising a CXL entity coupled to a host via CXL.cache, the host coupled to a UALink entity and includes an RPU that translates between CXL and UALink;

FIG. 17B illustrates an example of a TFD demonstrating translation of a CXL.cache D2H request from a CXL entity to a UPLI request targeting a UALink entity;

FIG. 18A illustrates an example of a system comprising an accelerator with an RPU and a cache, coupled via a UALink switch to another accelerator and coupled via CXL.cache to a host;

FIG. 18B illustrates an example of TFD demonstrating cache miss and cache hit behavior for UPLI read requests translated to CXL.cache requests;

FIG. 19A illustrates an example of a system that translates between CXL-based traffic and UALink-based traffic;

FIG. 19B illustrates an example of a TFD demonstrating translations between a CXL transaction and a UPLI transaction comprising UPLI read response/data;

FIG. 19C illustrates an example of a TFD demonstrating translations between a CXL transaction and a UPLI transaction comprising UPLI write response;

FIG. 20A illustrates an example of a system that translates between UALink-based traffic and CXL-based traffic;

FIG. 20B illustrates an example of a TFD demonstrating translations between UPLI request ReqCmd(Read) and CXL.io UIOMRd;

FIG. 20C illustrates an example of a TFD demonstrating translations between UPLI request ReqCmd(Read) and CXL.io MRd;

FIG. 21A illustrates an example of a system comprising an entity that enables UALink-based resource consumers to access CXL-based resources coupled to the entity;

FIG. 21B illustrates an example of a TFD demonstrating translations between UALink UPLI read request and CXL.io UIOMRd;

FIG. 22A illustrates an example of a system that translates between a UALink-based protocol and a PCIe-based protocol;

FIG. 22B illustrates an example of a TFD demonstrating translations between UPLI request ReqCmd(Read) and PCIe MRd;

FIG. 22C illustrates an example of a TFD demonstrating translations between UPLI request ReqCmd(Read) and PCIe UIOMRd;

FIG. 23A illustrates an example of a system comprising an accelerator or an RPU configured to translate between UALink-based traffic and PCIe-based traffic;

FIG. 23B illustrates an example of a TFD demonstrating translations between UALink-based traffic and PCIe-based traffic;

FIG. 24A illustrates an example of a system comprising an accelerator or a processor that translates between a UALink-based port and a PCIe-based port;

FIG. 24B illustrates an example of a TFD demonstrating translations between UALink-based traffic and PCIe-based traffic;

FIG. 25A illustrates an example of a system configured to enable PCIe over UALink;

FIG. 25B illustrates an example of a TFD demonstrating PCIe communications over UALink;

FIG. 26A illustrates an example of a system comprising a processor comprising a UALink port coupled to the processor's coherent interconnect;

FIG. 26B illustrates an example of a TFD demonstrating two UPLI requests forwarded to different memories mapped to an address space utilized by a processor's coherent interconnect;

FIG. 27A illustrates an example of a system comprising an entity that translates between UALink-based traffic and ISoL traffic;

FIG. 27B illustrates an example of a TFD demonstrating translations between UALink-based traffic and Intel UPI traffic;

FIG. 28A illustrates an example of a system comprising a processor/RPU that translates between UALink-based traffic and ISoL traffic;

FIG. 28B illustrates an example of a TFD demonstrating translations between UALink-based traffic and ISoL traffic;

FIG. 29A illustrates an example of a system comprising an RPU that translates between UALink and a Coherent Interconnect Interface;

FIG. 29B illustrates an example of a TFD showing address translation between UALink UPLI and ARM CHI ReadOnce;

FIG. 30A illustrates an example of a system that translates between UALink-based traffic and ARM CHI traffic;

FIG. 30B illustrates an example of an RPU that translates between UALink-based traffic and CHI traffic, utilizing an intermediate protocol based on ARM AMBA ACE-Lite;

FIG. 31A illustrates an example of a system comprising a cable that translates between UALink-based traffic and NVLink-based traffic;

FIG. 31B illustrates an example of a transaction flow diagram (TFD) demonstrating translations performed by a cable between a UALink-based protocol and an NVLink-based protocol;

FIG. 32 illustrates an example of a processor comprising RPUs, NVLink interfaces, and UALink ports;

FIG. 33 illustrates an example of a system demonstrating asymmetric bandwidth configuration between an RPU (comprising NVLink, UALink, and/or CXL ports) and a coherent interconnect;

FIG. 34A illustrates an example of a system optimized for accelerator applications utilizing UALink interfaces, wherein an RPU includes more home nodes than request nodes;

FIG. 34B illustrates an example of a system optimized for a memory pool or a memory switch applications utilizing UALink interfaces, wherein an RPU includes more request nodes than home nodes;

FIG. 35A illustrates an example of a system utilizing NVLink interfaces in an accelerator-optimized configuration;

FIG. 35B illustrates an example of a system configured as an NVLink-based memory pool;

FIG. 36 illustrates an example of a system comprising an IC package comprising an input/output (IO) die coupled to compute dies and RPU dies;

FIG. 37A illustrates an example of a system comprising a memory switch comprising an IC package with an IO die coupled to RPU dies;

FIG. 37B illustrates an example of a TFD demonstrating translations between CXL.mem and CXL.cache relevant to a memory switch;

FIG. 38A illustrates an example of a system comprising a memory switch or a memory pool;

FIG. 38B illustrates an example of a TFD demonstrating translations between CXL.mem and CXL.cache relevant to a memory pool;

FIG. 39A illustrates an example of a system comprising an xPU-based multi-protocol switch;

FIG. 39B illustrates an example of a TFD demonstrating protocol and address translations between UALink and CXL.cache;

FIG. 40A illustrates an example of a system configured to translate between first and second UALink traffic;

FIG. 40B illustrates an example of a TFD demonstrating translations that enable a processor to operate as a UALink-based switch;

FIG. 41 illustrates an example of a scalable GPU interconnect utilizing an xPU-based AI switch;

FIG. 42A illustrates an example of a system comprising an xPU-based switch coupled to memory;

FIG. 42B illustrates an example of a TFD demonstrating two UALink transactions through an xPU-based switch;

FIG. 43 illustrates an example of a CPU with a UALink port;

FIG. 44 illustrates an example of a memory switch or AI switch implementation utilizing two IC packages;

FIG. 45 illustrates an example of a processor comprising CXL endpoint ports and RPUs;

FIG. 46 illustrates an example of a CPU with UALink ports;

FIG. 47A illustrates an example of passing CXL traffic or CXL-related traffic over a PHY based on IEEE 802.3 PMA utilizing carrier protocol encapsulation;

FIG. 47B illustrates an example of a TFD showing the mapping between CXL.mem transaction layer and UPLI transaction layer;

FIG. 48A illustrates an example of a system comprising a host and a device coupled via a bridges that translates between CXL and carrier protocols that utilize PHYs based on IEEE 802.3 PMA;

FIG. 48B illustrates an example of a TFD demonstrating bidirectional CXL communications between a host and a device utilizing UALink as an intermediate protocol;

FIG. 49A illustrates an example of a system configured to enable CXL over UALink, such as via CXL tunneling over UALink;

FIG. 49B illustrates an example of a TFD demonstrating CXL communications over UALink, such as CXL over UALink, or CXL tunneling over UALink;

FIG. 50A illustrates an example of encapsulating 68-byte CXL flits into UPLI transactions comprising Write commands;

FIG. 50B illustrates an example of a TFD depicting translations utilized for encapsulating a 68-byte CXL flit into a UPLI Write command;

FIG. 51A illustrates an example of encapsulating 256-byte CXL flits into UPLI WriteFull commands;

FIG. 51B illustrates an example of a TFD depicting translations utilized for encapsulating or packing of a CXL.mem request message into a 256-byte CXL flit that is further encapsulated into a UPLI WriteFull command;

FIG. 52A illustrates an example of a system that translates CXL flits to UPLI transaction layer messages;

FIG. 52B illustrates an example of a TFD depicting tunneling of CXL flits over UPLI;

FIG. 53A illustrates an example of utilizing a UPLI write message command for tunneling CXL flits;

FIG. 53B illustrates an example of a TFD depicting utilizing UPLI write message commands for tunneling CXL transactions;

FIG. 54A illustrates an example of a system comprising a host having a first CXL port, a retimer, a bridge, and a device having a second CXL port;

FIG. 54B illustrates an example of a TFD demonstrating CXL communications between a host and a device based on a PHY based on IEEE 802.3 PMA utilizing UALink flits;

FIG. 55A illustrates an example of a system comprising a CXL host coupled to a CXL device over two bridges utilizing a UALink PHY;

FIG. 55B illustrates an example of a TFD demonstrating a translations between CXL flits and UALink flits;

FIG. 56A illustrates an example of a system configured to enable UALink over Ethernet-based network, such as UALink over standard Ethernet, UALink over UET, UALink over ESUN, or UALink over SUE;

FIG. 56B illustrates an example of a TFD demonstrating UALink-based communications over Ethernet, such as UALink over Ethernet, UALink tunneling over Ethernet, UPLI over Ethernet, or UPLI tunneling over Ethernet;

FIG. 57A illustrates an example of a system comprising a processor comprising multiple interfaces;

FIG. 57B illustrates an example of a system comprising a processor capable of servicing external requests through CCGs optimized for handling CXL.mem traffic;

FIG. 58A illustrates an example of a system that translates between PCIe and CXL.mem;

FIG. 58B illustrates an example of a TFD demonstrating translations between PCIe TLPs and CXL.mem messages;

FIG. 58C illustrates an example of a TFD demonstrating translations between PCIe UIO TLPs and CXL.mem messages;

FIG. 59A illustrates an example of a system that may function as an NVLink memory switch appliance or an NVLink memory pool;

FIG. 59B illustrates an example of a TFD depicting a multi-entity memory access scenario wherein GPUs access memory mapped to physical address spaces through NVLink to ARM CHI translations;

FIG. 60A illustrates an example of GPU/CPU coupled to an xPU comprising dies coupled by chip-to-chip interfaces;

FIG. 60B illustrates an example of a custom accelerator comprising an NVLink Fusion chiplet;

FIG. 61A illustrates an example of a system that translates between NVLink-based traffic and CHI-based coherent interconnect traffic;

FIG. 61B illustrates an example of a TFD showing the translation of NVLink read request to CHI ReadOnce request;

FIG. 62A illustrates an example of a system that translates between NVLink-based traffic and ARM CHI traffic;

FIG. 62B illustrates an example of an RPU that translates between NVLink traffic and CHI traffic, utilizing an intermediate protocol based on ARM AMBA ACE-Lite;

FIG. 63A illustrates an example of a system that translates between NVLink traffic and CHI-based traffic;

FIG. 63B illustrates an example of an RPU that translates between NVLink traffic and CHI traffic;

FIG. 64A illustrates an example of a TFD showing translating an NVLink read request to a PCIe UIO read request to an ARM CHI ReadOnce request;

FIG. 64B illustrates an example of a TFD showing translating an NVLink read request to a CXL.cache RdCurr request to an ARM CHI ReadOnce request;

FIG. 65A illustrates an example of a system comprising an external entity coupled to an optional NVLink switch coupled to a processor comprising an RPU comprising an NVLink interface, a Request Agent (RA) Proxy, and a Home Agent (HA) Proxy;

FIG. 65B illustrates an example of a system comprising a processor comprising NVLink chiplets (such as NVLink Fusion) to translate between NVLink and CHI;

FIG. 66A illustrates an example of a system comprising an xPU comprising an RPU that translates between NVLink traffic and CHI traffic;

FIG. 66B illustrates an example of a system comprising an entity including NVLink and CXL ports coupled to CHI interfaces that enable memory access via a processor's coherent interconnect;

FIG. 67A illustrates an example of a system comprising a processor comprising an NVLink chiplet coupled via NVLink-C2C to the processor's coherent interconnect;

FIG. 67B illustrates an example of a system comprising an xPU coupled to a GPU utilizing an RPU that translates between NVLink traffic and CHI-based traffic;

FIG. 68A illustrates an example of a system functioning as a multi-protocol memory switch appliance or a multi-protocol memory pool comprising NVLink-based interfaces;

FIG. 68B illustrates an example of a TFD depicting a multi-entity memory access scenario wherein separate NVLink and UALink transactions utilize the same coherent interconnect infrastructure for memory access;

FIG. 69 illustrates an example of a heterogeneous computing system comprising an NVLink chiplet coupled to an accelerator based on ARM mesh architecture;

FIG. 70A illustrates an example of a system comprising an apparatus that translates between NVLink-based traffic and CXL.mem traffic;

FIG. 70B illustrates an example of a TFD demonstrating translations between NVLink-based traffic and CXL.mem traffic;

FIG. 71A illustrates an example of a system, comprising an RPU having an NVLink interface, which enables a GPU to access resources coupled to the RPU over CXL.mem;

FIG. 71B illustrates an example of a TFD demonstrating translations between an NVLink-based protocol and CXL.mem utilized for communicating with a CXL device or CXL memory;

FIG. 71C illustrates an example of a TFD demonstrating translations between NVLink-based requests and CXL.mem requests;

FIG. 72A illustrates an example of a system that translates between an NVLink-based protocol and a CXL protocol;

FIG. 72B illustrates an example of a system comprising an RPU in an NVLink switch or NVSwitch, coupled to NVLink and CXL.mem entities;

FIG. 72C illustrates an example of a system comprising an xPU with an NVLink Fusion chiplet;

FIG. 73A illustrates an example of a system comprising a processor including a coherent interconnect and an NVLink interface;

FIG. 73B illustrates an example of a TFD demonstrating two NVLink read requests forwarded to different memories via a coherent interconnect;

FIG. 74A illustrates an example of a system comprising a processor comprising an NVLink interface and a CXL RP;

FIG. 74B illustrates an example of a TFD demonstrating translating a first NVLink request to a coherent interconnect protocol, and translating a second NVLink read request to a CXL.mem M2S MemRd request;

FIG. 75A illustrates an example of a system comprising a processor comprising an NVLink interface, processing cores, LLC, a CXL RP, and memory controllers coupled via memory channels to memory;

FIG. 75B illustrates an example of a transaction flow diagram (TFD) demonstrating translations from NVLink traffic to traffic conforming to a protocol utilized by a processor's coherent interconnect, utilizing CXL.cache as an intermediate protocol;

FIG. 76A illustrates an example of a system comprising a computer coupled between a first interface communicating according to an NVLink-based protocol and a second interface communicating according to CXL.cache;

FIG. 76B illustrates an example of a cable comprising an NVLink port and a CXL port, with an RPU integrated into the cable;

FIG. 76C illustrates an example of a TFD demonstrating translations between NVLink-based requests and CXL.cache requests;

FIG. 77A illustrates an example of a system comprising an xPU with an RPU that translates between CXL.cache and NVLink;

FIG. 77B illustrates an example of a TFD demonstrating translation of a CXL.cache D2H request to an NVLink read request and translation of the NVLink response to a CXL.cache H2D Data message;

FIG. 78A illustrates an example of a system comprising an xPU with an RPU, a cache, and a local memory, showing two access paths for CXL.cache D2H requests;

FIG. 78B illustrates an example of a TFD demonstrating two CXL.cache D2H request flows: a first flow served from local memory with cache state transition, and a second flow translated to an NVLink read request;

FIG. 79A illustrates an example of a system comprising a computer coupled between an NVLink-based interface and a CXL.cache interface;

FIG. 79B illustrates an example of a TFD demonstrating translation of an NVLink read request to a CXL.cache H2D request comprising SnpCur;

FIG. 79C illustrates an example of a TFD demonstrating translation of an NVLink read request to a CXL.cache H2D request comprising SnpData;

FIG. 80A illustrates an example of a system that translates between NVLink-based traffic and CXL-based traffic;

FIG. 80B illustrates an example of a TFD demonstrating translations between an NVLink request and a CXL.io request;

FIG. 81A illustrates an example of a system that translates between NVLink-based traffic and CXL-based traffic;

FIG. 81B illustrates an example of a TFD demonstrating translations between NVLink-based read requests and CXL.io UIO TLPs;

FIG. 81C illustrates an example of a TFD demonstrating translations between NVLink-based read requests and CXL.io MRd TLPs;

FIG. 82A illustrates an example of a system comprising a computer configured to translate between CXL.io traffic and NVLink-based traffic;

FIG. 82B illustrates an example of a TFD demonstrating translations between CXL.io read requests and NVLink-based read requests;

FIG. 83A illustrates an example of a system that translates between NVLink-based traffic and PCIe-based traffic;

FIG. 83B illustrates an example of a TFD demonstrating translations between an NVLink read request and a PCIe UIOMRd;

FIG. 83C illustrates an example of a TFD demonstrating translations between an NVLink read request and a PCIe MRd;

FIG. 84A illustrates an example of a cable comprising an RPU that translates between PCIe-based traffic and NVLink-based traffic;

FIG. 84B illustrates an example of a TFD demonstrating translations between PCIe-based requests and NVLink-based requests;

FIG. 85A illustrates an example of a system comprising a CXL host coupled to a CXL device over two bridges that utilize an NVLink PHY;

FIG. 85B illustrates an example of a TFD depicting tunneling of CXL.io transactions between a host and a device through two bridges that utilize IEEE 802.3 and NVLink flits;

FIG. 86A illustrates an example of a system configured to enable CXL over NVLink, such as via CXL tunneling over NVLink;

FIG. 86B illustrates an example of a TFD demonstrating CXL communications over NVLink, such as CXL over NVLink, or CXL tunneling over NVLink;

FIG. 87A illustrates an example of a system configured to enable PCIe over NVLink, such as via PCIe tunneling over NVLink;

FIG. 87B illustrates an example of a TFD demonstrating PCIe UIO communications over NVLink, such as PCIe UIO over NVLink, or PCIe UIO tunneling over NVLink;

FIG. 88A illustrates an example of a processor comprising an NVLink interface, processing cores, LLCs, and a coherent interconnect;

FIG. 88B illustrates an example of a processor comprising NVLink interfaces and DDR channels;

FIG. 89A illustrates an example of a processor comprising an NVLink interface, processing cores, caches, and a coherent interconnect;

FIG. 89B illustrates an example of a TFD demonstrating translating an NVLink read request to a read transactions of a protocol utilized by a processor's coherent interconnect to access memory;

FIG. 90A illustrates an example of a system comprising a processor that includes an NVLink interface;

FIG. 90B illustrates an example of a TFD demonstrating two translations from NVLink-based traffic to traffic conforming to a protocol utilized by a processor's coherent interconnect;

FIG. 91A illustrates an example of a system that translates between NVLink-based traffic and ISoL traffic;

FIG. 91B illustrates an example of a TFD demonstrating translations between NVLink-based traffic and Intel UPI traffic;

FIG. 92A illustrates an example of a memory switch configured to provide memory to its coupled entities;

FIG. 92B illustrates an example of a TFD demonstrating NVLink requests from entities to access memory;

FIG. 93A illustrates an example of a system that implements an NVLink-based switch, or an NVLink Memory Switch, utilizing a CHI-based interconnect;

FIG. 93B illustrates an example of a TFD demonstrating NVLink switching operation between entities through a switch interconnect;

FIG. 94A illustrates an example of a system comprising a processor comprising an NVLink-C2C interface; and

FIG. 94B illustrates an example of a system comprising a CPU comprising an NVLink-C2C chiplet, such as NVLink Fusion.

### DETAILED DESCRIPTION

In environments where entities may utilize different protocols while requiring coordinated access to shared resources, there may be scenarios where a first entity communicating according to UALink UPLI, such as an accelerator, needs to access memory resources coupled to a second entity communicating according to CXL, such as CXL.mem. An RPU may translate between UPLI and CXL.mem to facilitate memory operations, data transfers, and/or resource sharing across different protocol domains while maintaining the requirements of each protocol. The RPU may translate opcodes, commands, addresses, Tags, and additional fields between UPLI and CXL.mem messages, and may further perform address translations between different address spaces, such as between a Network Physical Address (NPA) space utilized by UALink-based traffic and a Host Physical Address (HPA) space utilized by CXL-based traffic, or between addresses within the same address space, such as a global address space, a partitioned global address space (PGAS), a pod address space, a virtual pod address space, or a fabric address space. The RPU may be implemented as a discrete component, as an IP block embedded in a processor, or as a chiplet within an IC package.

In various implementations, a method for translating from Ultra Accelerator Link (UALink) Protocol Level Interface (UPLI) requests to Compute Express Link (CXL) requests, comprising: communicating with a first entity according to UPLI; communicating with a second entity according to CXL.mem; receiving, from the first entity, a UPLI request comprising a read command and a first physical address; translating the UPLI request to a CXL.mem Master-to-Subordinate request comprising: a MemRd* and a second physical address (CXL.mem M2S Req MemRd*); and sending the CXL.mem M2S Req MemRd* to the second entity. The translation may enable entities communicating according to UPLI to access memory resources coupled to entities communicating according to CXL.mem. The method may be implemented in hardware, firmware, software, or combinations thereof, and may be performed by various types of devices, such as a processor, a switch, a bridge, an RPU, or a semiconductor device. MemRd* may refer to MemRd, MemRdData, MemRdTEE, MemRdDataTEE, or other memory read opcode variants defined or to be defined in CXL.mem. The first physical address may be associated with a first address space, such as an NPA space, and the second physical address may be associated with a second address space, such as an HPA space or an SPA space, wherein the translating may include translating the first physical address to the second physical address. Additionally or alternatively, the first and second physical addresses may be associated with the same address space, such as a global address space, a PGAS, a pod address space, a virtual pod address space, or a fabric address space. The elements may communicate through one or more intermediary components, such as a switch, a retimer, or other suitable entity that facilitates information transfer.

In some implementations of the method, the UPLI request further comprises a ReqSrcPhysAccID field, a ReqDstPhysAccID field, a ReqLen field, a ReqTag field, a ReqAddr field comprising the first physical address, and a ReqCmd field comprising the read command; and further comprising translating the ReqTag to a Tag associated with the CXL.mem M2S Req. The ReqSrcPhysAccID and ReqDstPhysAccID fields may carry identifiers that may be utilized by the RPU for routing the UPLI request to its target, and may be further utilized for constructing response routing information. The ReqLen field may indicate a transfer size of up to 256 Bytes of data. When the ReqLen indicates a transfer size exceeding a CXL.mem cacheline size (e.g., 64 Bytes), the RPU may translate a UPLI request to multiple CXL.mem M2S requests. The Tag translation may involve maintaining a bidirectional mapping between UPLI ReqTag values and CXL.mem Tag values, enabling proper correlation of CXL.mem responses with their corresponding UPLI requests.

In some implementations, the method further comprises receiving, from the second entity, a CXL.mem Subordinate-to-Master Data Response (S2M DRS) comprising MemData, a Tag, and data; translating the CXL.mem S2M DRS to a UPLI read response (RdRsp) comprising a RdRspSrcPhysAccID field, a RdRspDstPhysAccID field, a RdRspTag field, and RdRspData comprising the data; and sending the UPLI RdRsp to the first entity. The RdRspSrcPhysAccID may correspond to the ReqDstPhysAccID from the original UPLI request, and the RdRspDstPhysAccID may correspond to the ReqSrcPhysAccID, reflecting the routing path for the response. The RdRspTag may be retrieved from the bidirectional mapping maintained by the RPU, enabling the first entity to correlate the response with its original request. In some examples, the RPU may accumulate data from one or more CXL.mem S2M DRS messages before sending the data via the UPLI RdRsp, such as when CXL.mem M2S requests were generated from a UPLI request.

In some implementations of the method, the CXL.mem S2M DRS further comprises a Poison field, and the UPLI RdRsp further comprises a RdRspDataError field; and further comprising translating the Poison field of the CXL.mem S2M DRS to the RdRspDataError field of the UPLI RdRsp. The Poison field in CXL.mem S2M DRS may indicate that the returned data contains an error. The RdRspDataError field in UPLI may serve as a per-beat data poison indicator. The translation of error indications across protocol boundaries may enable the first entity to detect data corruption that originated in the CXL domain, and to take appropriate recovery actions, such as discarding the corrupted data, retrying the request, or reporting the error to system management software.

In some implementations of the method, the read command comprises a Read Class Vendor Defined Command, the first entity comprises an accelerator or a UALink switch, the second entity comprises a CXL device, and the second physical address is a host physical address (HPA) utilized by the second entity. Read Class VDCs may correspond to ReqCmd encodings and may enable vendor-specific memory access operations that extend beyond the standard UPLI read commands. The CXL device may include a CXL memory expander, a CXL memory pool, a Global Fabric-Attached Memory (G-FAM) Device (GFD), or a CXL accelerator. The HPA may represent an address within the address space utilized by the second entity for servicing memory requests.

In some implementations of the method, the UPLI request indicates an I/O-coherent read, and the CXL.mem M2S Req MemRd* further comprises a SnpType field comprising SnpCur, a MetaField field comprising Meta0-State (MS0), and a MetaValue field comprising Invalid (I). The SnpType(SnpCur), MetaField(MS0), and MetaValue(I) combination in the CXL.mem M2S request may indicate an intent to perform an I/O-coherent read by requesting a non-cacheable but current value of the data. This combination may correspond to the I/O-coherency model utilized by UALink, wherein a read from peer memory returns the most recent coherent copy from memory or a cache within the destination's system node. The RPU may select the SnpType, MetaField, and MetaValue values based on a predefined, predetermined, configurable, rule-based, or dynamic intent mapping between the UPLI I/O-coherent read semantics and CXL.mem coherency fields.

In some implementations, the method further comprises sending to the second entity a CXL.mem M2S request comprising MemSpecRd. The speculative memory read may be initiated by the RPU to facilitate data availability from the second entity before, or without, the first entity explicitly requesting that data. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. When utilizing the MemSpecRd opcode, some of the CXL.mem M2S Req fields, such as Tag, MetaField, MetaValue, and SnpType, may be reserved. Additionally or alternatively, the RPU may issue reads (e.g., CXL.mem M2S requests comprising MemRd or MemRdData) to prefetch data from the second entity, and may buffer the returned data for satisfying subsequent demand requests from the first entity.

In some implementations of the method, the first physical address is associated with a first address space, the second physical address is associated with a second address space different from the first address space, and the translating further comprises translating the first physical address to the second physical address. The first address space may include an NPA space utilized by the UALink-based traffic, and the second address space may include an HPA space utilized by CXL-based traffic. The first and second address spaces may have different sizes, different base addresses, different memory layouts, or different granularities, and the translation may accommodate these differences while maintaining the meaning of the memory operations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In computing environments where external entities, such as accelerators, may access memory resources coupled to a processing unit, there may be scenarios where the processing unit provides access to memory resources via different memory paths. For example, a processing unit may include a first memory path from a UALink port to a first memory via a memory controller, and a second memory path from the UALink port to a second memory via a CXL port. The processing unit may include an RPU that translates between a UALink-based protocol, such as UPLI, and the protocols utilized for accessing the first and second memories. The RPU may perform physical address translations, such as from NPAs to HPAs, to enable external entities to access both memory resources via the UALink port.

In various implementations, a system comprising: a processing unit comprising an Ultra Accelerator Link (UALink) port, a memory controller coupled to a first memory, and a Compute Express Link (CXL) port coupled to a second memory; wherein the UALink port is configured to communicate with an entity according to a UALink-based protocol; wherein the processing unit is configured to provide a first memory path from the UALink port to the first memory via the memory controller, and a second memory path from the UALink port to the second memory via the CXL port; and wherein the processing unit further comprises a resource provisioning unit (RPU) configured to receive a first UALink Protocol Level Interface (UPLI) request from the entity and forward a first translated request to the first memory via the first memory path, and to receive a second UPLI request from the entity and forward a second translated request to the second memory via the second memory path. The processing unit may be implemented as a processor, a system-on-chip (SoC), or as chiplets within an IC package. The first memory may include DRAM coupled to the memory controller, and the second memory may include a CXL memory expander, a CXL memory pool, or a CXL device that exposes memory resources. The RPU may perform physical address translations to determine whether a given UPLI request targets the first memory or the second memory, and may route the translated request to the appropriate memory path accordingly. The entity may include an accelerator, a CPU, or a switch that communicates with the processing unit via the UALink port according to UPLI. In some examples, the requested data may be provided by a cache of the processing unit, such as by LLC, instead of by the first or second memory.

In some implementations of the system, the processing unit further comprises a coherent interconnect, and wherein the first memory path and the second memory path traverse a portion of the coherent interconnect. The coherent interconnect may include a mesh network, a ring interconnect, a crossbar, a Network on Chip (NoC), or other types of interconnect fabrics that maintain cache coherency among processing cores and other components of the processing unit. The first memory path may traverse the coherent interconnect from the RPU to the memory controller, and the second memory path may traverse the coherent interconnect from the RPU to the CXL port. In some examples, the RPU may translate between the UALink-based protocol, such as UPLI, and a protocol utilized by the coherent interconnect. The paths from the RPU to the different memories may traverse other components coupled to the coherent interconnect, such as caching/home agent (CHA) slices, snoop filter (SF) slices, or LLC slices, optionally for resolving coherency.

In some implementations of the system, the CXL port comprises a CXL/PCIe root port (RP) coupled to the coherent interconnect. The CXL/PCIe RP may be a separate component on the coherent interconnect, enabling the processing unit to communicate with CXL devices coupled to the second memory. In other examples, the CXL/PCIe RP may be included within the RPU.

In some implementations of the system, the processing unit further comprises processing cores, caching/home agent (CHA), snoop filter (SF), and Last Level Cache (LLC) slices coupled to the coherent interconnect; and further comprising at least one of: a PCIe root port coupled to an I/O device, or an inter-socket link (ISoL) port coupled to a second processing unit. The processing cores, CHA/SF/LLC slices, and additional ports may be coupled to the coherent interconnect, enabling coordinated access to memory resources. The PCIe RP may be coupled to an I/O device, such as a network controller, an Ethernet NIC, an InfiniBand adapter, or a PCIe GPU. The ISoL port may utilize NVIDIA NVLink-C2C, ARM CHI C2C, or ICPIP for inter-socket or inter-chip communication.

In some implementations of the system, the UALink port, the CXL port, and the memory controller are located in a same integrated circuit (IC) package; and wherein the RPU is further configured to translate physical addresses associated with the UALink-based protocol to physical addresses associated with the processing unit, enabling the entity to access the first memory and the second memory. The IC package may be implemented as a monolithic die or as chiplets within a multi-chip module. The physical address translation may include translating Network Physical Addresses (NPAs) carried in UPLI requests to Host Physical Addresses (HPAs) utilized by the processing unit's address space. The translated addresses may be utilized by the processing unit to determine whether a given request targets the first memory or the second memory, and to route the translated request to the appropriate memory path.

In some implementations of the system, the second translated request comprises a CXL.mem Master-to-Subordinate (M2S) request comprising MemRd*, and the CXL port is configured to send the CXL.mem M2S request to the second memory; and wherein the CXL port is further configured to receive a CXL.mem Subordinate-to-Master Data Response (S2M DRS) comprising MemData and data from the second memory, and the RPU is further configured to translate the CXL.mem S2M DRS to a UPLI read response (RdRsp) comprising the data and send the UPLI RdRsp to the entity. The second memory path may utilize CXL.mem for communication between the CXL port and the second memory, wherein the RPU may translate between UPLI and CXL.mem, including translations of addresses, Tags, and opcodes. The second memory may include a CXL memory expander or a CXL device that responds to CXL.mem M2S requests with CXL.mem S2M DRS messages carrying the requested data.

In computing environments where a cluster of accelerators may be coupled via a switch, the accelerators may need to access memory resources that are external to the UALink domain. For example, memory resources such as CXL memory expanders, CXL memory pools, or GFDs may be coupled to the cluster via an RPU that translates between the UALink-based protocol utilized by the accelerators and CXL.mem utilized by the CXL memory devices. In some configurations, the RPU may be coupled to multiple distinct CXL memory devices, and may route translated requests to different CXL memory devices based on the physical addresses carried in the UPLI requests received from the accelerators. The RPU may thus enable accelerators within the cluster to access a pool of CXL memory resources distributed across devices, while the switch provides the communication fabric among the accelerators and between the accelerators and the RPU.

In various implementations, a system comprising: a switch; accelerators coupled to the switch, wherein the accelerators communicate according to a UALink-based protocol; a resource provisioning unit (RPU) coupled to the switch; a first Compute Express Link (CXL) memory device coupled to the RPU; and a second CXL memory device coupled to the RPU; wherein the RPU is configured to receive a first UALink Protocol Level Interface (UPLI) request and a second UPLI request from a first accelerator of the accelerators via the switch, translate the first UPLI request to a first CXL.mem Master-to-Subordinate (M2S) request and send the first CXL.mem M2S request to the first CXL memory device, and translate the second UPLI request to a second CXL.mem M2S request and send the second CXL.mem M2S request to the second CXL memory device. The system may enable accelerators within a UALink cluster to access CXL memory resources that reside outside the UALink domain, without requiring modifications to the accelerators' UALink interfaces or protocols. The RPU may determine which CXL memory device to target for each translated request based on the physical address carried in the UPLI request, for example by comparing the address against address range registers or translation tables that map address ranges to specific CXL memory devices. The first and second CXL memory devices may have different capacities, different performance characteristics, different address ranges, or different device types. The RPU may be implemented as a discrete component coupled to the switch, as an IP block embedded within one of the accelerators, or as a chiplet within an IC package. The RPU may translate between UPLI and CXL.mem including translations of opcodes, addresses, Tags, and additional fields. In some examples, the RPU may be coupled to more than two CXL memory devices, and may distribute translated requests across the CXL memory devices based on address, load balancing policies, or other criteria. The method may be implemented in hardware, firmware, software, or combinations thereof.

In some implementations of the system, at least one of the first CXL memory device or the second CXL memory device comprises a Global Fabric-Attached Memory Device (GFD); and wherein the RPU is further configured to receive a CXL.mem Subordinate-to-Master Data Response (S2M DRS) from the GFD, translate the CXL.mem S2M DRS to a UPLI read response (RdRsp), and send the UPLI RdRsp to the first accelerator via the switch. The GFD may provide large-capacity memory resources accessible via CXL.mem, and may be shared among requesters including accelerators via the RPU and hosts via direct CXL.mem access. The RPU may translate the CXL.mem S2M DRS, including by translating the Tag back to the original UPLI ReqTag and formatting the data as UPLI RdRspData for delivery to the first accelerator.

In some implementations, the system further comprises a host coupled to at least one of the first CXL memory device or the second CXL memory device via CXL.mem; wherein both the first accelerator, via the RPU, and the host access the at least one of the first CXL memory device or the second CXL memory device. The shared access configuration may enable both accelerators and hosts to access the same CXL memory resources, potentially for data sharing, producer-consumer communication, or tiered memory management. The host may access the CXL memory device via CXL.mem without translation, while the accelerators access the same CXL memory device via the RPU that translates between UPLI and CXL.mem.

In some implementations, the system further comprises a CXL fabric coupling the RPU to the first CXL memory device and the second CXL memory device; wherein at least one of the first CXL memory device or the second CXL memory device comprises at least one of: a CXL memory expander, a CXL memory pool, or a Global Fabric-Attached Memory Device (GFD). The CXL fabric may include one or more CXL switches, and may provide connectivity between the RPU and CXL memory devices. The CXL fabric may enable the RPU to reach CXL memory devices that are not directly coupled to the RPU.

In some implementations of the system, the first UPLI request comprises a first physical address associated with a first address space, and the second UPLI request comprises a second physical address associated with the first address space; wherein the first CXL.mem M2S request comprises a third physical address associated with a second address space, and the second CXL.mem M2S request comprises a fourth physical address associated with the second address space; and wherein the RPU translates the first physical address to the third physical address and the second physical address to the fourth physical address; and wherein the first address space comprises a Network Physical Address (NPA) space or a System Physical Address (SPA) space, and the second address space comprises a Host Physical Address (HPA) space. The address translation may be implemented utilizing lookup tables, page tables, base-and-offset calculations, range-based mapping, and/or programmable translation functions. The RPU may determine which CXL memory device to target based on the translated address, for example by comparing the third or fourth physical address against address ranges assigned to the first and second CXL memory devices. In some examples, the first and second address spaces may be the same address space, such as a global address space or a fabric address space, and the RPU may perform routing without address translation.

In some implementations of the system, the switch comprises a UALink switch comprising a route table, and the UALink switch routes the first UPLI request and the second UPLI request from the first accelerator to the RPU based on a Destination Accelerator ID carried in the first UPLI request and the second UPLI request; and wherein the accelerators communicate with the UALink switch via UPLI request channels and UPLI response channels. The UALink switch may route UPLI traffic based on the ReqDstPhysAccID field in each UPLI request, utilizing the route table to map the Destination Accelerator ID to an egress port coupled to the RPU. The RPU may thus appear to the accelerators as a UALink endpoint identified by an Accelerator ID, enabling the accelerators to send UPLI requests to the RPU using standard UALink routing mechanisms. The route table may be programmed by a Pod Controller or other management entity. The UPLI request channels may carry read, write, atomic, and vendor defined commands, and the UPLI response channels may carry corresponding read responses and write responses.

In environments where entities communicating according to UPLI need to write data to memory resources coupled to entities communicating according to CXL.mem, an RPU or other translating device may translate between UPLI write requests and CXL.mem write requests. The write path involves translating from UPLI request and Originator Data channels to CXL.mem M2S RwD messages, and translating the CXL.mem S2M NDR completion back to a UPLI write response (WrRsp). The RPU may translate opcodes, commands, addresses, Tags, byte enables, and completion status between the two protocol domains. In some examples, the RPU may split a UPLI write request carrying a transfer size exceeding a CXL.mem cacheline size into multiple CXL.mem M2S RwD requests, and may aggregate the corresponding completions before returning the UPLI WrRsp to the originating entity.

In various implementations, a method for translating from Ultra Accelerator Link (UALink) Protocol Level Interface (UPLI) write requests to Compute Express Link (CXL) write requests, comprising: communicating with a first entity according to UPLI; communicating with a second entity according to CXL.mem; receiving, from the first entity, a UPLI request comprising a write command, a first physical address, and write data; translating the UPLI request to a CXL.mem Master-to-Subordinate Request with Data (M2S RwD) comprising a MemWr* and a second physical address; sending the CXL.mem M2S RwD and the write data to the second entity; receiving, from the second entity, a CXL.mem Subordinate-to-Master No Data Response (S2M NDR) comprising Cmp*; translating the CXL.mem S2M NDR to a UPLI write response (WrRsp); and sending the UPLI WrRsp to the first entity. The write translation may enable entities communicating according to UPLI to store data in memory resources coupled to entities communicating according to CXL.mem. The method may be implemented in hardware, firmware, software, or combinations thereof, and may be performed by various types of devices, such as a processor, a switch, a bridge, an RPU, or a semiconductor device. The first physical address may be associated with a first address space, such as an NPA space, and the second physical address may be associated with a second address space, such as an HPA space, wherein the translating may include translating the first physical address to the second physical address. Additionally or alternatively, the first and second physical addresses may be associated with the same address space, such as a global address space, a PGAS, a pod address space, a virtual pod address space, or a fabric address space. The UPLI write command may include a Write, a WriteFull, or a Write Class Vendor Defined Command as defined by the UPLI specification.

In some implementations of the method, the UPLI request further comprises a ReqSrcPhysAccID field, a ReqDstPhysAccID field, a ReqTag field, and a ReqAddr field comprising the first physical address; wherein the write data is received on a UPLI Originator Data (OrigData) channel comprising OrigDataByteEn; and further comprising translating the ReqTag to a Tag associated with the CXL.mem M2S RwD. The ReqSrcPhysAccID and ReqDstPhysAccID fields may carry identifiers utilized for routing the UPLI request and for constructing response routing information. The OrigDataByteEn field may carry per-byte enable bits indicating which bytes of the write data are valid. The Tag translation may involve maintaining a bidirectional mapping between UPLI ReqTag values and CXL.mem Tag values, enabling proper correlation of CXL.mem S2M NDR completions with their corresponding UPLI write requests.

In some implementations of the method, the MemWr* comprises MemWrPtl, and the write data comprises a partial cacheline update; and wherein byte enables associated with a UPLI Originator Data channel are utilized to indicate which bytes of the cacheline are to be written by the second entity. The MemWrPtl opcode may indicate a partial write where only a subset of bytes within a CXL.mem cacheline are updated. The byte enables from the UPLI OrigDataByteEn field may be propagated to the CXL.mem domain, enabling the second entity to update only the specified bytes while preserving the remaining bytes of the cacheline.

In some implementations of the method, the UPLI WrRsp further comprises a WrRspTag field and a WrRspStatus field, and the CXL.mem S2M NDR further comprises a Cmp* completion opcode; and further comprising translating a Tag of the CXL.mem S2M NDR to the WrRspTag of the UPLI WrRsp, and translating a completion status of the CXL.mem S2M NDR to the WrRspStatus of the UPLI WrRsp. The WrRspTag may be retrieved from the bidirectional mapping maintained by the RPU, enabling the first entity to correlate the write response with its original write request. The WrRspStatus may indicate success or failure of the write operation. The translation of completion status across protocol boundaries may enable the first entity to detect write failures that originated in the CXL domain and to take appropriate recovery actions.

In some implementations of the method, the first entity comprises an accelerator, the second entity comprises a CXL device comprising at least one of: a CXL memory expander, a CXL memory pool, or a Global Fabric-Attached Memory Device (GFD); the first physical address is associated with a Network Physical Address (NPA) space; and the second physical address is associated with a Host Physical Address (HPA) space; and wherein the translating further comprises translating the first physical address to the second physical address. The address translation from NPA to HPA may be implemented utilizing lookup tables, page tables, base-and-offset calculations, range-based mapping, and/or programmable translation functions. The GFD may provide large-capacity memory resources accessible via CXL.mem and shared among requesters.

In some implementations of the method, the UPLI request further comprises a ReqLen field indicating a transfer size exceeding a CXL.mem cacheline size; and wherein the translating further comprises generating CXL.mem M2S RwD requests from the UPLI request, each of the CXL.mem M2S RwD requests comprising a respective MemWr* and a respective portion of the write data. UPLI write requests may carry a ReqLen indicating a transfer size of up to 256 bytes, while CXL.mem M2S RwD messages may carry up to 64 bytes of data per request. When the ReqLen exceeds the CXL.mem cacheline size, the RPU may split the UPLI write request into CXL.mem M2S RwD requests, each carrying a respective portion of the write data with a respective translated address. The RPU may aggregate the corresponding CXL.mem S2M NDR completions before returning a UPLI WrRsp to the first entity.

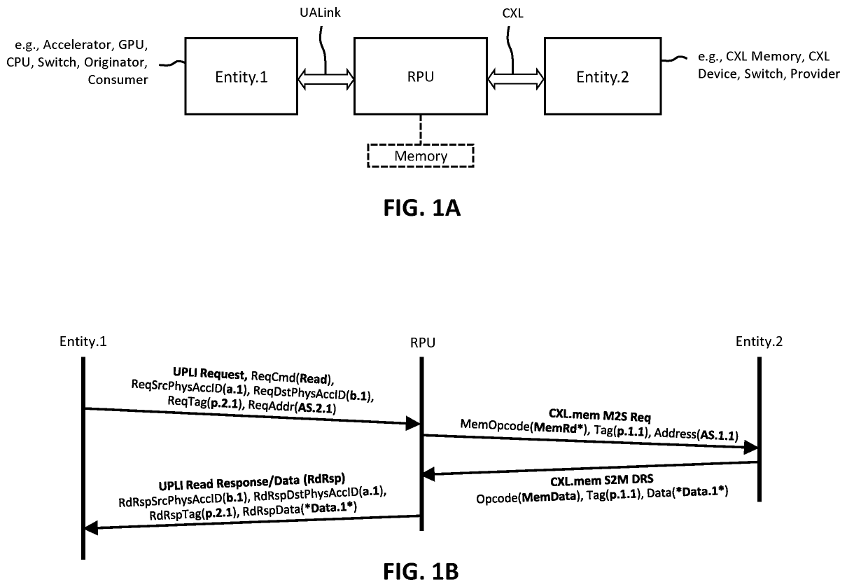

FIG. 1A illustrates an example of a system comprising an RPU, which may be coupled to memory, wherein the RPU may enable external entities to access resources coupled to the RPU. The RPU may translate between a UALink-based protocol (such as UPLI) and a CXL-based protocol (such as CXL.mem). Additionally or alternatively, the RPU may translate between UPLI and CXL.io, and/or between UPLI and CXL.cache. In some examples, the RPU may be implemented as a discrete component, such as on a PCB, coupled to other components such as CPUs, GPUs, accelerators, switches, or CXL devices. In other examples, the RPU may be embedded in another silicon design, such as an IP within a processor, or may be implemented as a chiplet within an IC package. The RPU is coupled to a first entity (Entity.1), which may be an accelerator, a GPU, a CPU, a switch, an originator, or a consumer, wherein the RPU may communicate with the first entity according to a UALink-based protocol, such as UPLI. The RPU is further coupled to a second entity (Entity.2), which may be a CXL memory, a CXL device, a switch, or a provider, wherein the RPU may communicate with the second entity according to a CXL-based protocol, such as at least one of CXL.mem, CXL.io, or CXL.cache. In some examples, the UALink-based traffic, such as UPLI traffic, may be associated with a first address space, such as an NPA space, and the CXL-based traffic, such as CXL.mem traffic, may be associated with a second address space, such as a System Physical Address (SPA) space or a Host Physical Address (HPA) space; wherein the RPU may perform address translations between addresses within the first and second address spaces, respectively, such as between addresses within the NPA space and addresses within the SPA space or the HPA space. In other examples, the UALink-based traffic and the CXL-based traffic may be associated with the same physical address space, such as with a global address space, a partitioned global address space (PGAS), a pod address space, a virtual pod address space, or a fabric address space; wherein the RPU may perform address translations between addresses within the same address spaces. The RPU may perform further translations, such as opcode, command, or TLP translations, e.g., translating between commands in requests conforming to the UALink-based protocol (e.g. UPLI vendor-defined read command) to opcodes in requests conforming to the CXL-based protocol (e.g., CXL.mem MemRd). The RPU may further translate between messages conforming to the UALink-based protocol and messages conforming to the CXL-based protocol, Tag translations, traffic class (TC) translations, and/or cross-field translations such as between CXL.mem Tag and UPLI ReqTag, and/or between UPLI RdRspTag and CXL.mem Tag. Additionally, the RPU may maintain tracking between Tags in the UPLI domain and Tags in the CXL domain, such as in order to associate responses with their corresponding requests. The RPU may further translate error indications, such as poison.

FIG. 1B illustrates an example of a TFD demonstrating translations performed by an RPU, between UALink-based traffic, such as UPLI traffic, utilized for communicating with a first entity (Entity.1), such as an accelerator, a GPU, a CPU, a switch, an originator, or a consumer, and CXL-based traffic, such as CXL.mem traffic, utilized for communicating with a second entity (Entity.2), such as a CXL device, a CXL memory, or a CXL switch. Additionally or alternatively, the RPU may translate between UPLI and CXL.io requests, and/or between UPLI and CXL.cache requests. The first entity may initiate a UPLI transaction that may include a UPLI request (Req) comprising Request Command (e.g., ReqCmd(Read)), Request Source Physical Accelerator ID (e.g., ReqSrcPhysAccID(a.1)), Request Destination Physical Accelerator ID (e.g., ReqDstPhysAccID(b.1)), Request Tag (e.g., ReqTag(p.2.1)), and Request Address (e.g., ReqAddr(AS.2.1)). The RPU may translate the UPLI transaction to a CXL.mem transaction that may include a CXL.mem M2S request comprising MemOpcode(MemRd*), Tag(p.1.1), and Address(AS.1.1), and may send the CXL.mem M2S request to the second entity. The asterisks in the translated CXL.mem M2S request MemRd indicate that this could represent any suitable superset combination of read opcodes, commands, or operations, supported by CXL.mem, such as MemRd, MemRdData, MemRdTEE, MemRdDataTEE, etc. The RPU may further translate between other fields of the UPLI transaction and fields of the CXL.mem transaction, such as between address fields, Tag fields, QoS-related fields, or identification (ID) fields that may serve to route the UPLI request to its target.

Upon receiving a response from the second entity, that may include a CXL.mem S2M DRS comprising Opcode(MemData), Tag(p.1.1), and Data(*Data.1*), the RPU may translate the CXL.mem S2M DRS to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(p.2.1)), and Read Response Data (e.g., RdRspData(*Data.1*)). Optionally, the RPU may act as an endpoint, or may act as a completer device, and may terminate the UPLI transactions. The RPU may issue the CXL.mem transactions, optionally acting as an independent protocol initiator, such as a CXL host, and may utilize translated fields from the UPLI transaction for constructing the CXL.mem transaction. The RPU may perform further translations, such as opcode or command translations, e.g., translating between vendor-defined read commands in UPLI requests and MemRd in CXL.mem requests. The RPU may further translate between messages conforming to UPLI and messages conforming to CXL.mem, translate Tags, and/or translate error indications, such as poison.

In some examples, the RPU may translate a UPLI transaction to multiple CXL.mem transactions, such as when the UPLI request may include a request length field, such as ReqLen, that may carry values representing a read of up to 256 Bytes of data, wherein the RPU may translate such UPLI requests to CXL.mem M2S requests, such that each may carry up to 64 Bytes of data that may represent a cacheline. The RPU may further translate between CXL.mem responses, such as CXL.mem S2M NDR and/or CXL.mem S2M DRS, and UPLI responses, such as UPLI read response, and may forward read data carried in CXL.mem DRS messages into the UPLI read response. In some examples, the RPU may accumulate data from one or more CXL.mem DRS messages before sending the data via the UPLI read response.

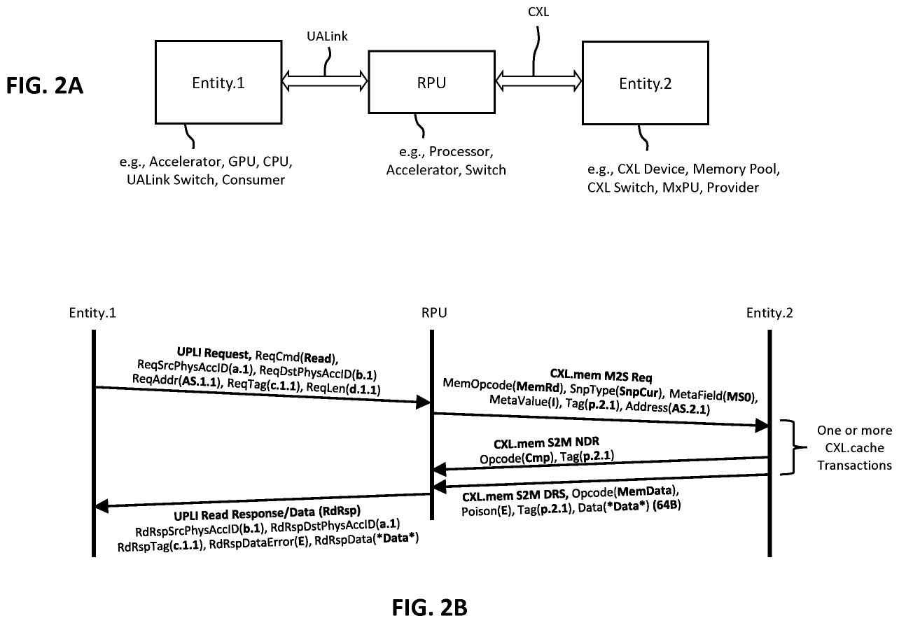

FIG. 2A illustrates an example of a system comprising an RPU (such as a processor, an accelerator, or a switch) that enables external entities to access resources coupled to the RPU, such as CXL devices or CXL memory. The RPU is coupled to a first entity (Entity.1), which may be an accelerator, a GPU, a CPU, a UALink switch, or a consumer, wherein the RPU may communicate with the first entity according to a UALink-based protocol, such as a UPLI. The RPU is further coupled to a second entity (Entity.2), which may be a CXL device, CXL memory, CXL-based memory pool, a CXL switch, an MxPU, or a provider, wherein the RPU may communicate with the second entity according to a CXL-based protocol, such as CXL.mem. In some examples, the UALink-based protocol, such as UPLI, may be associated with a first address space, such as an NPA space, and the CXL-based protocol, such as CXL.mem, may be associated with a second address space, such as an HPA space; wherein the RPU may perform address translations between addresses within the first and second address spaces, respectively, such as between addresses within the NPA space and addresses within the HPA space. In other examples, the UALink-based protocol, such as UPLI, and the CXL-based protocol, such as CXL.mem, may be associated with the same physical address space, such as a global address space; wherein the RPU may perform address translations between addresses within the same address spaces. The RPU may perform further translations, such as opcode or command translations, e.g., translating between Read commands in UPLI requests and MemRd in CXL.mem requests. The RPU may further translate between messages conforming to UPLI and messages conforming to CXL.mem, translate Tags, and/or translate error indications, such as poison.

FIG. 2B illustrates an example of a TFD demonstrating an RPU that may translate between UALink-based traffic, such as UPLI traffic, and CXL-based traffic, such as CXL.mem traffic. Additionally or alternatively, the RPU may translate between UPLI and CXL.io, and/or between UPLI and CXL.cache. The RPU may provide intent-based translation between protocols, such as between UPLI and CXL.mem, identifying the intent of a received transaction, and generating a translated transaction that may convey a corresponding intent, or convey an intent based on a predefined, predetermined, configurable, rule-based, or dynamic mapping between intentions. The RPU may receive from a first entity (Entity.1), such as an accelerator, a UALink UPLI transaction that may include a UPLI request comprising Request Command (e.g., ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., ReqAddr(AS.1.1)), Request Tag (e.g., ReqTag(c.1.1)), and Request Length (e.g., ReqLen(d.1.1)). The received UPLI transaction may indicate an intent to perform an I/O-coherent read, e.g., a request for the most recent copy of the data, corresponding to an I/O-coherency model that may be typical for UALink.

The RPU may translate the UPLI transaction to a CXL.mem transaction, that may include a CXL.mem M2S request comprising Memory Operation (e.g., MemOpcode(MemRd)), Snoop Type (e.g., SnpType(SnpCur)), Metadata Field (e.g., MetaField(MS0)), Metadata Value (e.g., MetaValue(I)), Tag(p.2.1), and Address(AS.2.1). This translation from UPLI to CXL.mem may indicate an intent to perform an I/O-coherent read, via a CXL.mem request for a non-cacheable but current value of the data, wherein the data may be represented as 64B cachelines that correspond to the Request Length (e.g., ReqLen(d.1.1)) in the UPLI request. The RPU may further translate between other values of the UPLI transaction and the CXL.mem transaction, such as between addresses, Tags, QoS-related values, or identifications (IDs) that may serve to route the UPLI request to its destination.

In some examples, the RPU may translate a UPLI transaction to multiple CXL.mem transaction, such as when the UPLI request comprises a request length field (e.g., ReqLen), which may carry values indicating a read of more than 64 Bytes of data, wherein the RPU may translate such UPLI requests to CXL.mem M2S requests, such that each may carry up to 64 Bytes of data, possibly representing a 64 Byte cacheline. The RPU may further translate between CXL.mem responses, such as CXL.mem S2M NDR and/or CXL.mem S2M DRS, and UPLI responses, such as UPLI read responses, and may forward read data carried in CXL.mem DRS messages via UPLI read responses.

In some examples, the RPU may receive a response from the second entity (Entity.2), which may include a CXL.mem S2M NDR comprising Opcode(Cmp) and Tag(p.2.1), and may further include a CXL.mem S2M DRS comprising Opcode(MemData), Poison(E), Tag(p.2.1), and Data(*Data*). The RPU may translate the CXL.mem S2M DRS to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), Read Response Data Error (e.g., RdRspDataError(E)), and Read Response Data (e.g., RdRspData(*Data*)). This translation demonstrates that the RPU may propagate error responses from the CXL domain to the UPLI domain, such as by translating error indications carried in CXL.mem S2M DRS messages, such as poison, to error indications carried in UPLI RdRsp messages, such as Read Response Data Error (e.g. RdRspDataError). Additionally, the RPU may accumulate data from one or more CXL.mem DRS messages before sending the data via the UPLI read response.

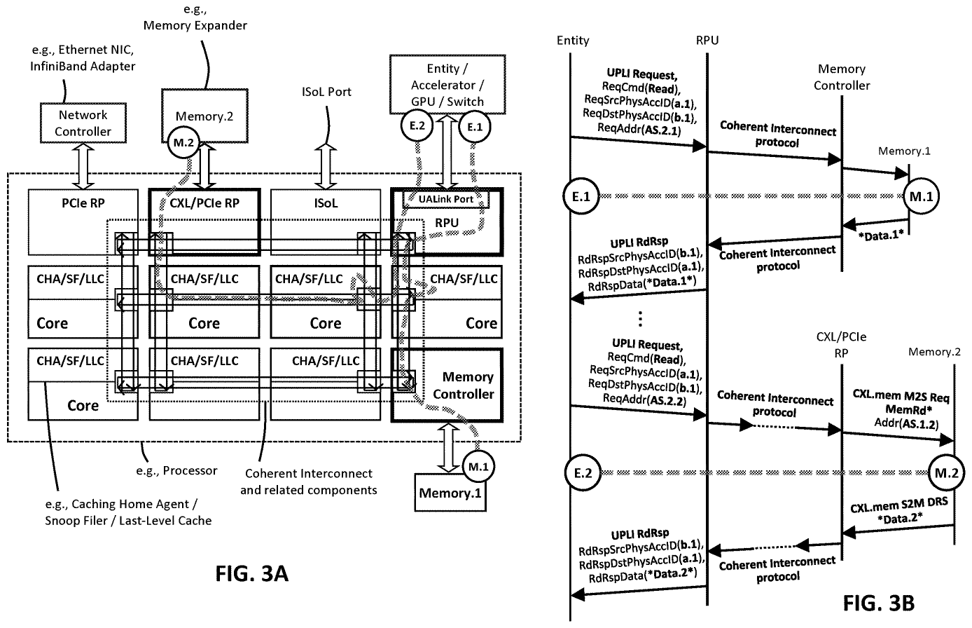

FIG. 3A illustrates an example of a system comprising a processor, including a coherent interconnect, capable of enabling an external entity, such as a GPU or an accelerator, to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and LLC, optionally implemented as distributed slices coupled to the coherent interconnect. The processor may further include a PCIe RP that may be coupled to a Network Controller, such as an Ethernet NIC or an InfiniBand Adapter, a CXL/PCIe RP, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), such as Intel UPI. The processor may be coupled to a second memory (Memory.2), such as a CXL memory expander, and may further include an RPU that includes or is coupled to a UALink port that may communicate with the entity according to a UALink-based protocol, such as UPLI, wherein the RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the UALink-based protocol and a protocol utilized by the coherent interconnect. The processor may be implemented as an IP block embedded into a silicon design, such as a switch or an accelerator. In other examples, the processor may be implemented as a monolithic die, as chiplets within an IC package, or as components on a board, and may utilize a mesh-based coherent interconnect, may utilize a ring, a crossbar, a Network on Chip (NoC) or other types of coherent interconnects.

FIG. 3B illustrates an example of a TFD demonstrating two UPLI requests, such as UPLI read requests, received from an entity, such as a GPU or an accelerator, processed by an RPU and forwarded, possibly using a protocol utilized by a coherent interconnect, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from Network Physical Addresses (NPAs) to Host Physical Addresses (HPAs), to enable the entity to access the processor's memories. The processor may have multiple memory resources, such as first memory (Memory.1), which may be a DRAM coupled to a memory controller of the processor, and/or second memory (Memory.2), which may be a CXL memory expander coupled to a CXL/PCIe RP of the processor. The RPU may further perform additional translations, such as protocol translations from a UALink-based protocol, such as UPLI, to a protocol utilized by the coherent interconnect, and may send the optionally translated request to the coherent interconnect, requesting a read from memory. In some examples, the requested data may be provided by a processor cache, such as by an LLC, instead of by the memory. The data may then return over the coherent interconnect to the RPU, wherein the RPU provides UPLI read response/data (RdRsp) to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction includes a first UPLI request (Req) comprising physical address (AS.2.1), which may be an NPA, which the RPU translates and forwards via the coherent interconnect protocol and via the memory controller to the first memory (Memory.1), resulting in the retrieval of *Data.1*, that is sent to the entity via the coherent interconnect protocol and via the RPU with the first UPLI RdRsp. The second exemplary transaction includes a second UPLI request comprising physical address (AS.2.2), which may be an NPA, which the RPU may translate to physical address (AS.1.2) and forward to the second memory (Memory.2), via the coherent interconnect protocol and via the CXL/PCIe RP, utilizing a CXL.mem M2S request. *Data.2* is retrieved from the second memory utilizing a CXL.mem S2M DRS, and sent to the RPU via the coherent interconnect protocol. The RPU may then send *Data.2* to the entity via the second UPLI RdRsp. It is noted that the physical addresses (AS.2.1) and (AS.2.2) may refer to different memory regions within an NPA address space exposed via the UALink port, enabling the entity to access memory resources based on the RPU's translation capabilities.

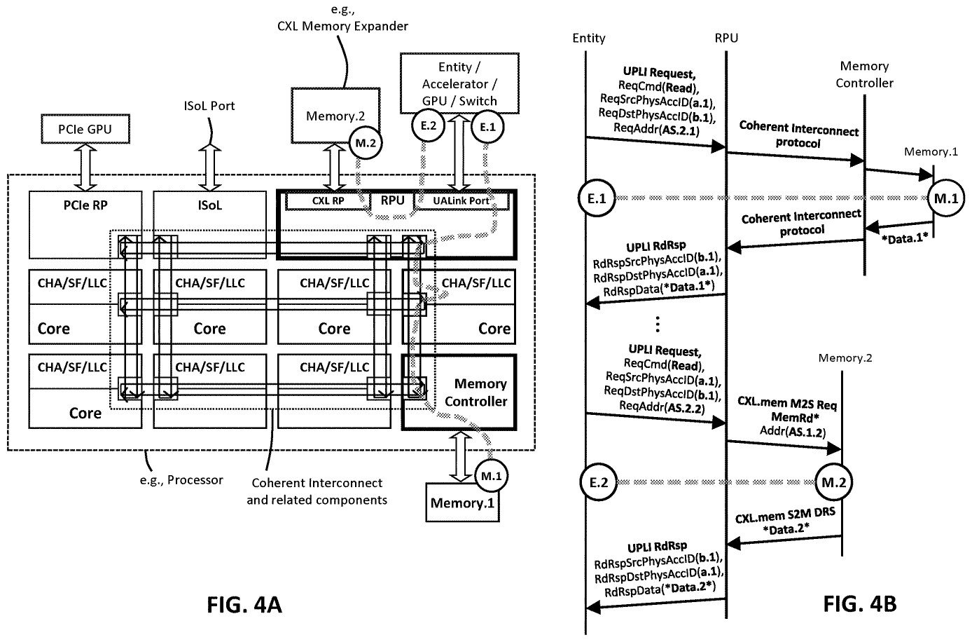

FIG. 4A illustrates an example of a system comprising a processor, including a coherent interconnect, capable of enabling an external entity, such as a GPU or an accelerator, to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and LLC, optionally implemented as distributed slices coupled to the coherent interconnect. The processor may further include a PCIe RP that may be coupled to a PCIe GPU, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), such as Intel UPI. The processor may include an RPU that includes or is coupled to a UALink port that may communicate with the entity according to a UALink-based protocol, such as UPLI, wherein the RPU further includes a CXL RP coupled to a second memory (Memory.2), such as a CXL memory expander. The RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the UALink-based protocol and a protocol utilized by the coherent interconnect. The processor may utilize a mesh-based coherent interconnect, or in other examples may utilize a ring, a crossbar, a Network on Chip (NoC) or other types of coherent interconnects.

FIG. 4B illustrates an example of a TFD demonstrating two UPLI requests, such as UPLI read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from Network Physical Addresses (NPAs) to Host Physical Addresses (HPAs), or from NPAs to System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between a UALink-based protocol, such as UPLI, and a protocol utilized by the coherent interconnect, wherein the RPU may send the optionally translated UPLI requests to the coherent interconnect, requesting reads from memory, such as from the first memory or from the second memory. The RPU may further translate between UALink-based traffic, such as UPLI traffic, and CXL-based traffic, such as at least one of CXL.mem, CXL.io, or CXL.cache traffic, wherein the RPU may send the optionally translated UPLI traffic to the second memory via the CXL RP. In some examples, the requested data may be provided by a cache of the processor, such as by an LLC, instead of by the memory. The data may then return over the coherent interconnect to the RPU, wherein the RPU provides UPLI read response/data (RdRsp) to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first UPLI request (Req) comprising physical address (AS.2.1), which may be an NPA, which the RPU may translate and forward via the coherent interconnect protocol and via the memory controller to the first memory, resulting in the retrieval of *Data.1*, that is sent to the entity via the coherent interconnect protocol and via the RPU with the first UPLI RdRsp. The second exemplary transaction corresponds to the memory read path denoted as (E.2)-(M.2), and may include a second UPLI request comprising physical address (AS.2.2), which may be an NPA. The RPU may translate the second UPLI request to a CXL.mem M2S request comprising MemRd* and Address(AS.1.2), wherein the RPU may send the translated request to the second memory via the CXL RP. *Data.2* is retrieved from the second memory utilizing a CXL.mem S2M DRS, and sent to the RPU via the CXL RP, wherein the RPU may send *Data.2* to the entity utilizing the second UPLI RdRsp.

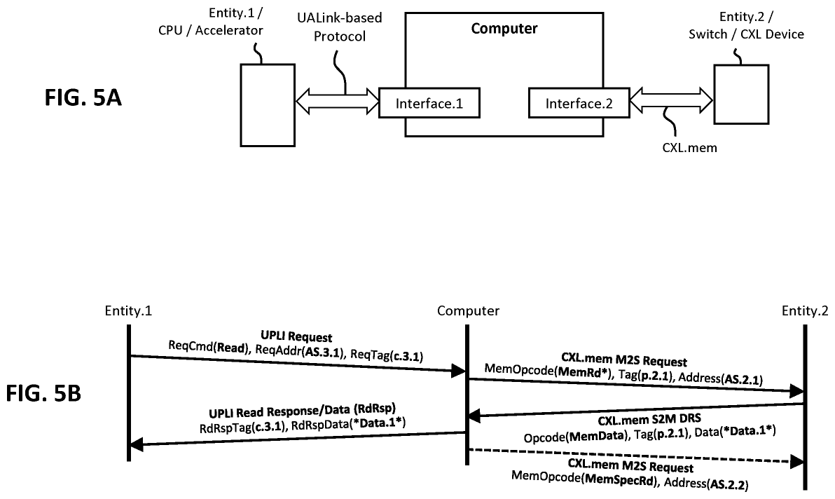

FIG. 5A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.mem, with a second entity (Entity.2), such as a switch, or a CXL device which may be a CXL memory expander, a CXL memory pool, a GFD, or a CXL accelerator. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In other examples, the first address space and the second address space may be associated with the same address space, such as a common address space, a global address space, a pod address space, or a fabric address space, wherein the computer may perform address translations between addresses within the same common address space. The computer may be implemented in an IC package having high-speed differential I/O balls positioned according to a ball grid array layout defined by a retimer specification.

FIG. 5B illustrates an example of a TFD demonstrating translations, such as address translations, performed by a computer, between: (1) first physical addresses, such as Network Physical Addresses (NPAs), carried in UALink-based requests, such as UPLI requests, received from a first entity (Entity.1), which may be a CPU or an accelerator; and (2) second physical addresses, such as Host Physical Addresses (HPAs), carried in CXL requests, such as CXL.mem requests, sent to a second entity (Entity.2), which may be a switch or a CXL device, possibly enabling the first entity to access resources mapped to an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.mem M2S request comprising MemOpcode(MemRd*), Tag(p.2.1), and Address(AS.2.1), and may send the CXL.mem M2S request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to a UPLI read response/data (RdRsp) comprising RdRspTag(c.3.1) and RdRspData(*Data.1*), and send the UPLI RdRsp to the first entity.

The computer may further initiate speculative memory reads targeting the second entity, wherein the speculative memory reads may include a CXL.mem M2S request comprising MemOpcode(MemSpecRd) and Address(AS.2.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved. The computer may perform further translations, such as protocol translations, opcode translations, command translations, TLP type translations, and translations between the UALink-based domain and the CXL domain. In some examples, the computer may issue multiple CXL.mem reads in response to receiving a UPLI request from the first entity. For example, the computer may issue CXL.mem M2S requests comprising MemRd or MemRdData, such as when splitting a UPLI request for a large block of data (e.g., 256 B) to smaller CXL.mem reads (e.g., 64 B each), or when prefetching data from the second entity utilizing CXL.mem reads. The computer may translate requests or transactions initiated from the UALink-based domain to the CXL domain, may translate requests or transactions initiated from the CXL domain to the UALink-based domain, or may translate requests or transactions initiated from both domains.

In environments where entities may utilize different protocols while requiring coordinated access to shared resources, there may be scenarios where a first entity communicating according to CXL.mem, such as a CXL host, needs to access memory resources residing in a UALink domain, such as memory coupled to accelerators or accessible via a UALink network. An RPU or other suitable device may translate between CXL.mem and UPLI to facilitate memory operations, data transfers, and resource sharing across different protocol domains while maintaining the requirements of each protocol. The translation may involve converting CXL.mem M2S requests to UPLI requests, and converting UPLI responses to CXL.mem S2M responses, including translations of opcodes, commands, addresses, Tags, and additional fields. The RPU may further perform address translations between different address spaces, such as between a Host Physical Address (HPA) space utilized by CXL-based traffic and a Network Physical Address (NPA) space utilized by UALink-based traffic, or between addresses within the same address space. The RPU may include a cache for storing fetched data and may operate as a CXL Type-2 device, a CXL Type-3 device, or may expose both HDM-D and HDM-H memory regions concurrently.

In various implementations, a method for translating from Compute Express Link (CXL) requests to Ultra Accelerator Link (UALink) Protocol Level Interface (UPLI) requests, comprising: communicating with a first entity according to CXL.mem; communicating with a second entity according to UPLI; receiving, from the first entity, a CXL.mem Master-to-Subordinate (M2S) request comprising a MemRd* and a first physical address; translating the CXL.mem M2S request to a UPLI request comprising a read command and a second physical address; sending the UPLI request to the second entity; receiving, from the second entity, a UPLI read response (RdRsp) comprising data; translating the UPLI RdRsp to a CXL.mem Subordinate-to-Master Data Response (S2M DRS) comprising the data; and sending the CXL.mem S2M DRS to the first entity. The translation may enable entities communicating according to CXL.mem to access memory resources coupled to entities communicating according to UPLI, such as HBM and/or High-Bandwidth Flash (HBF) coupled to an accelerator, or memory accessible via a UALink network. The method may be implemented in hardware, firmware, software, or combinations thereof, and may be performed by various types of devices, such as a processor, a switch, a bridge, an RPU, or a semiconductor device. The first physical address may be associated with a first address space, such as an HPA space, and the second physical address may be associated with a second address space, such as an NPA space, wherein the translating may include translating the first physical address to the second physical address. Additionally or alternatively, the first and second physical addresses may be associated with the same address space, such as a global address space, a partitioned global address space (PGAS), a pod address space, a virtual pod address space, or a fabric address space.

In some implementations of the method, the CXL.mem M2S request further comprises a MemOpcode field comprising the MemRd*, a Tag field, and an Address field comprising the first physical address; and wherein the UPLI request further comprises a ReqCmd field comprising the read command, a ReqAddr field comprising the second physical address, a ReqSrcPhysAccID field, a ReqDstPhysAccID field, a ReqLen field, and a ReqTag field; and further comprising translating the Tag to the ReqTag. The Tag translation may involve maintaining a bidirectional mapping between CXL.mem Tag values and UPLI ReqTag values, enabling proper correlation of UPLI responses with their corresponding CXL.mem requests. The ReqSrcPhysAccID and ReqDstPhysAccID fields may carry identifiers utilized for routing the UPLI request to the target accelerator. When the ReqLen indicates a transfer size exceeding a CXL.mem cacheline size (e.g., 64 Bytes), CXL.mem M2S requests may be consolidated into a UPLI request supporting transfer sizes up to 256 Bytes.

In some implementations of the method, the UPLI RdRsp further comprises a RdRspSrcPhysAccID field, a RdRspDstPhysAccID field, a RdRspTag field, and RdRspData comprising the data; and wherein the CXL.mem S2M DRS further comprises an Opcode field comprising MemData and the Tag. The RdRspDstPhysAccID may correspond to the ReqSrcPhysAccID from the original UPLI request, reflecting the routing path for the response. The RdRspTag may be utilized to retrieve the corresponding CXL.mem Tag from the bidirectional mapping maintained during request translation. In some examples, the UPLI RdRsp may carry data across multiple beats, and the RPU may accumulate the beats before constructing the CXL.mem S2M DRS.

In some implementations of the method, the UPLI RdRsp further comprises a RdRspDataError field, and the CXL.mem S2M DRS further comprises a Poison field; and further comprising translating the RdRspDataError field of the UPLI RdRsp to the Poison field of the CXL.mem S2M DRS. The RdRspDataError field in UPLI may serve as a per-beat data poison indicator. The Poison field in CXL.mem S2M DRS may indicate that the returned data contains an error. The translation of error indications across protocol boundaries may enable the first entity to detect data corruption that originated in the UALink domain, and to take appropriate recovery actions.

In some implementations, the method further comprises storing the data from the UPLI RdRsp in a cache; and sending a CXL.mem Subordinate-to-Master No Data Response (S2M NDR) comprising Cmp-S to the first entity, wherein the Cmp-S indicates a shared cacheline state. By storing the fetched data in the cache, the RPU may maintain a local copy of the cacheline and participate in coherency management with the first entity. The S2M NDR comprising Cmp-S may inform the first entity that the RPU retains a shared copy, enabling both the first entity and the RPU to hold cached copies concurrently. This behavior may correspond to CXL Type-2 device semantics utilizing an HDM-D memory region, wherein the device coherency engine (DCOH) manages cacheline state on behalf of the device.

In some implementations of the method, the CXL.mem M2S request further comprises a SnpType field comprising SnpData, a MetaField field comprising Meta0-State (MS0), and a MetaValue field comprising Shared (S); and wherein the CXL.mem M2S request targets a Host-managed Device Memory (HDM-D) memory region. The SnpType(SnpData), MetaField(MS0), and MetaValue(S) combination may indicate an intent by the first entity to acquire a shared copy of the cacheline. The RPU may utilize these fields to determine the coherency behavior and to select the Cmp-S opcode for the S2M NDR.

In some implementations of the method, the CXL.mem M2S request further comprises a SnpType field comprising No-Op and a MetaField field comprising No-Op; and wherein the CXL.mem S2M DRS is sent to the first entity without sending a CXL.mem Subordinate-to-Master No Data Response (S2M NDR) to the first entity; and wherein the CXL.mem M2S request targets a Host-managed Device Memory (HDM-H) memory region. The No-Op values for SnpType and MetaField may indicate that no snoop or metadata operation is involved, corresponding to CXL Type-3 device semantics. In this flow, the RPU may act as a passthrough that forwards data from the UALink domain to the first entity without maintaining a cached copy and without participating in coherency management.

In some implementations, the method further comprises sending a CXL.mem Subordinate-to-Master No Data Response (S2M NDR) comprising Cmp-S to the first entity without storing the data in a cache. The RPU may respond with Cmp-S even when the RPU does not have a cache or does not store the data. This may be beneficial in scenarios where the first entity does not support CXL Type-3 device flows and only supports CXL Type-2 device flows. By emulating Type-2 behavior, the RPU may maintain compatibility with hosts that lack Type-3 support.

In some implementations of the method, the first physical address is associated with a first address space, the second physical address is associated with a second address space different from the first address space, and the translating further comprises translating the first physical address to the second physical address; and wherein the first address space comprises a Host Physical Address (HPA) space or a System Physical Address (SPA) space, and the second address space comprises a Network Physical Address (NPA) space. The address translation may be implemented utilizing lookup tables, page tables, base-and-offset calculations, range-based mapping, and/or programmable translation functions. The HPA or SPA may represent addresses within the CXL domain, and the NPA may represent addresses within the UALink network that may span multiple accelerators or nodes. In some examples, the first and second address spaces may be the same address space, and the RPU may perform routing without address translation.

In some implementations of the method, the first entity comprises a CXL host, the second entity comprises an accelerator or a UALink switch, and the read command comprises a Read command or a Read Class Vendor Defined Command. Read Class VDCs may correspond to ReqCmd encodings that enable vendor-specific memory access operations extending beyond the standard UPLI read commands. The CXL host may include a CPU or other CXL-capable entity. The accelerator may include a GPU, a TPU, or other processing device coupled to a UALink network.

In some implementations, the method further comprises receiving, from the first entity, a CXL.mem Master-to-Subordinate Request with Data (M2S RwD) comprising MemWr* and write data; translating the CXL.mem M2S RwD to a UPLI request comprising a write command; sending the UPLI request and the write data to the second entity; receiving, from the second entity, a UPLI write response (WrRsp); translating the UPLI WrRsp to a CXL.mem Subordinate-to-Master No Data Response (S2M NDR) comprising Cmp; and sending the CXL.mem S2M NDR to the first entity. MemWr* may refer to MemWr, MemWrPtl, MemWrTEE, MemWrPtlTEE, or other memory write opcode variants defined or to be defined in CXL.mem. The write data may be transferred from the CXL.mem domain to the UPLI domain via the Originator Data Channel, optionally with byte enable manipulation utilizing OrigDataByteEn when the MemWr* refers to MemWrPtl for partial writes. The UPLI write command may include a Write or WriteFull command as defined by the UPLI specification. The UPLI WrRsp may carry a WrRspTag and WrRspStatus indicating the completion status of the write operation.

In some implementations, the method further comprises receiving, from the first entity, a CXL.mem M2S request comprising MemSpecRd; and translating the CXL.mem M2S request comprising MemSpecRd to a UPLI request. The MemSpecRd opcode may indicate a speculative read issued by the first entity before coherence resolution, and the RPU may translate it to a UPLI read request directed to the second entity. When utilizing the MemSpecRd opcode, some of the CXL.mem M2S Req fields, such as MetaField, MetaValue, and SnpType, may be reserved. Additionally or alternatively, the RPU may initiate speculative UPLI requests on its own to prefetch data from the second entity, based on access pattern recognition or configurable prefetch policies.

In some implementations of the method, the method is performed by a device that exposes a first memory region utilizing CXL Type-2 device memory flows associated with a Host-managed Device Memory-Device coherent (HDM-D) region, and a second memory region utilizing CXL Type-3 device memory flows associated with a Host-managed Device Memory-Host coherent (HDM-H) region. The CXL specification allows a device to expose both HDM-D and HDM-H memory regions concurrently. For example, local memory such as HBM and/or HBF coupled to an accelerator may be exposed as an HDM-D region utilizing CXL Type-2 memory flows with coherency management, while remote memory accessible via the UALink network may be exposed as an HDM-H region utilizing CXL Type-3 memory flows. The RPU may select the appropriate memory flow based on the address of the CXL.mem M2S request.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

In computing environments where a host communicating according to CXL.mem may need to access memory resources in a UALink domain, such as memory coupled to accelerators or accessible via a UALink network, an RPU may bridge the two protocol domains by translating between CXL.mem and UPLI. The RPU may include a CXL port for communicating with the host and a UALink port for communicating with accelerators or a UALink switch. The RPU may translate CXL.mem M2S requests to UPLI requests and translate UPLI responses to CXL.mem S2M responses. The RPU may include a cache for storing fetched data and may operate as a CXL Type-2 device or a CXL Type-3 device. The RPU may be a discrete component, an IP block embedded within an accelerator, or a chiplet within an IC package.

In various implementations, a system comprising: a resource provisioning unit (RPU) comprising a Compute Express Link (CXL) port configured to communicate with a first entity according to CXL.mem, and an Ultra Accelerator Link (UALink) port configured to communicate with a second entity according to a UALink-based protocol; wherein the RPU is configured to: receive, from the first entity via the CXL port, a CXL.mem Master-to-Subordinate (M2S) request; translate the CXL.mem M2S request to a UPLI request; and send the UPLI request to the second entity via the UALink port. The RPU may serve as a protocol translation bridge that enables entities in the CXL domain to access resources in the UALink domain. The CXL port may support CXL.mem M2S and S2M channels, while the UALink port may support UPLI request, read response/data, write response, and Originator Data channels. The RPU may translate between CXL.mem and UPLI including translations of opcodes, addresses, Tags, and additional fields. The first entity may include a CXL host such as a CPU, and the second entity may include an accelerator, a UALink switch, or other UALink-capable device. The RPU may be coupled to the first entity directly or via a CXL fabric, and may be coupled to the second entity directly or via a UALink switch. The system may be implemented within an IC package, across IC packages, or as a combination of discrete and integrated components.

In some implementations of the system, the RPU is further configured to: receive a UPLI read response (RdRsp) from the second entity via the UALink port; translate the UPLI RdRsp to a CXL.mem Subordinate-to-Master Data Response (S2M DRS); and send the CXL.mem S2M DRS to the first entity via the CXL port. The RPU may translate UPLI RdRsp fields to CXL.mem S2M DRS fields, including mapping the RdRspTag back to the corresponding CXL.mem Tag and formatting the RdRspData as CXL.mem data. The RPU may accumulate data from multiple UPLI response beats before constructing the S2M DRS.

In some implementations of the system, the RPU further comprises a cache; and wherein the RPU is further configured to store data from the UPLI RdRsp in the cache and send a CXL.mem Subordinate-to-Master No Data Response (S2M NDR) comprising Cmp-S to the first entity. By maintaining the fetched data in its cache, the RPU may participate in coherency management with the first entity and may respond to subsequent accesses to the same cacheline without issuing additional UPLI requests. The RPU with a cache may operate as a CXL Type-2 device.

In some implementations of the system, the first entity comprises a CXL host, the second entity comprises an accelerator; and wherein the RPU is configured to operate as at least one of a CXL Type-2 device or a CXL Type-3 device. The RPU may operate as a CXL Type-2 device utilizing HDM-D memory regions with device-managed coherency, or as a CXL Type-3 device utilizing HDM-H memory regions with host-managed coherency. In some examples, the RPU may expose both HDM-D and HDM-H regions concurrently, operating as a CXL Type-2 device for some memory regions and as a CXL Type-3 device for others.

In some implementations, the system further comprises a UALink switch coupled to the UALink port; wherein the RPU is configured to send the UPLI request to the second entity via the UALink switch. The UALink switch may route the UPLI request to the second entity based on a Destination Accelerator ID carried in the UPLI request. The RPU may appear to entities in the UALink domain as a UALink endpoint identified by an Accelerator ID.

In some implementations of the system, the RPU is further configured to: receive, from the first entity via the CXL port, a CXL.mem Master-to-Subordinate Request with Data (M2S RwD) comprising MemWr*; translate the CXL.mem M2S RwD to a UPLI request comprising a write command; and send the UPLI request and write data to the second entity via the UALink port. The RPU may translate CXL.mem write opcodes to UPLI write commands and transfer the write data from the CXL.mem domain to the UPLI Originator Data Channel. When the MemWr* refers to MemWrPtl for partial writes, the RPU may translate the CXL.mem byte enables to UPLI OrigDataByteEn fields.

In computing environments where a host, such as a CPU, may need to access memory resources residing in a UALink domain, such as HBM and/or HBF coupled to accelerators in a UALink pod, the host may communicate via CXL.mem with an RPU that translates requests to UPLI for delivery to the accelerators via a UALink switch. The UALink pod may include accelerators coupled to a UALink switch, forming a high-bandwidth interconnect fabric for inter-accelerator communication. The RPU may be embedded within one of the accelerators, or may be a discrete component coupled to the UALink switch. In some configurations, the system may include a CXL fabric coupling the host to the RPU and to CXL memory devices such as GFDs, memory expanders, or memory pools, enabling the host to access both CXL domain resources and UALink domain resources. The multi-path topology may enable the host to access different accelerators and memory resources via different translation paths, supporting workloads such as AI inference where data may be staged from CXL memory to accelerator memory.

In various implementations, a system comprising: a host; a UALink pod comprising a UALink switch and accelerators coupled to the UALink switch, wherein the accelerators communicate according to a UALink-based protocol; a resource provisioning unit (RPU) coupled to the host via CXL.mem and coupled to the UALink switch; and wherein the RPU is configured to receive a CXL.mem Master-to-Subordinate (M2S) request from the host, translate the CXL.mem M2S request to a UPLI request, and send the UPLI request to an accelerator of the accelerators via the UALink switch. The system may enable the host to access memory resources residing in the UALink domain, such as HBM and/or HBF coupled to the accelerators, DRAM within the accelerators, or memory accessible via the UALink network. The RPU may translate between CXL.mem and UPLI including translations of opcodes, addresses, Tags, and additional fields. The UALink switch may route the UPLI request to the target accelerator based on a Destination Accelerator ID. The host may utilize CXL.mem M2S requests comprising memory read or write opcodes, and the RPU may translate these to corresponding UPLI read or write commands. The system may support workloads where the host stages data between CXL memory resources and accelerator memory, such as populating KV cache entries into accelerator HBM and/or HBF for AI inference workloads. The RPU may be implemented as a discrete component, as an IP block embedded within one of the accelerators, or as a chiplet within an IC package.

In some implementations of the system, the RPU is embedded within a first accelerator of the accelerators, and the first accelerator is coupled to the host via CXL.mem; and wherein the UPLI request is sent from the first accelerator to a second accelerator of the accelerators via the UALink switch. The embedded RPU may share the first accelerator's silicon die or IC package and may utilize the first accelerator's CXL port for communication with the host. The first accelerator may serve as both an accelerator in the UALink pod and as a translation bridge for the host to reach other accelerators.

In some implementations of the system, the RPU is separate from the accelerators and is coupled to the UALink switch via a UALink port. The discrete RPU may function as a standalone protocol translation component that does not perform accelerator compute functions. This configuration may enable the RPU to be deployed independently of the accelerator design, potentially supporting different generations of accelerators or different UALink pod configurations.

In some implementations, the system further comprises a CXL fabric coupling the host to the RPU; and further comprising a CXL memory device coupled to the host via the CXL fabric, wherein the host is configured to access the CXL memory device via CXL.mem. The CXL fabric may include one or more CXL switches and may provide connectivity between the host, the RPU, and CXL memory devices. The host may access the CXL memory device via CXL.mem without protocol translation, while accessing accelerator memory in the UALink pod via the RPU with protocol translation.

In some implementations of the system, the CXL memory device comprises at least one of: a Global Fabric-Attached Memory Device (GFD), a CXL memory expander, or a CXL memory pool. The GFD may provide large-capacity memory resources accessible via CXL.mem, and may be shared among the host and other CXL entities. The host may stage data between the CXL memory device and accelerator memory via the RPU, such as migrating KV cache entries for AI inference workloads.

In some implementations of the system, the RPU is further configured to receive a UPLI read response (RdRsp) from the accelerator via the UALink switch, translate the UPLI RdRsp to a CXL.mem Subordinate-to-Master Data Response (S2M DRS), and send the CXL.mem S2M DRS to the host; and wherein the host comprises a central processing unit (CPU), and the accelerators comprise graphics processing units (GPUs) or tensor processing units (TPUs). The CPU may utilize the CXL.mem response to populate data structures, migrate data between memory tiers, or perform orchestration tasks on behalf of AI or HPC workloads. The GPUs or TPUs may serve as computational accelerators within the UALink pod.

In some implementations, the system further comprises a second RPU coupled to the host via CXL.mem and coupled to the UALink switch; wherein the RPU is configured to translate CXL.mem M2S requests from the host to UPLI requests targeting a first accelerator of the accelerators, and the second RPU is configured to translate CXL.mem M2S requests from the host to UPLI requests targeting a second accelerator of the accelerators. The RPUs may enable the host to access different accelerators through dedicated translation paths, potentially supporting different address ranges, different coherency policies, or different quality-of-service configurations for each path. The first and second RPUs may be discrete components or may include one embedded RPU and one discrete RPU.

In some implementations of the system, the UALink switch comprises a route table, and the UALink switch routes the UPLI request from the RPU to the accelerator based on a Destination Accelerator ID carried in the UPLI request; and wherein the accelerators communicate with the UALink switch via UPLI request channels and UPLI response channels. The UALink switch may route UPLI traffic based on the ReqDstPhysAccID field in each UPLI request, utilizing the route table to map the Destination Accelerator ID to an egress port coupled to the target accelerator. The route table may be programmed by a Pod Controller or other management entity. The RPU may populate the ReqDstPhysAccID based on the address of the CXL.mem M2S request or based on a preconfigured mapping.

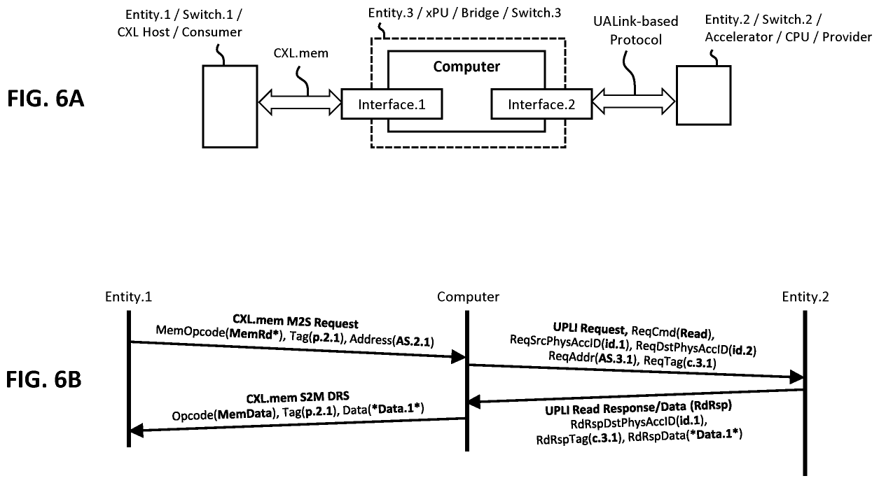

FIG. 6A illustrates an example of a block diagram showing a computer (Entity.3) coupled between a first entity (Entity.1) and a second entity (Entity.2). The first entity communicates with the computer via CXL.mem through a first interface (Interface.1), and the computer communicates with the second entity via a UALink-based protocol through a second interface (Interface.2). The first entity may include a CXL host, a switch, or a consumer of memory resources. The second entity may include an accelerator, a switch, or a provider of memory resources. The computer may include an xPU, a bridge, a switch, or an RPU.

FIG. 6B illustrates an example of a TFD demonstrating translations from a CXL.mem request from Entity.1 to a UPLI request sent to Entity.2, and from a UPLI read response from Entity.2 to a CXL.mem S2M DRS sent to Entity.1. The CXL.mem M2S request carries MemOpcode, Tag, and Address fields, and the UPLI request carries ReqCmd, ReqSrcPhysAccID, ReqDstPhysAccID, ReqAddr, and ReqTag fields. The UPLI read response carries RdRspDstPhysAccID, RdRspTag, and RdRspData fields, and the CXL.mem S2M DRS carries Opcode, Tag, and Data fields.

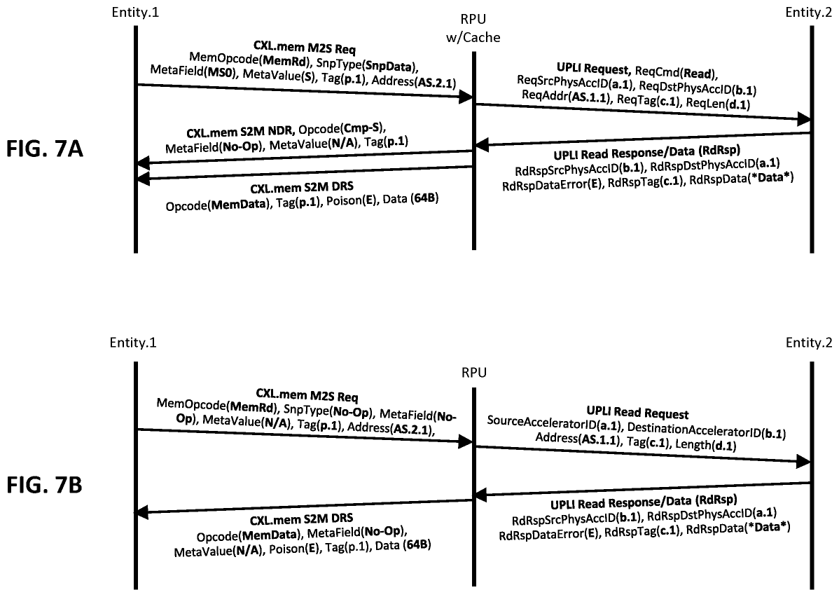

FIG. 7A illustrates an example of a TFD demonstrating an RPU comprising a cache (RPU w/Cache) that exposes a CXL Type-2 device utilizing an HDM-D memory region. Entity.1 sends a CXL.mem M2S request with SnpType(SnpData), MetaField(MS0), and MetaValue(S) to request a shared copy of a cacheline. The RPU translates the request to a UPLI request and receives a UPLI read response from Entity.2. The RPU stores the fetched data in its cache and sends a CXL.mem S2M NDR comprising Cmp-S to Entity.1, indicating a shared cacheline state, followed by a CXL.mem S2M DRS comprising MemData and the data.

FIG. 7B illustrates an example of a TFD demonstrating an RPU without a cache that exposes a CXL Type-3 device utilizing an HDM-H memory region. Entity.1 sends a CXL.mem M2S request with SnpType(No-Op) and MetaField(No-Op). The RPU translates the request to a UPLI request and receives a UPLI read response from Entity.2. The RPU translates the UPLI read response to a CXL.mem S2M DRS comprising MemData and the data, and sends the S2M DRS to Entity.1 without sending an S2M NDR.

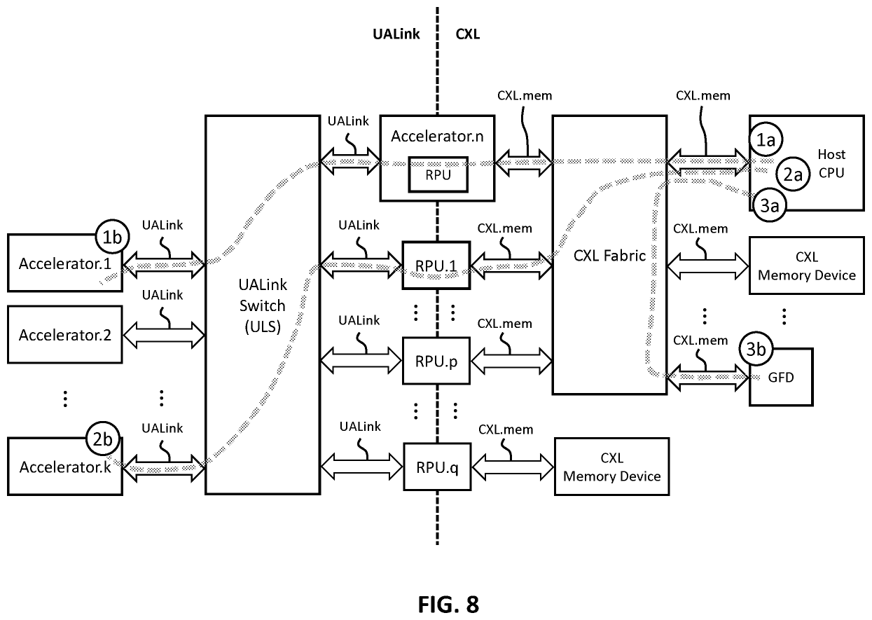

FIG. 8 illustrates an example of a system comprising a host CPU, a CXL fabric, a UALink switch, accelerators, and RPUs. Path 1 (1a to 1b) illustrates the host accessing Accelerator.1 via Accelerator.n that comprises an embedded RPU, wherein the host communicates with Accelerator.n via CXL.mem and Accelerator.n communicates with Accelerator.1 via UALink through the UALink switch. Path 2 (2a to 2b) illustrates the host accessing Accelerator.k via a discrete RPU (RPU.1) coupled to the UALink switch, wherein the host communicates with RPU.1 via CXL.mem and RPU.1 communicates with Accelerator.k via UALink. Path 3 (3a to 3b) illustrates the host accessing a GFD via CXL.mem through the CXL fabric.

In computing environments where a host, such as a CPU, accesses memory resources on a device, such as an accelerator, the device may expose memory regions to the host via CXL. Different memory regions may have different coherency requirements and may be backed by different types of memory. For example, a first memory region may be backed by local memory coupled to the device, such as HBM and/or High-Bandwidth Flash (HBF), and may benefit from device coherency where the device participates in cache coherency with the host. A second memory region may be backed by memory accessible via a UALink network, such as memory residing on remote accelerators, and may not require device coherency participation. The CXL specification defines different HDM types and device type flows that correspond to different coherency models, and a device may expose concurrent HDM regions utilizing different device type flows. An RPU or translation logic within the device may translate between CXL protocol messages received from the host and UPLI messages for accessing memory in the UALink domain, while maintaining the appropriate coherency semantics for each memory region.

In various implementations, a method comprising: exposing, by a device coupled to a host via a Compute Express Link (CXL) link, a first memory region via a first CXL device type flow and a second memory region via a second CXL device type flow, wherein the first CXL device type flow is different from the second CXL device type flow; wherein the first memory region is associated with a first memory; wherein the second memory region is associated with a second memory accessible via an Ultra Accelerator Link (UALink)-based protocol; and translating, by the device, between a protocol based on CXL and UALink Protocol Level Interface (UPLI) for at least one of the first memory region or the second memory region. The method may be implemented in hardware, firmware, software, or combinations thereof, and may be performed by various types of devices, such as an accelerator, an RPU, a semiconductor device, or a chiplet within an IC package. The first and second CXL device type flows may correspond to any combination of CXL Type-2 and Type-3 device flows, and may further include CXL Type-1 device flows in some examples. The device may expose additional memory regions beyond the first and second memory regions, each utilizing different or the same CXL device type flows. Translations between the protocol based on CXL and UPLI may include translations of opcodes, addresses, Tags, and additional fields, and may further include address translations between different address spaces such as a Host Physical Address (HPA) space and a Network Physical Address (NPA) space. The first memory may include memory coupled to the device, such as HBM, HBF, DRAM, or GDDR, while the second memory may include memory accessible via a UALink switch, a UALink network, or remote accelerators within a UALink domain. The elements may communicate through one or more intermediary components, such as a switch, a retimer, or other suitable entity that facilitates information transfer.

In some implementations of the method, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region; and wherein the device participates in cache coherency with the host for the first memory region and does not participate in cache coherency with the host for the second memory region. The CXL Type-2 device flow may enable the device to utilize both CXL.mem and CXL.cache protocols for the HDM-D region, allowing the device to maintain cached copies of data and participate in coherency negotiations with the host. The CXL Type-3 device flow may utilize CXL.mem without CXL.cache for the HDM-H region, where the host manages coherency without device cache participation.

In some implementations, the method further comprises receiving, from the host, a CXL.mem Master-to-Subordinate (M2S) request comprising MemRd* and an address targeting the first memory region, wherein the CXL.mem M2S request further comprises a SnpType field, a MetaField field, and a MetaValue field; translating the CXL.mem M2S request to a UPLI request; receiving a UPLI response comprising data; and sending to the host a CXL.mem Subordinate-to-Master No Data Response (S2M NDR) comprising Cmp-S or Cmp-E indicating a cache state of a cacheline at the address, and a CXL.mem Subordinate-to-Master Data Response (S2M DRS) comprising MemData and the data. The SnpType, MetaField, and MetaValue fields in the CXL.mem M2S request may indicate the cacheline state intent of the host, such as requesting a shared copy (SnpData) or an exclusive copy (SnpInv). The device may utilize these fields to determine the appropriate coherency response. The device coherency engine (DCOH) may select Cmp-S when the device retains a cached copy of the data, or Cmp-E when the device relinquishes its cached copy. The device may translate the CXL.mem M2S request to a UPLI request to fetch the data from the UALink domain before responding.

In some implementations of the method, the device comprises a cache; and wherein the device stores the data from the UPLI response in the cache and sends the CXL.mem S2M NDR comprising Cmp-S indicating that the device retains a cached copy of the cacheline at the address. By caching the fetched data and responding with Cmp-S, the device may enable subsequent accesses to the same cacheline to be served from its local cache without requiring another UPLI transaction. A device with cache, or a device that controls or utilizes a cache, may include a cache memory, a cache controller, or cache allocation and eviction logic.

In some implementations of the method, the UPLI request comprises a ReqSrcPhysAccID field, a ReqDstPhysAccID field, a ReqTag field, a ReqAddr field, and a ReqCmd field comprising a read command; and further comprising translating a Tag of the CXL.mem M2S request to the ReqTag of the UPLI request. The ReqSrcPhysAccID and ReqDstPhysAccID fields may carry identifiers utilized by the UALink network for routing the UPLI request. The Tag translation may involve maintaining a bidirectional mapping between CXL.mem Tag values and UPLI ReqTag values, enabling proper correlation of UPLI responses with their corresponding CXL.mem requests.

In some implementations, the method further comprises receiving, from the host, a CXL.mem Master-to-Subordinate (M2S) request comprising MemRd* and an address targeting the second memory region; translating the CXL.mem M2S request to a UPLI request; receiving a UPLI response comprising data; and sending to the host a CXL.mem Subordinate-to-Master Data Response (S2M DRS) comprising MemData and the data. For the second memory region, the device may operate as a passthrough translator that fetches data from the UALink domain and returns it to the host without maintaining cached copies or participating in coherency negotiations. The CXL.mem S2M DRS may carry MemData without an accompanying S2M NDR indicating Cmp-S or Cmp-E, because the device does not track cache state for this memory region.

In some implementations of the method, the UPLI response further comprises a RdRspDataError field indicating a data error; and further comprising translating the RdRspDataError field to a Poison field of the CXL.mem S2M DRS sent to the host. The RdRspDataError field in the UPLI response may serve as a per-beat data poison indicator. The translation of error indications across protocol boundaries may enable the host to detect data corruption that originated in the UALink domain and to take appropriate recovery actions.

In some implementations of the method, for the first memory region, the device communicates with the host via CXL.cache; and wherein the device issues CXL.cache Device-to-Host (D2H) requests to the host comprising an opcode selected from RdOwn, RdShared, RdCurr, or RdAny. The CXL.cache D2H requests may enable the device to initiate coherency transactions with the host for data in the first memory region. RdOwn may acquire exclusive ownership, RdShared may acquire a shared copy, RdCurr may request a non-cacheable current value, and RdAny may accept any coherency state.

In some implementations of the method, the first memory comprises at least one of High Bandwidth Memory (HBM) or High-Bandwidth Flash (HBF) coupled to the device, the second memory comprises memory accessible via a UALink switch or a UALink network, and the device comprises an accelerator. The accelerator may be a GPU, a TPU, or other processing unit with HBM and/or HBF that may benefit from device coherency for its local memory. The UALink switch or fabric may couple the accelerator to remote accelerators, and the second memory may reside on the remote accelerators or on other memory resources within the UALink domain.

In some implementations, the method further comprises translating, by the device, between a first address associated with a first address space utilized by the host and a second address associated with a second address space utilized by the UALink-based protocol; wherein the first address space comprises a Host Physical Address (HPA) space, and the second address space comprises a Network Physical Address (NPA) space or a System Physical Address (SPA) space. The address translation may be implemented utilizing lookup tables, page tables, base-and-offset calculations, or programmable translation functions. The HPA space may represent the host's view of the memory, while the NPA or SPA space may represent the address used by the UALink network for routing and accessing memory resources.

In some implementations of the method, at least one of the first memory region or the second memory region comprises a Host-managed Device Memory with Back-Invalidate (HDM-DB) region; and wherein the device sends a CXL.mem Subordinate-to-Master Back-Invalidate Snoop (S2M BISnp) to the host, and the host responds with a CXL.mem Master-to-Subordinate Back-Invalidate Response (M2S BIRsp). The HDM-DB region may enable the device to snoop the host's cache when the device needs to modify or evict cached data. The S2M BISnp may carry opcodes such as BISnpInv, BISnpData, or BISnpCur, and the M2S BIRsp may carry opcodes such as BIRspI, BIRspS, or BIRspE indicating the resulting host cache state. HDM-DB may be utilized with either CXL Type-2 or CXL Type-3 device flows.

In some implementations, the method further comprises receiving, from the host, a CXL.mem Master-to-Subordinate Request with Data (M2S RwD) comprising MemWr* and write data; translating the CXL.mem M2S RwD to a UPLI request comprising a write command and the write data; and sending a CXL.mem Subordinate-to-Master No Data Response (S2M NDR) to the host. The write command in the UPLI request may include Write or WriteFull commands. The device may send the S2M NDR before or after the UPLI write completes, depending on ordering requirements and system configuration.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

In computing systems where a host accesses memory resources on a device coupled via CXL, the device may expose memory regions with different coherency characteristics to the host. A first memory region associated with local memory, such as HBM, may be exposed via a CXL device type flow that supports device coherency, enabling the host and device to maintain coherent cached copies of data. A second memory region associated with memory accessible via a UALink port may be exposed via a different CXL device type flow that does not require device coherency participation. The device may include an RPU or translation logic configured to translate between CXL protocol messages and UPLI messages for memory access operations targeting the UALink-accessible memory. A UALink switch may couple the device to one or more remote accelerators whose memory resources form the second memory region.

In various implementations, a system comprising: a host; a device coupled to the host via a Compute Express Link (CXL) link; and a first memory coupled to the device; wherein the device is configured to expose to the host a first memory region via a first CXL device type flow and a second memory region via a second CXL device type flow, wherein the first CXL device type flow is different from the second CXL device type flow; wherein the first memory region is associated with the first memory; wherein the second memory region is associated with a second memory accessible via an Ultra Accelerator Link (UALink) port of the device; and wherein the device is configured to translate between a protocol based on CXL and UALink Protocol Level Interface (UPLI) for requests targeting at least one of the first memory region or the second memory region. The system may enable a host to access both local and remote memory resources on the device through a CXL link, with differentiated coherency semantics for different memory regions. The device may include an RPU, translation logic, or a combination of hardware and firmware that performs the translations between CXL and UPLI. The device may configure the boundaries between the first and second memory regions dynamically or statically, for example utilizing HDM decoder registers or programmable address range registers.

In some implementations of the system, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region. The CXL Type-2 device flow may enable the device to negotiate CXL.io, CXL.cache, and CXL.mem for the HDM-D region, while the CXL Type-3 device flow may negotiate CXL.io and CXL.mem for the HDM-H region. In some examples, the assignment of HDM types to memory regions may be configurable at system initialization or runtime.

In some implementations of the system, for CXL.mem requests targeting the first memory region, the device is configured to send a CXL.mem Subordinate-to-Master No Data Response (S2M NDR) comprising Cmp-S or Cmp-E indicating a cache state; and for CXL.mem requests targeting the second memory region, the device is configured to translate the CXL.mem requests to UPLI requests and send a CXL.mem Subordinate-to-Master Data Response (S2M DRS) comprising MemData. The differentiated response behavior may reflect the different coherency models of the first and second memory regions. For the first memory region, the Cmp-S or Cmp-E indication may inform the host of the cache state of the cacheline at the device. For the second memory region, the device may translate the request to UPLI, fetch the data from the UALink domain, and return the data.

In some implementations of the system, the host communicates with the device via CXL.mem and CXL.cache for the first memory region, and the host communicates with the device via CXL.mem without CXL.cache for the second memory region. The use of CXL.cache for the first memory region may enable the device to initiate coherency transactions and respond to host snoops, supporting scenarios where the device and host may both cache data from the first memory region. The absence of CXL.cache for the second memory region may simplify the memory access path for remote memory.

In some implementations of the system, the device comprises an accelerator comprising a resource provisioning unit (RPU), and the first memory comprises at least one of High Bandwidth Memory (HBM) or High-Bandwidth Flash (HBF) coupled to the accelerator; and further comprising a UALink switch coupling the UALink port of the device to one or more remote accelerators, wherein the second memory is accessible via the UALink switch. The RPU may be implemented as an IP block embedded within the accelerator, or as a chiplet within an IC package containing the accelerator. The UALink switch may route UPLI traffic based on destination accelerator identifiers carried in the UPLI requests. The one or more remote accelerators may each have their own HBM, HBF, or other memory that collectively forms the second memory accessible from the device.

In computing environments where a host, such as a CPU, accesses memory resources on a device coupled via CXL, the device may expose memory regions to the host with different connectivity. A first memory region may be backed by local memory coupled to the device, while a second memory region may be backed by memory accessible via an NVLink fabric, such as memory residing on GPUs or other NVLink-connected devices. NVLink provides high-bandwidth communication between GPUs and accelerators, and may support distributed memory models where devices access memory via other devices. The device may translate between CXL protocol messages received from the host and NVLink messages for accessing memory in the NVLink domain, while exposing different CXL device type flows for different memory regions to provide appropriate coherency semantics. NVLink messages may carry fields such as source and destination identifiers for routing, addresses for memory location, transaction tags for response correlation, length fields for transfer size, and data payloads.

In various implementations, a method comprising: exposing, by a device coupled to a host via a Compute Express Link (CXL) link, a first memory region via a first CXL device type flow and a second memory region via a second CXL device type flow, wherein the first CXL device type flow is different from the second CXL device type flow; wherein the first memory region is associated with a first memory; wherein the second memory region is associated with a second memory accessible via an NVLink-based protocol; and translating, by the device, between a protocol based on CXL and the NVLink-based protocol for at least one of the first memory region or the second memory region. The method may be implemented in hardware, firmware, software, or combinations thereof, and may be performed by various types of devices, such as an accelerator, an RPU, a semiconductor device, an active cable, or a chiplet within an IC package. The first and second CXL device type flows may correspond to any combination of CXL Type-2 and Type-3 device flows. Translations between CXL and NVLink may include translations of opcodes, addresses, transaction identifiers, and additional fields. NVLink messages may carry functional fields corresponding to source identifiers, destination identifiers, addresses, transaction tags, transfer lengths, and data payloads; the specific field names may vary across NVLink versions or implementations, and the translation may accommodate such variations. The first memory may include memory coupled to the device, such as HBM and/or HBF, while the second memory may include memory accessible via GPUs or other NVLink-connected devices. The device may be positioned in an active cable, in a module coupled to a CXL port, or within a computing platform, and may provide a bridge between the CXL domain and the NVLink domain. The elements may communicate through one or more intermediary components, such as an NVLink switch or other suitable entity that facilitates information transfer.

In some implementations of the method, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region; and wherein the device participates in cache coherency with the host for the first memory region and does not participate in cache coherency with the host for the second memory region. The CXL Type-2 device flow may enable the device to maintain cached copies of data from the first memory and to participate in coherency negotiations with the host via CXL.cache. The CXL Type-3 device flow for the HDM-H region may enable simpler passthrough access to NVLink-accessible memory without device coherency overhead.

In some implementations, the method further comprises receiving, from the host, a CXL.mem Master-to-Subordinate (M2S) request comprising MemRd* and a first address targeting the second memory region; translating the CXL.mem M2S request to an NVLink read request comprising a SourceID, a DestinationID, a second address, a Tag, and a Length; receiving an NVLink read response comprising *Data*; and sending to the host a CXL.mem Subordinate-to-Master Data Response (S2M DRS) comprising MemData and data from the NVLink read response. The SourceID may identify the device or RPU that originated the NVLink read request, while the DestinationID may identify the target entity, such as a GPU, in the NVLink fabric. The second address may be an NVLink network address that may be utilized to route the NVLink read request to its destination, and may go through additional address translation phases facilitated by one or more Link TLBs in the NVLink domain. The Tag may be a transaction identifier maintained by the device for correlating the NVLink read response with the original CXL.mem M2S request. The Length may indicate the requested transfer size. The *Data* in the NVLink read response may represent data carried in one or more response packets. Different NVLink versions or implementations may use different naming conventions for these functional fields; for example, a source identifier may alternatively be referred to as a requester identifier, a source node identifier, or a similar designation, and a destination identifier may alternatively be referred to as a target identifier, a destination node identifier, or a similar designation.

In some implementations, the method further comprises receiving, from the host, a CXL.mem Master-to-Subordinate (M2S) request comprising MemRd* and an address targeting the first memory region; accessing the first memory to obtain data; and sending to the host a CXL.mem Subordinate-to-Master No Data Response (S2M NDR) comprising Cmp-S or Cmp-E indicating a cache state of a cacheline at the address, and a CXL.mem Subordinate-to-Master Data Response (S2M DRS) comprising MemData and the data. For the first memory region, the device may access local memory, such as HBM and/or HBF, without performing protocol translation to NVLink. The device may respond with Cmp-S or Cmp-E based on the device's caching policy and the host's requested coherency state as indicated by SnpType and MetaValue fields in the M2S request.

In some implementations of the method, for the first memory region, the device communicates with the host via CXL.cache; and wherein the device issues CXL.cache Device-to-Host (D2H) requests to the host comprising an opcode selected from RdOwn, RdShared, RdCurr, or RdAny. The CXL.cache D2H requests may enable the device to initiate coherency transactions with the host for data in the first memory region, such as when the device needs to read or modify data that the host may have cached.

In some implementations, the method further comprises translating, by the device, between a first address associated with a Host Physical Address (HPA) space utilized by the host and a second address associated with an NVLink network address space utilized by the NVLink-based protocol. The address translation may be implemented utilizing lookup tables, page tables, base-and-offset calculations, or programmable translation functions. The NVLink network address may be utilized to route NVLink transactions to specific GPUs or memory resources within the NVLink fabric.

In some implementations of the method, a non-transitory computer-readable medium comprising instructions which, when executed by a processor, cause the processor to perform the method.

In computing systems where a host accesses memory resources on a device coupled via CXL, the device may expose memory regions with different connectivity and coherency models. A first memory region may be backed by local memory coupled to the device, and may be exposed via a CXL device type flow that supports device coherency. A second memory region may be backed by memory accessible via an NVLink port, such as memory residing on GPUs or other NVLink-connected devices, and may be exposed via a different CXL device type flow. The device may include an RPU or translation logic configured to translate between CXL protocol messages and NVLink messages for memory access operations targeting the NVLink-accessible memory. An NVLink switch, such as NVSwitch, may couple the device to one or more GPUs whose memory resources form the second memory region.

In various implementations, a system comprising: a host; a device coupled to the host via a Compute Express Link (CXL) link; and a first memory coupled to the device; wherein the device is configured to expose to the host a first memory region via a first CXL device type flow and a second memory region via a second CXL device type flow, wherein the first CXL device type flow is different from the second CXL device type flow; wherein the first memory region is associated with the first memory; wherein the second memory region is associated with a second memory accessible via an NVLink port of the device; and wherein the device is configured to translate between a protocol based on CXL and an NVLink-based protocol for requests targeting at least one of the first memory region or the second memory region. The system may enable a host to access both local and NVLink-domain memory resources on the device through a CXL link, with differentiated coherency semantics for different memory regions. The device may include an RPU, translation logic, or a combination of hardware and firmware that translate between CXL and the NVLink-based protocol. The device may be an accelerator, an RPU, a bridge device, or a component within an active cable positioned between the CXL domain and the NVLink domain. The device may configure the boundaries between the first and second memory regions dynamically or statically, for example utilizing HDM decoder registers or programmable address range registers. The system may be deployed in datacenter environments where CXL-enabled CPUs participate with NVLink GPUs in inference or training of AI models.

In some implementations of the system, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region. The CXL Type-2 device flow may enable the device to negotiate CXL.io, CXL.cache, and CXL.mem for the HDM-D region, while the CXL Type-3 device flow may negotiate CXL.io and CXL.mem for the HDM-H region.

In some implementations of the system, for CXL.mem requests targeting the first memory region, the device is configured to send a CXL.mem Subordinate-to-Master No Data Response (S2M NDR) comprising Cmp-S or Cmp-E indicating a cache state; and for CXL.mem requests targeting the second memory region, the device is configured to translate the CXL.mem requests to NVLink read requests and send a CXL.mem Subordinate-to-Master Data Response (S2M DRS) comprising MemData. The differentiated response behavior may reflect the different coherency models of the first and second memory regions. For the first memory region, the Cmp-S or Cmp-E indication may inform the host of the cache state maintained by the device. For the second memory region, the device may translate the request to an NVLink read request, receive data from the NVLink domain, and return the data to the host.

In some implementations of the system, the device comprises an accelerator or a resource provisioning unit (RPU), and the first memory comprises at least one of High Bandwidth Memory (HBM) or High-Bandwidth Flash (HBF) coupled to the device; and further comprising an NVLink switch coupling the NVLink port of the device to one or more GPUs, wherein the second memory is accessible via the NVLink switch. The NVLink switch may be an NVSwitch or similar switch device that provides high-bandwidth routing between the device and GPUs within an NVLink fabric. The one or more GPUs may each have their own HBM, HBF, or other memory that collectively forms the second memory accessible from the device via the NVLink port.

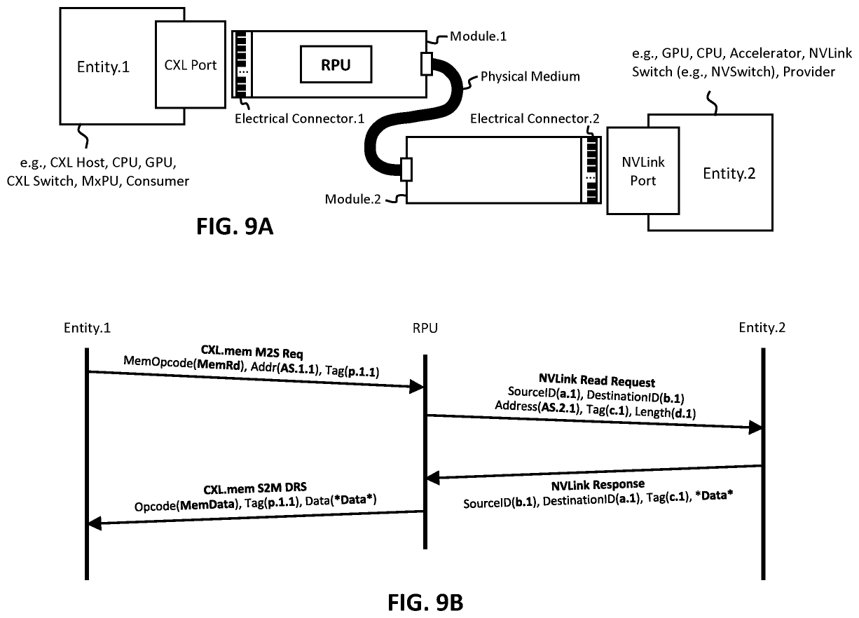

FIG. 9A illustrates an example of a system comprising an active cable that includes an RPU. The cable comprises a first pluggable module (Module.1) and a second pluggable module (Module.2) coupled by a Physical Medium. Module.1 includes the RPU and is coupled via a first electrical connector (Electrical Connector.1) to a CXL Port of a first entity (Entity.1). Module.2 is coupled via a second electrical connector (Electrical Connector.2) to an NVLink Port of a second entity (Entity.2). Entity.1 may be a CXL Host, CPU, GPU, CXL Switch, MxPU, or Consumer. Entity.2 may be a GPU, CPU, Accelerator, NVLink Switch (e.g., NVSwitch), or Provider. The RPU may be placed in various locations as a function of the requirements. In one example, the RPU is placed in Module.1 closer to the CXL Port of Entity.1, since CXL, which runs over PCIe electricals, is designed as a shorter-reach interface utilized for connecting devices to CPUs within a compute platform. Some versions of NVLink incorporate electrical signaling characteristics compatible with Ethernet and/or InfiniBand connectivity, designed for longer-reach interconnects that fit rack-level deployments and beyond. Placing the RPU closer to the CXL port may improve signal integrity. Additionally, NVLink typically utilizes a signaling rate higher than CXL, and consequently NVLink may require fewer lanes than CXL for the same bandwidth, which may allow for reducing the amount of copper wires or optical fibers in the Physical Medium.

FIG. 9B illustrates an example of a TFD demonstrating an RPU that translates between CXL.mem requests and NVLink requests. The TFD shows three entities: Entity.1/Consumer on the left, the RPU in the center, and Entity.2/Provider on the right. Entity.1 may send a CXL.mem M2S Req comprising MemOpcode(MemRd), Addr(AS.1.1), and Tag(p.1.1) to the RPU. Address (AS.1.1) may be an HPA of a Host, such as a CXL-enabled CPU coupled to the RPU. The RPU may translate the CXL.mem M2S Req to an NVLink Request Read comprising SourceID(a.1), DestinationID(b.1), Address(AS.2.1), Tag(c.1), and Length(d.1). Address (AS.2.1) may be an NVLink Network Address utilized to route the NVLink request to its destination on the NVLink fabric. In the response direction, Entity.2 may send an NVLink Response comprising SourceID(b.1), DestinationID(a.1), Tag(c.1), and *Data* to the RPU. The RPU may translate the NVLink Response to a CXL.mem S2M DRS comprising Opcode(MemData), Tag(p.1.1), and Data(*Data*), and may send the CXL.mem S2M DRS to Entity.1. The RPU may map the Tag from the NVLink response back to the original CXL.mem Tag (p.1.1) to enable proper transaction completion at Entity.1. In some examples, the NVLink Network Address may go through additional address translation phases, which may be facilitated by one or more Link TLBs residing on the transaction path. For example, in a GPU, a Link TLB may translate an NVLink Network Address to a GPU Physical Address that may reference memory resources integrated in or adjacent to the destination GPU. The RPU may perform another address translation to translate the HPA utilized by CXL.mem to the NVLink Network Address before the NVLink request is sent. Moreover, NVLink provides a distributed memory model where GPUs may access memory via other GPUs. This example provides a generic CXL.mem bridge/gateway for other, possibly non-NVLink compute elements, such as CPUs, to access memory residing on the NVLink Fabric, for example, where x86 GP-CPUs participate with NVLink GPUs in inference or training of AI models.

In AI inference systems, accelerators such as GPUs or TPUs may generate and consume large volumes of inference context data, including key-value (KV) cache data, model weight parameters, activation tensors, and embedding vectors. When the volume of inference context data exceeds the capacity of the accelerator's local memory, such as HBM, the data may be staged to external memory resources that provide larger capacity at lower cost, such as CXL memory devices, CXL memory pools, or GFDs. In environments where accelerators are coupled via a UALink switch and the CXL memory devices are accessible via CXL.mem, an RPU may translate between UPLI and CXL.mem to enable the accelerators to migrate inference context data between their local memory and the CXL memory devices across the UALink and CXL protocol domain boundaries. The accelerator may initiate migration by sending UPLI requests to the RPU via the UALink switch, and the RPU may translate these requests to CXL.mem M2S requests targeting the CXL memory device. The migration may be bidirectional: the accelerator may write inference context data to the CXL memory device when evicting data from local memory, and may read inference context data from the CXL memory device when the data is needed for active computation. The RPU may perform address translations between address spaces utilized by the UALink domain and the CXL domain, such as between NPA or SPA addresses and HPA addresses, and may further perform Tag and opcode translations between UPLI and CXL.mem message formats.

In various implementations, a method for migrating inference context data across protocol domain boundaries, comprising: sending, by an accelerator coupled to an Ultra Accelerator Link (UALink) switch, a UALink Protocol Level Interface (UPLI) request via the UALink switch to a resource provisioning unit (RPU), the UPLI request associated with the inference context data stored in a local memory of the accelerator, the UPLI request comprising a first physical address; translating, by the RPU, the UPLI request to a Compute Express Link (CXL) CXL.mem Master-to-Subordinate (M2S) request comprising a second physical address; and sending, by the RPU, the CXL.mem M2S request to a CXL memory device; wherein the inference context data is migrated between the local memory of the accelerator and the CXL memory device across a UALink protocol domain and a CXL protocol domain. The method may be utilized in AI inference systems where accelerator working memory, such as HBM, is insufficient to retain all inference context data simultaneously. The RPU may translate between UPLI and CXL.mem including translations of opcodes, commands, addresses, Tags, and additional fields. The migration may be performed by the accelerator without host intervention, such as when the accelerator determines that certain inference context data is no longer actively needed and may be offloaded to a lower-cost memory tier. Alternatively, the migration may be coordinated by a host or a scheduler that directs the accelerator to evict or fetch specific data. The UPLI request may include a write command when data is being evicted from local memory to the CXL memory device, carrying the inference context data on the UPLI Originator Data Channel. The UPLI request may alternatively comprise a read command when data is being fetched from the CXL memory device to local memory, in which case the data is returned via the CXL.mem S2M data response path and translated to a UPLI read response. The method may be implemented in hardware, firmware, software, or combinations thereof, and may be performed by various types of devices, such as a processor, a switch, a bridge, an RPU, or a semiconductor device.

In some implementations of the method, the inference context data comprises key-value (KV) cache data generated during attention computation in a transformer-based inference model, the KV cache data comprising key tensors and value tensors associated with one or more attention layers of the transformer-based inference model. The KV cache data may grow proportionally to the sequence length and the number of attention layers. As context lengths increase, the KV cache may consume a substantial portion of accelerator HBM, motivating migration of less-recently-accessed KV cache entries to CXL memory.

In some implementations of the method, the transformer-based inference model utilizes at least one of: (i) grouped query attention (GQA) wherein a plurality of query heads share a reduced number of key-value heads, or (ii) multi-latent attention (MLA) wherein the key tensors and the value tensors are compressed into a low-rank latent representation; and wherein the KV cache data corresponds to the reduced number of key-value heads or to the low-rank latent representation, respectively. GQA may reduce KV cache size by sharing key-value heads across multiple query heads, as utilized in models such as Llama. MLA may further compress the KV cache by projecting key and value tensors into a lower-dimensional latent space, as utilized in models such as DeepSeek. The reduced KV cache size per token may affect staging granularity and transfer efficiency.

In some implementations of the method, the inference context data comprises at least one of: model weight parameters, activation tensors generated during inference computation, or embedding vectors associated with an input sequence. Model weight parameters may be staged when different models or model components are loaded on demand, such as in multi-tenant serving or model-switching scenarios. Activation tensors may be checkpointed to CXL memory during long inference sequences. Embedding vectors, such as token embeddings or positional embeddings, may be pre-staged from CXL memory before inference begins.

In some implementations of the method, the accelerator executes a mixture-of-experts (MoE) inference model comprising a gating network and expert sub-networks, and wherein the inference context data comprises weight parameters of at least one expert sub-network of the expert sub-networks; and wherein the UPLI request is sent based on a routing decision of the gating network indicating that the at least one expert sub-network is to be activated or deactivated. In MoE models, only a subset of expert sub-networks may be active for any given input token. Inactive expert weights may be offloaded to CXL memory to free accelerator HBM capacity, and activated expert weights may be fetched from CXL memory when the gating network routes tokens to those experts. This dynamic staging may enable serving MoE models that are larger than the available HBM capacity.

In some implementations, the method further comprises sending, by the accelerator, a second UPLI request comprising a read command and a third physical address via the UALink switch to the RPU; translating, by the RPU, the second UPLI request to a second CXL.mem M2S request comprising a fourth physical address; sending, by the RPU, the second CXL.mem M2S request to the CXL memory device; receiving, by the RPU, a CXL.mem Subordinate-to-Master Data Response (S2M DRS) comprising second inference context data from the CXL memory device; translating, by the RPU, the CXL.mem S2M DRS to a UPLI read response (RdRsp) comprising the second inference context data; and sending, by the RPU, the UPLI RdRsp to the accelerator via the UALink switch; wherein the second inference context data is stored in the local memory of the accelerator. The fetch direction may be utilized when inference context data that was previously offloaded to the CXL memory device is needed again for active computation. The RPU may translate the CXL.mem S2M DRS, including by translating the Tag back to the original UPLI ReqTag and formatting the data as UPLI RdRspData. In some examples, the RPU may accumulate data from CXL.mem S2M DRS messages before sending a UPLI RdRsp, such as when the CXL.mem cacheline size differs from the UPLI transfer size.

In some implementations of the method, the CXL memory device comprises a Global Fabric-Attached Memory Device (GFD), the local memory comprises at least one of high-bandwidth memory (HBM) or High-Bandwidth Flash (HBF), the first physical address refers to a Network Physical Address (NPA) or a System Physical Address (SPA), and the second physical address refers to a Host Physical Address (HPA); and wherein the translating comprises translating the first physical address to the second physical address. The GFD may provide large-capacity memory accessible by both accelerators via the RPU and hosts via direct CXL.mem access. The address translation between NPA or SPA and HPA may be performed utilizing lookup tables, base-and-offset calculations, or programmable translation functions within the RPU.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In AI inference systems, a host such as a CPU may orchestrate the staging of inference context data between CXL memory devices and accelerators that reside in the UALink domain. The host may read inference context data from a CXL memory device via CXL.mem and write the data to an accelerator by sending a CXL.mem M2S request to an RPU, which translates the request to a UPLI request and forwards it to the accelerator via a UALink port. This host-initiated staging may be utilized in scenarios where the host manages a tiered memory hierarchy, determines which inference context data to pre-stage to accelerators based on scheduling policies, inference request queues, or predicted workload patterns, and coordinates data movement between the CXL and UALink protocol domains. The host may also orchestrate reading inference context data from accelerators via the RPU and writing it to CXL memory devices for longer-term retention. This bidirectional host-orchestrated staging may support a variety of inference architectures and model types, including transformer models with large KV caches, mixture-of-experts models with dynamic expert activation, disaggregated prefill and decode architectures, speculative decoding, hybrid attention and state-space models, multimodal models, and retrieval-augmented generation pipelines. In each case, the CXL memory device may serve as an intermediate staging area that bridges the capacity gap between accelerator working memory and the volume of inference context data associated with the workload.

In various implementations, a method for staging inference context data across protocol domain boundaries, comprising: reading, by a host, inference context data from a Compute Express Link (CXL) memory device via CXL.mem; sending, by the host, a CXL.mem Master-to-Subordinate (M2S) request to a resource provisioning unit (RPU), the CXL.mem M2S request associated with the inference context data and comprising a first physical address; translating, by the RPU, the CXL.mem M2S request to an Ultra Accelerator Link (UALink) Protocol Level Interface (UPLI) request comprising a second physical address; and sending, by the RPU, the UPLI request to an accelerator via a UALink port; wherein the inference context data is staged from the CXL memory device to a local memory of the accelerator across a CXL protocol domain and a UALink protocol domain. The host-initiated staging may enable the host to manage a tiered memory hierarchy comprising accelerator local memory as a working memory tier, host memory as an intermediate tier, and CXL memory devices as a capacity tier. The host may determine which inference context data to stage based on scheduling policies, inference request queues, or predictions about upcoming workload requirements. The RPU may be a discrete component, an IP block embedded in an accelerator, or a chiplet within an IC package. The CXL.mem M2S request may include a write command carrying the inference context data, and the translated UPLI request may carry the data on the UPLI Originator Data Channel to the accelerator. The RPU may perform address translations between HPA addresses utilized by the host and NPA or SPA addresses utilized by the UALink domain, and may further perform Tag and opcode translations between CXL.mem and UPLI message formats. The host may access the CXL memory device via CXL.mem without translation, and may access the accelerator via the RPU that translates between CXL.mem and UPLI. The method may be implemented in hardware, firmware, software, or combinations thereof.

In some implementations, the method further comprises reading, by the host, second inference context data from the accelerator, wherein the reading comprises the host sending a second CXL.mem M2S request to the RPU, the RPU translating the second CXL.mem M2S request to a second UPLI request comprising a read command and sending the second UPLI request to the accelerator via the UALink port, the RPU receiving a UPLI read response (RdRsp) comprising the second inference context data from the accelerator, and the RPU returning the second inference context data to the host; and writing, by the host, the second inference context data to the CXL memory device via CXL.mem. This direction may enable the host to evict inference context data from accelerator local memory to the CXL memory device when the data is no longer actively needed or when the local memory capacity is exceeded. The host may coordinate both staging and eviction to maintain a working set of inference context data in accelerator local memory that matches the current workload.

In some implementations of the method, the accelerator executes a mixture-of-experts (MoE) inference model comprising a gating network and expert sub-networks, and the second inference context data comprises weight parameters of an inactive expert sub-network of the expert sub-networks, the inactive expert sub-network identified based on a routing decision of the gating network. Evicting inactive expert weights to CXL memory may free accelerator HBM capacity for the active experts, enabling the system to serve MoE models whose total expert weight parameters exceed the HBM capacity.

In some implementations of the method, the second inference context data comprises key-value (KV) cache entries that have been evicted from the local memory of the accelerator based on at least one of: an access frequency, an access recency, or the KV cache entries exceeding a capacity of the local memory. Long-context inference models may generate KV cache entries that exceed the accelerator HBM capacity. Eviction policies based on access frequency or recency may retain the most relevant KV cache entries in HBM while offloading less-accessed entries to CXL memory for potential later retrieval.

In some implementations of the method, the inference context data comprises key-value (KV) cache data associated with a transformer-based inference model, and wherein the host stages the KV cache data from the CXL memory device to the local memory of the accelerator based on a scheduled inference request or a predicted inference request. The host may maintain a scheduling queue of inference requests and may pre-stage KV cache data associated with upcoming requests to reduce latency when the request is dispatched to the accelerator. Prediction of upcoming requests may be based on session affinity, user activity patterns, or model serving policies.

In some implementations of the method, the accelerator comprises a decode accelerator, the inference context data comprises key-value (KV) cache data generated during a prefill phase of an inference operation by a prefill accelerator, and the KV cache data is staged from the CXL memory device to the local memory of the decode accelerator for use in a decode phase of the inference operation; and wherein the CXL memory device serves as an intermediate storage between the prefill accelerator and the decode accelerator. In disaggregated inference architectures, the prefill phase and the decode phase may be performed by different accelerators to optimize resource utilization. The prefill accelerator may write the generated KV cache data to the CXL memory device, and the host may subsequently stage the KV cache data from the CXL memory device to the decode accelerator. The CXL memory device may thus serve as a shared staging area that decouples the prefill and decode phases across protocol domain boundaries.

In some implementations of the method, the accelerator performs speculative decoding comprising a draft model generating candidate token sequences and a verification model accepting or rejecting the candidate token sequences, and wherein the inference context data comprises at least one of: draft model weight parameters, draft model KV cache data, or verification context data associated with the speculative decoding. Speculative decoding may utilize a smaller draft model to generate candidate tokens that a larger verification model subsequently accepts or rejects. The draft model weight parameters or the draft model KV cache data may be staged from CXL memory to accelerator HBM when speculative decoding is activated for a given inference session.

In some implementations of the method, the inference context data comprises state data associated with a hybrid inference model, the hybrid inference model comprising attention layers that generate key-value (KV) cache data and state-space model layers that maintain recurrent state vectors; and wherein the staging comprises staging at least one of the KV cache data or the recurrent state vectors from the CXL memory device to the local memory of the accelerator. Hybrid models, such as those combining attention layers with Mamba-style state-space model (SSM) layers, may maintain both KV cache data for attention layers and recurrent state vectors for SSM layers. The staging may include both data types, which may have different sizes, access patterns, and staging priorities.

In some implementations of the method, the inference context data comprises visual embeddings generated by an image encoder or a video encoder of a multimodal inference model; and wherein the staging comprises staging the visual embeddings from the CXL memory device to the local memory of the accelerator for processing alongside text token embeddings by the multimodal inference model. Multimodal inference models may process both visual and textual inputs. Visual embeddings generated by an image or video encoder may be large and may be pre-computed and stored in CXL memory, then staged to the accelerator when a multimodal inference request is dispatched.

In some implementations of the method, the inference context data comprises pre-computed embeddings associated with retrieved documents in a retrieval-augmented generation (RAG) pipeline; and wherein the staging comprises staging the pre-computed embeddings from the CXL memory device to the local memory of the accelerator for concatenation with an input query during inference. In RAG pipelines, retrieved document embeddings may be pre-computed and stored in the CXL memory device as a large-capacity embedding store. When a query triggers retrieval, the relevant embeddings may be staged from the CXL memory device to the accelerator for concatenation with the query tokens before the generation phase.

In some implementations of the method, the inference context data comprises key-value (KV) cache entries associated with token positions in an input sequence, and the staging comprises staging a subset of the KV cache entries from the CXL memory device to the local memory of the accelerator, the subset selected based on the token positions being predicted to be accessed during a subsequent inference step; and wherein remaining KV cache entries associated with remaining token positions are retained in the CXL memory device. For long-context inference, the host may stage only the KV cache entries associated with token positions predicted to be attended during the next decoding step, retaining the remaining entries in CXL memory. This selective staging may reduce transfer volume and accelerator memory pressure while maintaining the full context available for on-demand retrieval.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In AI inference deployments, a system may include a cluster of accelerators coupled via a UALink switch, one or more CXL memory devices providing large-capacity memory, an RPU that translates between UPLI and CXL.mem, and a host that orchestrates workload scheduling and data movement. Such a system may be configured to migrate inference context data between accelerator local memory and the CXL memory devices across the UALink and CXL protocol domain boundaries, enabling the system to serve inference workloads whose aggregate inference context data exceeds the capacity of any single accelerator's local memory. The host may access the CXL memory devices via CXL.mem, while the accelerators access the same CXL memory devices via the RPU that translates between UPLI and CXL.mem. This architecture may support tiered memory management, where inference context data is staged between accelerator HBM, HBF, host memory, and CXL memory based on access patterns, scheduling policies, or memory capacity constraints.

In various implementations, a system comprising: an Ultra Accelerator Link (UALink) switch; accelerators coupled to the UALink switch, each accelerator of the accelerators comprising a local memory; a Compute Express Link (CXL) memory device; a resource provisioning unit (RPU) coupled to the UALink switch and to the CXL memory device, the RPU configured to translate between UALink Protocol Level Interface (UPLI) and CXL.mem; and a host coupled to the CXL memory device via CXL.mem; wherein the system is configured to migrate inference context data between the local memory of at least one accelerator of the accelerators and the CXL memory device across a UALink protocol domain and a CXL protocol domain. The system may enable both accelerator-initiated and host-initiated data migration across the protocol domain boundaries. The accelerators may communicate with one another and with the RPU via the UALink switch utilizing UPLI, while the host may communicate with the CXL memory device utilizing CXL.mem. The RPU may be implemented as a discrete component coupled to the UALink switch, as an IP block embedded within one of the accelerators, or as a chiplet within an IC package. The system may support various inference workloads, and the inference context data may include KV cache data, model weight parameters, activation tensors, embedding vectors, or other data generated or consumed during inference computation. The CXL memory device may include a CXL memory expander, a CXL memory pool, or a GFD.

In some implementations of the system, the at least one accelerator is configured to initiate migration of the inference context data by sending a UPLI request via the UALink switch to the RPU, and the RPU is configured to translate the UPLI request to a CXL.mem M2S request and send the CXL.mem M2S request to the CXL memory device. The accelerator may determine when to migrate inference context data based on local memory capacity utilization, access patterns, or workload scheduling signals received from the host or from other accelerators.

In some implementations of the system, the local memory comprises a first memory tier, the system further comprises host memory coupled to the host, the host memory comprising a second memory tier, and the CXL memory device comprises a third memory tier; and wherein the inference context data is migrated between the first memory tier and the third memory tier based on at least one of: access frequency, access recency, a capacity of the first memory tier, or a scheduling policy of the host. The tiered memory hierarchy may enable the system to retain actively-accessed inference context data in the highest-bandwidth tier (accelerator local memory) while staging less-accessed data to lower-cost, higher-capacity tiers (CXL memory). The second memory tier (host memory) may serve as an intermediate staging buffer.

In some implementations, the system further comprises a second CXL memory device and a CXL fabric coupling the RPU to the CXL memory device and the second CXL memory device; wherein at least one of the CXL memory device or the second CXL memory device comprises at least one of: a CXL memory expander, a CXL memory pool, or a Global Fabric-Attached Memory Device (GFD). The CXL fabric may include one or more CXL switches and may provide connectivity between the RPU and CXL memory devices. The RPU may route translated requests to specific CXL memory devices based on the physical addresses carried in the UPLI requests.

In some implementations of the system, the inference context data comprises key-value (KV) cache data associated with a transformer-based inference model, the local memory comprises high-bandwidth memory (HBM), and the at least one accelerator comprises at least one of: a graphics processing unit (GPU) or a tensor processing unit (TPU). GPUs and TPUs are accelerators commonly utilized for transformer-based inference workloads that generate substantial KV cache data. HBM provides the high-bandwidth, low-latency access needed for active inference computation, while the CXL memory device may provide the additional capacity needed for KV cache entries that are not actively accessed.

In environments where accelerators communicate utilizing NVLink-based protocols, such as GPUs coupled via NVLink or NVSwitches, the accelerators may similarly need to migrate inference context data to CXL memory devices that reside in a different protocol domain. An RPU may translate between NVLink-based protocol messages and CXL.mem messages to enable accelerators in the NVLink domain to stage inference context data to and from CXL memory devices. The RPU may be integrated into an active cable, an NVSwitch, or a discrete bridge device, and may perform address translations between NVLink addresses and CXL.mem addresses, as well as command and Tag translations between the two protocol domains. This NVLink-to-CXL.mem translation path may enable heterogeneous computing environments where different clusters of accelerators utilize different interconnect protocols while sharing access to common CXL memory resources.

In various implementations, a method for migrating inference context data across protocol domain boundaries, comprising: sending, by an accelerator, a request conforming to an NVLink-based protocol to a resource provisioning unit (RPU), the request associated with the inference context data stored in a local memory of the accelerator, the request comprising a first physical address; translating, by the RPU, the request to a Compute Express Link (CXL) CXL.mem Master-to-Subordinate (M2S) request comprising a second physical address; and sending, by the RPU, the CXL.mem M2S request to a CXL memory device; wherein the inference context data is migrated between the local memory of the accelerator and the CXL memory device across an NVLink protocol domain and a CXL protocol domain. The method may enable accelerators communicating according to an NVLink-based protocol to access CXL memory resources for staging inference context data. The RPU may translate between NVLink-based protocol messages and CXL.mem messages, including translations of addresses, commands, and identifiers. The first physical address may be an NVLink Network Address, and the second physical address may be an HPA utilized by the CXL memory device. The RPU may be integrated into an active cable, an NVSwitch, or a discrete bridge device. In some examples, the RPU may be positioned closer to the CXL port to optimize signal integrity, since CXL runs over PCIe electricals designed for shorter-reach connectivity while NVLink may incorporate signaling characteristics compatible with longer-reach interconnects.

In some implementations of the method, the accelerator is coupled to the RPU via an NVLink switch (NVSwitch), and the request conforming to the NVLink-based protocol is sent via the NVSwitch to the RPU. The NVSwitch may route the NVLink-based request from the accelerator to the RPU based on routing information carried in the request. The NVSwitch may couple accelerators to the RPU, enabling accelerators within the NVLink domain to access the CXL memory device for inference context data staging.

In some implementations of the method, the inference context data comprises key-value (KV) cache data generated during attention computation in a transformer-based inference model, and the local memory comprises high-bandwidth memory (HBM). KV cache data generated by NVLink-coupled accelerators during transformer-based inference may be staged to CXL memory devices when the KV cache exceeds the HBM capacity.

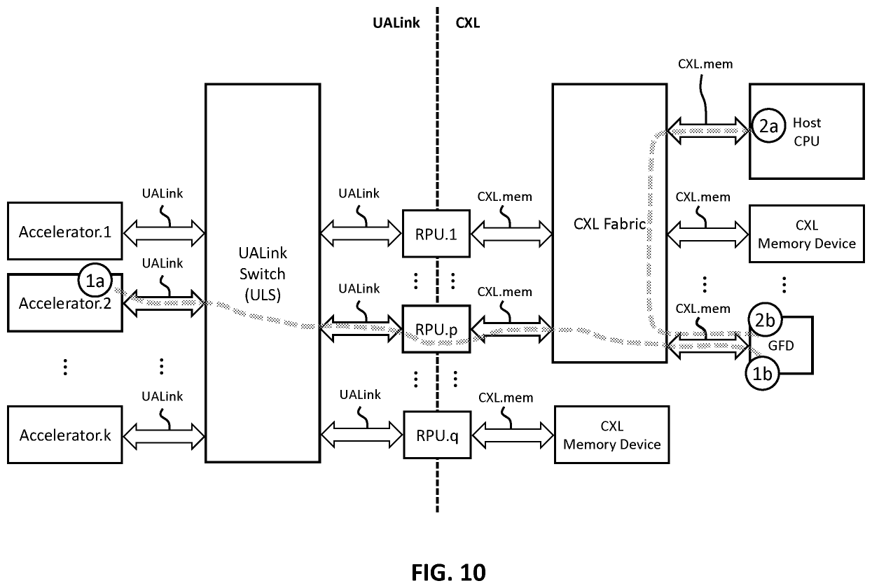

FIG. 10 illustrates an example of a system comprising a cluster of accelerators (e.g., GPUs or TPUs) interconnected by a UALink switch, an RPU coupled to the UALink switch, CXL memory devices coupled to the RPU via a CXL fabric, and a host coupled to the CXL memory devices via CXL.mem. Path 1a to 1b illustrates an accelerator-initiated data migration path. Accelerator.2 sends a UPLI request via the UALink switch to RPU.p. RPU.p translates the UPLI request to a CXL.mem M2S request and sends the CXL.mem M2S request to a GFD via the CXL fabric. The RPU may translate addresses between the UALink address space (e.g., NPA or SPA) and the CXL address space (e.g., HPA), and may translate opcodes, Tags, and additional fields between UPLI and CXL.mem message formats. In the write direction, the accelerator may evict inference context data from its local memory, such as HBM and/or HBF, to the GFD by sending a UPLI write request carrying the data on the Originator Data Channel. In the read direction, the accelerator may fetch inference context data from the GFD by sending a UPLI read request, and the RPU may receive a CXL.mem S2M DRS from the GFD, translate the CXL.mem S2M DRS to a UPLI RdRsp, and return the data to the accelerator via the UALink switch.

Path 2a to 2b illustrates a host-initiated access path. The host accesses the GFD via CXL.mem, without translation by the RPU. The host may read inference context data from the GFD via CXL.mem, and may subsequently write the inference context data to an accelerator by sending a CXL.mem M2S RwD to the RPU, which translates the CXL.mem M2S request to a UPLI request and sends the UPLI request to the accelerator via the UALink switch. Conversely, the host may read inference context data from an accelerator by sending a CXL.mem M2S request to the RPU, which translates the request to a UPLI read request, receives a UPLI RdRsp from the accelerator, and returns the data to the host; the host may then write the data to the GFD via CXL.mem. The host may thus orchestrate bidirectional data staging between the CXL memory devices and the accelerators across the CXL and UALink protocol domain boundaries.

In one example, the host may bring inference context data, such as KV cache data, from storage (e.g., NVMe or remote storage) into a CXL memory device such as the GFD. The accelerator may then fetch the KV cache data from the GFD to its local memory (e.g., HBM and/or HBF) for active inference computation. When the KV cache data is no longer actively accessed, or when the local memory capacity is exceeded, the accelerator may migrate the colder KV cache data from its HBM back to the GFD. In this manner, the system may maintain a tiered memory hierarchy where the accelerator HBM serves as a working memory tier for actively-accessed inference context data, and the CXL memory device serves as a capacity tier for less-frequently-accessed inference context data. The RPU may enable the data migration between these tiers by translating between UPLI and CXL.mem across the protocol domain boundaries.

The CXL memory devices shown in FIG. 10 may include CXL memory expanders, CXL memory pools, or GFDs, and may be coupled to the RPU via the CXL fabric, which may include one or more CXL switches. The RPU may route translated requests to specific CXL memory devices based on the physical addresses carried in the translated CXL.mem M2S requests. The system may support various types of inference context data, including KV cache data associated with transformer-based models, model weight parameters associated with mixture-of-experts models, activation tensors, embedding vectors, and other data generated or consumed during inference computation.

In environments where entities may utilize different protocols while requiring access to shared memory resources, there may be scenarios where a first entity communicating according to UPLI, such as an accelerator or a UALink switch, needs to access memory resources residing in a CXL domain, such as host memory accessible via a CXL host. An RPU or other suitable device may translate between UPLI and CXL.cache to facilitate memory operations across different protocol domains. The translation may involve converting UPLI requests comprising read or write commands to CXL.cache D2H requests comprising corresponding read or write opcodes, and converting CXL.cache H2D data messages and responses to UPLI read responses, including translations of addresses, Tags, CQIDs, and data formats.

In various implementations, a method comprising: receiving, from a first entity, an Ultra Accelerator Link Protocol Level Interface (UPLI) request comprising a read command; translating, by a Resource Provisioning Unit (RPU), the UPLI request to a CXL.cache Device-to-Host (D2H) request comprising a read opcode, wherein CXL denotes Compute Express Link; sending the CXL.cache D2H request to a second entity; receiving, from the second entity, a CXL.cache Host-to-Device (H2D) data message; translating, by the RPU, the CXL.cache H2D data message to a UPLI read response; and sending the UPLI read response to the first entity. The method translates between UPLI and CXL.cache domains. The RPU receives UPLI requests containing read commands which may include Read commands, AtomicR commands, Vendor Defined Commands with read data returned over the UPLI read response/data (Rd Rsp/Data) Channel, or other read command types supported by UPLI. The RPU translates these read commands into corresponding CXL.cache read opcodes such as RdCurr, RdOwn, RdShared, or RdAny. The translation adapts the operation to the requirements and capabilities of the domain. Upon receiving data responses from the CXL host, the RPU translates the data for the originator, which enables communication between the UPLI and CXL domains while abstracting the protocol differences from both sides.

In some implementations of the method, the UPLI request comprises a source accelerator identifier and a destination accelerator identifier, and the UPLI read response comprises a destination accelerator identifier carrying a value that matches the source accelerator identifier from the UPLI request, and wherein the RPU saves at least the source accelerator identifier from the UPLI request for use in generating the UPLI read response. In some examples, the UPLI request includes identifiers that specify both the source and destination accelerators. The RPU saves at least the source accelerator identifier upon receiving the UPLI request. When generating the UPLI read response, the RPU uses the saved source accelerator identifier from the request as the destination accelerator identifier in the response for proper message routing back to the original requester. In some examples, the RPU may also save the destination accelerator identifier from the UPLI request, and include a source accelerator identifier in the UPLI read response, such as for debugging purposes, however such inclusion is not required for basic functionality.

In some implementations of the method, the UPLI request further comprises a first address and a first Tag, the CXL.cache D2H request comprises a second address translated from the first address and a command queue identifier (CQID) associated with the first Tag, and the UPLI read response comprises the first Tag. In some examples, the RPU performs address translation between physical addresses within UALink address space and physical addresses within CXL.cache address space while maintaining correlations between requests and responses utilizing Tag/CQID mapping. The RPU translates the UALink address to a corresponding CXL.cache address based on configured address mappings. Additionally, the RPU maintains a mapping between UPLI Tags and CXL.cache CQIDs to properly associate responses with their originating requests. This mapping enables the RPU to include the original UPLI Tag in the UPLI read response, allowing the originator to correlate responses with its outstanding requests.

In some implementations of the method, the UPLI request further comprises a length field indicating an amount of data requested; and wherein translating the UPLI request comprises generating multiple CXL.cache D2H requests when the amount of data requested exceeds a maximum CXL.cache transaction size. The RPU may handle UPLI requests that specify data transfers larger than what a CXL.cache transaction can support. The length field in the UPLI request indicates the amount of data requested, which can be up to 256 bytes, while CXL.cache transactions typically handle up to 64 bytes each. When the requested data size exceeds the CXL.cache transaction size limit, the RPU may segment the request into multiple CXL.cache transactions. For example, a 256-byte UPLI request would be translated into four 64-byte CXL.cache transactions, and the RPU manages these multiple transactions while maintaining the appearance of a single operation to the originator.

In some implementations of the method, the UPLI request comprises a Tag, the CXL.cache D2H requests comprise command queue identifiers (CQIDs); and wherein generating the multiple CXL.cache D2H requests comprises associating multiple CQIDs with the Tag. When handling large data transfers that require multiple CXL.cache transactions, the RPU may implement Tag-to-CQID mapping. For a UPLI comprising one Tag, the RPU may generate and track multiple CQIDs, one for each CXL.cache transaction. For example, if a UPLI request comprising Tag #1 requires four CXL.cache transactions, the RPU may generate CQIDs #1 through #4, maintaining mappings between the CQIDs and the original Tag #1. This mapping enables the RPU to associate the relevant CXL.cache responses with the original UPLI request and generate a consolidated response.

In some implementations of the method, translating the CXL.cache H2D data message further comprises: receiving multiple CXL.cache H2D data messages corresponding to the multiple CXL.cache D2H requests, aggregating data from the multiple CXL.cache H2D data messages, and including the aggregated data in the UPLI read response. When handling large data transfers that were split into multiple CXL.cache transactions, the RPU may perform data aggregation before generating the UPLI read response. The RPU receives multiple CXL.cache H2D data messages collectively containing the requested data, which are collected and optionally reassembled in a predetermined order to form a complete data payload. The RPU may manage this aggregation process while maintaining data integrity and proper ordering, such that the originator receives a single, coherent response containing the requested data.

In some implementations of the method, the read opcode of the CXL.cache D2H request is RdCurr, and processing the CXL.cache D2H request does not change existing state in a cache accessible to the RPU. In some examples, the RPU translates the UPLI read command into a CXL.cache D2H request comprising RdCurr, thereby indicating that the memory read is performed using a current state read function, which means that the RPU either does not issue cache commands, or processing the CXL.cache RdCurr request does not change existing state in a cache accessible to the RPU.

In some implementations of the method, the read command is selected from at least one of: a Read command, an AtomicR command, or a Vendor Defined Command with read data returned over a UPLI read response/data (Rd Rsp/Data) Channel; and wherein the read opcode is selected from at least one of: RdCurr, RdOwn, RdShared, or RdAny. The RPU may support translation between various types of read commands in the UPLI domain and read opcodes in the CXL domain. The UPLI read commands may include one or more of memory reads, atomic operations that provide atomicity guarantees, and/or Vendor Defined read commands for custom functionality. The UPLI read commands are translated to appropriate CXL.cache read opcodes based on the operation's requirements. For example, RdCurr requests the current value without changing cache states, RdOwn obtains exclusive ownership, RdShared enables shared access, and RdAny allows flexible coherency state transitions.

In some implementations of the method, the CXL.cache H2D data message comprises first data in a first format; and wherein translating the CXL.cache H2D data message comprises transforming the first data to second data in a second format for the UPLI read response. The RPU may need to transform data between different formats as it moves between UPLI and CXL.cache domains, which may involve changes in data organization, alignment, or representation. The RPU can maintain data integrity while performing the applicable format conversions to meet the requirements of the protocol. The first format may be optimized for CXL.cache operations, while the second format adheres to UPLI specifications for data transfer.

In some implementations, the method further comprises receiving, from the first entity, a UPLI request comprising a write command and write data; translating, by the RPU, the UPLI request comprising the write command to a CXL.cache D2H request comprising a write opcode selected from at least one of: DirtyEvict, ItoMWr, WrCur, or WrInv; and sending the CXL.cache D2H request comprising the write opcode and the write data to the second entity; wherein the first entity comprises a UPLI originator, an accelerator, or a UALink switch; and wherein the second entity comprises a CXL host; and wherein the RPU comprises a CXL device exposing a CXL endpoint to the second entity. The RPU may translate UPLI write commands to CXL.cache D2H write opcodes. DirtyEvict may be utilized when evicting a modified cacheline from the RPU, ItoMWr may be utilized for write operations that upgrade the cacheline from Invalid to Modified state, WrCur may write to a cacheline on a cache hit or to memory on a cache miss, and WrInv may write data while invalidating the cacheline. In some examples, the first entity may be a UPLI originator, such as an accelerator or a UALink switch, that initiates the write transaction, and the second entity may be a CXL host that receives the translated CXL.cache D2H write request. The RPU may expose a CXL endpoint, such as a Type-1 or Type-2 CXL device, to the CXL host for CXL.cache communication.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

An apparatus may include a first interface configured to communicate according to UPLI and a second interface configured to communicate according to CXL.cache, with a computer coupled to both interfaces and configured to translate between the two protocol domains. The apparatus may be implemented as a discrete component, an IP block embedded within an accelerator or a processor, a chiplet within an IC package, or may be integrated into an active cable. The computer may maintain mappings between UPLI Tags and CXL.cache CQIDs, perform address translations between UALink and CXL address spaces, and aggregate data from multiple CXL.cache transactions when a UPLI request exceeds a maximum CXL.cache transaction size. The first interface may include a UPLI completer that receives UPLI requests from a UPLI originator.

In various implementations, an apparatus comprising: a first interface configured to communicate according to an Ultra Accelerator Link Protocol Level Interface (UPLI); a second interface configured to communicate according to CXL.cache, wherein CXL denotes Compute Express Link; and a computer coupled to the first interface and the second interface, the computer configured to: translate a UPLI request comprising a read command, received via the first interface, to a CXL.cache Device-to-Host (D2H) request comprising a read opcode, and send the CXL.cache D2H request via the second interface; and translate a CXL.cache Host-to-Device (H2D) data message, received via the second interface, to a UPLI read response, and send the UPLI read response via the first interface.

In some implementations of the apparatus, the UPLI request comprises a source accelerator identifier and a destination accelerator identifier, the UPLI read response comprises a destination accelerator identifier carrying a value that matches the source accelerator identifier from the UPLI request; and wherein the computer is configured to save at least the source accelerator identifier from the UPLI request for use in generating the UPLI read response. In some examples, the computer processes identifier information embedded in UPLI messages by saving at least the source accelerator identifiers from incoming UPLI requests, and generating UPLI read responses by using the saved source accelerator identifier as the destination accelerator identifier in the response for proper message routing back to the original requester. Optionally, the computer may also save the destination accelerator identifier from the UPLI request, and include a source accelerator identifier in the UPLI read response, such as for debugging purposes, however such inclusion is not required for basic functionality.

In some implementations of the apparatus, the UPLI request further comprises a first address and a first Tag, the CXL.cache D2H request comprises a second address translated from the first address and a command queue identifier (CQID) associated with the first Tag, and the UPLI read response comprises the first Tag; and wherein the computer is further configured to receive, via the second interface, a CXL.cache H2D response comprising a Global Observation (GO) opcode and the CQID, the GO opcode indicating a cache coherency state. In some examples, the computer performs address translation between physical addresses within UALink address space and physical addresses within CXL.cache address space, while maintaining correlations between requests and responses utilizing Tag/CQID mapping. The computer translates the UALink address to a corresponding CXL.cache address based on configured address mappings. Additionally, the computer maintains a mapping between UPLI Tags and CXL.cache CQIDs to properly associate responses with their originating requests. This mapping enables the computer to include the original UPLI Tag in the UPLI read response, allowing the originator to correlate responses with its outstanding requests.

In some implementations of the apparatus, the UPLI request further comprises a length field indicating an amount of data requested; and wherein the computer is further configured to generate multiple CXL.cache D2H requests when the amount of data requested exceeds a maximum CXL.cache transaction size. The computer may handle UPLI requests that specify data transfers larger than what a single CXL.cache transaction can support. The length field in the UPLI request indicates the amount of data requested, which can be up to 256 bytes, while CXL.cache transactions typically handle up to 64 bytes each. When the requested data size exceeds the CXL.cache transaction size limit, the computer may segment the request into multiple CXL.cache transactions. For example, a 256-byte UPLI request would be translated into four 64-byte CXL.cache transactions, and the computer manages these multiple transactions while maintaining the appearance of a single operation to the originator.

In some implementations of the apparatus, the UPLI request comprises a Tag, the CXL.cache D2H requests comprise command queue identifiers (CQIDs); and wherein the computer is further configured to associate multiple CQIDs with the Tag when generating the multiple CXL.cache D2H requests. When handling large data transfers that require multiple CXL.cache transactions, the computer may implement Tag-to-CQID mapping. For a UPLI request comprising one Tag, the computer may generate and track multiple CQIDs, one for each CXL.cache transaction. This mapping enables the computer to associate the relevant CXL.cache responses with the original UPLI request and generate a consolidated response.

In some implementations of the apparatus, the computer is further configured to: receive multiple CXL.cache H2D data messages corresponding to the multiple CXL.cache D2H requests, aggregate data from the multiple CXL.cache H2D data messages, and include the aggregated data in the UPLI read response. When handling large data transfers that were split into multiple CXL.cache transactions, the computer may perform data aggregation before generating the UPLI read response. The computer receives multiple CXL.cache H2D data messages collectively containing the requested data, which are collected and optionally reassembled in a predetermined order to form a complete data payload. The computer may manage this aggregation process while maintaining data integrity and proper ordering, such that the originator receives a single, coherent response containing the requested data.

In some implementations of the apparatus, the read opcode of the CXL.cache D2H request is RdCurr, and as a result of processing the CXL.cache D2H request the computer is further configured not to change existing state in a cache accessible to the computer. In some examples, the computer translates the UPLI read command into a CXL.cache D2H request comprising RdCurr, thereby indicating that the memory read is performed using a current state read function. In some examples, the apparatus either does not issue cache commands, or when processing the CXL.cache RdCurr request it retrieves data in a manner that does not alter the existing state in a cache accessible to the apparatus.

In some implementations of the apparatus, the read command is selected from at least one of: a Read command, an AtomicR command, or a Vendor Defined Command with read data returned over a UPLI read response/data (Rd Rsp/Data) Channel; and wherein the read opcode is selected from at least one of: RdCurr, RdOwn, RdShared, or RdAny. The computer may support translation between various types of read commands in the UPLI domain and read opcodes in the CXL domain. The UPLI read commands may include one or more of memory reads, atomic operations that provide atomicity guarantees, and/or Vendor Defined read commands for custom functionality. The UPLI read commands are translated to appropriate CXL.cache read opcodes based on the operation's requirements. For example, RdCurr requests the current value without changing cache states, RdOwn obtains exclusive ownership, RdShared enables shared access, and RdAny allows flexible coherency state transitions.

In some implementations of the apparatus, the CXL.cache H2D data message comprises first data in a first format; and wherein the computer is further configured to transform the first data to second data in a second format for the UPLI read response. The computer may need to transform data between different formats as it moves between UPLI and CXL.cache domains, which may involve changes in data organization, alignment, or representation. The computer can maintain data integrity while performing the applicable format conversions to meet the protocol requirements. The first format may be optimized for CXL.cache operations, while the second format adheres to UPLI specifications for data transfer.

In some implementations of the apparatus, the computer is further configured to: translate a UPLI request comprising a write command and write data, received via the first interface, to a CXL.cache D2H request comprising a write opcode selected from at least one of: DirtyEvict, ItoMWr, WrCur, or WrInv; and send the CXL.cache D2H request comprising the write opcode and the write data via the second interface; wherein the first interface comprises a UPLI completer. The computer may translate UPLI write commands to CXL.cache D2H write opcodes. The first interface may include a UPLI completer, which may receive UPLI requests from a UPLI originator, such as an accelerator or a UALink switch.

In some implementations of the apparatus, the apparatus comprises a chiplet within an integrated circuit (IC) package of a processor, the processor comprising a coherent interconnect coupling processing cores to a memory controller; and wherein the second interface is coupled to the coherent interconnect via a CXL root port; whereby the computer translates UPLI requests to CXL.cache D2H requests that traverse the coherent interconnect to access memory coupled to the memory controller. The apparatus may be implemented as a chiplet within an IC package of a processor, such as an MxPU. The coherent interconnect, such as a ring or mesh interconnect, may couple processing cores, an LLC, a CXL RP, and a memory controller. The computer may utilize CXL.cache as an intermediate protocol for translating between UPLI and a protocol utilized by the coherent interconnect. The CXL root port may be included in the chiplet or may be part of the processor, and may communicate with the coherent interconnect via a Ring-to-CXL (R2CXL) interconnect interface.

In some implementations of the apparatus, an active cable comprising: a first pluggable module coupled to a first physical medium, a second pluggable module coupled to a second physical medium, and an apparatus according to claim 13 coupling the first and second physical media.

In AI inference environments, accelerators may execute neural network models whose aggregate data requirements exceed the capacity of the accelerator's local memory. Model data such as expert weights, KV cache entries, and attention parameters may be stored in host memory and fetched on demand during inference. An RPU may translate between UPLI utilized by the accelerator and CXL.cache utilized by the host, enabling the accelerator to read model data from the host memory and write inference context data back to the host memory across the protocol domain boundary.

In various implementations, a method comprising: executing, by an accelerator comprising local memory, an inference workload on a neural network model; sending, by the accelerator, an Ultra Accelerator Link Protocol Level Interface (UPLI) request comprising a read command for model data stored in a host memory of a host; translating, by a Resource Provisioning Unit (RPU), the UPLI request to a CXL.cache Device-to-Host (D2H) request comprising a read opcode, wherein CXL denotes Compute Express Link; sending the CXL.cache D2H request to the host; receiving, from the host, a CXL.cache Host-to-Device (H2D) data message comprising the model data; translating, by the RPU, the CXL.cache H2D data message to a UPLI read response comprising the model data; and sending the UPLI read response to the accelerator. The method enables an accelerator executing an inference workload to access model data stored in a host memory via the RPU. The RPU translates between the UPLI domain utilized by the accelerator and the CXL.cache domain utilized by the host, enabling the accelerator to extend its accessible memory capacity beyond the local memory. The model data may include neural network weights, activation data, intermediate computation results, or other data associated with inference processing. The host memory may provide larger capacity than the accelerator's local memory, and the RPU may bridge the two protocol domains to enable memory capacity expansion for inference workloads.

In some implementations of the method, the model data comprises at least one of: expert weights associated with a Mixture-of-Experts (MoE) model, the expert weights fetched from the host memory when a gating network of the MoE model routes one or more tokens to an expert; key-value (KV) cache entries previously offloaded from the local memory to the host memory during inference of a sequence; or attention parameters associated with a transformer-based model. In MoE models, only a subset of expert sub-networks may be active for any given input token. Inactive expert weights may be offloaded to the host memory to free accelerator local memory capacity, and activated expert weights may be fetched from the host memory when the gating network routes tokens to those experts. KV cache entries may be offloaded to host memory during inference of long sequences to free local memory for active computation, and may be fetched back when needed for attention computation. This dynamic staging may enable inference of models that exceed the available local memory capacity.

In some implementations, the method further comprises sending, by the accelerator, a UPLI request comprising a write command and inference context data; translating, by the RPU, the UPLI request comprising the write command to a CXL.cache D2H request comprising a write opcode; and sending the CXL.cache D2H request and the inference context data to the host for storage in the host memory. The write direction may enable the accelerator to offload inference context data to the host memory, such as KV cache entries that are not actively needed, intermediate computation results, or checkpoint data. The RPU may translate the UPLI write command to a CXL.cache D2H write opcode, such as DirtyEvict, ItoMWr, WrCur, or WrInv, and may forward the inference context data to the host for storage in the host memory.

A system may include an accelerator with local memory, a host with host memory, and an RPU coupled between them to bridge the UPLI and CXL.cache protocol domains. The RPU may enable the accelerator to access host memory capacity beyond its local memory, addressing memory capacity limitations for workloads such as AI inference and high-performance computing. The host memory may include removable DDR modules or CXL-attached memory, providing larger but higher-latency capacity compared to the accelerator's local HBM. A UALink switch may couple accelerators to the RPU, enabling accelerators to share access to the host memory via the RPU.

In various implementations, a system comprising: an accelerator comprising local memory and configured to communicate according to an Ultra Accelerator Link Protocol Level Interface (UPLI); a host comprising host memory and configured to communicate according to CXL.cache, wherein CXL denotes Compute Express Link; and a Resource Provisioning Unit (RPU) coupled between the accelerator and the host, the RPU comprising a first interface configured to communicate with the accelerator according to UPLI and a second interface configured to communicate with the host according to CXL.cache; wherein the RPU is configured to: translate a UPLI request comprising a read command, received from the accelerator via the first interface, to a CXL.cache Device-to-Host (D2H) request comprising a read opcode, and send the CXL.cache D2H request to the host via the second interface; and translate a CXL.cache Host-to-Device (H2D) data message, received from the host via the second interface, to a UPLI read response, and send the UPLI read response to the accelerator via the first interface; whereby the accelerator accesses the host memory via the RPU. The system may enable an accelerator to access host memory through protocol translation performed by the RPU. The RPU may bridge the UPLI domain of the accelerator and the CXL.cache domain of the host, translating read commands to CXL.cache D2H read opcodes and translating CXL.cache H2D data messages back to UPLI read responses. The system may address memory capacity limitations of the accelerator by enabling access to the host memory, which may provide larger capacity than the accelerator's local memory. The RPU may be a discrete component, an IP block embedded in a processor, or a chiplet within an IC package.

In some implementations of the system, a capacity of the host memory exceeds a capacity of the local memory; and wherein the local memory comprises high-bandwidth memory (HBM) and the host memory comprises removable DDR modules, or CXL-attached memory; whereby the accelerator accesses a combined memory capacity comprising the local memory and the host memory; and wherein the RPU is further configured to: translate a UPLI request comprising a write command and write data, received from the accelerator, to a CXL.cache D2H request comprising a write opcode; and send the CXL.cache D2H request comprising the write opcode and the write data to the host for storage in the host memory. In one example, the removable DDR modules refer to a standardized hardware assembly comprising one or more memory integrated circuits disposed on a substrate and encompassing various form factors and mounting architectures, including but not limited to: dual in-line memory modules (DIMMs), compression-attached memory modules (CAMM or CAMM2), and any future iterations of modular memory form factors.

In some implementations, the system further comprises a UALink switch coupled between the accelerator and the RPU; wherein the UALink switch routes the UPLI request from the accelerator to the RPU based on a destination accelerator identifier carried in the UPLI request; and wherein accelerators are coupled to the UALink switch, the accelerators sharing access to the host memory via the RPU. The UALink switch may route UPLI traffic based on the destination accelerator identifier, such as the ReqDstPhysAccID field, utilizing a route table to map the destination identifier to an egress port coupled to the RPU. The accelerators may share access to the host memory via the RPU, enabling accelerators to extend their accessible memory capacity. In some examples, the UALink switch may also route UPLI responses from the RPU back to the originating accelerator based on the destination accelerator identifier in the response.

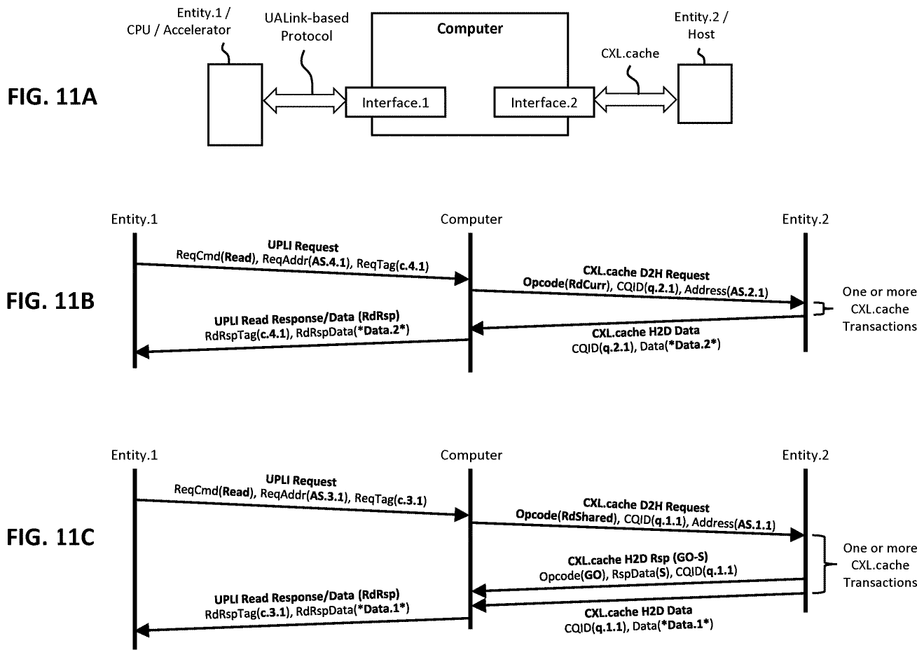

FIG. 11A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.cache, with a second entity (Entity.2), such as a host. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In some examples, the first address space and the second address space may be associated with the same address space, such as a common address space, a global address space, a pod address space, or a fabric address space, wherein the computer may perform address translations between addresses within the same common address space. In other examples, the computer may be implemented in an IC package having high-speed differential I/O balls positioned according to a ball grid array layout defined by a retimer specification.

FIG. 11B illustrates an example of a TFD demonstrating translations, such as protocol translations, between UALink-based requests, such as UPLI requests, received from a first entity (Entity.1), which may be a CPU or an accelerator, and CXL requests, such as CXL.cache D2H requests, sent to a second entity (Entity.2), which may be a host, possibly enabling the first entity to access resources mapped to an address space utilized by the second entity. The first entity may initiate a UPLI transaction that may include a UPLI request comprising ReqCmd(Read), ReqAddr(AS.4.1), and ReqTag(c.4.1). The computer may translate the UPLI transaction to a CXL transaction that may include a CXL.cache D2H request comprising Opcode(RdCurr), CQID(q.2.1), and Address(AS.2.1), and may send the CXL.cache D2H request to the second entity. Upon receiving one or more responses from the second entity, which may include a CXL.cache H2D Data comprising CQID(q.2.1) and Data(*Data.2*), the computer may translate the one or more responses, such as translating the CXL.cache H2D Data to a UPLI read response/data (RdRsp) comprising RdRspTag(c.4.1) and RdRspData(*Data.2*), and send the UPLI RdRsp to the first entity. In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity.

The computer may perform further translations, such as opcode translations, command translations, TLP type translations, and field translations between the UALink-based domain and the CXL domain. In some examples, the computer may issue multiple CXL.cache D2H requests in response to receiving a UPLI request from the first entity, such as when splitting a UPLI request for a large block of data (e.g., 256 B) to smaller CXL.cache D2H requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

FIG. 11C illustrates an example of a TFD demonstrating translations, such as protocol translations, between UALink-based requests, such as UPLI requests, received from a first entity (Entity.1), which may be a CPU or an accelerator, and CXL requests, such as CXL.cache D2H requests, sent to a second entity (Entity.2), which may be a host, possibly enabling the first entity to access resources mapped to an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.cache D2H request comprising Opcode(RdShared), CQID(q.1.1), and Address(AS.1.1), and send the CXL.cache D2H request to the second entity. Upon receiving one or more responses from the second entity, which may include a CXL.cache H2D Rsp comprising Opcode(GO), RspData(S), and CQID(q.1.1), and may further include a CXL.cache H2D Data comprising CQID(q.1.1) and Data(*Data.1*), the computer may translate the one or more responses, such as translating the CXL.cache H2D Data to a UPLI read response/data (RdRsp) comprising RdRspTag(c.3.1) and RdRspData(*Data.1*), and may send the UPLI RdRsp to the first entity. In some examples, the computer may include a cache or may control a cache that is external to the computer, wherein the computer may be configured to select the CXL.cache D2H request opcode according to a cacheline state intent that may be identified based on the UPLI request, or according to a caching policy, such as selecting RdShared for storing a shared copy of the cacheline in the cache, or selecting RdOwn for storing an exclusive copy of the cacheline in the cache.

In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity. The computer may perform further translations, such as opcode translations, command translations, TLP type translations, and field translations between the UALink-based domain and the CXL domain. In some examples, the computer may issue multiple CXL.cache D2H requests in response to receiving a UPLI request from the first entity, such as when splitting a UPLI request for a large block of data (e.g., 256 B) to smaller CXL.cache D2H requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

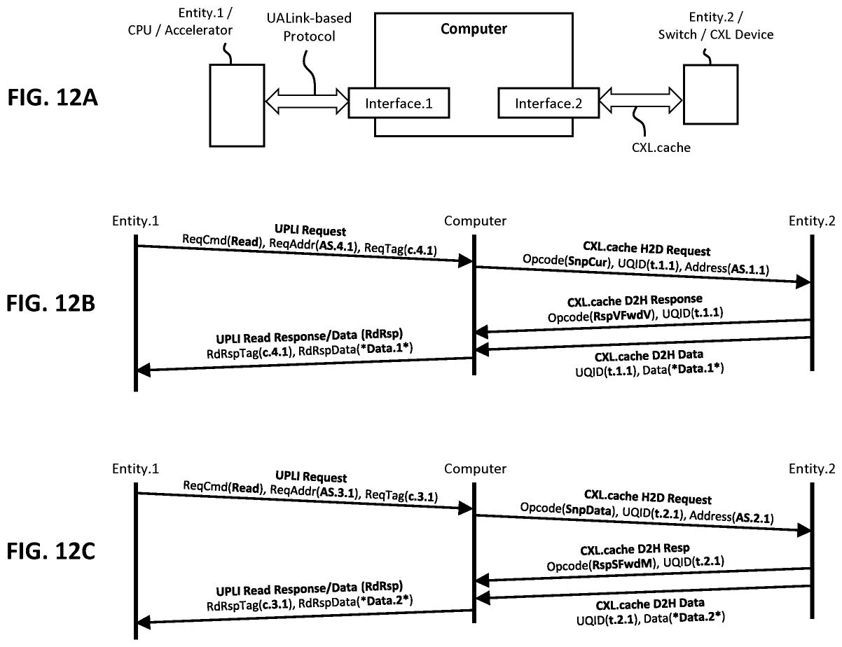

FIG. 12A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.cache, with a second entity (Entity.2), such as a switch, or a CXL device, which may be a CXL memory expander, a CXL memory pool, a GFD, or a CXL accelerator. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In some examples, the first address space and the second address space may be associated with the same address space, such as a common address space, a global address space, a pod address space, or a fabric address space, wherein the computer may perform address translations between addresses within the same common address space. In some examples, the computer may be implemented in an IC package having high-speed differential I/O balls positioned according to a ball grid array layout defined by a retimer specification.

FIG. 12B illustrates an example of a TFD demonstrating translations, such as protocol translations, between UALink-based requests, such as UPLI requests, received from a first entity (Entity.1), which may be a CPU or an accelerator, and CXL requests, such as CXL.cache H2D requests, sent to a second entity (Entity.2), which may be a switch or a CXL device, possibly enabling the first entity to access resources associated with an address space utilized by the second entity. The first entity may initiate a UPLI transaction that may include a UPLI request comprising ReqCmd(Read), ReqAddr(AS.4.1), and ReqTag(c.4.1). The computer may translate the UPLI transaction to a CXL transaction that may include a CXL.cache H2D request comprising Opcode(SnpCur), UQID(t.1.1), and Address(AS.1.1), and may send the CXL.cache H2D request to the second entity. Upon receiving one or more responses from the second entity, which may include a CXL.cache D2H response comprising Opcode(RspVFwdV) and UQID(t.1.1), and may further include a CXL.cache D2H Data comprising UQID(t.1.1) and Data(*Data.1*), the computer may translate the one or more responses, such as translating the CXL.cache D2H Data to a UPLI read response/data (RdRsp) comprising RdRspTag(c.4.1) and RdRspData(*Data.1*), and may send the UPLI RdRsp to the first entity. In some examples, the computer may include a cache or may control a cache that is external to the computer, wherein the computer may be configured to select the CXL.cache H2D request opcode according to a cacheline state intent that may be identified based on the UPLI request, or according to a caching policy, such as selecting SnpData for a cacheline that is intended to be cached in either Shared or Exclusive state, or selecting SnpCur to get the current version of a cacheline without requiring change of any cache state in the hierarchy.

In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity. The computer may perform further translations, such as opcode translations, command translations, TLP type translations, and field translations between the UALink-based domain and the CXL domain. In some examples, the computer may issue multiple CXL.cache H2D requests in response to receiving a UPLI request from the first entity, such as when splitting a UPLI request for a large block of data (e.g., 256 B) to smaller CXL.cache H2D requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

FIG. 12C illustrates an example of a TFD demonstrating translations, such as protocol translations, between UALink-based requests, such as UPLI requests, received from a first entity (Entity.1), which may be a CPU or an accelerator, and CXL requests, such as CXL.cache H2D requests, sent to a second entity (Entity.2), which may be a switch or a CXL device, possibly enabling the first entity to access resources associated with an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.cache H2D request comprising Opcode(SnpData), UQID(t.2.1), and Address(AS.2.1), and may send the CXL.cache H2D request to the second entity. Upon receiving one or more responses from the second entity, which may include a CXL.cache D2H response comprising Opcode(RspSFwdM) and UQID(t.2.1), and may further include a CXL.cache D2H Data comprising UQID(t.2.1) and Data(*Data.2*), the computer may translate the one or more responses, such as translating the CXL.cache D2H Data to a UPLI read response/data (RdRsp) comprising RdRspTag(c.3.1) and RdRspData(*Data.2*), and may send the UPLI RdRsp to the first entity. In some examples, the computer may include a cache or may control a cache that is external to the computer, wherein the computer may be configured to select the CXL.cache H2D request opcode according to a cacheline state intent that may be identified based on the UPLI request, or according to a caching policy, such as selecting SnpData for a cacheline that is intended to be cached in either Shared or Exclusive state, or selecting SnpCur to get the current version of a cacheline without requiring change of any cache state in the hierarchy.

In some examples, the computer may perform additional translations, such as address translations, between first physical addresses, such as Network Physical Addresses (NPAs), carried in UPLI requests received from the first entity, and second physical addresses, such as Host Physical Addresses (HPAs), carried in CXL requests sent to the second entity. The computer may perform further translations, such as opcode translations, command translations, TLP type translations, and field translations between the UALink-based domain and the CXL domain. In some examples, the computer may issue multiple CXL.cache H2D requests in response to receiving a UPLI request from the first entity, such as when splitting a UPLI request for a large block of data (e.g., 256 B) to smaller CXL.cache H2D requests (e.g., 64 B each), or when prefetching data from the second entity utilizing CXL.cache reads. The computer may translate requests or transactions initiated from the UALink-based domain to the CXL domain, may translate requests or transactions initiated from the CXL domain to the UALink-based domain, or may translate requests or transactions initiated from both domains.

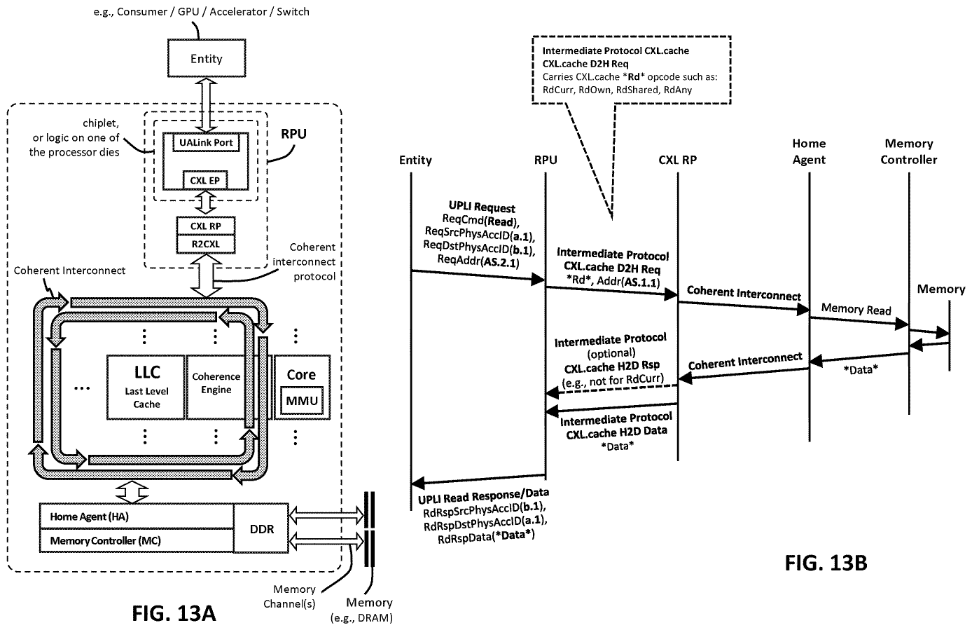

FIG. 13A illustrates an example of a system comprising a processor (such as an MxPU) comprising processing cores, LLC, a CXL RP, and a memory controller optionally coupled via memory channels to memory, such as DRAM. The CXL RP may be coupled to an on-chip coherent interconnect, such as a CHI ring or mesh interconnect, via a Ring-to-CXL (R2CXL) interconnect interface that may communicate with the coherent interconnect according to a protocol utilized by the coherent interconnect, such as ARM CHI, Intel UPI, or AMD Infinity Fabric. An RPU, which may be included in the MxPU, performs physical address translations that may enable an entity such as a GPU to access the memory. The MxPU may expose to the entity, optionally via the RPU, a UALink port that may communicate with the entity according to UPLI. The RPU may further perform translations, such as from UPLI to a protocol utilized by the coherent interconnect, wherein the RPU may utilize an intermediate protocol, such as CXL (e.g., CXL.cache), to provide the translations. The RPU may expose to the processor, via a CXL RP that may be included in the RPU, a CXL device utilizing a CXL endpoint (CXL EP), such as a Type-1 CXL device or a Type-2 CXL device, where an R2CXL, that may reside in the RPU, may communicate with the coherent interconnect and complete the translation path from UPLI to a protocol utilized by the coherent interconnect. In some examples, the RPU, the UALink port and the CXL device may be implemented in a chiplet inside an IC package of an MxPU, whereas in other examples they may be implemented as functional blocks on the same die with the CXL RP of the processor, or split between processor dies or chiplets.

FIG. 13B illustrates an example of a TFD demonstrating a UPLI request (Req) received from an entity, such as a GPU or an accelerator, wherein the RPU may translate a physical address (AS.2.1) carried in the UPLI request, to a physical address (AS.1.1) utilized for accessing the memory. The RPU may perform further translations, such as protocol translations from UPLI to a protocol utilized by the processor's coherent interconnect, possibly utilizing an intermediate protocol such as CXL.cache. The RPU may perform further translations, such as opcode translations and Tag translations, e.g., of transaction Tags, such as translating from UPLI Tags to CQIDs. The CXL.cache request, carrying the translated address (AS.1.1), is sent to the CXL RP for further processing and fetching of the requested data, such as from an LLC over the on-chip ring interconnect, or from memory, such as DRAM via the memory channels. The data may then return over the on-chip ring interconnect to the RPU, wherein the RPU provides UPLI read response/data (RdRsp) to the requesting entity.

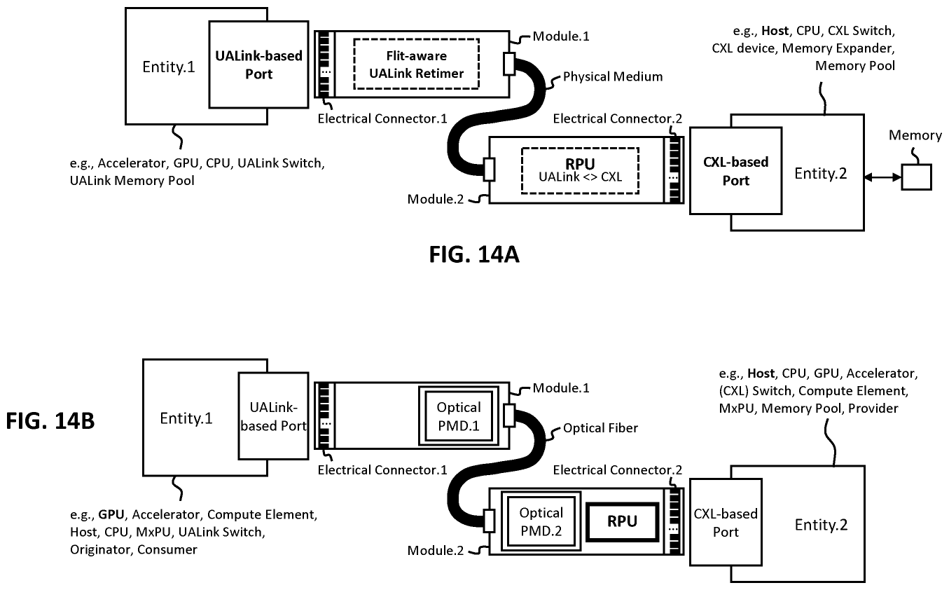

FIG. 14A illustrates an example of a system comprising a cable, such as an active cable, referred to as Cable/RPU, which may translate between UALink-based traffic and CXL-based traffic, such as at least one of CXL.io, CXL.mem, or CXL.cache traffic. The Cable/RPU enables a first entity (Entity.1), which may be an accelerator, a GPU, a CPU, a UALink switch, a UPLI originator, or a resource consumer, to access, via a UALink-based port, via the Cable/RPU, and via a CXL-based port, resources, such as memory, coupled to a second entity (Entity.2), which may be a host, a CPU, a CXL switch, a CXL device, a memory expander, a memory pool, or a resource provider. The Cable/RPU, which may include an RPU, may communicate with the first entity according to a UALink-based protocol, such as a UPLI, and may communicate with the second entity according to a CXL-based protocol, such as at least one of CXL.io, CXL.mem, or CXL.cache. In some examples, the UALink-based protocol, such as UPLI, may be associated with a first address space, such as an NPA space, and the CXL-based protocol, such as CXL.mem, may be associated with a second address space, such as a System Physical Address (SPA) space or a Host Physical Address (HPA) space; wherein the Cable/RPU may perform address translations between addresses within the first and second address spaces, respectively, such as between addresses within the NPA space and addresses within the SPA space or the HPA space.

In other examples, the UALink-based protocol, such as UPLI, and the CXL-based protocol, such as CXL.mem, may be associated with the same physical address space, such as a global address space, a pod address space, or a fabric address space; wherein the Cable/RPU may perform address translations between addresses within the same address spaces. The Cable/RPU may perform further translations, such as opcode, command, or TLP translations, e.g., translating between Read commands in UPLI requests and read opcodes in CXL.cache D2H requests. The Cable/RPU may further translate between messages conforming to the UALink-based protocol and messages conforming to the CXL-based protocol, translate Tags, and/or translate error indications, such as data corruption indications or poison.

In some examples, the Cable/RPU, such as an OSFP copper cable, an OSFP-XD copper cable, an OSFP Active Optical Cable (AOC), or an OSFP-XD AOC cable, may further include a first module (Module.1), which may include a flit-aware UALink retimer, a PAM4 retimer, or a retimer PHY, and may further include a second module (Module.2), which may include the RPU, optionally included in a discrete component compatible with a retimer form-factor. The Cable/RPU may conform to a standard specification, an industry standard, an implementation agreement (IA), or a multi-source agreement (MSA), such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard (such as SFF-8665), an Optical Internetworking Forum (OIF) implementation agreement, or an Institute of Electrical and Electronics Engineers (IEEE) standard. The Cable/RPU may further include a physical medium that may include a copper wire or an optical fiber. In some examples, the Cable/RPU may be coupled to the UALink-based port via a first electrical connector (Electrical Connector.1) and may be further coupled to the CXL-based port via a second electrical connector (Electrical Connector.2), whereas in other examples the Cable/RPU may be coupled to the UALink-based port and/or the CXL-based port via optical connectors.

FIG. 14B illustrates an example of a system comprising an active optical cable. The active optical cable may couple a first entity (Entity.1), such as a GPU, an accelerator, a compute element, a host, a CPU, an MxPU, a UALink switch, a UPLI originator, or a consumer, to a second entity (Entity.2), such as a host, a CPU, a GPU, an accelerator, a CXL switch, a compute element, an MxPU, a memory pool, or a provider. In some examples, the first entity may be coupled to a first port (Port.1), such as a UALink port, via a first electrical connector (Electrical Connector.1). The active optical cable may include a first module (Module.1) comprising a first optical physical media dependent (Optical PMD.1) device, and a second module (Module.2) comprising a second optical physical media dependent (Optical PMD.2) device and an RPU. The first module may be coupled to the first electrical connector and may convert electrical signals from the first entity to optical signals for transmission over an optical fiber. The second module may convert the optical signals back to electrical signals and may further comprise the RPU, which may translate between a UALink-based protocol, such as UPLI, and a CXL-based protocol, such as at least one of CXL.io, CXL.mem, or CXL.cache. The second module may be coupled to the second entity via a second electrical connector (Electrical Connector.2), wherein the second entity may be coupled to a second port (Port.2), such as a CXL port.

In some examples, the RPU within the active optical cable may perform address translations between addresses within a first address space associated with the UALink-based protocol, such as a NPA space, and addresses within a second address space associated with the CXL-based protocol, such as HPA space. The RPU may further perform opcode translations, command translations, Tag translations, and translations of error indications such as data corruption indications or poison. In some examples, the active optical cable may conform to a standard specification, an industry standard, an implementation agreement, or a multi-source agreement, such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard, an Optical Internetworking Forum (OIF) implementation agreement, or an IEEE standard. In other examples the active optical cable may utilize other form factors or standards as they become available.

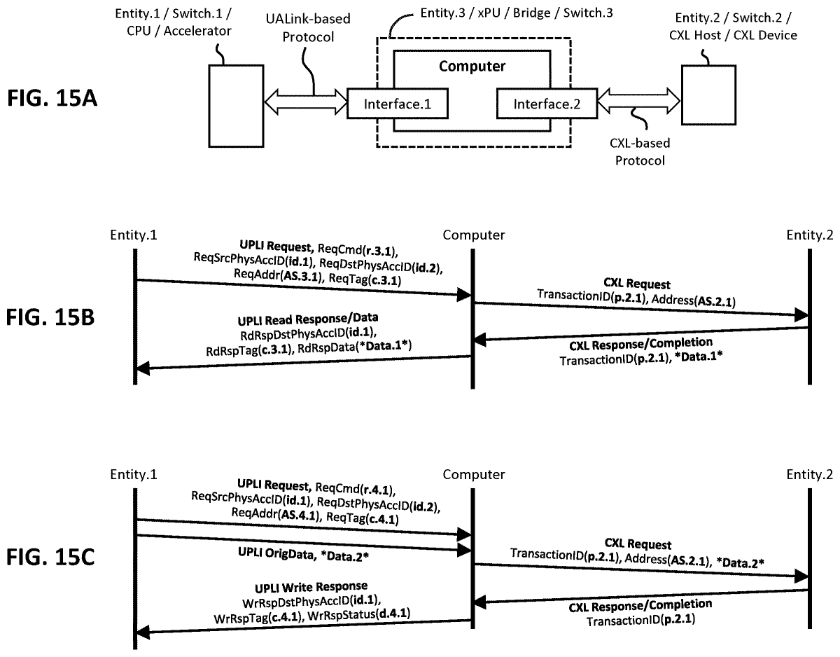

FIG. 15A illustrates an example of a system comprising a third entity (Entity.3), such as an xPU, a bridge, or a third switch (Switch.3). The third entity includes a computer comprising a first interface (Interface.1) and a second interface (Interface.2). The first interface may communicate according to a UALink-based protocol, such as UPLI, with a first entity (Entity.1), such as a first switch (Switch.1), a CPU, or an accelerator. The second interface may communicate according to a CXL-based protocol, such as CXL.io, CXL.mem, or CXL.cache, with a second entity (Entity.2), such as a second switch (Switch.2), a CXL host, or a CXL device which may be a CXL memory expander, a CXL-based memory pool, a GFD, or a CXL accelerator. The computer may perform translations, such as protocol translations between the UALink-based protocol and the CXL-based protocol, transaction translations, protocol data unit (PDU) translations, message translations, and/or address translations between the UALink-based protocol domain and the CXL-based protocol domain. In some examples, the computer may extract addresses from requests received via the first interface, wherein these addresses may refer to a first address space, such as a Network Physical Address (NPA) space utilized by the first entity. The computer may translate these addresses, and generate requests carrying the translated addresses for transmission via the second interface; wherein these translated addresses may refer to a second address space, such as a Host Physical Address (HPA) space utilized by the second entity. In other examples the first address space and the second address space may be associated with the same address space, such as a common address space, a global address space, a pod address space, or a fabric address space, wherein the computer may perform address translations between addresses within the same common address space. In some examples, the computer may be implemented in a chiplet, may utilize UCIe for chip-to-chip or die-to-die connectivity, or may be implemented in an IC package having high-speed differential I/O balls positioned according to a ball grid array layout defined by a retimer specification.

FIG. 15B illustrates an example of a TFD demonstrating translations, such as protocol translations, transaction translations, protocol data unit (PDU) translations, message translations, and/or address translations, which may be performed by a computer, between a UALink-based protocol, such as UPLI, utilized by a first entity (Entity.1), such as a first switch (Switch.1), a CPU, or an Accelerator, and a CXL-based protocol, such as CXL.io, CXL.mem, or CXL.cache, utilized by a second entity (Entity.2), such as a second switch (Switch.2), a CXL host, or a CXL device. The first entity may initiate a UPLI transaction that may include a UPLI request comprising ReqCmd(r.3.1), such as Read or Read class Vendor Defined Command, ReqSrcPhysAccID(id.1), ReqDstPhysAccID(id.2), ReqAddr(AS.3.1), and ReqTag(c.3.1). The computer may translate the UPLI transaction to a CXL transaction that may include a CXL request comprising TransactionID(p.2.1) and Address(AS.2.1), and may send the CXL request to the second entity. In some examples, the TransactionID, such as a CXL.io Tag, a CXL.mem Tag, a CXL.cache CQID, or a CXL.cache UQID, may be utilized by the computer as a transaction identifier for matching responses or completions with requests, and may be further utilized to identify outstanding transactions in-flight. Upon receiving from the second entity a CXL response or completion (CXL Response/Completion) comprising TransactionID(p.2.1) and *Data.1*, the computer may translate the CXL Response/Completion to a UPLI read response/data comprising RdRspDstPhysAccID(id.1), RdRspTag(c.3.1), and RdRspData(*Data.1*), and may send the UPLI read response/data to the first entity.

The computer may perform further translations, such as opcode translations, command translations, TLP type translations, or other translations between the UALink-based protocol domain and the CXL-based protocol domain. In some examples, the computer may issue multiple CXL requests in response to receiving a UPLI request from the first entity. For example, the computer may issue CXL.mem M2S requests comprising MemRd or MemRdData, such as when splitting a UPLI request for a large block of data (e.g., 256 B) to smaller CXL.mem reads (e.g., 64 B each), or when prefetching data from the second entity utilizing CXL.mem reads. The computer may translate requests or transactions initiated from the UALink-based protocol domain to the CXL-based protocol domain, may translate requests or transactions initiated from the CXL-based protocol domain to the UALink-based protocol domain, or may translate requests or transactions initiated from the protocol domains.

FIG. 15C illustrates an example of a TFD demonstrating translations, such as protocol translations, transaction translations, protocol data unit (PDU) translations, message translations, and/or address translations, which may be performed by a computer, between a UALink-based protocol, such as UPLI, utilized by a first entity (Entity.1), such as a first switch (Switch.1), a CPU, or an Accelerator, and a CXL-based protocol, such as CXL.io, CXL.mem, or CXL.cache, utilized by a second entity (Entity.2), such as a second switch (Switch.2), a CXL host, or a CXL device. The first entity may initiate a UPLI transaction that may include a UPLI request comprising ReqCmd(r.4.1), such as Write or Write class Vendor Defined Command, ReqSrcPhysAccID(id.1), ReqDstPhysAccID(id.2), ReqAddr(AS.4.1), and ReqTag(c.4.1). The UPLI transaction may further include a UPLI OrigData comprising *Data.2*. The computer may translate the UPLI transaction to a CXL transaction that may include a CXL request comprising TransactionID(p.2.1), Address(AS.2.1), and *Data.2*, and may send the CXL request to the second entity. In some examples, the TransactionID, such as a CXL.io Tag, a CXL.mem Tag, a CXL.cache CQID, or a CXL.cache UQID, may be utilized by the computer as a transaction identifier for matching responses or completions with requests, and may be further utilized to identify outstanding transactions in-flight. Upon receiving from the second entity a CXL response or completion (CXL Response/Completion) comprising TransactionID(p.2.1), the computer may translate the CXL Response/Completion to a UPLI write response comprising WrRspDstPhysAccID(id.1), WrRspTag(c.4.1), and WrRspStatus(d.4.1), and may send the UPLI write response to the first entity.

The computer may perform further translations, such as opcode translations, command translations, TLP type translations, or other translations between the UALink-based protocol domain and the CXL-based protocol domain. In some examples, the computer may issue CXL requests in response to receiving a UPLI request from the first entity. For example, the computer may issue multiple CXL.mem M2S RwD comprising MemWr or MemWrTEE, such as when splitting a UPLI request writing a large block of data (e.g., 256 B) to smaller CXL.mem writes (e.g., 64 B each). The computer may translate requests or transactions initiated from the UALink-based protocol domain to the CXL-based protocol domain, may translate requests or transactions initiated from the CXL-based protocol domain to the UALink-based protocol domain, or may translate requests or transactions initiated from the protocol domains.

In computing environments where entities communicating according to CXL may need to access data or memory resources in a UALink domain, a computer such as an RPU may bridge the two protocol domains by translating between CXL and UPLI. The computer may include a cache that stores data fetched from the UALink domain, such that subsequent CXL requests targeting the same data may be served from the cache without requiring additional cross-protocol translation or remote data fetches. This caching behavior may reduce latency for repeated accesses, reduce traffic on the UALink network, and improve overall system throughput. The computer may perform the cache lookup based on an address or other identifier carried in the CXL request, and may translate opcodes, addresses, Tags, and additional fields between CXL and UPLI messages when the requested data is not present in the cache.

In various implementations, a method comprising: receiving, by a computer comprising a cache, a Compute Express Link (CXL) request from a first entity; performing, by the computer, a cache lookup based on the CXL request; responsive to a cache miss: translating, by the computer, the CXL request to an Ultra Accelerator Link Protocol Level Interface (UPLI) request; sending the UPLI request to a second entity; receiving, from the second entity, a UPLI response comprising data; storing the data in the cache; translating the UPLI response to a CXL response; and sending the CXL response comprising the data to the first entity; and responsive to a cache hit: sending a CXL response comprising data from the cache to the first entity without sending to the second entity a UPLI request corresponding to the CXL request. The method may be performed by an RPU, a semiconductor device, a bridge, or other computing apparatus positioned between the first entity and the second entity. The cache may include an on-chip SRAM cache, an embedded DRAM cache, or a portion of memory allocated for caching purposes. On a cache miss, the computer may translate CXL opcodes to corresponding UPLI commands, translate addresses between address spaces, and map CXL Tags to UPLI Tags. On a cache hit, the computer may generate the CXL response locally from the cached data, avoiding the latency and bandwidth overhead of a cross-protocol round trip. The first entity may include a CXL host, a CXL device, or a CXL accelerator. The second entity may include an accelerator, a UALink switch, or other UPLI-capable entity coupled via a UALink network.

In some implementations of the method, the CXL request comprises a CXL.cache Device-to-Host (D2H) request comprising a read opcode, and the CXL response comprises a CXL.cache Host-to-Device (H2D) response comprising a Global Observation (GO) opcode and a CXL.cache H2D Data message comprising the data; and wherein the first entity comprises a CXL device or a CXL accelerator, and the second entity comprises an accelerator coupled to the computer via a UALink network. The computer may act as a CXL host toward the first entity, receiving D2H requests and responding with H2D responses and H2D Data messages. Examples of read opcodes include RdOwn, RdShared, or RdAny. The GO opcode may indicate a cache state grant such as GO-S, GO-E, or GO-M.

In some implementations of the method, the CXL request comprises a CXL.mem Master-to-Subordinate (M2S) request comprising MemRd*, and the CXL response comprises a CXL.mem Subordinate-to-Master Data Response (S2M DRS) comprising MemData and the data; and wherein the first entity comprises a CXL host. The computer may act as a CXL subordinate device toward the CXL host, exposing a Host-managed Device Memory (HDM) region backed by the cache and UALink-accessible memory.

In some implementations of the method, the CXL request comprises a first address in a first address space, and the UPLI request comprises a second address in a second address space translated from the first address; and wherein the first address space comprises a host physical address (HPA) space and the second address space comprises a network physical address (NPA) space. The computer may perform address translation utilizing address range registers, translation tables, or algorithmic mappings. Additionally or alternatively, both addresses may be within the same address space, such as a global address space or a partitioned global address space (PGAS).

In some implementations, the method further comprises receiving, by the computer, a second CXL request comprising write data from the first entity; translating the second CXL request to a second UPLI request comprising a write command and the write data; sending the second UPLI request to the second entity; and responsive to the second CXL request, at least one of: storing the write data in the cache, or invalidating data in the cache corresponding to an address of the second CXL request. The UPLI write command may include a Write or WriteFull command. The computer may update the cache with the write data to maintain coherency, or may invalidate the corresponding cacheline to avoid stale data, depending on the cache coherency policy utilized by the computer.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

An apparatus may include a CXL port, a UALink port, a cache, and a computer coupled to the ports and the cache, enabling the apparatus to bridge CXL and UALink protocol domains while caching data to reduce cross-protocol traffic. The CXL port may expose a CXL Type-2 or Type-3 device interface to the first entity, while the UALink port may couple to a UALink network comprising one or more accelerators. The cache may be located within the computer, within the apparatus but external to the computer, or may include a dedicated region of memory accessible to the computer. The apparatus may be implemented as a discrete device, as a chiplet within a multi-die processing unit, or as an IP block within an accelerator or switch.

In various implementations, an apparatus comprising: a Compute Express Link (CXL) port configured to communicate with a first entity according to CXL; an Ultra Accelerator Link (UALink) port configured to communicate with a second entity according to an Ultra Accelerator Link Protocol Level Interface (UPLI); a cache; and a computer coupled to the CXL port, the UALink port, and the cache; wherein the computer is configured to: receive a CXL request from the first entity via the CXL port; perform a cache lookup based on the CXL request; responsive to a cache miss: translate the CXL request to a UPLI request, send the UPLI request to the second entity via the UALink port, receive a UPLI response comprising data from the second entity, store the data in the cache, translate the UPLI response to a CXL response, and send the CXL response comprising the data to the first entity via the CXL port; and responsive to a cache hit: send a CXL response comprising data from the cache to the first entity via the CXL port without sending to the second entity a UPLI request corresponding to the CXL request. The apparatus may be implemented as an RPU, a bridge device, a semiconductor device, or other hardware positioned between the first entity and the second entity. The CXL port may support one or more CXL sub-protocols including CXL.cache, CXL.mem, and CXL.io. The UALink port may support UPLI commands including Read, Write, WriteFull, and Atomic operations. The cache may be indexed by address, and the computer may perform the cache lookup by comparing the address of the CXL request against tags stored in the cache. On a cache hit, the computer may generate the CXL response locally, avoiding the translation and network latency of a cross-protocol round trip.

In some implementations of the apparatus, the CXL port is further configured to communicate according to CXL.cache, the CXL request comprises a CXL.cache Device-to-Host (D2H) request comprising a read opcode selected from RdOwn, RdShared, or RdAny, and the CXL response comprises a CXL.cache Host-to-Device (H2D) response comprising a Global Observation (GO) opcode and a CXL.cache H2D Data message; and wherein the first entity comprises a CXL device, the second entity comprises an accelerator, and the computer comprises a resource provisioning unit (RPU). RdOwn may request data for exclusive ownership, RdShared may request data for shared state, and RdAny may allow the host to determine the granted state. The GO opcode in the H2D response may be selected by the second entity based on the read opcode and its coherency state tracking for the cacheline.

In some implementations of the apparatus, the computer is further configured to: receive, via the CXL port, a CXL.cache Host-to-Device (H2D) request comprising a snoop opcode targeting a cacheline; invalidate the cacheline responsive to the snoop opcode; and send, via the CXL port, a CXL.cache Device-to-Host (D2H) response comprising an opcode selected from RspIHitSE or RspIHitI. The snoop opcode may include SnpInv, SnpData, or SnpCur. The cache operation may include invalidating a cacheline, downgrading a cacheline from a higher state to Shared, or retaining the current cacheline state, depending on the snoop opcode and the cacheline state at the time the snoop is received. Rsp* may include RspIHitSE, RspIHitI, RspSHitSE, or RspVHitV, and may be selected based on the snoop opcode and the cacheline state. In some examples, the computer may also send a D2H Data message together with the D2H response, such as when the snoop opcode is SnpData and the computer forwards cached data to the second entity.

In some implementations of the apparatus, the computer is further configured to evict data from the cache according to an eviction policy comprising at least one of: a least recently used (LRU) replacement policy, a capacity-based eviction threshold, or a timer-based invalidation interval. Timer-based invalidation may be utilized when the computer caches data transparently without host coherency tracking, such as when utilizing RdCurr. The eviction policy may combine strategies, for example utilizing LRU replacement with a maximum capacity threshold.

In some implementations of the apparatus, the CXL port is further configured to communicate according to CXL.mem, the CXL request comprises a CXL.mem Master-to-Subordinate (M2S) request comprising MemRd*, and the CXL response comprises a CXL.mem Subordinate-to-Master Data Response (S2M DRS) comprising MemData; and wherein the first entity comprises a CXL host. The apparatus may expose an HDM region to the CXL host via CXL.mem, wherein the HDM region is backed by the cache and UALink-accessible memory. The CXL host may access the HDM region using standard CXL.mem read operations.

In some implementations of the apparatus, the apparatus comprises a multi-die processing unit, the computer comprises a resource provisioning unit (RPU) chiplet within the multi-die processing unit, and the CXL port is coupled to a CXL root port of the multi-die processing unit via a coherent interconnect within the multi-die processing unit. The multi-die processing unit may include chiplets coupled via the coherent interconnect, such as compute chiplets, I/O chiplets, and the RPU chiplet. The CXL root port may provide a CXL host interface for communicating with external CXL devices or hosts.

In environments where entities communicating according to UPLI, such as accelerators coupled via a UALink network, may need to access data or memory resources in a CXL domain, such as memory coupled to a CXL host or CXL memory devices, a computer such as an RPU may bridge the two protocol domains by translating between UPLI and CXL. The computer may include a cache that stores data fetched from the CXL domain, such that subsequent UPLI requests targeting the same data may be served from the cache without requiring additional cross-protocol translation or remote data fetches. This may be particularly beneficial for workloads involving repeated accesses to the same data, such as artificial intelligence (AI) inference workloads where accelerators may access shared model weights, key-value (KV) cache entries, or attention parameters stored in CXL-attached memory.

The computer may utilize different CXL opcodes when translating UPLI requests depending on the source of the request and the desired coherency behavior. For example, requests originating from a UALink network may be translated using a non-coherent opcode such as RdCurr, wherein the CXL host is unaware of the cached copy, while requests originating from local compute units within the same accelerator may be translated using a coherent opcode such as RdShared, wherein the CXL host tracks the cache state and may issue snoops to maintain coherency.

In various implementations, a method comprising: receiving, by a computer comprising a cache, an Ultra Accelerator Link Protocol Level Interface (UPLI) request comprising a read command from a first entity; performing, by the computer, a cache lookup based on the UPLI request; responsive to a cache miss: translating, by the computer, the UPLI request to a Compute Express Link (CXL) request; sending the CXL request to a second entity; receiving, from the second entity, a CXL response comprising data; storing the data in the cache; translating the CXL response to a UPLI read response; and sending the UPLI read response comprising the data to the first entity; and responsive to a cache hit: sending a UPLI read response comprising data from the cache to the first entity without sending to the second entity a CXL request corresponding to the UPLI request. The method may be performed by an RPU, a semiconductor device, abridge, or other computing apparatus positioned between the first entity and the second entity. On a cache miss, the computer may translate the UPLI read command to a CXL read opcode, translate addresses between address spaces such as NPA and HPA, and map UPLI ReqTags to CXL Tags or CQIDs. The UPLI read response may include a RdRsp carrying RdRspData and RdRspTag. On a cache hit, the computer may construct the UPLI read response locally from the cached data, populating the RdRspTag from the original UPLI request and providing the cached data as RdRspData, thereby avoiding cross-protocol translation and CXL network latency. The first entity may include an accelerator, a UALink switch, or other UPLI-capable entity. The second entity may include a CXL host, a CXL device, or a CXL memory device.

In some implementations of the method, the CXL request comprises a CXL.cache Device-to-Host (D2H) request comprising RdShared, and the CXL response comprises a CXL.cache Host-to-Device (H2D) response comprising GO-S and a CXL.cache H2D Data message comprising the data; and further comprising transitioning, by the computer, a cacheline state in the cache from Invalid (I) to Shared (S) responsive to storing the data in the cache. RdShared requests the cacheline in Shared state, allowing the second entity to retain its own cached copy. The GO-S response grants Shared state to the computer, making the second entity aware of the cached copy and enabling the second entity to issue snoops when coherency actions are needed.

In some implementations of the method, the CXL request comprises a CXL.cache Device-to-Host (D2H) request comprising RdCurr, and the CXL response comprises a CXL.cache Host-to-Device (H2D) Data message comprising the data; and wherein storing the data in the cache is transparent to the second entity such that the second entity does not maintain a coherency state for the data stored in the cache. RdCurr retrieves data without establishing a tracked coherency state at the second entity. Because the second entity is unaware of the cached copy, the computer may manage invalidation internally utilizing timer-based expiration, capacity-based eviction, or software-directed invalidation.

In some implementations of the method, the UPLI request is received from the first entity via a UALink network, and the CXL request comprises a first CXL opcode selected based on the UPLI request being received via the UALink network; and further comprising translating, by the computer, a request received from a local compute unit (CU) of an accelerator to a second CXL request comprising a second CXL opcode different from the first CXL opcode. For example, requests from the UALink network may be translated to RdCurr for non-coherent access, while requests from local CUs may be translated to RdShared for coherent caching. The local CU may include a streaming multiprocessor (SM), a compute engine, or other processing element within the accelerator.

In some implementations, the method further comprises receiving, from the second entity, a CXL.cache Host-to-Device (H2D) request comprising SnpInv targeting the data stored in the cache; transitioning the cacheline state in the cache from Shared (S) to Invalid (I); and sending, to the second entity, a CXL.cache Device-to-Host (D2H) response comprising RspIHitSE. SnpInv may be issued by the second entity when another agent requests exclusive ownership of the cacheline. The RspIHitSE response indicates that the cacheline was found in a clean state and has been invalidated, allowing the second entity to grant exclusive ownership to the requesting agent.

In some implementations of the method, the CXL request comprises a CXL.mem Master-to-Subordinate (M2S) request comprising MemRd*, and the CXL response comprises a CXL.mem Subordinate-to-Master Data Response (S2M DRS) comprising MemData and the data; and wherein the second entity comprises a CXL memory device. The CXL memory device may include a CXL memory expander, a CXL memory pool, or a GFD. The computer may act as a CXL master toward the CXL memory device, initiating M2S requests and receiving S2M data responses.

In some implementations of the method, the data stored in the cache comprises inference model data associated with an artificial intelligence (AI) model, the inference model data comprising at least one of: model weight parameters, key-value (KV) cache entries, activation data, or attention matrix coefficients. AI inference workloads may involve repeated access to the same model data by accelerators. Caching inference model data at the computer may reduce repeated cross-protocol fetches, lowering latency and reducing bandwidth consumption on both the CXL and UALink networks.

In some implementations of the method, the first entity comprises an accelerator comprising a local memory, and the second entity provides access to a CXL-attached memory; and wherein the cache provides an intermediate memory tier between the local memory of the first entity and the CXL-attached memory, the cache having a lower access latency for the data than the CXL-attached memory. The local memory may include HBM or other high-bandwidth memory coupled directly to the accelerator. The cache may mitigate the memory wall by providing faster access to frequently used data that does not fit in the local memory, without incurring the full latency of CXL-attached memory access.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

An apparatus may include a UALink port, a CXL port, a cache, and a computer coupled to the ports and the cache, enabling the apparatus to bridge UALink and CXL protocol domains while caching data to reduce cross-protocol traffic. The UALink port may couple to a UALink network comprising one or more accelerators, while the CXL port may couple to a CXL host, a CXL device, or a CXL memory device. The computer may utilize different CXL sub-protocols depending on the second entity, for example utilizing CXL.cache D2H requests when communicating with a CXL host, or utilizing CXL.mem M2S requests when communicating with a CXL memory device. The cache may support coherent caching with host-tracked states, transparent caching without host awareness, or both, depending on the CXL opcode utilized for the data fetch.

In various implementations, an apparatus comprising: an Ultra Accelerator Link (UALink) port configured to communicate with a first entity according to an Ultra Accelerator Link Protocol Level Interface (UPLI); a Compute Express Link (CXL) port configured to communicate with a second entity according to CXL; a cache; and a computer coupled to the UALink port, the CXL port, and the cache; wherein the computer is configured to: receive a UPLI request comprising a read command from the first entity via the UALink port; perform a cache lookup based on the UPLI request; responsive to a cache miss: translate the UPLI request to a CXL request, send the CXL request to the second entity via the CXL port, receive a CXL response comprising data from the second entity, store the data in the cache, translate the CXL response to a UPLI read response, and send the UPLI read response comprising the data to the first entity via the UALink port; and responsive to a cache hit: send a UPLI read response comprising data from the cache to the first entity via the UALink port without sending to the second entity a CXL request corresponding to the UPLI request. The apparatus may be implemented as an RPU, a bridge device, a semiconductor device, or other hardware positioned between the first entity and the second entity. The CXL port may support one or more CXL sub-protocols including CXL.cache, CXL.mem, and CXL.io. The UALink port may support UPLI commands including Read, Write, WriteFull, and Atomic operations. On a cache hit, the computer may construct the UPLI read response locally by populating the RdRspTag from the original UPLI request and providing the cached data as RdRspData, thereby avoiding cross-protocol translation and CXL network latency. The UPLI read command may include a Read command or a Read Class Vendor Defined Command.

In some implementations of the apparatus, the CXL port is further configured to communicate according to CXL.cache, the CXL request comprises a CXL.cache Device-to-Host (D2H) request comprising RdShared, and the CXL response comprises a CXL.cache Host-to-Device (H2D) response comprising GO-S and a CXL.cache H2D Data message; and wherein the first entity comprises an accelerator, the second entity comprises a CXL host, and the computer comprises a resource provisioning unit (RPU). The RPU may act as a CXL.cache device toward the CXL host, issuing D2H requests and receiving H2D responses. The GO-S grant makes the CXL host aware of the cached copy, enabling the host to issue snoops when coherency actions are needed for the cached data.

In some implementations of the apparatus, the CXL port is further configured to communicate according to CXL.cache, the CXL request comprises a CXL.cache Device-to-Host (D2H) request comprising RdCurr, and the CXL response comprises a CXL.cache H2D Data message; and wherein storing the data in the cache is transparent to the second entity such that the second entity does not maintain a coherency state for the data stored in the cache; and wherein the first entity comprises an accelerator and the second entity comprises a CXL host. RdCurr returns data without a GO response, leaving the CXL host unaware of the cached copy. The computer may manage cache validity internally utilizing eviction policies such as timer-based invalidation, capacity-based eviction, or software-directed invalidation.

In some implementations of the apparatus, the computer is further configured to: transition a state of a cacheline in the cache from Invalid (I) to Shared (S) responsive to receiving a CXL.cache H2D response comprising GO-S from the second entity; transition the state of the cacheline from Shared (S) to Invalid (I) responsive to receiving a CXL.cache Host-to-Device (H2D) request comprising SnpInv from the second entity; and transition the state of the cacheline from Invalid (I) to Exclusive (E) or from Invalid (I) to Modified (M) responsive to receiving a CXL.cache H2D response comprising GO-E or GO-M from the second entity. The cache state transitions may follow MESI protocol semantics. GO-E or GO-M may be granted by the CXL host when no other agent holds a cached copy of the cacheline, or when the host determines that exclusive or modified state is appropriate based on the access pattern.

In some implementations of the apparatus, the UPLI request comprises a first address in a first address space, and the CXL request comprises a second address in a second address space translated from the first address; and wherein the first address space comprises a network physical address (NPA) space and the second address space comprises a host physical address (HPA) space. The computer may perform address translation utilizing address range registers, translation tables, or algorithmic mappings. Additionally or alternatively, both addresses may be within the same address space, such as a global address space or a partitioned global address space.

In some implementations of the apparatus, the CXL port is further configured to communicate according to CXL.mem, the CXL request comprises a CXL.mem Master-to-Subordinate (M2S) request comprising MemRd*, and the CXL response comprises a CXL.mem Subordinate-to-Master Data Response (S2M DRS) comprising MemData; and wherein the second entity comprises a CXL memory device. The CXL memory device may include a CXL memory expander, a CXL memory pool, or a GFD. The computer may act as a CXL master toward the CXL memory device, caching retrieved data to reduce repeated accesses across the CXL link.

In some implementations of the apparatus, the apparatus comprises a multi-die processing unit, the computer comprises a resource provisioning unit (RPU) chiplet within the multi-die processing unit, and the CXL port is coupled to a CXL root port of the multi-die processing unit via a coherent interconnect within the multi-die processing unit. The multi-die processing unit may include chiplets coupled via the coherent interconnect, such as compute chiplets, I/O chiplets, and the RPU chiplet. The CXL root port may provide a CXL host interface for communicating with external CXL devices or hosts.

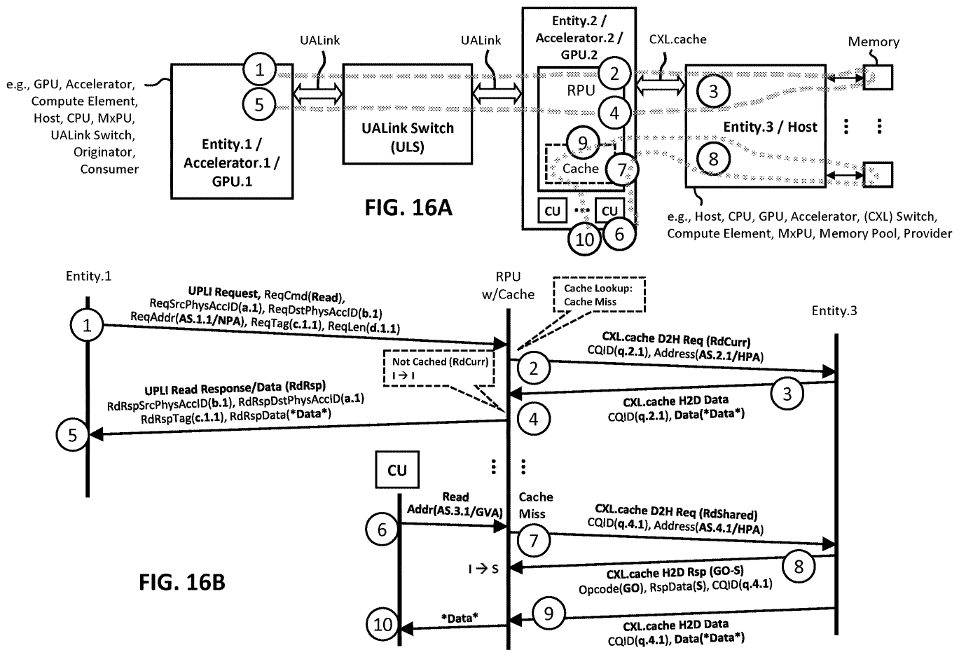

FIG. 16A illustrates an example of a system comprising a first entity (Entity.1/Accelerator.1/GPU.1), a UALink Switch (ULS), a second entity (Entity.2/Accelerator.2/GPU.2) comprising an RPU with a cache, and a third entity (Entity.3/Host) coupled to a memory. Entity.1 may include a GPU, an accelerator, a compute element, a host, a CPU, a multi-die processing unit, a UALink switch, an originator, or a consumer. Entity.3 may include a host, a CPU, a GPU, an accelerator, a CXL switch, a compute element, a multi-die processing unit, a memory pool, or a provider. Entity.1 is coupled to the UALink Switch via a UALink connection. The UALink Switch is coupled to Entity.2 via a UALink connection. Entity.2 comprises the RPU, which is coupled to Entity.3 via a CXL.cache connection. Entity.3 is coupled to a memory. FIG. 16B illustrates an example of a TFD demonstrating how an RPU comprising a cache (RPU w/Cache) may differentiate between requests received from different sources and translate the requests to CXL.cache D2H requests comprising different opcodes based on the source of the request. The TFD shows two transaction sequences: a UALink network request sequence translated to RdCurr, and a local compute unit (CU) request sequence translated to RdShared.

In the UALink network request sequence (denoted by Circles 1 through 5), Entity.1 sends a UPLI request (Req) comprising a read command (ReqCmd(Read)), a source physical accelerator identifier (ReqSrcPhysAccID(a.1)), a destination physical accelerator identifier (ReqDstPhysAccID(b.1)), a request address in network physical address space (ReqAddr(AS.1.1/NPA)), a request tag (ReqTag(c.1.1)), and a request length (ReqLen(d.1.1)) to the RPU (Circle 1). The RPU performs a cache lookup and determines a cache miss. Responsive to the cache miss, the RPU translates the UPLI request to a CXL.cache D2H request comprising RdCurr, a CQID(q.2.1), and an address in host physical address space (Address(AS.2.1/HPA)) (Circle 2). The RPU may perform address translation from the NPA space (AS.1.1/NPA) to the HPA space (AS.2.1/HPA). In some examples, the RPU may perform intermediate address translations, such as NPA to SPA (System Physical Address) to HPA. Entity.3 responds with a CXL.cache H2D Data message comprising CQID(q.2.1) and the requested data (Data(*Data*)) (Circle 3). Because RdCurr is utilized, Entity.3 does not send a GO response, and the data is not cached in a host-tracked coherency state. The annotation “Not Cached (RdCurr)” and the I to I transition (Circle 4) indicate that the RPU may cache the data transparently without Entity.3 maintaining a coherency state for the cached copy, or may not cache the data at all. The RPU translates the CXL.cache H2D Data to a UPLI read response/data (RdRsp) comprising RdRspSrcPhysAccID(b.1), RdRspDstPhysAccID(a.1), RdRspTag(c.1.1), and RdRspData(*Data*), and sends the UPLI RdRsp to Entity.1 (Circle 5).

In the local CU request sequence (denoted by Circles 6 through 10), a compute unit (CU) within the accelerator sends a read request comprising an address in a local address space, such as a guest virtual address (GVA) space (Addr(AS.3.1/GVA)), to the RPU (Circle 6). The RPU performs a cache lookup and determines a cache miss (Circle between 6 and 7). Responsive to the cache miss, the RPU translates the CU request to a CXL.cache D2H request comprising RdShared, a CQID(q.4.1), and an address in host physical address space (Address(AS.4.1/HPA)) (Circle 7). The RPU may perform address translation from the GVA space (AS.3.1/GVA) to the HPA space (AS.4.1/HPA). Entity.3 responds with a CXL.cache H2D response comprising GO-S, a response data value (RspData(S)) indicating Shared state, and CQID(q.4.1) (Circle 8), followed by a CXL.cache H2D Data message comprising CQID(q.4.1) and the requested data (Data(*Data*)) (Circle 9). The RPU stores the data in the cache and transitions the cacheline state from Invalid (I) to Shared (S) (denoted by the I to S transition between Circles 7 and 9). The RPU provides the requested data to the CU (Circle 10).

The opcode differentiation between RdCurr for UALink network requests and RdShared for local CU requests reflects the different coherency requirements of each source. Requests from the UALink network may be I/O-coherent and may not benefit from host-tracked caching, and thus the RPU may translate them to RdCurr, which retrieves data without establishing a tracked coherency state at Entity.3. Requests from local CUs may be related to the accelerator's cache hierarchy and may benefit from coherent caching, and thus the RPU may translate them to RdShared, which establishes a Shared state tracked by Entity.3 and enables Entity.3 to issue snoops when coherency actions are needed.

In environments where entities may utilize different protocols while requiring coordinated access to shared resources, there may be scenarios where a first entity communicating according to CXL, such as a CXL host, a CXL device, or a CXL accelerator, needs to access resources residing in a UALink domain, such as memory coupled to accelerators or accessible via a UALink network. The CXL entity may communicate according to CXL.cache, CXL.mem, or CXL.io, while the UALink entity may communicate according to an UPLI. A computer, such as an RPU, a bridge, a switch, or a semiconductor device, may translate between CXL and UPLI to facilitate memory operations, data transfers, and resource sharing across the CXL and UALink protocol domains while maintaining the requirements of each protocol. The translation may involve converting CXL requests to UPLI requests, and converting UPLI responses to CXL responses, including translations of opcodes, commands, addresses, Tags, and/or additional fields.

In various implementations, a method comprising: receiving, by a computer, a Compute Express Link (CXL) request from a first entity, the CXL request comprising a first address; translating, by the computer, the CXL request to an Ultra Accelerator Link Protocol Level Interface (UPLI) request comprising a second address; sending the UPLI request to a second entity; receiving, from the second entity, a UPLI response; translating, by the computer, the UPLI response to a CXL response; and sending the CXL response to the first entity. The method may encompass translation from any CXL protocol channel to UPLI. The computer may translate opcodes, commands, TLP types, addresses, Tags, and additional fields between the CXL-based protocol domain and the UALink-based protocol domain. The method may be implemented in hardware, firmware, software, or combinations thereof, and may be performed by various types of devices, such as an RPU, a switch, abridge, a semiconductor device, a Fabric Processing Unit (FPU), a Fabric NIC, or other suitable intermediary components. The first and second addresses may indicate the same address or indicate different addresses. In some examples, the computer may issue multiple UPLI request in response to receiving a CXL request from the first entity, such as when prefetching data from the second entity.

In some implementations of the method, the CXL request comprises a CXL.cache Device-to-Host (D2H) request comprising a read opcode selected from RdCurr, RdShared, RdOwn, or RdAny, and a command queue identifier (CQID); and wherein the UPLI request comprises a read command, a ReqTag, a ReqSrcPhysAccID, and a ReqDstPhysAccID; and wherein the CXL response comprises a CXL.cache Host-to-Device (H2D) response and a CXL.cache H2D Data. The CXL.cache D2H request path may be utilized when the first entity is a CXL device that sends D2H requests to the computer acting as CXL host. The computer may translate D2H read opcodes to UPLI read commands and may return an H2D response, such as GO with appropriate MESI state, and H2D Data carrying the fetched data to the first entity.

In some implementations of the method, the CXL request comprises a CXL.mem Master-to-Subordinate (M2S) request comprising MemRd* and a Tag, and the UPLI request comprises a read command and a ReqTag; and wherein the CXL response comprises a CXL.mem Subordinate-to-Master Data Response (S2M DRS) comprising MemData and the Tag. The CXL.mem path may be utilized when the first entity communicates via the CXL.mem M2S channel. The MemRd* opcode may include MemRd, MemRdData, or other read variants defined by the CXL.mem specification. The S2M DRS may carry the requested data with the MemData opcode and the Tag for correlation with the original M2S request.

In some implementations of the method, the CXL request comprises a CXL.io Memory Read (MRd) request comprising a first Tag, and the UPLI request comprises a read command and a ReqTag; and wherein the CXL response comprises a CXL.io Completion with Data (CpID) comprising the first Tag. The CXL.io path may be utilized when the first entity communicates via CXL.io transactions. The MRd request may include address and Tag fields, and the CpID completion may carry the requested data with the first Tag for correlation.

In some implementations of the method, the first address belongs to a first address space and the second address belongs to a second address space different from the first address space; wherein the first address space comprises a Host Physical Address (HPA) space, and the second address space comprises a Network Physical Address (NPA) space. Address translation may be performed utilizing lookup tables, base-and-offset calculations, or programmable translation functions. HPA addresses utilized by CXL-based traffic may be translated to NPA addresses utilized by UALink-based traffic for routing within the UALink network. In other examples, the first address space and the second address space may be associated with the same address space, such as a global address space, a pod address space, or a fabric address space.

In some implementations of the method, the CXL request comprises a CXL transaction identifier, the UPLI request comprises a ReqTag, the UPLI response comprises a RdRspTag matching the ReqTag. and the CXL response comprises the CXL transaction identifier; and wherein the computer maintains a mapping between the CXL transaction identifier and the ReqTag. The CXL transaction identifier may include a CXL.io Tag, a CXL.mem Tag, a CXL.cache CQID, or a CXL.cache UQID. The bidirectional mapping may be stored in a translation table, a tracker entry, or similar data structure to enable proper correlation of UPLI responses with their corresponding CXL requests.

In some implementations of the method, the CXL request comprises write data, the UPLI request comprises a write command, and translating the CXL request further comprises sending originator data comprising the write data on a UPLI Originator Data (OrigData) channel; and wherein the UPLI response comprises a UPLI write response (WrRsp) comprising a WrRspTag and a WrRspStatus. Write translation may enable the first entity to store data in memory accessible to the second entity across the CXL and UALink protocol domain boundaries. The WrRspStatus may indicate success or failure of the write operation. The OrigData channel may carry the write data in one or more beats from the computer to the second entity.

In some implementations of the method, the first entity comprises at least one of: a CXL host, a CXL device, or a CXL accelerator; and wherein the second entity comprises an accelerator coupled to a UALink network; and wherein the computer comprises a resource provisioning unit (RPU). The RPU may translate between CXL and UPLI domains and may be implemented as a discrete component, an IP block embedded in a processor, or a chiplet within an IC package. The first entity type may determine which CXL channel and message direction is utilized for the translation.

In some implementations of the method, a transfer size indicated by the CXL request differs from a maximum transfer size of a single UPLI request; and wherein translating the CXL request comprises generating UPLI requests or consolidating CXL requests into a UPLI request. UPLI may support transfer sizes up to 256 bytes per request while CXL.cache transactions may handle up to 64 bytes each. The computer may split or consolidate transactions to accommodate the transfer size differences between the two protocol domains, and may manage the transactions while maintaining the appearance of a single operation to the initiating entity.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In heterogeneous computing architectures, entities on different protocol domains may need to access resources across protocol boundaries. An apparatus comprising a CXL interface and a UPLI interface may provide bidirectional translation capability, enabling CXL entities to access UALink resources and UALink entities to access CXL device resources. The apparatus may include a computer that translates CXL requests to UPLI requests in one direction, and UPLI requests to CXL.cache H2D requests (snoops) in the other direction, thereby bridging the two protocol domains. The apparatus may be implemented as a switch, a bridge, a semiconductor device, a chiplet within an IC package, or other suitable form factor.

In various implementations, an apparatus comprising: a first interface configured to communicate according to Compute Express Link (CXL) with a first entity; a second interface configured to communicate according to an Ultra Accelerator Link Protocol Level Interface (UPLI) with a second entity; and a computer coupled between the first interface and the second interface, the computer configured to: translate a CXL request received from the first entity via the first interface to a UPLI request transmitted to the second entity via the second interface; and translate a UPLI response received from the second entity via the second interface to a CXL response transmitted to the first entity via the first interface. The apparatus may provide translation between CXL and UPLI for various CXL channels, including CXL.cache, CXL.mem, and CXL.io. The first interface may expose the computer as a CXL host, a CXL device, or a CXL Type-2 device to the first entity, depending on the system configuration. The second interface may communicate with the second entity utilizing a UPLI completer or originator interface. The computer may include translation logic, address translation tables, Tag mapping structures, and pending transaction trackers. In some examples, the apparatus may be implemented in an IC package having high-speed differential I/O balls positioned according to a ball grid array layout defined by a retimer specification, may utilize UCIe for die-to-die connectivity, or may be implemented as a chiplet within an IC package.

In some implementations of the apparatus, the first interface is further configured to receive CXL.cache Device-to-Host (D2H) requests from the first entity, the first entity comprising a CXL device; and wherein the computer is further configured to translate a CXL.cache D2H request comprising a read opcode and a CQID to a UPLI request comprising a read command and a ReqTag. The CXL device may be a CXL accelerator, a CXL memory expander, or a GFD. The computer acting as CXL host may translate D2H read opcodes such as RdCurr, RdShared, or RdOwn to UPLI read commands, and may return H2D responses and H2D Data to the CXL device after receiving the UPLI response.

In some implementations of the apparatus, the computer is further configured to: translate a UPLI request received from the second entity via the second interface to a CXL.cache Host-to-Device (H2D) request comprising a snoop opcode selected from SnpCur, SnpData, or SnpInv, and transmit the CXL.cache H2D request to the first entity via the first interface; and translate a CXL.cache D2H response and a CXL.cache D2H Data received from the first entity via the first interface to a UPLI read response (RdRsp), and transmit the UPLI RdRsp to the second entity via the second interface. The bidirectional capability may enable UALink entities to access resources associated with a CXL device. The computer may translate D2H responses such as RspVFwdV (in response to SnpCur) or RspSFwdM (in response to SnpData) to UPLI RdRsp messages for the second entity, and may map UQID values from H2D requests to corresponding UPLI ReqTag values in the RdRsp.

In some implementations of the apparatus, the computer is further configured to select the snoop opcode according to at least one of: a cacheline state intent identified based on the UPLI request, or a caching policy; wherein SnpData is selected for a cacheline intended to be cached in shared or exclusive state, and SnpCur is selected for reading current data without requiring a change of cache state. SnpCur may be selected for non-state-changing reads, such as I/O-coherent operations from the UALink network, while SnpData may be selected when the computer intends to cache the data locally. The caching policy may be configurable and may vary based on the source or characteristics of the UPLI request.

In some implementations of the apparatus, the computer comprises a resource provisioning unit (RPU) implemented as a chiplet within an integrated circuit (IC) package of a processor, the processor further comprising a CXL root port (RP) coupled to an on-chip coherent interconnect; and wherein the RPU is configured to translate a UPLI request received from the second entity via the second interface to a CXL.cache D2H request transmitted to the CXL RP. The RPU chiplet may expose a UALink port to external entities and a CXL endpoint to the processor's CXL RP. An R2CXL interface within the RPU may communicate with the on-chip coherent interconnect, such as ARM CHI, Intel UPI, or AMD Infinity Fabric. The RPU may be implemented on a separate die within the IC package or as a functional block on the processor die.

In some implementations of the apparatus, the computer comprises or controls a cache; and wherein the computer is configured to perform a cache lookup based on the CXL request and, on a cache hit, to generate the CXL response from the cache without transmitting the UPLI request to the second entity. The cache may store recently accessed data from either the CXL or UPLI domain, reducing latency for repeated accesses. On a cache miss, the computer may proceed with the UPLI translation path. The cache may be internal to the computer or external but controlled by the computer, and may store cachelines associated with the NPA space or the HPA space.

In AI inference systems, accelerators may execute inference workloads on neural network models that require access to model data distributed across accelerators. When a first accelerator communicating according to CXL needs to access model data stored in the memory of a second accelerator communicating according to UPLI, a computer may translate between CXL and UPLI to enable cross-protocol access. This translation may enable CXL-connected accelerators to access weight parameters, activation tensors, embedding vectors, key-value cache entries, and other model data residing on UALink-connected accelerators, supporting disaggregated inference architectures where model data is distributed across heterogeneous compute elements coupled via different interconnect protocols.

In various implementations, a method comprising: executing, by a first accelerator, an inference workload on a neural network model; sending, by the first accelerator, a Compute Express Link (CXL) request for model data stored in a memory of a second accelerator, the CXL request comprising a first address; translating, by a computer, the CXL request to an Ultra Accelerator Link Protocol Level Interface (UPLI) request comprising a second address; sending the UPLI request to the second accelerator; receiving, from the second accelerator, a UPLI response comprising the model data; translating, by the computer, the UPLI response to a CXL response comprising the model data; and sending the CXL response to the first accelerator. The method may enable a CXL-connected accelerator to access model data stored in the memory of a UALink-connected accelerator without requiring both accelerators to utilize the same interconnect protocol. The first accelerator may be a CXL device, a CXL accelerator, or another CXL-connected compute element that executes inference computation and generates requests for model data. The second accelerator may be a GPU, a TPU, or another accelerator coupled to a UALink network, wherein the model data resides in the second accelerator's local memory, such as HBM and/or HBF. The computer may translate between CXL requests and UPLI requests, including address translations between address spaces utilized by the CXL and UALink domains, opcode translations, and Tag translations. The neural network model may include a transformer-based model, a convolutional neural network, a recurrent neural network, a mixture-of-experts model, a hybrid attention and state-space model, a multimodal model, or other model architectures utilized for inference. The method may be implemented in hardware, firmware, software, or combinations thereof.

In some implementations of the method, the model data comprises at least one of: weight parameters, activation tensors, embedding vectors, or attention parameters associated with the neural network model. Different model data types may be stored across accelerators based on memory capacity, bandwidth requirements, and access patterns. Weight parameters and embedding vectors may be pre-loaded, while activation tensors and attention parameters may be generated and accessed dynamically during inference computation.

In some implementations of the method, the neural network model comprises a mixture-of-experts (MoE) model comprising a gating network and expert sub-networks, and wherein the model data comprises weight parameters of at least one expert sub-network; and wherein the CXL request is sent based on a routing decision of the gating network indicating that the at least one expert sub-network is to be activated. MoE models may have more expert sub-networks than can fit simultaneously in a single accelerator's memory. Fetching expert weights on demand from the second accelerator via CXL-to-UPLI translation may enable serving MoE models whose aggregate expert weights exceed the first accelerator's local memory capacity.

In some implementations of the method, the model data comprises key-value (KV) cache entries generated during attention computation in a transformer-based neural network model, the KV cache entries comprising key tensors and value tensors associated with one or more attention layers; and wherein the memory of the second accelerator comprises at least one of high-bandwidth memory (HBM) or High-Bandwidth Flash (HBF). KV cache entries may grow proportionally to sequence length and the number of attention layers. Storing KV cache data in HBM and/or HBF of the second accelerator and accessing it via CXL-to-UPLI translation may enable processing longer sequences or serving more concurrent inference requests than the first accelerator's local memory can support.

In some implementations, the method further comprises sending, by the first accelerator, a CXL write request comprising inference context data and a third address; translating, by the computer, the CXL write request to a UPLI write request comprising a fourth address and originator data comprising the inference context data; sending the UPLI write request to the second accelerator; and storing the inference context data in the memory of the second accelerator. Write translation may enable the first accelerator to store intermediate inference results, activation checkpoints, updated KV cache entries, or other inference context data in the second accelerator's memory across the CXL and UALink protocol domain boundaries.

In some implementations of the method, the first accelerator is coupled to the computer via CXL.cache, the second accelerator is coupled to the computer via a UALink port; and wherein the CXL request comprises a CXL.cache Device-to-Host (D2H) request comprising a read opcode, and the CXL response comprises a CXL.cache Host-to-Device (H2D) Data comprising the model data. The CXL.cache D2H request path may be utilized when the first accelerator is a CXL device that sends D2H requests to the computer acting as CXL host. The computer may translate the read opcode, such as RdCurr or RdShared, to a UPLI read command targeting the second accelerator.

In computing systems where accelerators are coupled via a UALink switch, a CXL-connected entity may need to access the local memory of those accelerators across the CXL and UALink protocol domain boundaries. The aggregate local memory capacity of accelerators connected via a UALink switch may exceed the memory directly accessible to any single CXL entity, creating a memory capacity challenge. A computer positioned between the CXL entity and the switch may translate between CXL and UPLI to enable the CXL entity to access the distributed local memory of the accelerators, effectively extending the accessible memory pool beyond the limitations of the CXL entity's directly attached memory. This system topology may support disaggregated memory architectures, tiered memory hierarchies, and heterogeneous compute clusters where entities communicating via different protocols share access to accelerator memory resources.

In various implementations, a system comprising: a first entity configured to communicate according to Compute Express Link (CXL); a switch; accelerators coupled to the switch and configured to communicate according to an Ultra Accelerator Link Protocol Level Interface (UPLI), wherein each accelerator of the accelerators comprises a local memory; and a computer coupled between the first entity and the switch, the computer configured to: translate a CXL request from the first entity to a UPLI request, and send the UPLI request to an accelerator of the accelerators via the switch; and translate a UPLI response from the accelerator to a CXL response, and send the CXL response to the first entity; wherein the first entity accesses at least portions of the local memory of at least two of the accelerators via the computer and the switch. The system may enable a CXL entity to access at least portions of the distributed local memory of accelerators connected via a switch, bridging the CXL and UALink protocol domains. The switch may be a UALink switch, a multi-protocol switch, or another switch that provides connectivity between the accelerators. The computer may translate CXL requests from the first entity to UPLI requests targeting specific accelerators, and may translate UPLI responses back to CXL responses. The computer may perform address translations, Tag translations, and opcode translations between the CXL and UPLI domains. The local memory of each accelerator may include HBM, HBF, GDDR, or other memory types. In some examples, the computer may be embedded within one of the accelerators, may be a discrete component coupled to the switch, or may be implemented as a chiplet within an IC package. The system may support both read and write operations across the protocol domain boundaries, enabling bidirectional data access between the first entity and the accelerators.

In some implementations of the system, an aggregate local memory capacity of the accelerators exceeds a memory capacity directly accessible to the first entity; and wherein the switch is a UALink switch, and the first entity accesses the aggregate local memory capacity via the computer and the UALink switch. The aggregate memory capacity may span the local memory of accelerators, enabling workloads that exceed any single entity's memory capacity. The UALink switch may route UPLI requests to specific accelerators based on routing fields such as ReqDstPhysAccID.

In some implementations of the system, the first entity comprises a CXL host coupled to host memory, the host memory comprising DDR5; and wherein the local memory of each accelerator of the accelerators comprises at least one of high-bandwidth memory (HBM) or High-Bandwidth Flash (HBF). DDR5 host memory may serve as a lower-bandwidth, higher-capacity memory tier, while HBM on the accelerators provides high-bandwidth access for compute-intensive operations. The translation may enable the CXL host to access the combined HBM capacity of the accelerator fleet.

In some implementations of the system, the first entity comprises a CXL device or a CXL accelerator coupled to the computer via CXL.cache; and wherein the computer is further coupled to a host via CXL. A CXL device or CXL accelerator coupled via CXL.cache may initiate D2H requests to access accelerator memory on the UALink network. The host may provide CXL connectivity and may expose UALink-accessible resources to the first entity via the computer's address mapping.

In some implementations of the system, the CXL request comprises a first address in a first address space, and the UPLI request comprises a second address in a second address space; wherein the first address space comprises a Host Physical Address (HPA) space and the second address space comprises a Network Physical Address (NPA) space; and wherein the switch is a UALink switch that routes the UPLI request to the accelerator based on a ReqDstPhysAccID field of the UPLI request. Address translation from HPA to NPA may enable routing of requests from the CXL domain to specific accelerators within the UALink network. The ReqDstPhysAccID may identify the target accelerator, and the UALink switch may utilize this field for routing decisions.

In some implementations of the system, the computer is further configured to translate a CXL write request from the first entity to a UPLI write request comprising originator data, and send the UPLI write request to the accelerator via the switch; wherein data from the first entity is stored in the local memory of the accelerator. Write operations may enable the first entity to pre-stage data, update shared state, or store computation results in accelerator local memory across the CXL and UALink protocol domain boundaries.

In some implementations, the system further comprises a second CXL entity configured to communicate according to CXL; wherein both the first entity and the second CXL entity communicate with the accelerators via the computer, and the computer translates between CXL and UPLI for both the first entity and the second CXL entity; and wherein the first entity, the second CXL entity, and the accelerators form a heterogeneous compute cluster in which the first entity and the second CXL entity access the local memory of the accelerators. The heterogeneous compute cluster may be analogous to a super chip architecture where compute elements with different protocol interfaces are unified through the computer's translation capability. The computer may maintain separate translation contexts for each CXL entity, including independent address mappings, Tag translations, and transaction queues, enabling isolated and concurrent access to accelerator memory.

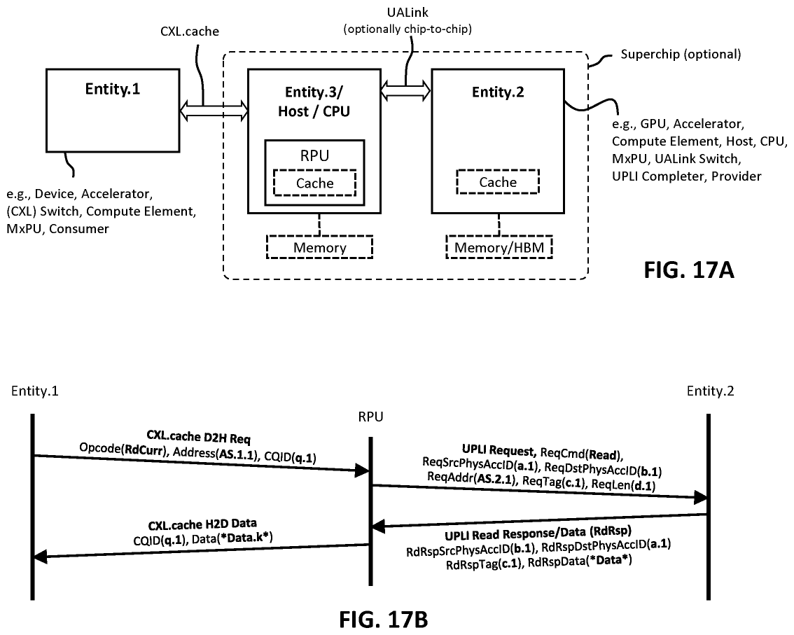

FIG. 17A illustrates an example of a system comprising a first entity (Entity.1), which may be a CXL device, an accelerator, a compute element, a switch, or an MxPU, coupled over CXL.cache to a third entity (Entity.3), which may be a host or a CPU. The third entity may be coupled over UALink, optionally via a chip-to-chip interface, to a second entity (Entity.2), which may be a GPU, an accelerator, a compute element, a host, a CPU, an MxPU, a UALink switch, a UPLI Completer, or a Provider. The third entity may include an RPU and a cache, and may be coupled to memory. The second entity may include a cache and may be coupled to memory, such as HBM and/or HBF. Resources accessible to the third entity via UALink may be mapped to the HPA space of the third entity, and therefore may also be accessible to the first entity over CXL.cache. The second and third entities may be manufactured as a superchip, wherein the first entity, the third entity, and the second entity form a heterogeneous compute cluster in which the first and second entities may access the memory of each other via the RPU.

FIG. 17B illustrates an example of a TFD demonstrating translations, such as protocol translations, between a CXL.cache D2H request received from a first entity (Entity.1), which may be a CXL device, an accelerator, or a compute element, and a UPLI request sent to a second entity (Entity.2), which may be an accelerator or another UALink entity, via an RPU. The first entity may initiate a CXL.cache transaction that may include a CXL.cache D2H request comprising Opcode(RdCurr), Address(AS.1.1), and CQID(q.1). The RPU may translate the CXL.cache D2H request to a UPLI request comprising ReqCmd(Read), ReqSrcPhysAccID(a.1), ReqDstPhysAccID(b.1), ReqAddr(AS.2.1), ReqTag(c.1), and ReqLen(d.1), and may send the UPLI request to the second entity. Upon receiving from the second entity a UPLI read response/data (RdRsp) comprising RdRspSrcPhysAccID(b.1), RdRspDstPhysAccID(a.1), RdRspTag(c.1), and RdRspData(*Data*). The RPU may translate the UPLI RdRsp to a CXL.cache H2D response comprising GO-I (for RdCurr) or GO-S and CQID(q.1), and a CXL.cache H2D Data comprising CQID(q.1) and Data(*Data.k*), and may send the CXL.cache H2D Data to the first entity. This translation from CXL.cache to UALink may enable CXL-connected entities to access resources, such as memory, residing on the UALink network, including resources of UALink-connected accelerators. The RPU may perform additional translations, such as address translations between physical addresses carried in CXL.cache requests and physical addresses carried in UPLI requests, and may further perform opcode translations, Tag-to-ReqTag translations, and field translations between the CXL.cache domain and the UPLI domain.

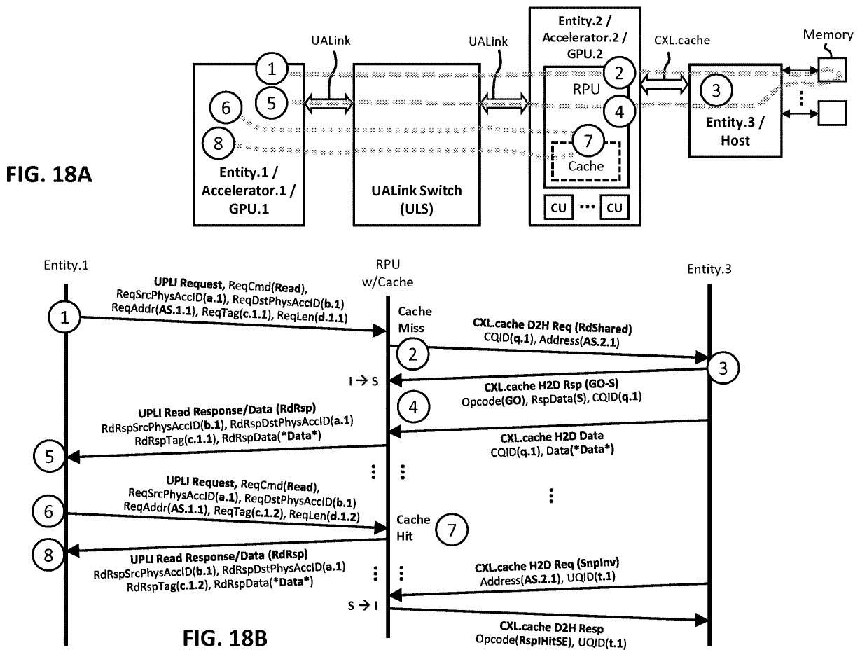

FIG. 18A illustrates an example of a system comprising a first entity (Entity.1), which may be an accelerator or a GPU (Accelerator.1/GPU.1), coupled via UALink to a UALink switch (ULS). The UALink switch is coupled via UALink to a second entity (Entity.2), which may be an accelerator or a GPU (Accelerator.2/GPU.2). The second entity may include an RPU and a cache, and may further include one or more Compute Units (CUs). The second entity may be coupled via CXL.cache to a third entity (Entity.3), which may be a host coupled to memory. The RPU may service memory transactions received from the CUs and UPLI transactions received from the first entity via the UALink switch. In some examples, the RPU may include the cache or may control a cache that is external to the RPU, and may perform cache lookups to service requests from the cache without forwarding the requests to the third entity via CXL.cache. The RPU may perform address translations between a first address space utilized by UALink-based traffic, such as NPA space, and a second address space utilized by CXL.cache, such as HPA space, prior to performing cache lookups or forwarding requests to the third entity.

FIG. 18B illustrates an example of a TFD demonstrating how an RPU comprising a cache (RPU w/Cache) may handle UPLI read requests received from a first entity (Entity.1) and translated to CXL.cache requests directed to a third entity (Entity.3), such as a host. The TFD shows three transaction sequences: a cache miss sequence, a cache hit sequence, and a snoop invalidation sequence. In the cache miss sequence (denoted by Circles 1 through 5), Entity.1 sends a UPLI request (Req) comprising a read command (ReqCmd(Read)), a source physical accelerator identifier (ReqSrcPhysAccID(a.1)), a destination physical accelerator identifier (ReqDstPhysAccID(b.1)), a request address (ReqAddr(AS.1.1)), a request tag (ReqTag(c.1.1)), and a request length (ReqLen(d.1.1)) to the RPU (Circle 1). The RPU performs a cache lookup based on the request address and determines a cache miss (Circle 2). Responsive to the cache miss, the RPU translates the UPLI request to a CXL.cache D2H request comprising RdShared, a command queue identifier (CQID(q.1)), and an address (Address(AS.2.1)), and sends the CXL.cache D2H request to Entity.3. The address AS.2.1 may represent a host physical address (HPA) translated from the network physical address (NPA) AS.1.1 carried in the UPLI request. Entity.3 responds with a CXL.cache Host-to-Device (H2D) response comprising a Global Observation (GO) opcode with GO-S, a response data value (RspData(S)) indicating Shared state, and the CQID(q.1) (Circle 3), followed by a CXL.cache H2D Data message comprising CQID(q.1) and the requested data (Data(*Data*)) (Circle 3). The RPU stores the data in the cache and transitions the cacheline state from Invalid (I) to Shared (S) responsive to receiving the GO-S response (Circle 4, denoted by the I to S transition). The RPU then translates the CXL.cache H2D Data to a UPLI read response/data (RdRsp) comprising RdRspSrcPhysAccID(b.1), RdRspDstPhysAccID(a.1), RdRspTag(c.1.1), and RdRspData(*Data*), and sends the UPLI RdRsp to Entity.1 (Circle 5).

In the cache hit sequence (denoted by Circles 6 through 8), Entity.1 sends a second UPLI request (Req) comprising a read command to the same address (ReqAddr(AS.1.1)) with a different request tag (ReqTag(c.1.2)) and request length (ReqLen(d.1.2)) to the RPU (Circle 6). The RPU performs a cache lookup and determines a cache hit (Circle 7) because the data for address AS.1.1 is already stored in the cache from the previous cache miss sequence. Responsive to the cache hit, the RPU sends a UPLI read response/data (RdRsp) comprising the data from the cache (RdRspData(*Data*)) to Entity.1 (Circle 8) without sending any CXL.cache request to Entity.3. The cache hit sequence demonstrates that the RPU may serve repeated requests for the same data directly from the cache, avoiding cross-protocol translation and the latency associated with fetching data from Entity.3.

In the snoop invalidation sequence, Entity.3 sends a CXL.cache H2D request comprising SnpInv (snoop invalidate) targeting the address (Address(AS.2.1)) and a UQID(t.1) to the RPU. SnpInv indicates that Entity.3 is requesting invalidation of the cacheline, which may be triggered when another agent requests exclusive ownership of the cacheline. The RPU transitions the cacheline state from Shared (S) to Invalid (I) (denoted by the S to I transition) and responds with a CXL.cache Device-to-Host (D2H) response comprising RspIHitSE and UQID(t.1). The RspIHitSE opcode indicates that the cacheline was found in a clean state (Shared or Exclusive) and is now Invalid, allowing Entity.3 to assume that the cacheline has been cleared from the RPU's cache.

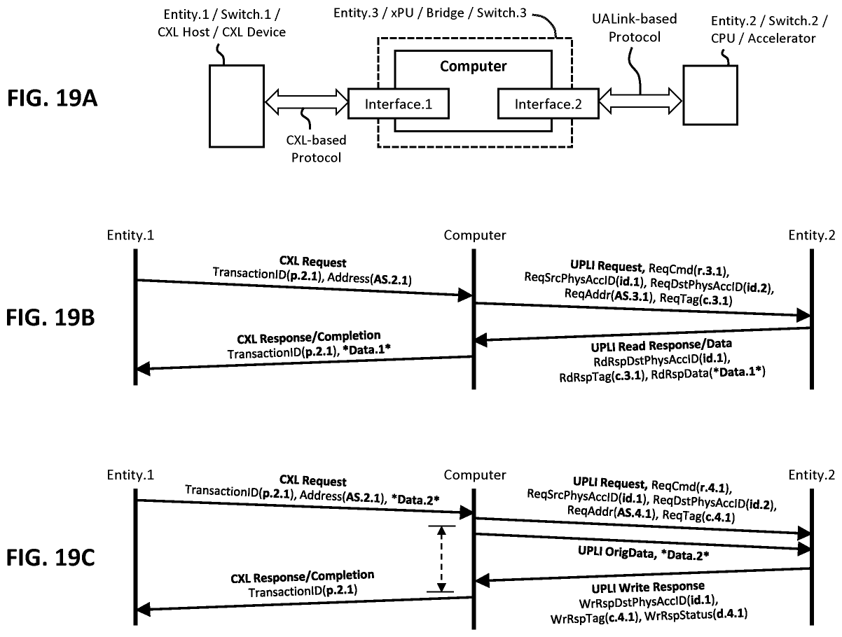

FIG. 19A illustrates an example of a system comprising a third entity (Entity.3), such as an xPU, a bridge, or a third switch (Switch.3) that may include a CXL switch or a UALink switch. The third entity includes a computer comprising a first interface (Interface.1) and a second interface (Interface.2). The first interface may communicate according to a CXL-based protocol, such as CXL.io, CXL.mem, or CXL.cache, with a first entity (Entity.1), such as a first switch (Switch.1), a CXL host, or a CXL device which may be a CXL memory expander, a CXL-based memory pool, a GFD, or a CXL accelerator. The second interface may communicate according to a UALink-based protocol, such as UPLI, with a second entity (Entity.2), such as a second switch (Switch.2), a CPU, or an accelerator. The computer may perform translations, such as protocol translations between the CXL-based protocol and the UALink-based protocol, transaction translations, protocol data unit (PDU) translations, message translations, and/or address translations between the CXL-based protocol domain and the UALink-based protocol domain. In some examples, the computer may extract addresses from requests received via the first interface, wherein these addresses may refer to a first address space, such as a Host Physical Address (HPA) space utilized by the first entity. The computer may translate these addresses, and generate requests carrying the translated addresses for transmission via the second interface; wherein these translated addresses may refer to a second address space, such as a Network Physical Address (NPA), utilized by the second entity. In other examples, the first address space and the second address space may be associated with the same address space, such as a common address space, a global address space, a pod address space, or a fabric address space, wherein the computer may perform address translations between addresses within the same common address space. In some examples, the computer may be implemented in a chiplet, may utilize UCIe for chip-to-chip or die-to-die connectivity, or may be implemented in an IC package having high-speed differential I/O balls positioned according to a ball grid array layout defined by a retimer specification.

FIG. 19B illustrates an example of a TFD demonstrating translations, such as protocol translations, transaction translations, protocol data unit (PDU) translations, message translations, and/or address translations, which may be performed by a computer, between a CXL-based protocol, such as CXL.io, CXL.mem, or CXL.cache, utilized by a first entity (Entity.1), such as a first switch (Switch.1), a CXL host, or a CXL device, and a UALink-based protocol, such as UPLI, utilized by a second entity (Entity.2), such as a second switch (Switch.2), a CPU, or an Accelerator. The first entity may initiate a CXL transaction that may include a CXL request comprising TransactionID(p.2.1) and Address(AS.2.1). In some examples, the TransactionID, such as a CXL.io Tag, a CXL.mem Tag, a CXL.cache CQID, or a CXL.cache UQID, may be utilized by the computer as a transaction identifier for matching responses or completions with requests, and may be further utilized to identify outstanding transactions in-flight. The computer may translate the CXL transaction to a UPLI transaction that may include a UPLI request comprising ReqCmd(r.3.1), such as Read or Read class Vendor Defined Command, ReqSrcPhysAccID(id.1), ReqDstPhysAccID(id.2), ReqAddr(AS.3.1), and ReqTag(c.3.1), and may send the UPLI request to the second entity. Upon receiving from the second entity a UPLI read response/data comprising RdRspDstPhysAccID(id.1), RdRspTag(c.3.1), and RdRspData(*Data.1*), the computer may translate the UPLI read response/data to a CXL response or completion (CXL Response/Completion) comprising TransactionID(p.2.1) and *Data.1*, and may send the CXL Response/Completion to the first entity.

The computer may perform further translations, such as opcode translations, command translations, TLP type translations, or other translations between the CXL-based protocol domain and the UALink-based protocol domain. In some examples, the computer may issue multiple UPLI request in response to receiving a CXL request from the first entity, such as when prefetching data from the second entity. The computer may translate transactions or requests initiated from the CXL-based protocol domain to the UALink-based protocol domain, may translate requests or transactions initiated from the UALink-based protocol domain to the CXL-based protocol domain, or may translate requests or transactions initiated from the protocol domains.

FIG. 19C illustrates an example of a TFD demonstrating translations, such as protocol translations, transaction translations, protocol data unit (PDU) translations, message translations, and/or address translations, which may be performed by a computer, between a CXL-based protocol, such as CXL.io, CXL.mem, or CXL.cache, utilized by a first entity (Entity.1), such as a first switch (Switch.1), a CXL host, or a CXL device, and a UALink-based protocol, such as UPLI, utilized by a second entity (Entity.2), such as a second switch (Switch.2), a CPU, or an Accelerator. The first entity may initiate a CXL transaction that may include a CXL request comprising TransactionID(p.2.1), Address(AS.2.1), and *Data.2*. In some examples, the TransactionID, such as a CXL.io Tag, a CXL.mem Tag, a CXL.cache CQID, or a CXL.cache UQID, may be utilized by the computer as a transaction identifier for matching responses or completions with requests, and may be further utilized to identify outstanding transactions in-flight. The computer may translate the CXL transaction to a UPLI transaction that may include a UPLI request comprising ReqCmd(r.4.1), such as Write or Write class Vendor Defined Command, ReqSrcPhysAccID(id.1), ReqDstPhysAccID(id.2), ReqAddr(AS.4.1), and ReqTag(c.4.1); and may further include a UPLI OrigData comprising *Data.2*; wherein the computer may send the UPLI transaction to the second entity. Upon receiving from the second entity a UPLI write response comprising WrRspDstPhysAccID(id.1), WrRspTag(c.4.1), and WrRspStatus(d.4.1), the computer may translate the UPLI write response to a CXL response or completion (CXL Response/Completion) comprising TransactionID(p.2.1), and may send the CXL Response/Completion to the first entity. The computer may perform further translations, such as opcode translations, command translations, TLP type translations, or other translations between the CXL-based protocol domain and the UALink-based protocol domain. The computer may translate transactions or requests initiated from the CXL-based protocol domain to the UALink-based protocol domain, may translate requests or transactions initiated from the UALink-based protocol domain to the CXL-based protocol domain, or may translate requests or transactions initiated from the protocol domains.

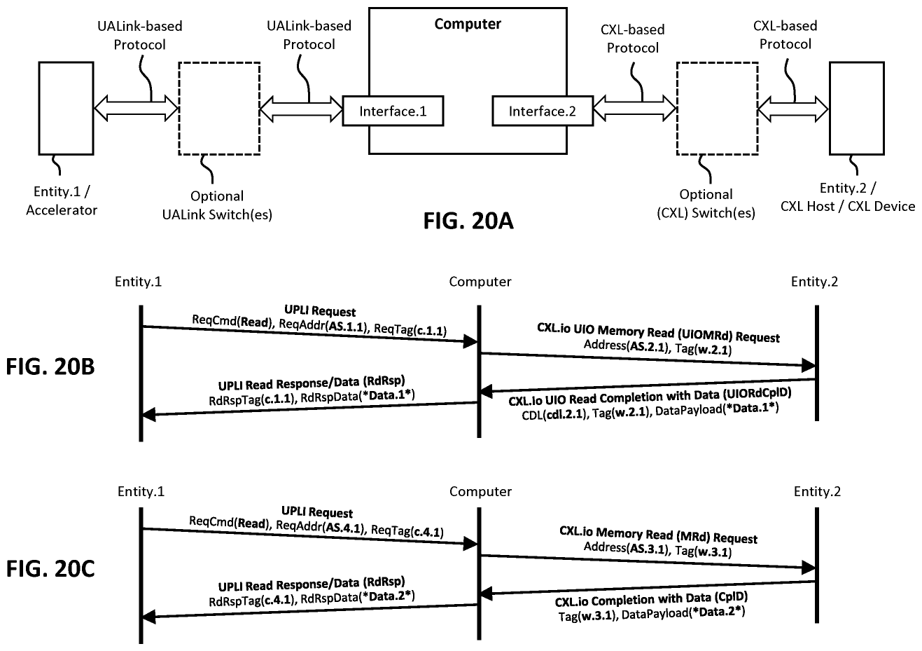

FIG. 20A illustrates an example of a system comprising a computer coupled between a first interface (Interface.1) and a second interface (Interface.2). The first interface may communicate according to a UALink-based protocol, such as UPLI, with a first entity (Entity.1), which may be an accelerator. The second interface may communicate according to a CXL-based protocol, such as CXL.io, with a second entity (Entity.2), which may be a CXL host or a CXL device. The computer may be implemented in an IC package having high-speed differential I/O balls positioned according to a ball grid array layout defined by a retimer specification, such as the PCIe 5.0, 6.0, or 7.0 Retimer Supplemental Features and Standard BGA Footprint Specification. The computer may extract physical addresses from requests received via the first interface, wherein these addresses may refer to a Network Physical Address (NPA) space utilized by the first entity. The computer may further translate these addresses, and generate requests carrying the translated physical addresses for transmission via the second interface; wherein these translated addresses may correspond to a Host Physical Address (HPA) space utilized by the second entity. Optional switches, such as UALink switch(es), may be positioned between the first interface and the first entity. Similarly, optional CXL switch(es) may be positioned between the second interface and the second entity.

FIG. 20B illustrates an example of a TFD demonstrating translations, optionally performed by a computer, between physical addresses carried in UALink-based requests, such as UPLI requests, received from a first entity (Entity.1), and physical addresses carried in CXL.io UIO TLPs sent to a second entity (Entity.2), possibly enabling the first entity to access resources mapped to an address space utilized by the second entity. The first entity may initiate a UPLI transaction that includes a UPLI request comprising ReqCmd(Read), ReqAddr(AS.1.1), and ReqTag(c.1.1). The computer may translate the UPLI transaction to a CXL.io UIO transaction that includes a CXL.io UIO Memory Read (UIOMRd) request comprising Address(AS.2.1) and Tag(w.2.1), and may send the CXL.io UIOMRd to the second entity. Upon receiving a completion from the second entity, which may include a CXL.io UIO Read Completion with Data (UIORdCpID) comprising CDL(cdl.2.1), Tag(w.2.1), and DataPayload(*Data.1*), wherein the CDL may be populated, by the CXL device (or alternatively by the CXL host), with information related to QoS, such as QoS telemetry value or values. The computer may translate the CXL.io UIORdCpID to a UPLI read response/data (RdRsp) comprising RdRspTag(c.1.1) and RdRspData(*Data.1*), and may send the UPLI RdRsp to the first entity. In some examples, the computer may issue multiple CXL.io UIO transactions in response to receiving a UPLI request from the first entity, such as when splitting a UPLI read request for a large block of data to smaller CXL.io UIO memory read requests, or when prefetching data from the second entity. The computer may translate requests or transactions initiated from the UALink-based domain to the CXL domain, may translate requests or transactions initiated from the CXL domain to the UALink-based domain, or may translate requests or transactions initiated from both the UALink-based domain and the CXL domain.

FIG. 20C illustrates an example of a TFD demonstrating translations between UALink-based requests, such as UPLI requests, received from a first entity (Entity.1), such as an accelerator, and CXL.io TLPs sent to a second entity (Entity.2), such as a CXL host or a CXL device, possibly enabling the first entity to access resources mapped to an address space utilized by the second entity. The first entity may initiate a UPLI transaction that includes a UPLI request comprising Request Command (e.g. ReqCmd(Read)), Request Address (e.g., ReqAddr(AS.4.1)), and Request Tag (e.g., ReqTag(c.4.1)). The computer may translate the UPLI transaction to a CXL transaction that includes a CXL.io Memory Read (MRd) request comprising Address(AS.3.1) and Tag(w.3.1), and may send the CXL.io MRd to the second entity. Upon receiving a completion from the second entity, which may include a CXL.io Completion with Data (CpID) comprising Tag(w.3.1) and DataPayload(*Data.2*), the computer may translate the CXL.io CpID to a UPLI RdRsp comprising Read Response Transaction Tag (e.g., RdRspTag(c.4.1)) and Read Response Data (e.g., RdRspData(*Data.2*)), and send the UPLI RdRsp to the first entity. The computer may perform further translations, such as protocol translations, opcode translations, command translations, TLP type translations, and translations between messages conforming to the UALink-based protocol (e.g., UPLI messages) and protocol data units (PDUs) of the CXL-based Protocol (e.g., CXL.io TLPs), Tag translations, traffic class (TC) translations, and/or cross-field translations. The computer may maintain tracking between Tags associated with the UALink-based protocol and Tags associated with the CXL-based protocol, such as in order to associate responses with their corresponding requests. In some examples, the computer may issue multiple CXL transactions in response to receiving a UPLI request from the first entity, such as when splitting a UPLI read request for a large block of data to smaller CXL.io memory read requests, or when prefetching data from the second entity. Moreover, the computer may translate requests or transactions initiated from the UALink-based domain to the CXL domain, may translate requests or transactions initiated from the CXL domain to the UALink-based domain, or may translate requests or transactions initiated from both the UALink-based domain and the CXL domain.

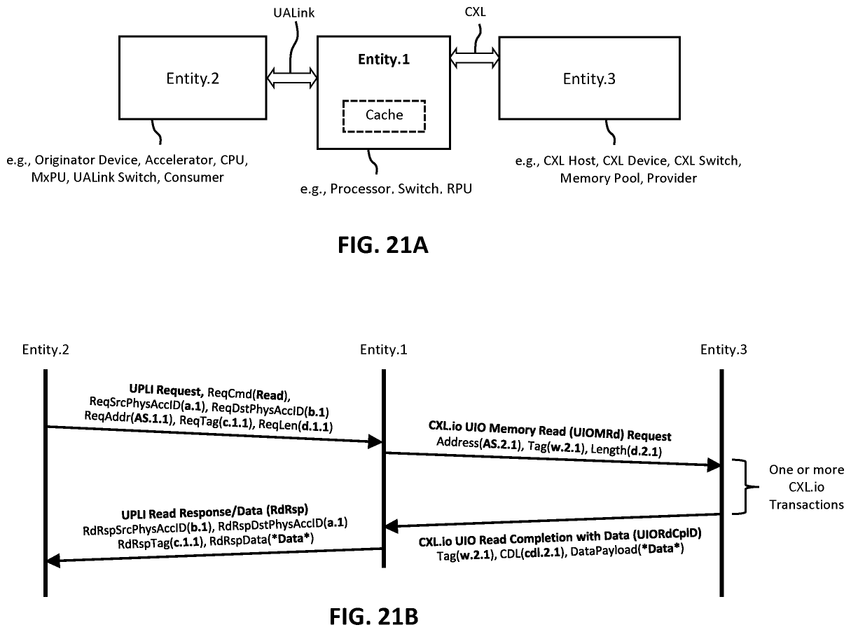

FIG. 21A illustrates an example of a system comprising a first entity (Entity.1), such as a processor, a switch, or an RPU, optionally comprising a cache, which enables UALink-based resource consumers to access resources coupled to the first entity, such as CXL hosts, CXL devices, or CXL memory. The first entity is coupled to a second entity (Entity.2), which may be a UALink-based originator device, an accelerator, a GPU, a CPU, an MxPU, a UALink switch, or a consumer, wherein the first entity may communicate with the second entity according to a UALink-based protocol, such as a UPLI. The first entity is further coupled to a third entity (Entity.3), which may be a CXL host, a CXL device, a CXL switch, a CXL-based memory pool, CXL memory, or a provider, wherein the first entity may communicate with the third entity according to a CXL-based protocol, such as at least one of CXL.io, CXL.mem, or CXL.cache. In some examples, the UALink-based protocol, such as UPLI, may be associated with a first address space, such as an NPA space, and the CXL-based protocol, such as CXL.io, may be associated with a second address space, such as a System Physical Address (SPA) space or a Host Physical Address (HPA) space; wherein the first entity may perform address translations between addresses within the first and second address spaces, respectively, such as between addresses within the NPA space and addresses within the SPA space or the HPA space.

In other examples, the UALink-based protocol, such as UPLI, and the CXL-based protocol, such as CXL.io, may be associated with the same physical address space, such as a global address space, a pod address space, or a fabric address space; wherein the first entity may perform address translations between addresses within the same address spaces. The first entity may perform further translations, such as opcode, command, or TLP translations, e.g., translating between Read commands in UPLI requests and MRd/UIOMRd TLPs in CXL.io requests. The first entity may further translate between messages conforming to UPLI and messages conforming to CXL, translate Tags, and/or translate error indications, such as data corruption indications or poison.

FIG. 21B illustrates an example of a TFD demonstrating a first entity (Entity.1), such as a processor, a switch, or an RPU, that may translate between UALink-based traffic, such as UPLI traffic, and CXL-based traffic, such as CXL.io traffic. Additionally or alternatively, the first entity, may translate between UPLI and CXL.mem traffic, and/or between UPLI and CXL.cache traffic. The first entity may receive from a second entity (Entity.2), which may be a UALink-based originator device, an accelerator, a GPU, a CPU, an MxPU, a UALink switch, or a consumer, a UALink UPLI transaction that may include a UPLI request comprising Request Command (e.g. ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., ReqAddr(AS.1.1)), Request Tag (e.g., ReqTag(c.1.1)), and Request Length (e.g., ReqLen(d.1.1)). The first entity may translate the UPLI transaction to a CXL.io transaction that may include CXL.io Memory Read (MRd) request or CXL.io UIO Memory Read (UIOMRd) request comprising Address(AS.2.1), Tag(w.2.1), and Length(d.2.1). Alternatively or additionally, the first entity may translate the UPLI transaction to a PCIe transaction that may include a PCIe MRd TLP or a PCIe UIOMRd TLP. The first entity may further translate between other fields of the UPLI transaction and fields of the CXL.io transaction, such as between addresses, Tags, QoS-related fields, or identifications (IDs), which may serve to route the UPLI request to its destination. In some examples, the first entity may translate a UPLI transaction to multiple CXL.io transaction, such as in order to split a large data read request (e.g., splitting a large 256 B UPLI read request to smaller 64 B CXL.io read requests), or in order to prefetch data, optionally into a cache that may be included in or coupled to the first entity.

The first entity (Entity.1) may further translate between CXL.io responses or completions, such as CXL.io Completion with Data (CpID) or CXL.io UIO Read Completion with Data (UIORdCpID), and UPLI responses, such as UPLI read responses, and may forward data carried in CXL.io completions into UPLI read responses. Alternatively or additionally, the first entity may further translate between PCIe responses or completions, such as a PCIe CpID TLP or a PCIe UIORdCpID TLP, and UPLI responses, such as UPLI read responses, and may forward data carried in PCIe completions into UPLI read responses. In some examples, upon receiving a response from the second entity, that may include a CXL.io UIORdCpID comprising Tag(w.2.1), CDL(cdl.2.1), and DataPayload(*Data*), the first entity may translate the CXL.io UIORdCpID to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), and Read Response Data (e.g., RdRspData(*Data*)). The CDL that may be included in the CXL.io UIORdCpID may be populated with information related to Quality-of-Service (QoS), such as QoS telemetry value or values. The first entity may translate information carried in the CDL and send it via one or more fields of the UPLI RdRsp, such as vendor-defined fields, custom fields, or reserved fields.

In some examples, the first entity (Entity.1) may accumulate data from one or more CXL.io TLPs, such as CpID TLPs or UIORdCpID TLPs, before sending the data via the UPLI read response. Optionally, the first entity may propagate error responses from the CXL domain to the UPLI domain, such as by translating error indications carried in CXL.io TLPs, such as poison, to error indications carried in UPLI RdRsp messages, such as Read Response Data Error (e.g., RdRspDataError). In some examples, the CXL protocol may support error forwarding (that may also be known as data poisoning), via indications such as an Error Poisoned (EP) bit in TLPs, or additionally, in some examples, through the use of Physical Layer Logical Block mechanisms.

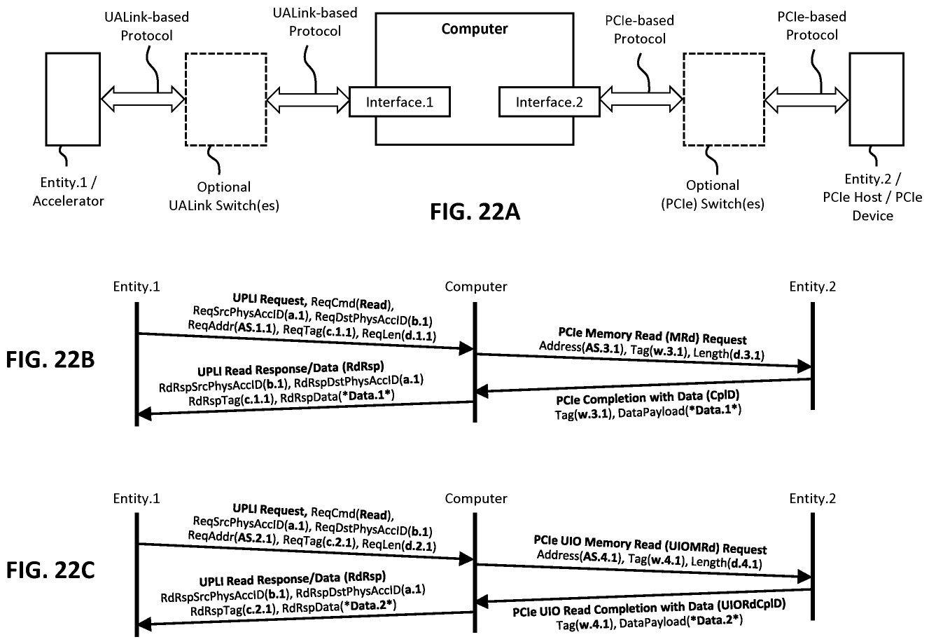

FIG. 22A illustrates an example of a system comprising a computer coupled between first and second interfaces. The first interface (Interface.1) may communicate according to a UALink-based protocol, such as UPLI, with a first entity (Entity.1), which may be an accelerator. The second interface (Interface.2) may communicate according to a PCIe-based protocol, such as a protocol conforming to PCI Express Base Specification Revision 6.2, with a second entity (Entity.2), which may be a PCIe host or a PCIe device. The computer may be implemented in an IC package having high-speed differential I/O balls positioned according to a ball grid array layout defined by a retimer specification, such as the PCIe 5.0, 6.0, or 7.0 Retimer Supplemental Features and Standard BGA Footprint Specification. The computer may extract physical addresses from requests received via the first interface, wherein these addresses may refer to a Network Physical Address (NPA) space utilized by the first entity. The computer may further translate these addresses, and generate requests carrying the translated physical addresses for transmission via the second interface; wherein these translated addresses may correspond to a Host Physical Address (HPA) space utilized by the second entity. Optional switches, such as UALink switch(es), may be positioned between the first interface and the first entity. Similarly, optional PCIe switch(es) may be positioned between the second interface and the second entity.

FIG. 22B illustrates an example of a TFD demonstrating translations between UALink-based requests, such as UPLI requests, received from a first entity (Entity.1), such as an accelerator, and PCIe TLPs sent to a second entity (Entity.2), such as a PCIe host or a PCIe device, possibly enabling the first entity to access resources mapped to an address space utilized by the second entity. The first entity may initiate a UPLI transaction that includes a UPLI request (Req) comprising Request Command (e.g. ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., physical addresses, such as NPAs ReqAddr(AS.1.1)), Request Tag (e.g., ReqTag(c.1.1)), and Request Length (e.g., ReqLen(d.1.1)). The computer may translate the UPLI transaction to a PCIe transaction that includes a PCIe Memory Read (MRd) request comprising physical addresses, such as Host Physical Addresses (HPAs), Address(AS.3.1), Tag(w.3.1), and Length(d.3.1), and may send the PCIe MRd to the second entity. Upon receiving a completion from the second entity, which may include a PCIe Completion with Data (CpID) comprising Tag(w.3.1) and DataPayload(*Data.1*), the computer may translate the PCIe CpID to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), and Read Response Data (e.g., RdRspData(*Data.1*)), and send the UPLI RdRsp to the first entity.

The computer may perform further translations, such as protocol translations, opcode translations, command translations, TLP type translations, and translations between messages conforming to the UALink-based protocol (e.g., UPLI messages) and protocol data units (PDUs) of the PCIe-based Protocol (e.g., PCIe TLPs), Tag translations, traffic class (TC) translations, and/or cross-field translations. The computer may maintain tracking between Tags associated with the UALink-based protocol and Tags associated with the PCIe-based protocol, such as in order to associate responses with their corresponding requests. In some examples, the computer may issue multiple PCIe transactions in response to receiving a UPLI request from the first entity, such as when splitting a UPLI read request for a large block of data to smaller PCIe memory read requests, or when prefetching data from the second entity.

In some examples, PCIe MRd and PCIe CpID TLPs may be utilized by legacy PCIe hosts or devices, whereas recent PCIe hosts or PCIe devices may utilize PCIe UIO Memory Read (UIOMRd) request and PCIe UIO Read Completion with Data (UIORdCpID) TLPs, leveraging the PCIe Unordered IO (UIO) optional capability, that is intended to address the limitations of the PCI/PCIe fabric-based ordering rules, and enables fabrics with multiple paths between a source and destination to be supported, optionally enabling higher-bandwidth communication. The computer may translate requests or transactions initiated from the UALink-based domain to the PCIe domain, may translate requests or transactions initiated from the PCIe domain to the UALink-based domain, or may translate requests or transactions initiated from both the UALink-based domain and the PCI domain.

FIG. 22C illustrates an example of a TFD demonstrating translations between physical addresses carried in UALink-based requests, such as UPLI requests, received from a first entity (Entity.1), and physical addresses carried in PCIe UIO TLPs sent to a second entity (Entity.2), possibly enabling the first entity to access resources mapped to an address space utilized by the second entity. The first entity may initiate a UPLI transaction that includes a UPLI request (Req) comprising ReqCmd(Read), ReqSrcPhysAccID(a.1), ReqDstPhysAccID(b.1), ReqAddr(AS.2.1), ReqTag(c.2.1), and ReqLen(d.2.1). The computer may translate the UPLI transaction to a PCIe UIO transaction that includes a PCIe UIOMRd comprising Address(AS.4.1), Tag(w.4.1), and Length(d.4.1), and may send the PCIe UIOMRd to the second entity. Upon receiving a completion from the second entity, which may include a PCIe UIORdCpID comprising Tag(w.4.1) and DataPayload(*Data.2*), the computer may translate the PCIe UIORdCpID to a UPLI RdRsp comprising RdRspSrcPhysAccID(b.1), RdRspDstPhysAccID(a.1), RdRspTag(c.2.1), and RdRspData(*Data.2*), and may send the UPLI RdRsp to the first entity. In some examples, the computer may issue multiple PCIe UIO transactions in response to receiving a UPLI request from the first entity, such as when splitting a UPLI read request for a large block of data to smaller PCIe UIO memory read requests, or when prefetching data from the second entity. The computer may translate requests or transactions initiated from the UALink-based domain to the PCIe domain, may translate requests or transactions initiated from the PCIe domain to the UALink-based domain, or may translate requests or transactions initiated from both the UALink-based domain and the PCI domain.

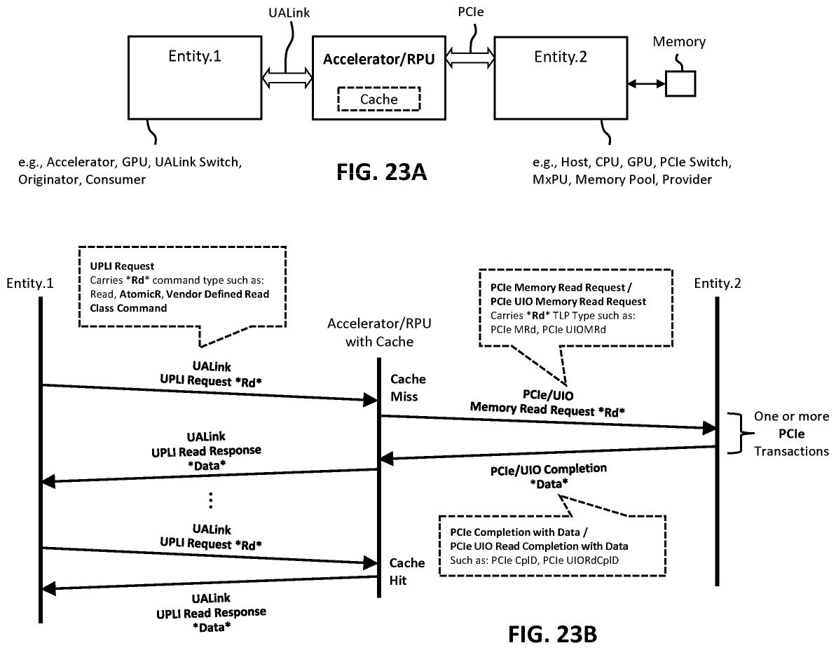

FIG. 23A illustrates an example of a system comprising an accelerator or an RPU, denoted as Accelerator/RPU, which may include a cache, wherein the Accelerator/RPU may translate between a UALink-based protocol, such as UPLI, and a PCIe-based protocol, such as a PCIe protocol. The Accelerator/RPU may be coupled to a first entity (Entity.1), which may be an accelerator, a GPU, a first processor, a UALink Switch, a UALink-based originator, or a resource consumer, wherein the Accelerator/RPU may communicate with the first entity according to a UALink-based protocol, such as UPLI. The Accelerator/RPU may be further coupled to a second entity (Entity.2), which may be a host, a CPU, a GPU, a second processor, a PCIe switch, a memory pool, or a resource provider, wherein the second entity may be coupled to a memory, and wherein the Accelerator/RPU may communicate with the second entity according to a PCIe-based protocol. The Accelerator/RPU may translate between the UALink-based protocol, such as UPLI, and the PCIe-based protocol, enabling the first entity to access resources coupled to the second entity, such as the memory.

The Accelerator/RPU may cache data retrieved from the second entity and may respond to UPLI requests received from the first entity with data from the cache, instead of issuing read requests to the second entity. Additionally or alternatively, the Accelerator/RPU may prefetch data from the second entity into the cache. The Accelerator/RPU may perform further translations between the UALink-based domain and the PCIe-based domain, such as protocol translations, e.g., UALink to PCIe or UPLI to PCIe translations. The Accelerator/RPU may further perform opcode translations, command translations, TLP translations, and translations between messages conforming to the UALink-based protocol and PDUs conforming to the PCIe-based Protocol, Tag translations, traffic class (TC) translations, and/or cross-field translations; wherein the Accelerator/RPU may maintain tracking between Tags associated with the UALink-based protocol and Tags associated with the PCIe-based protocol, such as in order to associate responses with their corresponding requests.

FIG. 23B illustrates an example of a TFD demonstrating translations performed by an accelerator or by an RPU, denoted as Accelerator/RPU, that may include a cache, between a UALink-based protocol, such as UPLI, utilized for communicating with a first entity (Entity.1), and a PCIe-based protocol, utilized for communicating with a second entity (Entity.2) that may be coupled to memory, such as DRAM, wherein the memory may be mapped to a physical address space (PAS) utilized by the Accelerator/RPU. The Accelerator/RPU may translate between the UALink-based domain and the PCIe-based domain, such as translate between messages conforming to the UALink-based protocol and messages conforming to the PCIe-based protocol, e.g., translate between UALink and PCIe, or between UPLI and PCIe. The TFD illustrates two exemplary transactions between the first entity and the Accelerator/RPU. The first exemplary transaction may include a UPLI request that may carry a *Rd* command type, such as Read, AtomicR, or a Vendor Defined Read Class Command, wherein the Accelerator/RPU may look up the data associated with the request address in the cache before issuing a PCIe request to the second entity. The lookup of the data may result in a cache miss, wherein the Accelerator/RPU may translate the UALink UPLI request (Req) to a PCIe Memory Read request or a PCIe UIO Memory Read request that may carry a *Rd* TLP Type such as PCIe MRd or PCIe UIOMRd, wherein the Accelerator/RPU may send the PCIe/UIO memory read request to the second entity. Upon receiving a response from the second entity, which may include a PCIe Completion with Data or a PCIe UIO Read Completion with Data such as PCIe CpID or PCIe UIORdCpID, the Accelerator/RPU may translate the PCIe/UIO completion comprising *Data* (e.g., CpID TLP or UIORdCpID TLP) to a UPLI read response comprising *Data*, wherein the Accelerator/RPU may store the data retrieved from the second entity in the cache.

The second exemplary transaction may similarly include a UPLI request that may carry a *Rd* command type, such as Read, AtomicR, or a Vendor Defined Read Class Command, wherein the Accelerator/RPU may look up the data associated with the request address in the cache before issuing a PCIe request to the second entity. The lookup of the data may result in a cache hit, wherein the Accelerator/RPU may respond to the request from the first entity with a UPLI read response comprising *Data*, without sending a translated PCIe/UIO memory read request to the second entity. In some examples, the Accelerator/RPU may issue multiple PCIe transactions in response to receiving a UPLI request from the first entity, such as when splitting a UPLI read request for a large block of data to smaller PCIe/UIO memory read requests, or when prefetching data from the second entity.

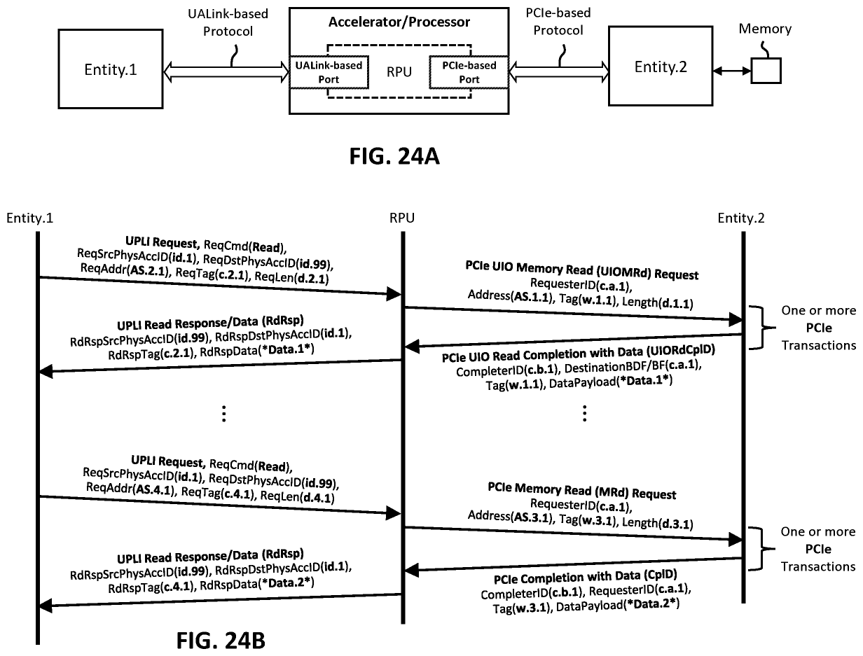

FIG. 24A illustrates an example of a system comprising an accelerator or a processor, denoted as Accelerator/Processor, which may include an RPU, and may further include a UALink-based port and a PCIe-based port, optionally coupled to or included in the RPU. The Accelerator/Processor may translate between a UALink-based protocol, such as UPLI, and a PCIe-based protocol. The Accelerator/Processor may be coupled, via the UALink-based port, to a first entity (Entity.1), which may be an accelerator, a GPU, a second processor, a UALink Switch, a UALink-based originator, or a resource consumer, wherein the Accelerator/Processor may communicate with the first entity according to a UALink-based protocol, such as UPLI. The Accelerator/Processor may be further coupled, via the PCIe-based port, to a second entity (Entity.2), which may be a host, a CPU, a GPU, a third processor, a PCIe switch, a PCIe device, a memory pool, or a resource provider, wherein the second entity may be coupled to a memory, and wherein the Accelerator/Processor may communicate with the second entity according to a PCIe-based protocol. The Accelerator/Processor may translate between the UALink-based domain and the PCIe-based domain, such as between UALink to PCIe or between UPLI to PCIe, enabling the first entity to access resources coupled to the second entity, such as the memory. The Accelerator/Processor may further perform opcode translations, command translations, TLP translations, and translations between messages conforming to the UALink-based protocol and PDUs conforming to the PCIe-based Protocol, Tag translations, traffic class (TC) translations, and/or cross-field translations; wherein the Accelerator/Processor may maintain tracking between Tags associated with the UALink-based protocol and Tags associated with the PCIe-based protocol, such as in order to associate responses with their corresponding requests.

FIG. 24B illustrates an example of a TFD demonstrating translations performed by an accelerator or by a processor, denoted as Accelerator/Processor, between UALink-based traffic, such as UPLI requests, utilized for communicating with a first entity (Entity.1), and PCIe-based traffic, utilized for communicating with a second entity (Entity.2) that may be coupled to memory, such as DRAM, wherein the memory may be mapped to a physical address space (PAS) utilized by the Accelerator/Processor. The Accelerator/Processor may include an RPU, and may translate between messages conforming to the UALink-based protocol and messages conforming to the PCIe-based protocol. The TFD illustrates two exemplary transactions between the first entity and the Accelerator/Processor. The first exemplary transaction may include a first UPLI request (Req) comprising Request Command (e.g. ReqCmd(Read)), Request Source Physical Accelerator ID (e.g., ReqSrcPhysAccID(id.1)), Request Destination Physical Accelerator ID (e.g., ReqDstPhysAccID(id.99)), Request Address (e.g., ReqAddr(AS.2.1)), Request Tag (e.g., ReqTag(c.2.1)), and Request Length (e.g., ReqLen(d.2.1)). The Accelerator/Processor may translate the first UALink UPLI request to a PCIe UIO Memory Read (UIOMRd) request, such as UIOMRd TLP, comprising RequesterID(c.a.1), Address(AS.1.1), Tag(w.1.1), and Length(d.1.1), wherein the Accelerator/Processor may send the PCIe UIOMRd to the second entity. Upon receiving a first response from the second entity, which may include a PCIe UIO Read Completion with Data (UIORdCpID), such as UIORdCpID TLP, comprising CompleterID(c.b.1), DestinationBDF/BF(c.a.1), Tag(w.1.1), and DataPayload(*Data.1*), the Accelerator/Processor may translate the PCIe UIORdCpID to a first UPLI read response/data (RdRsp) comprising Read Response Source Physical Accelerator ID (e.g., RdRspSrcPhysAccID(id.99)), Read Response Destination Physical Accelerator ID (e.g., RdRspDstPhysAccID(id.1)), Read Response Transaction Tag (e.g., RdRspTag(c.2.1)), and Read Response Data (e.g., RdRspData(*Data.1*)).

The second exemplary transaction may include a second UPLI request comprising Request Command (e.g. ReqCmd(Read)), Request Source Physical Accelerator ID (e.g., ReqSrcPhysAccID(id.1)), Request Destination Physical Accelerator ID (e.g., ReqDstPhysAccID(id.99)), Request Address (e.g., ReqAddr(AS.4.1)), Request Tag (e.g., ReqTag(c.4.1)), and Request Length (e.g., ReqLen(d.4.1)). The Accelerator/Processor may translate the second UALink UPLI request to a PCIe Memory Read (MRd) request, such as MRd TLP, comprising RequesterID(c.a.1), Address(AS.3.1), Tag(w.3.1), and Length(d.3.1), wherein the Accelerator/Processor may send the PCIe MRd to the second entity. Upon receiving a second response from the second entity, which may include a PCIe Completion with Data (CpID), such as CpID TLP, comprising CompleterID(c.b.1), RequesterID(c.a.1), Tag(w.3.1), and DataPayload(*Data.2*), the Accelerator/Processor may translate the PCIe CpID to a second UPLI RdRsp comprising Read Response Source Physical Accelerator ID (e.g., RdRspSrcPhysAccID(id.99)), Read Response Destination Physical Accelerator ID (e.g., RdRspDstPhysAccID(id.1)), Read Response Transaction Tag (e.g., RdRspTag(c.4.1)), and Read Response Data (e.g., RdRspData(*Data.2*)).

In some examples, one or more fields of the PCIe transactions such as RequesterID, CompleterID, and DestinationBDF/BF, may be set during enumeration or initialization phases of the Accelerator/Processor, or during enumeration or initialization phases of peer components coupled to the Accelerator/Processor, that may affect the PCIe topology and IDs assigned to PCIe components in the system. Additionally or alternatively, at least some of the fields in the PCIe transactions such as RequesterID, CompleterID, and DestinationBDF/BF, may be preconfigured, such as in a security-hardened system, e.g., in order to reduce the attack surface of the system. Optionally, the Accelerator/Processor may issue multiple PCIe transactions in response to receiving a UPLI request from the first entity, such as when splitting a UPLI read request for a large block of data to smaller PCIe memory read requests, or when prefetching data from the second entity.

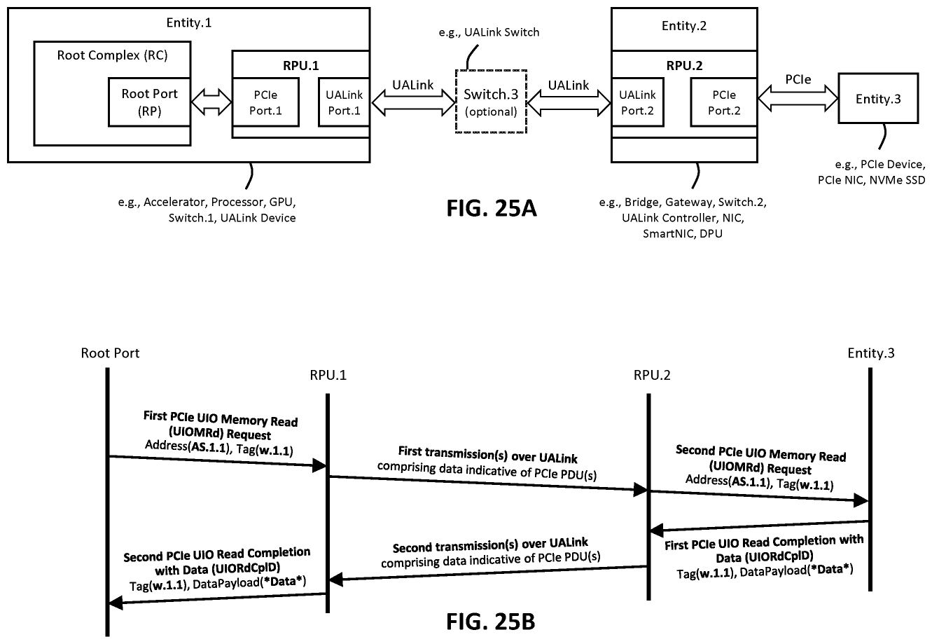

FIG. 25A illustrates an example of a system comprising a first entity (Entity.1), such as an accelerator, a processor, a GPU, a first switch (Switch.1), or a UALink device, wherein the first entity may include a Root Complex (RC) comprising a root port (RP), and may further include a first RPU (RPU.1) comprising a first PCIe port (PCIe Port.1) and a first UALink port (UALink Port.1). The system may further include an optional third switch (Switch.3), such as a UALink switch, and a second entity (Entity.2), such as a bridge, a gateway, a second switch (Switch.2), a UALink controller, a Network Interface Card (NIC), e.g., a UALink NIC, a SmartNIC, e.g., a UALink SmartNIC, or a Data Processing Unit (DPU), e.g., a UALink DPU. The second entity may include a second RPU (RPU.2) comprising a second PCIe port (PCIe Port.2) and a second UALink port (UALink Port.2). The system further includes a third entity (Entity.3), such as a PCIe device, a PCIe NIC, or an NVMe SSD. The first and second RPUs may enable the first entity to communicate with the third entity according to a PCIe-based protocol, via the second entity and optionally via the third switch, such as by translating between PCIe-based PDUs (such as PCIe TLPs, requests, messages, or flits) and transmissions comprising data indicative of PCIe PDUs, such as transmissions comprising data indicative of PCIe TLP types and physical addresses, wherein the transmissions utilize UALink PDUs (such as UPLI messages or UALink flits, e.g., TL Flits, DL Flits, or Payload Flits), which may be sent and received via the first and second UALink ports, optionally enabling the first entity to access resources of the third entity, such as registers or memory. In some examples, translating between the PCIe-based PDUs and the transmissions utilizing UALink PDUs may enable PCIe over UALink, such as via PCIe tunneling over UALink, e.g., tunneling of PCIe requests and completions over UALink, tunneling of PCIe TLPs over UALink, tunneling of PCIe-based PDUs over UALink, or tunneling of PCIe transactions over UALink.

In some examples, the first UALink port and the second UALink port may utilize the same physical layer technology, such as a physical layer based on IEEE 802.3 PMA (e.g., UALink 200 PHY based on 802.3 Ethernet PHY), or a physical layer based on PCIe (e.g., UALink 128G based on PCIe 6.3). In other examples, the first UALink port and the second UALink port may utilize different physical layer technologies. The first RPU may be implemented in a chiplet inside an IC package of the first entity, as a functional block on the same silicon die with the RP, or may be split between dies or chiplets. Alternatively, the first RPU may be implemented as a discrete component coupled to the second entity. Additionally or alternatively, the first RPU may be included in a switch, such as in a UALink switch. In some examples, the first entity may be a first switch, such as a first PCIe switch comprising the first UALink port, the second entity may be a second switch, such as a second PCIe switch comprising the second UALink port, wherein the PCIe traffic between the first PCIe switch and the second PCIe switch may be tunneled over UALink, and wherein the first PCIe switch and the second PCIe switch may be coupled by a the third switch, that may be a UALink switch. In other examples, the first entity may be a first switch comprising the first PCIe Port (PCIe Port.1), the second entity may be a second switch comprising the second PCIe Port (PCIe Port.2), and the PCIe traffic between the RP and the third entity (e.g., a PCIe device) may be tunneled over UALink via the second switch and optionally via the third switch.

FIG. 25B illustrates an example of a TFD demonstrating a PCIe communication between a first entity (Entity.1), such as a processor comprising a root port (RP), and a third entity (Entity.3), such as a PCIe device, wherein the PCIe communication may be tunneled over UALink. The first entity may initiate a read from the third entity, such as by sending a first PCIe UIO Memory Read (UIOMRd) request comprising Address(AS.1.1) and Tag(w.1.1) via the RP. The first RPU (RPU.1), which may reside in the first entity, may receive the first PCIe UIOMRd and translate it to first transmission(s) comprising data indicative of PCIe PDU, such as transmission(s) comprising data indicative of TLP types and physical addresses, wherein the first RPU may send the first transmission(s) which may utilize one or more UALink PDUs (such as UPLI messages or UALink flits, e.g., TL Flits, DL Flits, or Payload Flits), to a second RPU (RPU.2), which may reside in a second entity, such as a bridge or a gateway. The first RPU may further translate the first PCIe UIOMRd to the first transmission(s) in a manner that enables reconstruction of the first PCIe UIOMRd at the second RPU with minimal (or no) modifications, effectively tunneling the first PCIe UIOMRd over UALink. For example, the first RPU may encapsulate the first PCIe UIOMRd into a UPLI write message, and send the UPLI write message to the second RPU, wherein the PCIe request may be extracted from the UPLI write message such as by decapsulation. Additionally or alternatively, the first RPU may encapsulate a PCIe flit comprising the first PCIe UIOMRd into a UPLI write message, and send the UPLI write message to the second RPU, wherein the PCIe flit comprising the first PCIe UIOMRd may be extracted from the UPLI write message such as by decapsulation.

The second RPU may receive the first transmission(s) and translate it to a second PCIe UIOMRd comprising Address(AS.1.1) and Tag(w.1.1), and send the second PCIe UIOMRd to the third entity. In some examples, the first PCIe UIOMRd and the second PCIe UIOMRd may be identical, whereas in other examples the second RPU may construct the second PCIe UIOMRd based on the first PCIe UIOMRd with variations such as utilizing a different TLP type (e.g., MRd instead of UIOMRd), utilizing a different Tag namespace, e.g., Tag(q.2.1) instead of Tag (w.1.1), or utilizing address translations, e.g., Address(AS.2.1) instead of Address(AS.1.1). The third entity may respond to the second PCIe UIOMRd by sending a first PCIe UIO Read Completion with Data (UIORdCpID) comprising Tag(w.1.1) and DataPayload(*Data*) to the second RPU, wherein the second RPU may translate the first PCIe UIORdCpID to second transmission(s) comprising data indicative of PCIe PDU, and send the second transmission(s) to the first RPU. The first RPU may further receive the second transmission(s) and translate it to a second PCIe UIORdCpID comprising Tag(w.1.1) and DataPayload(*Data*), and send the second PCIe UIORdCpID to the RP.

In some examples, the first PCIe UIORdCpID and the second PCIe UIORdCpID may be identical, whereas in other examples the first RPU may construct the second PCIe UIORdCpID based on the first PCIe UIORdCpID with variations, such as updating fields, e.g., reserved fields or fields treated as reserved, such as CDL that may represent CXL device load for QoS telemetry, where this field may be treated as reserved for use cases not covered by CXL. Additionally or alternatively, the first RPU may alter the structure of the second PCIe UIORdCpID compared to the original first PCIe UIORdCpID, such as by adding a TLP trailer, such as for supporting Transaction Layer end-to-end 32-bit CRC (ECRC) that may cover the path between the second RPU and the RP.

In some examples, the second PCIe UIOMRd may be different from the first PCIe UIOMRd due to differences in protocol revisions, such as when the first RPU communicates with the RP according to a first PCIe specification revision, whereas the second RPU communicates with the third entity according to a second PCIe specification revision (that may be different than the first PCIe specification revision), or such as when translation is required between Flit Mode (FM) and Non-Flit Mode (NFM) TLP formats. Similarly, the second PCIe UIORdCpID may be different from the first PCIe UIORdCpID due to differences in protocol revisions, or such as when translation is required between FM and NFM TLP formats. In some examples, the first RPU and the second RPU may be coupled by a switch, such as a UALink switch.

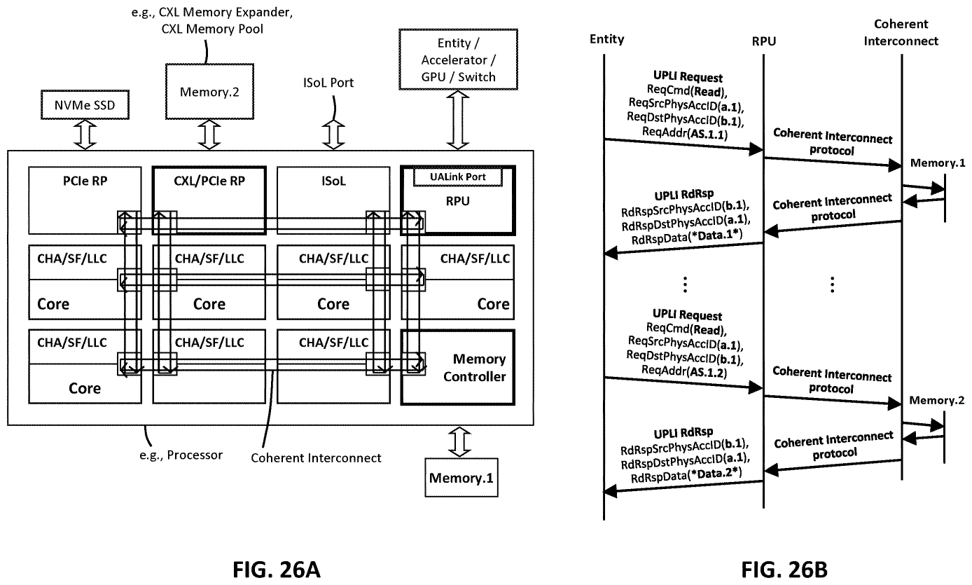

FIG. 26A illustrates an example of a system comprising a processor including a coherent interconnect, capable of enabling an external entity to access memory resources mapped to an address space utilized by the coherent interconnect. Optionally, the processor is an MxPU derived from an established processor design that may include processing cores, caching/home agent (CHA), snoop filter (SF), and LLC, optionally implemented as slices distributed across tiles on the coherent interconnect mesh. The processor may further include a memory controller that may be coupled to a first memory (Memory.1), such as DRAM, a PCIe RP that may be coupled to an NVMe SSD, a CXL/PCIe RP that may be coupled to a second memory (Memory.2), such as a CXL memory expander or a CXL-based memory pool, and an ISoL port, such as a port utilizing NVIDIA NVLink-C2C, ARM CHI C2C, or Intel Coherent Processor Interconnect Protocol (ICPIP), such as Intel UPI. The processor may further include an RPU that includes or coupled to a UALink port that may communicate with an entity, such as an accelerator, according to a UALink-based protocol, such as UPLI, wherein the RPU may perform physical address translations to enable the entity to access the first memory and/or the second memory. The illustrated RPU may be coupled to the coherent interconnect, and may translate between the UALink-based protocol and a protocol utilized by the coherent interconnect. The processor may be implemented as a monolithic die, as chiplets within an IC package, such as by utilizing separate compute die(s) and I/O die(s), or as components on a board, and may utilize a mesh-based coherent interconnect, or in other examples may utilize a ring, a crossbar, or other types of coherent interconnects.

FIG. 26B illustrates an example of a transaction flow diagram (TFD) demonstrating two UPLI requests, such as UPLI read requests, received from an entity and forwarded to different memories mapped to an address space utilized by the coherent interconnect. The RPU may perform physical address translations, such as from Network Physical Address (NPA) to Host Physical Address (HPA), to enable the entity to access the processor's memories. The processor may have multiple memory resources, such as first memory (Memory.1), which may be DRAM coupled to a memory controller of the processor, and/or second memory (Memory.2) that may be memory expanders that may be coupled to CXL RPs of the processor. The RPU may further perform additional translations, such as protocol translations from a UALink-based protocol, such as UPLI, to a protocol utilized by the coherent interconnect, and may send the optionally translated request to the coherent interconnect, requesting a read from memory. In some examples, the requested data may be provided by a processor cache, such as by an LLC, instead of by the memory. The data may then return over the coherent interconnect to the RPU, wherein the RPU provides UPLI read response/data (RdRsp) to the requesting entity. The TFD illustrates two exemplary transactions carrying different physical addresses mapped to different memory resources. The first exemplary transaction includes a UPLI request (Req) comprising physical address (AS.1.1), which may be an NPA, which the RPU translates and forwards via the coherent interconnect protocol to the first memory, resulting in the retrieval of *Data.1* that is returned to the entity with the first UPLI RdRsp. The second exemplary transaction includes a UPLI request comprising physical address (AS.1.2), which may be an NPA, which the RPU translates and forwards via the coherent interconnect protocol to the second memory, resulting in the retrieval of *Data.2* that is returned to the entity with the second UPLI RdRsp. The physical addresses (AS.1.1) and (AS.1.2) may refer to different memory regions within an NPA address space exposed via the UALink port, enabling the entity to access memory resources based on the RPU's translation capabilities.

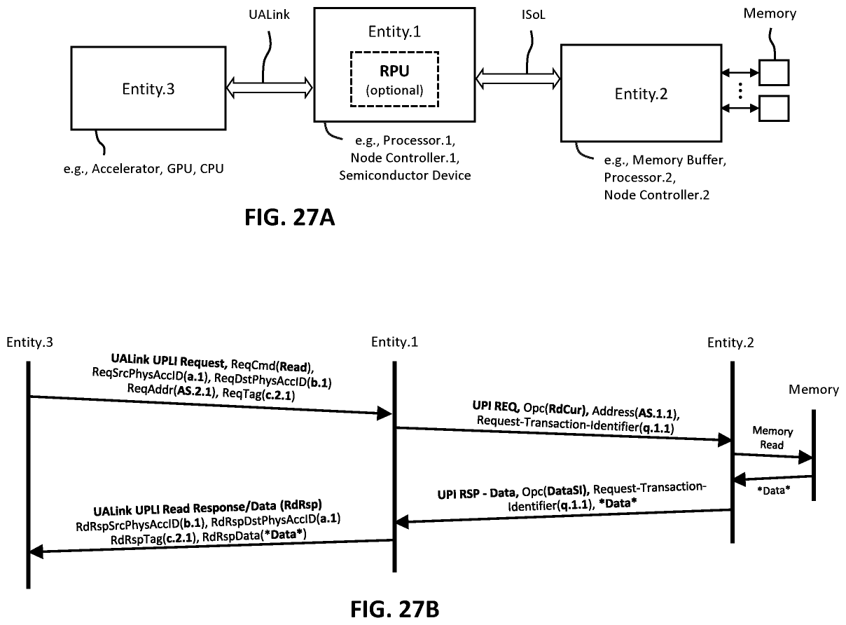

FIG. 27A illustrates an example of a system comprising a first entity (Entity.1), such as a first processor (Processor.1), a first node controller (Node Controller.1), or a semiconductor device, which may include an RPU. The first entity may be coupled to a third entity (Entity.3), which may be an accelerator, a GPU, a CPU, a UALink switch, or a UALink-based originator, wherein the first entity may communicate with the third entity according to a UALink-based protocol, such as UPLI. The first entity may be further coupled to a second entity (Entity.2), which may be a second processor (Processor.2), a memory buffer, or a second node controller (Node Controller.2), wherein the second entity may be coupled to a memory, and wherein the first entity may communicate with the second entity according to an ISoL protocol, such as ARM CHI C2C, a protocol utilizing an NVIDIA NVLink-C2C interconnect, or an Intel Coherent Processor Interconnect Protocol (ICPIP), such as Intel UPI. The first node controller (Node Controller.1) and the second node controller (Node Controller.2) may each include an ICPIP node controller, such as a UPI node controller (UNC), or an external node controller (e.g., XNC). The first entity, optionally via the RPU, may translate between the UALink-based protocol (such as UPLI) and the ISoL protocol (such as ICPIP), enabling the third entity to access resources coupled to the first entity, such as the memory that may be coupled to the second entity.

In some examples, the UALink-based protocol, such as UPLI, may be associated with a first address space, such as an NPA space, and the ISoL protocol, such as ICPIP, may be associated with a second address space, such as a System Physical Address (SPA) space or a Host Physical Address (HPA) space; wherein the first entity, optionally via the RPU, may perform address translations between addresses within the first and second address spaces, respectively, such as between addresses within the NPA space and addresses within the SPA space or the HPA space. In other examples, the UALink-based protocol, such as UPLI, and the ISoL protocol, such as ICPIP, may be associated with the same physical address space, such as with a global address space, a partitioned global address space (PGAS), a pod address space, a virtual pod address space, or a fabric address space; wherein the first entity, optionally via the RPU, may perform address translations between addresses within the same address spaces.

The first entity (Entity.1), optionally via the RPU, may perform further translations, such as opcode, command, or TLP translations, e.g., translating between commands in requests conforming to the UALink-based protocol (e.g. UPLI vendor-defined read command) to opcodes in requests conforming to the ISoL Protocol (e.g., Intel UPI RdCur opcode). The first entity, optionally via the RPU, may further translate between messages conforming to the UALink-based protocol and PDUs conforming to the ISoL Protocol, translate Tags, translate traffic class (TC), and/or perform cross-field translations. The first entity, optionally via the RPU, may maintain tracking between Tags associated with the UALink-based protocol and Tags associated with the ISoL protocol, such as in order to associate responses with their corresponding requests.

FIG. 27B illustrates an example of a TFD demonstrating translations between UALink-based traffic and ISoL traffic, such as ICPIP traffic. The translations are performed by a first entity (Entity.1), such as a first processor (Processor.1), a first node controller (Node Controller.1), or a semiconductor device, optionally via an RPU. The UALink-based protocol may be utilized for communicating with a third entity (Entity.3), such as an accelerator, and the ISoL protocol may be utilized for communicating with a second entity (Entity.2), such as a second processor (Processor.2), or a second node controller (Node Controller.2). The second entity may be coupled to memory, such as DRAM, which may be mapped to a physical address space (PAS) utilized by the first processor. The third entity may initiate a UPLI transaction that may include a UPLI request (Req) comprising Request Command (e.g., ReqCmd(Read)), Request Source Physical Accelerator ID (e.g., ReqSrcPhysAccID(a.1)), Request Destination Physical Accelerator ID (e.g., (ReqDstPhysAccID(b.1)), Request Tag (e.g., ReqTag(c.2.1)), and Request Address (e.g., ReqAddr(AS.2.1)). The first entity, optionally via the RPU, may translate the UPLI transaction to an ISoL (e.g., ICPIP) transaction, such as an Intel UPI transaction that may include a UPI request (REQ message class) comprising Opc(RdCur), Address(AS.1.1), and Request-Transaction-Identifier(q.1.1), wherein the Request-Transaction-Identifier (e.g., RTID) may denote a Tag, a transaction Tag, a transaction identifier, or another field or set of fields carried in UPI transactions which may serve to associate responses with their corresponding requests.

The first entity (Entity.1) may send the UPI request (REQ) to the second entity. Upon receiving a response from the second entity, that may include a UPI data response (“RSP—Data” message class, which may also be denoted by “RSP4—Data”) comprising Opc(DataSI), Request-Transaction-Identifier(q.1.1), and *Data*, the first entity, optionally via the RPU, may translate the UPI response (RSP—Data) to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.2.1)), and Read Response Data (e.g., RdRspData(*Data*)). In some examples, the requested data may be provided by a processor cache instead of by the memory, such as wherein the requested data may be provided by an LLC that may be included in the first entity, or by an LLC that may be included in the second entity. In other examples, the first entity, optionally via the RPU, may translate the UPLI transaction to an ICPIP transaction, such as an Intel UPI transaction, that may include message classes such as REQ, SNP, WB, RSP (such as RSP2 or RSP4), NCB, or NCS, that may include commands, operations, or opcodes (e.g., Opc), such as RdCode, RdCur, RdData, RdInv, RdInvOwn, SnpCode, SnpCur, SnpData, SnpInv, WbMtoS, WcWr, WcWrPtl, DataE, DataSI, or DataM_CmpO. The first entity, optionally via the RPU, may perform further translations, such as opcode, command, or TLP translations, e.g., translating between commands in requests conforming to the UALink-based protocol (e.g. UPLI vendor-defined read command) and opcodes in requests conforming to the ISoL Protocol (e.g., Intel UPI RdCur).

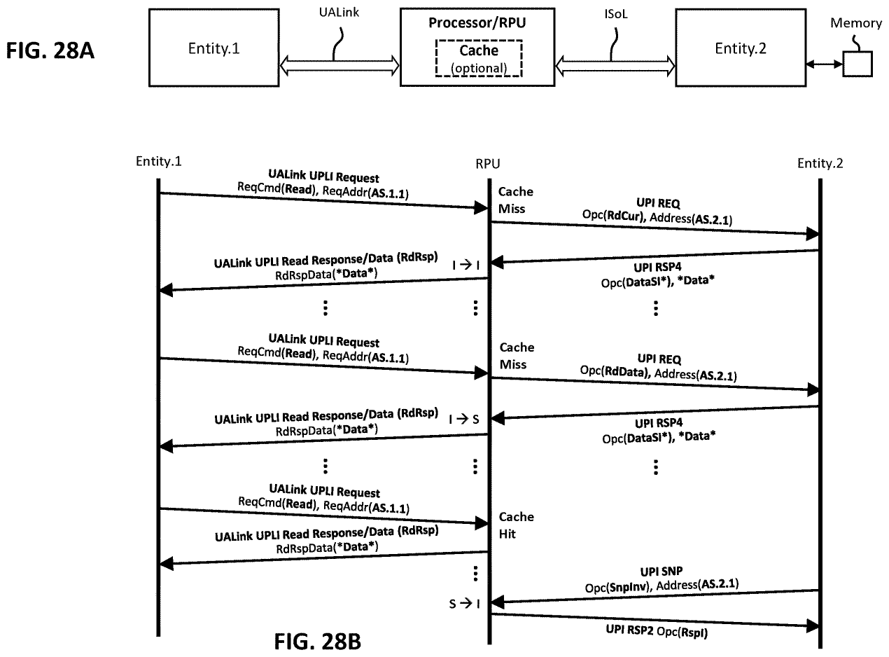

FIG. 28A illustrates an example of a system comprising a processor or an RPU, denoted as Processor/RPU, which may include a cache. The Processor/RPU may be coupled to a first entity (Entity.1), which may be an accelerator, a GPU, a second processor, a UALink Switch, or a resource consumer, wherein the Processor/RPU may communicate with the first entity according to a UALink-based protocol, such as UPLI. The Processor/RPU may be further coupled to a second entity (Entity.2), which may be a third processor, a node controller, or a memory buffer, wherein the second entity may be coupled to a memory, and wherein the Processor/RPU may communicate with the second entity according to an ISoL protocol, such as NVIDIA NVLink-C2C, ARM CHI C2C, or Intel Coherent Processor Interconnect Protocol (ICPIP), such as Intel UPI. The Processor/RPU may translate between the UALink-based protocol, such as UPLI, and the ISoL protocol, such as ICPIP, enabling the first entity to access resources coupled to the second entity, such as the memory. The Processor/RPU may cache data retrieved from the second entity and may respond to UPLI requests received from the first entity with data from the cache, instead of issuing read requests to the second entity. Additionally or alternatively, the Processor/RPU may prefetch data from the second entity into the cache. Moreover, the Processor/RPU may perform further translations between the UALink-based domain and the ISoL domain, such as protocol translations, address translations, opcode translations, command translations, TLP translations, and translations between messages conforming to the UALink-based protocol and PDUs conforming to the ISoL Protocol, Tag translations, traffic class (TC) translations, and/or cross-field translations. The Processor/RPU may maintain tracking between Tags associated with the UALink-based protocol and Tags associated with the ISoL protocol, such as in order to associate responses with their corresponding requests.

FIG. 28B illustrates an example of a TFD demonstrating translations performed by a processor or an RPU, denoted as Processor/RPU, that may include a cache, between UALink-based traffic, such as UPLI traffic, utilized for communicating with a first entity (Entity.1), and ISoL traffic, such as ICPIP traffic, utilized for communicating with a second entity (Entity.2) that may be coupled to memory, such as DRAM, wherein the memory may be mapped to a physical address space (PAS) utilized by the Processor/RPU. The Processor/RPU may translate between the UALink-based domain and the ISoL domain, such as translate between messages conforming to the UALink-based protocol (e.g., UPLI) and messages conforming to the ISoL protocol (e.g., Intel UPI). The TFD illustrates three exemplary transactions between the first entity and the Processor/RPU. The first exemplary transaction may include UALink UPLI request (Req) comprising ReqCmd(Read) and ReqAddr(AS.1.1), wherein the Processor/RPU may translate the request address (AS.1.1) to a translated address (AS.2.1) and may look up the data associated with the address and/or with the translated address in the cache before issuing a UPI request to the second entity. The lookup of the data may result in a cache miss, wherein the Processor/RPU may translate the UALink UPLI request to UPI REQ comprising Opc(RdCur) and Address(AS.2.1), wherein the Processor/RPU may send the UPI REQ to the second entity. Upon receiving a response from the second entity, which may include UPI RSP4 comprising Opc(DataSI*) and *Data*, the Processor/RPU may translate the UPI RSP4 to a UALink UPLI read response/data (RdRsp) comprising RdRspData(*Data*), without storing the data retrieved from the second entity in the cache, denoted in the drawing by “I-to-I”, indicating that the cache state associated with the cacheline address remains invalid.

The second exemplary transaction may include UALink UPLI request comprising ReqCmd(Read) and ReqAddr(AS.1.1), referencing the same address as the first exemplary transaction, wherein the Processor/RPU may translate the request address (AS.1.1) to a translated address (AS.2.1) and may look up the data associated with the address and/or with the translated address in the cache before issuing a UPI request to the second entity. The lookup of the data may result in a cache miss, wherein the Processor/RPU may translate the UALink UPLI request to UPI REQ comprising Opc(RdData) and Address(AS.2.1), wherein the Processor/RPU may send the UPI REQ to the second entity. Upon receiving a response from the second entity, which may include UPI RSP4 comprising Opc(DataSI*) and *Data*, the Processor/RPU may translate the UPI RSP4 to a UALink UPLI RdRsp comprising RdRspData(*Data*), and may store the data retrieved from the second entity in the cache, denoted in the drawing by “I-to-S”, indicating that the cache state associated with the cacheline address transitioned from invalid to shared, possibly indicating that the cacheline data is shared between the Processor/RPU and the second entity.

The third exemplary transaction may include UALink UPLI request comprising ReqCmd(Read) and ReqAddr(AS.1.1), referencing the same address as the first and the second transaction, wherein the Processor/RPU may translate the request address (AS.1.1) to a translated address (AS.2.1) and may look up the data associated with the address and/or with the translated address in the cache before issuing a UPI request to the second entity. The lookup of the data may result in a cache hit, wherein the Processor/RPU may respond to the request from the first entity with UALink UPLI RdRsp comprising RdRspData(*Data*) from the cache, without sending a translated UPI REQ to the second entity. Following the third transaction, the second entity may invalidate the cacheline address (AS.2.1) associated with the UPI domain, which may be stored in the Processor/RPU cache. The second entity may send to the Processor/RPU a UPI SNP comprising Opc(SnpInv) and Address(AS.2.1), wherein the Processor/RPU may respond to the UPI SNP by sending to the second entity a UPI RSP (e.g., UPI RSP2) comprising Opc(RspI), indicating that the Processor/RPU invalidated the associated cacheline address from the cache, denoted in the drawing by “S-to-I”, indicating that the cache state associated with the cacheline address transitioned from shared to invalid.

In some examples, the Processor/RPU may perform cache lookups before performing translations related to the UPLI request received from the first entity, or may perform cache lookups after performing some or all of the translations related to the UPLI request received from the first entity. In some examples, the Processor/RPU may further organize the cache and perform cache lookups according to addresses associated with the UALink-based domain (e.g., UPLI domain). Additionally or alternatively, the Processor/RPU may further organize the cache and perform cache lookups according to translated addresses associated with the ISoL domain (e.g., UPI domain).

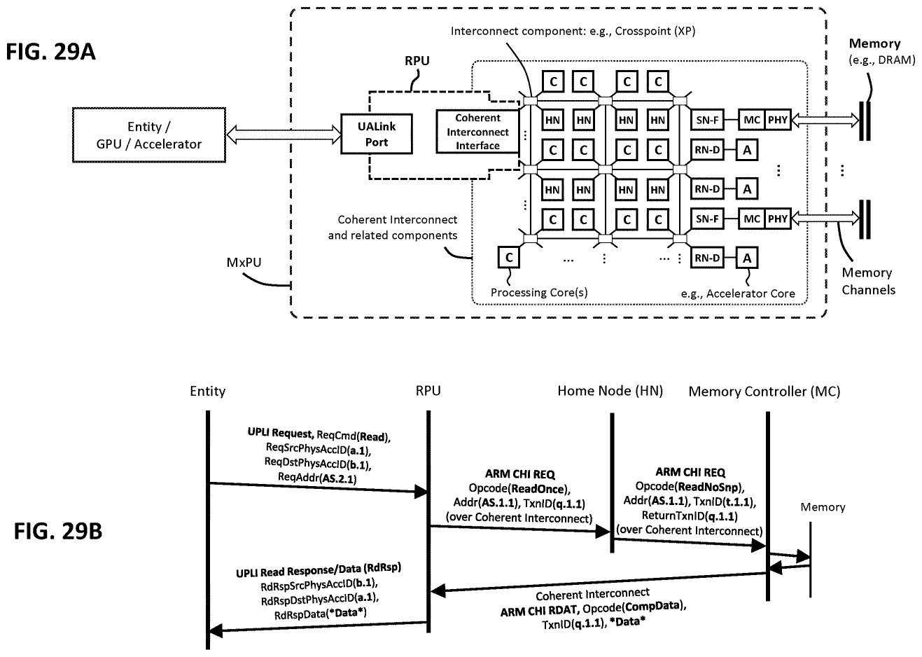

FIG. 29A illustrates an example of a system where an entity, such as a GPU or accelerator, communicates via a UALink port included in an RPU that further includes a Coherent Interconnect Interface that may utilize a protocol based on ARM CHI. The Coherent Interconnect Interface couples the RPU to an interconnect component, such as a crosspoint (XP), within a coherent interconnect. The Coherent Interconnect Interface performs the applicable protocol conversions between a UALink domain and a coherent interconnect domain, such as between UPLI and ARM CHI, enabling the entity to access memory and other resources coupled to the coherent interconnect. The coherent interconnect may be implemented as a mesh topology connecting various components including processing cores, home nodes (HN), memory controllers (MC), and accelerator cores.

FIG. 29B illustrates an example of a TFD showing address translation between UALink UPLI and CHI. An entity, such as a GPU, initiates a UPLI request comprising a physical address (AS.2.1), which the RPU translates to a CHI request carrying ReadOnce with a translated physical address (AS.1.1). The transaction flows through the coherent interconnect via a home node to a memory controller, which retrieves the data and returns it, through the coherent interconnect, to the RPU that translates the response back to the UPLI domain for delivery to the requesting entity.

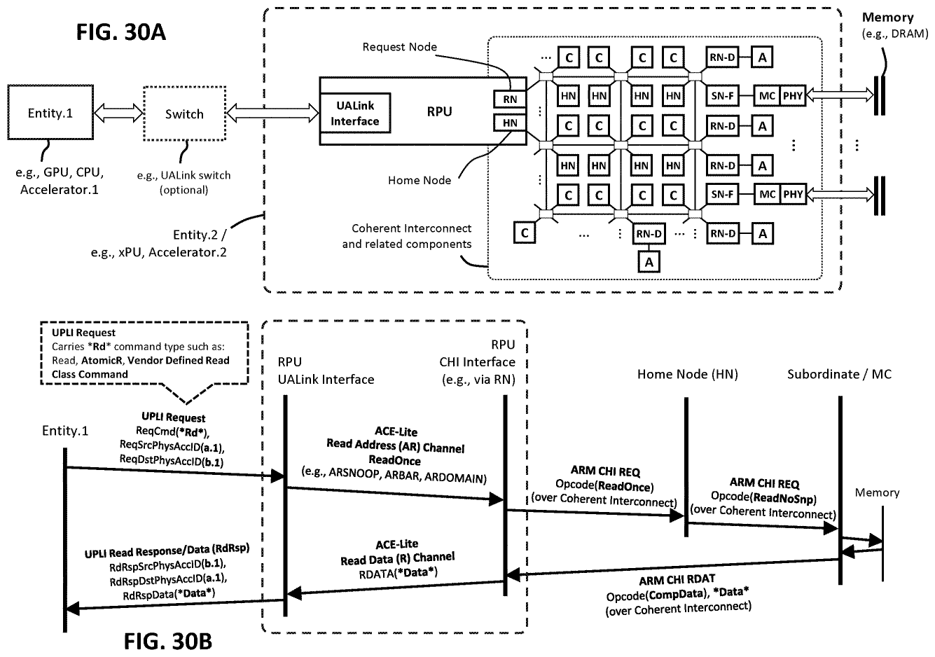

FIG. 30A illustrates an example of a system that translates between UALink-based traffic and CHI-based traffic. The system may include a first entity (Entity.1), such as a GPU, a CPU, or a first accelerator (Accelerator.1), which may be coupled to an RPU comprising a UALink port. The UALink port may be coupled to a coherent interconnect, such as a CHI-based coherent interconnect, via an interconnect component, such as a crosspoint (XP). The RPU may include request nodes (e.g., RNs), such as I/O-coherent RN-I nodes and/or RN-D, and/or home nodes (e.g., HNs), such as non-coherent HN-I nodes. This example may enable the first entity to access resources, such as memory, coupled to the coherent interconnect, utilizing appropriate translations and routing, such as by an RPU that translates between UALink traffic utilized by the first entity, and CHI traffic traveling via a crosspoint (XP) component of the coherent interconnect, wherein a request node or a home node provides the CHI interface for connecting to the XP. An optional switch, such as a UALink switch, may reside between the first entity and the UALink interface. In some examples, the coherent interconnect and the UALink port may be included within a second entity (Entity.2), such as an xPU or a second accelerator (Accelerator.2).

FIG. 30B illustrates an example of an RPU that translates between UALink-based traffic and CHI traffic, optionally utilizing an intermediate protocol based on ARM Advanced Microcontroller Bus Architecture (AMBA) Advance Extensible Interface (AXI) Coherency Extensions Lite (ACE-Lite). A first entity (Entity.1), such as a GPU, a CPU, or an accelerator, may issue a UPLI request (Req) comprising ReqCmd(*Rd*), ReqSrcPhysAccID(a.1), and ReqDstPhysAccID(b.1), wherein *Rd* denotes a read command type such as Read, AtomicR, or Vendor Defined Read Class Command. The RPU may receive the UPLI request (Req) via a UALink interface, and may process and translate the UPLI request (Req) to an intermediate transaction, such as ACE-Lite ReadOnce transaction, that may be encoded using a combination of ARSNOOP, ARBAR, and ARDOMAIN signals, wherein the ACE-Lite ReadOnce transaction may be carried on Read Address (AR) Channel. The RPU may process and send the ACE-Lite transaction to a CHI interface of the RPU that may be coupled to a coherent interconnect, optionally via a request node (e.g., RN), that may provide the CHI interface for connecting to the coherent interconnect, and may translate the ACE-Lite transaction to a first CHI request, such as CHI REQ comprising Opcode(ReadOnce) destined to a home node (e.g., HN). The home node may process the first CHI REQ (ReadOnce) and may issue a second CHI REQ comprising Opcode(ReadNoSnp) destined to a memory controller (MC) for servicing the original UPLI request received from the first entity via the UALink interface.

The memory controller may read the requested data from memory, and may respond with CHI RDAT comprising Opcode(CompData) and *Data*, sending the requested data via the coherent interconnect to the CHI interface of the RPU, wherein the RPU may further process and translate the CHI RDAT to an intermediate ACE-Lite RDATA comprising the *Data*, that may be carried on Read Data (R) channel. The RPU may further process and translate the ACE-Lite RDATA to a UPLI read response/data (RdRsp) comprising RdRspSrcPhysAccID(b.1), RdRspDstPhysAccID(a.1), and RdRspData(*Data*), and may send the UPLI read response/data (RdRsp) to the first entity. The RPU may further translate physical addresses associated with the UALink-based traffic, such as Network Physical Addresses (NPAs), to physical addresses associated with the CHI traffic. In some examples, the coherent interconnect and the UALink port may be included within a second entity (Entity.2), such as an xPU or a second accelerator (Accelerator.2).

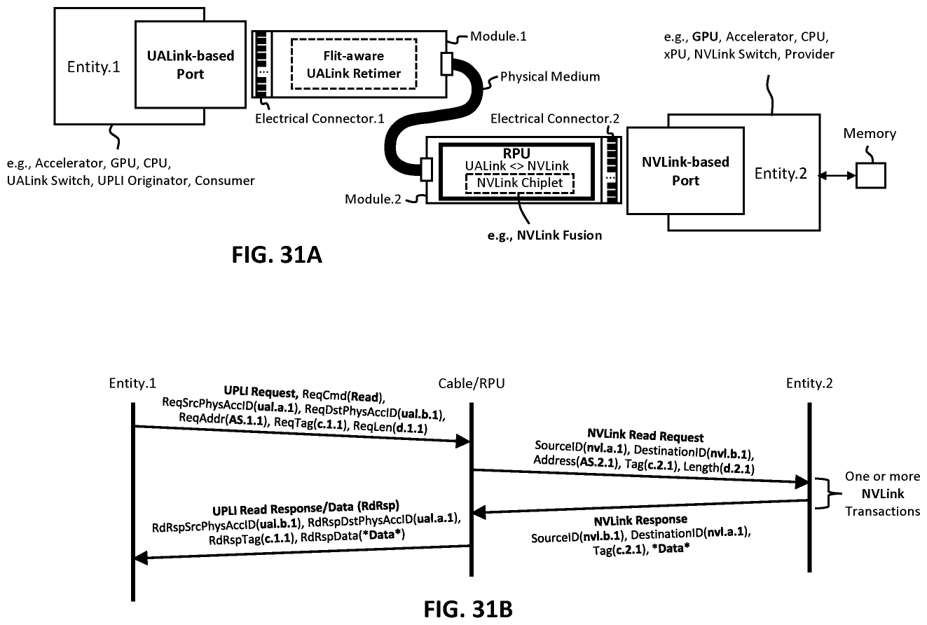

FIG. 31A illustrates an example of a system comprising a cable, referred to as Cable/RPU, which may translate between UALink-based requests and NVLink-based requests. The Cable/RPU enables a first entity (Entity.1), which may be an accelerator, a GPU, a CPU, a UALink switch, a UPLI originator, or a resource consumer, to access, via a UALink-based port, via the Cable/RPU, and via an NVLink-based interface, resources, such as memory, coupled to a second entity (Entity.2), which may be a GPU, an accelerator, a CPU, an xPU, an NVLink switch, an NVSwitch, or a resource provider. The Cable/RPU, which may include an RPU, may communicate with the first entity according to a UALink-based protocol, and may communicate with the second entity according to an NVLink-based protocol. In some examples, messages conforming to the UALink-based protocol, such as UPLI, may be associated with a first address space, such as an NPA space; and messages conforming to the NVLink-based protocol may be associated with a second address space, such as an NVLink-based address space or an NVLink-based network address space; wherein the Cable/RPU may perform address translations between addresses within the first and second address spaces, respectively, such as between addresses within the NPA space and addresses within the NVLink-based network address space. In other examples, the UALink-based protocol, such as UPLI, and the NVLink-based protocol, may be associated with the same address space, such as an NVLink-based common address space, a global address space, a pod address space, or a fabric address space; wherein the Cable/RPU may perform address translations between addresses within the same common address spaces.

The Cable/RPU may perform further translations, such as protocol translations, opcode translations, command translations, or TLP translations, e.g., translating between commands in UPLI requests and request types utilized by the NVLink-based protocol. The Cable/RPU may further translate between messages conforming to the UALink-based protocol and PDUs conforming to the NVLink-based protocol, translate Tags, and/or translate error indications, such as data corruption indications or poison. In some examples, the Cable/RPU may further include a first module (Module.1), which may include a flit-aware UALink retimer, and may further include a second module (Module.2), which may include the RPU, optionally comprising an NVLink chiplet, such as NVLink Fusion. In some examples, the Cable/RPU may be coupled to the UALink-based port via a first electrical connector (Electrical Connector.1) and may be further coupled to the NVLink-based interface via a second electrical connector (Electrical Connector.2). Whereas in other examples, the Cable/RPU may be coupled to the UALink-based port and/or the NVlink-based interface via optical connectors. The Cable/RPU may further include a physical medium that may include a copper wire or an optical fiber.

FIG. 31B illustrates an example of a transaction flow diagram (TFD) demonstrating translations performed by a cable, denoted as Cable/RPU, between a UALink-based protocol utilized for communicating with a first entity (Entity.1), such as UALink switch, and an NVLink-based protocol utilized for communicating with a second entity (Entity.2), such as an NVLink switch. The first entity may initiate a UPLI transaction that may include a UPLI request comprising Request Command (e.g., ReqCmd(Read)), Request Source Physical Accelerator ID (e.g., ReqSrcPhysAccID(ual.a.1)), Request Destination Physical Accelerator ID (e.g., (ReqDstPhysAccID(ual.b.1)), Request Address (e.g., ReqAddr(AS.1.1)), Request Tag (e.g., ReqTag(c.1.1)), and Request Length (e.g., ReqLen(d.1.1)). The Cable/RPU, which may include an RPU, may translate the UPLI request to an NVLink request or an NVLink read request that may include SourceID(nvl.a.1), such as source GPU ID, DestinationID(nvl.b.1), such as destination GPU ID, Address(AS.2.1), such as a network address or a GPU physical address, Tag(c.2.1), and Length(d.2.1), wherein the Cable/RPU may send the NVLink request to the second entity. Upon receiving a response from the second entity, that may include an NVLink response that may include SourceID(nvl.b.1), such as source GPU ID, DestinationID(nvl.a.1), such as destination GPU ID, Tag(c.2.1), and *Data*, the Cable/RPU may translate the NVLink response to a UPLI read response/data (RdRsp) comprising Read Response Source Physical Accelerator ID (e.g., RdRspSrcPhysAccID(ual.b.1)), Read Response Destination Physical Accelerator ID (e.g., RdRspDstPhysAccID(ual.a.1)), Read Response Transaction Tag (e.g., RdRspTag(c.1.1)), and Read Response Data (e.g., RdRspData(*Data*)). In some examples, the Cable/RPU may issue multiple NVLink requests in response to receiving a UPLI request from the first entity, such as when splitting a UPLI request for a large block of data to smaller NVLink requests, or when prefetching data from the second entity.

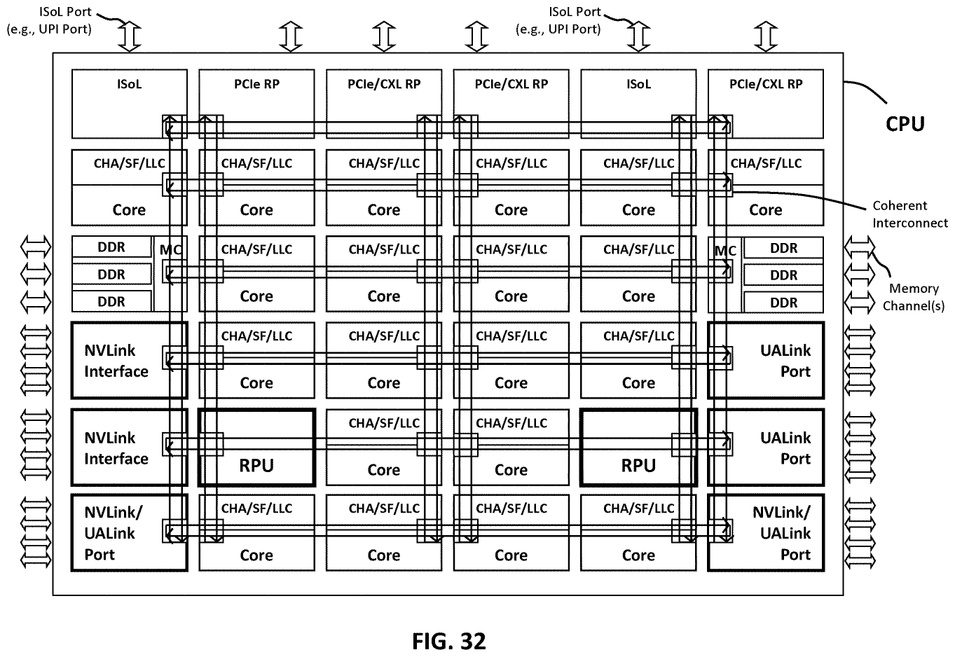

FIG. 32 illustrates an example of a processor, such as a CPU, comprising a coherent interconnect, processing cores, caching/home agent (CHA), snoop filter (SF), and last-level cache (LLC), optionally implemented as slices distributed across tiles on the coherent interconnect mesh. The processor may further include ISoL ports (such as ports utilizing Intel Coherent Processor Interconnect Protocol (ICPIP), e.g., UPI ports), one or more PCIe RPs, CXL/PCIe RPs, and memory controllers that may be coupled to memory such as DRAM. The processor may further include one or more RPUs, NVLink interfaces and/or UALink ports, wherein the RPUs may perform physical address translations to enable external entities (not shown in the figure), such as GPUs and accelerators, to access the memory. The illustrated RPUs may be coupled to the coherent interconnect, and may translate between an NVLink-based protocol or a UALink-based protocol and a protocol utilized by the coherent interconnect. Optionally, the RPUs may further enable the processing cores to access resources exposed by the external entities, such as HBM and/or HBF resources. In some examples, the processor may further include one or more multi-protocol ports, such as NVLink/UALink ports, which may be configured, either independently or as a group of ports, to communicate according to an NVLink-based protocol or according to a UALink-based protocol, utilizing a physical layer (PHY) such as an Ethernet-based PHY or a PHY based on IEEE 802.3 PMA. The processor may be implemented as a monolithic die, as chiplets within an IC package, such as by utilizing separate compute die(s) and I/O die(s), or as components on a board. In other examples, the NVLink interface may reside on a separate chiplet, such as NVLink Fusion, and may be coupled to the coherent interconnect via a UCIe interface or a proprietary chip-to-chip or die-to-die interface.

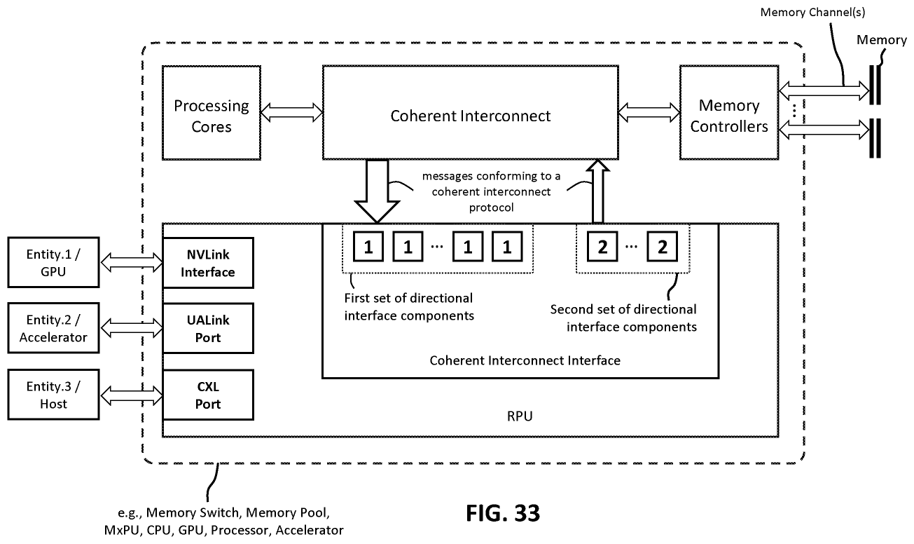

FIG. 33 illustrates an example of a system demonstrating asymmetric bandwidth configuration between an RPU and a coherent interconnect, wherein the RPU includes a first set of interface components (denoted ‘1’) for one direction of traffic flow, and a second set of interface components (denoted ‘2’) for another direction of traffic flow. The unequal number of interface components between the two sets creates an asymmetric bandwidth characteristic that may be optimized for specific workload patterns, wherein the interface components may be implemented as request nodes (RNs) and home nodes (HNs) in ARM CHI-based implementations, with the specific ratio and types of nodes selected based on whether the system prioritizes requests from external entities to internal resources, or prioritizes requests from internal processing cores to external resources.

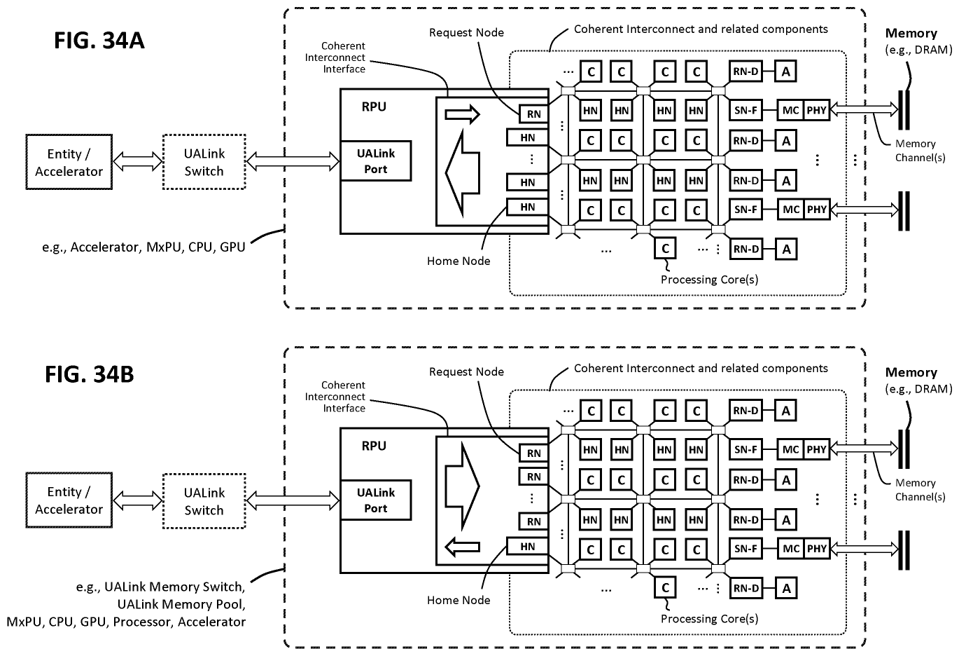

FIG. 34A illustrates an example of a system optimized for accelerator applications utilizing UALink interfaces, wherein an RPU includes more home nodes (HN) than request nodes (RN) coupled between one or more UALink ports and a coherent interconnect comprising crosspoints (XPs) and memory controllers (MCs) that are coupled to memory. The example with more home nodes than request nodes provides greater bandwidth for transactions initiated by processing cores within the coherent interconnect targeting external entities through the UALink ports, while providing more limited bandwidth for transactions initiated by external entities requesting access to internal memory resources, making this architecture suitable for accelerator implementations wherein the accelerator may initiate substantial outbound request traffic but may receive fewer inbound requests.

FIG. 34B illustrates an example of a system optimized for a memory pool or a memory switch applications utilizing UALink interfaces, wherein an RPU includes more request nodes (RN) than home nodes (HN) coupled between one or more UALink ports and a coherent interconnect comprising processing cores. The example with more request nodes than home nodes provides greater bandwidth for transactions initiated by external entities through the UALink ports requesting access to the internal memory resources, while providing more limited bandwidth for transactions initiated by processing cores targeting external resources, making this architecture suitable for memory pooling implementations wherein external entities frequently read from or write to the shared memory resources.

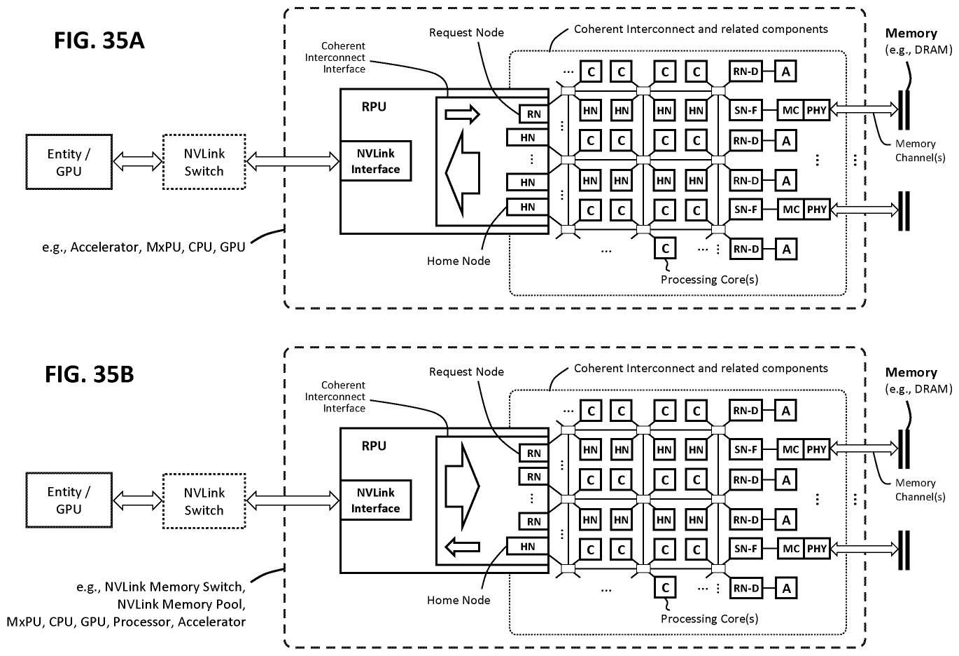

FIG. 35A illustrates an example of a system utilizing NVLink interfaces in an accelerator-optimized configuration, wherein an RPU includes more home nodes (HN) than request nodes (RN) coupled between at least one NVLink interface and a coherent interconnect comprising crosspoints (XPs) and memory controllers (MCs) that are coupled to memory. The asymmetric example with more home nodes (serving outbound request traffic) than request nodes (handling inbound request traffic) creates bandwidth characteristics optimized for accelerator workloads utilizing NVLink, wherein the accelerator prioritizes requests to external resources over serving requests from external entities. The Request Nodes may include I/O-coherent request nodes (RN-I) or I/O-coherent request nodes with DVM support (RN-D), while the Home Nodes may include I/O-coherent Home Node (HN-I). The entity, which may be a GPU such as NVIDIA Rubin GPU, is coupled through an optional NVLink switch, such as NVIDIA NVSwitch, to the RPU's NVLink interface. This asymmetric configuration may be beneficial for read-heavy workloads, such as wherein the accelerator requires high bandwidth capacity for receiving data from memory associated with the entity, such as an HBM of a GPU.

Optionally, the bandwidth capacity of a set of interface components refers to the maximum sustained data throughput that the set of interface components can collectively support for transferring messages in a given direction through the coherent interconnect interface. The bandwidth capacity may be determined by multiple factors including the number of interface components within the set, the aggregate width of physical connections allocated to those components, the processing capabilities of the individual components, and/or the degree to which the components can operate in parallel. For example, a first set comprising a larger number of Home Nodes coupled to the coherent interconnect through wider physical connections may provide greater bandwidth capacity than a second set comprising fewer Request Nodes with narrower connections. In examples wherein the first set of interface components is configured to send messages to the coherent interconnect and the second set of interface components is configured to receive messages from the coherent interconnect, each set may have a different bandwidth capacity, creating an asymmetric configuration wherein data throughput in one direction through the coherent interconnect interface differs from data throughput in the opposite direction. This asymmetry may be implemented by allocating different numbers of interface components to each set, assigning different physical connection widths to each set, and/or providing different levels of access to shared resources such as memory controllers, wherein such design choices may optimize the apparatus for workload patterns that exhibit directional preferences in data traffic.

FIG. 35B illustrates an example of a system configured as an NVLink-based memory pool, wherein an RPU includes more request nodes (RN) than home nodes (HN) coupled between one or more NVLink interfaces and a coherent interconnect comprising crosspoints (XPs), memory controllers (MCs), and memory. The example with more request nodes (handling inbound NVLink request traffic) than home nodes (managing outbound request traffic) optimizes the system for memory pooling scenarios wherein external accelerators frequently access the shared memory resources through NVLink interfaces, providing high bandwidth for external memory access requests while limiting bandwidth for internally-initiated transactions targeting external resources. The Request Nodes may handle read operations, write operations, command submissions, or other transactions initiated by the entity, while the fewer Home Nodes may be sufficient for coordinating read requests from the apparatus to the entity. The entity, which may be a GPU such as NVIDIA Rubin GPU, is coupled through an optional NVLink switch, such as NVIDIA NVSwitch, to the RPU's NVLink interface. This asymmetric configuration may be beneficial for memory-intensive workloads wherein the entity generates substantial data traffic to and from the memory of the apparatus.

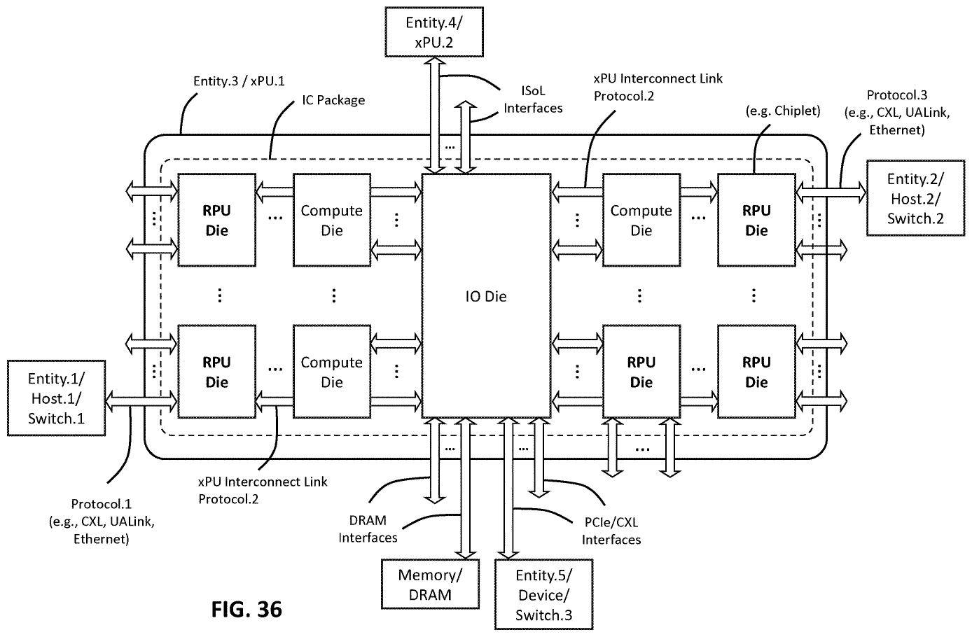

FIG. 36 illustrates an example of a system comprising an IC package comprising an input/output (IO) die coupled to compute dies and RPU dies via xPU interconnect links. The IC package may be representative of a modified AMD server-grade processor such as a modified EPYC processor or a modified consumer-grade processor such as a modified RYZEN processor. The IO die is positioned essentially centrally within the IC package and provides external interfaces including inter-socket link (ISoL) interfaces for multi-processor configurations, DRAM interfaces for memory connectivity, and PCIe/CXL interfaces for peripheral device connectivity. The xPU interconnect links may utilize high-bandwidth die-to-die interconnect protocols to enable communication between the various dies and the IO die within the IC package. The compute dies and RPU dies are arranged around the IO die, wherein the RPU dies are positioned at peripheral locations within the IC package. Entity.1/Host.1/Switch.1 is coupled to a first RPU die utilizing Protocol.1, which may be CXL, UALink, or Ethernet. Entity.2/Host.2/Switch.2 is coupled to a second RPU die utilizing Protocol.3, which may be CXL, UALink, or Ethernet. The IO die utilizes Protocol.2 for internal communications with both the compute dies and the RPU dies via the xPU interconnect links, wherein Protocol.2 may be ISoL protocol. Entity.3/MxPU.1 is the apparatus that includes the IO die, compute dies and RPU dies. Entity.4/MxPU.2 is coupled to the IC package via ISoL interfaces. The IO die may further provide connectivity to Memory/DRAM via DRAM interfaces and to Entity.5/Device/Switch.3 via PCIe/CXL interfaces. The RPU dies may enable translations between the external protocols (Protocol.1 and Protocol.3) utilized by the coupled entities and the internal protocol (Protocol.2) utilized by the coherent interconnect in the IC package.

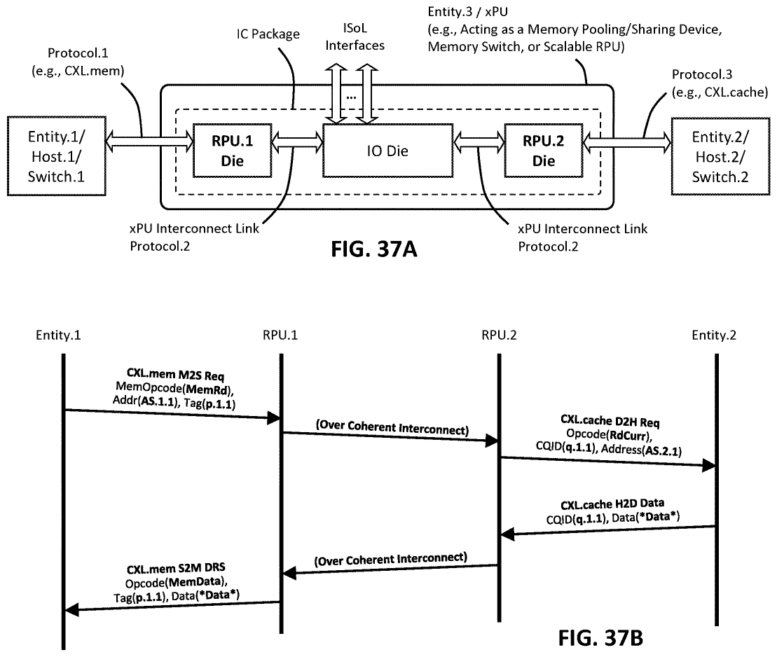

FIG. 37A illustrates an example of a system comprising a memory switch comprising an IC package with an IO die coupled to at least first and second RPU dies. The coherent interconnect of the xPU utilizes Protocol.2 for communications between the IO die and the RPU dies, wherein Protocol.2 may be based on Intel Intra-Die Interconnect (IDI) or AMD Infinity Fabric. The coherent interconnect may be implemented as AMD Infinity Fabric or Intel Ring/Mesh Interconnect. RPU.1 is configured to translate between Protocol.1 and Protocol.2, and RPU.2 is configured to translate between Protocol.2 and Protocol.3. The memory switch may support various translation scenarios including: (a) translations from CXL.mem to Intel UPI to CXL.cache, (b) translations from CXL.mem to Infinity Fabric to CXL.cache, (c) translations from CXL.io Unordered IO (UIO) to Infinity Fabric to CXL.io UIO, (d) translations from PCIe UIO to Infinity Fabric to PCIe UIO, or (e) translations from UALink to Infinity Fabric to UALink.

FIG. 37B illustrates an example of a TFD demonstrating protocol and address translation relevant to a memory switch. Entity.1 (which may be a host or a switch) initiates a CXL.mem M2S request comprising MemRd, a physical address (AS.1.1) within a first physical address space, and a Tag (p.1.1). RPU.1 receives the CXL.mem M2S request and translates it for transmission over the xPU/processor coherent interconnect. RPU.2 receives the translated M2S request from the coherent interconnect and generates a CXL.cache D2H request comprising RdCurr, a translated physical address (AS.2.1) within a second physical address space, and a translated identifier (q.1.1) that may be a CQID. Entity.2 (which may be a host or a switch) processes the CXL.cache request and returns a CXL.cache H2D Data response comprising the CQID (q.1.1) and the requested data. The response traverses back through RPU.2 and the coherent interconnect to RPU.1, which translates it to a CXL.mem S2M DRS comprising MemData, the original Tag (p.1.1), and the data for delivery to Entity.1.

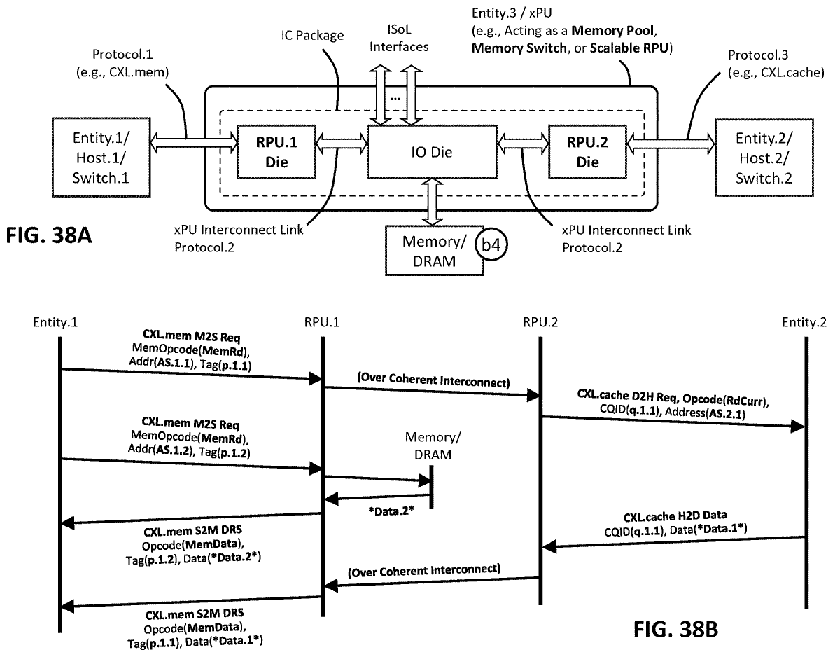

FIG. 38A illustrates an example of a system comprising an IC package with an IO die coupled to at least first and second RPU dies. Entity.3/MxPU may function as a memory pool, a memory switch, or a scalable RPU. The memory switch functionality enables two distinct transaction paths: a host-to-host transaction from Entity.1 to Entity.2, and a host-to-memory transaction path from Entity.1 to Memory/DRAM. RPU.1 Die communicates with Entity.1/Host.1/Switch.1 utilizing Protocol.1, such as CXL.mem. RPU.2 Die communicates with Entity.2/Host.2/Switch.2 utilizing Protocol.3, such as CXL.cache. The IO die utilizes Protocol.2 for internal communications with the RPU dies via xPU interconnect links, which may be a coherent interconnect. The Memory/DRAM is coupled to the IO die, enabling memory access for the host-to-memory transactions. ISoL interfaces on the IO die may provide connectivity to additional processors or coherent interconnects.

FIG. 38B illustrates an example of a TFD demonstrating two transactions relevant to a memory switch. The first CXL transaction is a host-to-host transaction, wherein Entity.1 initiates a CXL.mem M2S Req comprising MemRd, physical address (AS.1.1), and Tag (p.1.1, bubble al). RPU.1 receives the request and translates it for transmission over the processor's coherent interconnect. RPU.2 receives the translated request and generates a CXL.cache D2H Req comprising RdCurr, corresponding physical address (AS.2.1), and CQID (q.1.1) for delivery to Entity.2. The response path includes a CXL.cache H2D comprising CQID (q.1.1) and Data.1, which traverses back through the coherent interconnect to RPU.1, wherein it is translated to a CXL.mem S2M DRS comprising MemData, Tag (p.1.1), and Data.1.

The second CXL transaction is a host-to-memory transaction, which may be a host to fabric-attached memory, host to switch-attached memory, or host to memory pool transaction. The request path includes Entity.1 that initiates a CXL.mem M2S Req comprising MemRd, physical address (AS.1.2), and Tag (p.1.2, bubble bl). RPU.1 processes this request and forwards it to Memory/DRAM via the IO die. The response path includes Data.2 being retrieved from Memory/DRAM and sent to RPU.1, which encapsulates it in a CXL.mem S2M DRS comprising MemData, Tag (p.1.1), and Data.2 for delivery to Entity.1.

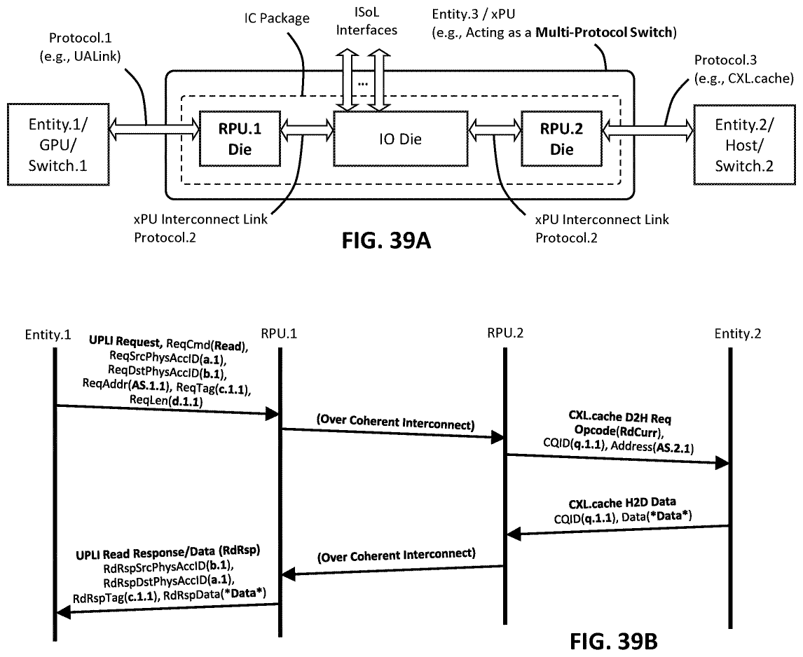

FIG. 39A illustrates an example of a system comprising an xPU-based multi-protocol switch comprising an IC package with an IO die coupled to at least first and second RPU dies. Entity.3/MxPU functions as an xPU-based multi-protocol switch. Entity.1/GPU/Switch.1 is coupled to RPU.1 Die utilizing Protocol.1, such as UALink. Entity.2/Host/Switch.2 is coupled to RPU.2 Die utilizing Protocol.3, such as CXL.cache. The IO die utilizes Protocol.2 for internal communications with the RPU dies via xPU interconnect links. ISoL interfaces on the IO die may provide connectivity to additional processors or xPU-based multi-protocol switches. The xPU-based multi-protocol switch enables translation between three or more distinct protocols.

FIG. 39B illustrates an example of a TFD demonstrating protocol and address translation relevant to an xPU-based multi-protocol switch. Entity.1 initiates a UPLI request (Req) comprising ReqCmd(Read), ReqSrcPhysAccID(a.1), ReqDstPhysAccID(b.1), ReqAddr(AS.1.1), ReqTag(c.1.1), and ReqLen(d.1.1). RPU.1 receives the UPLI request and translates it for transmission over the xPU/Processor Coherent Interconnect. RPU.2 receives the translated request and generates a CXL.cache D2H Req comprising RdCurr, CQID (q.1.1), and translated physical address (AS.2.1) for delivery to Entity.2/Host/Switch.2. The response path includes a CXL.cache H2D Data comprising CQID (q.1.1) and the requested data, which traverses back through the xPU/Processor Coherent Interconnect to RPU.1. RPU.1 translates the response to a UPLI read response/data (RdRsp) comprising RdRspSrcPhysAccID(b.1), RdRspDstPhysAccID(a.1), RdRspTag(c.1.1), and RdRspData for delivery to Entity.1/GPU/Switch.1. Protocol.2, utilized by the xPU/processor's coherent interconnect, may enable communication between the IO die and the RPUs. The xPU-based multi-protocol switch may support various translation scenarios, including: (a) UALink to in-die interconnect to CXL.cache, (b) UALink to Infinity Fabric to CXL.cache, (c) CXL.mem to on-die coherent fabric to CXL.cache, (d) CXL.mem to Infinity Fabric to CXL.cache, (e) CXL.io UIO to Infinity Fabric to CXL.io UIO, or (f) PCIe UIO to Infinity Fabric to PCIe UIO.

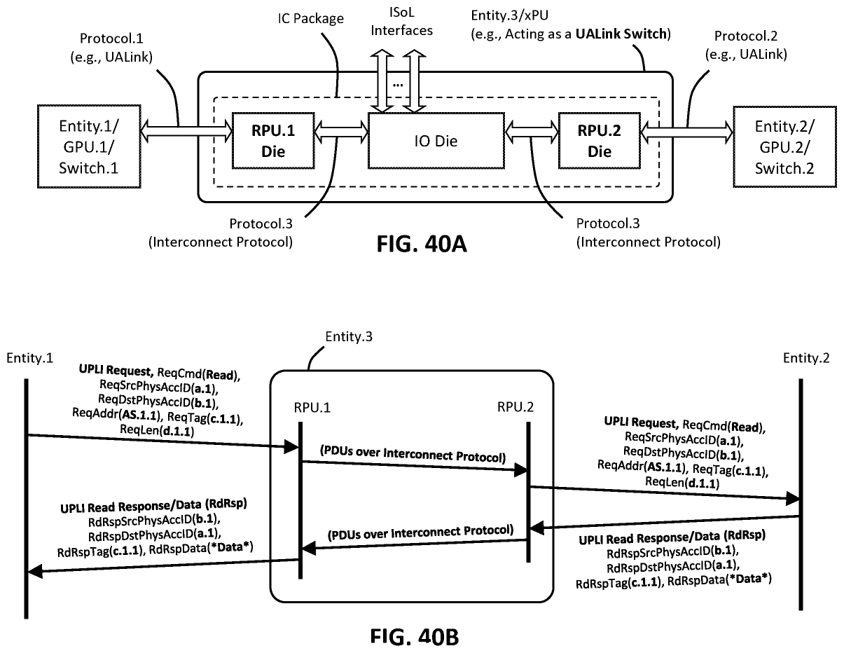

FIG. 40A illustrates an example of a system comprising a third entity (Entity.3), which may be an xPU, comprising an I/O die, that may communicate, via a first RPU (RPU.1) die, with a first entity (Entity.1), which may be a first GPU, or a first switch, according to a first protocol (Protocol.1), which may be a UALink-based protocol, such as UPLI. The I/O die may further communicate, via a second RPU (RPU.2) die, with a second entity (Entity.2), which may be a second GPU, or a second switch, according to a second protocol (Protocol.2), which may be a UALink-based protocol, such as UPLI. The I/O die may include an interconnect configured to switch traffic associated with an interconnect protocol (protocol.3) that may be based on ARM CHI, NVIDIA NVLink, Intel ICPIP, or AMD Infinity Fabric. The first RPU may translate between messages conforming to the first protocol and messages conforming to the third protocol (Protocol.3), such as between a UALink-based protocol, which may be UPLI, and the interconnect protocol; the second RPU may translate between messages conforming to the second protocol and messages conforming to the third protocol, such as between a UALink-based protocol (e.g., UPLI) and the interconnect protocol, enabling the first entity to communicate with the second entity according to a UALink-based protocol, such as UPLI; and the third entity may operate as a UALink switch, or a UALink-based switch. In some examples, the first protocol and the second protocol may conform to the same UALink-based protocol revision. In other examples, the first protocol and the second protocol may conform to different protocol revisions, wherein the first and second RPUs may translate between messages conforming to different protocol revisions.

FIG. 40B illustrates an example of a TFD demonstrating translations performed by a third entity (Entity.3), which may be an xPU, such as translations between protocols, that may enable the third entity to operate as a UALink-based switch. The third entity may receive from a first entity (Entity.1), via the first RPU (RPU.1), a first UPLI request (Req) comprising Request Command (e.g. ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., ReqAddr(AS.1.1)), Request Tag (e.g., ReqTag(c.1.1)), and Request Length (e.g., ReqLen(d.1.1)). The third entity may translate, optionally via the first RPU, the first UPLI request, to a first set of one or more Protocol Data Units (PDUs) of an interconnect protocol utilized by the third entity. The third entity may further translate, optionally via the second RPU (RPU.2), the first set of one or more PDUs of the interconnect protocol to a second UPLI request, comprising Request Command (e.g. ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., ReqAddr(AS.1.1)), Request Tag (e.g., ReqTag(c.1.1)), and Request Length (e.g., ReqLen(d.1.1)), wherein the third entity may send the second UPLI request to a second entity (Entity.2). Optionally, the second UPLI request may be equivalent to the first UPLI request.

Upon receiving a response from the second entity, the third entity may translate, optionally via the second RPU, the response to a second set of one or more PDUs of the interconnect protocol. Wherein the response from the second entity may include a first UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), and Read Response Data (e.g., RdRspData(*Data*)). The third entity may further translate, optionally via the first RPU, the second set of one or more PDUs of the interconnect protocol to a second UPLI RdRsp comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), and Read Response Data (e.g., RdRspData(*Data*)), wherein the third entity may send the second UPLI RdRsp to the first entity. In some examples, the second UPLI RdRsp may be equivalent to the first UPLI RdRsp. In some examples, the first UPLI request, the second UPLI request, the first UPLI RdRsp, and the second UPLI RdRsp, may correspond to the same protocol revision; whereas in other examples the first UPLI request and the second UPLI RdRsp may correspond to different protocol revisions than the second UPLI request and the first UPLI RdRsp.

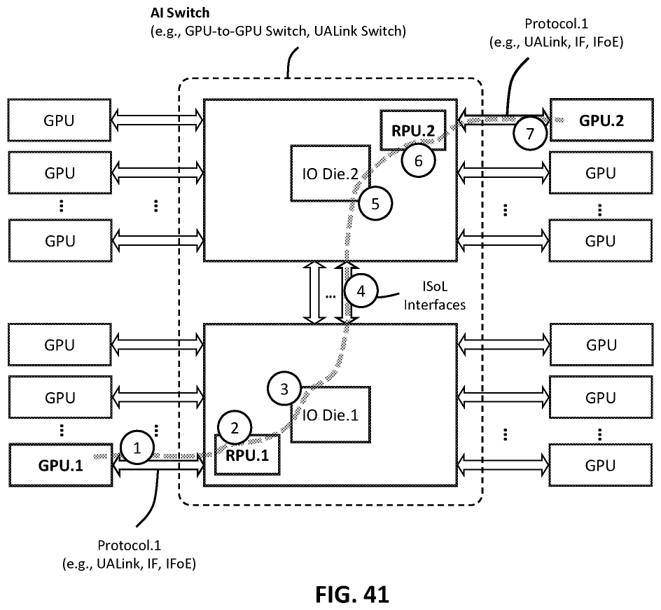

FIG. 41 illustrates an example of a scalable GPU interconnect utilizing an xPU-based AI switch, comprising at least first and second xPU-based switches coupled via one or more ISoL interfaces. The AI switch may function as a GPU-to-GPU Switch. GPUs on the left side of the switch are coupled to RPU.1 and additional RPUs that are coupled to IO Die.1, while GPUs on the right side are coupled to RPU.2 and additional RPUs (not shown) that are coupled to IO Die.2. The numbered bubbles 1 through 7 illustrate a transaction path from GPU.1 to GPU.2. Modern CPUs comprise one or more high-bandwidth coherent interconnects that couple elements such as compute cores, caching elements such as LLC slices, and port modules such as PCIe and CXL. The total bandwidth provided by the coherent interconnect of current advanced CPUs (in year 2025) may exceed 1 TB/s (>8Tbps), and may reach several TB/s in current advanced CPU architectures that utilize MCR-DIMMs or MR-DIMMs. The two xPU-based switches, coupled via the ISoL interface denoted as bubble 4, enable memory transactions between GPU.1 and GPU.2 in a manner similar to a UALink switch when the GPUs communicate according to UPLI. When GPUs communicate according to UPLI, the transaction path follows: GPU.1 sends a UPLI request to RPU.1 (bubbles 1-2), RPU.1 translates the UPLI request to the coherent interconnect protocol utilized by IO Die.1 (bubble 3), the translated request traverses through the ISoL interface to IO Die.2 (bubble 4), IO Die.2 forwards the request to RPU.2 (bubbles 5-6), and RPU.2 translates the request back to UPLI for delivery to GPU.2 (bubble 7). In another example, when the GPUs communicate according to Infinity Fabric, the RPUs may translate between Infinity Fabric and the coherent interconnect protocol of the IO dies, enabling GPU-to-GPU communication through the ISoL-coupled switches. In still another example, when the GPUs communicate according to Infinity Fabric over Ethernet (IFoE) protocol, the RPUs may extract Infinity Fabric messages from Ethernet frames, translate them to the coherent interconnect protocol, and re-encapsulate them for delivery to the destination GPU.

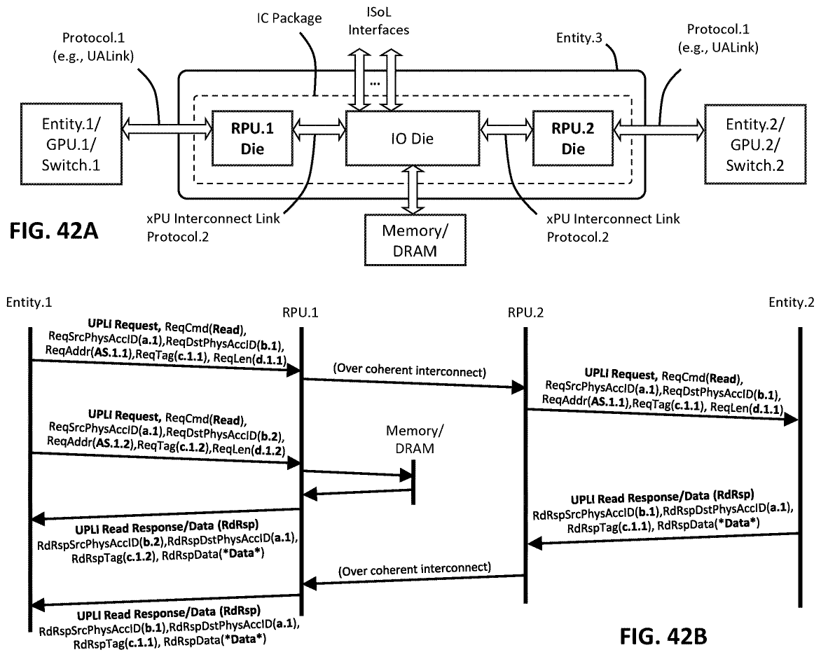

FIG. 42A illustrates an example of a system comprising an xPU-based switch coupled to memory. The xPU-based switch comprises an IC package with an IO die coupled to at least first and second RPU dies. Entity.3 functions as a switch coupled to memory. Entity.1 (such as a first GPU or a first switch) is coupled to RPU.1 Die via Protocol.1, such as UALink. Entity.2 (such as a second GPU or a second switch) is coupled to RPU.2 Die via Protocol.1, which may also be UALink. Memory/DRAM is coupled to the IO die, enabling Entity.3 to function as at least one of a switch for GPU-to-GPU transactions or a memory resource for GPU-to-memory transactions. This example supports at least two distinct transaction paths: a GPU-to-GPU transaction path from Entity.1 to Entity.2, and a GPU-to-memory transaction path from Entity.1 to the Memory/DRAM. The IO die utilizes Protocol.2 for internal communications with the RPU dies via xPU interconnect links. ISoL interfaces on the IO die may provide connectivity to additional processors, xPU-based switches, or memory resources.

FIG. 42B illustrates an example of a TFD demonstrating two UALink transactions through an xPU-based switch coupled to memory. The first UALink transaction is a GPU-to-GPU transaction, wherein Entity.1 initiates a UPLI request (Req) comprising ReqCmd(Read), ReqSrcPhysAccID(a.1), ReqDstPhysAccID(b.1), ReqAddr(AS.1.1), ReqTag(c.1.1), and ReqLen(d.1.1). RPU.1 receives this request and forwards it via the xPU/Processor Coherent Interconnect to RPU.2. RPU.2 forwards the UPLI request to Entity.2 with essentially the same parameters. The response path includes a UPLI read response/data (RdRsp) from Entity.2/GPU.2/Switch.2 comprising RdRspSrcPhysAccID(b.1), RdRspDstPhysAccID(a.1), RdRspTag(c.1.1), and RdRspData, which traverses back through the xPU/Processor Coherent Interconnect to RPU.1, wherein it is forwarded as a UPLI RdRsp to Entity.1/GPU.1/Switch.1.

The second UALink transaction is a GPU-to-memory transaction, which may be GPU to fabric-attached memory, GPU to switch-attached memory, or GPU to memory pool transaction. Entity.1 initiates a UPLI request comprising ReqCmd(Read), ReqSrcPhysAccID(a.1), ReqDstPhysAccID(b.2), ReqAddr(AS.1.2), ReqTag(c.1.2), and ReqLen(d.1.2). RPU.1 processes this request and forwards it to Memory/DRAM via the xPU/Processor Coherent Interconnect and IO die. The response path includes data being retrieved from Memory/DRAM and sent via the xPU/Processor Coherent Interconnect to RPU.1, which generates a UPLI RdRsp comprising RdRspSrcPhysAccID(b.2), RdRspDstPhysAccID(a.1), RdRspTag(c.1.2), and RdRspData for delivery to Entity.1/GPU.1/Switch.1.

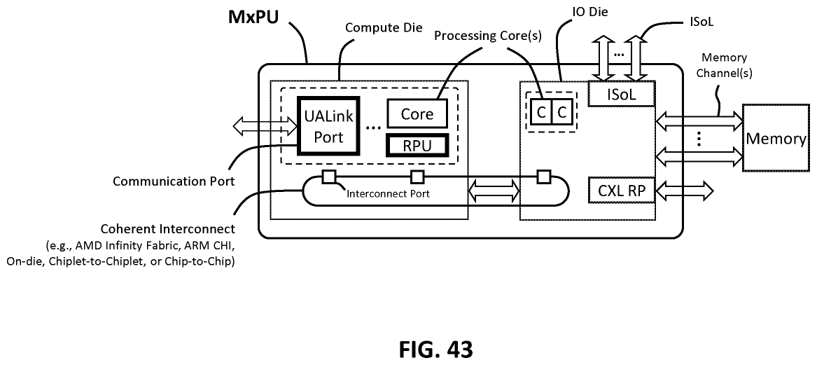

FIG. 43 illustrates an example of a processor, such as a CPU, that includes a UALink port and an RPU. The system includes an I/O die, a Compute Die such as a Core Complex Die (CCD) in AMD terminology, and a coherent interconnect such as AMD Infinity Fabric connecting the two dies.

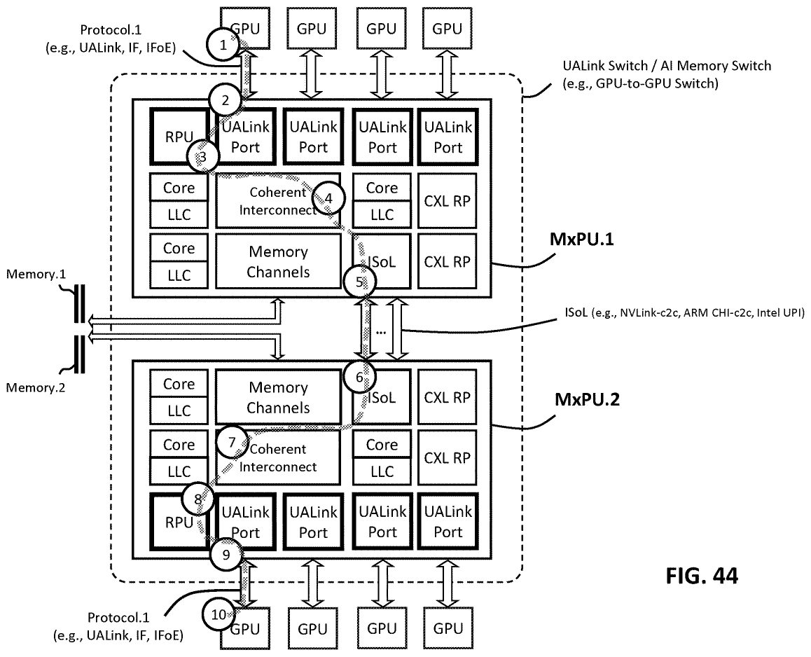

FIG. 44 illustrates an example of a memory switch or AI switch implementation utilizing two IC packages. The GPUs are coupled to UALink ports in a first processor, and another set of GPUs are coupled to UALink ports in a second processor. The processors are coupled via one or more ISoL ports, enabling switching of traffic between the UALink ports through the ISoL interface, such as ARM CHI C2C, Intel UPI, or AMD Infinity-Fabric. The example demonstrates how a switch can be constructed based on modified processor architectures.

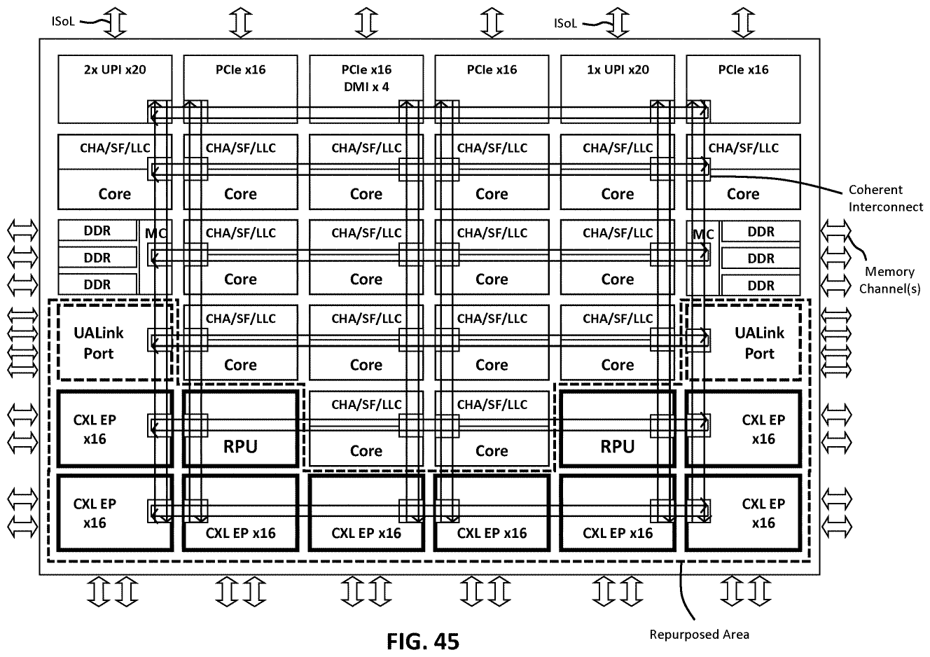

FIG. 45 illustrates an example of a processor comprising CXL endpoint ports and RPUs. The system demonstrates a CXL endpoint focused implementation where a repurposed area for the ports contains CXL endpoints, enabling CXL connectivity and functionality within the processor architecture.

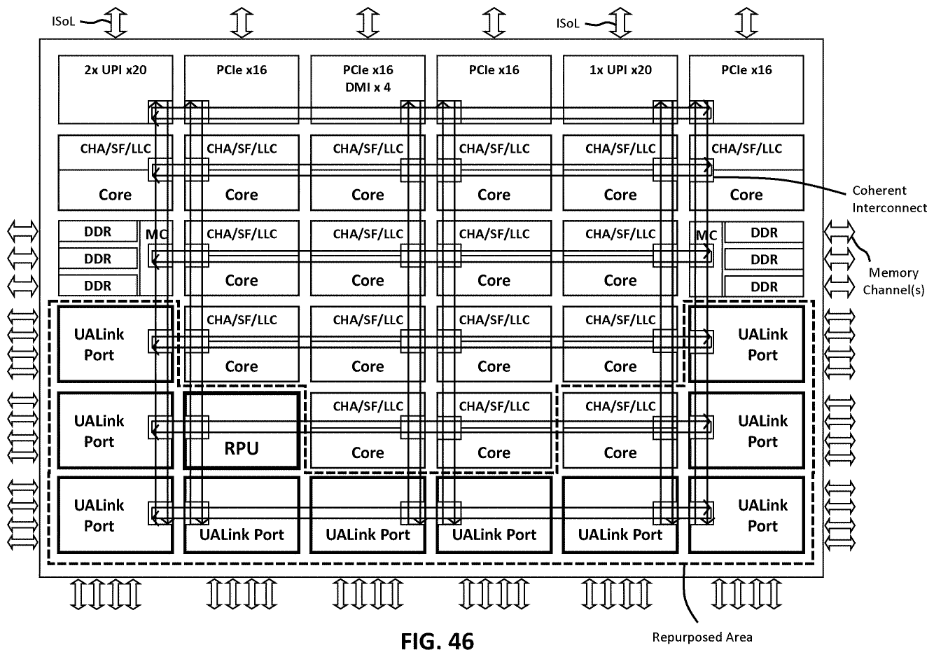

FIG. 46 illustrates an example of a processor comprising UALink ports and RPUs. The system demonstrates a UALink focused implementation where a repurposed area for the ports contains UALink ports, enabling UALink connectivity and functionality within the processor architecture.

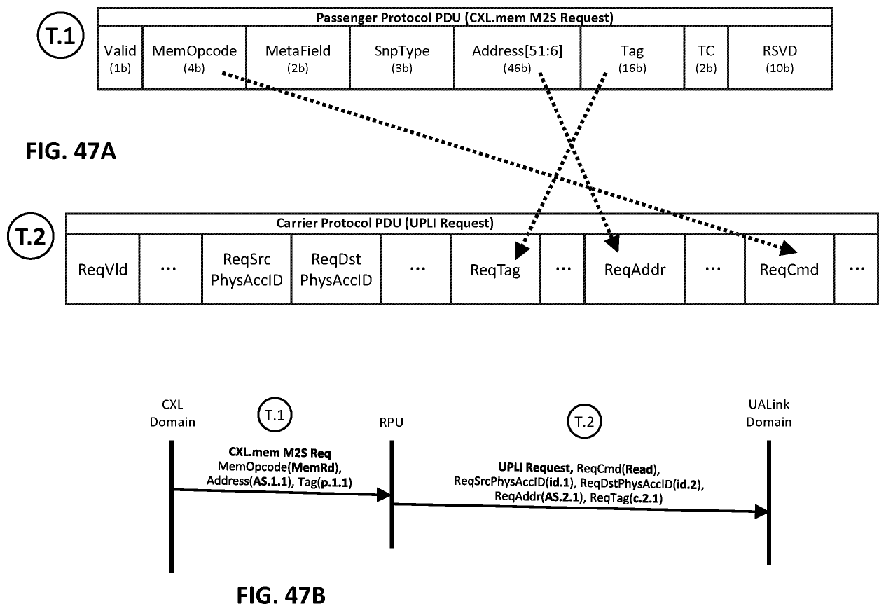

FIG. 47A illustrates an example of passing CXL traffic or CXL-related traffic over a physical layer (PHY) based on IEEE 802.3 PMA utilizing carrier protocol encapsulation. A carrier protocol runs over a PHY based on IEEE 802.3 PMA and a passenger protocol PDU associated with CXL. Optionally, the passenger protocol PDU may be based on CXL.mem. The carrier protocol encapsulates the CXL.mem PDU or portions thereof within carrier protocol structures that are suitable for transmission over the PHY based on IEEE 802.3 PMA. It may enable CXL communications to traverse physical infrastructure based on IEEE 802.3 standards, including but not limited to UALink physical layers, NVLink physical layers, or Ethernet physical layers, wherein UALink may utilize a modified IEEE 802.3 PHY or other types of IEEE 802.3 PHY, and wherein UALink may alternatively utilize a PCIe PHY in some variants.

FIG. 47B illustrates an example of a TFD showing the mapping between a CXL transaction layer and a UPLI transaction layer, wherein TL denotes transaction layer. The figure shows a CXL.mem M2S request at the CXL transaction layer being translated to a UPLI request at the UPLI transaction layer. The mapping comprises translating a MemOpcode field from the CXL request to a ReqCmd field in the UPLI request, translating a Tag field to a ReqTag field, and translating an Address field to a ReqAddr field. These represent the major mappings for the translation process, wherein additional mappings may include traffic class or other fields that are not explicitly illustrated. Some fields may pass through direct mapping while other fields may undergo translation, wherein for example the address may be translated between different address spaces, and the request Tag may be assigned from a pool rather than directly translated from the CXL Tag. The TFD shows the transaction flowing from a CXL.mem M2S Req through the translation process to a UPLI Req, demonstrating the translation at the transaction layer (TL) level.

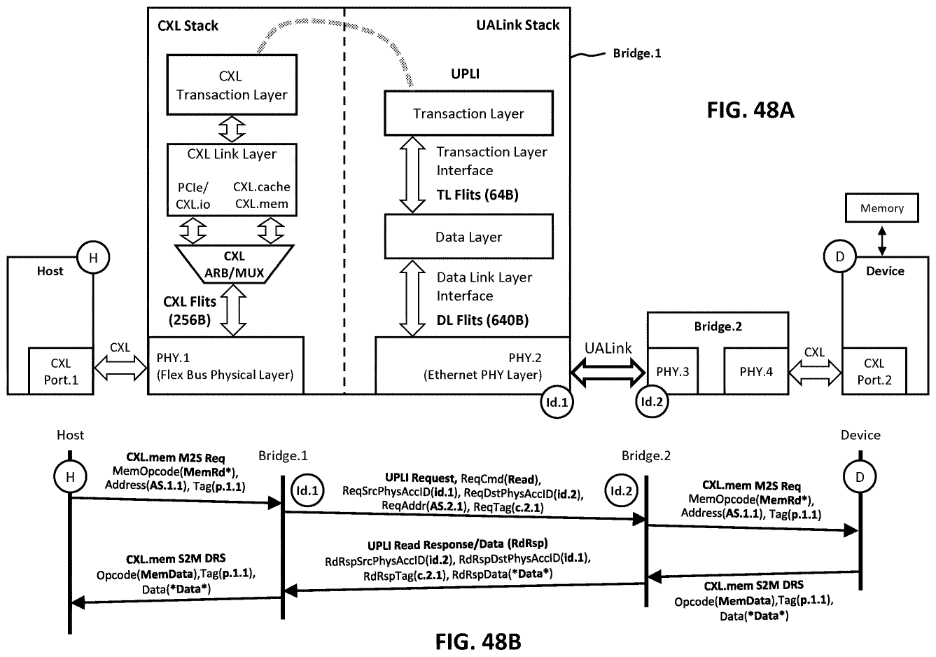

FIG. 48A illustrates an example of a system featuring host and device components coupled via bridges that translate between CXL and carrier protocols that utilize PHYs based on IEEE 802.3 PMA. The system comprises a host on the left side and a device on the right side, reflecting the asymmetry built into CXL wherein specific roles are assigned to each side. The system includes Bridge.1 and Bridge.2, wherein Bridge.1 translates between a Flex bus physical layer (a physical layer utilized by CXL) and an Ethernet PHY Layer (representing some implementations of a PHY based on IEEE 802.3 PMA), and Bridge.2 translates from an Ethernet PHY Layer back to a Flex bus physical layer. The host and device sides comprise CXL ports (designated as CXL Port.1 and CXL Port.2), which utilize a Flex bus physical layer and are unaware of the intermediate UALink or the IEEE 802.3-based physical layer infrastructure. The intermediate link between Bridge.1 and Bridge.2 may utilize UALink, wherein the UALink physical layer may be based on an IEEE 802.3 Ethernet PHY as specified in the UALink specification. The figure shows the detailed protocol stacks for both CXL and UPLI sides, wherein the CXL stack may include a CXL Transaction Layer, a CXL Link Layer with separate paths for PCIe/CXL.io and CXL.cache/CXL.mem, a CXL ARB/MUX that transmits CXL Flits (256 bytes representing an example), and a Flex Bus Physical Layer (denoted as PHY.1). The UPLI stack may include a transaction layer (which may include a transaction layer interface that transmits TL flits of 64 bytes), a Data Layer or a Data Link Layer (which may include a data link layer interface that transmits DL flits of 640 bytes), and an Ethernet PHY layer (denoted as PHY.2). This mapping occurs between transaction layers, specifically between the CXL transaction layer and the UPLI transaction layer, representing the typical translation approach wherein the system receives signals at the physical layer, processes upward to the transaction layer for mapping operations, and then processes downward to the physical layer for transmission. The bridges may be implemented or embedded within switches, such as CXL switches, UALink switches, or hybrid switches, enabling hosts and devices to connect through a switching infrastructure with UALink links between the switches, effectively tunneling CXL.mem transactions over UALink between switches.

FIG. 48B illustrates an example of a TFD corresponding to the system described in FIG. 48A, demonstrating bidirectional CXL communications between a host and a device utilizing UALink as an intermediate protocol. The TFD shows four communication points comprising the Host edge (designated H), Id.1 representing the UALink identity of Bridge.1, Id.2 representing the UALink identity of Bridge.2, and the Device edge (designated D). In the forward path from host to device, the Host H originates a CXL.mem M2S Req with MemOpcode(MemRd*), Address(AS.1.1), and Tag(p.1.1). Bridge.1 translates this CXL request to a UPLI request (Req) with ReqCmd(Read), ReqSrcPhysAccID(Id.1) identifying the source bridge, ReqDstPhysAccID(Id.2) identifying the destination bridge, ReqAddr(AS.2.1) representing the translated address, and ReqTag(c.2.1) representing the translated Tag. The UPLI request is transmitted at Id.1 using the UALink identities for routing between the Id.1 and Id.2 communication points. Bridge.2 at Id.2 receives the UPLI request and translates it back to a CXL.mem M2S Req with MemOpcode(MemRd*), Address(AS.1.1), and Tag(p.1.1) for delivery to the Device D, wherein the original CXL physical address and Tags may be restored.

In the return path from device to host, the Device sends a CXL.mem S2M DRS with Opcode(MemData), Tag(p.1.1), and Data(*Data*). Bridge.2 translates this CXL response to a UPLI read response/data (RdRsp) with RdRspSrcPhysAccID(Id.2) identifying the source bridge, RdRspDstPhysAccID(Id.1) identifying the destination bridge, RdRspTag(c.2.1) representing the translated Tag that matches the original request Tag, and RdRspData(*Data*) carrying the response data. The UPLI response is transmitted at Id.2 using the UALink identities for routing between the Id.2 and Id.1 communication points. Bridge.1 at Id.1 receives the UPLI RdRsp and translates it back to a CXL.mem S2M DRS with Opcode(MemData), Tag(p.1.1), and Data(*Data*) for delivery to Host H, wherein the original Tag enables the host to correlate the response with the original request. A UALink switch or another switching infrastructure may be positioned between Bridge.1 and Bridge.2, wherein the UALink physical accelerator identifiers (ReqSrcPhysAccID, ReqDstPhysAccID, RdRspSrcPhysAccID, RdRspDstPhysAccID) enable routing through such intermediate switching infrastructure. The translation process adapts the protocol format for transport over the UALink infrastructure, wherein Bridge.1 translates between CXL and UPLI requests, and Bridge.2 translates between UPLI and CXL requests. The address translation between AS.1.1 in the CXL domain and AS.2.1 in the UPLI domain, and the Tag translation between p.1.1 in the CXL domain and c.2.1 in the UPLI domain, enable the bridges to maintain proper transaction tracking and response correlation while adapting between different addressing and identification schemes utilized by the respective protocols.

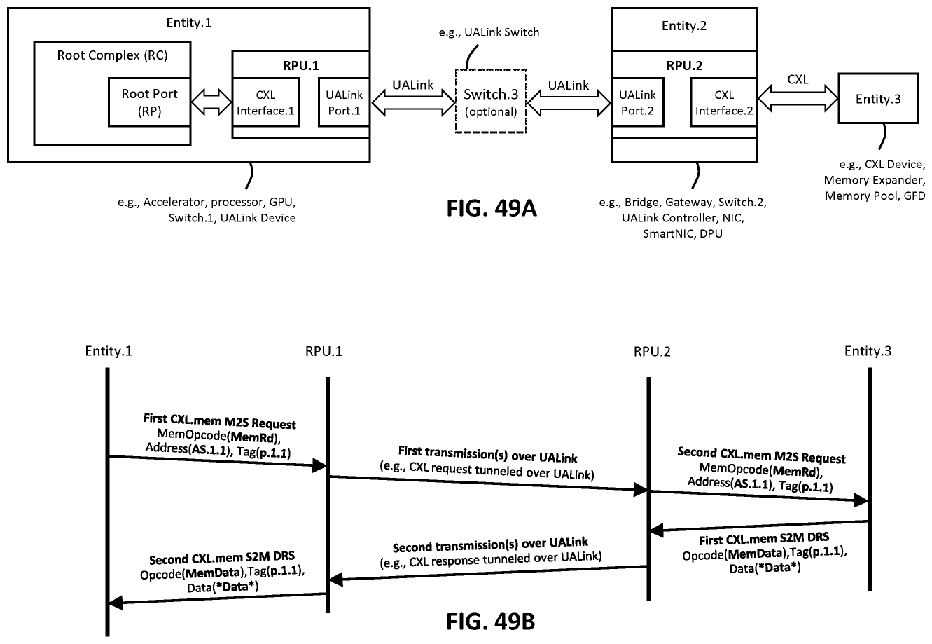

FIG. 49A illustrates an example of a system comprising a first entity (Entity.1), such as an accelerator, a processor, a GPU, a first switch (Switch.1), or a UALink device, wherein the first entity may include a Root Complex (RC) comprising a root port (RP), and may further include a first RPU (RPU.1) comprising a first CXL interface (CXL Interface.1) and a first UALink port (UALink Port.1). The system may further include an optional third switch (Switch.3), such as a UALink switch, and a second entity (Entity.2), such as a bridge, a gateway, a second switch (Switch.2), a UALink controller, a Network Interface Card (NIC), e.g., a UALink NIC, a SmartNIC, e.g., a UALink SmartNIC, or a Data Processing Unit (DPU), e.g., a UALink DPU. The second entity may include a second RPU (RPU.2) comprising a second CXL interface (CXL Interface.2) and a second UALink port (UALink Port.2). The system further includes a third entity (Entity.3), such as a CXL device, a memory expander, a memory pool, or a GFD.

The first and second RPUs may enable the first entity to communicate with the third entity according to a CXL-based protocol, via the second entity and optionally via the third switch (Switch.3), such as by translating between CXL-based PDUs (such as TLPs, requests, messages, or flits) and transmissions comprising data indicative of CXL PDUs, such as transmissions comprising data indicative of CXL opcodes and physical addresses, wherein the transmissions utilize UALink PDUs (such as UPLI messages or UALink flits, e.g., TL Flits, DL Flits, or Payload Flits), which may be sent and received via the first and second UALink ports, optionally enabling the first entity to access resources of the third entity, such as registers or memory. In some examples, translating between the CXL-based PDUs and the transmissions utilizing UALink PDUs may enable CXL over UALink, such as via CXL tunneling over UALink, e.g., tunneling of CXL.mem requests and responses over UALink, tunneling of CXL.io TLPs over UALink, tunneling of CXL-based PDUs over UALink, or tunneling of CXL transactions over UALink.

In some examples, the first UALink port and the second UALink port may utilize the same physical layer technology, such as a physical layer based on IEEE 802.3 PMA (e.g., UALink 200 PHY based on 802.3 Ethernet PHY), or a physical layer based on PCIe (e.g., UALink 128G based on PCIe 6.3). In other examples, the first UALink port and the second UALink port may utilize different physical layer technologies. The first RPU may be implemented in a chiplet inside an IC package of the first entity, as a functional block on the same silicon die with the RP, or may be split between dies or chiplets. Alternatively, the first RPU may be implemented as a discrete component coupled to the second entity. Additionally or alternatively, the first RPU may be included in a switch, such as in a UALink switch.

In some examples, the first entity may be a first switch (Switch.1) comprising the first UALink port, the second entity may be a second switch (Switch.2) comprising the second UALink port, and the CXL traffic between the first and second switches may be tunneled over UALink. Optionally, the first and second switches may be coupled by the third switch (Switch.3), which may be a UALink switch. In other examples, the first entity may be a first switch (Switch.1) comprising the first CXL interface (CLX Interface.1), the second entity may be a second switch (Switch.2) comprising the second CXL Interface (CXL Interface.2), and the CXL traffic between the RP and the third entity (e.g., a CXL device) may be tunneled over UALink via the second switch (Switch.2) and optionally via the third switch (Switch.3), which may be a UALink switch.

FIG. 49B illustrates an example of a TFD demonstrating a CXL communication between a first entity (Entity.1), such as a processor comprising a root port (RP), and a third entity (Entity.3), such as a CXL device, wherein the CXL communication may be tunneled over UALink. The first entity may initiate a read from the third entity, such as by sending a first CXL.mem M2S request comprising MemOpcode(MemRd), Address(AS.1.1), and Tag(p.1.1) via the RP. The first RPU (RPU.1), which may reside in the first entity, may receive the first CXL.mem M2S request and translate it to first transmission(s) comprising data indicative of CXL PDU, such as transmission(s) comprising data indicative of CXL opcodes and physical addresses, wherein the first RPU may send the first transmission(s) which may utilize one or more UALink PDUs (such as UPLI messages or UALink flits, e.g., TL Flits, DL Flits, or Payload Flits), to a second RPU (RPU.2), which may reside in a second entity, such as a bridge or a gateway. The first RPU may further translate the first CXL.mem M2S request to the first transmission(s) in a manner that enables reconstruction of the first CXL.mem M2S request at the second RPU with minimal (or no) modifications, effectively tunneling the first CXL.mem M2S request over UALink. For example, the first RPU may encapsulate the first CXL.mem M2S request into a UPLI write message, and send the UPLI write message to the second RPU, wherein the CXL request may be extracted from the UPLI write message such as by decapsulation. Additionally or alternatively, the first RPU may encapsulate a CXL flit comprising the first CXL.mem M2S request into a UPLI write message, and send the UPLI write message to the second RPU, wherein the CXL flit comprising the first CXL.mem M2S request may be extracted from the UPLI write message such as by decapsulation.

The second RPU may receive the first transmission(s) and translate it to a second CXL.mem M2S request comprising MemOpcode(MemRd), Address(AS.1.1), and Tag(p.1.1), and send the second CXL.mem M2S request to the third entity. In some examples, the first CXL.mem M2S request and the second CXL.mem M2S request may be identical, whereas in other examples the second RPU may construct the second CXL.mem M2S request based on the first CXL.mem M2S request with variations such as utilizing a different opcode (e.g., MemRdData instead of MemRd), utilizing a different Tag namespace, e.g., Tag(q.2.1) instead of Tag (p.1.1), or utilizing address translations, e.g., Address(AS.2.1) instead of Address(AS.1.1). The third entity may respond to the second CXL.mem M2S request by sending a first CXL.mem S2M DRS comprising Opcode(MemData), Tag(p.1.1), and Data(*Data*) to the second RPU, wherein the second RPU may translate the first CXL.mem S2M DRS to second transmission(s) comprising data indicative of CXL PDU, and send the second transmission(s) to the first RPU. The first RPU may further receive the second transmission(s) and translate it to a second CXL.mem S2M DRS comprising Opcode(MemData), Tag(p.1.1), and Data(*Data*), and send the second CXL.mem S2M DRS to the RP.

In some examples, the first CXL.mem S2M DRS and the second CXL.mem S2M DRS may be identical, whereas in other examples the first RPU may construct the second CXL.mem S2M DRS based on the first CXL.mem S2M DRS with variations, such as updating fields, e.g., Device Load (DevLoad), MetaField, MetaValue, TRP, Opcode, or reserved fields. Additionally or alternatively, the first RPU may alter the structure of the second CXL.mem S2M DRS compared to the original first CXL.mem S2M DRS, such as by adding a trailer. In some examples, the second CXL.mem M2S request may be different from the first CXL.mem M2S request due to differences in protocol revisions, such as when the first RPU communicates with the RP according to CXL 1.1, whereas the second RPU communicates with the third entity according to CXL 3.2, or such as when message format conversion is required between HBR and PBR formats, e.g., when the second RPU utilizes PBR mode or PBR messages, whereas, for example, the RP is associated with an HBR host. Similarly, the second CXL.mem S2M DRS may be different from the first CXL.mem S2M DRS due to differences in protocol revisions, or such as when message format conversion is required between HBR and PBR formats. In some examples, the first RPU and the second RPU may be coupled by a switch, such as a UALink switch.

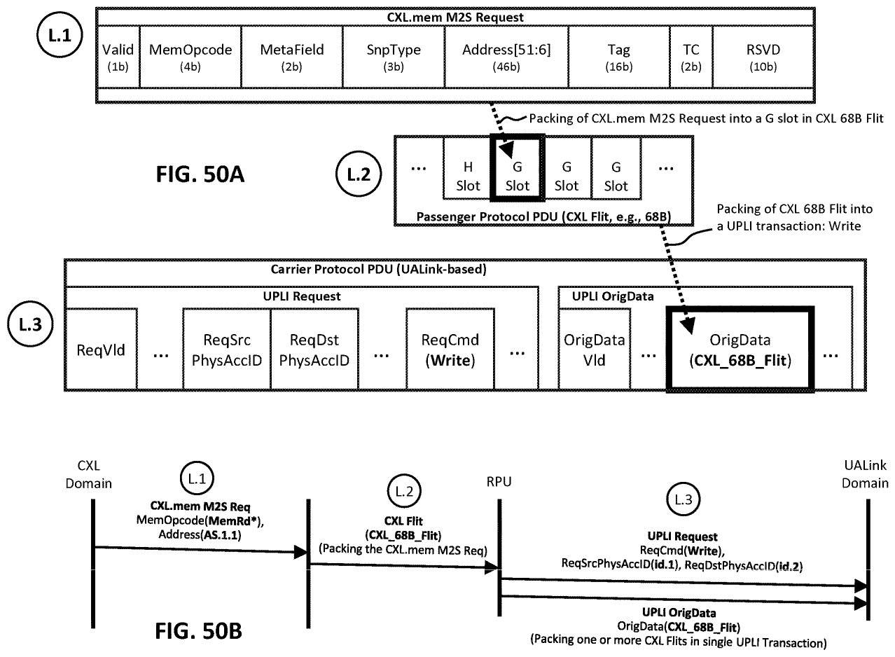

FIG. 50A illustrates an example of encapsulating 68-byte CXL flits into UPLI transactions comprising Write commands. The figure illustrates a CXL Transaction Layer message comprising a CXL.mem M2S request that is packed into a 68-byte CXL flit. The 68-byte CXL flits comprise H slots and G slots for organizing transaction data, wherein 68-byte flits correspond to CXL 1.1 and 2.0 specifications or may be utilized in other CXL versions. The UPLI side shows the encapsulation into a UPLI Write command, which supports variable payload sizes between 1 and 256 bytes, making it suitable for accommodating the 68-byte CXL flit payload. The UPLI Write command structure comprises a UPLI request section with fields including ReqVld, ReqSrcPhysAccID, ReqDstPhysAccID, and ReqCmd (Write), and a UPLI OrigData section wherein the 68-byte CXL flit payload is carried. The illustrated example may pack one or more 68-byte CXL flits into a UPLI transaction, enabling flexible encapsulations wherein 68-byte flits may be combined into a larger UPLI write command that does not necessarily utilize the full 256-byte capacity.

FIG. 50B illustrates an example of a TFD depicting translations utilized for encapsulating a 68-byte CXL flit into a UPLI Write command. The transaction flow shows a CXL.mem M2S request being packed into a 68-byte CXL Flit and subsequently encapsulated into a UPLI Write command. The UPLI Write command supports variable-size payloads and is suitable for encapsulating the 68-byte CXL flit, wherein the write command may specify the data payload size and utilize byte enables to indicate which bytes are being written. The TFD indicates that the OrigData channel of UPLI is utilized to pass the actual data content of the CXL flit. The encapsulation enables CXL communications to be transported over UPLI infrastructure, wherein the UPLI Write command provides sufficient capacity and flexibility to accommodate the 68-byte CXL flit payload that does not align with native UPLI block sizes of 64 bytes or 256 bytes. The byte enable mechanism allows specification of the valid data bytes within the write transaction, accommodating the non-standard 68-byte payload size.

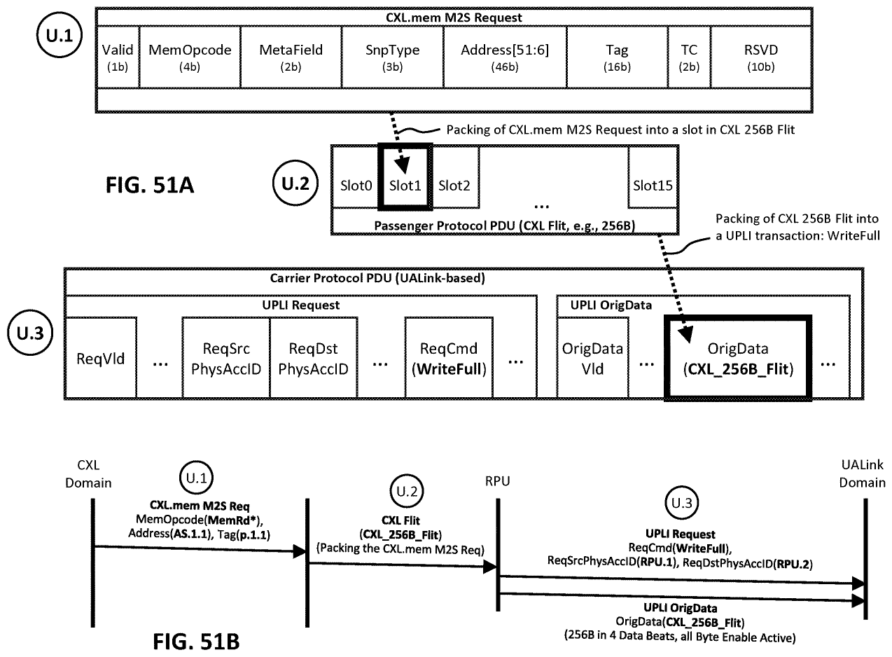

FIG. 51A illustrates an example of encapsulating 256-byte CXL flits into UPLI WriteFull commands. The figure is organized in three levels labeled U.1, U.2, and U.3, demonstrating the transformation from a CXL transaction layer message to UPLI carrier protocol PDU encapsulation. Level U.1 shows the CXL.mem M2S request message structure comprising fields Valid (1 bit), MemOpcode (4 bits), MetaField (2 bits), SnpType (3 bits), Address[51:6] (46 bits), Tag (16 bits), TC (2 bits), and RSVD (10 bits). Level U.2 shows the packing of the CXL.mem M2S request into a slot within a CXL 256-byte flit, wherein the flit structure comprises 16 slots labeled Slot0 through Slot15, representing the Passenger Protocol PDU (CXL Flit, e.g., 256 B). Level U.3 shows the packing of the CXL 256-byte flit into a UPLI transaction utilizing WriteFull command, wherein the Carrier Protocol PDU (UPLI Write) comprises two main sections: a UPLI request (Req) section with fields including ReqVld, ReqSrcPhysAccID, ReqDstPhysAccID, and ReqCmd (WriteFull), and a UPLI OrigData section wherein the CXL_256 B_Flit is carried as the OrigData payload. The WriteFull command is specifically designed for 256-byte payloads, matching the 256-byte CXL flit size and enabling efficient encapsulation wherein all bytes are active and all byte enables are set, in contrast to the variable-length Write command that requires byte enable management.

FIG. 51B illustrates an example of a TFD depicting translations utilized for encapsulating or packing of a CXL.mem request message into a 256-byte CXL flit that is further encapsulated into a UPLI WriteFull command. At U.1 in the CXL Domain, a CXL.mem M2S Req structure originates with MemOpcode(MemRd*), Address(AS.1.1), and Tag(p.1.1). At U.2, the RPU receives or generates a CXL Flit (designated as CXL_256 B_Flit), which indicates the packing of the CXL.mem M2S Req into the flit structure. At U.3 in the UALink Domain, the transaction is encapsulated into a UPLI request (Req) with ReqCmd(WriteFull), ReqSrcPhysAccID(RPU.1) identifying the source RPU, and ReqDstPhysAccID(RPU.2) identifying the destination RPU. The UPLI OrigData section carries the OrigData(CXL_256 B_Flit) payload, wherein the 256-byte payload is transmitted in 4 Data Beats with all Byte Enable Active, reflecting that UPLI transactions utilize 64-byte data beats such that four beats are required to transmit the 256-byte flit (4×64 bytes=256 bytes). The WriteFull command enables all bytes, indicating that the entire 256-byte capacity is utilized without requiring selective byte enable management, providing an efficient match between the 256-Byte CXL flit size and the 256-Byte UPLI WriteFull command capacity.

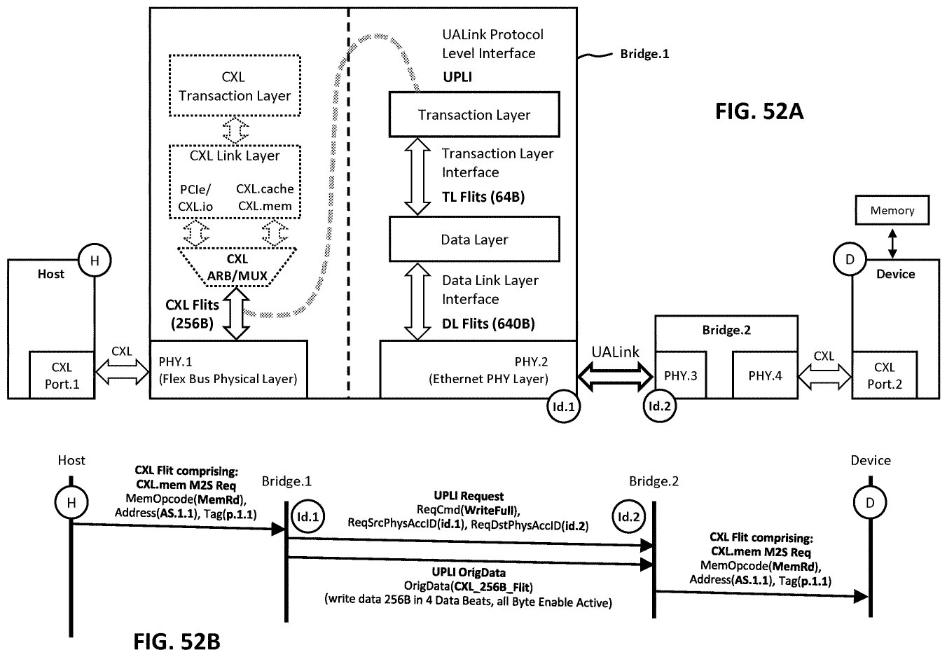

FIG. 52A illustrates an example of a system that translates CXL flits to UPLI transaction layer messages, providing a method for passing CXL protocols over a UALink infrastructure, wherein LL denotes link layer and TL denotes transaction layer. The system captures CXL flits from the interface between the CXL ARB/MUX and the Flex bus physical layer, or from the Flex bus physical layer (denoted as PHY.1), and maps them to the UPLI transaction layer. The upper-layers of the CXL side of the system, that may include the CXL Transaction Layer, the CXL Link Layer, and the CXL ARB/MUX, is illustrated with dotted lines, indicating that the dotted elements may not be utilized in the translation process. The interface between the CXL ARB/MUX and the Flex bus physical layer conveys CXL Flits, such as 256 bytes Flits, which may be captured for mapping to the UPLI transaction layer. The UPLI side shows the UPLI Transaction Layer that transmits TL Flits (of 64 Bytes in one example) to the Data Link Layer that transmits, via the data link layer interface, DL Flits (of 640 Bytes in one example) to the Ethernet PHY layer (denoted as PHY.2). The translation from the CXL link layer to the UPLI transaction layer may provide advantages wherein traffic may already be packed efficiently at the CXL link layer, and may enable support for various protocol types including CXL.mem, CXL.cache, CXL.io, and PCIe, without requiring separate translation schemes for each protocol type, wherein at the CXL link layer the protocols are packed into CXL flits regardless of whether the original traffic is PCIe, CXL.io, CXL.cache, or CXL.mem. The system encapsulates CXL flits entirely into UPLI requests, wherein 256-byte CXL flits may be packed into 256-byte UALink WriteFull transactions, wherein WriteFull utilizes the maximum 256-byte payload size in contrast to regular UALink write commands that support variable length with byte enables. The dotted lines for the CXL Transaction Layer and the CXL Link Layer indicate that these layers are bypassed in the translation process, distinguishing this example from transaction layer to transaction layer translations.

FIG. 52B illustrates an example of a TFD depicting the tunneling of CXL flits over UPLI, wherein the CXL flit structure is preserved during encapsulation and transport. The TFD shows a CXL Flit, which may include a CXL.mem M2S Req or other CXL transactions, being translated to a UPLI WriteFull command. The notation indicates that the CXL Flit comprises CXL transactions that were originally present at the transaction layer but are now packed within the flit structure. The UPLI WriteFull command encapsulates the entire 256-byte CXL flit, maintaining the flit structure intact during transmission over the UALink infrastructure. The TFD demonstrates flit-level tunneling wherein the contents of the flit remains opaque to the intermediate protocol, enabling a universal transport mechanism that may support various types of CXL protocol, possibly including future CXL protocols, without requiring modifications to the translation logic, wherein the CXL link layer packs transactions into CXL flits and the translation process encapsulates these CXL flits into UPLI transactions for transport. The illustrated example may operate point-to-point between known endpoints, wherein switching decisions are made at the transaction layer by edge switches while the tunneling maintains CXL flit integrity between translation points.

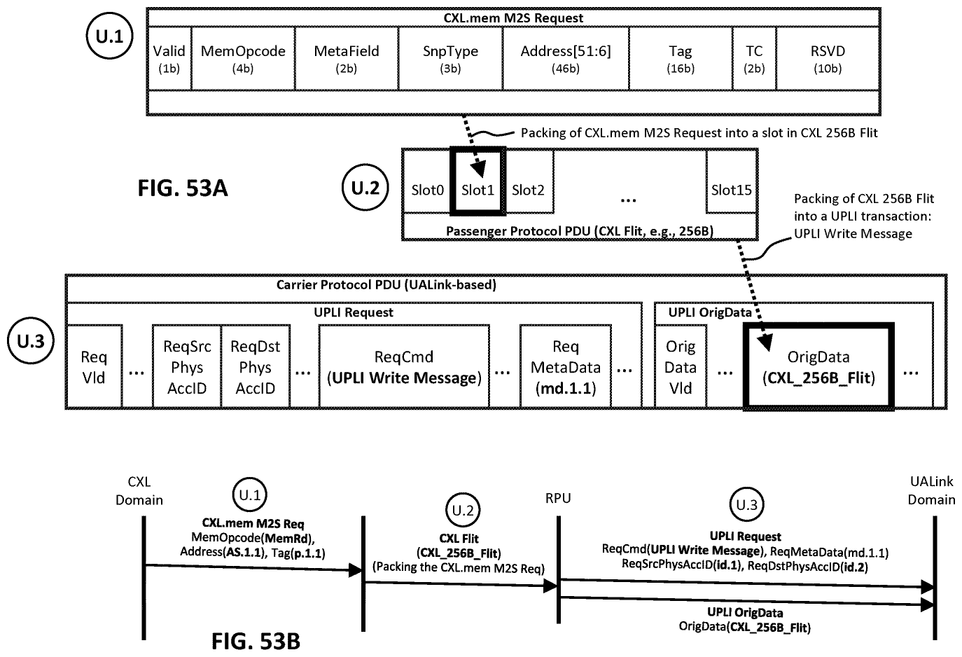

FIG. 53A illustrates an example of utilizing a UPLI write message command for tunneling CXL flits, wherein the UPLI write message command provides both read and write semantics. The UPLI write message command may be suitable for tunneling applications wherein bidirectional data flow is required, enabling both read operations (wherein data flows from the remote side back to the requester) and write operations (wherein data flows from the requester to the remote side). The UPLI write message command may support general-purpose tunneling wherein the flexibility of supporting both read and write patterns within a single command type may simplify the translation logic. The UPLI write message command may be utilized to encapsulate CXL flits regardless of whether the underlying CXL transaction is a read request (wherein response data will flow in the opposite direction) or a write request (wherein data accompanies the request).

FIG. 53B illustrates an example of a TFD depicting utilizing a UPLI write message command for tunneling a CXL transaction, wherein the command's dual semantics enable handling of both read and write transaction patterns. The TFD demonstrates how CXL requests are encapsulated within UPLI write message commands for transport over UPLI infrastructure, such as UALink infrastructure, wherein the UPLI write message command provides the flexibility to support the bidirectional nature of CXL communications. The UPLI write message command enables maintaining the transaction during tunneling operations, wherein read requests generate data responses flowing in the reverse direction and write requests include data flowing in the forward direction, and wherein a single command type accommodates both patterns.

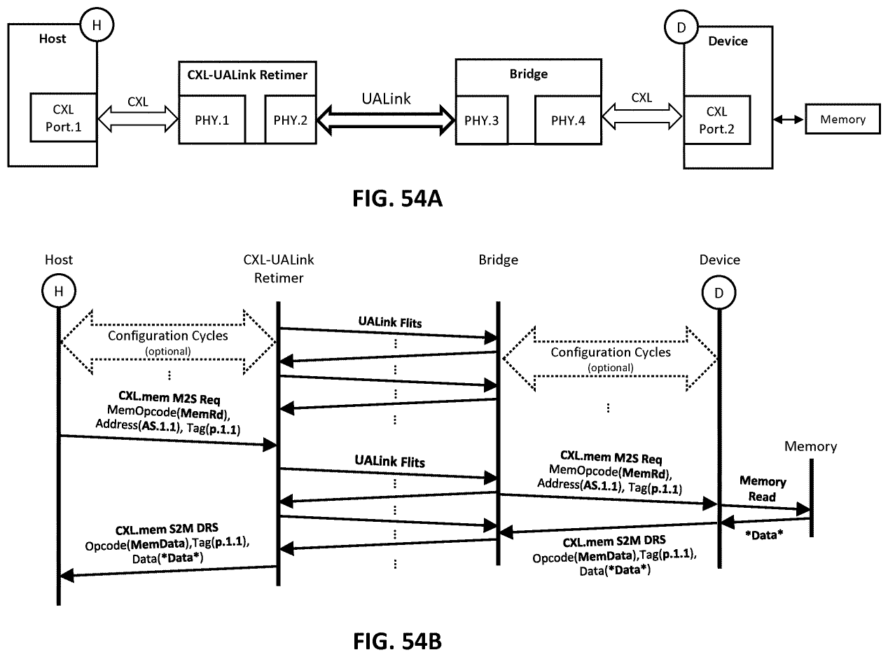

FIG. 54A illustrates an example of a system comprising a host comprising a first CXL port, a retimer (such as a flit-aware CXL-UALink retimer or a hybrid multi-protocol retimer), a bridge (which may be an RPU), and a device comprising a second CXL port. The retimer may communicate with the host via a first physical layer (PHY.1), such as a Flex Bus PHY, a UCIe PHY, or an NVLink-C2C PHY, and may further communicate with the bridge via a second physical layer (PHY.2) based on IEEE 802.3 PMA, such as a UALink PHY, an NVLink PHY, or an Ethernet PHY. The bridge may receive, via a third physical layer (PHY.3) based on IEEE 802.3 PMA (such as a UALink PHY, an NVLink PHY, or an Ethernet PHY), transmissions comprising data indicative of CXL opcodes and physical addresses, wherein the bridge may further translate the data to CXL requests, such as CXL.mem M2SReq, and send the translated CXL request to the device, via a fourth PHY (PHY.4, such as a Flex Bus PHY, a UCIe PHY, or an NVLink-C2C PHY), enabling the host to read the memory coupled to the device.

In some examples, the transmissions comprising data indicative of CXL opcodes and physical addresses may include tunneling or encapsulation of CXL-related traffic, such as tunneling or encapsulation of CXL PDUs, CXL messages, CXL requests, CXL responses, CXL.io TLPs, or CXL flits, over a carrier protocol such as UALink, UPLI, NVLink, or Ethernet, including Scale Up Ethernet (SUE) or Ultra Ethernet Transport (UET). The tunneling or encapsulation of CXL-related traffic over the carrier protocol may be performed from different layers of the CXL protocol stack to different layers of the carrier protocol stack, such as (1) tunneling or encapsulation of CXL transaction layer PDUs, e.g., CXL messages or TLPs, over UALink UPLI layer PDUs, e.g., UPLI write requests or UPLI requests utilizing vendor-defined commands, (2) tunneling or encapsulation of CXL messages or TLPs over UALink Transaction Layer (TL) Flits, such as over 64-Byte UALink TL Flits, (3) tunneling or encapsulation of CXL messages or TLPs over UALink Data Link Layer (DL) Flits, such as 640-Byte UALink DL Flits, or (4) tunneling or encapsulation of CXL flits in/over carrier protocol flits, such as over UALink flits (e.g., UALink TL flits or UALink DL flits), or over NVLink flits.

In some examples, one or more CXL flits may be tunneled over or encapsulated in a carrier protocol flit, such as over a UALink flit or an NVLink flit. In still other examples, the bridge may be implemented in a chiplet inside an IC package of the device, whereas in other examples the bridge may be implemented as a functional block on the same silicon die with the memory controller, or may be split between dies or chiplets. Alternatively, the bridge may be implemented as a discrete component coupled to the device. Additionally or alternatively, the bridge may be included in a switch, such as a UALink switch or a CXL switch.

FIG. 54B illustrates an example of a TFD demonstrating CXL communications between a host and a device utilizing a PHY based on IEEE 802.3 PMA, such as a UALink PHY, an NVLink PHY, or an Ethernet PHY. In some examples, CXL requests sent by the host, may be converted or translated by a retimer, such as a CXL-UALink retimer, to transmissions that may include data indicative of CXL opcodes and physical addresses, which may be packed in UALink flits. In other examples, the data indicative of CXL opcodes and physical addresses may be packed in NVLink flits. CXL responses from the device may be converted or translated by the bridge to transmissions that may be packed in UALink flits and sent towards the host. Optionally, the system may utilize configuration cycles for discovery, enumeration, and initialization of the device.

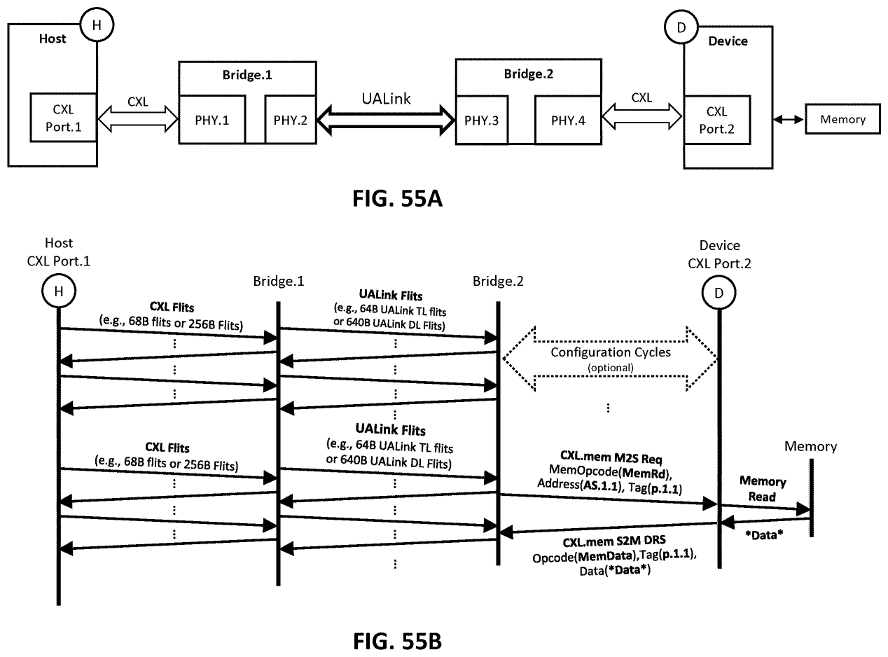

FIG. 55A illustrates an example of a system comprising a host with a first CXL port coupled to Bridge.1 via a first PHY (PHY.1), which may be implemented as a Flex Bus PHY, a UCIe PHY, or an NVLink-C2C PHY. Bridge.1 communicates with Bridge.2 via a second PHY (PHY.2) which may be based on IEEE 802.3 PMA, and may utilize a UALink PHY, an NVLink PHY, or an Ethernet PHY. Bridge.2 is coupled to a device comprising a second CXL port, via a fourth PHY (PHY.4), which may be implemented as a Flex Bus PHY, a UCIe PHY, or an NVLink-C2C PHY. In this example, Bridge.1 may potentially provide bridge-specific features while maintaining the ability to transport CXL protocol data units across the physical layer based on IEEE 802.3 PMA between the bridges.

FIG. 55B illustrates an example of a TFD demonstrating a translation between CXL flits and UALink flits, showing how CXL protocol data units (PDUs) may be packed, encapsulated or translated for transmission over UALink physical layers, such as IEEE 802.3-based UALink physical layers, or PCIe-based UALink physical layers. The figure shows CXL flits, which may include 68-byte flits or 256-byte flits depending on the CXL protocol configuration, being translated to UALink flits without specifying the particular protocol layer at which the translation occurs, as the translation may be performed at the transaction layer, link layer, or flit level depending on the implementation requirements. The translation enables CXL transactions to traverse a UALink infrastructure while maintaining protocol semantics, wherein the specific methodology for translating between the flit formats may vary based on factors such as bandwidth optimization, latency requirements, and protocol compatibility constraints.

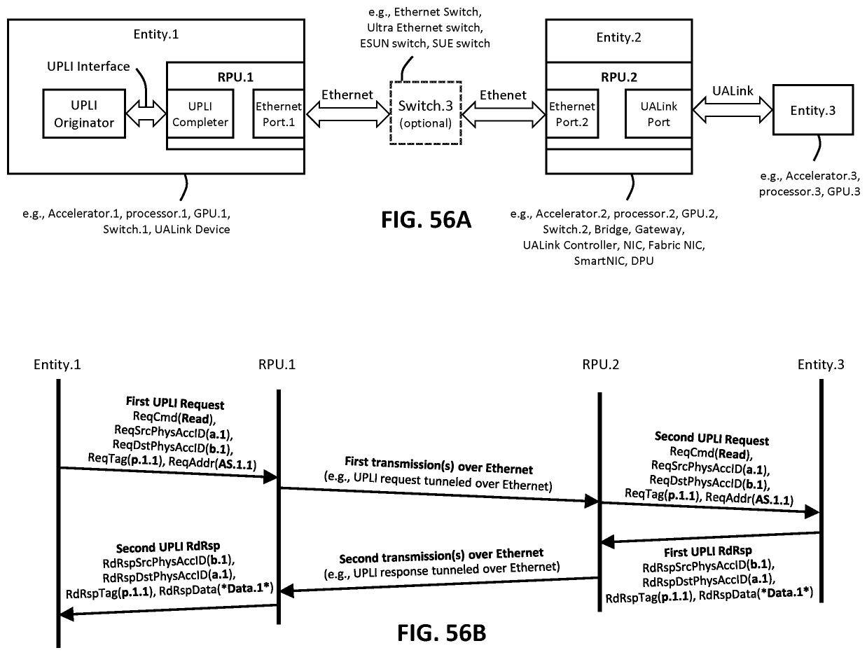

FIG. 56A illustrates an example of a system comprising a first entity (Entity.1), a second entity (Entity.2), and a third entity (Entity.3). The first entity (Entity.1) may include a first accelerator (Accelerator.1), a first processor (Processor.1), a first GPU (GPU.1), a first switch (Switch.1), or a UALink device, a UPLI originator. The first entity may further include a first RPU (RPU.1) comprising a UPLI completer and a first Ethernet port (Ethernet Port.1). The second entity (Entity.2) may include a second accelerator (Accelerator.2), a second processor (Processor.2), a second GPU (GPU.2), a bridge, a gateway, a UALink controller, a Network Interface Card (NIC), a Fabric NIC, a SmartNIC, or a Data Processing Unit (DPU), e.g., a UALink DPU. The second entity may further include a second RPU (RPU.2) comprising a second Ethernet port (Ethernet Port.2) and a UALink port. The third entity (Entity.3) may include a third accelerator (Accelerator.3), a third processor (Processor.3), or a third GPU (GPU.3). Additionally, the system may include an optional third switch (Switch.3), such as an Ethernet switch, an Ultra Ethernet switch, an ESUN switch, or an SUE switch.

The first and second RPUs may enable the first entity to communicate with the third entity according to a UALink-based protocol, such as UPLI, via the second entity and optionally via the third switch (Switch.3), such as by translating between UALink-based messages and transmissions comprising data indicative of UALink-based messages (e.g., transmissions comprising data indicative of UPLI messages, such as UPLI request messages), wherein the transmissions may utilize Ethernet-based frames such as standard Ethernet frames, which may be sent and received via the first and second Ethernet ports, optionally enabling the first entity to access resources of the third entity, such as registers or memory. In some examples, translating between the UALink-based messages and the transmissions utilizing Ethernet-based frames may enable UALink over Ethernet, such as via UALink tunneling over Ethernet, e.g., tunneling of UPLI requests and responses over Ethernet, or tunneling of UPLI transactions over Ethernet. In some examples, the first Ethernet port and the second Ethernet port may utilize the same physical layer technology, such as a physical layer based on IEEE 802.3 PMA (e.g., Ethernet PHY). In other examples, the first Ethernet port and the second Ethernet port may utilize different physical layer technologies. The first RPU may be implemented in a chiplet inside an IC package of the first entity, as a functional block on the same silicon die with the UPLI originator, or may be split between dies or chiplets. Alternatively, the first RPU may be implemented as a discrete component coupled to the second entity. Additionally or alternatively, the first RPU may be included in a switch, such as in an Ethernet switch.

FIG. 56B illustrates an example of a TFD demonstrating UALink-based communication, such as UPLI communication, between a first entity (Entity.1), such as a first accelerator, and a third entity (Entity.3), such as a third accelerator, wherein the UALink-based communication may be tunneled over Ethernet, such as over standard Ethernet, over Ultra Ethernet, over ESUN, or over SUE.

The first entity may initiate a read from the third entity, such as by sending a first UPLI request (Req) comprising ReqCmd(Read), ReqSrcPhysAccID(a.1), ReqDstPhysAccID(b.1), ReqTag(p.1.1), and ReqAddr(AS.1.1). The first RPU (RPU.1), which may reside in the first entity, may receive the first UPLI request (Req) and translate it to first transmission(s) comprising data indicative of UPLI messages, such as transmission(s) comprising data indicative of UPLI requests, wherein the first RPU may send the first transmission(s) which may utilize one or more Ethernet frames, to a second RPU (RPU.2), which may reside in a second entity, such as a bridge or a gateway. The first RPU may translate the first UPLI request (Req) to the first transmission(s) in a manner that enables reconstruction of the first UPLI request (Req) at the second RPU with minimal (or no) modifications, effectively tunneling the first UPLI request (Req) over Ethernet. For example, the first RPU may encapsulate the first UPLI request (Req) into an Ethernet frame, and send the Ethernet frame to the second RPU, wherein the first UPLI request (Req) may be extracted from the Ethernet frame such as by decapsulation. Additionally or alternatively, the first RPU may encapsulate a UALink flit comprising the first UPLI request (Req) into an Ethernet frame, and send the Ethernet frame to the second RPU, wherein the UALink flit comprising the first UPLI request (Req) may be extracted from the Ethernet frame such as by decapsulation.

The second RPU may receive the first transmission(s) and translate it to a second UPLI request (Req) comprising ReqCmd(Read), ReqSrcPhysAccID(a.1), ReqDstPhysAccID(b.1), ReqTag(p.1.1), and ReqAddr(AS.1.1), and send the second UPLI request (Req) to the third entity. In some examples, the first UPLI request (Req) and the second UPLI request (Req) may be identical, whereas in other examples the second RPU may construct the second UPLI request (Req) based on the first UPLI request (Req) with variations such as utilizing a different command (e.g., utilizing a Read class Vendor Defined Command instead of Read), utilizing a different tag namespace, e.g., ReqTag(p.2.1) instead of ReqTag(p.1.1), or utilizing address translations, e.g., ReqAddr(AS.2.1) instead of ReqAddr(AS.1.1).

The third entity may respond to the second UPLI request (Req) by sending a first UPLI read response/data (RdRsp) comprising RdRspSrcPhysAccID(b.1), RdRspDstPhysAccID(a.1), RdRspTag(p.1.1), and RdRspData(*Data.1*) to the second RPU, wherein the second RPU may translate the first UPLI read response/data (RdRsp) to second transmission(s) comprising data indicative of UPLI messages, such as transmission(s) comprising data indicative of UPLI responses, and send the second transmission(s) to the first RPU. The first RPU may further receive the second transmission(s) and translate it to a second UPLI read response/data (RdRsp) comprising RdRspSrcPhysAccID(b.1), RdRspDstPhysAccID(a.1), RdRspTag(p.1.1), and RdRspData(*Data.1*), and send the second UPLI read response/data (RdRsp) to the first entity. In some examples, the first UPLI read response/data (RdRsp) and the second UPLI read response/data (RdRsp) may be identical, whereas in other examples the first RPU may construct the second UPLI read response/data (RdRsp) based on the first UPLI read response/data (RdRsp) with variations, such as updating fields, e.g., RdRspPortID, RdRspAuthTag, RdRspSrcPhysAccID, RdRspDstPhysAccID, RdRspTag, or reserved fields. Additionally or alternatively, the first RPU may alter the structure of the second UPLI read response/data (RdRsp) compared to the original first UPLI read response/data (RdRsp), such as by appending metadata to the original data contents of the first UPLI read response/data (RdRsp). In some examples, the second UPLI request (Req) may be different from the first UPLI request (Req) due to differences in protocol revisions, such as different UALink protocol revisions. Similarly, the second UPLI read response/data (RdRsp) may be different from the first UPLI read response/data (RdRsp) due to differences in protocol revisions. In some examples, the first RPU and the second RPU may be coupled by a switch, such as an Ethernet switch.

Some implementations of the following apparatus relate to processor architectures that incorporate interconnects with CXL protocol interfaces coupled through interconnect components and RPUs for enabling CXL communication with external entities via a physical layer based on IEEE 802.3 PMA. The interconnect within the processor may be implemented as a mesh interconnect that routes messages among processing cores, cache controllers, home agents, memory controllers, and interface agents through crosspoints or similar routing elements. Interconnect components, such as ARM CCG, may bridge CXL protocol domains with CHI protocol domains on the interconnect, enabling CXL devices coupled to RPUs to exchange coherent and non-coherent traffic with agents on the interconnect. The CXL device may be implemented in at least one of the RPU or the interconnect component, and may serve as the CXL endpoint logic that enables CXL transactions between the external entities and the interconnect. The RPU and the interconnect component may together perform the translation between CXL transactions associated with data communicated with external entities via the physical layer based on IEEE 802.3 PMA, and interconnect transactions communicated via the interconnect. The translation may include extracting CXL information from carrier protocol PDUs, reconstructing CXL transactions, performing address and Tag translations, translating CXL transactions to interconnect transactions, and encapsulating CXL responses for transmission back to external entities.

In various implementations, an apparatus comprising: a processor comprising processing cores coupled via an interconnect; an interconnect component coupled to the interconnect; a resource provisioning unit (RPU) coupled to the interconnect component; a physical layer based on IEEE 802.3 physical medium attachment (PMA), coupled to the RPU, configured to communicate with an external entity; a Compute Express Link (CXL) device implemented in at least one of the RPU or the interconnect component; and wherein at least one of the RPU or the interconnect component is configured to translate between CXL transactions and interconnect transactions; wherein the CXL transactions are associated with data communicated with the external entity via the physical layer based on IEEE 802.3 PMA, and the interconnect transactions are communicated via the interconnect. The processor may be implemented as a SoC, a multi-chip module, or a chiplet-based design incorporating processing cores, an interconnect, and various interface agents. The interconnect may provide a scalable on-chip fabric that routes transactions among agents based on packet identifiers, node addresses, or other routing information. The interconnect component may translate between CXL transactions (such as CXL.mem M2S and S2M transactions, CXL.cache H2D and D2H transactions) and interconnect transactions (such as CHI Read, Write, Snoop, and Data transactions) for communication with agents on the interconnect. The CXL device, implemented in at least one of the RPU or the interconnect component, may present CXL endpoint functionality, implementing the CXL protocol logic for one or more CXL sub-protocols. The RPU and the interconnect component may together perform carrier-to-CXL and CXL-to-interconnect protocol translations, enabling external entities connected via the IEEE 802.3 PMA to exchange CXL traffic with the processor's interconnect-coupled agents. Multiple interconnect components may be utilized to provide ports or to handle different CXL sub-protocols.

In the context of coherent interconnects, an interconnect component may refer to various types of devices, blocks, or functional entities that participate in, terminate, bridge, gateway, aggregate, or otherwise interface with a coherent or non-coherent fabric. Non-limiting examples of interconnect components may include router modules, request nodes, home nodes, subordinate nodes, gateways, bridges, and domain bridges. For example, in certain revisions of ARM-based coherent mesh architectures, such as the ARM Neoverse and CoreLink CMN families, interconnect components may include: crosspoint (XP) router blocks; Request Nodes, such as Fully Coherent Request Node (RN-F), I/O-coherent Request Node (RN-I), or I/O-coherent Request Node with Distributed Virtual Memory support (RN-D); Home Nodes, such as Fully Coherent Home Node (HN-F) or I/O-coherent Home Node (HN-I); Gateways, such as CXL/CCIX Gateway (CCG) blocks used with Coherent Multichip Link (CML) or external CXL attachment, or CCIX Gateway (CXG) bridging between CHI and CXS interfaces; and Bridges, such as AMBA 5 CHI to ACE5-Lite bridge (SBSX), AMBA Domain Bridge (ADB), CHI Domain Bridge (CDB), or CXS Domain Bridge (CXSDB). Other revisions of ARM architectures or other coherent interconnect architectures may define different interconnect component types, classifications, or naming conventions.

In some implementations of the apparatus, the interconnect component comprises an ARM CXL/CCIX Gateway (CCG). The CCG may translate between CXL and CHI protocol domains. The CCG may be coupled to the interconnect via one or more ports at a crosspoint.

In some implementations of the apparatus, the interconnect comprises a mesh interconnect, the mesh interconnect comprising crosspoints (XPs) configured to route interconnect transactions between the processing cores, the interconnect component, and memory controllers based on packet identifiers. The crosspoints may function as routing elements at intersections within the mesh topology, examining fields within packets to determine the appropriate output port and routing path. Packet identifiers may include target node identifiers, address-based routing information, or other fields defined by the interconnect protocol for mesh routing. The crosspoints may connect to processing cores, LLC slices, home agents, memory controllers, interconnect components, RN-D nodes, SN-F nodes, and other agents on the mesh interconnect.

In some implementations, the apparatus further comprises an I/O-coherent Request Node with Distributed Virtual Memory support (RN-D) coupled to the interconnect, the RN-D configured to handle CXL.io or non-coherent traffic between the CXL device and the processing cores. The RN-D may handle CXL.io configuration reads and writes, memory-mapped I/O (MMIO) access, and other non-coherent transactions. The RN-D may support Distributed Virtual Memory (DVM) operations, which may enable synchronization of virtual memory management operations across the interconnect.

In some implementations, the apparatus further comprises Subordinate Node (SN-F) nodes coupled to memory controllers, the memory controllers coupled to DRAM via DDR PHY and memory channels. The SN-F nodes may serve as subordinate agents on the interconnect that interface between the interconnect protocol domain and the memory controllers. The SN-F nodes may include snoop filter functionality for tracking cacheline state and location across the interconnect. The memory controllers may access DRAM through DDR PHY interfaces and memory channels, supporting memory technologies such as DDR4, DDR5, LPDDR5, or HBM. When a CXL.mem request from an external entity is translated through the RPU, the request may be routed through the interconnect to a home node, which may in turn access the SN-F node and memory controller to read from or write to DRAM.

In some implementations of the apparatus, the interconnect component comprises a CXL Streaming (CXS) interface and a Coherent Multichip Link (CML) gateway or a Cache Coherent Interconnect for Accelerators (CCIX) Gateway (CXG) that utilizes the CXS interface. Utilizing the CXS interface may enable modular design where different CXL device configurations can be paired with different interconnect component implementations. The CXS interface may support flow control, credit management, and virtual channels for different CXL sub-protocols. The CML gateway or CXG may utilize the CXS interface as the streaming interface protocol for exchanging CXL transactions between the CXL device and the interconnect. The CML gateway may provide coherent multichip link functionality that extends the coherent interconnect across chip boundaries, while the CXG may provide CCIX-based gateway functionality that bridges between CXL and CHI protocol domains with CCIX compatibility. Optionally, a 32-bit cyclic-redundancy check (CRC-32) may be applied to transactions conforming to the CXS interface to detect bit errors, which may be beneficial when the CXS interface spans die-to-die boundaries within a multi-chip module or chiplet-based design where signal integrity conditions may differ from on-die interconnects.

In some implementations of the apparatus, the interconnect component is configured to initiate a CHI allocating ReadShared request to a Home Node in response to a CXL.mem request, wherein the Home Node is coupled to a memory controller. When the RPU receives a CXL.mem read request from an external entity via the physical layer based on IEEE 802.3 PMA and translates it into a CXL transaction, the interconnect component may translate the CXL.mem request into a CHI allocating ReadShared request directed to the Home Node responsible for the targeted address.

In some implementations of the apparatus, the Home Node is configured to send a ReadNoSnp request to the memory controller, and the memory controller is configured to return data to the interconnect component using a CompData response. The combined response optimization may reduce transaction latency by enabling the memory controller to send response data directly to the interconnect component as the requester, rather than routing the data back through the Home Node.

In some implementations of the apparatus, the CXL device comprises a Global Fabric-Attached Memory Device (GFD) supporting CXL.mem transactions, and the interconnect component is optimized for handling CXL.mem traffic. The GFD may operate as a specialized CXL device that supports CXL.mem transactions without supporting CXL.io or CXL.cache sub-protocols. By limiting the supported sub-protocols to CXL.mem, the GFD and the associated interconnect component may be optimized specifically for memory access operations, simplifying the design by eliminating the need for separate CXL.io handling paths that would otherwise be managed by RN-D or RN-I nodes. This simplified architecture may be suitable for processors or accelerators designed for servicing external memory requests through fabric-attached memory pooling, where CXL.io configuration and enumeration may be handled through alternative mechanisms or may not be utilized.

In some implementations of the apparatus, the data communicated with the external entity via the physical layer based on IEEE 802.3 PMA comprises protocol data units (PDUs) of a carrier protocol encapsulating CXL PDUs, and the RPU is configured to extract CXL PDUs from the carrier protocol PDUs. The carrier protocol may include Ethernet, Ultra Ethernet Transport (UET), Ethernet for Scale-Up Networking (ESUN), Scale Up Ethernet (SUE), UALink, NVLink, or other protocols that utilize the IEEE 802.3 PMA for data transmission. The carrier protocol PDUs may encapsulate CXL information within carrier protocol headers and trailers, including encapsulating headers with fields such as source and destination node identifiers, segmentation identifiers, PDU sequence numbers, and passenger protocol identifiers. The RPU may extract the encapsulated CXL PDUs by parsing the carrier protocol headers, identifying the passenger protocol type, extracting CXL fields from the carrier protocol payload, translating field formats between carrier and CXL representations, and reconstructing complete CXL PDUs conforming to the CXL specification. The extracted and reconstructed CXL transactions may then be communicated to the interconnect component for translation to interconnect transactions.

In some implementations of the apparatus, the external entity comprises at least one of a GPU, an accelerator, or a switch, and the apparatus is configured to enable the external entity to access memory coupled to memory controllers of the processor via the RPU and the interconnect component. External entities such as GPUs, accelerators (including AI/ML accelerators, FPGAs, and data processing units), or switches may communicate with the processor through a carrier protocol fabric via the physical layer based on IEEE 802.3 PMA. The RPU and the interconnect component may translate carrier protocol PDUs from these external entities into interconnect transactions that traverse the interconnect to home nodes and memory controllers, which access DRAM to service the requests. This path may enable external entities to read from or write to the processor's memory for purposes such as shared memory access in heterogeneous computing environments, memory pooling across a fabric, or remote direct memory access (RDMA) operations.

In various implementations, a method comprising: receiving, via a physical layer based on IEEE 802.3 physical medium attachment (PMA), data from an external entity; translating, utilizing a Compute Express Link (CXL) device implemented in at least one of a resource provisioning unit (RPU) or an interconnect component coupled to an interconnect of a processor, between CXL transactions and interconnect transactions communicated via the interconnect; and wherein the processor comprises processing cores coupled via the interconnect, and the CXL transactions are associated with the data received from the external entity via the physical layer based on IEEE 802.3 PMA. The receiving of data may include receiving carrier protocol PDUs from the external entity via the physical layer based on IEEE 802.3 PMA. The translating may include extracting CXL information from the received data, reconstructing CXL transactions conforming to the CXL specification, and translating the CXL transactions into interconnect transactions for routing through the interconnect. The CXL device, implemented in at least one of the RPU or the interconnect component, may provide the CXL protocol endpoint functionality utilized during the translation.

In some implementations of the method, the data comprises protocol data units (PDUs) of a carrier protocol encapsulating CXL PDUs, and the translating comprises extracting CXL PDUs from the carrier protocol PDUs and reconstructing CXL transactions from the extracted CXL PDUs. The carrier protocol PDUs may include headers and trailers specific to the carrier protocol (such as Ethernet, UET, ESUN, or SUE), encapsulating headers with routing and identification metadata, and a payload containing CXL PDU fields. The extraction may involve parsing the carrier protocol structure, identifying the CXL sub-protocol type from a passenger protocol identifier, extracting CXL fields such as opcodes, addresses, and transaction identifiers, and translating field formats where the carrier protocol utilizes different encodings than the CXL specification. Reconstruction may include assembling the extracted and translated fields into complete CXL transactions and inserting any fields that were omitted from the carrier protocol PDU for bandwidth optimization, utilizing configuration parameters or default values for the omitted fields.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

Some implementations of the following apparatus further relate to processor architectures where a CXL root port couples to an interconnect for exchanging CXL traffic with external entities via an RPU and a physical layer based on IEEE 802.3 PMA. A root port may provide root complex functionality and may couple to the interconnect through different nodes depending on the types of CXL traffic to be supported. In one configuration, the root port may couple to a fully coherent request node (RN-F) and a fully coherent home node (HN-F), enabling bidirectional coherent access where external entities access the processor's memory and the processor's cores access resources coupled to external entities. In another configuration, the root port may couple to a CXL/CCIX Gateway (CCG) and an RN-D node, providing coherent CXL.mem handling through the CCG and non-coherent CXL.io handling through the RN-D node.

In various implementations, an apparatus comprising: a processor comprising processing cores coupled via an interconnect; a Compute Express Link (CXL) root port coupled to the interconnect; a resource provisioning unit (RPU) coupled to the CXL root port; a physical layer based on IEEE 802.3 physical medium attachment (PMA), coupled to the RPU, configured to communicate with an external entity; and wherein at least one of the RPU or the CXL root port is configured to translate between CXL transactions and interconnect transactions; wherein the CXL transactions are associated with data communicated with the external entity via the physical layer based on IEEE 802.3 PMA, and the interconnect transactions are communicated via the interconnect. The CXL root port may provide root complex functionality for CXL devices and endpoints coupled to or accessed through the RPU and the IEEE 802.3 PMA. The root port may be coupled to the interconnect through one or more intermediate nodes that translate between CXL protocol transactions and interconnect protocol transactions for communication with agents on the interconnect. The specific node configuration through which the root port is coupled to the interconnect may vary depending on the types of CXL traffic to be supported and the coherency requirements of the deployment. The RPU and the CXL root port may together translate between CXL transactions associated with data from external entities (received as carrier protocol PDUs via the IEEE 802.3 PMA) and interconnect transactions communicated via the interconnect.

In some implementations of the apparatus, the CXL root port is coupled to a fully coherent request node (RN-F) and a fully coherent home node (HN-F) on the interconnect. The RN-F and HN-F may be included within a gateway or bridge node structure coupled between the root port and the interconnect. The RN-F may act as a fully coherent request node that participates in the interconnect coherency protocol, enabling it to issue fully coherent requests (such as ReadShared, ReadUnique, or MakeUnique) on behalf of external entities whose CXL traffic arrives through the RPU and root port. The HN-F may act as a fully coherent home node that manages a portion of the address space, enabling the processor's cores to issue coherent requests to resources accessible through the external entity. Together, the RN-F and HN-F may enable bidirectional coherent communication between the processor and external entities through the CXL root port path.

In some implementations of the apparatus, the RN-F enables the external entity to access memory coupled to memory controllers of the processor via the physical layer based on IEEE 802.3 PMA, the RPU, the CXL root port, and the RN-F. When the external entity, such as a GPU or a storage device, transmits a read or write request encapsulated within a carrier protocol PDU, the RPU may extract the CXL request, translate it into a CXL transaction, and deliver it via the root port to the RN-F node on the interconnect. The RN-F may issue a corresponding interconnect request (such as a ReadShared or WriteBack) to the Home Node responsible for the targeted address, which may access the memory controller and DRAM to service the request. The response data may traverse back through the interconnect to the RN-F, the root port, the RPU, and the physical layer for delivery to the external entity. This path may enable external entities to access the processor's DRAM with full cache coherency, meaning that if the targeted cacheline is present in any of the processor's caches, the coherency protocol may handle the applicable snoops and state transitions.

In some implementations of the apparatus, the HN-F enables the processing cores to access a resource coupled to the external entity via the interconnect, the CXL root port, the RPU, and the physical layer based on IEEE 802.3 PMA. The HN-F may serve as a home node proxy for an address range that maps to resources coupled to the external entity, such as HBM coupled to a GPU, storage buffers coupled to a storage device, or memory-mapped registers of a remote accelerator. When a processing core issues a coherent read or write to an address within this range, the request may be routed through the interconnect to the HN-F, which may translate the interconnect request into a CXL transaction delivered through the root port to the RPU. The RPU may encapsulate the CXL transaction within a carrier protocol PDU and transmit it via the physical layer to the external entity for servicing. The response from the external entity may traverse the reverse path back to the processing core. This outbound path may enable the processor's cores to access external resources with coherency, without requiring the cores to be aware that the resource is accessible via a carrier protocol fabric.

In some implementations of the apparatus, the CXL root port is coupled to the interconnect via a CXL/CCIX Gateway (CCG) and an I/O-coherent Request Node with Distributed Virtual Memory support (RN-D). In this configuration, the CXL root port may couple to the interconnect through a CCG for handling coherent traffic, and through an RN-D node for handling non-coherent traffic. The CCG may translate CXL.mem and CXL.cache transactions arriving through the root port into interconnect transactions for communication with agents on the interconnect. The RN-D node may handle CXL.io or PCIe traffic that does not require full cache coherency but may participate in DVM operations. This configuration may provide a different balance of functionality compared to the RN-F/HN-F configuration, potentially offering advantages for workloads that primarily utilize CXL.mem for memory access combined with CXL.io for device configuration and management.

In some implementations of the apparatus, the CCG is optimized for handling CXL.mem traffic. The CCG in this configuration may be optimized specifically for CXL.mem transactions, potentially simplifying the translation logic by focusing on memory read, memory write, and related memory operations without the overhead of supporting CXL.cache coherency operations through the root port path. The optimization may reduce the logic area, power consumption, and latency of the CXL-to-interconnect translation for CXL.mem traffic. When CXL.cache operations are not expected through the root port path (for example, when cache coherency is managed through a separate path or is not utilized), the CCG may omit or disable the CXL.cache translation logic, further simplifying the design.

In some implementations of the apparatus, the RN-D is configured to handle CXL.io or PCIe traffic communicated via the CXL root port. The RN-D may receive CXL.io or PCIe transactions from the root port and communicate them to the interconnect for routing to the appropriate agents. CXL.io traffic may include configuration reads and writes for device enumeration and management, MMIO access for device control, and other non-coherent transactions defined by the CXL.io (PCIe-based) protocol. The RN-D may support DVM operations that enable synchronization of virtual memory management across the interconnect. The separation of CXL.mem traffic (handled by the CCG) and CXL.io traffic (handled by the RN-D) through the same root port may enable the root port to support the full range of CXL sub-protocols while utilizing specialized nodes for each traffic type.

In some implementations, the apparatus further comprises Subordinate Nodes (SN-F) coupled to memory controllers, the memory controllers coupled to DRAM via DDR PHY and memory channels. The memory subsystem in the root port architecture may be similar to that in the CXL device architecture, with SN-F nodes serving as subordinate agents that interface between the interconnect protocol domain and the memory controllers. CXL traffic arriving through the root port path may ultimately be serviced by the memory controllers accessing DRAM through the DDR PHY and memory channels, after traversal through the interconnect and home node processing.

In some implementations of the apparatus, the data communicated with the external entity via the physical layer based on IEEE 802.3 PMA comprises protocol data units (PDUs) of a carrier protocol encapsulating CXL PDUs, and the RPU is configured to extract CXL PDUs from the carrier protocol PDUs. The carrier protocol PDUs may include Ethernet, UET, ESUN, SUE, or other carrier protocol frames carrying encapsulated CXL information within headers, payloads, and trailers. The RPU may parse the carrier protocol structure, extract CXL fields, translate between carrier and CXL field formats, and deliver reconstructed CXL transactions to the root port for communication with the interconnect.

In some implementations of the apparatus, the external entity comprises at least one of a GPU, an accelerator, or a switch, and the apparatus is configured to enable the external entity to access memory coupled to memory controllers of the processor via the RPU, the CXL root port, and the interconnect. External entities communicating through a carrier protocol fabric may access the processor's memory through the root port path, with the RPU and the CXL root port translating carrier protocol PDUs into interconnect transactions routed to home nodes and memory controllers. The type of external entity may influence the traffic patterns and CXL sub-protocols utilized: GPUs may generate high-bandwidth CXL.mem read and write requests for shared memory access, accelerators may combine CXL.mem access with CXL.io for device control, and switches may aggregate and route CXL traffic from downstream entities. The root port path may provide advantages for certain entity types that benefit from root complex enumeration and management capabilities.

In some implementations of the apparatus, the interconnect comprises a mesh interconnect, the mesh interconnect comprising crosspoints (XPs) configured to route interconnect transactions between the processing cores, the CXL root port, and memory controllers based on packet identifiers. The crosspoints in the root port architecture may route interconnect transactions between agents including the processing cores, the nodes through which the root port couples to the interconnect (such as RN-F, HN-F, CCG, or RN-D nodes), home agents, SN-F nodes, memory controllers, and other agents. The routing based on packet identifiers may enable the crosspoints to direct transactions along the mesh topology from source to destination without centralized routing control. The crosspoints may support virtual channels, quality-of-service levels, and flow control mechanisms defined by the interconnect protocol.

In various implementations, a method comprising: receiving, via a physical layer based on IEEE 802.3 physical medium attachment (PMA), data from an external entity; translating, by at least one of a resource provisioning unit (RPU) or a Compute Express Link (CXL) root port coupled to an interconnect of a processor, between CXL transactions and interconnect transactions; wherein the processor comprises processing cores coupled via the interconnect, the CXL transactions are associated with the data received from the external entity via the physical layer based on IEEE 802.3 PMA, and the interconnect transactions are communicated via the interconnect. The receiving of data may include receiving carrier protocol PDUs from external entities such as GPUs, accelerators, or switches. The translating may include extracting CXL information from the received data, reconstructing CXL transactions, and translating the CXL transactions into interconnect transactions for routing to agents on the interconnect through the root port and its coupled nodes.

In some implementations of the method, the CXL root port is coupled to a fully coherent request node (RN-F) and a fully coherent home node (HN-F) on the interconnect, the RN-F enabling the external entity to access memory coupled to memory controllers of the processor, and the HN-F enabling the processing cores to access a resource coupled to the external entity. The bidirectional coherent access method may enable external entities to read from or write to the processor's memory through the RN-F path, and may enable the processor's cores to read from or write to resources coupled to external entities through the HN-F path. The inbound path through the RN-F may involve the RPU extracting and translating incoming data into CXL transactions, which the root port delivers to the RN-F for issuance as interconnect requests. The outbound path through the HN-F may involve the processing cores issuing coherent requests that the HN-F translates into CXL transactions delivered through the root port and RPU for transmission to the external entity via the physical layer. Both paths may operate simultaneously, enabling full-duplex coherent communication between the processor and external entities.

In some implementations of the method, an active cable comprising first and second pluggable modules coupled by a physical medium, wherein the active cable further comprises hardware circuitry, integrated into the active cable, configured to perform the method. In some implementations of the method, an apparatus configured to operate as a switch, wherein the apparatus comprises switching circuitry and is configured to perform the method.

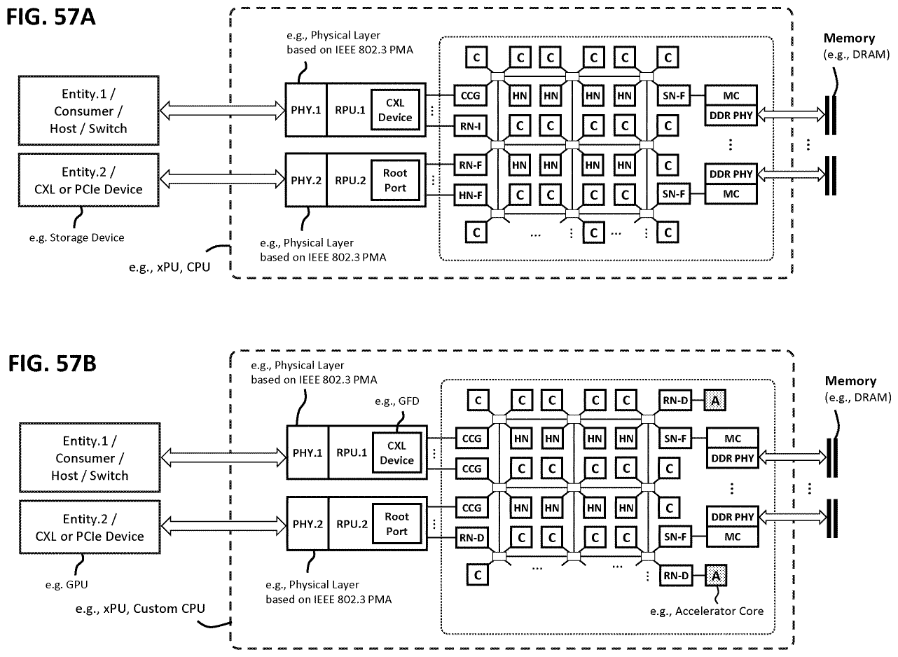

FIG. 57A illustrates an example of a system comprising a processor comprising interfaces that may utilize a physical layer based on IEEE 802.3 PMA. A first RPU includes or is coupled to a CXL device that is coupled to both a CCG node for handling coherent CXL.mem and/or CXL.cache transactions and an RN-D node for handling non-coherent CXL.io transactions, where the CXL device may be implemented in at least one of the RPU or the CCG. The system may couple the first RPU to the CCG over a CXS interface, providing a path for coherent communications. A second RPU includes or is coupled to a root port that is coupled to both a fully coherent request node (RN-F) and a fully coherent home node (HN-F) that may be included within a gateway or a bridge node structure, enabling bidirectional coherent access wherein an external entity, such as a GPU or a storage device, may read from the processor's DRAM through the RN-F node, and in the opposite direction, the processor cores may read from the GPU's HBM or from buffers in the storage device through the HN-F node.

FIG. 57B illustrates an example of a system comprising an xPU or a CPU, which may be a custom CPU design, incorporating accelerator cores and interfaces that may utilize a physical layer based on IEEE 802.3 PMA. A Global Fabric-Attached Memory Device (GFD), utilized by a first RPU, may operate as a specialized CXL device that supports only CXL.mem transactions, allowing the GFD to service external requests through CCGs that are optimized for handling CXL.mem traffic, thereby simplifying the design by eliminating the need for separate CXL.io handling paths typically managed by RN-D or RN-I nodes. The system further includes an optional second RPU that includes or is coupled to a root port, coupled to the interconnect via a CCG and an I/O-Coherent Request Node with DVM support (RN-D), wherein the RN-D may handle CXL.io or PCIe traffic.

It is noted that a line in the drawings may denote more than one port, interface, or link. For example, a single line connecting a CCG to an XP may represent two ports, such as one port for a Request Agent (RA) proxy and another port for a Home Agent (HA) proxy.

In environments where entities may utilize different protocols while requiring coordinated access to shared resources, there may be scenarios where a first entity communicating based on PCIe, such as a GPU, needs to access memory resources coupled to a second entity communicating based on CXL.mem, such as a CXL memory expander or a CXL memory pool. Translations between PCIe TLPs and CXL.mem messages may facilitate memory operations, data transfers, and resource sharing across different domains while maintaining the requirements of each protocol. Such translations may be performed by a computer, an apparatus, a cable, a Fabric Processing Unit (FPU), a Fabric NIC, or other suitable devices positioned between the first entity and the second entity. This translation may enable PCIe devices that do not natively support CXL protocols to access large-capacity CXL-attached memory resources. For example, GPUs designed with PCIe interfaces may access CXL memory pools that provide memory capacity exceeding the HBM integrated within the GPUs, thereby extending the effective memory available for AI/ML workloads, graphics rendering, or general-purpose GPU computing possibly without requiring hardware modifications to existing GPU designs. The computer may perform address translations between different physical address spaces, opcode translations between PCIe and CXL.mem, and Tag translations between PCIe Tag formats and CXL.mem Tag formats.

In various implementations, a method for translating between Peripheral Component Interconnect Express (PCIe) Transaction Layer Packets (TLPs) and Compute Express Link (CXL) messages, comprising: receiving a PCIe memory request by a computer from a first entity; translating, by the computer, the PCIe memory request to a CXL.mem Master-to-Subordinate (M2S) request; sending, by the computer to a second entity, the CXL.mem M2S request; receiving, by the computer from the second entity, a CXL.mem Subordinate-to-Master Data Response (S2M DRS) corresponding to the CXL.mem M2S request; translating, by the computer, the CXL.mem S2M DRS to a PCIe Completion; and sending the PCIe Completion by the computer to the first entity. The translation may encompass various aspects of the protocol messages, including opcodes, addresses, and transaction identifiers, thereby enabling communication between entities that utilize different protocols. The method may be implemented in hardware, firmware, software, or combinations thereof, and may be performed by various types of devices, such as semiconductor devices, switches, bridges, or active cables. The computer may maintain state information, such as pending transaction tables or tracker entries, to correlate CXL.mem S2M DRS responses with previously transmitted CXL.mem M2S requests and with pending PCIe transactions. Additionally, the elements may communicate through one or more intermediary components, such as a switch, a retimer, or other suitable entity that facilitates information transfer. The first entity may include devices such as GPUs, NICs, DMA engines, accelerators, or other PCIe endpoints, while the second entity may include CXL memory expanders, CXL memory pools, GFDs, or other CXL.mem-capable devices.

In some implementations of the method, the PCIe memory request comprises a first physical address belonging to a first physical address space utilized by the first entity, and wherein translating the PCIe memory request to the CXL.mem M2S request comprises generating the CXL.mem M2S request comprising a second physical address belonging to a second physical address space utilized by the second entity. The address translation may be implemented utilizing lookup tables, page tables, hash tables, base-and-offset calculations, and/or programmable translation functions. The first and second physical address spaces may have different sizes, different base addresses, or different memory layouts, and the translation may accommodate these differences while maintaining the meaning of the memory operations. In some examples, the first physical address space may include an address space utilized by the first entity for PCIe memory-mapped I/O (MMIO) operations, and the second physical address space may include a Host Physical Address (HPA) space utilized by a CXL host coupled to a CXL device of the second entity. The computer may maintain translation tables that map regions of the first physical address space to corresponding regions of the second physical address space, enabling the first entity to access CXL-attached memory resources using addresses within its native address space.

In some implementations of the method, the first entity comprises a GPU that does not support CXL.mem, wherein the second entity comprises a CXL memory pool, and wherein the computer exposes memory resources of the CXL memory pool to the GPU via a PCIe memory address space. The computer may expose the CXL memory pool to the GPU by configuring Base Address Registers (BARs) or other PCIe mechanisms to advertise a memory region that the GPU can access using standard PCIe memory read and write operations. The GPU may utilize this exposed memory region for various purposes, such as storing intermediate computation results, model parameters for AI/ML inference, texture data for graphics rendering, or working data sets that exceed the GPU's local HBM capacity. The computer may handle the translation transparently, such that the GPU may operate without awareness that the underlying memory is accessed utilizing CXL.mem rather than standard PCIe memory, which may enable existing GPU designs with PCIe interfaces to benefit from CXL-attached memory resources.

In some implementations of the method, the computer communicates with GPUs via interfaces, and wherein the computer translates PCIe memory requests from the GPUs to CXL.mem M2S requests targeting a shared memory resource of the CXL memory pool. The shared memory region of the CXL memory pool may be accessible by multiple GPUs, enabling data sharing, inter-GPU communication, or load balancing across the GPUs. The computer may implement arbitration logic to manage concurrent memory requests from the GPUs, and may utilize QoS mechanisms to allocate bandwidth or prioritize requests from different GPUs. The shared memory architecture may be beneficial in multi-GPU computing environments, such as AI/ML training clusters, where GPUs may need to access common datasets, model parameters, or intermediate results. The interfaces may include separate PCIe links, lanes within a shared PCIe link, or virtual channels within a PCIe fabric.

In some implementations of the method, the computer maintains memory allocation information associating portions of the CXL memory pool with certain respective GPUs of the GPUs, and wherein translating the PCIe memory request comprises selecting a portion of the CXL memory pool based on an identity of a requesting GPU. The memory allocation information may include address range tables, partition descriptors, or access control lists that define which portions of the CXL memory pool are accessible by each GPU. The computer may identify the requesting GPU based on the Requester ID in the PCIe memory request, a source port identifier, or other identification mechanisms. The partitioning may enable isolation between GPUs for security or fault containment purposes, or may enable dynamic memory allocation wherein portions of the CXL memory pool are assigned to GPUs based on workload requirements. The computer may support exclusive partitions (accessible by a single GPU) and/or shared regions (accessible by multiple GPUs) within the CXL memory pool.

In some implementations of the method, the first entity comprises at least one of a GPU, a Network Interface Card (NIC), or a Direct Memory Access (DMA) engine; wherein the second entity comprises at least one of a CXL memory expander, a CXL memory pool, or a Global Fabric-Attached Memory device (GFD); wherein the PCIe memory request comprises a PCIe Memory Read (MRd) request comprising a first Tag; wherein the CXL.mem M2S request comprises MemRd* and a second Tag; wherein the CXL.mem S2M DRS comprises MemData and data; wherein the PCIe Completion comprises a Completion with Data (CpID) comprising the data and the first Tag; and wherein the computer maintains a mapping between the first Tag and the second Tag. The computer may maintain the mapping between the first Tag and the second Tag in a tracker entry, a translation table, or another relevant data structure. Upon receiving the CXL.mem S2M DRS from the second entity, the computer may utilize the second Tag to identify the corresponding pending transaction and retrieve the first Tag for inclusion in the PCIe CpID. GPUs may utilize PCIe memory reads to access large memory pools for workloads such as graphics rendering, machine learning inference, or general-purpose GPU computing workloads. NICs may utilize PCIe memory reads to access memory buffers for network packet processing, RDMA, or storage traffic handling. DMA engines may utilize PCIe memory reads to transfer data between memory regions on behalf of other system components. The second entity may expose memory resources that are implemented using various memory technologies such as DDR5, DDR4, HBM, persistent memory, or combinations thereof.

In some implementations, the method further comprises receiving, by the computer from the first entity, a PCIe Memory Write request (MWr) comprising write data; translating the PCIe MWr to a CXL.mem M2S request with Data (M2S RwD) comprising a MemWr* and the write data; sending the CXL.mem M2S RwD to the second entity; and receiving, from the second entity, a CXL.mem S2M No Data Response (S2M NDR) comprising Cmp*. The PCIe MWr may be a posted write that does not require a completion to be returned to the first entity. However, CXL.mem may return an S2M NDR with Cmp* to acknowledge receipt of the write data by the second entity. The computer may absorb the S2M NDR without forwarding the acknowledgment to the first entity, or may utilize the S2M NDR to update internal state or flow control mechanisms. The write data may be transferred from the PCIe domain to the CXL.mem domain with optional format conversion, alignment adjustment, or byte enable manipulation as appropriate for the respective protocol specifications. The computer may buffer the write data internally and may implement mechanisms to handle scenarios where the CXL.mem M2S RwD encounters errors or back-pressure from the second entity.

In some implementations of the method, the computer is included in a switch, and wherein the PCIe memory request is selected from: a UIO Memory Read (UIOMRd) request, a UIO Memory Write request (UIOMWr), a Memory Read (MRd) request, or a Memory Write request (MWr). The selection among UIOMRd, UIOMWr, MRd, or MWr may depend on the capabilities of the first entity and the configuration of the path between the first entity and the computer.

In some implementations of the method, the PCIe memory request comprises a PCIe Unordered Input/Output (UIO) Memory Read (UIOMRd) request, and wherein the PCIe Completion comprises a PCIe UIO Read Completion with Data (UIORdCpID). The UIO transaction types may be utilized when the first entity supports UIO capabilities and when the path between the first entity and the computer has UIO enabled. The UIOMRd request type may provide ordering flexibility that enables more efficient utilization of fabric bandwidth in topologies with multiple paths between source and destination. UIO transactions may allow out-of-order completion delivery, which may reduce head-of-line blocking and improve overall system throughput in heavily loaded systems. The UIORdCpID completion may include a CDL that the computer may populate with information collected from the CXL.mem domain, from the computer itself, or from intermediate components.

In some implementations, the method further comprises receiving, by the computer from the first entity, a PCIe UIO Memory Write request (UIOMWr) comprising write data; translating the PCIe UIOMWr to a CXL.mem M2S request with Data (M2S RwD) comprising a MemWr* and the write data; sending the CXL.mem M2S RwD to the second entity; receiving, from the second entity, a CXL.mem S2M No Data Response (S2M NDR); translating the CXL.mem S2M NDR to a PCIe UIO Write Completion (UIOWrCpl); and sending the PCIe UIOWrCpl to the first entity. The UIO Memory Write request may be a non-posted transaction for which the first entity expects a UIOWrCpl, and the computer may translate the CXL.mem S2M NDR to the PCIe UIOWrCpl, thereby providing end-to-end acknowledgment that the write data has been received by the second entity. This non-posted write may be beneficial for maintaining ordering guarantees or for implementing synchronization mechanisms. The UIOWrCpl may include a CDL that the computer may populate based on the DevLoad from the CXL.mem S2M NDR or based on locally generated information.

In some implementations of the method, the CXL.mem S2M DRS comprises a DevLoad, and wherein the PCIe Completion comprises a CXL DevLoad (CDL) populated based on the DevLoad. The DevLoad in the CXL.mem S2M DRS may carry QoS telemetry information indicating the loading or congestion state of the second entity or intermediate components in the CXL.mem path. The computer may translate this telemetry information to the CDL in the PCIe UIORdCpID, thereby propagating QoS information back to the first entity. The first entity may utilize this information to make informed decisions about subsequent memory operations, such as throttling request rates, adjusting request priorities, or selecting alternative memory resources based on observed loading conditions. This end-to-end propagation of telemetry information may enable more efficient resource utilization in heterogeneous computing systems.

In some implementations, the method further comprises sending, by the computer to the second entity, a CXL.mem M2S request comprising MemSpecRd. The speculative memory read may be initiated by the computer to fetch data from the second entity in advance of, or without, the first entity explicitly requesting that data. The CXL.mem MemSpecRd opcode provides a mechanism for speculative memory access that does not have a direct equivalent in PCIe, enabling the computer to leverage CXL.mem-specific capabilities to improve performance for PCIe devices. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. Data returned in response to speculative reads may be buffered by the computer and may be utilized to satisfy subsequent requests from the first entity, potentially reducing observed read latency.

In some implementations, the method further comprises receiving, by the computer from the second entity, a CXL.mem S2M DRS comprising data responsive to the CXL.mem M2S request comprising MemSpecRd; buffering, by the computer, the data; receiving a subsequent PCIe memory request from the first entity targeting an address corresponding to the buffered data; and populating a subsequent PCIe Completion with at least some of the buffered data responsive to the subsequent PCIe memory request. The computer may maintain a prefetch buffer or cache structure to store data received in response to speculative read requests. When a subsequent PCIe memory request from the first entity targets an address for which speculative data has been buffered, the computer may service the request from the buffer without initiating a new CXL.mem transaction, thereby reducing the observed read latency. The buffered data may be invalidated or refreshed based on coherency requirements, timeout policies, or subsequent write operations to the same address. The computer may implement address matching logic to determine whether incoming PCIe memory requests can be satisfied from buffered speculative data.

In some implementations, the method further comprises detecting sequential access patterns in physical addresses of prior PCIe memory requests received from the first entity, and initiating the CXL.mem M2S request comprising MemSpecRd targeting a next sequential physical address. The computer may track physical addresses from consecutive PCIe memory requests received from the first entity to identify sequential access patterns indicative of linear memory traversal. Upon detecting that the first entity has accessed certain addresses in sequence, the computer may speculatively facilitate the readiness of the data from subsequent addresses before the first entity explicitly requests them. The sequential pattern detection may account for cacheline boundaries, page boundaries, or other memory organization units to optimize prefetch granularity.

In some implementations, the method further comprises detecting strided access patterns in physical addresses of prior PCIe memory requests received from the first entity, calculating a stride distance between accessed addresses, and initiating the CXL.mem M2S request comprising MemSpecRd targeting a physical address offset by the stride distance. The computer may identify non-sequential but regular access patterns wherein the first entity accesses memory locations separated by a consistent stride distance, such as when processing array elements or matrix columns. For example, if the computer observes accesses to addresses A, A+S, A+2S, where S represents the stride, it may speculatively prefetch from address A+3S. The stride detection algorithm may maintain a history buffer of recent addresses and compute stride patterns using difference calculations or pattern matching algorithms.

In some implementations of the method, the PCIe memory request comprises a first Tag having a first bit width selected from 5 bits, 8 bits, 10 bits, or 14 bits; wherein the CXL.mem M2S request comprises a second Tag having a 16-bit width; and wherein the computer translates between the first Tag and the second Tag. PCIe supports variable Tag widths depending on device capabilities and negotiated settings, including 5-bit Tags (default), 8-bit extended Tags, 10-bit Tags (for high-speed links), and 14-bit Tags (for flit mode and UIO). CXL.mem utilizes a fixed 16-bit Tag for transaction identification. The computer may translate between these different Tag formats by allocating CXL.mem Tags from a Tag pool, maintaining a mapping table between PCIe Tags and CXL.mem Tags, or implementing algorithmic Tag generation based on the PCIe Tag and additional context. The translation may also accommodate scenarios where the computer needs to maintain more outstanding CXL.mem transactions than the PCIe Tag space allows (for example, when issuing speculative CXL.mem reads independently of PCIe demand requests) by drawing from the larger CXL.mem Tag space for those additional transactions.

In some implementations of the method, the PCIe memory request specifies a requested data length larger than a cacheline size, wherein translating the PCIe memory request comprises generating CXL.mem M2S requests each targeting a cacheline-sized data portion, and wherein the method further comprises: receiving CXL.mem S2M DRS responses from the second entity, and aggregating data from the CXL.mem S2M DRS responses into the PCIe Completion. CXL.mem transactions are typically cacheline-sized (64 bytes), while PCIe memory requests may specify data lengths up to 4 KB using the Length field and byte enables. When a PCIe memory request specifies a data length exceeding the cacheline size, the computer may split the request into CXL.mem M2S requests, each targeting a 64-byte cacheline. The computer may track the outstanding CXL.mem requests and may aggregate the returned data into a single PCIe Completion or into multiple PCIe Completions as permitted by PCIe. The aggregation may involve buffering data from responses, ordering the data according to address sequence, and formatting the aggregated data according to PCIe Completion requirements.

In some implementations of the method, the PCIe memory request specifies a requested data length smaller than a cacheline size, wherein the CXL.mem S2M DRS comprises cacheline-sized data, and wherein the method further comprises trimming the cacheline-sized data to match the requested data length prior to populating the PCIe Completion. PCIe memory requests may specify data lengths smaller than a cacheline using byte enables, requesting as little as a single doubleword (4 bytes) or even individual bytes. CXL.mem responses return cacheline-sized data regardless of the requested length. The computer may trim the returned data to the bytes requested by the first entity, aligning the data to native boundaries such as doubleword boundaries as specified by the PCIe specifications. The trimming operation may reduce the data payload size in the PCIe Completion, potentially improving bandwidth efficiency on the path between the computer and the first entity.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus for translating between Peripheral Component Interconnect Express (PCIe) Transaction Layer Packets (TLPs) and Compute Express Link (CXL) messages, comprising: a first interface configured to communicate with a first entity based on PCIe; a second interface configured to communicate with a second entity based on CXL.mem; and a computer coupled to the first interface and the second interface, wherein the computer is configured to: receive a PCIe memory request from the first entity via the first interface; translate the PCIe memory request to a CXL.mem Master-to-Subordinate (M2S) request; send, to the second entity via the second interface, the CXL.mem M2S request; receive, from the second entity via the second interface, a CXL.mem Subordinate-to-Master Data Response (S2M DRS) corresponding to the CXL.mem M2S request; translate the CXL.mem S2M DRS to a PCIe Completion; and send the PCIe Completion to the first entity via the first interface. The apparatus may be implemented as a switch, a bridge, a semiconductor device, a chiplet within an IC package, or other suitable form factor. The first interface may include PCIe physical layer components, link layer components, and transaction layer logic configured to communicate according to PCIe specifications. The second interface may include CXL physical layer components (which may share physical layer characteristics with PCIe), link layer components, and CXL.mem transaction layer logic. The computer may include translation logic, address translation tables, Tag mapping structures, and pending transaction trackers. In some examples, the apparatus and at least one of the first entity or the second entity may be included within the same IC package, optionally coupled by UCIe links or other die-to-die interconnects.

In some implementations of the apparatus, the PCIe memory request comprises a first physical address belonging to a first physical address space, the CXL.mem M2S request comprises a second physical address belonging to a second physical address space, and wherein the computer is further configured to translate between the first physical address and the second physical address. The apparatus may include address translation logic, which may be implemented using lookup tables, content-addressable memory (CAM), translation lookaside buffers (TLBs), or programmable translation functions. The translation may enable the first entity to access CXL-attached memory using addresses within its native address space while the second entity operates within its own address space. The address translation may be configured by system software, firmware, or hardware during system initialization or dynamically during operation.

In some implementations of the apparatus, the first entity comprises a GPU that does not support CXL.mem, the second entity comprises a CXL memory pool, and wherein the computer is configured to expose memory resources of the CXL memory pool to the GPU as a PCIe memory-mapped region. The apparatus may function as a bridge enabling GPUs designed with PCIe interfaces to access CXL-attached memory resources. The apparatus may expose the CXL memory pool as one or more PCIe BARs that the GPU can access using PCIe memory transactions, which may enable GPU-based AI/ML workloads to utilize memory capacities exceeding the HBM integrated within the GPU.

In some implementations of the apparatus, the computer is further configured to send, to the second entity via the second interface, a CXL.mem M2S request comprising MemSpecRd. The apparatus may include logic configured to initiate speculative memory reads to the second entity based on observed access patterns from the first entity. The speculative reads may utilize the CXL.mem MemSpecRd, which provides speculative access not available in PCIe. Data returned in response to speculative reads may be stored in a buffer within the apparatus for rapid delivery when subsequently requested by the first entity.

In some implementations of the apparatus, the apparatus is located in an active cable. The active cable may include the first interface at one end configured to connect to a PCIe device such as a GPU, and the second interface at the other end configured to connect to a CXL device such as a memory expander or memory pool. The computer may be implemented within the cable housing utilizing embedded logic. The active cable form factor may enable translation to be added to existing systems by replacing passive cables with active translation cables, possibly without requiring modifications to the connected devices.

In various implementations, a system comprising: Graphics Processing Units (GPUs), wherein at least one GPU of the GPUs does not support Compute Express Link (CXL) communications; a CXL device coupled to memory having a capacity greater than a capacity of high-bandwidth memory (HBM) of any one of the GPUs; and a computer coupled between the GPUs and the CXL device, the computer comprising: a first interface configured to communicate with the GPUs based on PCIe; and a second interface configured to communicate with the CXL device based on CXL.mem; wherein the computer is configured to: receive, from a GPU of the GPUs via the first interface, a PCIe memory request; translate the PCIe memory request to a CXL.mem Master-to-Subordinate (M2S) request; send, to the CXL device via the second interface, the CXL.mem M2S request; receive, from the CXL device via the second interface, a CXL.mem Subordinate-to-Master Data Response (S2M DRS); translate the CXL.mem S2M DRS to a PCIe Completion; and send the PCIe Completion to the GPU via the first interface. The system may enable GPUs that do not natively support CXL to access memory resources that exceed their local HBM capacity, such as for storing model parameters, intermediate computation results, KV-cache entries, or working data sets for AI/ML inference and training workloads. The CXL device may include a CXL memory expander, a CXL memory pool, a Global Fabric-Attached Memory device (GFD), or a CXL Type 2 device with device-attached memory. The memory coupled to the CXL device may be implemented using DDR5, DDR4, LPDDR, persistent memory, or combinations thereof, and may provide memory capacity and bandwidth characteristics that complement the high-bandwidth but limited-capacity HBM integrated within the GPUs. The computer may be implemented as a semiconductor device, an ASIC, a chiplet, a switch, an active cable, or other suitable form factor positioned between the PCIe domain of the GPUs and the CXL.mem domain of the CXL device. The computer may maintain per-GPU tracking structures, address translation tables, and Tag mapping resources to support concurrent translations from GPUs. In some examples, the computer and the CXL device may be included within a same IC package, optionally coupled by UCIe links or other die-to-die interconnects.

In some implementations of the system, the memory is accessible by the GPUs as a shared memory region, and wherein the computer is configured to translate PCIe memory requests from the GPUs to CXL.mem M2S requests targeting the shared memory region. The shared memory region may enable GPUs to access common data, such as model parameters, training datasets, or intermediate computation results, without requiring explicit data copying between GPUs. The computer may implement arbitration and flow control mechanisms to manage concurrent access from GPUs. The shared memory architecture may reduce total memory requirements and inter-GPU communication latency in multi-GPU systems.

In some implementations of the system, the computer maintains memory allocation information associating portions of the memory with respective GPUs, and wherein translating the PCIe memory request comprises selecting a target address within the memory based on an identity of a requesting GPU of the GPUs. The memory allocation information may enable partitioned access wherein each GPU is assigned a dedicated portion of the memory for private use. The computer may identify the requesting GPU based on the Requester ID in the PCIe memory request or other identification mechanisms, and may direct the CXL.mem M2S request to the appropriate memory partition. The partitioning may provide isolation between GPU workloads for security, fault containment, or resource management purposes.

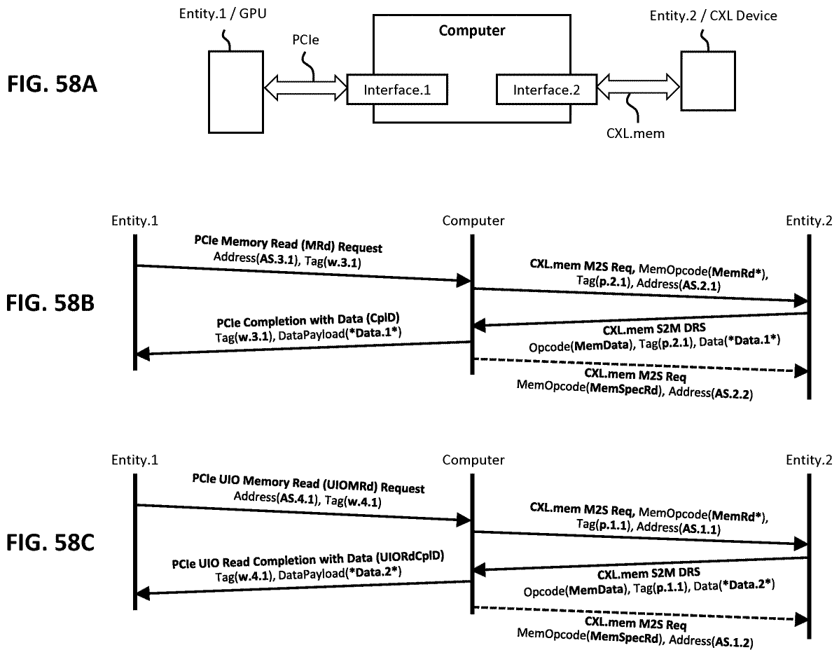

FIG. 58A illustrates an example of a system comprising a switch (e.g., a CXL switch), a processor, or a bridge, which comprises a computer coupled between a first interface (Interface.1) and a second interface (Interface.2). The first interface may communicate according to PCIe with a first entity (Entity.1), such as a GPU. The second interface may communicate according to a CXL protocol, such as CXL.mem, with a second entity (Entity.2), such as a CXL device, which may be a CXL memory expander, a CXL memory pool, or a GFD. The computer may extract physical addresses from messages received via the first interface, wherein these addresses may refer to a first Physical Address (PA) space utilized by the first entity; translate these addresses; and generate messages carrying the translated physical addresses for transmission via the second interface; wherein these translated addresses may refer to a second PA space utilized by the second entity. In some examples, the first PA space and the second PA space may be the same PA space, wherein the computer may perform address translations between addresses within the same PA space. The computer may perform further translations between the PCIe domain and the CXL domain, such as translating between PCIe TLP types (e.g., MRd, UIOMRd) and CXL.mem opcodes (e.g., MemRd, MemRdData, MemRdTEE). The computer may be implemented as a monolithic die, as one or more chiplets within an IC package, or as one or more components on a board. In some examples, the computer and at least one of the first entity or the second entity may be included within the same IC package, optionally coupled by one or more UCIe links.

FIG. 58B illustrates an example of a TFD demonstrating translations, performed by a computer, between PCIe TLPs received from a first entity (Entity.1), which may be a GPU, and CXL.mem messages sent to a second entity (Entity.2), which may be a CXL device, possibly enabling the first entity to access resources mapped to an address space utilized by the second entity. The first entity may initiate a PCIe transaction that includes a PCIe Memory Read (MRd) request comprising Address(AS.3.1) and Tag(w.3.1). The computer may translate the PCIe transaction to a CXL.mem transaction that includes a CXL.mem M2S request comprising MemOpcode(MemRd*), Tag(p.2.1), and Address(AS.2.1), and may send the CXL.mem M2S request to the second entity. Upon receiving one or more responses from the second entity, which may include a CXL.mem S2M DRS comprising Opcode(MemData), Tag(p.2.1), and Data(*Data.1*), the computer may translate the one or more responses such as translating the CXL.mem S2M DRS to a PCIe Completion with Data (CpID) comprising Tag(w.3.1) and DataPayload(*Data.1*), and may send the CpID to the first entity. The computer may perform further translations, such as protocol translations, opcode translations, command translations, or TLP translations, e.g., translating between PCIe TLPs and CXL.mem messages, wherein these translations may include field translations, such as translating between PCIe Tags and CXL.mem Tags, translating between reserved fields, and translating between reserved and non-reserved fields. The computer may further initiate speculative memory reads targeting the second entity, wherein the speculative memory reads may include a CXL.mem M2S Req comprising MemOpcode(MemSpecRd) and Address(AS.2.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved.

FIG. 58C illustrates an example of a TFD demonstrating translations between PCIe UIO TLPs received from a first entity (Entity.1), which may be a GPU, and CXL.mem messages sent to a second entity (Entity.2) which may be a CXL device, possibly enabling the first entity to access resources mapped to an address space utilized by the second entity (Entity.2). The first entity may initiate a PCIe UIO transaction that may include a PCIe UIO Memory Read (UIOMRd) request comprising Address(AS.4.1) and Tag(w.4.1). The computer may translate the PCIe UIO transaction to a CXL.mem transaction that may include a CXL.mem M2S request comprising MemOpcode(MemRd*), Tag(p.1.1), and Address(AS.1.1), and may send the CXL.mem M2S request to the second entity. Upon receiving one or more responses from the second entity, which may include a CXL.mem S2M DRS comprising Opcode(MemData), Tag(p.1.1), and Data(*Data.2*), the computer may translate the one or more responses, such as translating the CXL.mem S2M DRS to a PCIe UIO Read Completion with Data (UIORdCpID) comprising Tag(w.4.1) and DataPayload(*Data.2*); and may send the UIORdCpID to the first entity. The computer may perform further translations, such as protocol translations, opcode translations, command translations, or TLP translations, e.g., translating between PCIe UIO TLPs and CXL.mem messages, wherein these translations may include field translations. The computer may further initiate speculative memory reads targeting the second entity, wherein the speculative memory reads may include a CXL.mem M2S Req comprising MemOpcode(MemSpecRd) and Address(AS.1.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved.

In various implementations, an apparatus comprising: an integrated circuit comprising processing cores comprising memory management units (MMUs) and coherent caches; wherein the processing cores are configured to respond to snoop requests that utilize physical addresses within a physical address space (PAS), and wherein the MMUs are configured to translate virtual addresses to physical addresses within the PAS; a coherent interconnect coupling the processing cores to memory controllers coupled to memory channels capable of supporting memory having a capacity of at least 64 GB, and wherein the processing cores are configured to execute an operating system (OS) that accesses the memory utilizing the physical addresses within the PAS; a resource provisioning unit (RPU) comprising an NVLink-based interface configured to communicate, according to an NVLink-based protocol, with an entity coupled to the apparatus; and wherein the RPU is further coupled to the coherent interconnect and configured to translate physical addresses associated with the NVLink-based protocol to physical addresses within the PAS; whereby the translate of the physical addresses enables the entity to access the memory via the NVLink-based interface and the memory controllers.

In some implementations of the apparatus, the NVLink-based interface comprises at least one differential pair and is configured to support reliable communication by utilizing at least one of: a replay buffer configured to enable retransmissions of packets that were not positively acknowledged by a receiver, or a Forward Error Correction (FEC) code configured to enable correction of symbol errors.

In some implementations of the apparatus, The apparatus of claim 1, wherein, in addition to the physical address translations, the RPU is further configured to translate between first fields conforming to the NVLink-based protocol message formats, and second fields conforming to message formats of a protocol utilized by the coherent interconnect.

In some implementations of the apparatus, the protocol utilized by the coherent interconnect is based on Coherent Hub Interface (CHI-based protocol), and the RPU is further configured to translate read requests corresponding to the NVLink-based protocol to requests corresponding to the CHI-based protocol carrying ReadOnce or ReadShared. The RPU may further translate CHI responses to NVLink responses, such as CHI responses carrying CompData to NVLink responses. Additionally, the RPU may maintain transaction context to properly correlate requests and responses across the protocol domains. The translation to CHI ReadOnce may be utilized for non-cacheable data accesses, while ReadShared may be utilized for cacheable shared data. The RPU may handle protocol-specific differences inflow control, credit management, and response ordering between the NVLink and CHI domains. The CompData responses from CHI may carry the requested data along with completion status, which the RPU translates into appropriate NVLink response formats.

In some implementations of the apparatus, the protocol utilized by the coherent interconnect is based on an Intel Coherent Processor Interconnect Protocol (ICPIP-based protocol) for scalable multiprocessors with a shared physical address space, and wherein the RPU is further configured to translate memory access requests corresponding to the NVLink-based protocol to requests corresponding to the ICPIP-based protocol, while maintaining coherency state tracking for physical addresses within the PAS that are associated with the coherent caches. Examples of ICPIP include Intel's Ultra Path Interconnect (UPI) and future Intel's Coherent Processor Interconnect Protocols. Optionally, the coherency state tracking between NVLink and ICPIP domains may include monitoring cacheline states and ensuring consistency across protocol boundaries. The RPU may include state machines to track outstanding transactions and their coherency implications. The translation may accommodate differences in data transfer granularity and response timing between NVLink and ICPIP protocols.

In some implementations of the apparatus, the protocol utilized by the coherent interconnect is based on Infinity Fabric (IF-based), and wherein the RPU is further configured to translate NVLink-based traffic to IF-based traffic, while preserving memory ordering required by the entity. The preservation of memory ordering may include tracking command dependencies and enforcing completion ordering as required by both NVLink and Infinity Fabric specifications. The RPU may include ordering enforcement logic that respect producer-consumer relationships and memory barrier semantics across the protocol boundary. The RPU may translate NVLink commands that include partial write indicators to appropriate Infinity Fabric write command types while maintaining data integrity.

In some implementations of the apparatus, the RPU is further configured to translate commands or encodings associated with the NVLink-based protocol to commands or opcodes associated with a protocol utilized by the coherent interconnect, based on a mapping between request types of the NVLink-based protocol and corresponding request types of the protocol utilized by the coherent interconnect. The mapping may be implemented utilizing lookup tables, state machines, or programmable translation logic. The RPU may handle various NVLink categories including memory reads, memory writes, and atomic operations, translating them to appropriate coherent interconnect opcodes while preserving transaction semantics.

In some implementations of the apparatus, the RPU is further configured to translate a request corresponding to the NVLink-based protocol to at least one message corresponding to the protocol utilized by the coherent interconnect; wherein the at least one message causes prefetch to a cache of a processor comprising the processing cores. The RPU may translate NVLink requests, such as requests carrying explicit or implicit prefetch hints, to messages of a protocol utilized by the coherent interconnect that effectively prefetch data into a cache of the processor, enabling reduced memory access latency for anticipated future accesses. An example of a prefetch hint may include a case wherein the RPU detects a pattern of reading pairs of addresses that are adjacent to each other or separated by a distinguishable stride.

In some implementations of the apparatus, the RPU is further configured to utilize an intermediate protocol selected from Peripheral Component Interconnect Express (PCIe) or Compute Express Link (CXL) when translating between the NVLink-based protocol and a protocol utilized by the coherent interconnect. The use of an intermediate protocol may facilitate translation by leveraging existing protocol conversion logic. When utilizing PCIe as an intermediate protocol, the RPU may translate NVLink traffic to PCIe Transaction Layer Packets (TLPs) and subsequently to coherent interconnect transactions. When utilizing CXL as an intermediate protocol, the RPU may leverage CXL.cache or CXL.mem as appropriate for the transaction type. The intermediate protocol stage may enable reuse of existing protocol bridges and translation logic.

In some implementations of the apparatus, the RPU is further configured to maintain mappings between transaction identifiers utilized by the NVLink-based protocol and transaction identifiers utilized by the coherent interconnect, enabling correlation of requests and responses across domains. The transaction identifier mappings may accommodate different identifier formats, sizes, and allocation schemes between NVLink and the coherent interconnect. Transaction identifiers may be used to identify a transaction, such as when supporting outstanding requests in-flight through the RPU, or may be used to convey properties associated with messages or transactions, such as trace identifiers used for debugging and performance measurements, or authorization identifiers used for security. The RPU may include identifier pools and allocation mechanisms to prevent identifier exhaustion and may support identifier recycling upon transaction completion. The mapping structures may be optimized for fast lookup during high-frequency transaction processing and may utilize on-silicon SRAM, content-addressable memory (CAM) or Ternary Content-Addressable Memory (TCAM) structures.

In some implementations of the apparatus, the RPU is further configured to: maintain a transaction tracking structure to monitor outstanding transactions from the entity, allocate coherent interconnect transaction identifiers for transactions initiated by the RPU, and release identifiers upon transaction completion. The transaction tracking structure may be implemented using content-addressable memories, linked lists, or circular buffers optimized for the expected transaction rates. The RPU may include timeout logic to handle lost or excessively delayed transactions and may support error recovery procedures. The tracking structure may maintain additional transaction attributes such as timestamps, retry counts, or quality-of-service parameters.

In some implementations of the apparatus, the RPU is further configured to enable bidirectional access by translating requests between messages conforming to the NVLink-based protocol and messages conforming to the protocol utilized by the coherent interconnect; whereby the entity accesses the memory according to the NVLink-based protocol, and the processing cores access resources attached to the entity via the coherent interconnect. The bidirectional access capability may enable memory pooling and memory sharing architectures wherein system memory and entity-attached memory form a memory space accessible from both domains via translations. The RPU may maintain separate translation contexts for each direction and may apply different translation policies based on the initiator and target of each transaction. The bidirectional capability may support various computing paradigms including GPU-direct operations and peer-to-peer transfers. When processing cores access entity-attached resources, such as High-Bandwidth Memory (HBM) resources, the RPU may handle different memory attributes between the two domains.

In some implementations of the apparatus, the entity comprises at least one of: high-bandwidth memory (HBM), High-Bandwidth Flash (HBF), Low-Power Double Data Rate (LPDDR) memory, or Graphics Double Data Rate (GDDR) memory; and wherein the RPU is further configured to map a portion of the entity memory into the PAS, enabling the processing cores to access the entity memory based on memory-mapped operations. The mapping of entity memory such as HBM, HBF, LPDDR, or GDDR memory into PAS may include establishing memory windows with specific attributes optimized for the memory type. The RPU may handle differences in memory access granularity, bandwidth characteristics, and latency profiles between system memory and entity memory. The memory-mapped operations may be subject to caching policies and coherency protocols appropriate for cross-domain memory access.

In some implementations of the apparatus, the RPU is further configured to provide access control by validating the physical addresses associated with the NVLink-based protocol against permitted address ranges for the entity, and blocking NVLink-based traffic targeting prohibited address ranges. The permitted address ranges may be configured utilizing secure configuration registers or loaded from trusted firmware during system initialization. The RPU may support different access control contexts for different operational modes or security domains. The blocking of prohibited traffic may generate error responses conforming to NVLink error reporting logic and may trigger security event logging.

In some implementations of the apparatus, the RPU is further configured to evaluate transaction attributes associated with the NVLink-based protocol, including source identifiers and access types, and to apply security policies to allow or deny traffic based on preconfigured security rules. The security policies may consider combinations of transaction attributes including source device identification, vendor-defined commands or fields, transaction type, address range, and temporal factors. The RPU may provide role-based access control wherein different entities have different access privileges. The security rules may be updateable utilizing authenticated channels and may support both static and dynamic security policy enforcement.

In some implementations of the apparatus, the RPU is further configured to detect access patterns in NVLink-based traffic from the entity, and generates prefetch requests based on predicted future accesses; and wherein the prefetch requests are routed via the coherent interconnect and the memory controllers. The access pattern detection may utilize algorithms such as stride detection, stream buffers, or correlation-based prediction algorithms. The RPU may maintain pattern history tables to track access behaviors and may adapt prefetching aggressiveness based on prefetch accuracy metrics. The prefetch requests may be tagged with lower priority to avoid interfering with demand requests and may be cancelled if subsequent access patterns diverge from predictions.

In some implementations of the apparatus, the RPU is further configured to coalesce coherent interconnect transactions targeting contiguous or nearby addresses into fewer NVLink-based transactions; whereby the coalescing improves memory bandwidth utilization. The request coalescing may consider factors including address proximity, request types, and timing windows when determining which transactions to combine. The RPU may include write combining buffers for write transactions and may support read coalescing for sequential read patterns. In one example, coherent interconnects may use up to 64-byte transfers, that may reflect a nominal cacheline size utilized by the coherent interconnect, whereas NVLink may use larger transfers up to 256 bytes, making coalescing beneficial for bandwidth efficiency.

In some implementations of the apparatus, the NVLink-based interface is configured to support virtual channels, and the RPU is further configured to map the virtual channels to quality-of-service (QoS) attributes in a protocol utilized by the coherent interconnect. The virtual channel to QoS mapping may enable differentiated service levels for different traffic classes, such as bulk data transfers versus latency-sensitive communications. The RPU may include programmable mapping tables to allow flexible QoS policy configuration. The mapping may consider both NVLink virtual channel priorities and coherent interconnect QoS mechanisms to maintain end-to-end service level objectives.

In some implementations of the apparatus, the memory comprises dynamic random-access memory (DRAM), and the entity comprises a graphics processing unit (GPU) or an accelerator coupled to the apparatus via the NVLink-based interface; and wherein the RPU enables the entity to access the DRAM with cache-line granularity. An entity, such as a GPU or an accelerator, may utilize the NVLink interface for memory access to memory resources attached to the processor. Optionally, when the entity is coupled through an NVLink switch, the RPU may handle switch-specific routing information and may support entities sharing the NVLink interface through switch-based connectivity. The GPU or accelerator entity may utilize the NVLink interface for high-bandwidth memory access patterns characteristic of parallel computing workloads. The RPU may optimize translations for the specific access patterns and bandwidth requirements of GPU or accelerator workloads.

In various implementations, a method for enabling an entity to access memory via an NVLink-based interface, comprising: operating a processor comprising processing cores, memory management units (MMIUs), and coherent caches; wherein the processing cores respond to snoop requests that utilize physical addresses within a physical address space (PAS), and the MMUs translate virtual addresses to physical addresses within the PAS; communicating, via a coherent interconnect, between the processing cores and memory controllers that communicate with memory channels coupled to memory having a capacity of at least 64 GB; executing, by the processing cores, an operating system (OS) that accesses the memory utilizing the physical addresses within the PAS; communicating according to an NVLink-based protocol with the entity via an NVLink-based interface; and translating physical addresses associated with the NVLink-based protocol to physical addresses within the PAS.

In some implementations, the method further comprises translating from non-address fields conforming to the NVLink-based protocol message formats to corresponding fields conforming to message formats of a protocol utilized by the coherent interconnect; and wherein the translating of the physical addresses is performed by a resource provisioning unit (RPU) coupled between the NVLink-based interface and the coherent interconnect.

In some implementations of the method, the protocol utilized by the coherent interconnect is based on Coherent Hub Interface (CHI-based protocol); and wherein the translating between non-address fields comprises translating NVLink-based protocol read commands to CHI-based protocol opcodes or commands comprising ReadOnce or ReadShared. The method may further include translating CHI response opcodes to NVLink response opcodes, such as translating CHI responses carrying CompData to NVLink responses.

In some implementations of the method, the protocol utilized by the coherent interconnect is based on an Intel Coherent Processor Interconnect Protocol (ICPIP-based protocol) for scalable multiprocessors with a shared physical address space; and wherein the translating between non-address fields comprises translating NVLink-based protocol memory access commands to ICPIP-based protocol requests while maintaining coherency state tracking between domain of the NVLink-based protocol and domain of the ICPIP-based protocol.

In some implementations of the method, the protocol utilized by the coherent interconnect is based on Infinity Fabric (IF-based); and wherein the translating between non-address fields comprises translating NVLink-based commands to IF-based commands while preserving memory ordering required by the entity.

In some implementations, the method further comprises translating NVLink-based commands to commands associated with a protocol utilized by the coherent interconnect, based on a mapping between NVLink-based transaction types and corresponding transaction types of the protocol utilized by the coherent interconnect. It is noted that in the context of such implementations, NVLink-based commands and NVLink-based encodings may be used interchangeably.

In some implementations of the method, the translating of the physical addresses comprises utilizing an intermediate protocol selected from Peripheral Component Interconnect Express (PCIe) or Compute Express Link (CXL) as an intermediate stage between the NVLink-based protocol and a protocol utilized by the coherent interconnect.

In some implementations, the method further comprises translating transaction identifiers utilized by the NVLink-based protocol to transaction identifiers utilized by the coherent interconnect, maintaining a transaction tracking structure to monitor outstanding transactions from the entity, allocating coherent interconnect transaction identifiers for RPU-initiated transactions, and releasing identifiers upon transaction completion.

In some implementations, the method further comprises validating the physical addresses associated with the NVLink-based protocol against permitted address ranges for the entity, and blocking NVLink-based traffic targeting prohibited address ranges; and further comprising evaluating NVLink-based traffic attributes including source identifiers and access types, and applying security policies to allow or deny traffic based on preconfigured security rules.

In some implementations, the method further comprises detecting access patterns in NVLink-based traffic from the entity, and generating prefetch requests based on predicted future accesses, wherein the prefetch requests are routed via the coherent interconnect and the memory controllers.

In various implementations, a system comprising: a host processor; a memory having a capacity of at least 64 GB; a coherent interconnect architecture coupling processing elements to the memory, wherein the processing elements utilize a local physical address space to access the memory; and a resource provisioning unit (RPU) configured to translate physical addresses associated with an NVLink-based protocol, utilized by an entity coupled to the RPU via an NVLink-based interface, to physical addresses within the local physical address space; whereby the translate of the physical addresses enables the entity to utilize the memory as disaggregated memory accessed via the NVLink-based interface and the memory controllers.

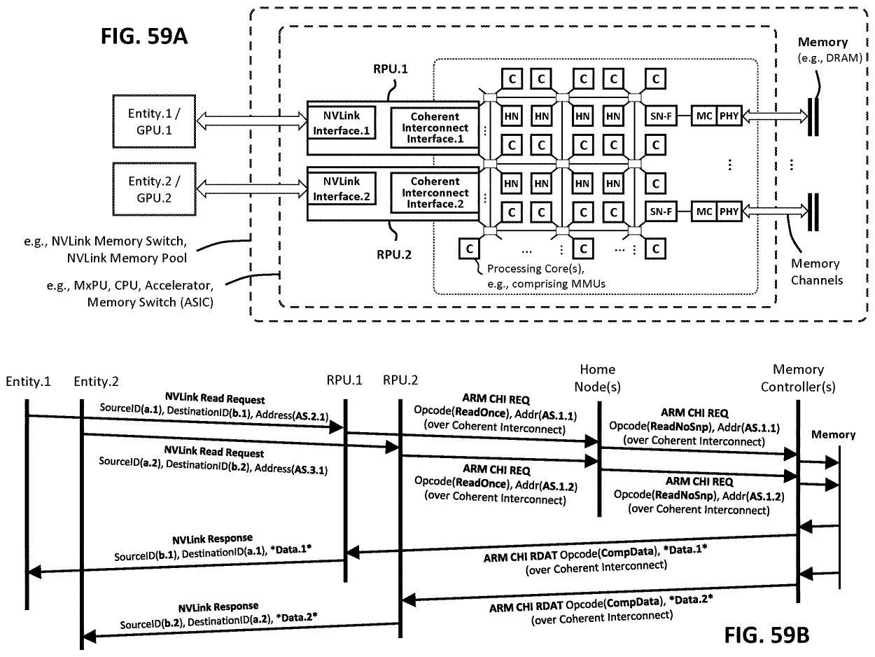

FIG. 59A illustrates an example of a system that may function as an NVLink memory switch appliance or an NVLink memory pool, and may include an MxPU, CPU, accelerator, or a memory switch ASIC, that is coupled to two entities denoted as Entity.1/GPU.1 and Entity.2/GPU.2. The MxPU includes processing cores and memory controllers coupled to a coherent interconnect that may be based on CHI. The MxPU utilizes translations, performed by the RPUs, between NVLink-based interfaces and an MxPU's coherent interconnect. The first RPU (RPU.1) may enable Entity.1/GPU.1 to access resources mapped to a physical address space utilized by the MxPU's coherent interconnect, wherein the access is via the first NVLink interface and the MxPU's coherent interconnect. Examples of resources mapped to the physical address space utilized by the MxPU's coherent interconnect include DRAM or other memory resources of the MxPU. Correspondingly, the second RPU (RPU.2) may enable Entity.2/GPU.2 to access, via the second NVLink interface and the MxPU's coherent interconnect, resources mapped to a physical address space utilized by the MxPU's coherent interconnect, such as memory resources of the MxPU.

FIG. 59B illustrates an example of a TFD depicting a multi-entity memory access scenario wherein first and second entities/GPUs access memory mapped to one or more physical address spaces utilized by the coherent interconnect (CohInterMappedMemory), through NVLink to ARM CHI translations. Entity.1/GPU.1 initiates a first NVLink request: Read with SourceID(a.1) to identify the source GPU, DestinationID(b.1) to identify the destination GPU, and Address(AS.2.1) representing an NVLink network address from a second physical address space. RPU.1 translates the first NVLink request to ARM CHI REQ carrying Opcode(ReadOnce), and Addr(AS.1.1) from a first physical address space utilized by the coherent interconnect. Concurrently or sequentially, Entity.2/GPU.2 may initiate a second NVLink request: Read with SourceID(a.2), DestinationID(b.2), and Address(AS.3.1) representing an NVLink network address optionally from a third physical address space or from the second physical address space. RPU.2 translates the second NVLink request to ARM CHI REQ carrying Opcode(ReadOnce) and Addr(AS.1.2) from the first physical address space utilized by the coherent interconnect.

Both transactions flow through the coherent interconnect to one or more home nodes, which may send respective ARM CHI REQ messages to one or more memory controllers with Opcode(ReadNoSnp) and the addresses Addr(AS.1.1) and Addr(AS.1.2), respectively. The memory controller(s) retrieve the requested data from the CohInterMappedMemory and send first and second ARM CHI RDAT messages with Opcode(CompData) carrying *Data.1* and *Data.2*, representing the data retrieved from the addresses AS.1.1 and AS.1.2, respectively. RPU.1 translates the first ARM CHI RDAT message to NVLink response with SourceID(b.1), DestinationID(a.1), and *Data.1* for Entity.1/GPU.1. RPU.2 translates the second ARM CHI RDAT message to NVLink response with SourceID(b.2), DestinationID(a.2), and *Data.2* for Entity.2/GPU.2. The illustrated example demonstrates how entities/GPUs may share access to the same CohInterMappedMemory through different RPUs that translate between NVLink and ARM CHI, including physical address translations. Alternatively, the illustrated example may be viewed as two separate NVLink transactions that utilize the same coherent interconnect infrastructure to access CohInterMappedMemory, wherein the GPU entities may access the CohInterMappedMemory via a shared or separate address spaces that are translated to the shared coherent interconnect physical address space. Still alternatively, the response and read data paths may be implemented according to other designs, such as wherein the memory controller(s) may send the data to the home node(s) that send it to the respective RPUs, or the home node(s) send responses to the RPUs while the memory controller(s) send the data to the RPUs.

Depending on system characteristics, such as implementation choices and platform configurations, different physical addresses, such as (AS.1.1) and (AS.1.2), within a physical address space utilized by the coherent interconnect, may be typically partitioned, such as via hashing or interleaving schemes, across a set of home nodes. Such partitioning is typically performed in order to reduce bottleneck effects in the system and spread the load of transaction processing across home nodes of the coherent interconnect, and may result in mapping the different physical addresses, such as (AS.1.1) and (AS.1.2), to the same home node, or to different home nodes. Similarly, different physical addresses may be associated with one memory controller, or with different memory controllers, such as according to a separate mapping scheme, which may be different from the mapping scheme utilized for selecting a home node for processing the request. Alternatively, other implementations may co-locate the home node function with a specific memory controller, utilizing a unified mapping scheme that selects both a home node and a memory controller.

In various implementations, an apparatus comprising: a coherent interconnect that utilizes a protocol based on Coherent Hub Interface (CHI-based protocol), comprising an interconnect component configured to receive CHI-based messages; processing cores coupled via the coherent interconnect to memory controllers coupled to memory channels capable of supporting memory having a capacity of at least 64 GB; a resource provisioning unit (RPU) comprising an NVLink interface and a CHI interface; wherein the NVLink interface utilizes differential pairs and is capable of communicating according to an NVLink-based protocol with an entity external to the apparatus; wherein the CHI interface is coupled to the interconnect component; and wherein the RPU is configured to translate between messages conforming to the NVLink-based protocol and messages conforming to the CHI-based protocol to enable the entity to access resources via the NVLink interface and the coherent interconnect.

In some implementations of the apparatus, the RPU is further configured to: translate first physical addresses associated with the NVLink-based protocol to second physical addresses associated with the CHI-based protocol, and translate NVLink command encodings to corresponding CHI opcodes. The RPU may perform address translation from the NVLink domain to the CHI domain. The address translation may support different memory mapping schemes between the NVLink and CHI domains, while the command translation may preserve the intent of the transaction. For example, when translating an NVLink read request transaction, received from a GPU, to a CHI request transaction, targeting an xPU coherent interconnect, wherein the CHI transaction carries ReadOnce for obtaining a non-cacheable snapshot of the data, satisfying the intent of the I/O-coherent NVLink read request. The RPU may preserve the ordering requirements of the original NVLink traffic within the CHI-based protocol framework.

In some implementations of the apparatus, the resources are selected from at least one of: registers within the apparatus, SRAM, HBF, or HBM within the apparatus, at least some of the 64 GB of memory, network devices coupled to the apparatus, or storage devices coupled to the apparatus.

In some implementations of the apparatus, the RPU further comprises a request node which does not include a hardware-coherent cache, and wherein the request node is configured to communicate with the interconnect component according to the CHI-based protocol.

In some implementations of the apparatus, the request node is coupled to the interconnect component and is further configured to expose registers accessible utilizing memory-mapped I/O (MMIO) operations, to enable the entity to detect at least one of: node type, node configuration, or connection topology based on register inspection.

In some implementations of the apparatus, the request node is configured to expose the registers via Advanced Microcontroller Bus Architecture (AMBA) Advanced Peripheral Bus (APB) interface, to enable the entity to read the registers via the NVLink interface.

In some implementations of the apparatus, the request node comprises an I/O-Coherent Request Node (RN-I) or an I/O-Coherent Request Node with Distributed Virtual Memory (DVM) support (RN-D); and the RPU is configured to translate NVLink read requests to CHI read requests. The integration with ARM mesh architecture may allow the NVLink-coupled entity to participate in the broader system interconnect fabric, with interconnect components, such as crosspoints, providing routing decisions based on transaction addresses and types. The MMIO-accessible registers enable system firmware or diagnostic software to discover the structure of the coherent interconnect, the presence of request nodes and home nodes included in the RPU, verify correct node connections, detect NVLink translation capabilities in the RPU via additional register inspections, and configure operational parameters for the translation path.

In some implementations of the apparatus, the RPU further comprises a home node which does not include a Point of Coherence (PoC) and is not capable of processing snoopable requests, and wherein the home node is configured to communicate with the interconnect component according to the CHI-based protocol.

In some implementations of the apparatus, the home node comprises a I/O-coherent Home Node (HN-I), enabling the processing cores to access resources via the NVLink interface.

In some implementations of the apparatus, the RPU further comprises a request node and a home node, the request node couples the NVLink interface to the interconnect component, and the home node couples the NVLink interface to a second interconnect component. The RPU may implement routing decisions based on transaction types, directing memory access transactions from the NVLink domain through a request node, such as an RN-I node, while receiving, from a home node, such as an HN-I node, transactions targeting the NVLink domain. The apparatus may enable entities communicating according to NVLink-based protocol to perform I/O-coherent accesses to resources within a CHI-based system through appropriate non-coherent or I/O-coherent nodes. A request node, such as an RN-D node, may receive DVM transactions and generate a subset of CHI transactions without maintaining a hardware-coherent cache. The home node, such as an HN-I node, may process a limited subset of request types and manage ordering between I/O requests targeting the I/O subsystem without maintaining coherency utilizing snooping. The RPU may perform protocol-specific translations including command mapping, address formatting, address translations, orchestration and tracking of transaction IDs, and transaction sequencing between the NVLink and CHI domains.

In some implementations of the apparatus, the RPU further comprises an interconnect gateway configured to communicate with the interconnect component according to the CHI-based protocol, wherein the RPU is further configured to utilize a streaming interface protocol to enable connectivity between the NVLink interface and the coherent interconnect via the interconnect gateway.

In some implementations of the apparatus, the streaming interface protocol transports packets of an intermediate protocol; and wherein the RPU is further configured to translate between messages conforming to the intermediate protocol and messages conforming to the CHI-based protocol.

In some implementations of the apparatus, the intermedia protocol conforms to PCIe, and the RPU is further configured to translate a PCIe UIO memory read request utilizing a UIOMRd TLP type to a CHI REQ comprising ReadOnce.

In some implementations of the apparatus, the streaming interface protocol is based on Advanced Microcontroller Bus Architecture (AMBA) Credited eXtensible Stream (CXS); and wherein the interconnect gateway provides credit-based flow-control and supports bi-directional connectivity between the NVLink interface and the coherent interconnect.

In some implementations of the apparatus, the interconnect gateway comprises CXL/CCIX Gateway (CCG) comprising a link agent that supports the streaming interface protocol, providing flit packing and unpacking, end-to-end data integrity, and a flit-retry mechanism for reliability, availability and serviceability (RAS) containment when data corruption is detected.

In some implementations of the apparatus, the interconnect gateway comprises at least one of Coherent Multichip Link (CML) or Cache Coherent Interconnect for Accelerators (CCIX) Gateway (CXG); and wherein the gateway is configured to utilize a 32-bit cyclic-redundancy check (CRC-32) to protect transactions conforming to the streaming interface protocol.

In some implementations of the apparatus, the RPU comprises a request agent (RA) proxy configured to communicate with the interconnect component according to the CHI-based protocol, enabling the entity to access, via the NVLink interface, resources coupled to the coherent interconnect.

In some implementations of the apparatus, the RPU comprises a home agent (HA) proxy configured to communicate with the interconnect component according to the CHI-based protocol, enabling the processing cores to access resources via the NVLink interface.

In some implementations of the apparatus, the interconnect component comprises a crosspoint comprising at least four mesh ports and at least two device ports; and wherein the RPU is coupled to a device port of the at least two device ports.

In some implementations of the apparatus, the coherent interconnect comprises a scalable coherent fabric (SCF), the interconnect component comprises a Cache Switch Node (CSN), and the RPU is coupled to the CSN via the CHI interface. In some implementations, the xPU may be based on an NVIDIA SCF coherent interconnect that includes CSNs as a crosspoint, and an NVLink-C2C for connecting to an external entity, such as a GPU, via an NVLink interface.

In some implementations of the apparatus, the SCF comprises an SCF Cache partition (SCC); and wherein the RPU and the SCC are coupled to the CSN, providing the entity, via the NVLink interface, with low-latency access to caching resources of the apparatus.

In some implementations of the apparatus, the memory comprises dynamic random-access memory (DRAM), and the entity comprises an NVLink Switch, a GPU, or an accelerator.

In various implementations, a method comprising: operating a coherent interconnect that utilizes a protocol based on Coherent Hub Interface (CHI-based protocol), comprising an interconnect component that receives CHI-based messages; communicating, via the coherent interconnect, between processing cores and memory controllers that communicate with memory channels coupled to memory having a capacity of at least 64 GB; operating a resource provisioning unit (RPU) comprising an NVLink interface and a CHI interface, wherein the NVLink interface utilizes differential pairs and communicates according to an NVLink-based protocol with an entity external to the RPU, and wherein the CHI interface communicates with the interconnect component; and translating, by the RPU, between messages conforming to the NVLink-based protocol and messages conforming to the CHI-based protocol to enable the entity to access resources via the NVLink interface and the coherent interconnect.

In some implementations, the method further comprises translating, by the RPU, first physical addresses associated with the NVLink-based protocol to second physical addresses associated with the CHI-based protocol, and translating NVLink command encodings to corresponding CHI opcodes.

In some implementations of the method, the RPU comprises a request agent (RA) proxy, and further comprising communicating, by the RA proxy, with the interconnect component according to the CHI-based protocol, enabling the entity to access, via the NVLink interface, resources coupled to the coherent interconnect.

In some implementations of the method, the RPU comprises a home agent (HA) proxy, and further comprising communicating, by the HA proxy, with the interconnect component according to the CHI-based protocol, enabling the processing cores to access resources via the NVLink interface.

In various implementations, a system comprising: a coherent interconnect that utilizes a protocol based on Coherent Hub Interface (CHI-based protocol), comprising interconnect components configured to route CHI-based messages; processing cores coupled via the coherent interconnect to memory controllers coupled to memory channels coupled to memory having a capacity of at least 64 GB; resource provisioning units (RPUs) comprising external interfaces and CHI interfaces, wherein at least one of the external interfaces comprises an NVLink interface utilizing differential pairs for communication according to an NVLink-based protocol with one or more external entities; wherein the CHI interfaces are coupled to the interconnect components; and wherein the RPUs are configured to translate between protocols utilized by the external interfaces and the CHI-based protocol; whereby the translate enables the external entities to access system resources via the external interfaces and the coherent interconnect.

In some implementations of the system, the RPUs are configured to translate physical addresses from physical address spaces associated with their external interface protocol to addresses from physical address spaces associated with the CHI-based protocol, and to translate command encodings from the external interface protocol to command encodings from corresponding CHI opcodes.

In some implementations of the system, the RPUs comprise at least one of request agent (RA) proxies or home agent (HA) proxies configured to communicate with the interconnect components according to the CHI-based protocol; wherein the RA proxies enable external entities to access memory and I/O resources coupled to the coherent interconnect, and the HA proxies enable the processing cores to access external memory resources via the external interfaces, thereby implementing a distributed shared memory architecture.

In some implementations of the system, at least one of the RPUs comprises an interconnect gateway configured to communicate with a corresponding interconnect component according to the CHI-based protocol; wherein the interconnect gateway utilizes a streaming interface protocol to enable connectivity between the external interface associated with the at least one of the RPUs and the coherent interconnect via the at least one of the RPUs. The external interfaces associated with the RPUs may implement various protocol bridging architectures to enable communication between external entities and the coherent interconnect. In one example, an RPU may utilize proxy-based mechanisms such as Request Agent (RA) proxy and Home Agent (HA) proxy for NVLink translations. In alternative implementations, the RPUs may employ direct translation engines that perform stateless or stateful conversion between external protocols and CHI-based messages, transaction queuing and reordering mechanisms that handle protocol-specific ordering requirements, or address remapping units that maintain translation tables for converting between addresses from different physical address spaces. The RPUs may implement credit-based flow control, transaction tracking structures, or protocol-specific state machines that manage the lifecycle of transactions as they traverse between domains. These various implementation approaches may enable external entities to access system memory while system components access resources attached to the external entities.

Optionally, the architectural flexibility of the RPUs may enable multiple protocols to co-exist within the system utilizing various mechanisms. Different RPUs in the system may support UALink through UPLI message processing engines, CXL protocol through CXL.mem and/or CXL.cache transaction handlers, PCIe protocol through TLP processing units, or proprietary interconnect protocols through custom translation logic. The system may include RPUs configured for multi-protocol operation, such as multi-protocol RPUs embedded in a Fabric Processing Unit (FPU) or in a software-defined fabric processor, wherein an RPU implements protocol detection and routing logic, shared transaction buffers with protocol-specific handling, unified address translation units that support multiple addressing schemes, or configurable state machines that adapt to different protocol requirements. The streaming interface protocol utilized by the interconnect gateway may provide a common transport mechanism with protocol-agnostic packetization and framing, enabling these diverse protocols to efficiently communicate with the CHI-based coherent interconnect. The RPUs may implement protocol-specific optimizations such as transaction coalescing, speculative prefetching, or latency hiding techniques while maintaining protocol semantics and coherency requirements utilizing appropriate translation and synchronization mechanisms.

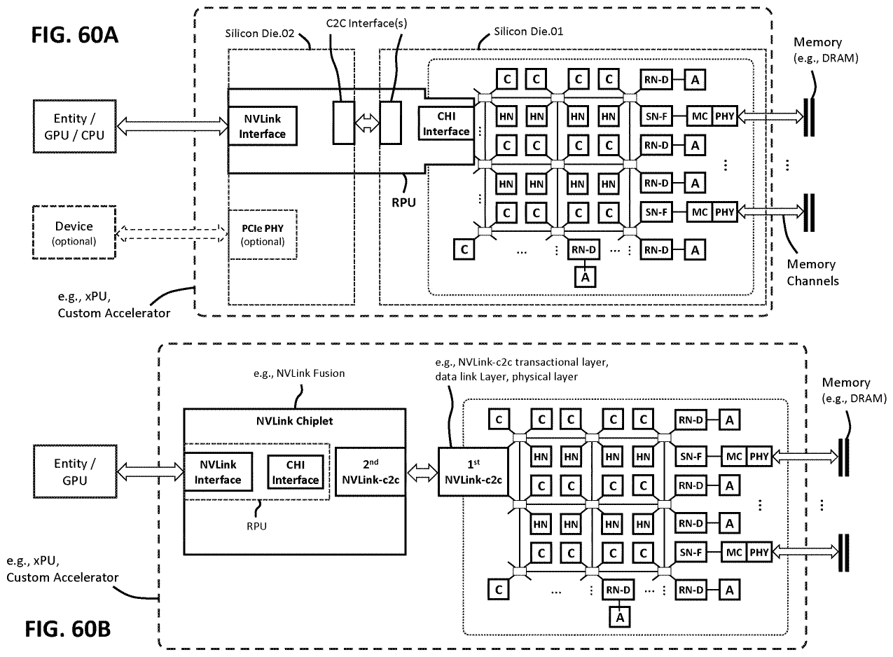

FIG. 60A illustrates an example of an xPU coupled to an entity such as a CPU or a GPU. The xPU includes an RPU which translates between NVLink traffic protocol and CHI-based traffic. The xPU further includes at least two silicon dies, wherein the first die includes a CHI interface of the RPU, and the second die includes an NVLink interface of the RPU. The second die may further include an optional PCIe PHY to communicate according to PCIe with a device external to the xPU. The first die and the second die are coupled by at least one C2C interface, utilizing chip-to-chip or die-to-die protocols such as CHI C2C or NVLink-C2C. The RPU may enable coherent memory access from the entity to the xPU, and optionally, from the device to the xPU.

FIG. 60B illustrates an example of an xPU coupled to an entity such as an NVIDIA Blackwell GPU. The xPU includes processing cores, acceleration cores, memory controllers, a coherent interconnect, and an NVLink chiplet, such as NVLink Fusion, that is coupled to the coherent interconnect via a first NVLink-C2C. The NVLink chiplet includes a second NVLink-C2C, and an RPU that translates between NVLink traffic and CHI-based traffic. The RPU includes an NVLink interface for coupling to the entity, and a CHI interface for coupling to the second NVLink-C2C. The NVLink-C2C interfaces are optionally integrated into NVLink-C2C controllers that includes transactional layers, data link layers and physical layers. The RPU may enable the GPU to access, via the NVLink interface, resources mapped to the physical address space utilized by the xPU coherent interconnect. Correspondingly, the RPU may enable the processing cores of the xPU to access, via the NVLink interface, resources of the GPU, such as HBM, High-Bandwidth Flash (HBF), or GDDR memory.

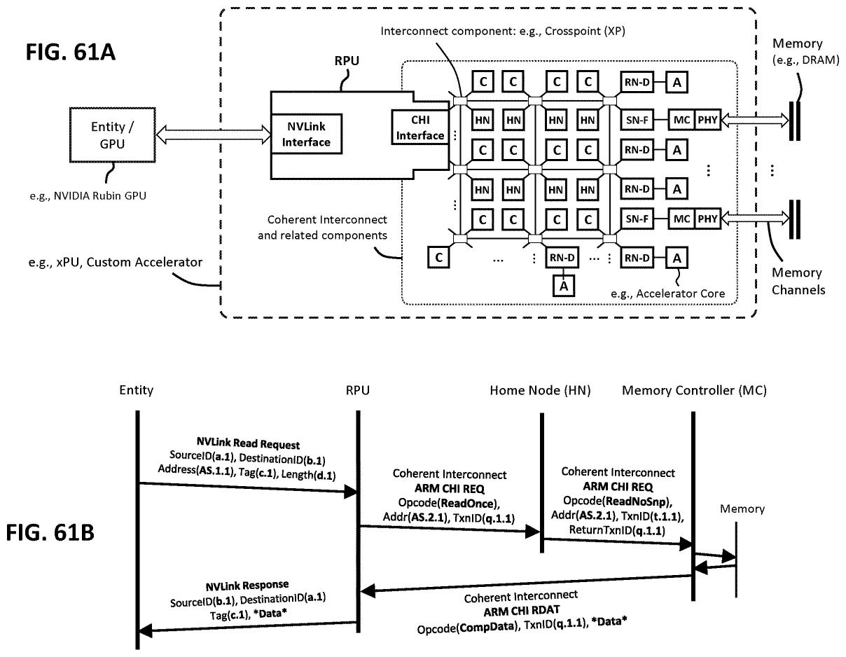

FIG. 61A illustrates an example of a system that translates between NVLink-based traffic and coherent interconnect CHI-based traffic. The NVLink connections are coupled via an RPU to an interconnect component such as a crosspoint (e.g., XP), which may serve as a fundamental building block of a coherent interconnect, providing switching or routing of CHI messages between participating elements such as request nodes, home nodes, gateways, protocol bridges, or other elements that connect to the coherent interconnect. The RPU may translate between NVLink traffic utilized by an entity, such as a GPU or a CPU, to CHI-based traffic utilized by the interconnect component, possibly eliminating intermediate protocol translations. Alternatively, the RPU may translate between an NVLink traffic and CHI traffic by utilizing intermediate protocols such as Advance Extensible Interface (AXI), or AXI Coherency Extensions Lite (ACE-Lite), or by utilizing streaming interface protocols such as Credited eXtensible Stream (CXS). Direct translation from NVLink to CHI may provide high-performance connectivity between a GPU coupled to the NVLink interface and memory coupled to the coherent interconnect, a performance gain that may be reflected via lower-latency accesses to memory and higher-bandwidth of reads and writes.

FIG. 61B illustrates an example of a transaction flow diagram (TFD) showing the translation of NVLink traffic to CHI traffic. An entity, such as a GPU or a CPU, initiates an NVLink read request, that is received by the RPU via the NVLink interface. The RPU translates the NVLink request to a CHI request carrying ReadOnce, optionally translating the physical address (AS.1.1) associated with NVLink to a physical address (AS.2.1) associated with CHI. The RPU may capture identification information associated with the NVLink request, such as source identifier of the requesting entity, and transaction Tag identifier, and may record the information together with identification information associated with the CHI request generated, such as the transaction ID (TxnID), in order to support the generation of an NVLink response for the NVLink request received from the entity. The RPU sends the CHI request, via the CHI interface, to an interconnect component, such as a crosspoint (e.g., an XP on a CHI coherent interconnect), that forwards the request to a home node. The home node processes the request and issues a CHI request carrying ReadNoSnp to a memory controller coupled to the coherent interconnect. The memory controller may read the requested data from memory, and may send the data to the RPU, or alternatively the memory controller may send the data to the home node, wherein the home node is responsible for sending the data to the RPU. When the RPU receives the data via the CHI interface, the RPU may issue an NVLink response with the data to the requesting entity, utilizing the identification information the RPU captured when processing and translating the NVLink request.

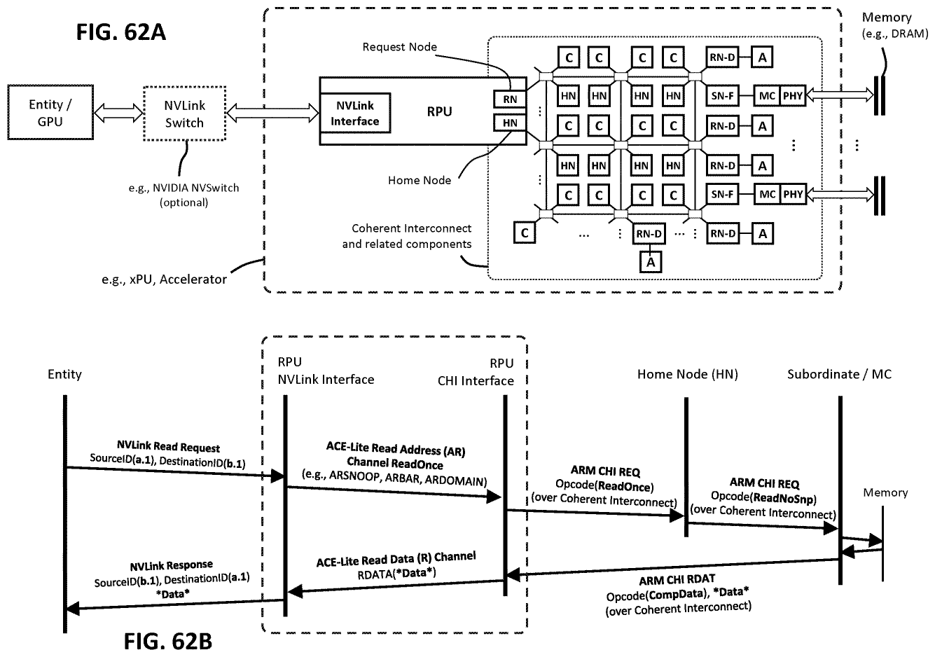

FIG. 62A illustrates an example of a system that translates between NVLink-based traffic and CHI-based traffic. The NVLink connections are coupled via an RPU to crosspoint (e.g., XP) interconnect components of the CHI coherent interconnect. The RPU may include request nodes (e.g., RNs), such as I/O-coherent RN-I nodes and/or RN-D, and/or home nodes (e.g., HNs), such as non-coherent HN-I nodes. This example enables external entities, such as GPUs, CPUs, or accelerators, which communicate utilizing NVLink traffic, to access resources within the ARM-based processor's coherent domain utilizing appropriate translations and routing, such as by an RPU translating from NVLink traffic utilized by a GPU entity, to CHI traffic, utilized by a crosspoint (XP) component of the CHI interconnect, wherein a request node or a home node provides the CHI interface for connecting to the XP.

FIG. 62B illustrates an example of an RPU that translates between NVLink traffic and CHI traffic, utilizing an intermediate protocol based on ARM Advanced Microcontroller Bus Architecture (AMBA) Advance Extensible Interface (AXI) Coherency Extensions Lite (ACE-Lite). The RPU may further translate physical addresses associated with NVLink to physical addresses associated with CHI. The RPU may process and translate the NVLink traffic, received from an NVLink interface, to ACE-Lite traffic for further processing, and send the ACE-Lite traffic to a request node (e.g., RN). The request node translates the ACE-Lite traffic to CHI traffic and provides a CHI interface for connecting to the coherent interconnect. In this example, the RPU receives from an entity, such as a GPU or a CPU, NVLink traffic that includes a read request. The RPU translates the NVLink traffic to an intermediate ACE-Lite ReadOnce, that is further translated by a request node to a CHI ReadOnce destined to a home node (e.g., HN). The home node processes the CHI ReadOnce and may issue a ReadNoSnp to a memory controller, for servicing the original read request received from the entity via the NVLink interface. The memory controller reads the requested data from memory, and may send the data via the coherent interconnect to the CHI interface of the RPU for delivery to the entity over the NVLink interface.

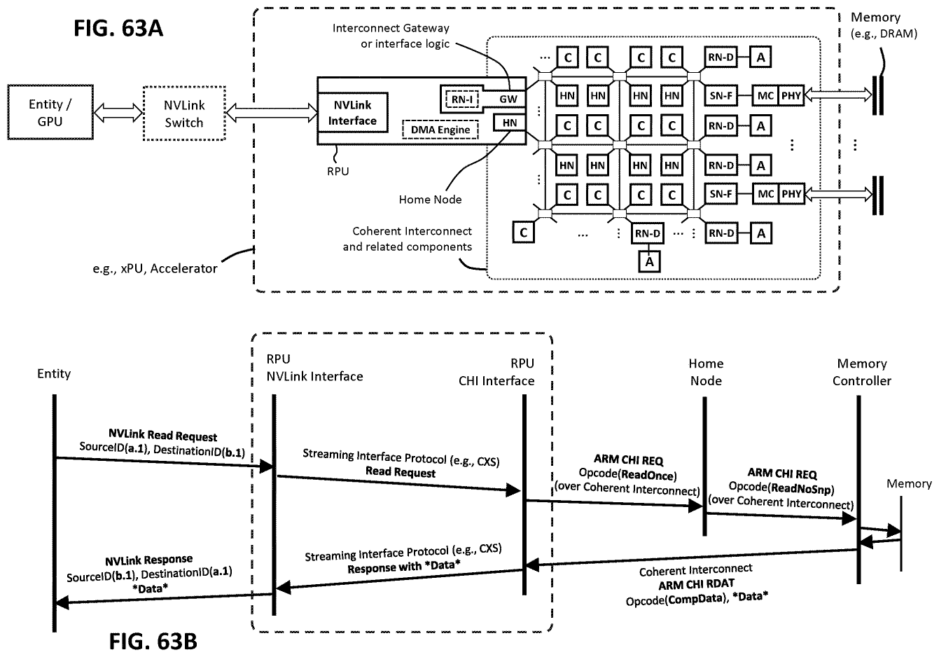

FIG. 63A illustrates an example of a system that translates between an interface based on NVLink, and interconnect components that communicate according to a protocol based on ARM CHI. The system enables entities, such as GPUs or CPUs, to access, via an optional NVLink switch, and an NVLink interface, resources coupled to the coherent interconnect. The NVLink connections are coupled, via an RPU, to crosspoint (e.g., XP) interconnect components of the coherent interconnect. The RPU may include a gateway or interface logic (marked GW in the figure), such as CXL/CCIX Gateway (CCG), Coherent Multichip Link (CML), Cache Coherent Interconnect for Accelerators (CCIX) Gateway (CXG), CHI C2C, or NVLink-C2C, that may include a CHI interface coupled to the coherent interconnect, enabling connectivity between the NVLink interface and the coherent interconnect, via the RPU. The gateway or interface logic may utilize a streaming interface protocol, such as Credited eXtensible Stream (CXS), to provide packing and un-packing of CHI C2C or an intermediate protocol over the streaming interface. The RPU may further include one or more request nodes (e.g., RN-I), home nodes (e.g., HN-I), optionally placed in the GW, that may enable DMA engines in the RPU to move blocks of data between the NVLink interface and the CHI interface. Examples of the gateway or interface logic include CCG, CML, CXG, CHI C2C, or NVLink-C2C.

FIG. 63B illustrates an example of an RPU that translates between NVLink traffic and CHI traffic. The RPU may further translate NVLink physical addresses to CHI physical addresses. The RPU utilizes a streaming interface protocol that may be based on ARM Advanced Microcontroller Bus Architecture (AMBA) Credited eXtensible Stream (CXS). Optionally, the RPU may utilize an intermediate protocol, such as CCIX, PCIe, or CXL, over the streaming interface protocol, and may translate from NVLink to intermediate protocol, and/or from the intermediate protocol to CHI. Optionally or alternatively, the RPU may include interfacing logic such as CHI C2C or NVLink-C2C, that may utilize a streaming interface protocol based on CXS.

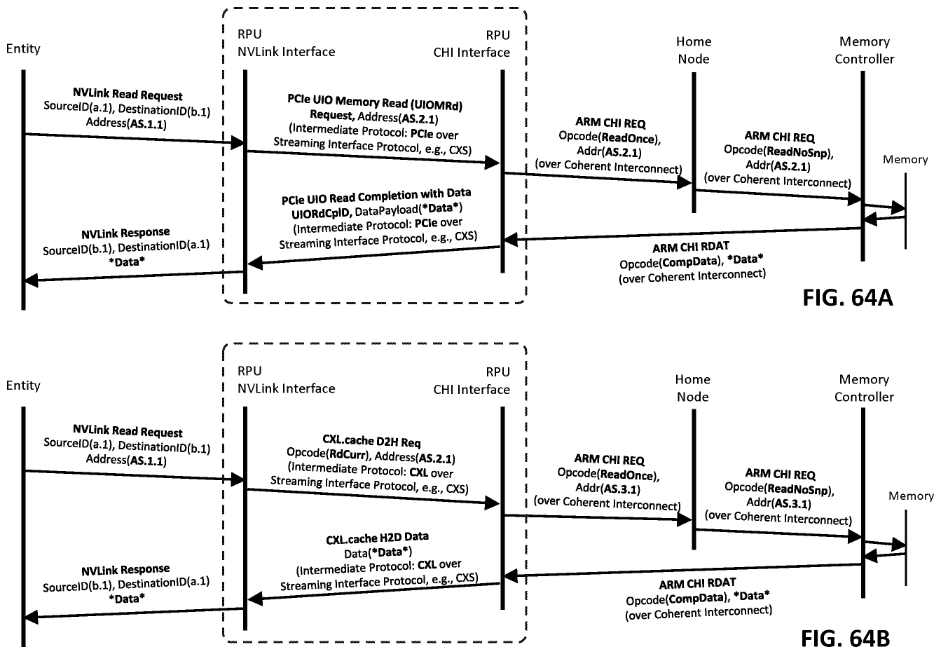

FIG. 64A illustrates an example of a TFD showing a read transaction from an entity such as a GPU to memory resources of an xPU or a memory pool, wherein an RPU provides translations between NVLink traffic, such as traffic based on a protocol utilizing NVLink5, and CHI traffic that may be utilized by the coherent interconnect of the xPU or the memory pool. The RPU may further translate physical addresses associated with NVLink to physical addresses associated with CHI, such as when translating from (AS.1.1) to (AS.2.1), optionally utilizing one stage of address translation. The RPU may utilize a streaming interface protocol, such as CXS, and may utilize PCIe as an intermediate protocol over the CXS streaming interface protocol, translating from NVLink to the PCIe intermediate protocol, and/or from the PCIe intermediate protocol to CHI.

The entity/GPU initiates the transaction by sending an NVLink read request carrying a physical address (AS.1.1) to the RPU, which translates the NVLink read request to a PCIe UIO Memory Read request utilizing a UIOMRd TLP type, optionally translating the physical address (AS.1.1) carried in the NVLink read request to a different physical address (AS.2.1) carried in the UIOMRd TLP. The RPU further translates the PCIe UIO Memory Read request to an ARM CHI REQ carrying ReadOnce and a physical address (AS.2.1 in the illustrated example), which is sent via the coherent interconnect to the Home Node (HN). The Home Node processes the request and sends a subsequent ARM CHI REQ with ReadNoSnp and the physical address (AS.2.1), to the Memory Controller (MC) for retrieving the requested data from memory. The Memory Controller accesses the memory and returns the data via an ARM CHI RDAT message carrying CompData and the requested data. The RPU receives the CHI response and translates it to the intermediate protocol, such as to PCIe UIO Read Completion with Data, utilizing a UIORdCpID TLP type, and further translates from the intermediate protocol to an NVLink response carrying the data, which is sent back to the entity/GPU via the NVLink interface, completing the read transaction.

When the RPU provides address translations, these address translations may take place during a stage wherein the RPU translates from NVLink to an intermediate protocol, such as PCIe or CXL. Additionally or alternatively, address translations may take place during a stage wherein the RPU translates from the intermediate protocol, such as PCIe or CXL, to CHI. In some examples, the RPU may perform address translations in stages, such as from a physical address (AS.1.1) in an NVLink request, to physical address (AS.2.1) in a PCIe request or a CXL request, and to physical address (AS.3.1) in a CHI request, optionally providing physical address space isolation between the NVLink domain, the intermediate protocol domain, and the CHI domain. Opcodes, TLP types, or intermediate protocols shown in this example, serve as an example. Other examples may utilize other TLP types such as MRd for a PCIe or CXL request, CpID for PCIe or CXL response, and other intermediate protocols such as CXL.mem or CXL.io.

FIG. 64B illustrates an example of a TFD showing a read transaction from an entity such as a GPU to memory resources of an xPU or a memory pool, wherein an RPU translates between NVLink traffic, such as traffic based on a protocol utilizing NVLink5, and CHI traffic that may be utilized by the coherent interconnect of the xPU or the memory pool. The RPU may further translate physical addresses associated with NVLink to physical addresses associated with CHI, such as when translating from (AS.1.1) to (AS.3.1), optionally utilizing two stages of address translation with an intermediate address (AS.2.1) that may be associated with an intermediate protocol. The RPU utilizes a streaming interface protocol, such as CXS, and may utilize CXL as an intermediate protocol over the CXS streaming interface protocol, translating from NVLink to the CXL intermediate protocol, and/or from the CXL intermediate protocol to CHI.

The entity/GPU initiates the transaction by sending an NVLink read request carrying a physical address (AS.1.1) to the RPU, which translates the NVLink read request to a CXL.cache D2H request comprising RdCurr, optionally translating the physical address (AS.1.1) carried in the NVLink read request to a different physical address (AS.2.1) carried in the CXL.cache D2H request, wherein (AS.2.1) may be an intermediate address associated with the intermediate protocol. The RPU further translates the CXL.cache D2H request to an ARM CHI REQ carrying ReadOnce, optionally translating the physical address (AS.2.1) carried in the CXL.cache D2H request to a different physical address (AS.3.1), carried in the ARM CHI REQ, which is sent via the coherent interconnect to the Home Node (HN). The Home Node processes the request and sends a subsequent ARM CHI REQ with ReadNoSnp and the physical address (AS.3.1), to the Memory Controller (MC) for retrieving the requested data from memory. The Memory Controller accesses the memory and returns the data via an ARM CHI RDAT message carrying CompData and the requested data. The RPU receives the CHI response and translates it to the intermediate protocol, such as to CXL.cache H2D Data, and further translates from the intermediate protocol to an NVLink response carrying the data, which is sent back to the entity/GPU via the NVLink interface, completing the read transaction.

When the RPU provides address translations, these address translations may take place during a stage wherein the RPU translates from NVLink to an intermediate protocol, such as PCIe or CXL. Additionally or alternatively, address translations may take place during a stage wherein the RPU translates from the intermediate protocol, such as PCIe or CXL, to CHI. In some examples, the RPU may perform address translations in stages, such as from a physical address (AS.1.1) in an NVLink request, to physical address (AS.2.1) in a PCIe request or a CXL request, and to physical address (AS.3.1) in a CHI request, optionally providing physical address space isolation between the NVLink domain, the intermediate protocol domain, and the CHI domain. Opcodes, TLP types, or intermediate protocols shown in this example, serve as an example. Other examples may utilize other opcodes, such as CXL.cache RdShared or CXL.cache RdAny, other TLP types such as MRd for a PCIe or CXL request, CpID for PCIe or CXL response, and other intermediate protocols such as CXL.mem or CXL.io.

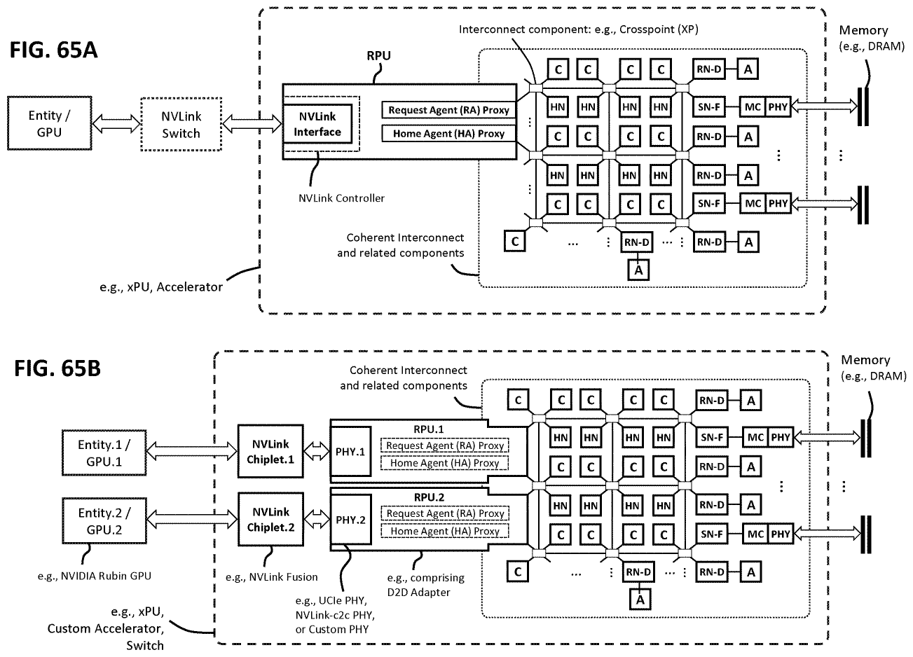

FIG. 65A illustrates an example of a system comprising an external entity coupled to an optional NVLink switch coupled to a processor comprising (such as an xPU) comprising an RPU comprising an NVLink interface, a Request Agent (RA) Proxy, and a Home Agent (HA) Proxy. The RPU may further comprise an NVLink controller, wherein the NVLink controller may include the NVLink interface. The RPU may be coupled to an interconnect component, such as a crosspoint (e.g., XP), optionally via the RA Proxy and/or the HA Proxy, wherein the RPU may communicate with the interconnect component according to a CHI-based protocol. The RPU may be further coupled, via the NVLink interface, and optionally via an NVLink switch, to an external entity, such as a GPU, wherein the RPU may communicate with the external entity according to an NVLink-based protocol. The RPU may translate between messages conforming to the NVLink-based protocol and messages conforming to the CHI-based protocol, possibly enabling the external entity to access resources of the xPU, such as xPU local memory (e.g., DRAM), and/or enabling the xPU to access resources of the external entity, such as remote memory coupled to the entity. The Request Agent (RA) proxy may receive requests that originate outside of the coherent interconnect, such as from remote agents, from the NVLink interface, from the NVLink controller, from an attached accelerator die, or from a remote chip, wherein the RA proxy may represent such remote initiators as a proxy when communicating with the coherent interconnect, e.g., by utilizing a Source ID (SrcID) namespace and a Transaction ID (TxnID) namespace associated with the coherent interconnect. The Home Agent (HA) proxy may own an address window backed by memory that may be placed on another chip or silicon die, such as on the external entity, wherein the HA proxy may enable processing cores of the xPU to access resources coupled to the external entity, such as memory (e.g., HBM and/or HBF).

FIG. 65B illustrates an example of a system comprising an xPU, such as a custom accelerator, that may utilize translations between NVLink and CHI, wherein the xPU may utilize NVLink for communicating with a first entity and with a second entity, which may each be a GPU external to the xPU, and wherein the xPU may further utilize CHI for intra-xPU communications between xPU resources coupled to a coherent interconnect of the xPU. The xPU may include first and second NVLink chiplets, or silicon dies, such as NVLink Fusion, coupled to the first and second entities, respectively. The first and second NVLink chiplets may be further coupled to first and second RPUs, respectively, via first and second physical layers (PHYs), respectively. The first and second RPUs may each include a Die-to-Die (D2D) adapter, a Request Agent (RA) Proxy, and/or a Home Agent (HA) proxy, wherein each RPU may communicate with the coherent interconnect, via the RA Proxy and/or the HA Proxy. The first and second PHYs may each include a UCIe PHY, an NVLink-C2C PHY, or a custom PHY.

The translations between NVLink and CHI may enable the first and/or the second entity to access resources coupled to the coherent interconnect of the xPU; and may further enable processing cores of the xPU to access resources coupled to the first and/or second entity. The translations between NVLink and CHI may further enable the xPU to perform as a switch, such as an NVLink switch, that may utilize NVLink to enable communication between the first entity and the second entity. The first entity may communicate with the second entity via the xPU, such as via the first NVLink chiplet, the first RPU, the coherent interconnect, the second RPU, and the second NVLink chiplet. Similarly, the second entity may communicate with the first entity via the xPU, such as via the second NVLink chiplet, the second RPU, the coherent interconnect, the first RPU, and the first NVLink chiplet.

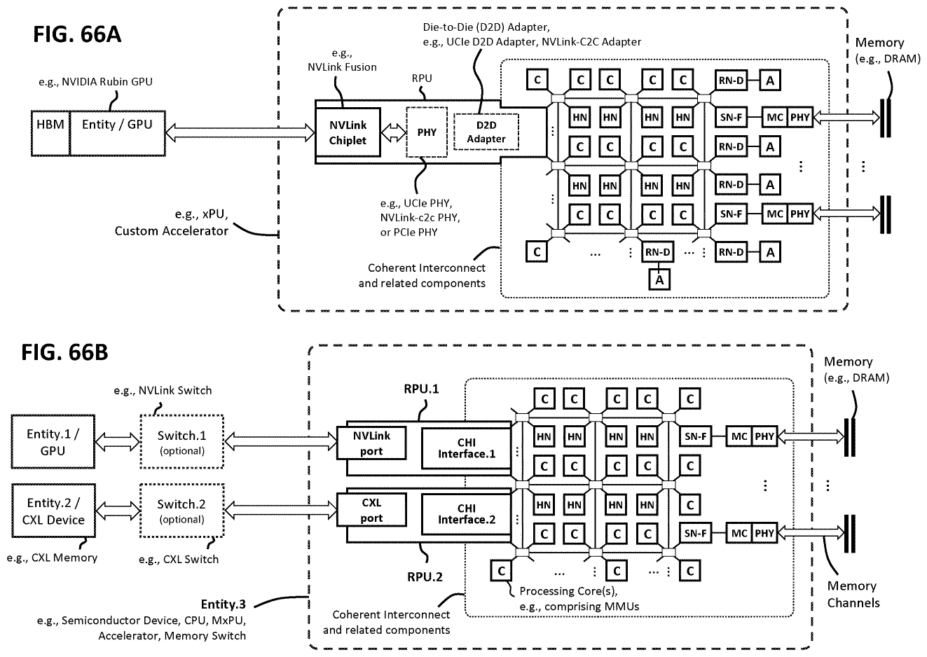

FIG. 66A illustrates an example of a system comprising an xPU comprising an RPU that translates between NVLink traffic and CHI traffic. The RPU may include a die-to-die (D2D) adapter, such as UCIe D2D adapter or NVLink-C2C adapter, which may perform at least one of: (1) Serve as an interfacing logic coupling the coherent interconnect and a die-to-die link; (2) Packetize CHI C2C into flits that can be streamed out to another chip or die, and correspondingly, handle de-packetization in the reverse direction; (3) Provide a CHI interface for connecting to an interconnect component such as a crosspoint (e.g., XP); or (4) Couple to a PHY such as a UCIe PHY, an NVLink-C2C PHY, or a PCIe PHY, for connecting to an NVLink chiplet, such as NVLink Fusion.

FIG. 66B illustrates an example of a system comprising a third entity (Entity.3), such as a semiconductor device, a CPU, an MxPU, an accelerator, or a memory switch, wherein the third entity may be coupled to a memory, such as DRAM, optionally via memory channels. The third entity may include a coherent interconnect, a first RPU (RPU.1) comprising an NVLink port and a first CHI interface (CHI Interface.1), and a second RPU (RPU.2) comprising a CXL port and a second CHI interface (CHI Interface.2). The third entity may be coupled, via the NVLink port and optionally via a first switch (Switch.1), such as an NVLink switch or an NVSwitch, to a first entity (Entity.1), such as a GPU, wherein the third entity may be further coupled, via the CXL port and optionally via a second switch (Switch.2), which may be a CXL switch, to a second entity (Entity.2), such as a CXL device (e.g., CXL memory). The third entity may utilize translations between NVLink and CHI that may enable the first entity to access the memory of the third entity, wherein the third entity may further utilize translations between CXL and CHI that may enable the second entity to access the memory of the third entity.

In some examples, the translations between NVLink and CHI, and the translations between CXL and CHI, may enable the third entity to perform as a switch, such as a multi-protocol switch or a hybrid switch, enabling communication between the first entity and the second entity, which may enable the GPU to utilize the CXL memory. For example, the first entity may communicate with the second entity via the third entity, such as via the first RPU comprising the NVLink port and the first CHI interface (CHI Interface.1), via the coherent interconnect, and via the second RPU that includes the CXL port and the second CHI interface (CHI Interface.2). In another example, the second entity may communicate with the first entity via the third entity, such as via the second RPU, the coherent interconnect, and the first RPU.

In some examples, the third entity may enable communication between the NVLink domain and the CXL domain, such as communication between NVLink ports and CXL ports, or communication between NVLink interfaces and CXL ports, whereas in other examples the communication between the NVLink domain and the CXL domain may be restricted, optionally by an access control list (ACL), such as to a subset of the NVLink ports and/or to a subset of the CXL ports. Additionally or alternatively, communication between the NVLink domain and the CXL domain may be restricted to a subset of allowed address regions associated with one or more address spaces, or may be restricted to a subset of allowed protocols, such as CXL.mem (e.g., not allowing CXL.cache transactions).

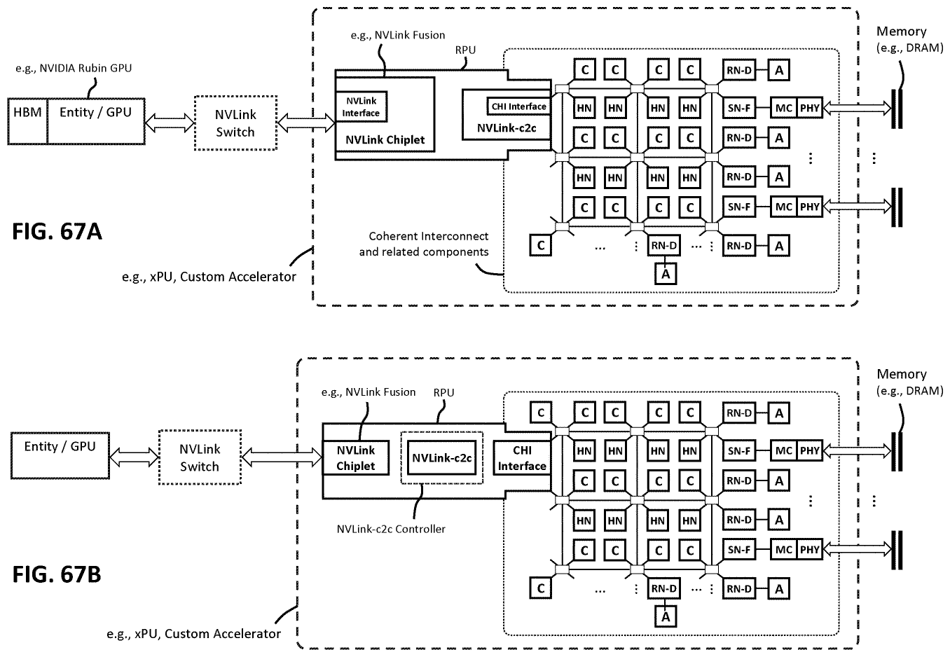

FIG. 67A illustrates an example of a system comprising an xPU or a custom accelerator, coupled to an entity such as a GPU, optionally via an NVLink switch. The xPU includes an RPU which translates between an NVLink traffic and CHI traffic. The RPU includes an NVLink chiplet, such as NVLink Fusion, that provides an NVLink interface for coupling to the external entity. The RPU further includes an NVLink-C2C for coupling the NVLink chiplet to the coherent interconnect, wherein the NVLink-C2C utilizes a CHI interface for connecting to at least one crosspoint of the coherent interconnect. The RPU may provide bi-directional memory access between the xPU and the GPU, enabling the xPU to read from the GPU's HBM, and enabling the GPU to read from DRAM coupled to the xPU. Alternatively, the RPU may provide unidirectional memory access, enabling the GPU to access xPU memory but not vice-versa, such as by exposing at least some of the xPU resources as a memory expander or a memory pool for use by the GPU.

FIG. 67B illustrates an example of a system comprising an xPU coupled to an entity such as a GPU. The xPU includes an RPU which translates between NVLink traffic and CHI-based traffic, wherein the RPU includes a CHI interface for coupling to a coherent interconnect, an NVLink-C2C logic, optionally integrated into an NVLink-C2C controller that includes a transactional layer, a data link layer and a physical layer. The RPU further includes an NVLink chiplet, such as NVLink Fusion, for coupling to the GPU, wherein the NVLink chiplet is further coupled to the coherent interconnect via the NVLink-C2C logic, optionally communicating with at least one crosspoint interconnect component according to a protocol based on ARM CHI.

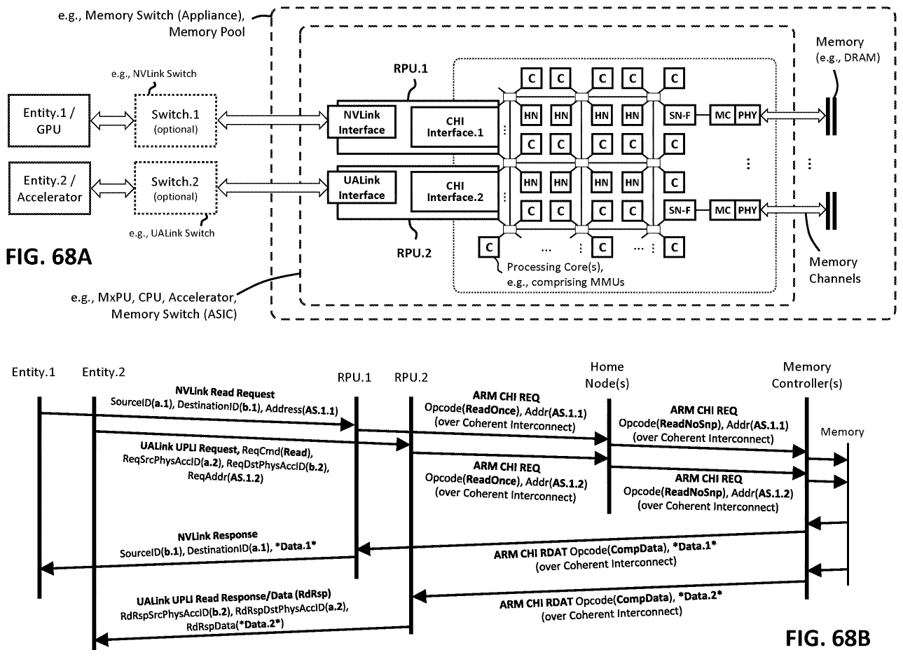

FIG. 68A illustrates an example of a system that may function as a multi-protocol memory switch appliance or a multi-protocol memory pool, and may include an MxPU, CPU, accelerator, or a memory switch ASIC, that may be coupled to two entities, optionally via switches: (1) Entity.1/GPU via an optional first switch (Switch.1), such as an NVLink switch or NVSwitch, and (2) Entity.2/Accelerator via an optional second switch (Switch.2), such as a UALink switch. The MxPU includes processing cores and memory controllers coupled to a coherent interconnect that may be based on CHI. The MxPU may utilize different translations for the external interfaces, performed by different RPUs, such as between NVLink-based interfaces and the MxPU coherent interconnect, or between UALink-based interfaces and the MxPU coherent interconnect. The first RPU (RPU.1) may enable Entity.1/GPU to access resources mapped to a physical address space utilized by the MxPU coherent interconnect, wherein the access is via the optional first switch, the NVLink interface and the MxPU coherent interconnect. Examples of resources mapped to the physical address space utilized by the MxPU coherent interconnect include DRAM or other memory resources of the MxPU. Correspondingly, the second RPU (RPU.2) may enable Entity.2/Accelerator to access, via the optional second switch, the UALink interface and the MxPU's coherent interconnect, resources mapped to a physical address space utilized by the MxPU's coherent interconnect, such as DRAM or other memory resources of the MxPU.

FIG. 68B illustrates an example of a TFD depicting a multi-entity memory access scenario wherein a GPU/first entity and an accelerator/second entity access memory mapped to one or more address spaces utilized by the coherent interconnect (CohInterMappedMemory) utilizing heterogeneous protocol message translations. Entity.1/GPU.1 initiates an NVLink request: Read with SourceID(a.1) to identify the source GPU, DestinationID(b.1) to identify the destination, and Address(AS.1.1) representing a physical address, such as an NVLink network address. RPU.1 translates the NVLink request to ARM CHI REQ carrying Opcode(ReadOnce) while preserving Addr(AS.1.1) unchanged. Concurrently or sequentially, Entity.2/Accelerator may initiate a UALink UPLI request (Req) with ReqCmd(Read), ReqSrcPhysAccID(a.2) to identify the source accelerator, ReqDstPhysAccID(b.2) to identify the destination, and ReqAddr(AS.1.2) representing a request address, such as a network physical address (NPA). RPU.2 translates the UALink UPLI request to ARM CHI REQ carrying Opcode(ReadOnce) while preserving Addr(AS.1.2) unchanged. Both transactions flow through the coherent interconnect to one or more home nodes, which may send respective ARM CHI REQ messages to one or more memory controllers with Opcode(ReadNoSnp) and the addresses Addr(AS.1.1) and Addr(AS.1.2), respectively. The memory controller(s) retrieve the requested data from the CohInterMappedMemory and send first and second ARM CHI RDAT messages with Opcode(CompData) carrying *Data.1* and *Data.2*, representing the data retrieved from the addresses AS.1.1 and AS.1.2, respectively. RPU.1 translates the first ARM CHI RDAT message to NVLink response with SourceID(b.1), DestinationID(a.1), and *Data.1* for Entity.1/GPU. RPU.2 translates the second ARM CHI RDAT message to UALink UPLI read response/data (RdRsp) with RdRspSrcPhysAccID(b.2), RdRspDstPhysAccID(a.2), and RdRspData(*Data.2*) for Entity.2/Accelerator.

The illustrated example demonstrates how heterogeneous entities utilizing different protocols may share access to the same CohInterMappedMemory through different RPUs that translate messages between different protocols while preserving the physical addresses. Alternatively, the illustrated example may be viewed as separate NVLink and UALink transactions that utilize the same coherent interconnect infrastructure to access the CohInterMappedMemory. Still alternatively, the response and read data paths may be implemented according to other designs, such as wherein the memory controller(s) may send the data to the home node(s) that send it to the respective RPUs, or the home node(s) send responses to the RPUs while the memory controller(s) send the data to the RPUs.

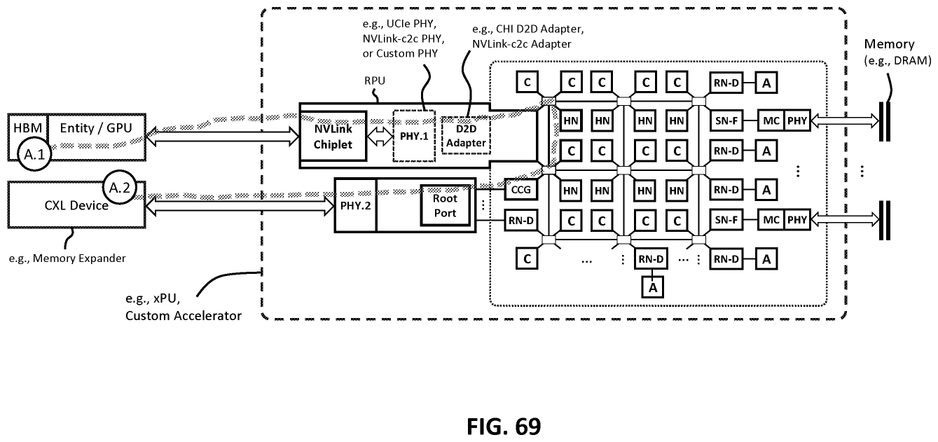

FIG. 69 illustrates an example of a heterogeneous computing system comprising an xPU or custom accelerator that utilizes an ARM-based mesh architecture with protocol interconnections. The xPU comprises a coherent interconnect implemented as a mesh topology with crosspoints (XP) that route transactions between various system components. Processing cores (C) are distributed throughout the mesh architecture and coupled to the coherent interconnect via the crosspoints. Home nodes are positioned within the mesh, optionally including HN-I nodes that may handle I/O-coherent transactions and HN-F nodes that may manage fully coherent transactions. System Node Fully coherent (SN-F) nodes are coupled to memory controllers (MC) which interface with external memory via physical layers (PHYs). The memory may be DRAM accessible through the memory channels. An entity comprising an NVIDIA Rubin GPU with integrated HBM is coupled to the xPU coherent interconnect via an NVLink chiplet. The NVLink chiplet, which may be an NVLink Fusion chiplet or custom PHY, is coupled utilizing a first physical layer (PHY.1, such as a UCIe PHY) to a die-to-die (D2D) adapter, which may be a CHI D2D Adapter or an NVLink-C2C Adapter, that enables communication between the NVLink chiplet and the coherent interconnect. The NVLink chiplet may provide the NVLink physical layer interface and may additionally provide higher protocol layers including the NVLink data link layer and transaction layer functionality.

Moreover, a CXL device, which may be a memory expander, may be coupled to the xPU coherent interconnect via a second physical layer (PHY.2) and a root port. The root port provides the interface between the CXL device and the coherent interconnect, enabling the CXL device to be discovered and configured by the system. The xPU architecture may enable the GPU to access memory resources of the CXL memory expander utilizing translations performed by the RPU and the coherent interconnect. The transaction path denoted as A.1 to A.2 in the figure illustrates a memory access flow that may represent an NVLink read transaction initiated by the GPU. The transaction may traverse from the GPU through the NVLink chiplet to the ARM mesh interconnect, wherein the RPU may translate the NVLink read request to a CHI transaction compatible with the ARM mesh interconnect. The CHI transaction may then be routed through the coherent interconnect to the appropriate home node and subsequently to the root port, wherein it may be further translated to a CXL.mem MemRd transaction for delivery to the CXL memory expander (A.2). The xPU may additionally comprise accelerator cores that may perform specialized computation tasks and may access both the GPU-attached HBM and the CXL-attached memory through the coherent interconnect.

In some implementations, a computer, such as an RPU, may be coupled between an NVLink interface and a CXL interface, and may translate between NVLink-based traffic and CXL.mem traffic. The computer may receive NVLink-based requests from a first entity, such as a GPU or an accelerator, and may translate the NVLink-based requests to CXL.mem M2S requests for transmission to a second entity, such as a CXL device, a CXL memory expander, or a CXL memory pool. The translation may include address translation between physical address spaces, opcode translation between NVLink commands and CXL.mem memory opcodes, and Tag translation between NVLink transaction identifiers and CXL.mem Tags. The computer may be implemented as a discrete component, as a chiplet within an IC package, as an IP block within a processor, or may be integrated into an active cable or an NVLink switch. The translation may enable NVLink-coupled accelerators to access CXL memory resources for GPU memory disaggregation, capacity expansion, AI model parameter storage, key-value (KV) cache offloading, and other memory-intensive AI workloads.

In various implementations, a method comprising: receiving, by a computer from a first entity via a first interface that communicates according to an NVLink-based protocol, an NVLink-based request comprising a first physical address associated with a first address space; translating, by the computer, the first physical address to a second physical address associated with a second address space; generating, by the computer, a CXL.mem Master-to-Subordinate (M2S) request comprising a read-class memory opcode and the second physical address, wherein CXL denotes Compute Express Link; sending, by the computer via a second interface, the CXL.mem M2S request to a second entity; receiving, by the computer from the second entity, a CXL.mem Subordinate-to-Master Data Response with Status (S2M DRS) comprising data; and sending, by the computer to the first entity, an NVLink-based response comprising the data. The computer may translate the NVLink-based request by terminating the NVLink transaction and initiating a corresponding CXL.mem transaction. For example, the read-class memory opcode may include MemRd, MemRdData, or other read-class opcodes defined by CXL.mem. The address translation may be implemented utilizing lookup tables, page tables, base-and-offset calculations, or programmable translation functions. The computer may translate requests initiated from the NVLink-based domain to the CXL domain, may translate requests initiated from the CXL domain to the NVLink-based domain, or may translate requests initiated from both domains.

In some implementations of the method, the NVLink-based request is associated with a data payload size exceeding a maximum CXL.mem data payload size, and wherein generating the CXL.mem M2S request comprises generating CXL.mem M2S requests corresponding to the NVLink-based request. For example, an NVLink-based read request for 256 Bytes of data may be translated to four CXL.mem M2S requests, each targeting a 64-Byte cacheline. The computer may generate the CXL.mem M2S requests with sequential or non-sequential addresses derived from the first physical address.

In some implementations, the method further comprises accumulating data from CXL.mem S2M DRS responses corresponding to the CXL.mem M2S requests before sending the NVLink-based response to the first entity. The computer may buffer partial data from individual S2M DRS responses and assemble the complete data payload before generating the NVLink-based response. The S2M DRS responses may arrive out of order, and the computer may utilize Tag mappings to associate each response with the corresponding CXL.mem M2S request.

In some implementations, the method further comprises maintaining, by the computer, a mapping between a first Tag associated with the NVLink-based request and a second Tag associated with the CXL.mem M2S request, and utilizing the mapping to associate the CXL.mem S2M DRS with the NVLink-based request. The mapping may be stored in a tracker entry, a translation table, or a content-addressable memory. The first Tag may include an NVLink Tag or TransactionID, and the second Tag may be a CXL.mem Tag allocated from a Tag space utilized by the computer toward the second entity.

In some implementations, the method further comprises generating, by the computer, a second CXL.mem M2S request comprising a MemSpecRd opcode and a third physical address; and sending the second CXL.mem M2S request to the second entity. The computer may generate speculative read requests to prefetch data from the second entity before, or without, the first entity explicitly requesting it. The speculative reads may reduce read latency when the second entity exhibits long access times, such as when accessing slow memory media or remote memory resources over a fabric.

In some implementations of the method, the first address space comprises an NVLink-based network address space or a GPU physical address space, and the second address space comprises a Host Physical Address (HPA) space; and wherein the first entity comprises a GPU, an accelerator, or an NVLink switch, and the second entity comprises a CXL device, a CXL memory expander, or a CXL memory pool. The NVLink-based network address space may be utilized for routing NVLink requests across the NVLink fabric. The HPA space may be utilized by a CXL host or CXL device for memory access operations. The address translation may accommodate differences in size, base addresses, or memory layouts between the address spaces.

In some implementations of the method, the CXL.mem S2M DRS further comprises a Poison indication, and the NVLink-based response further comprises an error indication translated from the Poison indication. The Poison indication in CXL.mem S2M DRS may signal that the data contains an error. The computer may translate the Poison indication to an equivalent error indication in the NVLink-based response to propagate the error status to the first entity.

In some implementations, the method further comprises receiving, from the first entity via the first interface, an NVLink-based write request comprising write data; generating, by the computer, a CXL.mem Master-to-Subordinate Request with Data (M2S RwD) comprising MemWr* and the write data; sending the CXL.mem M2S RwD to the second entity via the second interface; receiving, from the second entity, a CXL.mem Subordinate-to-Master No Data Response (S2M NDR); and sending an NVLink-based write response to the first entity. For example, MemWr* may include MemWr, MemWrPtl, or other memory write opcode variants defined by CXL.mem. The write data may be transferred from the NVLink domain to the CXL.mem domain with optional byte enable manipulation when the write is partial. The S2M NDR may include a Cmp opcode indicating completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to an NVLink-based protocol and a second interface configured to communicate according to CXL, with a computer coupled between the interfaces. The computer may be implemented in various form factors, such as an IC package conforming to a retimer BGA specification, an NVLink Fusion chiplet within a processor IC package, a discrete bridge device, or a component integrated into an active cable or an NVLink switch. The system may include optional NVLink switches and CXL switches to support multi-entity topologies. The computer may translate between physical address spaces and between NVLink-based requests and CXL.mem M2S requests, enabling NVLink-coupled entities to access CXL memory resources.

In various implementations, a system comprising: a first interface configured to communicate according to an NVLink-based protocol with a first entity; a second interface configured to communicate according to Compute Express Link (CXL) with a second entity; and a computer coupled between the first and second interfaces, configured to: translate physical addresses associated with the NVLink-based protocol to physical addresses associated with CXL; and translate between NVLink-based requests received via the first interface and CXL.mem Master-to-Subordinate (M2S) requests transmitted via the second interface. The computer may further translate CXL.mem S2M responses received via the second interface to NVLink-based responses transmitted via the first interface. The computer may include logic for address translation, Tag management, protocol conversion, and transaction tracking. The system may be deployed in datacenters, HPC environments, or AI training and inference clusters to enable NVLink-coupled accelerators to access CXL-attached memory resources such as CXL memory expanders or CXL memory pools.

In some implementations of the system, the computer is packaged in an integrated circuit (IC) package comprising input/output (I/O) connection points arranged according to a retimer ball grid array (BGA) specification. The retimer BGA form factor may enable the computer to be deployed in existing retimer sockets within server platforms, optionally facilitating adoption without requiring board-level redesign.

In some implementations, the system further comprises at least one of: an NVLink switch coupled between the first interface and the first entity, the NVLink switch configured to route NVLink-based requests from NVLink entities to the first interface; or a CXL switch coupled between the second interface and the second entity, the CXL switch configured to route CXL.mem M2S requests to CXL devices or CXL memory pools. The NVLink switch may be an NVSwitch that aggregates traffic from accelerators/GPUs toward the computer. The CXL switch may enable the computer to access multiple CXL memory devices or memory pools via a CXL interface, expanding the addressable memory capacity.

In some implementations of the system, the computer comprises an NVLink Fusion chiplet within an integrated circuit (IC) package of a processor, the NVLink Fusion chiplet comprising the first interface and coupled to the processor via a die-to-die (D2D) interface, the D2D interface utilizing a Universal Chiplet Interconnect Express (UCIe) PHY or a proprietary chip-to-chip PHY. The NVLink Fusion chiplet may enable integration of NVLink connectivity into processors that may not have native NVLink support. The D2D interface may couple the chiplet to a coherent interconnect within the processor, such as an on-chip ring or mesh interconnect.

In some implementations of the system, the NVLink-based protocol and CXL are associated with a same physical address space, the same physical address space comprising a global address space, a pod address space, or a fabric address space. When both protocols are associated with the same physical address space, the computer may perform address translations between addresses within the same space, such as range adjustments or offset calculations, rather than translations between fundamentally different address spaces.

In some implementations, a computer may translate CXL.mem requests to NVLink-based requests, enabling CXL hosts or CPUs to access memory residing on an NVLink fabric via NVLink-coupled entities such as accelerators/GPUs. NVLink provides a distributed memory model where GPUs may access memory via other GPUs. This translation may provide a CXL.mem bridge or gateway for non-NVLink compute elements, such as CPUs, to access memory on the NVLink fabric. The computer may be implemented as a discrete component, integrated into an active cable, or included in an NVLink switch.

In various implementations, a method comprising: receiving, by a computer from a first entity via a first interface that communicates according to Compute Express Link (CXL), a CXL.mem Master-to-Subordinate (M2S) request comprising a read-class memory opcode and a first physical address associated with a first address space; translating, by the computer, the first physical address to a second physical address associated with a second address space; generating, by the computer, an NVLink-based request comprising the second physical address; sending, by the computer via a second interface that communicates according to an NVLink-based protocol, the NVLink-based request to a second entity; receiving, by the computer from the second entity, an NVLink-based response comprising data; and generating, by the computer, a CXL.mem Subordinate-to-Master Data Response with Status (S2M DRS) comprising the data, and sending the CXL.mem S2M DRS to the first entity. The computer may translate the CXL.mem M2S request by terminating the CXL.mem transaction and initiating a corresponding NVLink transaction. The read-class memory opcode in the CXL.mem M2S request may include opcodes such as MemRd, MemRdData, or MemSpecRd. The computer may translate the HPA from the CXL.mem M2S request to an NVLink network address utilized for routing the NVLink request to its destination on the NVLink fabric. The CXL.mem S2M DRS may carry a MemData opcode and the data retrieved from the second entity.

In some implementations, the method further comprises maintaining, by the computer, a mapping between a first Tag associated with the CXL.mem M2S request and a second Tag associated with the NVLink-based request, and utilizing the mapping to associate the NVLink-based response with the CXL.mem M2S request. Upon receiving the NVLink-based response, the computer may utilize the second Tag to retrieve the first Tag from the mapping and include the first Tag in the CXL.mem S2M DRS for transaction completion at the first entity.

In some implementations of the method, the first address space comprises a Host Physical Address (HPA) space, and the second address space comprises an NVLink-based network address space; and wherein the NVLink-based request further comprises a DestinationID derived from the first physical address, the DestinationID identifying a target entity on an NVLink fabric coupled to the second interface. The computer may derive the DestinationID from the translated address, from a routing table, or from address-range-to-destination mappings. The DestinationID may be utilized for routing the NVLink request through NVLink switches to the target entity on the NVLink fabric.

In some implementations of the method, the first entity comprises a CXL host or a CPU, and the second entity comprises a GPU, an NVLink switch, or an accelerator; and wherein the NVLink-based response comprises data retrieved from a memory accessible via the second entity on an NVLink fabric. The translation may enable CPUs to access GPU-attached memory, such as HBM and/or High-Bandwidth Flash (HBF), via the CXL.mem-to-NVLink bridge, facilitating scenarios where CPUs participate alongside NVLink GPUs in AI inference or training workloads.

In some implementations, the method further comprises receiving, from the second entity, a second NVLink-based response that does not carry data; and generating a CXL.mem Subordinate-to-Master No Data Response (S2M NDR) based on the second NVLink-based response, and sending the CXL.mem S2M NDR to the first entity. The S2M NDR may carry a Cmp opcode to indicate completion of a write or invalidation operation. The computer may translate NVLink completion indications to the corresponding CXL.mem S2M NDR opcode.

In some implementations, the method further comprises receiving, from the first entity via the first interface, a CXL.mem Master-to-Subordinate Request with Data (M2S RwD) comprising MemWr* and write data; generating, by the computer, an NVLink-based write request comprising the write data; sending the NVLink-based write request to the second entity via the second interface; receiving, from the second entity, an NVLink-based write response; and generating a CXL.mem Subordinate-to-Master No Data Response (S2M NDR), and sending the CXL.mem S2M NDR to the first entity. MemWr* may include MemWr, MemWrPtl, or other memory write opcode variants. The computer may translate the CXL.mem write data and byte enables to corresponding NVLink write request formats. The S2M NDR may be sent after the NVLink-based write response is received, or may be sent before the NVLink write completes as an early completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to CXL and a second interface configured to communicate according to an NVLink-based protocol, with a computer coupled between the interfaces to translate CXL.mem M2S requests to NVLink-based requests. The computer may be integrated into an active cable, included in an NVLink switch, or implemented as a discrete bridge device. The system may position the computer closer to the CXL interface for signal integrity, since CXL runs over PCIe electricals designed for shorter-reach connectivity, while NVLink may incorporate signaling compatible with longer-reach deployments.

In various implementations, a system comprising: a first interface configured to communicate according to Compute Express Link (CXL) with a first entity; a second interface configured to communicate according to an NVLink-based protocol with a second entity; and a computer coupled between the first and second interfaces, configured to: translate physical addresses associated with CXL to physical addresses associated with the NVLink-based protocol; and translate between CXL.mem Master-to-Subordinate (M2S) requests received via the first interface and NVLink-based requests transmitted via the second interface. The computer may further translate NVLink-based responses received via the second interface to CXL.mem S2M responses transmitted via the first interface. The system may enable CXL hosts or CPUs to access memory on an NVLink fabric, such as GPU-attached HBM and/or HBF, via the NVLink-based protocol. The computer may maintain transaction tracking structures for matching NVLink responses to pending CXL.mem requests.

In some implementations, the system further comprises an active cable comprising a first pluggable module coupled to the first interface, a second pluggable module coupled to the second interface, and a physical medium coupling the first and second pluggable modules; wherein the computer is integrated into the active cable and converts between CXL signaling conforming to PCIe electrical specifications at the first interface and NVLink signaling at the second interface. The physical medium may include twinaxial cable, multimode fiber, or single-mode fiber. The active cable may be implemented as an Active Optical Cable (AOC) or an Active Copper Cable (ACC). The signaling conversion within the cable may simplify system integration by presenting standard CXL and NVLink interfaces at each end.

In some implementations of the system, the second interface utilizes fewer lanes than the first interface, and wherein the NVLink-based protocol operates at a higher per-lane signaling rate than CXL, such that the second interface achieves a bandwidth comparable to the first interface utilizing the fewer lanes. The lane reduction may simplify cable design by reducing the number of copper wires or optical fibers, which may reduce cost and complexity of the interconnect while maintaining bandwidth parity between the two interfaces.

In some implementations of the system, the computer is positioned closer to the first interface than to the second interface; and wherein the first interface communicates via electrical signaling conforming to PCIe physical layer specifications designed for shorter-reach connectivity, and the second interface communicates via electrical signaling compatible with longer-reach interconnect deployments. Positioning the computer closer to the CXL interface may improve signal integrity for the shorter-reach CXL signaling, while the longer-reach NVLink signaling may tolerate the additional distance to the second entity.

In some implementations of the system, the computer is included in an NVLink switch, the NVLink switch coupled to NVLink entities via the second interface; and wherein the computer translates CXL.mem M2S requests from the first entity to NVLink-based requests directed to at least one of the NVLink entities. The NVLink switch may route the translated NVLink-based requests to the appropriate NVLink entity based on destination identifiers or address-based routing. Integrating the computer into the NVLink switch may enable a CXL host to access memory across multiple NVLink-coupled accelerators/GPUs.

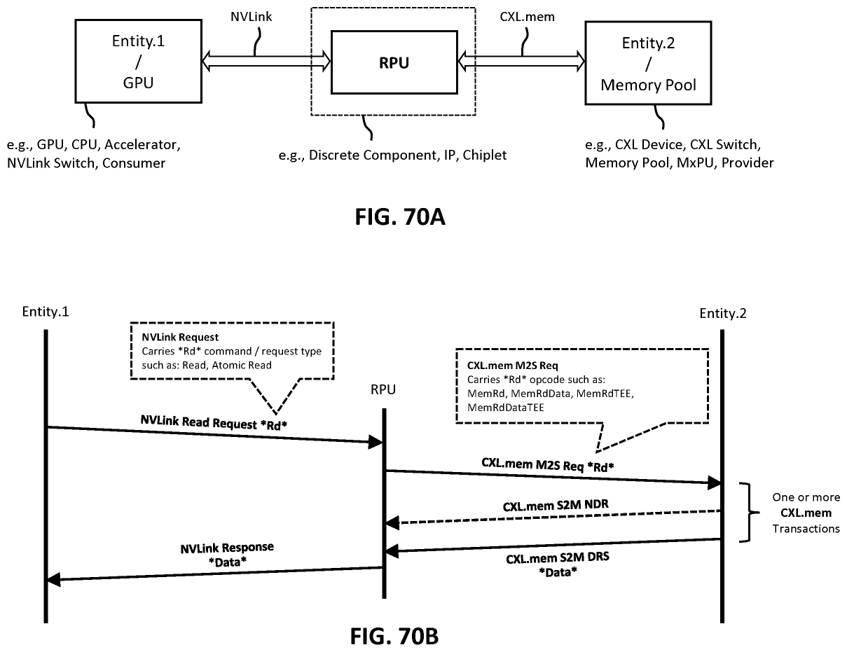

FIG. 70A illustrates an example of a system comprising an apparatus, such as an RPU, coupled between a first entity (Entity.1) and a second entity (Entity.2). The RPU may translate between NVLink-based traffic and CXL-based traffic, such as CXL.mem traffic. Entity.1, shown as a GPU, may communicate with the RPU according to an NVLink-based protocol, and may include a GPU, CPU, Accelerator, NVLink Switch (NVSwitch), or other resource consumer. Entity.2, shown as a Memory Pool, may communicate with the RPU according to CXL.mem, and may include a CXL Device, CXL Switch, Memory Pool, MxPU, or other resource provider. The RPU may be implemented as a discrete component, an IP block within a processor, or a chiplet within an IC package. Additionally or alternatively, the RPU may translate between the NVLink-based traffic and CXL.io traffic, and/or between the NVLink-based traffic and CXL.cache traffic.

FIG. 70B illustrates an example of a Transaction Flow Diagram (TFD) demonstrating an apparatus, such as an RPU, that may translate between NVLink-based traffic and CXL-based traffic, such as CXL.mem traffic. The TFD shows three entities: Entity.1 (a GPU or Consumer) on the left, the RPU in the center, and Entity.2 (a CXL Device or Provider) on the right. The first entity may send an NVLink Read Request carrying a *Rd* command or request type, such as Read or Atomic Read, to the RPU. The RPU may translate the NVLink Read Request to a CXL.mem M2S Req carrying a *Rd* opcode, such as MemRd, MemRdData, MemRdTEE, or MemRdDataTEE, and may send the CXL.mem M2S Req to the second entity. The second entity may respond with one or more CXL.mem transactions, including a CXL.mem S2M NDR and/or a CXL.mem S2M DRS carrying *Data*. The RPU may translate the CXL.mem S2M DRS to an NVLink Response carrying *Data* and send the NVLink Response to the first entity. In some examples, the RPU may translate an NVLink-based request to multiple CXL.mem request, such as when splitting an NVLink request for a data payload of 256 Bytes to CXL.mem M2S requests each carrying 64 Bytes. The RPU may accumulate data from one or more CXL.mem S2M DRS messages before sending the data via an NVLink-based response.

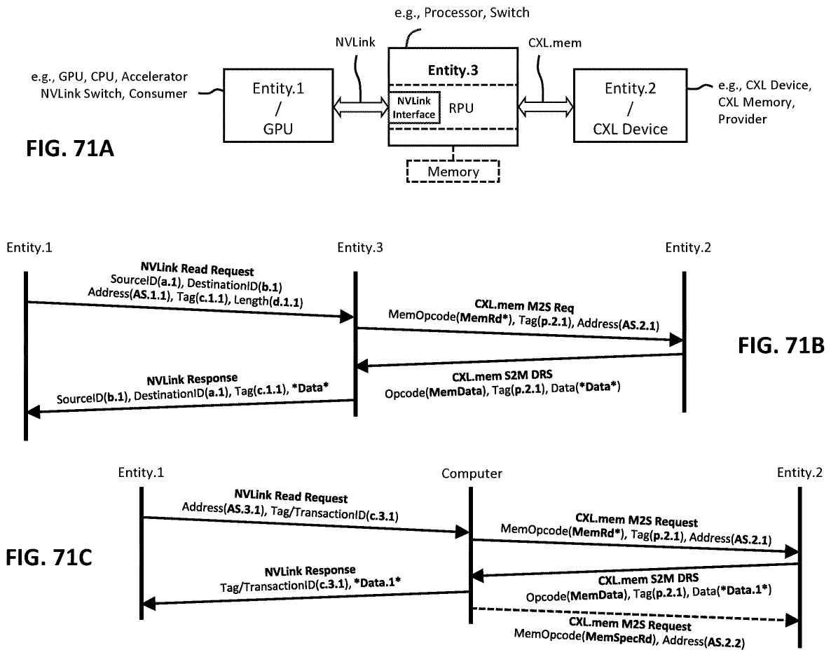

FIG. 71A illustrates an example of a system comprising a third entity (Entity.3), such as a processor or a switch. Entity.3 includes an NVLink Interface and an RPU, and includes or is coupled to an optional Memory. Entity.3 is coupled to a first entity (Entity.1), which may be a GPU, CPU, Accelerator, NVLink Switch (NVSwitch), or resource consumer, via an NVLink-based protocol. Entity.3 is further coupled to a second entity (Entity.2), which may be a CXL Device, CXL Memory, or resource provider, via CXL.mem. In some examples, messages conforming to the NVLink-based protocol may be associated with a first physical address (PA) space, such as a GPU physical address space or an NVLink-based network address space, and messages conforming to CXL.mem may be associated with a second PA space, such as HPA space. The RPU may perform address translations between addresses within the first PA space and addresses within the second PA space. In other examples, messages conforming to the NVLink-based protocol and messages conforming to CXL.mem may be associated with the same PA space, such as a global address space. Optionally, the RPU may perform further translations between the NVLink-based domain and CXL.mem domain, such as protocol translations, opcode translations, command translations, and field translations.

FIG. 71B illustrates an example of a TFD demonstrating translations performed by a third entity (Entity.3), such as a processor, a switch, or an RPU, between messages conforming to an NVLink-based protocol utilized for communicating with a first entity (Entity.1), such as a GPU, a CPU, or an accelerator, and messages conforming to CXL.mem utilized for communicating with a second entity (Entity.2), such as a CXL device or CXL memory. The first entity may initiate an NVLink Read Request comprising SourceID(a.1), DestinationID(b.1), Address(AS.1.1), Tag(c.1.1), and Length(d.1.1), wherein SourceID(a.1) may denote the NVLink interconnect address utilized by the requesting entity, and DestinationID(b.1) may denote the NVLink interconnect address utilized by the target of the NVLink request. The third entity may translate the NVLink request to a CXL.mem M2S Req comprising MemOpcode(MemRd*), Tag(p.2.1), and Address(AS.2.1), and may send the CXL.mem M2S Req to the second entity. Upon receiving a response from the second entity, which may include a CXL.mem S2M DRS comprising Opcode(MemData), Tag(p.2.1), and Data(*Data*), the third entity may translate the CXL.mem S2M DRS to an NVLink Response comprising SourceID(b.1), DestinationID(a.1), Tag(c.1.1), and *Data*. The third entity may perform further translations, such as protocol translations, opcode translations, command translations, or translations between PDUs conforming to the NVLink-based protocol and messages conforming to CXL.mem, such as translations of Tags and translations of error indications, such as poison.

FIG. 71C illustrates an example of a TFD demonstrating translations, such as address translations, optionally performed by a computer, between NVLink-based requests received from a first entity (Entity.1), which may be a CPU or a GPU, and CXL.mem requests sent to a second entity (Entity.2), which may be a CXL device. The first entity may initiate an NVLink Read Request comprising Address(AS.3.1) and Tag/TransactionID(c.3.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.mem M2S Request comprising MemOpcode(MemRd*), Tag(p.2.1), and Address(AS.2.1), and may send the CXL.mem M2S Request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to an NVLink response comprising Tag/TransactionID(c.3.1) and *Data.1*, and send the NVLink response to the first entity. The computer may further initiate speculative memory reads targeting the second entity, such as a CXL.mem M2S request comprising MemOpcode(MemSpecRd) and Address(AS.2.2), to facilitate data prefetches and potentially reduce read latency from the second entity. Optionally, the computer may utilize the speculative memory reads on behalf of the first entity. When utilizing MemSpecRd, some of the CXL.mem M2S Req fields, such as Tag, MetaField, MetaValue, and SnpType, may be reserved. In some examples, the computer may issue multiple CXL.mem reads in response to receiving an NVLink request from the first entity, such as when splitting an NVLink request for a large block of data (e.g., 256 B) to smaller CXL.mem reads (e.g., 64 B each), or when prefetching data from the second entity utilizing CXL.mem reads. The computer may translate requests or transactions initiated from the NVLink-based domain to the CXL domain, and/or may translate requests or transactions initiated from the CXL domain to the NVLink-based domain.

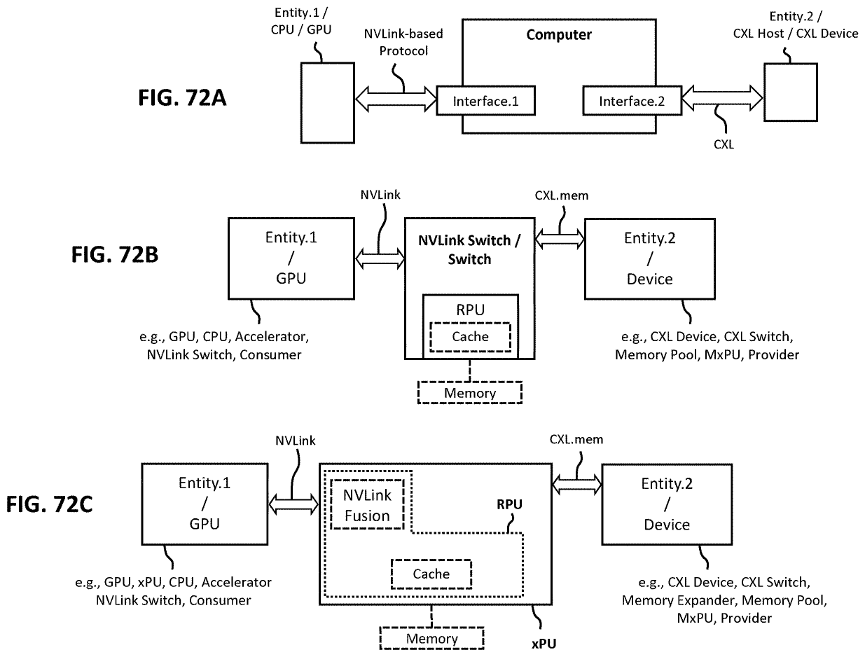

FIG. 72A illustrates an example of a system comprising a computer coupled between a first interface (Interface.1) and a second interface (Interface.2). Interface.1 may communicate according to an NVLink-based Protocol with a first entity (Entity.1), which may be a CPU or a GPU. Interface.2 may communicate according to CXL with a second entity (Entity.2), which may be a CXL host or a CXL device. The computer may extract addresses from requests received via the first interface, wherein these addresses may refer to a first address space, such as an NVLink-based address space, an NVLink-based network address space, or a GPU address space utilized by the first entity. The computer may further translate these addresses and generate requests carrying the translated addresses for transmission via the second interface, wherein the translated addresses may refer to a second address space utilized by the second entity. In other examples, the first address space and the second address space may be associated with the same address space, such as a common address space, a global address space, a pod address space, or a fabric address space. The computer may be implemented in an IC package having high-speed differential I/O balls positioned according to a ball grid array layout defined by a retimer specification. Optional switch(es), such as NVLink switches, may be positioned between the first interface and the first entity. Similarly, optional switch(es), such as CXL switches, may be positioned between the second interface and the second entity.

FIG. 72B illustrates an example of a system comprising an NVLink Switch, or Switch that includes an RPU and a Cache. The switch is coupled to a first entity (Entity.1), shown as a GPU, via an NVLink-based protocol, and to a second entity (Entity.2), shown as a Device, via CXL.mem. Entity.1 may be a GPU, CPU, Accelerator, NVLink Switch, or Consumer. Entity.2 may be a CXL Device, CXL Switch, Memory Pool, MxPU, or Provider. The switch may further be coupled to a Memory. The RPU within the switch may translate between NVLink-based requests received from the first entity and CXL.mem M2S requests transmitted to the second entity. The Cache within the switch may store data for reducing latency or accumulating data from multiple CXL.mem responses.

FIG. 72C illustrates an example of a system comprising a processor, such as an xPU, that includes an RPU that may include an NVLink Fusion chiplet or IP block. The RPU may further include a Cache, and may be coupled to a Memory. The RPU may be coupled, via the NVLink Fusion component, to a first entity (Entity.1) that may be a GPU, xPU, CPU, Accelerator, NVLink Switch, or Consumer. The RPU is coupled via CXL.mem to a second entity (Entity.2), shown as a Device. Entity.2 may be a CXL Device, CXL Switch, Memory Expander, Memory Pool, MxPU, or Provider. The NVLink Fusion chiplet may include the NVLink interface and may be part of the RPU, such that protocol translation between NVLink-based traffic and CXL.mem traffic may be performed within the NVLink Fusion chiplet. The NVLink Fusion chiplet may also include an NVLink PHY. In other examples, the NVLink interface and the RPU may be implemented as functional blocks on the same die with the xPU, or split between silicon dies or chiplets inside the IC package of the xPU.

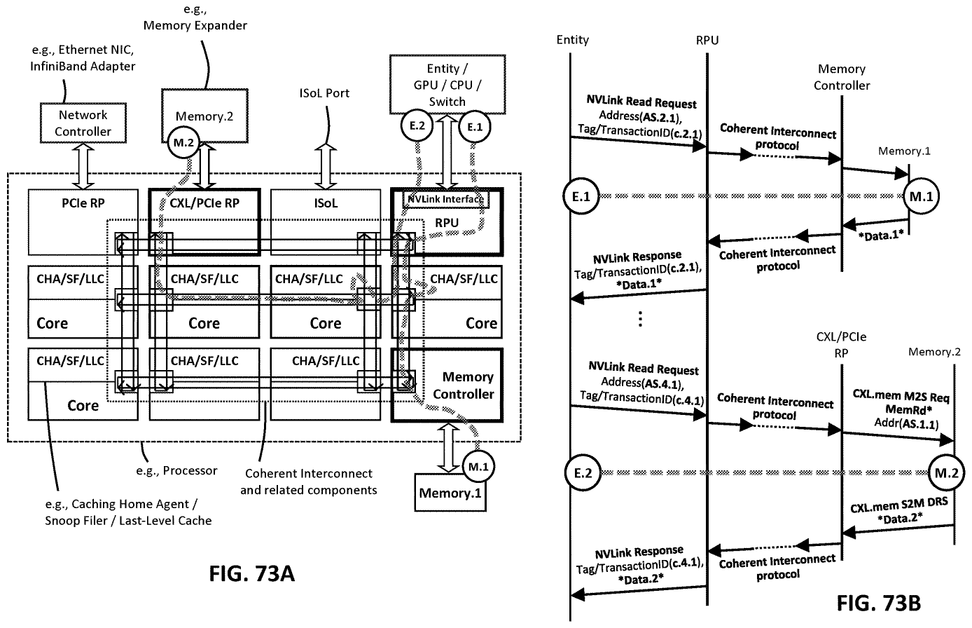

FIG. 73A illustrates an example of a system comprising a processor including a coherent interconnect, which may enable an external entity, such as a GPU, CPU, or Switch, to access memory resources mapped to an address space utilized by the coherent interconnect, such as via one or more of the two illustrated paths denoted as (E.1)-(M.1) and (E.2)-(M.2). The processor may include processing cores, and coherent interconnect, and related components, such as Caching Home Agent/Snoop Filter/Last-Level Cache (CHA/SF/LLC) slices. The processor may further include a PCIe RP coupled to a Network Controller (e.g., Ethernet NIC, InfiniBand Adapter), a CXL/PCIe RP coupled to a second memory (Memory.2, such as a Memory Expander), a memory controller coupled to a first memory (Memory.1), such as DRAM, and an ISoL port (e.g., utilizing NVIDIA NVLink-C2C, ARM CHI C2C, or Intel Coherent Processor Interconnect Protocol (ICPIP)). The processor includes an RPU coupled to an NVLink interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL/PCIe RP, such as over path (E.2)-(M.2). The illustrated RPU may be coupled to the coherent interconnect, and may translate between the NVLink-based protocol and a protocol utilized by the coherent interconnect. The processor may be implemented as a monolithic die, as chiplets within an IC package, or as components on a board, and may utilize a mesh-based coherent interconnect, or other types of coherent interconnects such as a ring, a crossbar, or a Network on Chip (NoC).

FIG. 73B illustrates an example of a TFD demonstrating two NVLink requests, such as NVLink read requests, received from an entity, such as a GPU or a CPU, processed by an RPU and forwarded, possibly using a protocol utilized by a coherent interconnect of a processor, to different memories that may be mapped to an address space utilized by the coherent interconnect. The paths from the RPU to the different memories may traverse other components, such as CHA/SF/LLC slices, memory controllers, or in other examples a home agent or a home node, optionally for resolving coherency. The RPU may perform physical address translations between first physical addresses, such as from GPU physical addresses or NVLink-based network addresses that may be carried in the NVLink requests, and second physical addresses, such as Host Physical Addresses (HPAs), which may refer to an address space utilized by the coherent interconnect, wherein the physical address translations may enable the entity to access the processor's memories. The processor may have multiple memory resources, such as first memory (Memory.1), which may be DRAM coupled to a memory controller of the processor, and/or second memory (Memory.2), which may be a CXL memory expander coupled to a CXL/PCIe RP of the processor. The RPU may further translate between NVLink-based requests and requests based on a protocol utilized by the coherent interconnect, and send the translated requests to the coherent interconnect, requesting read from memory. In some examples, the requested data may be provided by a processor cache, such as by an LLC, instead of by the memory. The data may then return over the coherent interconnect to the RPU, wherein the RPU may provide the data to the requesting entity via an NVLink response.

The TFD illustrates two exemplary transactions between the entity and the RPU, (Entity/GPU/CPU /Switch), processed by an RPU and forwarded via the coherent interconnect protocol to different memories. The TFD illustrates two exemplary transactions corresponding to two distinct memory read paths denoted as (E.1)-(M.1) and (E.2)-(M.2), each associated with a different physical address mapped to different memory resources. The first exemplary transaction (E.1) includes a first NVLink Read Request comprising Address(AS.2.1) and Tag/TransactionID(c.2.1). The RPU may translate the first NVLink request and forward the translated request via the Coherent Interconnect protocol, resulting in the retrieval of *Data.1* from the first memory (Memory.1) via the Memory Controller, wherein *Data.1* may be sent to the entity via the Coherent Interconnect protocol and via the RPU with the first NVLink Response comprising Tag/TransactionID(c.2.1) and *Data.1*.

The second exemplary transaction (E.2) includes a second NVLink Read Request comprising Address(AS.4.1) and Tag/TransactionID(c.4.1). The RPU may translate the second NVLink read request and may further translate the physical address (AS.4.1) carried in the second NVLink read request to a translated physical address (AS.1.1) which may refer to an address space utilized by the coherent interconnect. The RPU may forward the translated request, that may include the translated physical address (AS.1.1), via the coherent interconnect protocol, resulting in the retrieval of *Data.2* from the second memory (Memory.2) via the CXL/PCIe RP, utilizing a CXL.mem M2S request comprising MemRd* and Address(AS.1.1). The second memory (Memory.2) may respond with a CXL.mem S2M DRS comprising *Data.2*, which may be sent to the RPU via the coherent interconnect protocol. The RPU may then send *Data.2* to the entity via the second NVLink response. It is noted that the physical addresses (AS.2.1) and (AS.4.1) may refer to different memory regions within an address space, such as a GPU physical address space or an NVLink-based network address space, which may be exposed via an NVLink interface, enabling the entity to access memory resources based on the translation capabilities of the RPU.

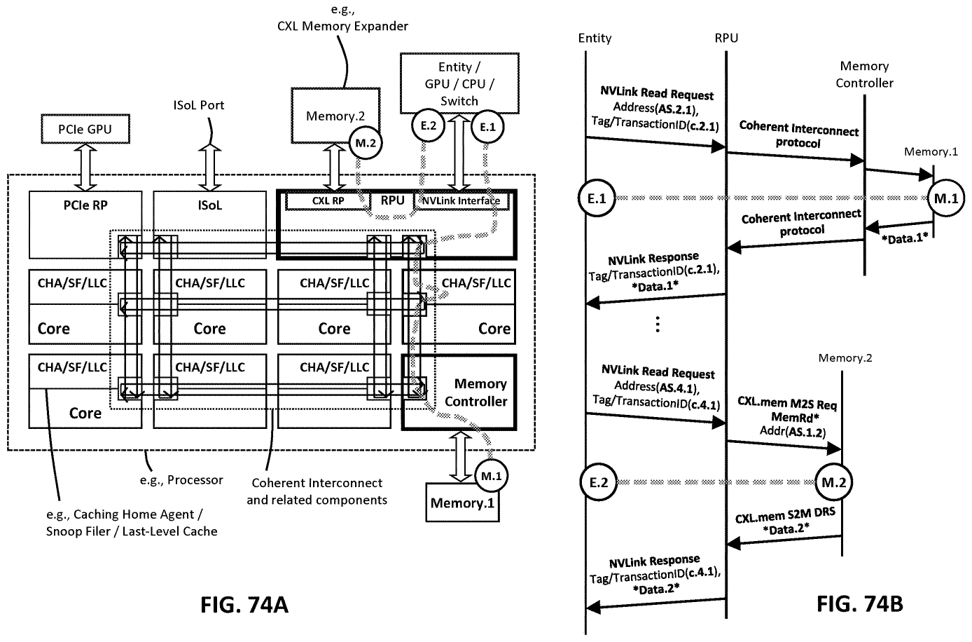

FIG. 74A illustrates an example of a system comprising a processor, including a coherent interconnect, capable of enabling an external entity, such as a GPU, CPU, or accelerator, to access memory resources mapped to an address space utilized by the coherent interconnect, such as via one or more of the two illustrated paths denoted as (E.1)-(M.1) and (E.2)-(M.2). The processor may include processing cores and CHA/SF/LLC, optionally implemented as distributed slices coupled to the coherent interconnect. The processor may further include a PCIe RP that may be coupled to a PCIe GPU, an ISoL port (e.g., utilizing NVLink-C2C, CHI C2C, or Intel Coherent Processor Interconnect Protocol (ICPIP), e.g., Intel UPI), and a Memory Controller coupled to a first memory (Memory.1). The processor includes an RPU that comprises a CXL RP, wherein the CXL RP is coupled to a second memory (Memory.2), such as a CXL Memory Expander. The RPU further includes an NVLink Interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL RP within the RPU, such as over path (E.2)-(M.2). The illustrated RPU and NVLink Interface are coupled to the coherent interconnect, and may translate between the NVLink-based protocol and a protocol utilized by the coherent interconnect. The processor may utilize a mesh-based coherent interconnect, or other types of coherent interconnects such as a ring, a crossbar, or a Network on Chip (NoC).

FIG. 74B illustrates an example of a TFD demonstrating two NVLink requests, such as NVLink read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations between first physical addresses, such as NVLink-based physical addresses, NVLink-based network addresses, or GPU physical addresses, and second physical addresses, such as Host Physical Addresses (HPAs) or System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between an NVLink-based protocol, such as a protocol utilizing an NVLink interconnect, and a protocol utilized by the coherent interconnect, wherein the RPU may send the optionally translated NVLink requests to the coherent interconnect, requesting reads from memory, such as from the first memory or from the second memory. Additionally or alternatively, the RPU may translate NVLink-based traffic to CXL-based traffic (e.g., CXL.mem), and send the translated NVLink traffic to the second memory via the CXL RP. In some examples, the requested data may be provided by a cache of the processor, such as by an LLC, instead of by the memory. The data may then return over the coherent interconnect to the RPU, wherein the RPU may provide an NVLink response to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first NVLink request comprising Address(AS.2.1) and Tag/TransactionID(c.2.1). The Tag/TransactionID may denote a Tag, a transaction Tag, a transaction identifier, or another field or set of fields carried in NVLink requests and/or NVLink responses, which may serve to associate the NVLink responses with the NVLink requests. The RPU may translate the first NVLink request and forward the translated request via the coherent interconnect protocol, resulting in the retrieval of *Data.1* from the first memory (Memory.1) via the memory controller, wherein *Data.1* may be sent to the entity via the coherent interconnect protocol and via the RPU with the first NVLink response. The second exemplary transaction corresponds to the memory read path denoted as (E.2)-(M.2), and may include a second NVLink request comprising Address(AS.4.1) and Tag/TransactionID(c.4.1). The RPU may translate the second NVLink request to a CXL.mem M2S request comprising MemRd* and translated Address(AS.1.2), wherein the RPU may send the translated request to the second memory (Memory.2) via the CXL RP. *Data.2* is retrieved from the second memory utilizing a CXL.mem S2M DRS, and sent to the RPU via the CXL RP, wherein the RPU may send *Data.2* to the entity via the second NVLink response.

In computing systems where NVLink-attached entities, such as accelerators/GPUs, require access to memory resources managed by a processor, an RPU may translate between NVLink-based traffic and CXL.cache traffic. The RPU may utilize CXL.cache as an intermediate protocol for reaching the processor's coherent interconnect, by presenting itself to a CXL host as a CXL endpoint and issuing CXL.cache D2H requests. The CXL host, which may be a CXL root port or another CXL-capable entity, may process the D2H requests and return data via CXL.cache H2D responses. The RPU may perform address translations between NVLink address spaces (such as GPU physical addresses or NVLink network addresses) and address spaces utilized by the CXL host (such as Host Physical Addresses), as well as Tag translations between NVLink Tags and CXL.cache CQIDs. In some examples, the RPU may split an NVLink-based request to multiple CXL.cache D2H requests when the requested data payload exceeds a cacheline size.

In various implementations, a method comprising: receiving, by a resource provisioning unit (RPU) from a first entity via an NVLink interface that communicates according to an NVLink-based protocol, an NVLink-based request comprising a first physical address; translating, by the RPU, the NVLink-based request to a CXL.cache Device-to-Host (D2H) request comprising an opcode and a second physical address, wherein CXL denotes Compute Express Link; sending, by the RPU, the CXL.cache D2H request to a second entity; receiving, by the RPU from the second entity, a CXL.cache Host-to-Device (H2D) response comprising data accessed via the second physical address; and sending, by the RPU, an NVLink-based response comprising the data to the first entity. The RPU may receive NVLink-based requests from various types of NVLink-attached entities, such as GPUs, accelerators, or NVLink switches, and may translate these requests to CXL.cache D2H requests directed at a CXL host. The second entity may include a CXL root port of a processor, a CXL switch, or another entity that processes CXL.cache D2H requests and returns CXL.cache H2D responses. The opcode in the CXL.cache D2H request may be selected based on the type of NVLink-based request, the caching policy of the RPU, and the coherency requirements of the access. The CXL.cache H2D response may include a Global Observation (GO) indication along with data, or may include data delivered via an H2D Data message. The RPU may aggregate data from one or more H2D responses or H2D Data messages before sending the NVLink-based response to the first entity.

In some implementations of the method, the second entity comprises a CXL root port (RP) coupled to a coherent interconnect of a processor, and the data is retrieved via the coherent interconnect from at least one of: a cache of the processor, a memory controller coupled to memory, or a CXL memory expander. The cache may include an LLC. The memory may include DRAM coupled to the memory controller via memory channels. The CXL memory expander may be coupled to a separate CXL port of the processor. The coherent interconnect may route the request to the appropriate resource based on address decoding.

In some implementations of the method, the CXL RP is coupled to the coherent interconnect via an interconnect interface, and the coherent interconnect utilizes a protocol selected from at least one of: ARM CHI, Intel UPI, or AMD Infinity Fabric. The interconnect interface may be a Ring-to-CXL (R2CXL) interface or a mesh-to-CXL interface that translates between the CXL protocol domain and the coherent interconnect protocol domain.

In some implementations of the method, the translating comprises translating an NVLink Tag carried in the NVLink-based request to a command queue identifier (CQID) carried in the CXL.cache D2H request, and maintaining a mapping between the NVLink Tag and the CQID for correlating the CXL.cache H2D response with the NVLink-based response. The mapping may be maintained in a translation table or tracker. The CQID may identify the RPU's tracker entry for the transaction. Upon receiving an H2D response carrying the CQID, the RPU may look up the corresponding NVLink Tag to route the response to the originating entity.

In some implementations of the method, the translating comprises translating the NVLink-based request to CXL.cache D2H requests when the NVLink-based request specifies a data payload larger than a cacheline, and wherein each of the CXL.cache D2H requests comprises an opcode selected from RdOwn or RdShared. NVLink-based requests may specify data payloads of up to 256 bytes, while CXL.cache D2H requests may operate on cacheline granularity, such as 64 bytes. The RPU may split an NVLink-based request to multiple D2H requests with consecutive addresses. RdOwn or RdShared may be selected based on the caching policy of the RPU.

In some implementations of the method, the translating comprises translating the first physical address from a GPU physical address or an NVLink network address to a Host Physical Address (HPA) carried as the second physical address in the CXL.cache D2H request. The address translation may be implemented utilizing address range registers, translation tables, page tables, or algorithmic mappings. The GPU physical address or NVLink network address may be utilized by the NVLink-attached entity for routing within the NVLink domain, while the HPA may be utilized by the CXL host for accessing memory resources.

In some implementations of the method, the RPU, the NVLink interface, and a CXL device are implemented in a chiplet within an integrated circuit (IC) package of a processor, and the second entity comprises a CXL root port (RP) of the processor. The chiplet may be an NVLink chiplet, or NVLink Fusion, coupled to other dies within the IC package via a chip-to-chip (C2C) interface, such as UCIe or NVLink-C2C. The CXL device may present as a CXL EP to the CXL RP of the processor.

In some implementations of the method, the RPU presents as a CXL endpoint (CXL EP) to the second entity, the CXL EP comprising a Type-1 CXL device or a Type-2 CXL device, and wherein the opcode of the CXL.cache D2H request comprises RdCurr. A Type-1 CXL device may support CXL.io and CXL.cache, enabling the RPU to issue D2H requests and receive H2D responses from the second entity. A Type-2 CXL device may additionally support CXL.mem, enabling the second entity to also access memory resources of the RPU via M2S requests in addition to cache coherency operations. The selection between Type-1 and Type-2 may depend on whether the RPU exposes memory resources to the second entity beyond cache coherency functionality.

In some implementations of the method, the opcode of the CXL.cache D2H request comprises RdCurr, and the data received via the CXL.cache H2D response is forwarded to the first entity without being cached by the RPU, whereby the RPU provides I/O-coherent access to resources accessible via the second entity. I/O-coherent access may be suitable for streaming or peer data transfers where cacheline residency at the RPU is not required and snoop filter overhead at the second entity is to be avoided. The RPU may forward data directly to the first entity upon receipt, without allocating cache entries, maintaining coherency state, or participating in snoop exchanges beyond those inherent to the RdCurr transaction.

In some implementations of the method, the RPU comprises a cache, the opcode of the CXL.cache D2H request is selected from RdOwn, RdShared, or RdAny, and the data received via the CXL.cache H2D response is stored in the cache of the RPU; and further comprising receiving, by the RPU from the second entity, a CXL.cache H2D request comprising a snoop opcode targeting a cacheline stored in the cache, and sending, by the RPU, a CXL.cache D2H response to the second entity. The RPU cache may reduce cross-protocol round trips by serving subsequent requests from cached data. RdOwn may request exclusive ownership, RdShared may request shared state, and RdAny may allow the host to determine the state. The snoop opcode may include SnpData, SnpInv, or SnpCur. The D2H response may include RspIHitI, RsplHitSE, RspSHitSE, RspVHitV, RspSFwdM, RspIFwdM, or RspVFwdV based on the cache state and the snoop type. When the D2H response includes a data-forwarding opcode such as RspSFwdM, RspIFwdM, or RspVFwdV, the RPU may also send a CXL.cache D2H Data comprising the cached data.

In some implementations of the method, a non-transitory computer-readable medium comprising instructions which, when executed by a processor, cause the processor to perform the method. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

The following system may include a processor with a CXL root port coupled to a coherent interconnect, and an RPU comprising an NVLink interface and a CXL EP. The RPU may translate between NVLink-based requests and CXL.cache D2H requests, enabling NVLink-attached entities to access processor memory resources via the coherent interconnect. The CXL EP may present the RPU to the CXL RP as a CXL device, such as a Type-1 or Type-2 CXL device. The processor may include processing cores, caches, and memory controllers coupled to the coherent interconnect. In some examples, the RPU and NVLink interface may reside on a separate silicon die or chiplet within the processor's IC package.

In various implementations, a system comprising: a processor comprising a Compute Express Link (CXL) root port (RP), a coherent interconnect, and memory controllers; wherein the memory controllers are coupled to the coherent interconnect and coupled to memory; a resource provisioning unit (RPU) comprising: an NVLink interface configured to communicate with an entity according to an NVLink-based protocol, and a CXL endpoint (CXL EP) coupled to the CXL RP; and wherein the RPU is configured to translate between NVLink-based requests received via the NVLink interface and CXL.cache Device-to-Host (D2H) requests sent to the CXL RP, to enable the entity to access memory resources via the coherent interconnect. The system may be implemented as a monolithic processor die, as chiplets within an IC package, or as components on a board. The CXL RP may process the CXL.cache D2H requests and access memory resources via the coherent interconnect, such as from DRAM coupled to the memory controllers, from a cache of the processor, or from a CXL memory expander coupled to a separate CXL port. The RPU may perform address translations between NVLink address spaces and Host Physical Addresses, Tag translations between NVLink Tags and CXL.cache CQIDs, and opcode translations between NVLink request types and CXL.cache D2H opcodes. The entity may include a GPU, an accelerator, or an NVLink switch.

In some implementations of the system, the CXL EP comprises a Type-1 CXL device or a Type-2 CXL device, and the coherent interconnect utilizes a protocol selected from at least one of: ARM CHI, Intel UPI, or AMD Infinity Fabric. A Type-1 CXL device may support CXL.io and CXL.cache. A Type-2 CXL device may additionally support CXL.mem. The coherent interconnect protocol may determine how the CXL RP communicates with processing cores, caches, and memory controllers within the processor.

In some implementations, the system further comprises processing cores and a last level cache (LLC) coupled to the coherent interconnect, and wherein the CXL RP is coupled to the coherent interconnect via an interconnect interface. The interconnect interface may be a Ring-to-CXL (R2CXL) interface or a mesh-to-CXL interface. The processing cores and LLC may be implemented as distributed slices coupled to the coherent interconnect. The CXL.cache D2H requests from the RPU may be served by the LLC on a cache hit, avoiding access to DRAM.

In some implementations of the system, the RPU, the NVLink interface, and the CXL EP are on a first silicon die, and the CXL RP and the coherent interconnect are on a second silicon die, the first and second silicon dies within an IC package. The first silicon die may be an NVLink chiplet, such as NVLink Fusion, coupled to the second silicon die via a chip-to-chip (C2C) interface, such as UCIe or NVLink-C2C.

In some implementations of the system, the RPU is further configured to translate CXL.cache Host-to-Device (H2D) requests received from the CXL RP to NVLink-based requests sent to the entity via the NVLink interface, enabling the processor to access resources of the entity. The translation may enable the processor's cores to access memory or resources coupled to the NVLink-attached entity, such as GPU memory. The RPU may maintain separate translation contexts for inbound (NVLink-to-CXL.cache) and outbound (CXL.cache-to-NVLink) traffic.

In some implementations, a computer may translate CXL.cache H2D requests, such as snoops, to NVLink-based requests targeting NVLink-attached entities. This translation may enable a CXL host, such as a processor, to access resources coupled to NVLink-attached entities, such as GPU memory or accelerator memory, by issuing CXL.cache H2D requests that the computer translates to NVLink-based requests. The computer may translate UQTDs carried in H2D requests to NVLink Tags, perform address translations between Host Physical Addresses and NVLink or GPU physical addresses, and generate CXL.cache D2H response and D2H Data messages from NVLink-based responses. The computer may be implemented in a switch, a bridge, a semiconductor device, a chiplet, or an active cable.

In various implementations, a method comprising: receiving, by a computer from a first entity, a CXL.cache Host-to-Device (H2D) request comprising an opcode and a first address, wherein CXL denotes Compute Express Link; translating, by the computer, the CXL.cache H2D request to an NVLink-based request comprising a second physical address; sending, by the computer via an NVLink interface that communicates according to an NVLink-based protocol, the NVLink-based request to a second entity; receiving, by the computer from the second entity, an NVLink-based response; and translating, by the computer, the NVLink-based response to one or more CXL.cache Device-to-Host (D2H) messages, and sending the one or more CXL.cache D2H messages to the first entity. The first entity may be a CXL host, such as a processor comprising a CXL root port, or another entity that issues CXL.cache H2D requests. The second entity may be a GPU, an accelerator, or an NVLink switch that processes NVLink-based requests and returns NVLink-based responses. The opcode in the H2D request may include a snoop opcode, such as SnpData, SnpInv, or SnpCur, and the computer may generate an appropriate NVLink-based request type based on the snoop intent. The one or more CXL.cache D2H messages may include a CXL.cache D2H response, a CXL.cache D2H Data, or both, depending on whether data return is indicated by the snoop type and the NVLink-based response.

In some implementations of the method, the translating of the CXL.cache H2D request comprises translating a Unique Queue ID (UQID) carried in the CXL.cache H2D request to an NVLink Tag carried in the NVLink-based request, and maintaining a mapping between the UQID and the NVLink Tag for correlating the NVLink-based response with the one or more CXL.cache D2H messages. The UQID may identify the host entry that originated the H2D request. Upon receiving the NVLink-based response, the computer may look up the mapping to recover the UQID for inclusion in the D2H response and D2H Data messages.

In some implementations of the method, the opcode of the CXL.cache H2D request comprises a snoop opcode selected from SnpData, SnpInv, or SnpCur, the NVLink-based request comprises a read or invalidation request type corresponding to the snoop opcode, the first entity comprises a CXL host, and the second entity comprises a GPU, an NVLink switch, or an accelerator. SnpData may be translated to an NVLink read with data return. SnpInv may be translated to an NVLink invalidation or read for exclusive ownership. SnpCur may be translated to an NVLink read without cache state change. The NVLink request type may be selected based on the snoop intent.

In some implementations of the method, the NVLink-based response comprises data, and the one or more CXL.cache D2H messages comprise a CXL.cache D2H response comprising a snoop response opcode and a Unique Queue ID (UQID), and a CXL.cache D2H Data comprising the data and the UQID. The snoop response opcode may include RspSFwdM, RspIFwdM, or RspVFwdV, indicating data forwarding with the corresponding cache state transition. The UQID in both the D2H response and D2H Data may be reflected from the H2D request to enable the first entity to correlate the response with the originating snoop.

In some implementations, the method further comprises issuing, by the computer via the NVLink interface, additional NVLink-based requests to the second entity as prefetch requests based on a detected access pattern of CXL.cache H2D requests received from the first entity. The computer may detect sequential, strided, or other access patterns from the addresses in the H2D requests and may issue speculative NVLink-based requests to reduce latency for subsequent H2D requests. Prefetched data may be stored in a local buffer or cache of the computer.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface communicating according to CXL.cache with a first entity and a second interface communicating according to an NVLink-based protocol with a second entity, with a computer coupled between the two interfaces. The computer may translate CXL.cache H2D requests to NVLink-based requests and NVLink-based responses to CXL.cache D2H messages, enabling the first entity to access resources of the second entity across the protocol boundary. The computer may be included in a switch, a bridge, or a standalone semiconductor device, and may further support bidirectional translation.

In various implementations, a system comprising: a first interface configured to communicate according to CXL.cache with a first entity, wherein CXL denotes Compute Express Link; a second interface configured to communicate according to an NVLink-based protocol with a second entity; and a computer coupled between the first and second interfaces, configured to translate CXL.cache Host-to-Device (H2D) requests received via the first interface to NVLink-based requests transmitted via the second interface, and to translate NVLink-based responses received via the second interface to CXL.cache Device-to-Host (D2H) messages transmitted via the first interface. The first entity may be a CXL host, such as a processor, and the second entity may be a GPU, an accelerator, or an NVLink switch. The computer may perform address translations, transaction identifier translations, and opcode translations between the CXL.cache and NVLink protocol domains. The CXL.cache D2H messages may include D2H responses, D2H Data, or both. The system may be implemented in an IC package, on a PCB, or integrated into a cable form factor.

In some implementations of the system, the CXL.cache D2H messages comprise a CXL.cache D2H response comprising an opcode selected from RspSFwdM, RspIFwdM, or RspVFwdV, and a CXL.cache D2H Data comprising data sourced from a memory or a cache of the second entity. The selection of the D2H response opcode may depend on the snoop type in the H2D request and the data returned by the second entity. The memory of the second entity may include HBM, HBF, or DRAM. The cache of the second entity may include an L2 cache or an LLC of a GPU or accelerator.

In some implementations of the system, the computer is configured to translate Host Physical Addresses (HPAs) carried in the CXL.cache H2D requests to NVLink network addresses or GPU physical addresses carried in the NVLink-based requests. The address translation may be implemented utilizing address range registers, translation tables, or algorithmic mappings. HPAs may be utilized by the first entity, such as a processor, and NVLink network addresses or GPU physical addresses may be utilized for routing within the NVLink domain.

In some implementations of the system, the computer is included in a switch or a bridge, and the computer is further configured to translate NVLink-based requests received via the second interface to CXL.cache D2H requests transmitted via the first interface, enabling the second entity to access resources coupled to the first entity. The translation may enable both the first entity to access resources of the second entity and the second entity to access resources of the first entity through the same switch or bridge. The switch may be an NVLink switch or a CXL switch.

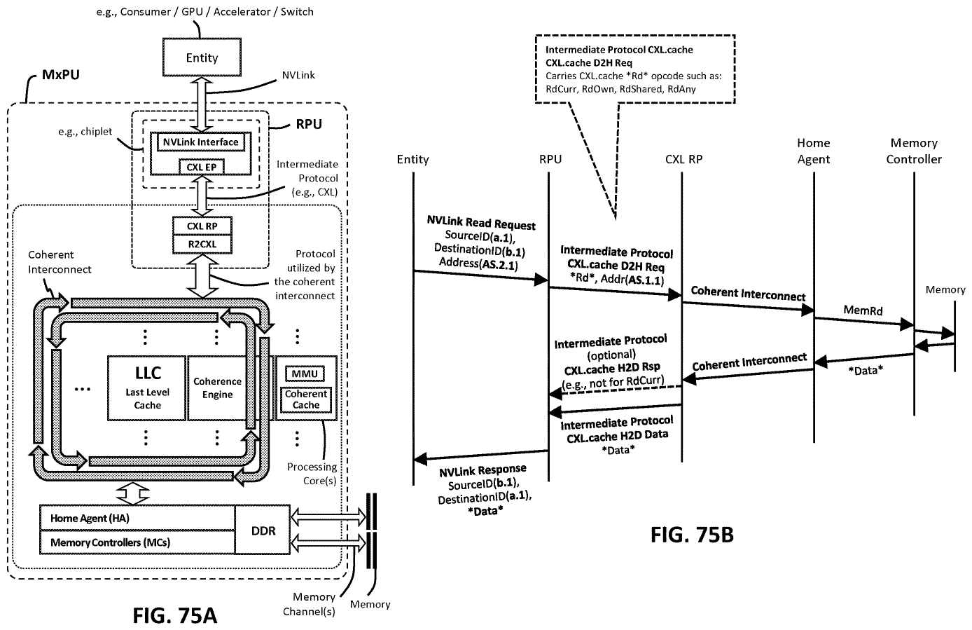

FIG. 75A illustrates an example of a system comprising a processor (such as an MxPU) comprising processing cores, LLC, a CXL RP, and memory controllers coupled via memory channels to memory, such as DRAM. The processor may include a coherent interconnect, such as a ring or mesh interconnect. The coherent interconnect may couple the processing cores, the LLC, and the memory controllers, and may further couple a coherence engine. The processing cores may each include an MMU and a coherent cache. The CXL RP may be coupled to the coherent interconnect via a Ring-to-CXL (R2CXL) interconnect interface that may communicate with the coherent interconnect according to a protocol utilized by the coherent interconnect, such as ARM CHI, Intel UPI, or AMD Infinity Fabric. A Home Agent (HA) may be coupled to the memory controllers, and the memory controllers may communicate with the memory via DDR memory channels.

An RPU, which may be included in the processor, may perform physical address translations that may enable an entity, such as a GPU, an accelerator, or a switch, to access the memory. The processor may expose to the entity, optionally via the RPU, an NVLink interface that may communicate with the entity according to an NVLink-based protocol. The RPU may further perform translations, such as from NVLink to a protocol utilized by the coherent interconnect, wherein the RPU may utilize an intermediate protocol, such as CXL (e.g., CXL.cache), to provide the translations. The RPU may expose to the processor, via the CXL RP, a CXL device utilizing a CXL endpoint (CXL EP), such as a Type-1 CXL device or a Type-2 CXL device. The R2CXL interconnect interface, that may reside in the RPU or between the RPU and the coherent interconnect, may couple the CXL RP to the coherent interconnect and complete the translation path from NVLink, via the intermediate protocol, to traffic based on the protocol utilized by the coherent interconnect. In some examples, the RPU, the NVLink interface, and the CXL device (e.g., CXL EP) may be implemented in a chiplet, such as an NVLink chiplet or NVLink Fusion, inside an IC package of the processor. In other examples, the RPU, the NVLink interface, and the CXL device may be implemented as functional blocks on the same die with the CXL RP of the processor, or split between silicon dies or chiplets inside the IC package of the processor.

FIG. 75B illustrates an example of a TFD demonstrating an NVLink read request received from an entity (such as a consumer, GPU, accelerator, or a switch), wherein the RPU may translate the NVLink read request to traffic conforming to a protocol utilized by the processor's coherent interconnect, utilizing CXL.cache as an intermediate protocol. The entity may send an NVLink request, such as an NVLink read request, comprising SourceID(a.1), DestinationID(b.1), and Address(AS.2.1), to the RPU. The RPU may translate the physical address (AS.2.1) carried in the NVLink request to a physical address (AS.1.1) utilized for accessing the memory. The RPU may perform further translations, such as opcode translations and Tag translations, e.g., translating from NVLink Tags to CXL.cache CQIDs. The RPU may generate a CXL.cache D2H request carrying the translated address (AS.1.1) and a CXL.cache read opcode (*Rd*) which indicates that the CXL.cache D2H request may carry an opcode such as RdCurr, RdOwn, RdShared, or RdAny. The CXL.cache D2H request is sent to the CXL RP for further processing. The CXL RP may communicate with a Home Agent via the coherent interconnect, and the Home Agent may issue a MemRd to a memory controller to retrieve data (*Data*) from the memory. The data may return over the coherent interconnect to the CXL RP, which may send an optional CXL.cache H2D response (when the opcode is not RdCurr) and a CXL.cache H2D Data comprising *Data* to the RPU. The RPU may then send an NVLink response comprising SourceID(b.1), DestinationID(a.1), and *Data* to the requesting entity. In some examples, the data may be provided by an LLC of the processor over the coherent interconnect, instead of by the memory via the memory controller.

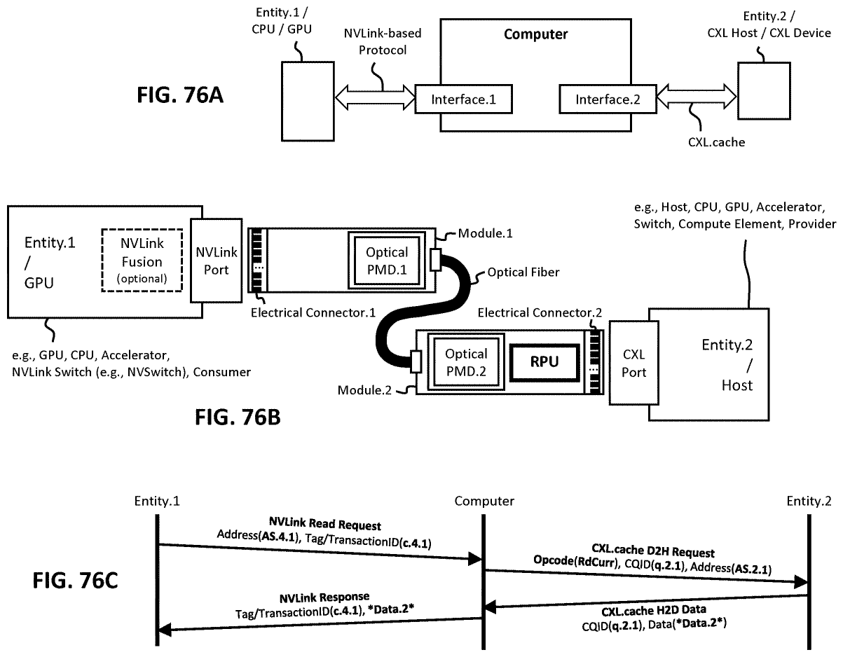

FIG. 76A illustrates an example of a system comprising a computer coupled between a first interface (Interface.1) communicating according to an NVLink-based protocol with a first entity (Entity.1), and a second interface (Interface.2) communicating according to CXL.cache with a second entity (Entity.2). The first entity may be a CPU or a GPU. The second entity may be a CXL host or a CXL device. The computer may extract addresses from requests received via either the first interface or the second interface, translate the addresses, and generate requests carrying the translated addresses for transmission via the other interface. In one direction, the computer may translate NVLink-based requests from the first entity to CXL.cache requests sent to the second entity. In the other direction, the computer may translate CXL.cache requests from the second entity to NVLink-based requests sent to the first entity. The addresses carried in NVLink-based requests may refer to a first address space, such as an NVLink-based address space, an NVLink-based network address space, or a GPU address space utilized by the first entity. The translated addresses carried in CXL.cache requests may refer to a second address space utilized by the second entity, such as a Host Physical Address (HPA) space.

FIG. 76B illustrates an example of a cable comprising an NVLink port and a CXL port, with an RPU integrated into the cable. The cable couples a first entity (Entity.1), such as a GPU, CPU, accelerator, NVLink switch (e.g., NVSwitch), or consumer, to a second entity (Entity.2), such as a host, CPU, GPU, accelerator, switch, compute element, or provider. The first entity may include an NVLink Fusion chiplet or IP block (optional) coupled to an NVLink port. The second entity may include a CXL port. The cable may include a first module (Module.1) including an optical physical medium dependent (Optical PMD.1) sublayer, and a second module (Module.2) including an optical physical medium dependent (Optical PMD.2) sublayer and an RPU. The first module may be coupled to the first entity via a first electrical connector (Electrical Connector.1) and the second module may be coupled to the second entity via a second electrical connector (Electrical Connector.2). An optical fiber may couple the first module to the second module. The RPU may translate between messages conforming to the NVLink-based protocol utilized by the first entity and messages conforming to CXL.cache utilized by the second entity. In the illustrated example, the RPU is placed in Module.2 closer to the CXL port. CXL, which runs over PCIe electricals, is designed as a shorter-reach interface, while some versions of NVLink incorporate electrical signaling characteristics designed for longer-reach interconnects. Placing the RPU closer to the CXL port may improve signal integrity and may allow for reducing the number of optical fibers or copper wires between the modules, since NVLink may utilize a higher signaling rate than CXL and therefore may require fewer lanes for the same bandwidth.

FIG. 76C illustrates an example of a TFD demonstrating translations performed by a computer between NVLink-based requests and CXL.cache requests. A first entity (Entity.1), which may be a CPU or a GPU, may initiate an NVLink request, such as an NVLink read request, comprising Address(AS.4.1) and Tag/TransactionID(c.4.1). The, wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.cache D2H request comprising Opcode(RdCurr), CQID(q.2.1), and Address(AS.2.1), and may send the CXL.cache D2H request to a second entity (Entity.2), which may be a CXL host. The computer may translate the physical address (AS.4.1) carried in the NVLink request to a physical address (AS.2.1) carried in the CXL.cache D2H request, and may translate the NVLink Tag/TransactionID(c.4.1) to a CXL.cache CQID(q.2.1). Upon receiving one or more responses from the second entity, which may include a CXL.cache H2D Data comprising CQID(q.2.1) and Data(*Data.2*), the computer may translate the one or more responses to an NVLink response comprising Tag/TransactionID(c.4.1) and *Data.2*, and send the NVLink response to the first entity. In some examples, the computer may issue multiple CXL.cache D2H requests in response to receiving an NVLink request from the first entity, such as when splitting an NVLink request for a large block of data (e.g., 256 bytes) to smaller CXL.cache D2H requests (e.g., 64 bytes each), or when prefetching data from the second entity utilizing CXL.cache reads.

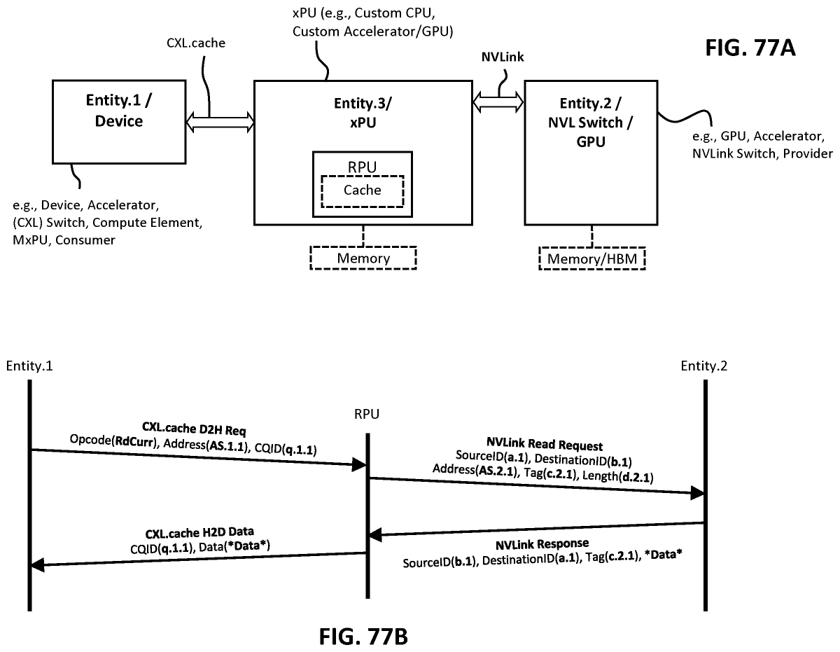

FIG. 77A illustrates an example of a system comprising an xPU (Entity.3), such as a custom CPU or a custom accelerator/GPU, coupled between a first entity (Entity.1) via CXL.cache and a second entity (Entity.2) via NVLink. Entity.1 may be a device, an accelerator, a CXL switch, a compute element, an MxPU, or a consumer. Entity.2 may be a GPU, an accelerator, an NVLink switch, or a provider. The xPU may include an RPU with an optional cache and an optional memory coupled to the RPU. The RPU may translate CXL.cache D2H requests received from Entity.1 to NVLink read requests sent to Entity.2, and may translate NVLink responses to CXL.cache H2D messages returned to Entity.1. Entity.2 may include Memory/HBM accessible via NVLink.

FIG. 77B illustrates an example of a TFD demonstrating translation of a CXL.cache D2H request to an NVLink read request. Entity.1 sends a CXL.cache D2H Req comprising Opcode(RdCurr), Address(AS.1.1), and CQID(q.1.1) to the RPU. The RPU translates the D2H request to an NVLink Read Request comprising SourceID(a.1), DestinationID(b.1), Address(AS.2.1), Tag(c.2.1), and Length(d.2.1), and sends the NVLink Read Request to Entity.2. Entity.2 returns an NVLink Response comprising SourceID(b.1), DestinationID(a.1), Tag(c.2.1), and *Data*. The RPU translates the NVLink Response to a CXL.cache H2D Data comprising CQID(q.1.1) and Data(*Data*), and sends the H2D Data to Entity.1. Because the opcode is RdCurr, no CXL.cache H2D Response (GO) is sent.

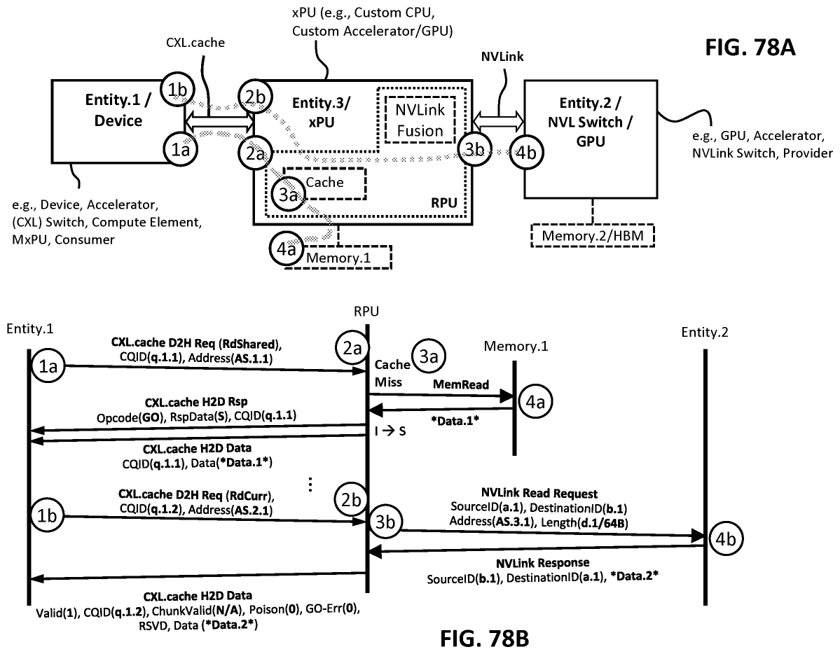

FIG. 78A illustrates an example of a system comprising an xPU (Entity.3), such as a custom CPU or a custom accelerator/GPU, coupled between Entity.1 via CXL.cache and Entity.2 via NVLink. The xPU may include an optional NVLink Fusion chiplet, an RPU with a cache, and a local memory (Memory.1). Entity.1 may be a device, an accelerator, a CXL switch, a compute element, an MxPU, or a consumer. Entity.2 may be a GPU, an accelerator, an NVLink switch, or a provider. Entity.2 may include Memory.2/HBM. The figure illustrates two access paths for CXL.cache D2H requests from Entity.1. A first path (1a, 2a, 3a, 4a) routes a D2H request from Entity.1 to the RPU, through the cache, and to Memory.1 of the xPU. A second path (1b, 2b, 3b, 4b) routes a D2H request from Entity.1 to the RPU, through NVLink, to Entity.2 and its Memory.2/HBM.

FIG. 78B illustrates an example of a TFD demonstrating two CXL.cache D2H request flows processed by an RPU with a cache. In a first flow, Entity.1 sends a CXL.cache D2H Req comprising Opcode(RdShared), CQID(q.1.1), and Address(AS.1.1) to the RPU (step 1a). The RPU performs a cache lookup (step 2a), which results in a cache miss. The RPU issues a MemRead to Memory.1 (step 3a), and Memory.1 returns *Data.1* (step 4a). The RPU stores *Data.1* in the cache and transitions the cache state from Invalid (I) to Shared (S). The RPU sends to Entity.1 a CXL.cache H2D Rsp comprising Opcode(GO) with RspData indicating Shared state and CQID(q.1.1), followed by a CXL.cache H2D Data comprising CQID(q.1.1) and Data(*Data.1*). In a second flow, Entity.1 sends a CXL.cache D2H Req comprising Opcode(RdCurr), CQID(q.1.2), and Address(AS.2.1) to the RPU (step 1b). The RPU translates the D2H request to an NVLink Read Request comprising SourceID(a.1), DestinationID(b.1), Address(AS.3.1), and Length(d. 1/64B), and sends the NVLink Read Request to Entity.2 (steps 2b, 3b). Entity.2 returns an NVLink Response comprising SourceID(b.1), DestinationID(a.1), and *Data.2* (step 4b). The RPU translates the NVLink Response to a CXL.cache H2D Data comprising Valid(1), CQID(q.1.2), ChunkValid(N/A), Poison(0), GO-Err(0), RSVD, and Data(*Data.2*), and sends the H2D Data to Entity.1. Because the opcode is RdCurr, no CXL.cache H2D Response (GO) is sent, and the data is not cached by the RPU.

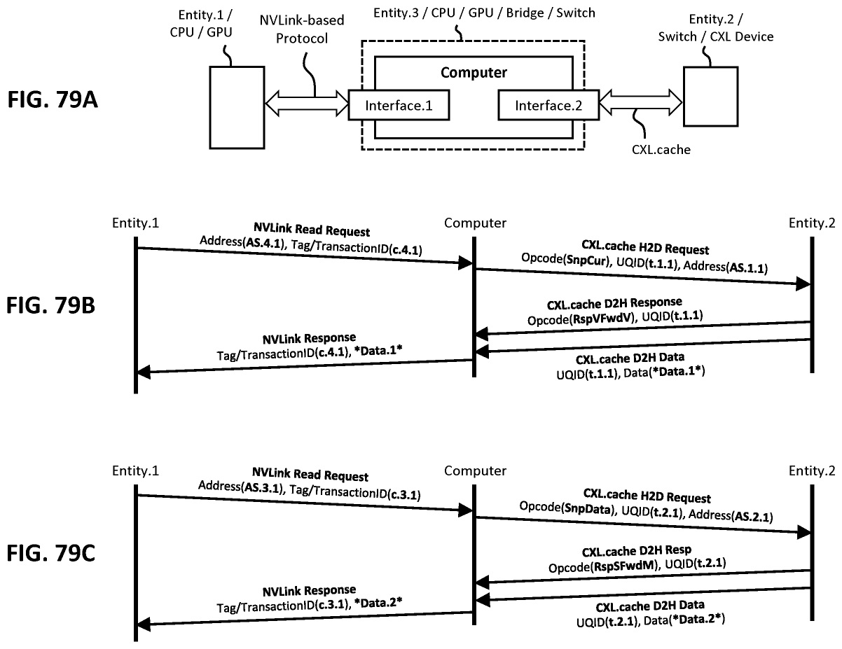

FIG. 79A illustrates an example of a system comprising a computer (Entity.3), such as a CPU, GPU, bridge, or switch, coupled between a first entity (Entity.1) via an NVLink-based protocol and a second entity (Entity.2) via CXL.cache. Entity.1 may be a CPU or a GPU. Entity.2 may be a switch or a CXL device. The computer may include a first interface (Interface.1) communicating according to the NVLink-based protocol and a second interface (Interface.2) communicating according to CXL.cache. The computer may translate NVLink read requests received from Entity.1 to CXL.cache H2D requests sent to Entity.2, and may translate CXL.cache D2H messages received from Entity.2 to NVLink responses sent to Entity.1.

FIG. 79B illustrates an example of a TFD demonstrating translation of an NVLink read request to a CXL.cache H2D request comprising SnpCur. Entity.1 sends an NVLink Read Request comprising Address(AS.4.1) and Tag/TransactionID(c.4.1) to the computer. The computer translates the NVLink Read Request to a CXL.cache H2D request comprising Opcode(SnpCur), UQID(t.1.1), and Address(AS.1.1), and sends the H2D request to Entity.2. Entity.2 returns a CXL.cache D2H Response comprising Opcode(RspVFwdV) and UQID(t.1.1), and a CXL.cache D2H Data comprising UQID(t.1.1) and Data(*Data.1*). The computer translates the D2H messages to an NVLink Response comprising Tag/TransactionID(c.4.1) and *Data.1*, and sends the NVLink Response to Entity.1. RspVFwdV indicates that the data is returned without changing cache state at Entity.2.

FIG. 79C illustrates an example of a TFD demonstrating translation of an NVLink read request to a CXL.cache H2D request comprising SnpData. Entity.1 sends an NVLink Read Request comprising Address(AS.3.1) and Tag/TransactionID(c.3.1) to the computer. The computer translates the NVLink Read Request to a CXL.cache H2D request comprising Opcode(SnpData), UQID(t.2.1), and Address(AS.2.1), and sends the H2D request to Entity.2. Entity.2 returns a CXL.cache D2H Resp comprising Opcode(RspSFwdM) and UQID(t.2.1), and a CXL.cache D2H Data comprising UQID(t.2.1) and Data(*Data.2*). The computer translates the D2H messages to an NVLink Response comprising Tag/TransactionID(c.3.1) and *Data.2*, and sends the NVLink Response to Entity.1. RspSFwdM indicates that the cacheline was in Modified state at Entity.2 and has been downgraded to Shared state, with the data forwarded.

In heterogeneous computing architectures, NVLink-based entities such as GPUs, accelerators, and NVLink switches may need to access resources coupled to CXL-based entities such as CXL hosts, CXL devices, CXL switches, or CXL-attached memory pools. NVLink-based protocols and CXL.io utilize different message formats, addressing schemes, and transaction semantics. NVLink-based requests may carry NVLink-based network addresses or GPU physical addresses within a first address space, while CXL.io requests may carry Host Physical Addresses (HPAs) within a second address space. A computer, which may be implemented as a processor, a switch, an RPU, a semiconductor device, a chiplet, an active cable, or other suitable device, may be positioned between an NVLink-based interface and a CXL.io interface to translate between these incompatible protocol domains. The computer may translate addresses, Tags, opcodes, and other fields, and may propagate QoS telemetry information carried in CDL fields of CXL.io UIO completions. The translation may be performed in one direction from NVLink to CXL.io, in the reverse direction from CXL.io to NVLink, or bidirectionally. In the reverse direction, the computer may generate CDL values in CXL.io UIO completions based on load or congestion information observed at the NVLink domain, even when the NVLink-based protocol does not natively carry CDL. Such CDL generation by a host-side entity may extend QoS telemetry capabilities beyond what CXL specifications define for CXL devices alone.

In various implementations, a method comprising: receiving, by a computer from a first entity via a first interface, an NVLink-based request comprising a first physical address; translating, by the computer, the NVLink-based request to a CXL.io request comprising a read-class Transaction Layer Packet (TLP) type and a second physical address, wherein CXL denotes Compute Express Link; sending, by the computer via a second interface, the CXL.io request to a second entity; receiving, by the computer from the second entity, a CXL.io completion comprising data and a Tag; translating, by the computer, the CXL.io completion to an NVLink-based response; and sending the NVLink-based response comprising the data to the first entity. The method may enable an NVLink-based entity, such as a GPU, an accelerator, or an NVLink switch, to access resources coupled to a CXL-based entity, such as a CXL host, a CXL device, a CXL switch, or a CXL-attached memory pool, by translating NVLink-based requests to CXL.io requests and translating CXL.io completions to NVLink-based responses. The computer may be a processor, a switch, an RPU, an active cable, or a semiconductor device positioned between the first entity and the second entity. The first interface may communicate according to an NVLink-based protocol, and the second interface may communicate according to CXL.io. The NVLink-based request may be an NVLink read request comprising fields such as SourceID, DestinationID, Address, Tag, and Length. The computer may translate the NVLink-based request to a CXL.io request comprising a read-class TLP type, which may be either a standard Memory Read (MRd) or a UIO Memory Read (UIOMRd). The CXL.io completion may be a CpID or a UIORdCpID, and may carry a CDL field when the UIO path is utilized. The computer may translate the data and Tag from the CXL.io completion into the NVLink-based response, reconstructing the NVLink response fields such as SourceID, DestinationID, and Tag for delivery to the first entity. In some examples, the computer may issue one or more CXL.io requests in response to an NVLink-based request, such as when splitting a large NVLink read into smaller CXL.io reads, or when prefetching data from the second entity into a cache coupled to the computer.

In some implementations of the method, the CXL.io request comprises a CXL.io Unordered Input/Output (UIO) Memory Read (UIOMRd) request, and the CXL.io completion comprises a CXL.io UIO Read Completion with Data (UIORdCpID). UIO may be utilized when the path between the computer and the second entity supports Flit Mode and has UIO enabled. The UIOMRd may provide multi-path routing and out-of-order completion delivery capabilities. The UIORdCpID may include a CDL that carries QoS telemetry populated by the second entity or intermediate components.

In some implementations of the method, the CXL.io UIORdCpID comprises a CXL DevLoad (CDL) field, and wherein the computer performs at least one of: (i) translating information carried in the CDL to one or more fields of the NVLink-based response, or (ii) utilizing information carried in the CDL for at least one of throttling subsequent requests to the second entity or collecting Quality-of-Service (QoS) telemetry. The CDL may carry device load indicators such as light load, optimal load, moderate overload, or severe overload encodings. The computer may translate CDL information to reserved fields, vendor-defined fields, or custom fields of the NVLink-based response, or may collect CDL values over time to build a telemetry profile of the second entity. When utilizing CDL for throttling, the computer may reduce or modulate the rate of subsequent CXL.io requests based on the observed loading state.

In some implementations of the method, the CXL.io request comprises a CXL.io Memory Read (MRd) request, and the CXL.io completion comprises a CXL.io Completion with Data (CpID). The standard MRd and CpID types may be utilized when the second entity does not support UIO, when UIO is not enabled along the path, or when the path between the computer and the second entity does not utilize Flit Mode. The CpID does not include a CDL, and the computer may populate any QoS-related fields in the NVLink-based response with locally generated information or default values.

In some implementations of the method, the first physical address refers to an NVLink-based network address or a GPU physical address belonging to a first address space, the second physical address refers to a Host Physical Address (HPA) belonging to a second address space, wherein the NVLink-based request further comprises a first Tag, the computer assigns a second Tag to the CXL.io request, and the computer maintains a mapping between the first Tag and the second Tag to correlate the CXL.io completion with the NVLink-based request. The address translation may be implemented utilizing lookup tables, page tables, base-and-offset calculations, or programmable translation functions. The Tag mapping may be maintained in tracker entries, content-addressable memory, or translation tables. Upon receiving the CXL.io completion comprising the Tag, the computer may look up the corresponding first Tag and include it in the NVLink-based response for proper correlation at the first entity.

In some implementations of the method, the computer translates an NVLink-based request to CXL.io requests, the computer prefetches data from the second entity into a cache coupled to the computer, the first entity comprises at least one of a GPU, an accelerator, or an NVLink switch, and the second entity comprises at least one of a CXL host, a CXL device, or a CXL switch. The computer may split a large NVLink read request, such as a 256-byte read, to smaller CXL.io read requests, such as 64-byte or 128-byte reads, to accommodate differences in maximum payload sizes between the NVLink-based protocol and CXL.io. The computer may additionally prefetch data from addresses adjacent to or following the requested address, storing the prefetched data in the cache for servicing anticipated subsequent requests from the first entity with reduced latency.

In some implementations of the method, the computer translates error indications between the CXL.io completion and the NVLink-based response, comprising translating at least one of a poison indication or a data corruption indication. The poison indication in CXL.io may indicate that the data payload has been corrupted or is otherwise invalid. The computer may translate this indication to a corresponding error indication in the NVLink-based response, enabling the first entity to handle the error accordingly.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system, which may be configured for translation from NVLink-based traffic to CXL.io traffic, may include a semiconductor device, a bridge, a switch, or another apparatus that includes a first interface configured to communicate according to an NVLink-based protocol and a second interface configured to communicate according to CXL.io. A computer coupled between the interfaces may translate physical addresses between a first address space, such as an NVLink-based network address space or a GPU physical address space, and a second address space, such as an HPA space, associated with CXL.io. The computer may additionally translate between NVLink-based requests and other CXL sub-protocols such as CXL.mem or CXL.cache. The system may include optional switches on one or both sides of the computer, and the computer may be implemented in various form factors including a retimer BGA package. Such systems may serve heterogeneous AI computing architectures where NVLink-based accelerators need to access CXL-attached resources including memory expansion devices, coherent memory pools, or host-managed device memory.

In various implementations, a system comprising: a first interface configured to communicate according to an NVLink-based protocol with a first entity; a second interface configured to communicate according to CXL.io with a second entity, wherein CXL denotes Compute Express Link; and a computer coupled between the first and second interfaces, configured to translate between NVLink-based requests received via the first interface and CXL.io requests transmitted via the second interface; wherein the computer is further configured to translate physical addresses between a first address space associated with the NVLink-based protocol and a second address space associated with CXL.io. The system may enable an NVLink-based entity, such as a GPU or an accelerator, to access resources coupled to a CXL-based entity, such as a CXL host, a CXL device, or a CXL-attached memory device, through the translating computer. The first interface may be coupled to the first entity directly or through one or more NVLink switches, and the second interface may be coupled to the second entity directly or through one or more CXL switches. The computer may be implemented as a processor, a switch, an RPU, a semiconductor device, or an active cable. The first address space may include an NVLink-based network address space or a GPU physical address space, and the second address space may include an HPA space. The computer may translate addresses utilizing lookup tables, page tables, base-and-offset calculations, or programmable translation functions. In some examples, the computer may additionally translate between NVLink-based requests and CXL.mem requests or CXL.cache requests, enabling access to different types of CXL-attached resources through the same system.

In some implementations of the system, the computer is further configured to translate between NVLink-based requests and at least one of CXL.mem requests or CXL.cache requests via the second interface; and wherein the NVLink-based requests comprise requests associated with an artificial intelligence (AI) model, comprising at least one of: requests for AI model parameters stored in a CXL-attached memory device accessible via CXL.mem, or requests for AI model data maintained in a cache coherency domain accessible via CXL.cache. The multi-channel CXL translation may enable AI accelerators to access model parameters from CXL-attached memory expansion devices via CXL.mem, while simultaneously accessing coherent data structures via CXL.cache. The computer may select the appropriate CXL sub-protocol based on the address range, transaction type, or memory attributes of each NVLink-based request.

In some implementations of the system, the computer is implemented in an integrated circuit (IC) package having high-speed differential I/O balls positioned according to a ball grid array (BGA) layout defined by a retimer specification. The retimer BGA form factor may enable the computer to be deployed in existing retimer sockets within server platforms, utilizing a standardized physical footprint such as the PCIe 5.0, 6.0, or 7.0 Retimer Supplemental Features and Standard BGA Footprint Specification.

In some implementations of the system, the computer comprises a cache configured to store prefetched data received via the second interface, the prefetched data comprising data associated with an artificial intelligence (AI) model comprising at least one of model weights, activation tensors, or embedding tables, and the computer comprises at least one of a processor, a switch, or a Request Processing Unit (RPU). The cache may store prefetched AI model data to reduce latency for subsequent NVLink-based requests from the first entity. AI model weights, activation tensors, and embedding tables may exhibit predictable sequential access patterns that benefit from prefetching. The RPU, processor, or switch may manage the prefetch scheduling and cache allocation policies.

In some implementations of the system, one or more NVLink switches are positioned between the first interface and the first entity, one or more CXL switches are positioned between the second interface and the second entity, and the first entity comprises an AI accelerator that processes an artificial intelligence (AI) model distributed across AI accelerators coupled via the one or more NVLink switches. The NVLink switches may couple AI accelerators that collectively process a distributed AI model, such as when model parameters or activations are partitioned across accelerators using model parallelism, tensor parallelism, or pipeline parallelism. The CXL switches may couple the second interface to one or more CXL-attached memory devices, memory pools, or hosts that store portions of the AI model data.

In some implementations, translation may be performed from CXL.io traffic to NVLink-based traffic. A first entity, such as a CXL host, may initiate CXL.io read requests targeting resources coupled to a second entity, such as a GPU, that communicates according to an NVLink-based protocol. The computer may translate CXL.io requests to NVLink-based requests and translate NVLink-based responses to CXL.io completions. The computer may determine NVLink routing fields such as SourceID and DestinationID based on routing information, since CXL.io requests do not natively carry NVLink routing fields. Additionally, when translating to CXL.io UIO completions such as UIORdCpID, the computer may populate a CDL field with QoS telemetry information derived from the NVLink domain, from locally observed load or congestion conditions, or from information carried in the NVLink-based response. This CDL generation by a host-side or bridge-side entity extends the telemetry model beyond the CXL specification, which defines CDL population for CXL devices under specific conditions. Such translation may enable CXL hosts to access GPU memory storing AI model data, intermediate computations, or inference results.

In various implementations, a method comprising: receiving, by a computer from a first entity via a first interface, a CXL.io request comprising a read-class Transaction Layer Packet (TLP) type and a first physical address, wherein CXL denotes Compute Express Link; translating, by the computer, the CXL.io request to an NVLink-based request comprising a second physical address; sending, by the computer via a second interface that communicates according to an NVLink-based protocol, the NVLink-based request to a second entity; receiving, by the computer from the second entity, an NVLink-based response comprising data; translating, by the computer, the NVLink-based response to a CXL.io completion comprising the data; and sending the CXL.io completion to the first entity. The method may enable a CXL-based entity, such as a CXL host or a CXL device, to access resources coupled to an NVLink-based entity, such as a GPU, by translating CXL.io requests to NVLink-based requests and translating NVLink-based responses to CXL.io completions. The computer may be a processor, a switch, an RPU, a bridge, an active cable, or a semiconductor device positioned between the first entity and the second entity. The first interface may communicate according to CXL.io, and the second interface may communicate according to an NVLink-based protocol. The CXL.io request may be a CXL.io MRd or a CXL.io UIOMRd, and the CXL.io completion may be a CpID or a UIORdCpID, respectively. The computer may translate the first physical address, which may be an HPA or an address within a CXL address space, to the second physical address, which may be an NVLink-based network address or a GPU physical address. The computer may additionally determine NVLink routing fields such as SourceID and DestinationID for the outgoing NVLink-based request based on routing information, address mapping tables, or configuration maintained by the computer. The NVLink-based response may include fields such as SourceID, DestinationID, Tag, and data, and the computer may translate these to the corresponding CXL.io completion fields. In some examples, the computer may aggregate CXL.io requests into an NVLink-based request, or may prefetch additional data from the second entity into a cache coupled to the computer.

In some implementations of the method, the CXL.io request comprises a CXL.io Unordered Input/Output (UIO) Memory Read (UIOMRd) request, and the CXL.io completion comprises a CXL.io UIO Read Completion with Data (UIORdCpID). The UIO path may be utilized when the first entity supports UIO capabilities and the path between the first entity and the computer has UIO enabled. The UIORdCpID may include a CDL that the computer may populate with telemetry information derived from the NVLink domain.

In some implementations of the method, the computer populates a CXL DevLoad (CDL) field in the CXL.io UIORdCpID with information based on at least one of: load information observed by the computer, congestion information associated with the second entity, or Quality-of-Service (QoS) telemetry derived from the NVLink-based response. The CDL generation by the computer may extend the CXL DevLoad telemetry model to the NVLink domain, where the NVLink-based protocol does not natively carry CDL. The computer may derive load or congestion information from the response latency, queue depth, or other observable characteristics of the second entity. The computer may populate the CDL utilizing the same encoding as defined for CXL devices, such as light load, optimal load, moderate overload, or severe overload, enabling the first entity to make informed scheduling or resource allocation decisions based on conditions at the second entity.

In some implementations of the method, the CXL.io request comprises a CXL.io Memory Read (MRd) request, and the CXL.io completion comprises a CXL.io Completion with Data (CpID). The standard MRd and CpID types may be utilized when the first entity does not support UIO or when UIO is not enabled along the path. The CpID does not include a CDL, and the computer may utilize any QoS or load information internally for traffic management or monitoring rather than propagating it to the first entity.

In some implementations of the method, the CXL.io request further comprises a first Tag, the NVLink-based request further comprises a second Tag assigned by the computer, the computer maintains a mapping between the first Tag and the second Tag, and translating the CXL.io request to the NVLink-based request comprises determining a SourceID and a DestinationID for the NVLink-based request based on routing information maintained by the computer. The computer may assign the second Tag from a pool of available NVLink Tags and store the mapping in a tracker entry. The SourceID and DestinationID may be determined based on routing tables, address range configurations, or forwarding information maintained by the computer, since CXL.io requests do not natively carry NVLink routing fields. Upon receiving the NVLink-based response comprising the second Tag, the computer may retrieve the corresponding first Tag for inclusion in the CXL.io completion.

In some implementations of the method, the computer aggregates CXL.io requests received from the first entity, and translates the aggregated CXL.io requests to an NVLink-based request. The computer may aggregate smaller CXL.io read requests targeting adjacent or contiguous addresses into a larger NVLink-based read request, leveraging the NVLink-based protocol's support for larger payload sizes to improve bandwidth utilization and reduce the number of transactions on the NVLink-based interface.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system may be configured to translate from CXL.io traffic to NVLink-based traffic. The system may include a computer coupled between a first interface configured to communicate according to CXL.io and a second interface configured to communicate according to an NVLink-based protocol. The computer may translate CXL.io requests received from a first entity, such as a CXL host, to NVLink-based requests transmitted to a second entity, such as a GPU. The computer may include an RPU with a cache, and may be implemented as a bridge, a switch, a standalone translation device, or a chiplet. The system may include optional NVLink switches or CXL switches on either side of the computer. Such systems may enable CXL hosts to access GPU memory resources, such as memory storing AI model data, intermediate computation results, or inference outputs, through the CXL.io interface.

In various implementations, a system comprising: a first interface configured to communicate according to CXL.io with a first entity, wherein CXL denotes Compute Express Link; a second interface configured to communicate according to an NVLink-based protocol with a second entity; and a computer coupled between the first and second interfaces, configured to translate between CXL.io requests received via the first interface and NVLink-based requests transmitted via the second interface. The system may enable a CXL-based entity, such as a CXL host, a CXL device, or a CXL switch, to access resources coupled to an NVLink-based entity, such as a GPU, an accelerator, or an NVLink switch, through the computer that performs translation between the CXL.io and NVLink-based protocol domains. The computer may translate addresses, Tags, routing fields, error indications, and other protocol-specific fields. The computer may additionally determine NVLink routing fields such as SourceID and DestinationID for outgoing NVLink-based requests, since CXL.io requests do not carry NVLink routing information. In some examples, the computer may include an RPU coupled to a cache, and may be coupled to a memory. The first interface may be coupled to the first entity directly or through one or more CXL switches, and the second interface may be coupled to the second entity directly or through one or more NVLink switches. The computer may be implemented as a bridge, a switch, a standalone translation device, a semiconductor device, or a chiplet.

In some implementations of the system, the computer is configured to determine a SourceID and a DestinationID for NVLink-based requests transmitted via the second interface based on routing information maintained by the computer. The routing information may include routing tables, address-to-destination mappings, forwarding information, or configuration data programmed by a management entity. The SourceID and DestinationID may be utilized by NVLink switches or the second entity to route and deliver the NVLink-based requests.

In some implementations of the system, the computer is further configured to translate at least one of poison indications or data corruption indications between messages communicated via the first interface and messages communicated via the second interface. The poison indication in CXL.io may be propagated to or from corresponding error fields in NVLink-based messages, enabling end-to-end error visibility across the protocol boundary.

In some implementations of the system, the computer comprises a Request Processing Unit (RPU) coupled to a cache configured to store data associated with translations between the CXL.io requests and the NVLink-based requests, and wherein the computer is further configured to translate between fields of the CXL.io requests and fields of the NVLink-based requests, comprising at least one of: Traffic Class (TC) to QoS priority, Tag to Tag, or length to length translations. The RPU may manage the translation state and orchestrate the protocol conversions. The cache may store data retrieved from the second entity to reduce latency for repeated or adjacent accesses. The cross-field translations may include mapping CXL.io Traffic Class values to NVLink QoS priority levels, mapping CXL.io Tags to NVLink Tags, and translating length fields to accommodate differences in granularity or maximum transfer sizes between the protocols.

In some implementations of the system, the computer is included in at least one of a bridge, a switch, or a standalone translation device, which enables the first entity to access, via CXL.io, GPU memory of the second entity storing data associated with an artificial intelligence (AI) model. The bridge, switch, or standalone translation device may be deployed in AI inference or training systems where CXL hosts need to read intermediate results, model outputs, or gradient data from GPU memory. The translation device may enable such access without requiring the GPU to natively support CXL.io.

In some implementations of the system, the computer comprises an NVLink Fusion chiplet coupled to a processing die via an NVLink Chip-to-Chip (NVLink-C2C) coherent interface; and wherein at least one of: one or more NVLink switches are positioned between the second interface and the second entity, or one or more CXL switches are positioned between the first interface and the first entity. The NVLink Fusion chiplet may implement the translation logic as a separate die within a multi-die package, communicating with the processing die via the NVLink-C2C coherent interface. The NVLink switches or CXL switches may extend the system topology to include multiple NVLink-based entities or multiple CXL-based entities, respectively.

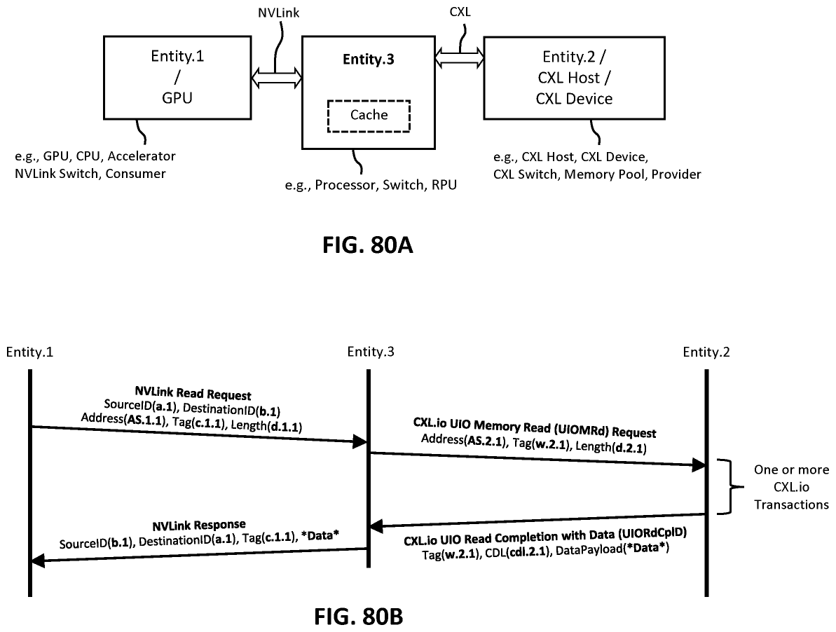

FIG. 80A illustrates an example of a system comprising a third entity (Entity.3), such as a processor, a switch, or an RPU, optionally comprising a cache, that may enable NVLink-based resource consumers to access resources coupled to CXL-based entities. The third entity is coupled to a first entity (Entity.1), which may be a GPU, a CPU, an accelerator, an NVLink switch, or a consumer, wherein the third entity may communicate with the first entity according to an NVLink-based protocol. The third entity is further coupled to a second entity (Entity.2), which may be a CXL host, a CXL device, a CXL switch, a CXL-based memory pool, or a resource provider, wherein the third entity may communicate with the second entity according to a CXL-based protocol, such as at least one of CXL.io, CXL.mem, or CXL.cache. In some examples, messages conforming to the NVLink-based protocol may be associated with a first address space, such as an NVLink-based address space, an NVLink-based network address space, or a GPU address space; and messages conforming to the CXL-based protocol, such as CXL.io, may be associated with a second address space, such as a System Physical Address (SPA) space or a Host Physical Address (HPA) space; wherein the third entity may perform address translations between addresses within the first and second address spaces, respectively. In other examples, messages conforming to the NVLink-based protocol and messages conforming to the CXL-based protocol may be associated with the same physical address space, such as a global address space, a pod address space, or a fabric address space; wherein the third entity may perform address translations between addresses within the same address space. The third entity may perform further translations, such as protocol translations, opcode translations, command translations, request translations, or TLP translations, such as when translating between NVLink requests and CXL.io requests. The third entity may further translate between PDUs of the NVLink-based protocol and PDUs of the CXL protocol, translate Tags, and/or translate error indications, such as data corruption indications or poison. The optional cache within the third entity, shown in dashed outline, may store prefetched data or data retrieved from the second entity to reduce latency for subsequent requests from the first entity. Optionally, the first entity may be a GPU, CPU, accelerator, NVLink switch, or consumer; the third entity may be a processor, switch, or RPU; and the second entity may be a CXL host, CXL device, CXL switch, memory pool, or provider.

FIG. 80B illustrates an example of a transaction flow diagram (TFD) demonstrating a third entity (Entity.3), such as a processor, a switch, or an RPU, that may translate between NVLink-based traffic and CXL-based traffic, such as CXL.io traffic. The third entity may receive from a first entity (Entity.1), which may be a GPU, an NVLink read request that may include SourceID(a.1), DestinationID(b.1), Address(AS.1.1), Tag(c.1.1), and Length(d.1.1), wherein SourceID(a.1) may denote the NVLink interconnect address utilized by the requesting entity, such as a source GPU, and wherein DestinationID(b.1) may denote the NVLink interconnect address utilized by the target of the NVLink request, and may be utilized for routing or forwarding the NVLink request to its destination. The third entity may translate the NVLink request to a CXL.io request that may include a CXL.io UIO Memory Read (UIOMRd) request comprising Address(AS.2.1), Tag(w.2.1), and Length(d.2.1), and may send the CXL.io UIOMRd to a second entity (Entity.2), which may be a CXL host or a CXL device. The third entity may further translate between other values of the NVLink request and the CXL.io request, such as between addresses, Tags, QoS-related values, or identifications (IDs), which may serve to route or forward the NVLink request to its destination. In some examples, the third entity may translate an NVLink request to multiple CXL.io request, such as in order to split a large data read request (e.g., splitting a large 256 B NVLink read request to smaller 64 B CXL.io read requests), or in order to prefetch data, optionally into a cache that may be included in or coupled to the third entity. Upon receiving a response from the second entity (Entity.2), which may include a CXL.io UIORdCpID comprising Tag(w.2.1), CDL(cdl.2.1), and DataPayload(*Data*), the third entity may translate the CXL.io UIORdCpID to an NVLink response comprising SourceID(b.1), DestinationID(a.1), Tag(c.1.1), and *Data*. The CDL that may be included in the CXL.io UIORdCpID may be populated with information related to QoS, such as QoS telemetry value or values. The third entity may translate information carried in the CDL and send it via one or more fields of the NVLink response, such as via reserved fields, vendor-defined fields, or custom fields. Alternatively or additionally, the third entity may collect QoS information, telemetry, or statistics from UIORdCpID completions.

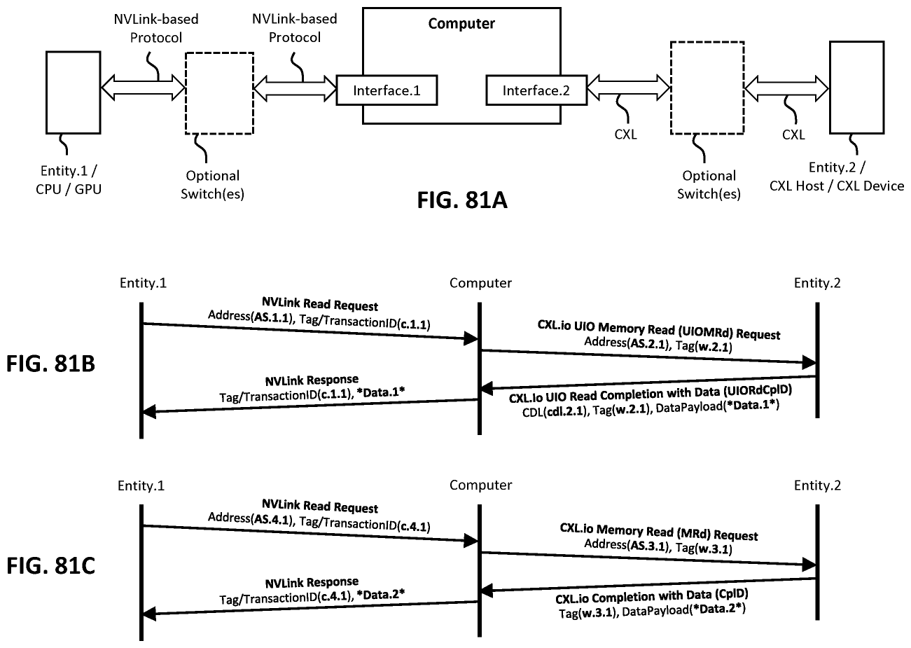

FIG. 81A illustrates an example of a system comprising a computer coupled between: (1) a first interface (Interface.1) that may communicate according to an NVLink-based protocol, such as a protocol utilizing an NVLink interconnect, with a first entity (Entity.1), which may be a CPU or a GPU; and (2) a second interface (Interface.2) that may communicate according to a CXL-based protocol, such as CXL.io, with a second entity (Entity.2), which may be a CXL host or a CXL device. Optionally, the computer may be implemented in a semiconductor device package. The computer may extract physical addresses from requests received via the first interface, wherein these addresses may refer to an NVLink-based address space, an NVLink-based network address space, or a GPU address space utilized by the first entity. The computer may further translate these addresses, and generate requests carrying the translated physical addresses for transmission via the second interface; wherein these translated addresses may correspond to an HPA space utilized by the second entity. Optional switch(es), such as NVLink switches, may be positioned between the first interface and the first entity, as shown in dashed outline on the left side of the figure. Similarly, optional switch(es), such as CXL switches, may be positioned between the second interface and the second entity, as shown in dashed outline on the right side of the figure. The NVLink-based protocol labels on the connections between the first entity, the optional switches, and the first interface indicate that NVLink-based traffic traverses the left side of the illustrated system. The CXL labels on the connections between the second interface, the optional switches, and the second entity indicate that CXL-based traffic traverses the right side of the illustrated system. Optionally, the computer may be included in a switch or a bridge. In some examples, the computer may be implemented in an IC package having high-speed differential I/O balls positioned according to a ball grid array layout defined by a retimer specification, such as the PCIe 5.0, 6.0, or 7.0 Retimer Supplemental Features and Standard BGA Footprint Specification.

FIG. 81B illustrates an example of a TFD demonstrating translations between NVLink-based requests, such as NVLink read requests, received from a first entity (Entity.1), which may be a CPU or a GPU, and CXL.io UIO TLPs sent to a second entity (Entity.2), which may be a CXL host or a CXL device, possibly enabling the first entity to access resources mapped to an address space utilized by the second entity. The first entity may initiate an NVLink request, which may be an NVLink read request, comprising a physical address, such as a GPU physical address or an NVLink-based network address Address(AS.1.1), and Tag/TransactionID(c.1.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.io request, such as a CXL.io UIO Memory Read (UIOMRd) request comprising a physical address, such as HPAs Address(AS.2.1), and Tag(w.2.1), and may send the CXL.io UIOMRd to the second entity. Upon receiving the CXL.io UIOMRd, the second entity may respond with a completion, which may include a CXL.io UIO Read Completion with Data (UIORdCpID) comprising CDL(cdl.2.1), Tag(w.2.1), and DataPayload(*Data.1*), wherein the CDL may be populated by the CXL device (or alternatively by the CXL host) with information related to QoS, such as QoS telemetry value or values. The computer may translate the CXL.io UIORdCpID to an NVLink response comprising Tag/TransactionID(c.1.1) and *Data.1*, and may send the NVLink response to the first entity. In some examples, the computer may issue multiple CXL.io UIO memory read requests in response to receiving an NVLink request from the first entity, such as when splitting an NVLink request for a large block of data to smaller CXL.io UIO memory read requests, or when prefetching data from the second entity. The computer may translate requests or transactions initiated from the NVLink-based domain to the CXL domain, or may translate requests or transactions initiated from the CXL domain to the NVLink-based domain.

FIG. 81C illustrates an example of a TFD demonstrating translations between NVLink-based requests, such as NVLink read requests, received from a first entity (Entity.1), which may be a CPU or a GPU, and CXL.io TLPs sent to a second entity (Entity.2), which may be a CXL host or a CXL device. The translation is performed by a computer, which may be a semiconductor device. The first entity may initiate an NVLink request, which may be an NVLink read request, comprising physical address Address(AS.4.1), and Tag/TransactionID(c.4.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.io request, such as a CXL.io Memory Read (MRd) request comprising physical address Address(AS.3.1) and Tag(w.3.1), and may send the CXL.io MRd to the second entity. Upon receiving a completion from the second entity, which may include a CXL.io Completion with Data (CpID) comprising Tag(w.3.1) and DataPayload(*Data.2*), the computer may translate the CXL.io CpID to an NVLink response comprising Tag/TransactionID(c.4.1) and *Data.2*, and may send the NVLink response to the first entity. In some examples, the computer may issue multiple CXL.io memory read requests in response to receiving an NVLink request from the first entity, such as when splitting an NVLink request for a large block of data to smaller CXL.io memory read requests, or when prefetching data from the second entity.

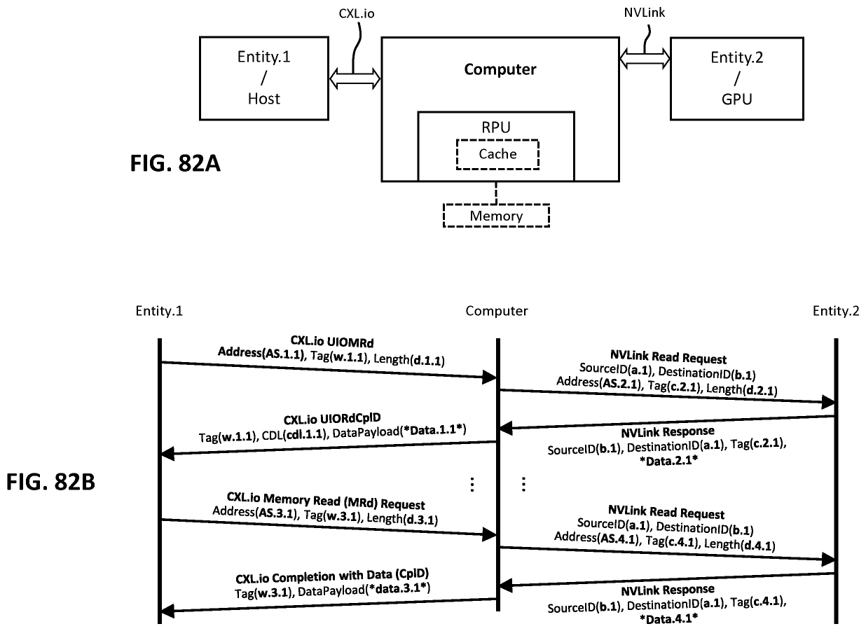

FIG. 82A illustrates an example of a system comprising a computer configured to translate between CXL.io traffic and NVLink-based traffic. A first entity (Entity.1), which may be a host, is coupled to the computer via a CXL.io interface. A second entity (Entity.2), which may be a GPU, is coupled to the computer via an NVLink interface. The computer includes an RPU that may orchestrate the protocol translation logic. The RPU may include an optional cache, which may store data associated with translations between CXL.io requests and NVLink-based requests, such as prefetched data, cached responses, or translation state. The computer is further coupled to an optional memory, shown in dashed outline below the computer, that may store routing tables, address translation tables, Tag mapping entries, or other state information utilized by the RPU during translation. The system enables the first entity (Host) to access resources coupled to the second entity (GPU) through the computer by translating CXL.io requests to NVLink-based requests and translating NVLink-based responses to CXL.io completions. The computer may determine NVLink routing fields such as SourceID and DestinationID for outgoing NVLink-based requests, since CXL.io requests do not natively carry NVLink routing fields. When translating NVLink-based responses to CXL.io UIO completions, the computer may populate a CDL field with QoS telemetry information derived from the NVLink domain, from load or congestion information observed by the computer, or from information carried in the NVLink-based response.

FIG. 82B illustrates an example of a TFD demonstrating translations between CXL.io read requests received from a first entity (Entity.1) and NVLink-based read requests sent to a second entity (Entity.2), with the translation performed by a computer positioned between the first and second entities. The figure shows two separate transaction flows separated by a vertical ellipsis, representing two alternative translation paths: an upper UIO path and a lower non-UIO path. In the upper UIO path, the first entity sends a CXL.io UIOMRd comprising Address(AS.1.1), Tag(w.1.1), and Length(d.1.1) to the computer. The computer translates the CXL.io UIOMRd to an NVLink read request comprising SourceID(a.1), DestinationID(b.1), Address(AS.2.1), Tag(c.2.1), and Length(d.2.1), and sends the NVLink read request to the second entity. The computer determines the SourceID(a.1) and DestinationID(b.1) based on routing information maintained by the computer, since the CXL.io UIOMRd does not carry NVLink routing fields. Upon receiving an NVLink Response from the second entity comprising SourceID(b.1), DestinationID(a.1), Tag(c.2.1), and *Data.2.1*, the computer translates the NVLink Response to a CXL.io UIORdCpID comprising Tag(w.1.1), CDL(cdl.1.1), and DataPayload(*Data.1.1*), and sends the CXL.io UIORdCpID to the first entity. The CDL(cdl.1.1) may be populated by the computer with QoS telemetry information based on load information observed by the computer, congestion information associated with the second entity, or information derived from the NVLink Response, since the NVLink-based protocol does not natively carry a CDL field.

In the lower non-UIO path, the first entity sends a CXL.io Memory Read (MRd) request comprising Address(AS.3.1), Tag(w.3.1), and Length(d.3.1) to the computer. The computer translates the CXL.io MRd to an NVLink read request comprising SourceID(a.1), DestinationID(b.1), Address(AS.4.1), Tag(c.4.1), and Length(d.4.1), and sends the NVLink read request to the second entity. Upon receiving an NVLink Response from the second entity comprising SourceID(b.1), DestinationID(a.1), Tag(c.4.1), and *Data.4.1*, the computer translates the NVLink Response to a CXL.io Completion with Data (CpID) comprising Tag(w.3.1) and DataPayload(*Data.3.1*), and sends the CXL.io CpID to the first entity. Unlike the upper UIO path, the CpID in the lower non-UIO path does not include a CDL. In both paths, the computer translates addresses between the CXL.io domain (Address AS.1.1 and AS.3.1) and the NVLink domain (Address AS.2.1 and AS.4.1), translates Tags between the CXL.io domain (Tag w.1.1 and w.3.1) and the NVLink domain (Tag c.2.1 and c.4.1), and determines NVLink SourceID and DestinationID routing fields for the outgoing NVLink read requests.

In heterogeneous computing architectures, entities may communicate using different interconnect protocols while requiring coordinated access to shared resources. NVLink is a high-bandwidth interconnect technology utilized for communication among GPUs, accelerators, and switches, while PCIe is an interconnect technology utilized for communication between hosts and devices. NVLink-based PDUs utilize an NVLink-based address space, whereas PCIe TLPs utilize a PCIe address space, such as a Host Physical Address (HPA) space. In environments where a first entity communicating via NVLink needs to access resources coupled to a second entity communicating via PCIe, or vice versa, translations between NVLink-based PDUs and PCIe TLPs may facilitate memory operations and data transfers across the different protocol domains. Such translations may be performed by a computer, an apparatus, a cable, or other suitable devices positioned between the first entity and the second entity. The translations may include translating physical addresses between the NVLink-based address space and the PCIe address space, translating between NVLink-based request types and PCIe TLP types, and translating identifier fields such as Tags, SourceIDs, DestinationIDs, and RequesterIDs. The translations may support AI workloads, such as training and inference of large language models (LLMs), mixture-of-experts (MoE) models, multi-modal models, and diffusion models, which may involve transferring model weights, key-value (KV) cache entries, activation tensors, and embedding tables between NVLink-connected entities and PCIe-connected resources.

In various implementations, a method comprising: operating a computer coupled between a first interface that communicates according to an NVLink-based protocol with a first entity, and a second interface that communicates according to a PCI Express (PCIe) protocol with a second entity; translating, by the computer, between NVLink-based Protocol Data Units (PDUs) communicated via the first interface and PCIe Transaction Layer Packets (TLPs) communicated via the second interface, wherein the translating comprises: translating physical addresses between a first address space associated with the NVLink-based protocol and a second address space associated with the PCIe protocol; and translating between NVLink-based request types and PCIe TLP types. The computer may be implemented as a semiconductor device, an integrated circuit (IC), a chiplet, an active cable, a switch, or another suitable device positioned between the first entity and the second entity. The first address space may include an NVLink-based network address space or a GPU physical address space, and the second address space may include an HPA space or another PCIe memory address space. The computer may maintain address translation tables, such as Link TLBs or address mapping tables, to translate between addresses in the first and second address spaces. The translating may be bidirectional: in one direction, the computer may translate NVLink-based PDUs received from the first entity to PCIe TLPs sent to the second entity; in the opposite direction, the computer may translate PCIe TLPs received from the second entity to NVLink-based PDUs sent to the first entity. The NVLink-based request types may include NVLink read requests and NVLink write requests, and the PCIe TLP types may include Memory Read (MRd) requests, Memory Write (MWr) requests, and Completions. The method may be implemented in hardware, firmware, software, or combinations thereof. Additionally, the first and second entities may communicate through one or more intermediary components, such as a switch, a retimer, or another suitable entity that facilitates information transfer.

In some implementations of the method, the NVLink-based PDUs comprise an NVLink-based request from the first entity, the NVLink-based request comprising a first address in the first address space; wherein the PCIe TLPs comprise a PCIe Memory Read (MRd) request comprising a second address in the second address space; and wherein the translating further comprises translating the NVLink-based request to the PCIe MRd and sending the PCIe MRd to the second entity via the second interface. The NVLink-based request may be an NVLink read request carrying a GPU physical address or an NVLink-based network address. The computer may translate this address to an HPA or another address within the PCIe memory address space. The computer may further translate NVLink Tags or transaction identifiers to PCIe Tags for tracking the transaction.

In some implementations of the method, the PCIe TLPs further comprise a PCIe Completion with Data (CpID) from the second entity, the PCIe CpID comprising a data payload corresponding to the PCIe MRd; and wherein the translating further comprises translating the PCIe CpID to an NVLink-based response comprising the data payload. The computer may correlate the PCIe CpID with the previously sent PCIe MRd using the PCIe Tag, and may translate the PCIe Tag back to the corresponding NVLink Tag or transaction identifier. The data payload may be forwarded from the PCIe CpID into the NVLink-based response without modification.

In some implementations of the method, the PCIe TLPs comprise a PCIe Memory Read (MRd) request from the second entity, the PCIe MRd comprising a first address in the second address space; wherein the NVLink-based PDUs comprise an NVLink-based request comprising a second address in the first address space; and wherein the translating further comprises translating the PCIe MRd to the NVLink-based request and sending the NVLink-based request to the first entity via the first interface. In the opposite direction, the second entity may initiate a PCIe MRd targeting a resource accessible via the NVLink fabric. The computer may translate the PCIe address, such as an HPA, to an NVLink-based address, and may generate NVLink identifier fields such as SourceID and DestinationID that are not present in the PCIe domain. The computer may further translate the PCIe Tag to an NVLink Tag for transaction tracking.

In some implementations of the method, the NVLink-based PDUs further comprise an NVLink-based response from the first entity, the NVLink-based response comprising a data payload; and wherein the translating further comprises translating the NVLink-based response to a PCIe Completion with Data (CpID) comprising the data payload. The computer may translate the NVLink Tag back to the PCIe Tag of the original MRd and may generate PCIe completion header fields such as CompleterID and RequesterID. The data payload may be forwarded from the NVLink response into the PCIe CpID.

In some implementations of the method, the PCIe MRd further comprises a RequesterID, and wherein the PCIe CpID further comprises a CompleterID and the RequesterID, and wherein the computer generates the CompleterID for the PCIe CpID. The CompleterID may identify the computer as the PCIe Completer for the transaction. The RequesterID may be reflected from the original PCIe MRd to enable correct routing of the CpID back to the originating entity. These identifiers may be set during enumeration or initialization phases.

In some implementations of the method, the PCIe MRd further comprises a RequesterID and a first Tag, and wherein the NVLink-based request further comprises a SourceID, a DestinationID, and a second Tag; and wherein translating the PCIe MRd to the NVLink-based request comprises generating the SourceID and the DestinationID, and translating the first Tag to the second Tag. The PCIe domain utilizes RequesterID (Bus/Device/Function) for identifying the requester, whereas the NVLink domain utilizes separate SourceID and DestinationID fields for routing. The computer may generate the SourceID based on its own NVLink identity, and the DestinationID based on the target entity in the NVLink fabric. The computer may maintain a Tag mapping table to translate between PCIe Tags and NVLink Tags and to correlate responses with their corresponding requests.

In some implementations of the method, the PCIe TLPs communicated via the second interface utilize a Flit Mode (FM) format, and wherein the first entity comprises a GPU or an accelerator, and the second entity comprises a PCIe host or a PCIe device. Flit Mode may be supported by PCIe Revision 6.0 and above, and may provide increased bandwidth efficiency and support for 14-bit Tags. The second entity may be a PCIe host, such as a CPU or a Root Complex, or a PCIe device, such as an NVMe SSD, a network interface card (NIC), or a memory controller.

In some implementations of the method, the computer translates between Flit Mode (FM) and Non-Flit Mode (NFM) TLP formats for the PCIe TLPs communicated via the second interface, and wherein the NVLink-based PDUs carry data associated with an artificial intelligence (AI) model comprising at least one of: a large language model (LLM), a mixture-of-experts (MoE) model, a multi-modal model, or a diffusion model. When the second interface operates in a different data stream mode than an adjacent PCIe link segment, the computer may translate between FM and NFM TLP formats, including adapting header formats, Tag widths, and encoding mechanisms. LLMs may include transformer-based architectures, MoE models may route inputs to subsets of expert sub-networks, multi-modal models may process inputs across text, image, and video modalities, and diffusion models may generate content through iterative denoising.

In some implementations of the method, the PCIe TLPs carry a data payload not exceeding 64 Double Words (DWs), and wherein the computer translates an NVLink-based PDU to multiple PCIe TLPs. The 64 DW ceiling (256 bytes) may correspond to a maximum payload size supported by the NVLink-based protocol, which may be imposed on the PCIe domain. When an NVLink request targets a data block that exceeds the PCIe Maximum Payload Size or requires multiple completions, the computer may split the request into smaller PCIe TLPs and may reassemble the returned data before translating it back to the NVLink domain.

In some implementations of the method, at least one physical address within the second address space, which is a PCIe memory address space, is not mapped to an NVLink address in the first address space, and wherein the NVLink-based PDUs and the PCIe TLPs carry data associated with an artificial intelligence (AI) workload, the data comprising at least one of: model weights, key-value (KV) cache entries, activation tensors, or embedding tables. The computer may expose only a subset of the PCIe memory address space to the NVLink domain. Unmapped PCIe addresses may correspond to configuration registers, management interfaces, or memory regions reserved for local use by the second entity. KV cache entries may be utilized during autoregressive inference, activation tensors may represent intermediate computation results, and embedding tables may map discrete tokens to continuous vector representations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

The following system translates between NVLink-based traffic and PCIe traffic. The system may support various form factors, including semiconductor devices packaged in retimer-compatible BGA layouts, active cables with optical or copper physical media, and chiplet-based implementations. The system may further include NVLink switches or PCIe switches positioned between the interfaces and the respective entities, enabling multi-entity topologies. The system may be deployed in datacenters, high-performance computing (HPC) environments, or AI/ML training and inference clusters, where NVLink-connected accelerators/GPUs need to access PCIe-attached resources such as host memory, NVMe storage, or network interface cards.

In various implementations, a system comprising: a first interface configured to communicate according to an NVLink-based protocol with a first entity; a second interface configured to communicate according to a PCI Express (PCIe) protocol with a second entity; and a computer coupled between the first and second interfaces, configured to translate between NVLink-based traffic communicated via the first interface and PCIe traffic communicated via the second interface, comprising translating physical addresses between a first address space associated with the NVLink-based protocol and a second address space associated with the PCIe protocol. The system may be deployed in environments where NVLink-connected entities, such as GPUs, accelerators, or NVLink switches, need to access resources coupled to PCIe-connected entities, such as PCIe hosts, NVMe SSDs, or network interface cards. The computer may be implemented as a semiconductor device comprising translation logic, address mapping tables, and pending transaction trackers. The first and second interfaces may support different link speeds, lane widths, and signaling technologies. The system may support bidirectional translation, wherein in one direction the computer translates NVLink-based traffic to PCIe traffic, and in the opposite direction the computer translates PCIe traffic to NVLink-based traffic. Optional switches may be positioned between the first interface and the first entity, and between the second interface and the second entity, to support multi-entity topologies.

In some implementations of the system, the computer is implemented in an IC package having differential input/output (I/O) balls positioned according to a ball grid array (BGA) layout, and wherein the system further comprises a cable including a first module and a second module coupled by a physical medium, the computer residing within the first module or the second module. The BGA layout may conform to a retimer specification, such as the PCIe 5.0, 6.0, or 7.0 Retimer Supplemental Features and Standard BGA Footprint Specification. The physical medium may include a copper wire, a twinaxial cable, a multimode fiber (MMIF), or a single-mode fiber (SMF). The cable may be implemented as an Active Optical Cable (AOC) or an Active Copper Cable (ACC).

In some implementations of the system, the computer comprises an NVLink Fusion chiplet, and wherein an NVLink switch is coupled between the first interface and the first entity. The NVLink Fusion chiplet may integrate the translation logic, address mapping functionality, and NVLink interface within a chiplet package. The NVLink switch may enable multi-entity connectivity, allowing multiple accelerators (e.g., GPUs) to access PCIe resources through the same computer. The NVLink Fusion chiplet may be a component of an RPU within an active cable or a discrete semiconductor device.

In some implementations of the system, the second interface operates in Flit Mode (FM), and wherein the NVLink-based traffic and the PCIe traffic carry data associated with an artificial intelligence (AI) workload comprising at least one of: model training, model inference, or model fine-tuning. Flit Mode operation on the second interface may provide increased bandwidth efficiency and support for 14-bit Tags and UIO capabilities. Model training may involve distributing gradient computations and model parameters across NVLink-connected GPUs while accessing datasets stored on PCIe-attached storage. Model inference may involve transferring model weights and KV cache entries between memory tiers. Model fine-tuning may involve adapting pre-trained model parameters using task-specific data.

In some implementations, the translations between NVLink-based traffic and PCIe traffic may involve PCIe Unordered I/O (UIO) TLPs. UIO is an optional capability defined in PCIe that introduces TLP types associated with UIO Virtual Channels, including UIO Memory Read (UIOMRd) and UIO Read Completion with Data (UIORdCpID). UIO enables multi-path routing and may provide improved performance in fabric environments. In environments where a first entity communicating via NVLink needs to access resources coupled to a second entity via PCIe UIO, or vice versa, translations between NVLink-based PDUs and PCIe UIO TLPs may facilitate memory operations and data transfers. UIO TLPs are defined for Flit Mode and are associated with dedicated UIO Virtual Channels. The translations between NVLink-based PDUs and PCIe UIO TLPs may involve translating between NVLink identifier fields, such as SourceID and DestinationID, and PCIe UIO identifier fields, such as RequesterID and DestinationBDF/BF. The translations may support AI workloads such as training and inference of LLMs, MoE models, and multi-modal models.

In various implementations, a method comprising: operating a computer coupled between a first interface that communicates according to an NVLink-based protocol with a first entity, and a second interface that communicates according to a PCI Express (PCIe) protocol with a second entity; translating, by the computer, between NVLink-based Protocol Data Units (PDUs) communicated via the first interface and PCIe UIO Transaction Layer Packets (TLPs) communicated via the second interface. The computer may be implemented as a semiconductor device, an IC, a chiplet, an active cable, a switch, or another suitable device positioned between the first entity and the second entity. PCIe UIO TLPs are distinct from standard PCIe TLPs and are associated with UIO Virtual Channels. The method may be bidirectional: in one direction, the computer may translate NVLink-based PDUs received from the first entity to PCIe UIO TLPs sent to the second entity; in the opposite direction, the computer may translate PCIe UIO TLPs received from the second entity to NVLink-based PDUs sent to the first entity. The translating may include opcode translations, Tag translations, address translations, and identifier translations between the NVLink-based domain and the PCIe UIO domain. The PCIe UIO TLPs may include UIOMRd, UIOMWr, UIORdCpID, UIORdCpl, and UIOWrCpl. The method may be implemented in hardware, firmware, software, or combinations thereof. Additionally, the first and second entities may communicate through one or more intermediary components, such as a switch, a retimer, or another suitable entity that facilitates information transfer.

In some implementations of the method, the NVLink-based PDUs comprise an NVLink-based request from the first entity; wherein the PCIe UIO TLPs comprise a PCIe UIO Memory Read (UIOMRd) request; and wherein the translating further comprises translating the NVLink-based request to the PCIe UIOMRd and sending the PCIe UIOMRd to the second entity via the second interface. The NVLink-based request may be an NVLink read request comprising a physical address and a Tag or transaction identifier. The computer may translate the NVLink-based request to a PCIe UIOMRd carrying a translated address and a PCIe Tag. The UIOMRd may utilize a UIO Virtual Channel for transmission to the second entity.

In some implementations of the method, the PCIe UIO TLPs further comprise a PCIe UIO Read Completion with Data (UIORdCpID) from the second entity, the UIORdCpID comprising a data payload; and wherein the translating further comprises translating the UIORdCpID to an NVLink-based response comprising the data payload. The computer may correlate the UIORdCpID with the previously sent UIOMRd using the PCIe Tag, and may translate the response back to the NVLink domain. UIO completions may be received in any order by the requester, and the computer may handle out-of-order completions when reassembling data for the NVLink response.

In some implementations of the method, the PCIe UIO TLPs comprise a PCIe UIO Memory Read (UIOMRd) request from the second entity; wherein the NVLink-based PDUs comprise an NVLink-based request; and wherein the translating further comprises translating the UIOMRd to the NVLink-based request and sending the NVLink-based request to the first entity via the first interface. In the opposite direction, the second entity may initiate a PCIe UIOMRd targeting a resource accessible via the NVLink fabric. The computer may translate the UIOMRd to an NVLink-based request, generating NVLink SourceID and DestinationID fields and translating the PCIe Tag to an NVLink Tag. The UIOMRd may carry a RequesterID that the computer may store for generating the corresponding UIORdCpID.

In some implementations of the method, the NVLink-based PDUs further comprise an NVLink-based response from the first entity, the NVLink-based response comprising a data payload; and wherein the translating further comprises translating the NVLink-based response to a PCIe UIO Read Completion with Data (UIORdCpID) comprising the data payload. The computer may generate PCIe UIO completion header fields, such as CompleterID and DestinationBDF/BF, when constructing the UIORdCpID. The DestinationBDF/BF may correspond to the RequesterID of the originating UIOMRd. The data payload may be forwarded from the NVLink response into the UIORdCpID.

In some implementations of the method, the translating further comprises translating physical addresses between a first address space associated with the NVLink-based protocol and a second address space associated with the PCIe protocol. The address translation for UIO transactions may utilize the same address mapping tables or Link TLBs as standard PCIe translations. The first address space may include an NVLink-based network address space, and the second address space may include a PCIe memory address space. The address translation may be applied in both directions.

In some implementations of the method, the PCIe UIO TLPs carry a data payload not exceeding 64 Double Words (DWs), wherein the PCIe UIO TLPs are associated with a UIO Virtual Channel, and wherein the NVLink-based PDUs carry data associated with an artificial intelligence (AI) model comprising at least one of: a large language model (LLM), a mixture-of-experts (MoE) model, or a multi-modal model. The 64 DW ceiling (256 bytes) may correspond to a maximum payload size supported by the NVLink-based protocol. UIO TLPs may only be transmitted on Virtual Channels configured for UIO. The first UIO Virtual Channel may be VC2, and a second UIO Virtual Channel, if supported, may be VC4. LLMs may generate token sequences using autoregressive decoding, MoE models may route tokens to specialized expert sub-networks, and multi-modal models may fuse representations across text, image, and video inputs.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

In some implementations, translations between NVLink-based traffic and PCIe UIO TLPs may be implemented as a system comprising interfaces and a computer. The system may support PCIe UIO transactions that enable multi-path routing and out-of-order completions, providing performance benefits for fabric-based deployments. The system may be deployed in environments where NVLink-connected accelerators/GPUs need to access PCIe UIO-capable resources, or where PCIe UIO-capable entities need to access resources accessible via the NVLink fabric.

In various implementations, a system comprising: a first interface configured to communicate according to an NVLink-based protocol with a first entity; a second interface configured to communicate according to a PCI Express (PCIe) protocol with a second entity; and a computer coupled between the first and second interfaces, configured to translate between NVLink-based traffic communicated via the first interface and PCIe UIO Transaction Layer Packets (TLPs) communicated via the second interface. The system may be deployed in environments where NVLink-connected entities need to access PCIe UIO-capable resources, or vice versa. The computer may translate between NVLink-based PDUs and PCIe UIO TLPs, including UIOMRd, UIOMWr, and UIORdCpID. The system may support bidirectional translation: in one direction the computer translates NVLink-based traffic to PCIe UIO TLPs, and in the opposite direction the computer translates PCIe UIO TLPs to NVLink-based traffic. The second interface may operate in Flit Mode, as UIO TLPs are defined for Flit Mode. The system may be implemented in various form factors, including semiconductor devices, active cables, chiplets, and switches.

In some implementations of the system, at least one physical address within a PCIe memory address space is not mapped to an NVLink address, and wherein the first entity comprises a GPU, a CPU, or an accelerator, and the second entity comprises a PCIe host or a PCIe device. The partial address space exposure may allow the system to selectively map only certain PCIe memory regions to the NVLink domain. The first entity may be a GPU, a CPU, or an accelerator connected via NVLink. The second entity may be a PCIe host, such as a CPU comprising a Root Complex, or a PCIe device, such as an NVMe SSD or a network interface card.

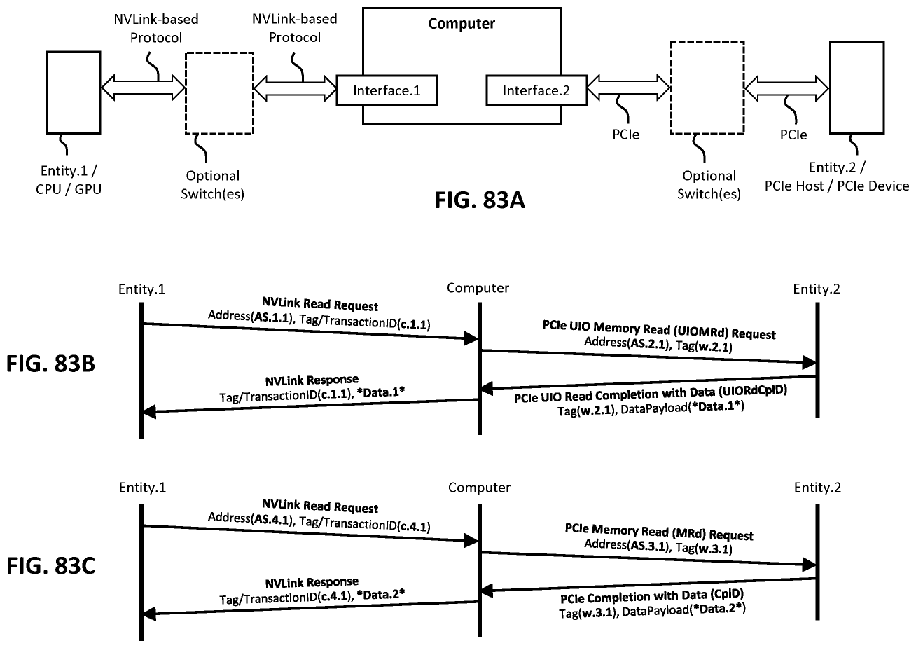

FIG. 83A illustrates an example of a system comprising a computer, which may be referred to as a semiconductor device, coupled between: (1) a first interface (Interface.1) that may communicate according to an NVLink-based protocol, such as a protocol utilizing an NVLink interconnect, with a first entity (Entity.1), which may be a CPU or a GPU; and (2) a second interface (Interface.2) that may communicate according to a PCIe-based protocol with a second entity (Entity.2), which may be a PCIe host or a PCIe device. The first interface may communicate bidirectionally with the first entity using the NVLink-based protocol. The second interface may communicate bidirectionally with the second entity using PCIe. The computer may be implemented in an IC package having high-speed differential I/O balls positioned according to a ball grid array (BGA) layout defined by a retimer specification, such as the PCIe 5.0, 6.0, or 7.0 Retimer Supplemental Features and Standard BGA Footprint Specification. The computer may translate between NVLink-based traffic communicated via the first interface and PCIe traffic communicated via the second interface, including translating physical addresses between a first address space associated with the NVLink-based protocol and a second address space associated with the PCIe protocol. Optional switch(es) may be positioned between the first interface and the first entity. Similarly, optional switch(es) may be positioned between the second interface and the second entity. The system may support bidirectional translation, wherein the computer may translate NVLink-based traffic to PCIe traffic in one direction, and may translate PCIe traffic to NVLink-based traffic in the opposite direction.

FIG. 83B illustrates an example of a TFD demonstrating translations, in one direction, between NVLink-based requests, such as NVLink read requests, received from a first entity (Entity.1), which may be a CPU or a GPU, and PCIe UIO TLPs sent to a second entity (Entity.2), which may be a PCIe host or a PCIe device. A semiconductor device or computer, positioned between the first entity and the second entity, may perform the translations, possibly enabling the first entity to access resources mapped to an address space utilized by the second entity. The first entity may initiate an NVLink request, which may be an NVLink read request, comprising a physical address Address(AS.1.1), such as a GPU physical address or an NVLink-based network address, and Tag/TransactionID(c.1.1), wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a PCIe UIO Memory Read (UIOMRd) request comprising Address(AS.2.1) and Tag(w.2.1), and may send the PCIe UIOMRd to the second entity. Upon receiving a completion from the second entity, which may include a PCIe UIO Read Completion with Data (UIORdCpID) comprising Tag(w.2.1) and DataPayload(*Data.1*), the computer may translate the PCIe UIORdCpID to an NVLink response comprising Tag/TransactionID(c.1.1) and *Data.1*, and may send the NVLink response to the first entity.

The computer may perform further translations, such as protocol translations, opcode translations, command translations, TLP type translations, and field translations between the NVLink-based domain and the PCIe domain. In some examples, the computer may issue multiple PCIe UIO memory read requests in response to receiving an NVLink request from the first entity, such as when splitting an NVLink request for a large block of data to smaller PCIe UIO memory read requests, or when prefetching data from the second entity. The computer may translate NVLink-based traffic to PCIe UIO traffic in one direction, and/or may translate PCIe UIO traffic to NVLink-based traffic in the opposite direction.

FIG. 83C illustrates an example of a TFD demonstrating translations, in one direction, between NVLink-based requests, such as NVLink read requests, received from a first entity (Entity.1), which may be a CPU or a GPU, and PCIe TLPs sent to a second entity (Entity.2), which may be a PCIe host or a PCIe device. A semiconductor device or computer, positioned between the first entity and the second entity, may perform the translations, possibly enabling the first entity to access resources mapped to an address space utilized by the second entity. The first entity may initiate an NVLink request, which may be an NVLink read request, comprising a physical address, such as a GPU physical address or an NVLink-based network address Address(AS.4.1), and Tag/TransactionID(c.4.1), wherein Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a PCIe request, such as a PCIe Memory Read (MRd) request comprising a physical address, such as an HPA Address(AS.3.1), and Tag(w.3.1), and may send the PCIe MRd to the second entity. Upon receiving a completion from the second entity, which may include a PCIe Completion with Data (CpID) comprising Tag(w.3.1) and DataPayload(*Data.2*), the computer may translate the PCIe CpID to an NVLink response comprising Tag/TransactionID(c.4.1) and *Data.2*, and may send the NVLink response to the first entity.

The computer may perform further translations, such as protocol translations, opcode translations, command translations, TLP type translations, and field translations between the NVLink-based domain and the PCIe domain. In some examples, the computer may issue multiple PCIe memory read requests in response to receiving an NVLink request from the first entity, such as when splitting an NVLink request for a large block of data to smaller PCIe memory read requests, or when prefetching data from the second entity. The computer may translate NVLink-based traffic to PCIe traffic in one direction, and/or may translate PCIe traffic to NVLink-based traffic in the opposite direction.

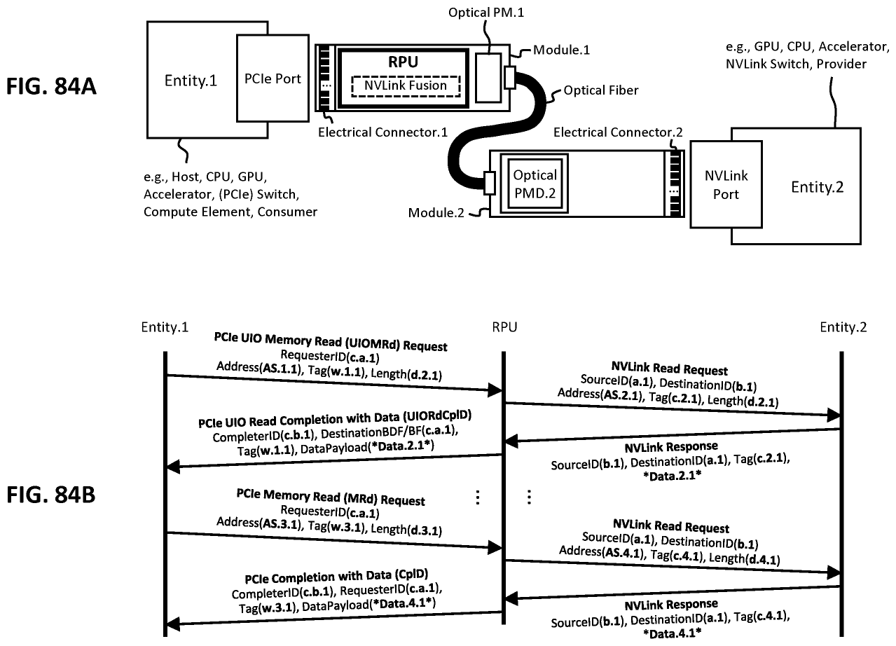

FIG. 84A illustrates an example of a cable comprising an RPU that translates between PCIe-based traffic and NVLink-based traffic. A first entity (Entity.1), which may be a host, a CPU, a GPU, an accelerator, a PCIe switch, or a compute element, and which may be referred to as a consumer, is coupled to a PCIe Port. The PCIe Port is coupled via a first electrical connector (Electrical Connector.1) to a first module (Module.1) within the cable. Module.1 may include an RPU, wherein the RPU may include an NVLink Fusion chiplet shown as an optional component, and an optical physical medium dependent (Optical PMD.1). The RPU within Module.1 may translate between PCIe-based traffic received from the first entity via the PCIe Port and NVLink-based traffic for transmission over the cable, and may translate between NVLink-based traffic received over the cable and PCIe-based traffic sent to the first entity. The cable may further include an optical fiber coupling Module.1 to a second module (Module.2), wherein the optical fiber carries NVLink-based traffic between the modules. Module.2 may include an optical physical medium dependent (Optical PMD.2). Module.2 is coupled via a second electrical connector (Electrical Connector.2) to an NVLink Port of a second entity (Entity.2), which may be a GPU, a CPU, an accelerator, or an NVLink switch, and which may be referred to as a provider. Placing the RPU in Module.1, closer to the PCIe Port, facilitates the translation from PCIe signaling to NVLink signaling at the entry point of the cable, such that the optical fiber carries NVLink-based traffic rather than PCIe-based traffic. NVLink may incorporate electrical signaling characteristics that are compatible with longer-reach interconnects, and may utilize a signaling rate higher than PCIe, and may therefore require fewer lanes for the same bandwidth. Consequently, placing the RPU closer to the PCIe Port may allow for reducing the number of optical fibers or optical wavelengths, which may simplify the cable design and reduce cost. In other examples, the RPU may reside in Module.2 instead of Module.1.

FIG. 84B illustrates an example of a TFD demonstrating translations, by an RPU, between PCIe-based requests received from a first entity (Entity.1) and NVLink-based requests sent to a second entity (Entity.2). The TFD illustrates two exemplary transactions, separated by a vertical ellipsis, demonstrating both PCIe UIO and standard PCIe paths. In a first exemplary transaction, the first entity may send a PCIe UIO Memory Read (UIOMRd) request comprising RequesterID(c.a.1), Address(AS.1.1), Tag(w.1.1), and Length(d.2.1). The RPU may translate the PCIe UIOMRd to an NVLink read request comprising SourceID(b.1), DestinationID(a.1), Address(AS.2.1), Tag(c.2.1), and Length(d.2.1), and may send the NVLink read request to the second entity. Upon receiving an NVLink response from the second entity comprising SourceID(b.1), DestinationID(a.1), Tag(c.2.1), and *Data.2.1*, the RPU may translate the NVLink response to a PCIe UIO Read Completion with Data (UIORdCpID) comprising CompleterID(c.b.1), DestinationBDF/BF(c.a.1), Tag(w.1.1), and DataPayload(*Data.2.1*), and may send the PCIe UIORdCpID to the first entity. The DestinationBDF/BF field in the UIORdCpID may correspond to the RequesterID of the originating UIOMRd, facilitating routing of the completion back to the requester.

In a second exemplary transaction, the first entity may send a PCIe Memory Read (MRd) request comprising RequesterID(c.a.1), Address(AS.3.1), Tag(w.3.1), and Length(d.3.1). The RPU may translate the PCIe MRd to an NVLink read request comprising SourceID(a.1), DestinationID(b.1), Address(AS.4.1), Tag(c.4.1), and Length(d.4.1), and may send the NVLink read request to the second entity. Upon receiving an NVLink response from the second entity comprising SourceID(b.1), DestinationID(a.1), Tag(c.4.1), and *Data.4.1*, the RPU may translate the NVLink response to a PCIe Completion with Data (CpID) comprising CompleterID(c.b.1), RequesterID(c.a.1), Tag(w.3.1), and DataPayload(*Data.4.1*), and may send the PCIe CpID to the first entity. In both transactions, the RPU may generate NVLink SourceID and DestinationID values when translating from PCIe requests, and may generate PCIe CompleterID values when translating NVLink responses to PCIe completions. The RPU may maintain state information, such as pending transaction tables, to correlate PCIe Tags with NVLink Tags and to associate completions with their corresponding requests. The RPU may translate physical addresses between the PCIe address space and the NVLink address space.

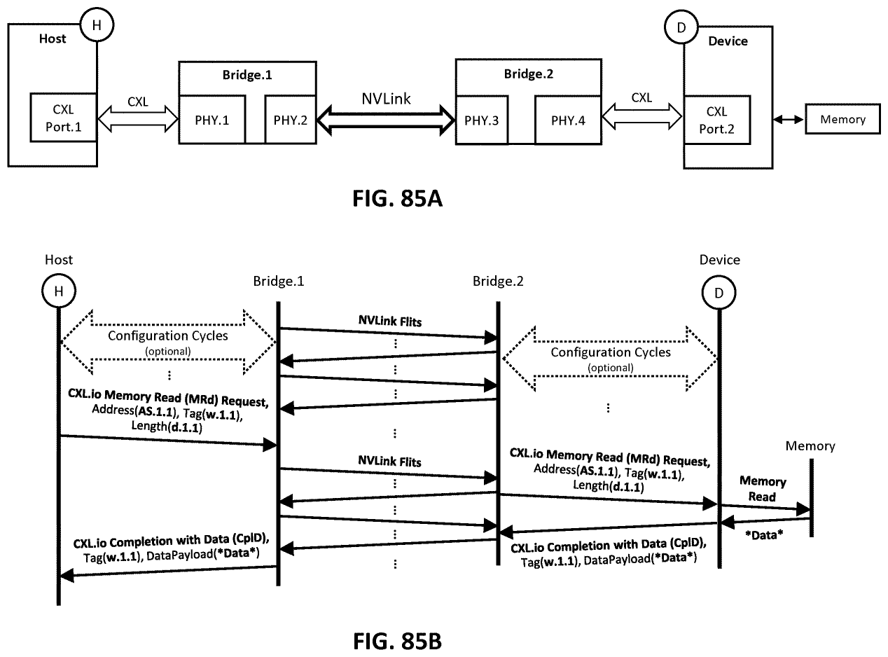

FIG. 85A illustrates an example of a system wherein a host comprising a first CXL port is coupled to Bridge.1 via a first PHY (PHY.1), which may be implemented as a Flex Bus PHY, a UCIe PHY, or an NVLink-C2C PHY. Bridge.1 communicates with Bridge.2 via a second PHY (PHY.2) which may be based on IEEE 802.3 PMA and may include an NVLink PHY instead of a UALink PHY. Bridge.2 is coupled via a fourth PHY (PHY.4) to a device comprising a second CXL port. Using NVLink PHY for inter-bridge communication demonstrates the flexibility of the bridge architecture to support different high-speed interconnect protocols while maintaining CXL protocol compatibility at the host and device interfaces.

FIG. 85B illustrates an example of a TFD depicting tunneling of CXL.io transactions between a host and a device through bridge.1 and bridge.2, utilizing physical layers based on IEEE 802.3 PMA. The TFD shows CXL.io Memory Read (MRd) request transmitted from the host through bridge.1, which translates or encapsulates the request for transmission to bridge.2 over NVLink flits, wherein bridge.2 performs the applicable translations to forward the request as a CXL.io transaction to the device ‘D’, with the corresponding CXL.io Completion with Data (CpID) response following the reverse path from the device through bridge.2 and bridge.1 back to the host ‘H’.

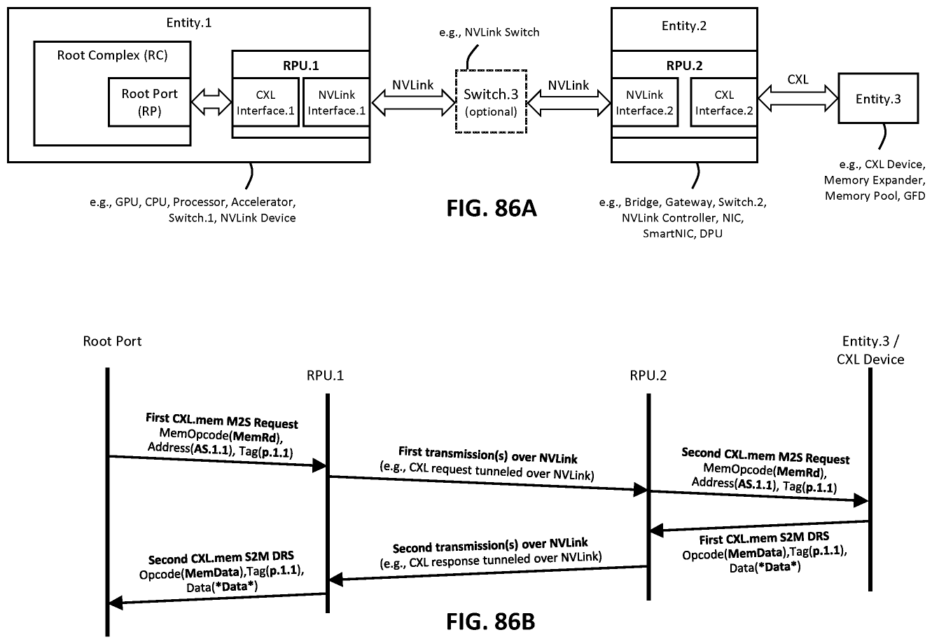

FIG. 86A illustrates an example of a system comprising a first entity (Entity.1), such as a GPU, a CPU, a processor, an accelerator, a first switch (Switch.1), or an NVLink device, wherein the first entity may include a Root Complex (RC) comprising a root port (RP), and may further include a first RPU (RPU.1) comprising a first CXL interface (CXL Interface.1) and a first NVLink Interface (NVLink Interface.1). The system may further include an optional third switch (Switch.3), such as an NVLink switch, and a second entity (Entity.2), such as abridge, a gateway, a second switch (Switch.2), an NVLink controller, a Network Interface Card (NIC), e.g., an NVLink NIC, a SmartNIC, e.g., an NVLink SmartNIC, or a Data Processing Unit (DPU), e.g., an NVLink DPU. The second entity may include a second RPU (RPU.2) comprising a second CXL interface (CXL Interface.2) and a second NVLink Interface (NVLink Interface.2). The system further includes a third entity (Entity.3), such as a CXL device, a memory expander, a memory pool, or a GFD. The first and second RPUs may enable the first entity to communicate with the third entity according to a CXL-based protocol, via the second entity and optionally via the third switch, such as by translating between CXL-based PDUs (such as TLPs, requests, messages, or flits) and transmissions comprising data indicative of CXL PDUs, such as transmissions comprising data indicative of CXL opcodes and physical addresses, wherein the transmissions utilize NVLink PDUs (such as NVLink requests, NVLink packets, or NVLink flits), which may be sent and received via the first and second NVLink interfaces, optionally enabling the first entity to access resources of the third entity, such as registers or memory.

In some examples, translating between the CXL-based PDUs and the transmissions utilizing NVLink PDUs may enable CXL over NVLink, such as via CXL tunneling over NVLink, e.g., tunneling of CXL.mem requests and responses over NVLink, tunneling of CXL.io TLPs over NVLink, tunneling of CXL-based PDUs over NVLink, or tunneling of CXL transactions over NVLink. In some examples, the first NVLink Interface and the second NVLink Interface may utilize the same physical layer technology. In other examples, the first NVLink interface and the second NVLink interface may utilize different physical layer technologies. The first RPU may be implemented in a chiplet inside an IC package of the first entity, as a functional block on the same silicon die with the RP, or may be split between dies or chiplets. Alternatively, the first RPU may be implemented as a discrete component coupled to the second entity. Additionally or alternatively, the first RPU may be included in a switch, such as in an NVLink switch.

In some examples, the first entity may be a first switch comprising the first NVLink interface, the second entity may be a second switch comprising the second NVLink interface, and the CXL traffic between the first and second switches may be tunneled over NVLink. Optionally, the first and second switches may be coupled by the third switch, which may be an NVLink switch. In other examples, the first entity may be a first switch comprising the first CXL interface (CLX Interface.1), the second entity may be a second switch comprising the second CXL Interface (CXL Interface.2), and the CXL traffic between the RP and the third entity (e.g., a CXL device) may be tunneled over NVLink via the second switch and optionally via the third switch, which may be an NVLink switch.

FIG. 86B illustrates an example of a TFD demonstrating a CXL communication between a first entity (Entity.1), such as a processor comprising a root port (RP), and a third entity (Entity.3), such as a CXL device, wherein the CXL communication may be tunneled over NVLink. The first entity may initiate a read from the third entity, such as by sending a first CXL.mem M2S request comprising MemOpcode(MemRd), Address(AS.1.1), and Tag(p.1.1) via the RP. The first RPU (RPU.1), which may reside in the first entity, may receive the first CXL.mem M2S request and translate it to first transmission(s) comprising data indicative of CXL PDU, such as transmission(s) comprising data indicative of CXL opcodes and physical addresses, wherein the first RPU may send the first transmission(s) which may utilize one or more NVLink PDUs (such as NVLink requests, NVLink packets, or NVLink flits), to a second RPU (RPU.2), which may reside in a second entity, such as a bridge or a gateway. The first RPU may further translate the first CXL.mem M2S request to the first transmission(s) in a manner that enables reconstruction of the first CXL.mem M2S request at the second RPU with minimal (or no) modifications, effectively tunneling the first CXL.mem M2S request over NVLink. For example, the first RPU may encapsulate the first CXL.mem M2S request into an NVLink request, such as an NVLink write request, and send the NVLink request to the second RPU, wherein the CXL request may be extracted from the NVLink request such as by decapsulation. Additionally or alternatively, the first RPU may encapsulate a CXL flit comprising the first CXL.mem M2S request into an NVLink request, such as an NVLink write request, and send the NVLink request to the second RPU, wherein the CXL flit comprising the first CXL.mem M2S request may be extracted from the NVLink request such as by decapsulation. The second RPU may receive the first transmission(s) and translate it to a second CXL.mem M2S request comprising MemOpcode(MemRd), Address(AS.1.1), and Tag(p.1.1), and send the second CXL.mem M2S request to the third entity. In some examples, the first CXL.mem M2S request and the second CXL.mem M2S request may be identical, whereas in other examples the second RPU may construct the second CXL.mem M2S request based on the first CXL.mem M2S request with variations such as utilizing a different opcode (e.g., MemRdData instead of MemRd), utilizing a different Tag namespace, e.g., Tag(q.2.1) instead of Tag (p.1.1), or utilizing address translations, e.g., Address(AS.2.1) instead of Address(AS.1.1).

The third entity may respond to the second CXL.mem M2S request by sending a first CXL.mem S2M DRS comprising Opcode(MemData), Tag(p.1.1), and Data(*Data*) to the second RPU, wherein the second RPU may translate the first CXL.mem S2M DRS to second transmission(s) comprising data indicative of CXL PDU, and send the second transmission(s) to the first RPU. The first RPU may further receive the second transmission(s) and translate it to a second CXL.mem S2M DRS comprising Opcode(MemData), Tag(p.1.1), and Data(*Data*), and send the second CXL.mem S2M DRS to the RP. In some examples, the first CXL.mem S2M DRS and the second CXL.mem S2M DRS may be identical, whereas in other examples the first RPU may construct the second CXL.mem S2M DRS based on the first CXL.mem S2M DRS with variations, such as updating fields, e.g., Device Load (DevLoad), MetaField, MetaValue, TRP, Opcode, or reserved fields. Additionally or alternatively, the first RPU may alter the structure of the second CXL.mem S2M DRS compared to the original first CXL.mem S2M DRS, such as by adding a trailer.

In some examples, the second CXL.mem M2S request may be different from the first CXL.mem M2S request due to differences in protocol revisions, such as when the first RPU communicates with the RP according to CXL 1.1, whereas the second RPU communicates with the third entity according to CXL 3.2, or such as when message format conversion is required between HBR and PBR formats, e.g., when the second RPU utilizes PBR mode or PBR messages, whereas, for example, the RP is associated with an HBR host. Similarly, the second CXL.mem S2M DRS may be different from the first CXL.mem S2M DRS due to differences in protocol revisions, or such as when message format conversion is required between HBR and PBR formats. In some examples, the first RPU and the second RPU may be coupled by a switch, such as a UALink switch.

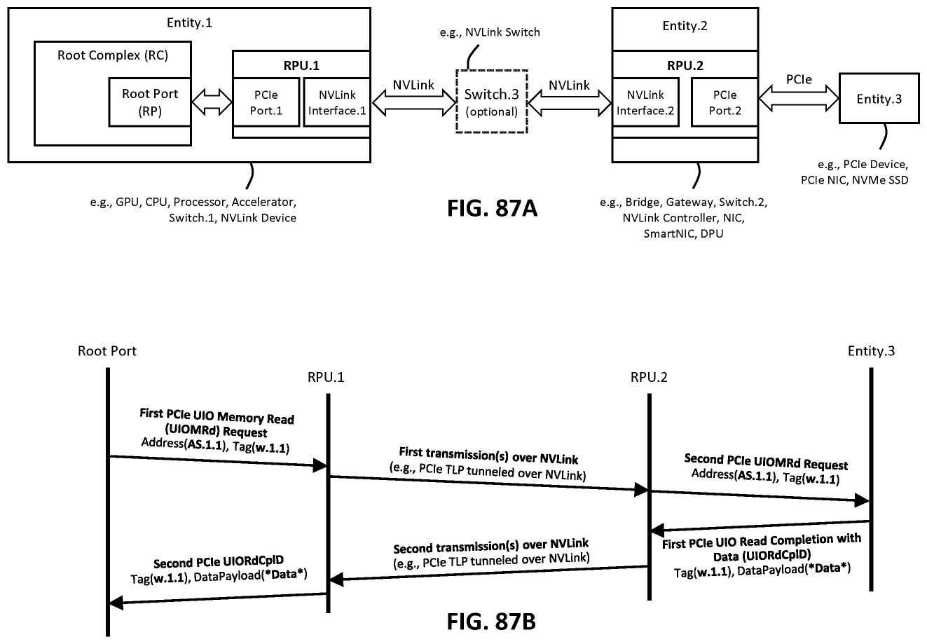

FIG. 87A illustrates an example of a system comprising a first entity (Entity.1), such as a GPU, a CPU, a processor, an accelerator, a first switch (Switch.1), or an NVLink device, wherein the first entity may include a Root Complex (RC) comprising a root port (RP), and may further include a first RPU (RPU.1) comprising a first PCIe port (PCIe Port.1) and a first NVLink Interface (NVLink Interface.1). The system may further include an optional third switch (Switch.3), such as a NVLink switch, and a second entity (Entity.2), such as a bridge, a gateway, a second switch (Switch.2), an NVLink controller, a Network Interface Card (NIC), e.g., an NVLink NIC, a SmartNIC, e.g., an NVLink SmartNIC, or a Data Processing Unit (DPU), e.g., an NVLink DPU. The second entity may include a second RPU (RPU.2) comprising a second PCIe port (PCIe Port.2) and a second NVLink Interface (NVLink Interface.2). The system further includes a third entity (Entity.3), such as a PCIe device, a PCIe NIC, or an NVMe SSD. The first and second RPUs may enable the first entity to communicate with the third entity according to a PCIe-based protocol, via the second entity and optionally via the third switch, such as by translating between PCIe-based PDUs (such as PCIe TLPs, requests, messages, or flits) and transmissions comprising data indicative of PCIe PDUs, such as transmissions comprising data indicative of PCIe TLP types and physical addresses, wherein the transmissions utilize NVLink PDUs (such as NVLink requests, NVLink packets, or NVLink flits), which may be sent and received via the first and second NVLink interfaces, optionally enabling the first entity to access resources of the third entity, such as registers or memory.

In some examples, translating between the PCIe-based PDUs and the transmissions utilizing NVLink PDUs may enable PCIe over NVLink, such as via PCIe tunneling over NVLink, e.g., tunneling of PCIe requests and completions over NVLink, tunneling of PCIe TLPs over NVLink, tunneling of PCIe-based PDUs over NVLink, or tunneling of PCIe transactions over NVLink. In some examples, the first NVLink Interface and the second NVLink Interface may utilize the same physical layer technology. In other examples, the first NVLink interface and the second NVLink interface may utilize different physical layer technologies. The first RPU may be implemented in a chiplet inside an IC package of the first entity, as a functional block on the same silicon die with the RP, or may be split between dies or chiplets. Alternatively, the first RPU may be implemented as a discrete component coupled to the second entity. Additionally or alternatively, the first RPU may be included in a switch, such as in an NVLink switch.

In some examples, the first entity may be a first switch, such as a first PCIe switch comprising the first NVLink interface, the second entity may be a second switch, such as a second PCIe switch comprising the second NVLink interface, wherein the PCIe traffic between the first PCIe switch and the second PCIe switch may be tunneled over NVLink, and wherein the first PCIe switch and the second PCIe switch may be coupled by the third switch, that may be an NVLink switch. In other examples, the first entity may be a first switch, such as a first NVLink switch comprising the first PCIe Port (PCIe Port.1), the second entity may be a second switch, such as a second NVLink switch comprising the second PCIe Port (PCIe Port.2), wherein the PCIe traffic between the RP and the third entity (e.g., a PCIe device) may be tunneled over NVLink via the second NVLink switch and optionally via the third switch, such as a third NVLink switch.

FIG. 87B illustrates an example of a TFD demonstrating PCIe communication between a first entity (Entity.1), such as a processor comprising a root port (RP), and a third entity (Entity.3), such as a PCIe device, wherein the PCIe communication may be tunneled over NVLink. The first entity may initiate a read from the third entity, such as by sending a first PCIe UIO Memory Read (UIOMRd) request comprising Address(AS.1.1) and Tag(w.1.1) via the RP. The first RPU (RPU.1), which may reside in the first entity, may receive the first PCIe UIOMRd and translate it to first transmission(s) comprising data indicative of PCIe PDU, such as transmission(s) comprising data indicative of TLP types and physical addresses, wherein the first RPU may send the first transmission(s) which may utilize one or more NVLink PDUs (such as NVLink requests, NVLink packets, or NVLink flits), to a second RPU (RPU.2), which may reside in a second entity, such as a bridge or a gateway. The first RPU may further translate the first PCIe UIOMRd to the first transmission(s) in a manner that enables reconstruction of the first PCIe UIOMRd at the second RPU with minimal (or no) modifications, effectively tunneling the first PCIe UIOMRd over NVLink. For example, the first RPU may encapsulate the first PCIe UIOMRd into an NVLink request, such as an NVLink write request, and send the NVLink request to the second RPU, wherein the PCIe request may be extracted from the NVLink request such as by decapsulation. Additionally or alternatively, the first RPU may encapsulate a PCIe flit comprising the first PCIe UIOMRd into an NVLink request, such as an NVLink write request, and send the NVLink request to the second RPU, wherein the PCIe flit comprising the first PCIe UIOMRd may be extracted from the NVLink request such as by decapsulation.

The second RPU may receive the first transmission(s) and translate it to a second PCIe UIOMRd comprising Address(AS.1.1) and Tag(w.1.1), and send the second PCIe UIOMRd to the third entity. In some examples, the first PCIe UIOMRd and the second PCIe UIOMRd may be identical, whereas in other examples, the second RPU may construct the second PCIe UIOMRd based on the first PCIe UIOMRd with variations such as utilizing a different TLP type (e.g., MRd instead of UIOMRd), utilizing a different Tag namespace, e.g., Tag(q.2.1) instead of Tag (w.1.1), or utilizing address translations, e.g., Address(AS.2.1) instead of Address(AS.1.1). The third entity may respond to the second PCIe UIOMRd by sending a first PCIe UIO Read Completion with Data (UIORdCpID) comprising Tag(w.1.1) and DataPayload(*Data*) to the second RPU, wherein the second RPU may translate the first PCIe UIORdCpID to second transmission(s) comprising data indicative of PCIe PDU, and send the second transmission(s) to the first RPU. The first RPU may further receive the second transmission(s) and translate it to a second PCIe UIORdCpID comprising Tag(w.1.1) and DataPayload(*Data*), and send the second PCIe UIORdCpID to the RP.

In some examples, the first PCIe UIORdCpID and the second PCIe UIORdCpID may be identical, whereas in other examples, the first RPU may construct the second PCIe UIORdCpID based on the first PCIe UIORdCpID with variations, such as updating fields, e.g., reserved fields or fields treated as reserved, such as CDL that may represent CXL device load for QoS telemetry, where this field may be treated as reserved for use cases not covered by CXL. Additionally or alternatively, the first RPU may alter the structure of the second PCIe UIORdCpID compared to the original first PCIe UIORdCpID, such as by adding a TLP trailer, such as for supporting Transaction Layer end-to-end 32-bit CRC (ECRC) that may cover the path between the second RPU and the RP.

In some examples, the second PCIe UIOMRd may be different from the first PCIe UIOMRd due to differences in protocol revisions, such as when the first RPU communicates with the RP according to a first PCIe specification revision, whereas the second RPU communicates with the third entity according to a second PCIe specification revision (that may be different than the first PCIe specification revision), or such as when translation is required between Flit Mode (FM) and Non-Flit Mode (NFM) TLP formats. Similarly, the second PCIe UIORdCpID may be different from the first PCIe UIORdCpID due to differences in protocol revisions, or such as when translation is required between FM and NFM TLP formats. In some examples, the first RPU and the second RPU may be coupled by a switch, such as an NVLink switch.

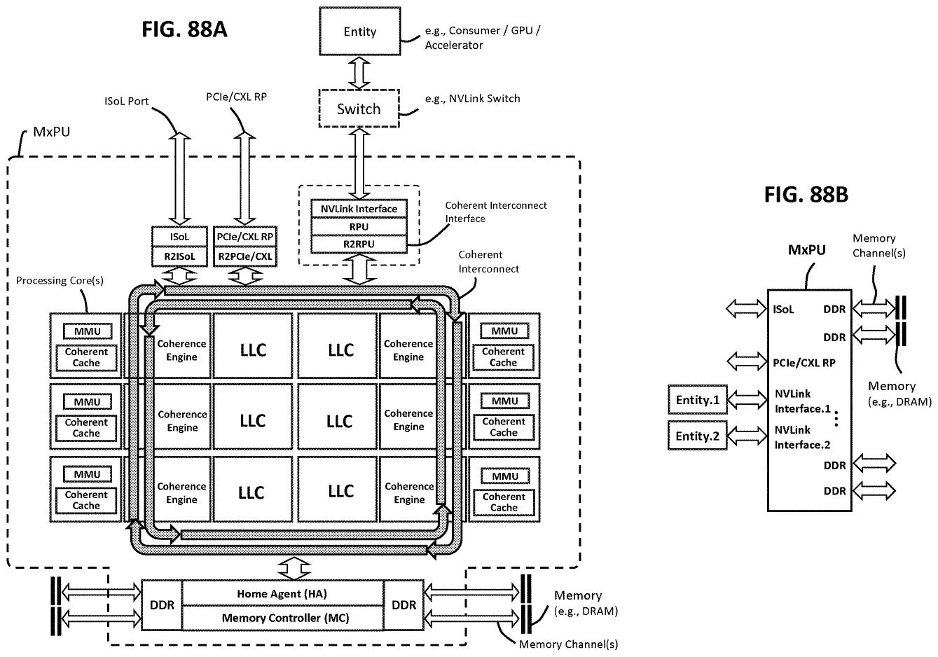

FIG. 88A illustrates an example of a processor (such as an MxPU that may be derived from an established processor design) comprising processing cores, last level cache (LLC), and a coherent interconnect utilizing a topology structure of a ring. Alternatively, the coherent interconnect may utilize other topology structures such as a mesh, a crossbar, or a custom topology. The processor may include an NVLink interface, and an ISoL port, such as a port utilizing ARM CHI C2C, NVIDIA NVLink-C2C, Intel UPI, or AMD Infinity Fabric. The processor may further include a PCIe/CXL root port (PCIe/CXL RP), and may be coupled to memory, such as DRAM, optionally via a memory controller and memory channels. The NVLink interface may communicate with an entity, such as a GPU or a CPU, optionally via a switch, according to an NVLink-based protocol, wherein an RPU may perform physical address translations that may enable the entity to access the memory via the NVLink interface. The illustrated RPU is coupled to the on-chip ring interconnect via a coherent interconnect interface, such as a Ring-to-RPU (R2RPU). Alternatively, the RPU may be coupled to the on-chip ring interconnect essentially directly. Similarly, the illustrated ISoL port is coupled to the on-chip ring interconnect via a coherent interconnect interface, such as a Ring-to-ISoL (R2ISoL), and the PCIe/CXL RP is coupled to the on-chip ring interconnect via a coherent interconnect interface, such as a Ring-to-PCIe/CXL (R2PCIe/CXL). The processor may be implemented as a monolithic die, as chiplets within an IC package, such as by utilizing separate compute die(s) and I/O die(s), or as components on a board.

FIG. 88B illustrates an example of a processor (such as an MxPU) comprising NVLink interfaces, DDR channels, at least one optional PCIe/CXL RP, and at least one optional ISoL. The NVLink interfaces may not utilize the same physical address space, may be coupled to entities, optionally via a switch, and may communicate with the entity according to one or more NVLink-based protocols.

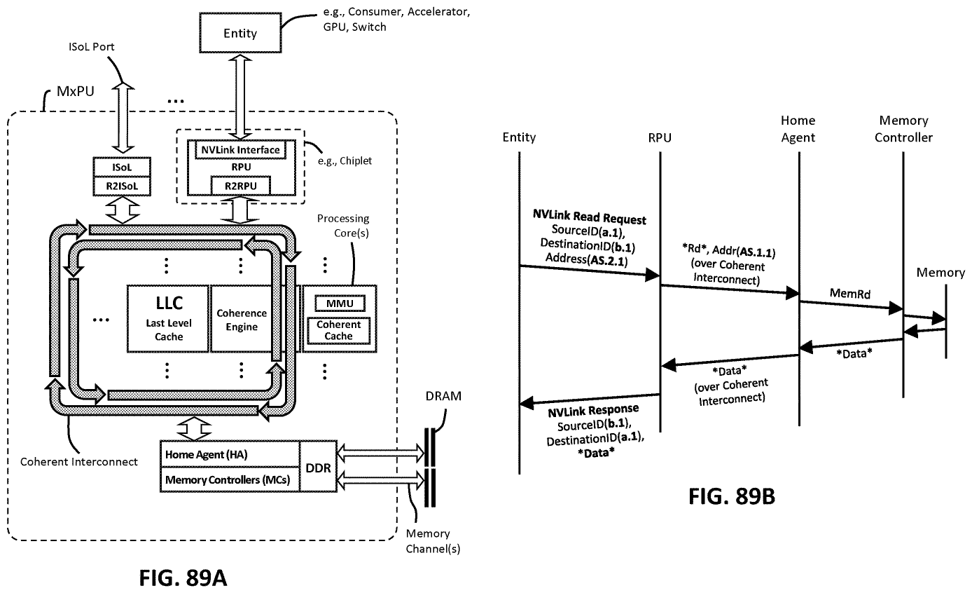

FIG. 89A illustrates an example of a processor (such as an MxPU) comprising processing cores, caches, and a coherent interconnect utilizing a topology structure of a ring. Alternatively, the coherent interconnect may utilize other topology structures such as a mesh, a crossbar, or a custom topology. The processor may further include an ISoL port such as ARM CHI C2C, NVIDIA NVLink-C2C, or Intel UPI, and memory controllers coupled via memory channels to memory, such as DRAM. The processor may include an NVLink interface that may communicate with an entity such as a GPU or an accelerator, according to an NVLink-based protocol, wherein an RPU may perform physical address translations to enable the entity to access the memory. The illustrated RPU is coupled to the coherent interconnect via a Ring-to-RPU (R2RPU) interconnect interface. Alternatively, the RPU may be coupled to the on-chip ring interconnect essentially directly. In some examples, the RPU, the NVLink interface, and the R2RPU may reside on a chiplet, such as an NVLink chiplet or NVLink Fusion, and coupled to the coherent interconnect via a chip-to-chip (C2C) interface. Similarly, the illustrated ISoL port may be coupled to the on-chip ring interconnect via a Ring-to-ISoL (R2ISoL) interconnect interface. The processor may be implemented as a monolithic die that includes the RPU and the NVLink interface, as silicon dies or chiplets within an IC package, such as by utilizing separate compute die(s) and I/O die(s), or as components on a board.

FIG. 89B illustrates an example of a TFD demonstrating an NVLink read request received from an entity, such as a GPU or an accelerator, wherein the RPU may translate a physical address (AS.2.1) carried in the NVLink request, to a physical address (AS.1.1) utilized for accessing the memory. The NVLink request may carry ID-based fields, such as source ID and destination ID, which may be utilized by NVLink switches for routing the request. In some examples, the NVLink request may further include a Tag that may be utilized to identify a transaction and match it with a corresponding NVLink response, and may further include a Length field that may specify the length of the data transfer requested. In some examples, the RPU may translate an NVLink request to multiple read transactions of the protocol utilized by the coherent interconnect, such as in order to fulfill the length of the data transfer specified in the NVLink request. The RPU may perform further translations, such as protocol translations from an NVLink-based protocol to a protocol utilized by the processor's coherent interconnect, and may further send the optionally translated request to a home agent (also known as home node), and/or to a memory controller, requesting the read of address (AS.1.1). In some examples, the requested data may be provided by a processor cache, such as by an LLC, instead of being provided by the memory. The data may then return over the processor's coherent interconnect to the RPU, wherein the RPU provides an NVLink response to the requesting entity. In some examples, the NVLink response may include a Tag that may identify the transaction and may enable matching the NVLink response with a corresponding NVLink request.

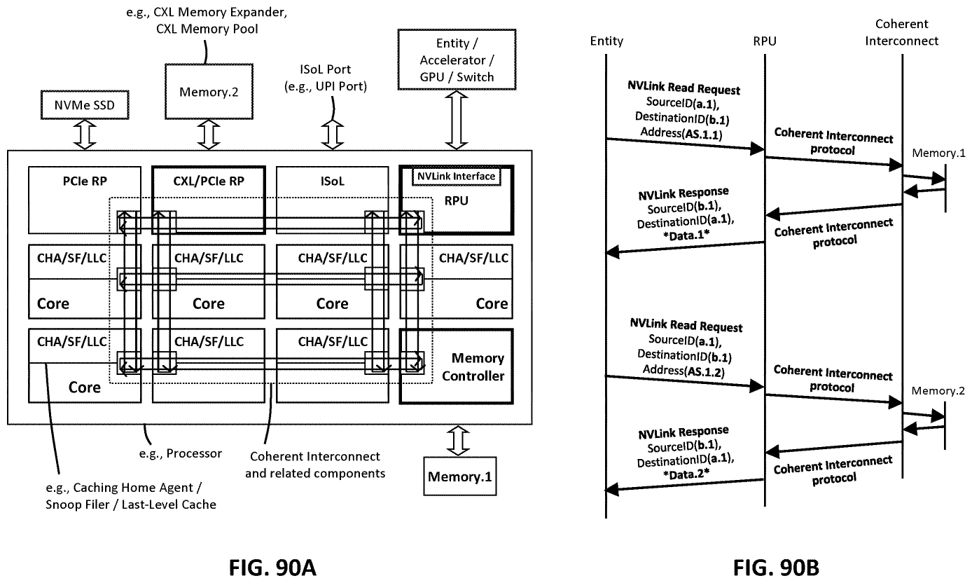

FIG. 90A illustrates an example of a system comprising a processor, including a coherent interconnect, capable of enabling an external entity to access memory resources mapped to the address space utilized by the coherent interconnect. Optionally, the processor may include an MxPU derived from an established processor design that may include processing cores, caching/home agent (CHA), snoop filter (SF), and last-level cache (LLC), optionally implemented as slices distributed across tiles on the coherent interconnect mesh. The processor may further include an ISoL port (such as a port utilizing Intel Coherent Processor Interconnect Protocol (ICPIP), or ARM CHI C2C), a PCIe RP that may be coupled to an NVMe SSD, a CXL/PCIe RP, and/or a memory controller that may be coupled to a first memory, such as DRAM. The processor may be coupled to a second memory, such as a CXL memory expander or a CXL memory pool, and may further include an RPU that includes or coupled to an NVLink interface that may communicate with an entity, such as an accelerator, according to an NVLink-based protocol, wherein the RPU may perform physical address translations to enable the entity to access the first memory (Memory.1) and/or the second memory (Memory.2). The illustrated RPU may be coupled to the coherent interconnect, and may translate between the NVLink-based protocol and a protocol utilized by the coherent interconnect. The processor may be implemented as a monolithic die, as chiplets within an IC package, such as by utilizing separate compute die(s) and I/O die(s), or as components on a board, and may utilize a mesh-based coherent interconnect, or in other examples may utilize a ring, a crossbar, or other types of coherent interconnects. In other examples, the NVLink interface may reside on a separate chiplet, such as an NVLink Fusion, and may be coupled to the coherent interconnect via a UCIe interface or a proprietary chip-to-chip or die-to-die interface.

FIG. 90B illustrates an example of a TFD demonstrating two NVLink requests, such as NVLink read requests, received from an entity (such as an accelerator, GPU, or a switch) and forwarded to different memories mapped to an address space utilized by the coherent interconnect. The RPU may perform physical address translations to enable the entity to access the processor's memories. The processor may have multiple memory resources, such as DRAM coupled to a memory controller of the processor, and/or memory expanders that may be coupled to a CXL RP of the processor. The RPU may further translate from NVLink-based traffic to traffic conforming to a protocol utilized by the coherent interconnect, and may send the optionally translated traffic to the coherent interconnect, requesting a read from memory. In some examples, the requested data may be provided by a processor cache, such as by an LLC, instead of by the memory. The data may then return over the coherent interconnect to the RPU, wherein the RPU provides an NVLink response to the requesting entity. The TFD illustrates two exemplary transactions carrying different physical addresses mapped to different memory resources. The first exemplary transaction includes an NVLink request comprising physical address (AS.1.1), which the RPU translates and forwards via the coherent interconnect protocol to Memory.1, resulting in the retrieval of *Data.1* that is returned to the entity with the first NVLink response. The second exemplary transaction includes an NVLink request comprising physical address (AS.1.2), which the RPU translates and forwards via the coherent interconnect protocol to Memory.2, resulting in the retrieval of *Data.2* that is returned to the entity with the second NVLink response. The physical addresses (AS.1.1) and (AS.1.2) may refer to different memory regions within the address space utilized by the coherent interconnect, enabling the entity to access memory resources based on the RPU's translation capabilities.

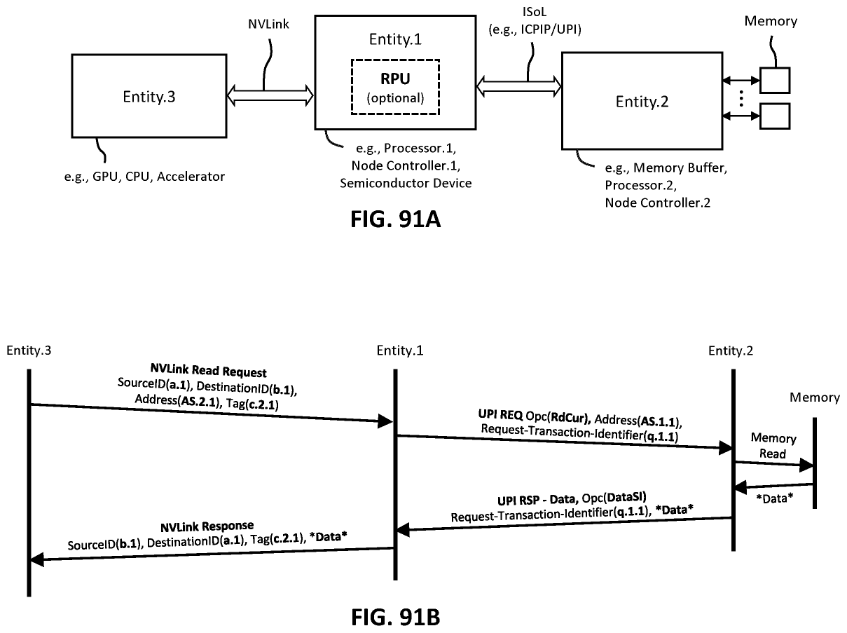

FIG. 91A illustrates an example of a system comprising a first entity (Entity.1), such as a first processor (Processor.1), a first node controller (Node Controller.1), or a semiconductor device, which may include an RPU. The first entity may be coupled to a third entity (Entity.3), which may be an accelerator, a GPU, a CPU, or an NVLink switch, wherein the first entity may communicate with the third entity according to an NVLink-based protocol, such as a protocol utilizing an NVLink interconnect. The first entity may be further coupled to a second entity (Entity.2), which may be a second processor (Processor.2), a memory buffer, or a second node controller (Node Controller.2), wherein the second entity may be coupled to memory, and wherein the first entity may communicate with the second entity according to an ISoL protocol, such as ARM CHI C2C, a protocol utilizing an NVIDIA NVLink-C2C interconnect, or Intel Coherent Processor Interconnect Protocol (ICPIP), such as Intel UPI. The first node controller (Node Controller.1) and the second node controller (Node Controller.2) may each include an ICPIP node controller, such as a UPI node controller (UNC), or an external node controller (e.g., XNC).

The first entity, optionally via the RPU, may translate between messages conforming to the NVLink-based protocol and messages conforming to the ISoL protocol, such as ICPIP, enabling the third entity to access resources coupled to the first entity (Entity.1), such as the memory that may be coupled to the second entity. In some examples, messages conforming to the NVLink-based protocol may be associated with a first address space, such as an NVLink-based address space, an NVLink-based network address space, or a GPU address space; and messages conforming to the ISoL protocol, such as ICPIP (e.g., Intel UPI), may be associated with a second address space, such as a System Physical Address (SPA) space or a Host Physical Address (HPA) space; wherein the first entity, optionally via the RPU, may perform address translations between addresses within the first and second address spaces, respectively, such as between addresses within the NVLink-based address space and addresses within the SPA space or the HPA space. In other examples, messages conforming to the NVLink-based protocol and messages conforming to the ISoL protocol, such as ICPIP (e.g., Intel UPI), may be associated with the same physical address space, such as with a global address space, a partitioned global address space (PGAS), a pod address space, a virtual pod address space, or a fabric address space; wherein the first entity, optionally via the RPU, may perform address translations between addresses within the same address spaces.

The first entity, optionally via the RPU, may perform further translations, such as protocol translations, opcode translations, command translations, TLP translations, or field translations (e.g. cross-field translations), such as between request types of NVLink requests and opcodes in requests conforming to the ISoL Protocol (e.g., Intel UPI RdCur opcode). The first entity, optionally via the RPU, may further translate between values of fields carried in PDUs of the NVLink-based protocol and in PDUs of the ISoL Protocol, e.g., translate traffic class (TC) and/or Tags, wherein the first entity, optionally via the RPU, may maintain tracking between Tags associated with the NVLink-based protocol and Tags associated with the ISoL protocol, such as in order to associate responses with their corresponding requests, within the same domain and/or between different domains.

FIG. 91B illustrates an example of a TFD demonstrating translations performed by a first entity (Entity.1), such as a first processor (Processor.1), a first node controller (Node Controller.1), or a semiconductor device, optionally via an RPU, between NVLink-based traffic and ISoL traffic, such as ICPIP traffic. The NVLink-based traffic may be utilized for communicating with a third entity (Entity.3), such as an accelerator, and the ISoL traffic may be utilized for communicating with a second entity (Entity.2), such as a second processor (Processor.2), or a second node controller (Node Controller.2). The second entity may be coupled to a memory, such as DRAM, which may be mapped to a physical address space (PAS) utilized by the first entity. The third entity may initiate an NVLink request, such as an NVLink read request, comprising SourceID(a.1), DestinationID(b.1), Address(AS.2.1), and Tag(c.2.1), wherein SourceID(a.1) may identify the source entity in the NVLink interconnect, such as the source GPU, wherein DestinationID(b.1) may identify the destination entity in the NVLink interconnect, such as the destination GPU, and wherein the NVLink interconnect may utilized ID-based routing when forwarding the NVLink request. The first entity, optionally via the RPU, may translate the NVLink request to an ISoL (e.g., ICPIP) transaction, such as an Intel UPI transaction that may include a UPI request (REQ message class) comprising Opc(RdCur), Address(AS.1.1), and Request-Transaction-Identifier(q.1.1), wherein the Request-Transaction-Identifier (e.g., RTID) may denote a Tag, a transaction Tag, a transaction identifier, or another field or set of fields carried in UPI transactions which may serve to associate responses with their corresponding requests. The first entity may send the UPI request (REQ) to the second entity.

Upon receiving a response from the second entity, that may include a UPI data response (“RSP—Data” message class, which may also be denoted by “RSP4—Data”) comprising Opc(DataSI), Request-Transaction-Identifier(q.1.1), and *Data*, the first entity, optionally via the RPU, may translate the UPI response (RSP—Data) to an NVLink response comprising SourceID(b.1), DestinationID(a.1), Tag(c.2.1), and *Data*. In some examples, the requested data may be provided by a processor cache instead of by the memory, such as wherein the requested data may be provided by an LLC that may be included in the first entity, or by an LLC that may be included in the second entity. In other examples, the first entity (Entity.1), optionally via the RPU, may translate the NVLink request to an ICPIP transaction, such as an Intel UPI transaction, that may include message classes such as REQ, SNP, WB, RSP (such as RSP2 or RSP4), NCB, or NCS, that may include commands, operations, or opcodes (e.g., Opc), such as RdCode, RdCur, RdData, RdInv, RdInvOwn, SnpCode, SnpCur, SnpData, SnpInv, WbMtoS, WcWr, WcWrPtl, DataE, DataSI, or DataM_CmpO. The first entity, optionally via the RPU, may perform further translations, such as protocol translations, opcode translations, command translations, or translations between protocol data units (PDUs) of the NVLink-based traffic and PDUs of the ISoL traffic (e.g., Intel UPI), such as traffic class (TC) translations, cross-field translations, or Tag translations. The first entity, optionally via the RPU, may maintain tracking between Tags in the NVLink-based domain and Tags in the ISoL domain, such as in order to associate responses with their corresponding requests, within the same domain and/or between different domains.

In various implementations, an apparatus comprising: processing cores coupled via an interconnect to memory controllers coupled to memory channels capable of supporting memory having a capacity of at least 64 GB; wherein the interconnect utilizes a protocol based on Coherent Hub Interface (CHI-based protocol); first and second resource provisioning units (RPUs) comprising first and second NVLink interfaces and first and second CHI interfaces; wherein the first and second NVLink interfaces utilize differential pairs and are capable of communicating according to NVLink-based protocol with first and second entities external to the apparatus, respectively; and wherein the first and second RPUs are configured to translate between messages conforming to the NVLink-based protocol and messages conforming to the CHI-based protocol to enable the first and second entities to access in parallel the memory via the respective first and second NVLink interfaces and the interconnect. Sentences in the form of “access the memory” encompass accessing at least a portion of the memory, where the portion may range from a minimal addressable unit to the entire memory capacity, indicating open-ended claim language.

In some implementations of the apparatus, the first entity comprises a graphics processing unit (GPU) configured to: access dynamic random-access memory (DRAM) coupled to the memory channels via the first NVLink interface and the first RPU, and receive memory access requests from the processing cores targeting GPU-attached memory; wherein the first RPU is further configured to translate CHI-based requests to NVLink-based requests. The bidirectional communication may enable the GPU to function as both an initiator of memory transactions to system DRAM and a target for processor-initiated accesses to GPU-attached memory such as HBM. The RPU may maintain transaction context for both directions, managing protocol differences in flow control, credit management, and response generation between the NVLink and CHI-based domains.

In some implementations of the apparatus, the interconnect is a coherent interconnect, the GPU comprises on-package high-bandwidth memory (HBM), and the first RPU translates CHI-based write-back traffic targeting the HBM to NVLink-based traffic.

In some implementations of the apparatus, the interconnect is a coherent interconnect, the first RPU is further configured to maintain translations from first physical addresses associated with the first NVLink interface to physical addresses associated with the coherent interconnect, and the second RPU is further configured to maintain separate translations from second physical addresses associated with the second NVLink interface to the physical addresses associated with the coherent interconnect.

In some implementations of the apparatus, the interconnect comprises first and second interconnect components, the first RPU is coupled to the first interconnect component, and the second RPU is coupled to the second interconnect component, whereby the apparatus provides distributed bandwidth for the first and second entities to access resources.

In some implementations of the apparatus, a path between at least one of the first or second RPUs and at least one memory controller and/or processing core comprises one interconnect component. In some implementations, the RPU and at least one memory controller may be coupled to the same interconnect component, providing a low-latency communication path between the NVLink interface and memory attached to the xPU.

In some implementations of the apparatus, each of the first and second RPUs exposes registers accessible utilizing memory-mapped I/O (MMIO) operations via an Advanced Microcontroller Bus Architecture (AMBA) Advanced Peripheral Bus (APB) interface, enabling detection of RPU presence, NVLink-interface status, and translation capabilities.

In some implementations of the apparatus, each of the first and second RPUs is configured to: translate physical addresses associated with the respective NVLink-based protocol to physical addresses associated with the CHI-based protocol, and translate NVLink command encodings to corresponding CHI opcodes.

In some implementations of the apparatus, at least one of the first or second RPUs comprises a gateway utilizing a streaming interface protocol based on Advanced Microcontroller Bus Architecture (AMBA) Credited eXtensible Stream (CXS); and wherein the first and second entities are accelerators, from which at least one comprises a graphics processing unit (GPU).

In some implementations of the apparatus, each of the first and second RPUs comprises a request node that does not include a hardware-coherent cache and is configured to communicate with the interconnect according to the CHI-based protocol; and wherein the first and second entities are accelerators, from which at least one comprises a graphics processing unit (GPU). In some implementations of the apparatus, at least one of the request nodes comprises an I/O-coherent request node (RN-I) or an I/O-coherent Request Node with Distributed Virtual Memory support (RN-D). In some implementations of the apparatus, the interconnect comprises at least one crosspoint comprising at least four mesh ports and at least two device ports, wherein at least one of the first or second RPUs is coupled to one of the at least two device ports; and wherein the first and second entities are accelerators, from which at least one comprises a graphics processing unit (GPU).

In some implementations of the apparatus, each of the first and second NVLink interfaces supports virtual channels, and the respective RPUs map the virtual channels to corresponding quality-of-service fields of the CHI-based protocol. In some implementations of the apparatus, the mapping between NVLink virtual channels and CHI quality-of-service fields is programmable via the MMIO registers exposed by the RPUs. In some implementations of the apparatus, the memory comprises dynamic random-access memory (DRAM) having a capacity of at least 256 GB; wherein the first and second entities are accelerators, from which at least one comprises a graphics processing unit (GPU); and wherein the first and second entities can access in parallel different regions of the DRAM.

In some implementations, the apparatus further comprises a third NVLink interface coupled via a third RPU to the interconnect, enabling a third entity to access resources via the third NVLink interface and the interconnect, while maintaining I/O-coherency without cache coherency participation. The implementation may be scaled to support multiple NVLink-coupled entities, with their own translation paths through the I/O-coherent or non-coherent nodes, enabling high-bandwidth parallel access to system memory resources while the CHI-based protocol maintains appropriate ordering and coherency at the I/O level without requiring the NVLink entities to participate in cache coherency protocols. In some implementations of the apparatus, each of the first and second RPUs maintains a link translation look-aside buffer that translates NVLink network addresses, including destination identifiers, into physical addresses employed by the interconnect.

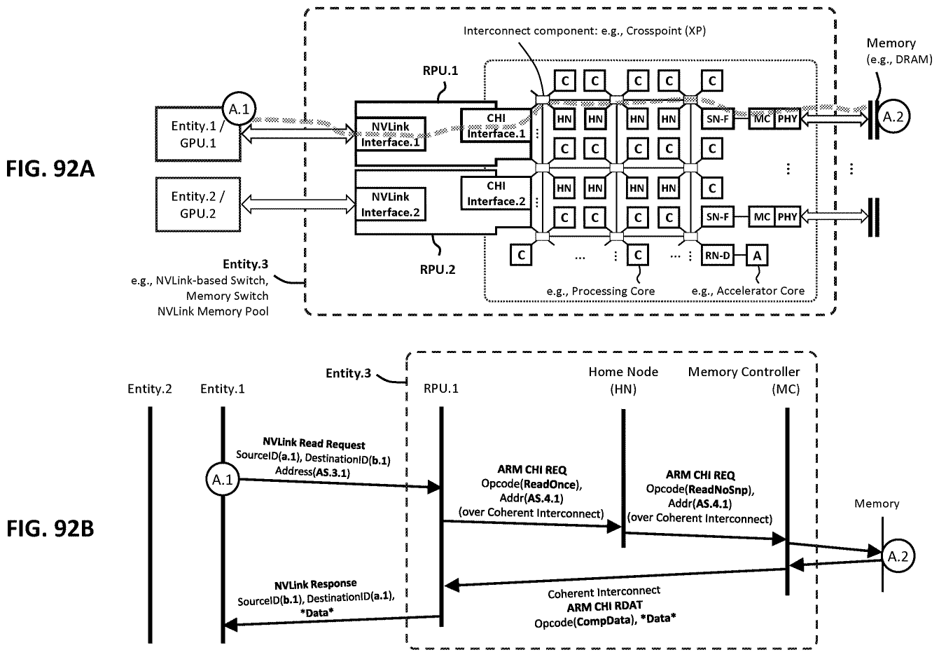

FIG. 92A illustrates an example of a memory switch configured to provide memory to entities coupled to it. Entity.1 is coupled to the memory switch wherein the entity may utilize the memory coupled to the coherent interconnect. The memory switch may function as an NVLink-based switch or an NVLink memory pool, providing switching capabilities between entities while also enabling access to memory resources.

FIG. 92B illustrates an example of a TFD demonstrating an NVLink request from Entity.1 to access memory. RPU.1 receives an NVLink request carrying a read request comprising an address, and translates it to an ARM CHI request comprising ReadOnce, potentially with a different address due to address translation. The request flows through the coherent interconnect to a home node (HN), which may translate it to a ReadNoSnp transaction destined to a memory controller (MC). The MC retrieves the data from memory and may return the data to RPU.1 without routing through the HN, or alternatively may send the data through the HN to RPU.1. Then RPU.1 generates the NVLink response with the data to Entity.1.

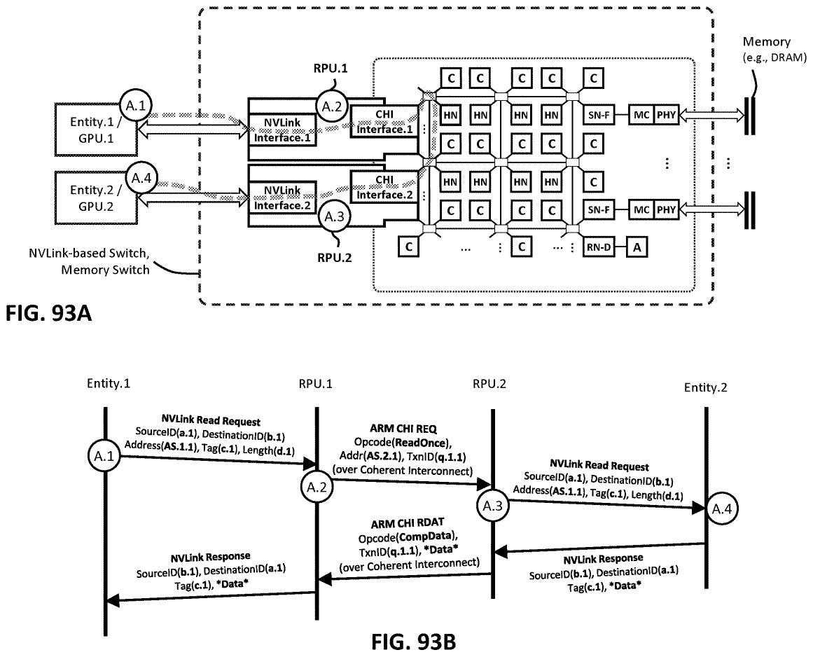

FIG. 93A illustrates an example of a system that implements an NVLink-based switch, or an NVLink Memory Switch, utilizing a CHI-based interconnect. The switch is coupled to two entities marked in the figure as Entity.1/GPU.1 and Entity.2/GPU.2. The switch may include processing cores, accelerator cores such as security accelerators, and memory controllers, coupled to the CHI-based interconnect. The switch utilizes translations, performed by each of the RPUs, between NVLink-based interfaces and the switch interconnect. The first RPU may enable Entity.1/GPU.1 to access, via the first NVLink interface and the switch interconnect (which may be a coherent interconnect), resources mapped to the address space utilized by the switch interconnect, such as memory resources of the switch. Correspondingly, the second RPU may enable Entity.2/GPU.2 to access, via the second NVLink interface and the switch interconnect, resources mapped to the address space utilized by the switch interconnect, such as memory resources of the switch. The first RPU may map resources of Entity.1/GPU.1, such as memory resources, to the physical address space associated with the switch interconnect, and may further enable Entity.2/GPU.2 to access resources mapped to the address space utilized by the switch interconnect, so that Entity.2/GPU.2 is able to access memory resources of Entity.1/GPU.1, via the second NVLink interface, the switch interconnect, and the first NVLink interface. Correspondingly, the second RPU may map resources of Entity.2/GPU.2, such as memory resources, to the physical address space associated with the switch interconnect, and may further enable Entity.1/GPU.1 to access resources mapped to the address space utilized by the switch interconnect, so that Entity.1/GPU.1 is able to access memory resources of Entity.2/GPU.2, via the first NVLink interface, the switch interconnect, and the second NVLink interface.

FIG. 93B illustrates an example of a TFD demonstrating NVLink switching operation between entities through a switch interconnect. Entity.1/GPU.1 issues a first NVLink request comprising source ID, destination ID and an address (AS.1.1). The first NVLink request is switched through the switch interconnect wherein a first RPU (RPU.1) translates it to an ARM CHI request comprising ReadOnce. The example demonstrates a switching operation wherein the switch typically does not change the message or the PDU, similar to how an Ethernet switch typically does not change an Ethernet frame. The first NVLink request is translated to an ARM CHI request that is translated to a second NVLink request, resulting in a switching operation of an NVLink request that passes from Entity.1/GPU.1 to Entity.2/GPU.2 through the first RPU, the switch interconnect, and a second RPU (RPU.2). The first RPU converts the first NVLink request to an ARM CHI request carrying ReadOnce, possibly utilizing user-defined fields within the switch interconnect protocol to pass fields of the first NVLink request such as NVLink source ID, destination ID, Tags, and length, to the second RPU, wherein the ARM CHI request is translated to the second NVLink request that is sent to Entity.2/GPU.2. ARM CHI may include fields such as RSVDC that may be utilized as user-defined fields for passing transaction-related information such as fields from the first NVLink request of Entity.1/GPU.1 to the second NVLink request sent to Entity.2/GPU.2. Some of the fields of the NVLink traffic received from Entity.1/GPU.1 may be translated, whereas some of the fields may be truncated or compressed to fit within the available user-defined field widths. The second RPU translates the ReadOnce ARM CHI request to the second NVLink request, and translates the first NVLink response to an ARM CHI RDAT. The first RPU on the receiving side may translate the ARM CHI response (ARM CHI RDAT) with CompData and data back to a second NVLink response. The ARM CHI RDAT may also utilize user-defined fields for passing information to the other side, while the data itself may be passed natively through the ARM CHI RDAT data field.

In various implementations, an apparatus comprising: processing cores coupled via a coherent interconnect to memory controllers, wherein the coherent interconnect is based on Coherent Hub Interface (CHI) protocol (CHI-based protocol), and the memory controllers are coupled to memory channels capable of supporting memory having a capacity of at least 64 GB; interconnect gateway coupled to the coherent interconnect, or a Fully Coherent Request Node (RN-F) comprising a hardware-coherent cache and a Fully Coherent Home Node (HN-F) comprising a Point of Coherence (PoC) coupled to the coherent interconnect; an NVLink Chip-to-Chip (NVLink-C2C) interface configured to communicate according to NVLink-C2C coherent protocol with an entity external to the apparatus; and an NVLink-C2C to CHI adapter configured to translate between messages conforming to the NVLink-C2C coherent protocol and messages conforming to the CHI-based protocol, wherein the adapter couples the NVLink-C2C interface to the CCGs or the RN-F and HN-F to enable bidirectional coherent memory access between the entity and the processing cores. The following are two examples according to which the apparatus enables full cache-coherent communication between entities using NVLink-C2C protocol and the CHI-based system. In the first example, RN-F and HN-F nodes provide coherent connectivity, wherein the RN-F node may generate transactions defined by the CHI-based protocol and support snoop transactions, while the HN-F node manages coherency by snooping required RN-F nodes and serving as both the Point of Coherence and Point of Serialization. In the second example, CCGs provide integrated coherent gateway functionality that internally implements RN-F and HN-F capabilities. The adapter may perform coherency-preserving translations that enable the external entity to read from the apparatus's DRAM through the coherent request path while the processing cores may read from the entity's memory through the coherent home path, maintaining full cache coherency across both directions of communication.

In some implementations of the apparatus, the entity comprises a graphics processing unit (GPU), and wherein: the GPU accesses dynamic random-access memory (DRAM) coupled to the memory channels through the NVLink-C2C interface, the adapter, and the coherent interconnect; and the processing cores access memory attached to the GPU through the coherent interconnect, the adapter, and the NVLink-C2C interface. The bidirectional coherent access may enable the GPU to read from the processor's DRAM while maintaining cache coherency utilizing the coherent request functionality, and simultaneously allows the processor cores to access GPU-attached memory such as High Bandwidth Memory (HBM) or High-Bandwidth Flash (HBF) through the coherent home functionality, creating a coherent memory space across heterogeneous processing elements.

In some implementations of the apparatus, the NVLink-C2C interface comprises an NVLink Fusion chiplet coupled to the adapter via a physical layer (PHY), wherein the PHY is a UCIe PHY configured for chiplet-to-chiplet communication. The NVLink Fusion chiplet may provide a modular other implementation of NVLink-C2C protocol processing, with the UCIe PHY offering a standardized chiplet interconnect that enables integration of NVLink-C2C coherent capabilities into processors that may not have native NVLink support.

In some implementations of the apparatus, the adapter comprises a CHI C2C die-to-die adapter with UCIe streaming, configured to bridge between the UCIe PHY domain and the CHI-based domain while maintaining coherency. The ARM CHI C2C die-to-die adapter may implement streaming optimizations for UCIe transfers while performing the applicable translations between NVLink-C2C and CHI, managing credit flow, transaction ordering, and coherency state transitions required for maintaining cache coherency across the die boundary.

In some implementations of the apparatus, the apparatus comprises the RN-F and HN-F coupled to the coherent interconnect, and the adapter couples the NVLink-C2C interface to the RN-F and HN-F; and wherein the apparatus further comprises additional CCGs coupled to the coherent interconnect, and a Compute Express Link (CXL) device coupled to the additional CCGs, configured to communicate with a second entity based on a CXL protocol, wherein the CXL device and the NVLink-C2C interface share access to the memory channels through their respective coherent nodes. Optionally, this configuration provides dedicated coherent paths for different protocols, with the NVLink-C2C interface utilizing discrete RN-F and HN-F nodes while the CXL device utilizes CCGs that internally implement their own coherent functionality, enabling optimizations of protocol paths while sharing access to memory resources.

In some implementations of the apparatus, the CXL device is configured to route CXL.mem and/or CXL.cache transactions through the additional CCGs via a CXS interface; the apparatus further comprises an I/O-coherent Request Node with Distributed Virtual Memory support (RN-D) coupled to the coherent interconnect; and the CXL device is further configured to route CXL.io transactions through the RN-D via an AXI interface. The separation of CXL protocol types may leverage the additional CCGs' coherency management capabilities for CXL.mem and/or CXL.cache transactions while utilizing the simpler RN-D path for CXL.io transactions, with the CXS interface providing an optimized bridge protocol for coherent transactions and the AXI interface handling I/O transactions similar to PCIe.

In some implementations of the apparatus, the CXL device comprises a Global Fabric-Attached Memory (G-FAM) Device (GFD) configured to support only CXL.mem transactions through the additional CCGs. The GFD may allow the CXL transactions to be processed through the coherent path provided by the additional CCGs, which is suitable for memory pooling applications wherein I/O functionality is not required.

In some implementations of the apparatus, the second entity communicates with the CXL device via a physical layer based on IEEE 802.3 physical medium attachment (PMA) coupled to a resource provisioning unit (RPU) that includes the CXL device. The physical layer based on IEEE 802.3 PMA may enable the CXL device to receive CXL protocol messages encapsulated within a carrier protocol, extending the reach of CXL communications beyond traditional PCIe-based physical layers while the NVLink-C2C interface provides high-bandwidth coherent connectivity for tightly-coupled accelerators.

In some implementations of the apparatus, the apparatus comprises the CCGs coupled to the coherent interconnect, and the adapter couples the NVLink-C2C interface to the CCGs; and wherein the apparatus further comprises a Compute Express Link (CXL) device coupled to additional CCGs, wherein the additional CCGs provide shared coherent infrastructure for both the NVLink-C2C interface and the CXL device. Optionally, this configuration leverages the CCGs as unified coherent gateways that handle both NVLink-C2C and CXL protocols, with the CCGs internally implementing the coherent request and home functionality required for coherent transactions, potentially simplifying the system architecture by consolidating coherent protocol handling within shared CCG blocks.

In some implementations of the apparatus, the processing cores are part of a custom CPU comprising an integrated NVLink-C2C interface; and wherein the entity comprises an NVIDIA Blackwell GPU, an accelerator processing unit, or a second custom CPU with an NVLink-C2C interface. The custom CPU design may incorporate native NVLink-C2C support to enable direct coherent communication with NVIDIA GPUs or other NVLink-C2C capable devices, eliminating the need for protocol bridges in GPU-accelerated computing systems while maintaining full cache coherency between the CPU and accelerator domains.

In some implementations of the apparatus, the interconnect gateway comprises at least one of Coherent Multichip Link (CML) or Cache Coherent Interconnect for Accelerators (CCIX) Gateway (CXG) that utilizes a streaming interface protocol; and wherein the gateway is configured to utilize a 32-bit cyclic-redundancy check (CRC-32) to protect transactions conforming to the streaming interface protocol.

In various implementations, a system comprising: a processor comprising processing cores coupled via a coherent interconnect to memory controllers, wherein the coherent interconnect is based on Coherent Hub Interface (CHI) protocol (CHI-based protocol), and the memory controllers are coupled to memory channels coupled to memory having a capacity of at least 64 GB; a first graphics processing unit (GPU) coupled to the coherent interconnect via a first interface path comprising a first NVLink interface and a first adapter; a second GPU coupled to the coherent interconnect via a second interface path comprising a second NVLink interface and a second adapter; and wherein the first adapter and the second adapter are configured to translate between messages conforming to NVLink-based protocol and messages conforming to the CHI-based protocol, enabling the first GPU and the second GPU to communicate with each other through the coherent interconnect while the first and second GPUs have access to the memory via the coherent interconnect. The system may enable GPU-to-GPU communication through the processor's coherent interconnect rather than through direct GPU-to-GPU links or NVSwitch, providing a flexible communication architecture wherein GPUs may exchange data while sharing access to the processor's memory resources. The adapters translate between the NVLink domains and the CHI domain, managing differences in transaction formats, flow control, and addressing. The coherent interconnect serves as a common communication fabric that routes transactions between the GPUs while also handling memory access requests from the GPUs and the processor cores, potentially enabling new computational models wherein GPUs collaborate utilizing shared memory spaces managed by the processor.

Optionally, this implementation may route GPU-to-GPU communications through a processor's coherent interconnect, potentially offering several technical advantages, such as leveraging existing processor interconnect infrastructure without requiring additional dedicated GPU switching hardware, enabling GPUs to communicate while simultaneously accessing processor-attached memory through the same interconnect, and/or allowing heterogeneous accelerators using different protocols to participate in the same communication fabric. This implementation may also facilitate integration scenarios wherein the number or configuration of GPUs is not known at processor design time, as the coherent interconnect may dynamically route communications between whatever GPUs are coupled. Furthermore, by translating GPU protocols to the processor's native coherent protocol, the system may apply the processor's existing quality-of-service, security, and routing mechanisms to GPU traffic, potentially simplifying system-level traffic management. The translations performed by the adapters may enable memory architectures wherein GPUs, CPUs, and other accelerators share common view(s) of memory resources.

In some implementations of the system, the first NVLink interface and the second NVLink interface are NVLink interfaces configured for I/O-coherent communication; the first adapter couples the first NVLink interface to an I/O-coherent Request Node with Distributed Virtual Memory support (RN-D) and a I/O-coherent Home Node (HN-I); and wherein the second adapter couples the second NVLink interface to a second RN-D and a second HN-I. The I/O-coherent NVLink configuration may utilize I/O-Coherent nodes that do not maintain hardware cache coherency, suitable for GPU workloads that manage their own memory consistency, with the RN-D nodes handling DVM transactions and the HN-I nodes managing IO ordering for GPU-initiated operations.

In some implementations of the system, the first NVLink interface and the second NVLink interface are NVLink-C2C interfaces configured for coherent communication; the first adapter couples the first NVLink-C2C interface to a Fully Coherent Request Node (RN-F) and a Fully Coherent Home Node (HN-F); and the second adapter couples the second NVLink-C2C interface to a second RN-F and a second HN-F, enabling cache-coherent GPU-to-GPU communication through the coherent interconnect. The coherent NVLink-C2C configuration may enable the GPUs to participate in the processor's cache coherency protocol, with the RN-F nodes supporting snoop transactions and the HN-F nodes managing coherency as Points of Coherence, allowing GPUs to maintain cache-coherent views of shared data structures during communication.

In some implementations of the system, the first interface path further comprises a first NVLink Fusion chiplet coupled to the first adapter via a first physical layer (PHY); the second interface path further comprises a second NVLink Fusion chiplet coupled to the second adapter via a second PHY; and the first and second PHYs are selected from a UCIe PHY, an NVLink-C2C PHY, or a custom PHY. The NVLink Fusion chiplets may provide modular NVLink-based protocol processing capabilities that can be integrated into systems without native NVLink support, with the PHY selection enabling different physical layer implementations based on packaging technology and bandwidth requirements.

In some implementations, the system further comprises a third accelerator coupled to the coherent interconnect via a third interface path; wherein the third accelerator is selected from a custom accelerator, an xPU, or a third GPU; and wherein the third interface path comprises a Compute Express Link (CXL) device coupled to CXL/CCIX Gateways (CCGs), enabling the third accelerator to communicate with the first GPU and the second GPU through the coherent interconnect. This mixed configuration demonstrates the flexibility of the coherent interconnect to support heterogeneous accelerators using different protocols, with CXL-attached accelerators communicating with NVLink-attached GPUs based on appropriate translations at their respective adapter/gateway interfaces.

In some implementations of the system, the first GPU reads data from the memory through the first adapter and the coherent interconnect while the second GPU reads the same data from the memory; and the first GPU writes results to the memory that are subsequently read by the second GPU, implementing a producer-consumer pattern utilizing the processor's memory. The shared memory access patterns may enable collaborative computing models wherein GPUs coordinate utilizing processor memory rather than utilizing direct GPU memory transfers, potentially simplifying programming models and enabling dynamic work distribution among GPUs.

In some implementations of the system, the first adapter comprises a CHI C2C die-to-die adapter configured to translate between the first NVLink Fusion chiplet's domain and the CHI-based domain; and the second adapter comprises a second CHI C2C die-to-die adapter configured to translate between the second NVLink Fusion chiplet's domain and the CHI-based domain. The ARM CHI C2C die-to-die adapters may provide the translations while managing inter-die communication requirements including credit flow, transaction ordering, and optional support for UCIe streaming when coupled with UCIe PHYs.

In some implementations of the system, the first GPU is an NVIDIA Blackwell GPU with High Bandwidth Memory (HBM); the second GPU is a different GPU architecture; and the coherent interconnect enables the asymmetric GPUs to exchange data despite differences in their native memory architectures and protocol implementations. The support for asymmetric GPU configurations may enable systems to combine GPUs with different capabilities, memory hierarchies, or vendor implementations, with the coherent interconnect and adapters abstracting protocol differences to enable interoperability.

In some implementations of the system, the first adapter translates GPU physical addresses within a first GPU physical address space to CHI physical addresses within the coherent interconnect's physical address space; the second adapter translates GPU physical addresses within a second GPU physical address space to CHI physical addresses; and the processor maintains address mappings that enable the first GPU to access memory regions allocated to the second GPU through the coherent interconnect. The multi-level address translation may enable the GPUs to maintain their own physical address spaces while the processor's coherent interconnect provides a unified addressing scheme for routing transactions, with the processor potentially implementing memory protection and isolation between GPU physical address spaces.

In some implementations, the system further comprises additional GPUs coupled to the coherent interconnect via additional interface paths, the additional interface paths comprise NVLink interfaces and adapters; wherein the GPUs communicate with each other through the coherent interconnect in a fully-connected logical topology without requiring a dedicated GPU switch. The scalable architecture may support arbitrary numbers of GPUs limited by the coherent interconnect's capacity rather than by the dedicated GPU switching hardware, with the GPUs able to communicate with each other through the processor's routing infrastructure.

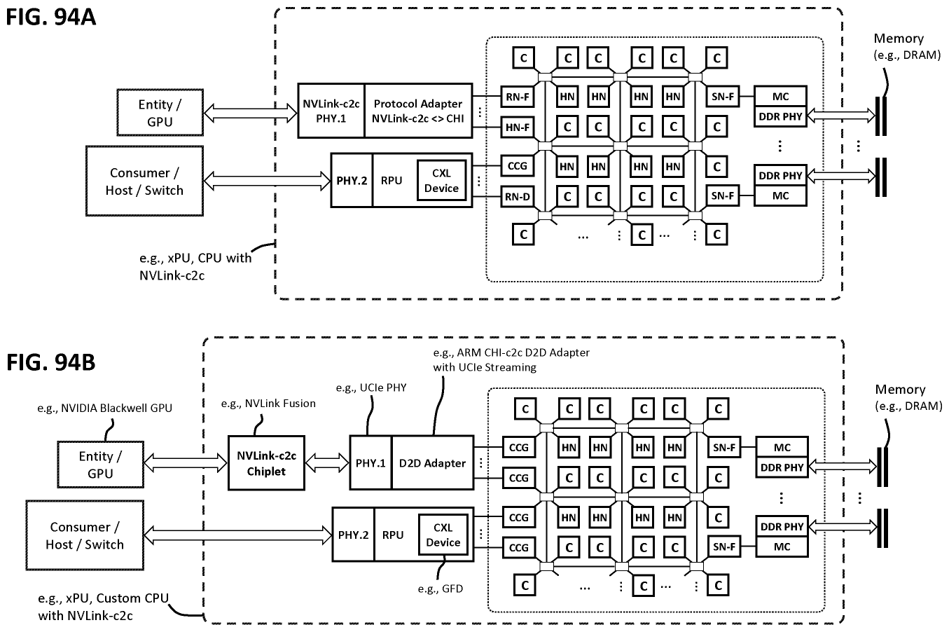

FIG. 94A illustrates an example of a system comprising a processor incorporating protocol interfaces integrating an RPU with a CXL device. The RPU includes or is coupled to a CXL device that is coupled to both (i) a CCG node for handling coherent CXL.mem and/or CXL.cache transactions, and (ii) an RN-D node for handling non-coherent CXL.io transactions. The system may couple the RPU to the CCG over a CXS interface, providing a path for coherent communications. The connection of NVLink-C2C interfaces to fully coherent request nodes (RN-F) and fully coherent home nodes (HN-F) may be included within a gateway node structure, enabling bidirectional coherent access wherein a GPU may read from the processor's DRAM through the RN-F node and the processor cores may read from the GPU's HBM through the HN-F node.

FIG. 94B illustrates an example of a system including a CPU, which may be a custom CPU design, incorporating NVLink-C2C capabilities and optionally including an NVLink-C2C chiplet, such as NVLink Fusion. The system integrates a Global Fabric-Attached Memory (G-FAM) Device (GFD) that operates as a specialized CXL device. The GFD may support only CXL.mem transactions, allowing it to service external requests through CCG nodes that are optimized for handling CXL.mem traffic, thereby simplifying the design by eliminating the need for separate CXL.io handling paths typically managed by RN-D or RN-I nodes.

### Terminology

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term “PCI Express” (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

The term “Ultra Accelerator Link” (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Resource Provisioning Unit” (RPU) refers to a physical and/or logical processing module comprising or coupled to at least two interfaces and/or ports. The RPU may be implemented in various hardware, firmware, and/or software configurations, such as an ASIC, an FPGA, a logical and/or physical module inside a CPU/GPU/TPU/MxPU, a hardware accelerator, a host, a device, a controller, a switch, a memory pool, and/or a network node. The RPU may be implemented as a single module, a single computer, and/or as a distributed computation entity running on a combination of computing machines, such as ASICs, FPGAs, hosts, servers, network devices, CPUs, GPUs, accelerators, fabric managers, and/or switches. Unless the context indicates otherwise, descriptions of the RPU as comprising its interfaces and/or ports, descriptions of the RPU as being coupled to such elements, and descriptions of such elements as being part of or separate from the RPU, may be used herein interchangeably. Furthermore, references to the RPU performing operations may encompass both direct implementation by the RPU and indirect implementation through components coupled to or associated with the RPU, unless specifically distinguished by the context.

Various implementations described herein involve interconnected computers. The term “computer” refers to a device, an integrated circuit (IC), or a system that includes at least a processor or processing element, memory to store instructions or data, and a communication interface. This definition encompasses a wide range of implementations, including but not limited to: traditional computers, mobile devices, embedded systems, specialized computing elements (such as GPUs, FPGAs, ASICs, and DSPs), System-on-Chip (SoC) designs, network nodes, RPUs, MxPUs, and ICs incorporating processing capabilities, memory, and a communication interface. The processor may be of any type, including single-core or multi-core microprocessors, embedded controllers, accelerators, or any combination thereof. The memory may include volatile or non-volatile storage media. The communication interface allows the processor to send and/or receive data, signals, or instructions, and may include memory interfaces, buses, interconnects, network interfaces, or other arrangements facilitating data exchange. References to a “computer” or a “processor” include any collection of one or more computers and/or processors that individually or jointly execute one or more sets of computer instructions, meaning that the singular term “computer” is intended to imply one or more computers, which jointly perform the functions attributed to “the computer”.

It is noted that in an apparatus comprising interconnect interfaces and/or ports, the computer may be implemented as part of one or more of the interconnect interfaces and/or ports, as a separate component, or as a combination thereof. Unless the context indicates otherwise, operations attributed to the computer may be performed by one or more of the interconnect interfaces and/or ports, and conversely, relevant operations attributed to one or more of the interconnect interfaces and/or ports may be performed by the computer. This interchangeability applies to relevant processing operations described in this specification in relation to elements such as the computer, RPU, MxPU, xPU, switch, or the interconnect interfaces and/or ports.

The term “memory pool” refers to a system, an apparatus, a device, and/or a logically or physically distinct collection of resources that may incorporate, manage, or otherwise control memory capacity (such as volatile memory (e.g., DRAM) and/or non-volatile memory), and that may provide the capability to provision, allocate, deallocate, expose, share, map, and/or otherwise make available portions or aspects of its memory capacity for use, access, sharing, allocation, and/or consumption by one or more entities external to the memory pool. Such entities may include, but are not limited to, hosts, servers, processors, accelerators, computing devices, virtual machines, containers, processes, applications, services, operating systems, hypervisors, or other memory pools. Memory pool encompasses relevant implementations that perform functions related to memory resource aggregation, management, provisioning, and/or sharing, irrespective of its commercial designation, physical form factor, architectural design, interconnection method, communication protocol(s), or implementation methodology. A memory pool may also be capable of running workloads, applications, and/or computational tasks, thereby functioning as both a memory entity and a compute entity. Furthermore, a memory pool may be implemented as a logical entity that borrows, aggregates, or otherwise utilizes memory resources from other entities (such as hosts, devices, or other memory pools), rather than solely relying on dedicated physical memory resources under its direct control.

Depending on the context, the term “inter-socket link” (ISoL) may refer to any current or future high-speed communication link, interconnect, protocol, and/or architecture that facilitates data transfer between processors, such as CPUs, GPUs, TPUs, accelerators, DSAs, and/or other types of processing units. The interface points for these technologies may be collectively referred to as “ISoL ports”, though they may have technology-specific designations. ISoL encompasses direct inter-processor links, switched fabric designs, node controller-based topologies, optical interconnects, and/or heterogeneous computing interconnects linking different processor types. These interconnects support various processor arrangements including those soldered to PCBs, installed in motherboard sockets, or integrated as separate dies within chiplet-based designs.

Non-limiting examples of ISoL technologies include Intel's Coherent Processor Interconnect Protocol (ICPIP) for scalable multiprocessors with a shared physical address space, such as Ultra Path Interconnect (UPI); AMD's Infinity Fabric (IF) and its underlying External Global Memory Interconnect (xGMI); ARM's Coherent Hub Interface chip-to-chip (CHI C2C); NVIDIA's NVLink and NVLink chip-to-chip (NVLink-C2C); Ultra Accelerator Link (UALink); Ethernet for Scale-Up Networking (ESUN), and Scale Up Ethernet (SUE), including SUE-based Protocol Data Units (PDUs) such as SUE PDU, SUE Lite PDU, or PDUs based on future revisions of SUE. Each of these technologies, their successors, and other technologies developed in the future, implements specific port, interface, and protocol designs for inter-processor communication. The interface points for these technologies may have technology-specific designations, such as “UPI port” or “UPI link” for Intel processors, “IF link” or “xGMI link” for AMD processors, “NVLink port”, “NVLink link”, or “NVLink interface” for NVIDIA GPUs, or “UALink port”, “UPLI interface”, or “UPLI interface port” for UALink implementations.

A Cache-Coherent Chip-to-Chip Interconnect (CCCI) refers to a subset of ISoL that enables communication between processors while maintaining cache coherency across chips. CCCI may connect various types of processing units, such as CPUs to CPUs, GPUs to GPUs, CPUs to GPUs, or other combinations of processing units, and may implement cache coherency protocols such as MESI (Modified, Exclusive, Shared, Invalid), MOESI (Modified, Owned, Exclusive, Shared, Invalid), or other coherency schemes. The cache coherency support provided by CCCI may enable the processing units to efficiently share data, maintain memory consistency, and coordinate access to shared resources. Examples of ISoL technologies that function as CCCI include Intel's UPI, AMD's xGMI and Infinity Fabric, ARM's CHI C2C, and NVIDIA's NVLink-C2C.

The term “Physical Layer” or “PHY” refers to hardware and protocol responsible for transmission and reception of signals, typically in the context of data communication wherein raw data bits are converted to physical signal representations, and vice versa, to be sent and received over a target medium such as copper twin-axial (Twinax) cabling, fiber optics, PCB traces for chip-to-chip (C2C) communication, or a silicon interposer for die-to-die (D2D) connectivity. The physical layer (PHY) is typically associated with the lower layer, or layer 1, of the Open System Interconnection (OSI) reference model, and may include, but is not limited to, sub-layers such as a Physical Coding Sublayer (PCS), a Physical Medium Attachment (PMA), and a Physical Medium Dependent (PMD). Examples of physical layers may include the Flex Bus Physical Layer as specified in the various CXL specifications, the collection of physical layers defined by the IEEE 802.3 Working Group, sometimes collectively referred to as “802.3 PHY”, “Ethernet PHY”, or “IEEE 802.3 PMA” when referring to sub-layers of the PHY, such as a PMA. Other PHYs may include UALink physical layers, such as UALink_200 Rev 1.0 that is based on IEEE 802.3dj (D1.4), NVIDIA NVLink physical layers, Ultra Ethernet Transport (UET) physical layers, or other appropriate current or future communication technologies.

When referring to fields, operations, or operation types associated with communication protocols, the terms “opcode”, “command”, “TLP type”, “request”, “request type”, “transaction”, and “transaction type” may be used herein interchangeably as long as they refer to the same operation, and unless a particular context specifies otherwise. This interchangeable usage may apply to data indicative of operation types (such as a field or a set of fields) within messages, packets (such as TLPs), flits, phits, frames, protocol data units (PDUs), or other protocol data structures, as well as descriptions of protocol operations, requests, transactions, or communications across different communication protocols. For example, a “CXL.cache DirtyEvict opcode”, a “CXL.cache DirtyEvict command”, and a “CXL.cache DirtyEvict request” may refer to the same operation where a device communicates with a host, such as via a D2H request message, asking the host to evict a full 64-byte modified cacheline from the device. Likewise, an “ARM CHI ReadOnce opcode”, an “ARM CHI ReadOnce command”, an “ARM CHI ReadOnce request”, and an “ARM CHI ReadOnce transaction” may refer to the same operation that specifies a read within the CHI framework, whether referring to the actual field within a CHI message or to the operation itself. Similarly, a “UPLI read command”, a “UPLI read opcode”, a “UPLI read request”, and a “UPLI read transaction” may refer to the same operation, field, or set of fields within a UPLI message that indicates a read within the UPLI framework.

The CXL Specifications use terms such as message, transaction, command, opcode, request, and response in contexts that sometimes overlap. For example, “MemRd message”, “MemRd command”, and “MemRd opcode” may refer to similar or related concepts. Similarly, “CXL.mem message”, “CXL.mem transaction”, “CXL.mem request”, and “CXL.mem response” may be used in overlapping contexts. Accordingly, depending on the context, this specification may use such terms broadly. Additionally, references to CXL messages may encompass CXL transactions, and vice versa. Moreover, the CXL Specifications occasionally describe CXL.cache and CXL.mem using various terms such as protocols, channels, interfaces, or transactional interfaces, which may be used herein interchangeably depending on the context.

Depending on the context and implementation, the terms “UALink requests”, “UALink UPLI requests”, and “UPLI requests” may be used herein interchangeably. The interchangeable use of these terms reflects that UPLI constitutes the protocol layer of UALink communications, and unless a particular context requires distinction between the physical layer aspects and the protocol layer aspects, these terms may refer to the same underlying communication transactions within the UALink ecosystem.

In the context of ARM CHI implementations, the terms “CHI messages”, “CHI packets”, and “CHI flits” may be used herein interchangeably, unless a particular context specifies otherwise. The ARM AMBA CHI Architecture Specification defines communication granularity at different layers, including transactions at the protocol layer, packets at the network layer, and flow control units (flits) at the link layer. For CHI, packets may include a single flit, which may contribute to the interchangeable use of these terms. When referring to CHI communications herein, any of these terms may be used to describe CHI protocol-level communications without implying limitations to a specific layer or format.

The terms “port” and “interface” may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context. For example, the following pairs may be used herein interchangeably unless a particular context specifies otherwise: CHI interface and CHI port, CXL interface and CXL port, UALink interface and UALink port, and NVLink interface and NVLink port.

The term “Coherent Hub Interface” (CHI) as used herein is intended to encompass presently available and future versions, variations, revisions, and equivalent implementations of the CHI interconnect architecture, including AMBA 5 CHI and subsequent issues or architectural extensions published or adopted by ARM or by other entities that may extend CHI. Unless stated otherwise, translating between CHI and another protocol, such as translating between CHI and CXL, refers to converting CHI-related protocol data units (PDUs), such as CHI requests, CHI snoop requests, CHI data responses, and CHI snoop responses, to corresponding PDUs of the other protocol, such as to CXL.cache requests and responses, or to CXL.mem requests and responses, and vice versa, optionally including field value translations between the CHI domain and the other protocol domain, such as addresses, transaction identifiers, and/or cache state indications.

The term “NVLink” as used herein is intended to encompass previous, current, and future versions, variations, revisions, and equivalent implementations of NVIDIA's NVLink interconnect, including NVLink-C2C, NVLink used with NVSwitch and/or NVLink Switch fabrics, and other NVLink-related implementations that provide a high-bandwidth, low-latency, scalable interconnect between GPUs, between GPUs and CPUs, and/or between other types of processing units. Unless stated otherwise, translating between NVLink and another protocol, such as translating between NVLink and CXL, refers to converting NVLink-related protocol data units (PDUs), such as NVLink requests and NVLink responses, to corresponding PDUs of the other protocol, such as to CXL.io requests and completions, or to CXL.mem requests and responses, and vice versa, optionally including field value translations between the NVLink domain and the other protocol domain, such as Tags, error indications, and/or addresses.

### GENERAL CONSIDERATIONS

Asterisks (*) may be utilized as wildcard notations within the context of an implementation and/or an example, such as for representing a subset of relevant operations within a broader set of operations that may be indicated by opcodes, TLP types, commands, requests, request types, transactions, or transaction types, collectively referred to in this specific paragraph as “operation types”. The subset of relevant operations may include operation types that are relevant to the revisions or standards being discussed, encompassing both existing operation types and potential future operation types that may be introduced in subsequent versions of the applicable interconnect standards, including CXL, UALink, ESUN, SUE, PCIe, UCIe, ARM CHI, ARM AXI, or protocol implementations based on NVLink technology, provided they are applicable and relevant to the implementation in question. For example, the wildcard operation type ReadOnce* may represent a subset of relevant requests or transactions within the ARM CHI specifications, which may include, but is not limited to: ReadOnce, ReadOnceCleanInvalid, and ReadOnceMakeInvalid. Similarly, the wildcard operation type MemRd* may represent a subset of relevant opcodes within the CXL standard, which may include, but is not limited to: MemRd, MemRdData, MemRdFwd, MemRdTEE, MemRdDataTEE, or other opcodes that may be introduced in future CXL standard revisions, provided they are relevant to the implementation under consideration. Likewise, the wildcard operation type *Rd* may represent a broader subset of relevant operations across different protocols or different standards, which may encompass, but is not limited to: (1) ReadNoSnp, ReadOnce, ReadClean, ReadShared, ReadUnique and MakeReadUnique commands in ARM CHI; (2) UIOMRd and MRd TLP types in CXL.io; (3) RdCurr, RdOwn, RdShared, RdAny, and RdOwnNoData opcodes in CXL.cache; (4) MemRd, MemRdData, MemRdFwd, MemRdTEE, MemRdDataTEE, MemSpecRd, or MemSpecRdTEE opcodes in CXL.mem; (5) read commands in UALink UPLI; (6) memory read TLP types in PCIe; (7) read-class operations in SUE; or (8) read request types in NVLink-based protocol implementations. The examples listed for each protocol are non-limiting and are intended to encompass future operation types that may be introduced in subsequent revisions of the applicable standards, provided they are relevant to the implementations. The wildcard notation does not extend to operation types that are irrelevant to the implementation in question, even if such operation types exist within the broader specifications of the respective standards.

The wildcard form “*Data*” may be utilized for denoting essentially the same underlying information (“the Data”) irrespective of its representation, state, or protocol encoding. *Data* may encompass functionally equivalent forms and transformations of “the Data”, such as encoding, packetization, encapsulation, serialization, scrambling, compression, encryption, segmentation, or splitting, and their respective reverse transformations, represented in a suitable structure, manner, form, or format that may be carried by or interoperate with the applicable interconnect standard specifications, such as CXL, UALink, ESUN, SUE, PCIe, UCIe, ARM CHI, ARM AXI, or NVLink-based protocol implementations. For example, *Data* may refer to the same essential data payload when carried across different hops of a communication path that may each use different encryption, such as when one hop utilizes CXL Integrity and Data Encryption (CXL IDE) and another hop utilizes a different encryption mechanism or no encryption, or when different encryption keys are used on different interconnect links or channels. *Data* may further encompass the same essential data payload when carried in PDUs associated with the same or different protocols, such as: a CXL.mem S2M Data Response (DRS), a CXL.cache H2D Data message, a PCIe Completion with Data (CpID), a PCIe UIO Read Completion with Data (UIORdCpID), a UALink UPLI Data Beat carrying Read Response Data, or an NVLink data transmission. *Data* may also denote PDUs having collectively essentially the same payload, such as when splitting a 128 B cacheline into two 64 B transfers carried in two separate messages, or when an RPU splits a request for a large data block into smaller requests for translation to another protocol that supports a smaller maximum transfer size per request.

Depending on the context, each line, arrow, label, and/or box illustrated in the figures may represent one or more lines, arrows, labels, and/or boxes. For example, a single arrow representing a *Rd* operation in CXL, UALink UPLI, ESUN, SUE, PCIe, or an NVLink-based protocol may encompass one or more read or data messages relevant to the specific implementation and applicable standard, even though each may be represented by a single arrow. Additionally, optional messages, such as completion, acknowledgment, or response messages in the respective standards, may be explicitly depicted or implicitly included within the mandatory messages or their equivalents.

It is specifically noted that the transaction flow diagrams (TFDs) presented herein are schematic representations, which means that the number, order, timings, dimensions, and other properties of the information illustrated in the TFDs are non-limiting examples. Every modification, variation, or alternative allowed by a current or future Specification mentioned in the TFD (such as CXL, UALink, ESUN, SUE, PCIe, UCIe, CHI, AXI, etc.) that is relevant to a diagram, is also intended to be included within the scope of said diagrams. Furthermore, the scope of these diagrams extends to encompass implementations that may deviate from the strict specifications mentioned in the TFDs due to factors such as hardware bugs, relaxed designs, or implementation-specific optimizations.

Herein, terms such as send/sending, receive/receiving, communicate/communicating, or exchange/exchanging when used to describe elements (e.g., computer, RPU, MxPU, processor, semiconductor device, switch, port, interface) involved in data, message, packet, or other information exchanges, may refer to direct or indirect operation(s) that facilitate information transfer to/from/between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of “a port/interface configured to communicate with an entity” refer to direct or indirect coupling between the port/interface and the entity.

As used herein, “mounted to” refers to a physical coupling between components, such as cards, boards, or devices, where a first component is mechanically secured or attached to a second component through a suitable mounting mechanism. The physical mounting may be direct or may involve intermediate mounting structures, and encompasses components that are mounted on, mounted in, mounted within, mounted through, mounted under, mounted alongside, or mounted via a mechanical coupling arrangement. The physical mounting connection may include an electrical connection integrated with the mechanical mounting mechanism, such as when a card is inserted into a slot with integrated electrical contacts. Alternatively, the electrical connection between mounted components may be established through a separate element from the mechanical mounting structure. Non-limiting examples of such separate electrical connection elements may include: cables (such as MCIO cables, SlimSAS cables, or power cables), sockets, card edge connectors, PCIe connectors, CXL connectors, backplane connectors, EDSFF connectors, OCP connectors, QSFP-DD connectors, or other electrical interconnects suitable for establishing electrical communication between the mounted components.

References to a protocol “based on” a specific standard or an industry standard (such as a protocol based on CXL, a CXL-based protocol, a protocol based on UALink, a UALink-based protocol, a protocol based on NVLink, an NVLink-based protocol, a protocol based on CHI, a CHI-based protocol, a protocol based on Ethernet, an Ethernet-based protocol, a protocol based on PCIe, or a PCIe-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a CXL-based protocol may encompass implementations that rename CXL.mem opcodes but preserve their memory access properties, add vendor-defined fields to CXL message formats while maintaining backward compatibility, or that implement CXL transaction flows over alternative physical layers such as IEEE 802.3 PMA or UCIe. A UALink-based protocol may encompass implementations that add vendor-defined fields, packets, or commands while preserving the essential accelerator-to-accelerator communication model. A PCIe-based protocol may encompass implementations that utilize non-PCIe physical layers or carrier protocols for transferring PCIe TLPs. An NVLink-based protocol may encompass implementations that extend or modify the command encoding while maintaining the fundamental interconnect functionality.

References to a protocol-based port (such as CXL-based port, UALink-based port, NVLink-based port, or PCIe-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a CXL-based port may refer to a standard CXL port communicating over PCTe physical layer, a port communicating according to CXL over a physical layer based on IEEE 802.3 PMA, or a port communicating according to CXL over UCIe. A UALink-based port may communicate over its native physical layer, over UCIe, over ESUN, or over SUE. Similarly, an NVLink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, “non-transitory computer-readable medium” refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The “computer-implemented methods” described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as “an implementation”, “various implementations”, “some implementations”, “one or more implementations”, “an embodiment”, “some embodiments”, “one embodiment”, “an aspect”, “a configuration”, “an example”, and similar phrases are used herein for convenience and do not imply that a disclosure relating to such phrase(s) is essential to the subject technology or that such disclosure applies to all implementations of the subject technology. Phrases such as “an implementation”, “some implementations”, or “various implementations” may refer to one or more implementations and vice versa, and this applies similarly to other foregoing phrases. Distinct references, including terms such as “one implementation”, “another implementation”, “various implementations”, or “some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of “X is indicative of Y” mean that X includes information correlated with Y and/or describing Y, up to the case wherein X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive; they indicate an open-ended claim language, thus, for example, sentences in the form of “a portion of the memory” or “a subset of the memory” encompass anything from just a small part of the memory to the entire memory, optionally together with additional memory region(s). Sentences in the form of “access the memory” encompass accessing at least a portion of the memory, where the portion may range from a minimal addressable unit to the entire memory capacity, indicating an open-ended claim language. “Coupled” indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of “a” or “an” refers to one or more things. The phrase “based on” indicates an open-ended claim language, and encompasses “based, at least in part, on”. Additionally, stating that a value is calculated “based on X” and following that, in a certain implementation, that the value is calculated “also based on Y”, means that in the certain implementation, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction ‘and’ or ‘or’. A predetermined, predefined, or preselected value is a fixed value and/or a value determined before performing a calculation that utilizes the predetermined value. When appropriate, the word “value” may indicate a predetermined value. The word “threshold” indicates a threshold whose value, and/or the logic used to determine whether the threshold is reached, is established prior to performing the computation that utilizes the threshold, whether the threshold value is fixed, predefined, or dynamically determined.

In the context of RPUs and/or translations, references to “first” and “second” protocols may denote either distinct protocol types, which are different protocols with differing opcodes and functionalities (such as CXL.mem vs. CXL.cache, PCIe vs. NVLink, or UALink vs. SUE), or different instantiations of the same protocol type operating in separate domains or with distinct configurations (such as a first CXL.mem utilizing a first physical address space vs. a second CXL.mem utilizing a second physical address space).

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

In implementations where the first domain and the second domain may be associated with the same physical address space, the translator may utilize the address in the transaction associated with the first protocol for generating the address in the transaction associated with the second protocol, possibly copying the address value as is between the messages, or adjusting for address width differences between the messages by zero-extending or truncating unused upper address bits. For example, when translating between CXL-based traffic and ISoL traffic such as UPI, wherein both requests utilize the same physical address space, an address such as (AS.1.1) in a CXL.mem request may be utilized to generate the corresponding address (AS.2.1) in a UPI request. Similarly, when translating between CHI-based traffic and PCIe traffic that share the same physical address space, or between NVLink traffic and CHI traffic in certain configurations, the translator may perform comparable address formatting operations without changing the underlying memory location being referenced. Hence, in relevant contexts, notations in the form of (AS.1.1) and (AS.2.1) used in the drawings may refer to the same address represented in different protocols, such as the address (AS.1.1)=00-00-CA-FE in a protocol that utilizes 32-bit address fields, which corresponds to the address (AS.2.1)=00-00-00-00-00-00-CA-FE in a protocol that utilizes 64-bit address fields.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of “One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages” are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of “An active cable comprising first and second pluggable modules coupled by a physical medium; wherein the active cable further comprises hardware circuitry, integrated into the active cable, configured to perform the method of claim X” are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of “An apparatus configured to operate as a switch, wherein the apparatus comprises switching circuitry and is configured to perform the method of claim X” are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

We claim:

1. A method for translating from Ultra Accelerator Link (UALink) Protocol Level Interface (UPLI) requests to Compute Express Link (CXL) requests, comprising:
communicating with a first entity according to UPLI;
communicating with a second entity according to CXL.mem;
receiving, from the first entity, a UPLI request comprising a read command and a first physical address;
translating the UPLI request to a CXL.mem Master-to-Subordinate request comprising: a MemRd* and a second physical address (CXL.mem M2S Req MemRd*); and
sending the CXL.mem M2S Req MemRd* to the second entity.

2. The method of claim 1, wherein the UPLI request further comprises a ReqSrcPhysAccID field, a ReqDstPhysAccID field, a ReqLen field, a ReqTag field, a ReqAddr field comprising the first physical address, and a ReqCmd field comprising the read command; and further comprising translating the ReqTag to a Tag associated with the CXL.mem M2S Req.

3. The method of claim 1, further comprising: receiving, from the second entity, a CXL.mem Subordinate-to-Master Data Response (S2M DRS) comprising MemData, a Tag, and data; translating the CXL.mem S2M DRS to a UPLI read response (RdRsp) comprising a RdRspSrcPhysAccID field, a RdRspDstPhysAccID field, a RdRspTag field, and RdRspData comprising the data; and sending the UPLI RdRsp to the first entity.

4. The method of claim 3, wherein the CXL.mem S2M DRS further comprises a Poison field, and the UPLI RdRsp further comprises a RdRspDataError field; and further comprising translating the Poison field of the CXL.mem S2M DRS to the RdRspDataError field of the UPLI RdRsp.

5. The method of claim 1, wherein the read command comprises a Read Class Vendor Defined Command, the first entity comprises an accelerator or a UALink switch, the second entity comprises a CXL device, and the second physical address is a host physical address (HPA) utilized by the second entity.

6. The method of claim 1, wherein the UPLI request indicates an I/O-coherent read, and the CXL.mem M2S Req MemRd* further comprises a SnpType field comprising SnpCur, a MetaField field comprising Meta0-State (MS0), and a MetaValue field comprising Invalid (I).

7. The method of claim 1, further comprising sending to the second entity a CXL.mem M2S request comprising MemSpecRd.

8. The method of claim 1, wherein the first physical address is associated with a first address space, the second physical address is associated with a second address space different from the first address space, and the translating further comprises translating the first physical address to the second physical address.

9. A non-transitory computer-readable medium comprising instructions which, when executed by a processor, cause the processor to perform the method of claim 1.

10. One or more integrated circuits configured to perform the method of claim 1, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

11. An active cable comprising first and second pluggable modules coupled by a physical medium; wherein the active cable further comprises hardware circuitry, integrated into the active cable, configured to perform the method of claim 1.

12. An apparatus configured to operate as a switch, wherein the apparatus comprises switching circuitry and is configured to perform the method of claim 1.

13. A system comprising:
a processing unit comprising an Ultra Accelerator Link (UALink) port, a memory controller coupled to a first memory, and a Compute Express Link (CXL) port coupled to a second memory;
wherein the UALink port is configured to communicate with an entity according to a UALink-based protocol;
wherein the processing unit is configured to provide a first memory path from the UALink port to the first memory via the memory controller, and a second memory path from the UALink port to the second memory via the CXL port; and
wherein the processing unit further comprises a resource provisioning unit (RPU) configured to receive a first UALink Protocol Level Interface (UPLI) request from the entity and forward a first translated request to the first memory via the first memory path, and to receive a second UPLI request from the entity and forward a second translated request to the second memory via the second memory path.

14. The system of claim 13, wherein the processing unit further comprises a coherent interconnect, and wherein the first memory path and the second memory path traverse a portion of the coherent interconnect.

15. The system of claim 14, wherein the CXL port comprises a CXL/PCIe root port (RP) coupled to the coherent interconnect.

16. The system of claim 14, wherein the processing unit further comprises processing cores, caching/home agent (CHA), snoop filter (SF), and Last Level Cache (LLC) slices coupled to the coherent interconnect; and further comprising at least one of: a PCIe root port coupled to an I/O device, or an inter-socket link (ISoL) port coupled to a second processing unit.

17. The system of claim 13, wherein the UALink port, the CXL port, and the memory controller are located in a same integrated circuit (IC) package; and wherein the RPU is further configured to translate physical addresses associated with the UALink-based protocol to physical addresses associated with the processing unit, enabling the entity to access the first memory and the second memory.

18. The system of claim 13, wherein the second translated request comprises a CXL.mem Master-to-Subordinate (M2S) request comprising MemRd*, and the CXL port is configured to send the CXL.mem M2S request to the second memory; and wherein the CXL port is further configured to receive a CXL.mem Subordinate-to-Master Data Response (S2M DRS) comprising MemData and data from the second memory, and the RPU is further configured to translate the CXL.mem S2M DRS to a UPLI read response (RdRsp) comprising the data and send the UPLI RdRsp to the entity.

19. A system comprising:
a switch;
accelerators coupled to the switch, wherein the accelerators communicate according to a UALink-based protocol;
a resource provisioning unit (RPU) coupled to the switch;
a first Compute Express Link (CXL) memory device coupled to the RPU; and
a second CXL memory device coupled to the RPU;
wherein the RPU is configured to receive a first UALink Protocol Level Interface (UPLI) request and a second UPLI request from a first accelerator of the accelerators via the switch, translate the first UPLI request to a first CXL.mem Master-to-Subordinate (M2S) request and send the first CXL.mem M2S request to the first CXL memory device, and translate the second UPLI request to a second CXL.mem M2S request and send the second CXL.mem M2S request to the second CXL memory device.

20. The system of claim 19, wherein at least one of the first CXL memory device or the second CXL memory device comprises a Global Fabric-Attached Memory Device (GFD); and wherein the RPU is further configured to receive a CXL.mem Subordinate-to-Master Data Response (S2M DRS) from the GFD, translate the CXL.mem S2M DRS to a UPLI read response (RdRsp), and send the UPLI RdRsp to the first accelerator via the switch.

21. The system of claim 19, further comprising a host coupled to at least one of the first CXL memory device or the second CXL memory device via CXL.mem; wherein both the first accelerator, via the RPU, and the host access the at least one of the first CXL memory device or the second CXL memory device.

22. The system of claim 19, further comprising a CXL fabric coupling the RPU to the first CXL memory device and the second CXL memory device; wherein at least one of the first CXL memory device or the second CXL memory device comprises at least one of: a CXL memory expander, a CXL memory pool, or a Global Fabric-Attached Memory Device (GFD).

23. The system of claim 19, wherein the first UPLI request comprises a first physical address associated with a first address space, and the second UPLI request comprises a second physical address associated with the first address space; wherein the first CXL.mem M2S request comprises a third physical address associated with a second address space, and the second CXL.mem M2S request comprises a fourth physical address associated with the second address space; and wherein the RPU translates the first physical address to the third physical address and the second physical address to the fourth physical address; and wherein the first address space comprises a Network Physical Address (NPA) space or a System Physical Address (SPA) space, and the second address space comprises a Host Physical Address (HPA) space.

24. The system of claim 19, wherein the switch comprises a UALink switch comprising a route table, and the UALink switch routes the first UPLI request and the second UPLI request from the first accelerator to the RPU based on a Destination Accelerator ID carried in the first UPLI request and the second UPLI request; and wherein the accelerators communicate with the UALink switch via UPLI request channels and UPLI response channels.

25. A method for translating from Ultra Accelerator Link (UALink) Protocol Level Interface (UPLI) write requests to Compute Express Link (CXL) write requests, comprising:
communicating with a first entity according to UPLI;
communicating with a second entity according to CXL.mem;
receiving, from the first entity, a UPLI request comprising a write command, a first physical address, and write data;
translating the UPLI request to a CXL.mem Master-to-Subordinate Request with Data (M2S RwD) comprising a MemWr* and a second physical address;
sending the CXL.mem M2S RwD and the write data to the second entity;
receiving, from the second entity, a CXL.mem Subordinate-to-Master No Data Response (S2M NDR) comprising Cmp*;
translating the CXL.mem S2M NDR to a UPLI write response (WrRsp); and
sending the UPLI WrRsp to the first entity.

26. The method of claim 25, wherein the UPLI request further comprises a ReqSrcPhysAccID field, a ReqDstPhysAccID field, a ReqTag field, and a ReqAddr field comprising the first physical address; wherein the write data is received on a UPLI Originator Data (OrigData) channel comprising OrigDataByteEn; and further comprising translating the ReqTag to a Tag associated with the CXL.mem M2S RwD.

27. The method of claim 25, wherein the MemWr* comprises MemWrPtl, and the write data comprises a partial cacheline update; and wherein byte enables associated with a UPLI Originator Data channel are utilized to indicate which bytes of the cacheline are to be written by the second entity.

28. The method of claim 25, wherein the UPLI WrRsp further comprises a WrRspTag field and a WrRspStatus field, and the CXL.mem S2M NDR further comprises a Cmp* completion opcode; and further comprising translating a Tag of the CXL.mem S2M NDR to the WrRspTag of the UPLI WrRsp, and translating a completion status of the CXL.mem S2M NDR to the WrRspStatus of the UPLI WrRsp.

29. The method of claim 25, wherein the first entity comprises an accelerator, the second entity comprises a CXL device comprising at least one of a CXL memory expander, a CXL memory pool, or a Global Fabric-Attached Memory Device (GFD); the first physical address is associated with a Network Physical Address (NPA) space; and the second physical address is associated with a Host Physical Address (HPA) space; and wherein the translating further comprises translating the first physical address to the second physical address.

30. The method of claim 25, wherein the UPLI request further comprises a ReqLen field indicating a transfer size exceeding a CXL.mem cacheline size; and wherein the translating further comprises generating CXL.mem M2S RwD requests from the UPLI request, each of the CXL.mem M2S RwD requests comprising a respective MemWr* and a respective portion of the write data.
